(19) United States
(12) Patent Application Publication
(10) Pub. No.: US 2013/0124232 A1
(43) Pub. Date: May 16, 2013

(54) MANAGING CONSISTENT INTERFACES FOR INDIAN PAYROLL BUSINESS OBJECTS ACROSS HETEROGENEOUS SYSTEMS

(71) Applicants: Guoqing Zhao, Shanghai (CN); Zhi Zhang, Shanghai (CN); Haixing Zhou, Shanghai (CN); Guy Cases Langhoff, Rauenberg (DE); Jesus Lopez Mijan, Madrid (ES); Karel Hol Soto Borja, Heidelberg (DE); Monica Reidl, Sandhausen (DE); Werner Gnan, Angelbachtal (DE); Michael Seubert, Sinsheim (DE); Bin Fu, Shanghai (CN); Rui Zhou, Shanghai (CN); Gaogao Zheng, Shanghai (CN); Xiaoming Wang, Shanghai (CN); Debiao Cao, Shanghai (CN); Ke Ding, Shanghai (CN)

(72) Inventors: Guoqing Zhao, Shanghai (CN); Zhi Zhang, Shanghai (CN); Haixing Zhou, Shanghai (CN); Guy Cases Langhoff, Rauenberg (DE); Jesus Lopez Mijan, Madrid (ES); Karel Hol Soto Borja, Heidelberg (DE); Monica Reidl, Sandhausen (DE); Werner Gnan, Angelbachtal (DE); Michael Seubert, Sinsheim (DE); Bin Fu, Shanghai (CN); Rui Zhou, Shanghai (CN); Gaogao Zheng, Shanghai (CN); Xiaoming Wang, Shanghai (CN); Debiao Cao, Shanghai (CN); Ke Ding, Shanghai (CN)

(21) Appl. No.: 13/703,471

(22) PCT Filed: Jun. 12, 2010
(86) PCT No.: PCT/CN10/73868

§ 371 Date: Jan. 28, 2013

(51) Int. Cl. G06Q 10/06

(52) U.S. Cl. CPC G06Q 10/067
USPC 705/4; 705/32; 705/31

(57) ABSTRACT

A business object model, which reflects data that is used during a given business transaction, is utilized to generate interfaces. This business object model facilitates commercial transactions by providing consistent interfaces that are suitable for use across industries, across businesses, and across different departments within a business during a business transaction. In some operations, software creates, updates, or otherwise processes information related to Indian employee payroll input, Indian social insurance arrangement, and Indian tax arrangement business objects.

### TECHNICAL FIELD

The subject matter described herein relates generally to the generation and use of consistent interfaces (or services) derived from a business object model. More particularly, the present disclosure relates to the generation and use of consistent interfaces or services that are suitable for use across industries, across businesses, and across different departments within a business.

### BACKGROUND

Transactions are common among businesses and between business departments within a particular business. During any given transaction, these business entities exchange information. For example, during a sales transaction, numerous business entities may be involved, such as a sales entity that sells merchandise to a customer, a financial institution that handles the financial transaction, and a warehouse that sends the merchandise to the customer. The end-to-end business transaction may require a significant amount of information to be exchanged between the various business entities involved. For example, the customer may send a request for the merchandise as well as some form of payment authorization for the merchandise to the sales entity, and the sales entity may send the financial institution a request for a transfer of funds from the customer's account to the sales entity's account.

Exchanging information between different business entities is not a simple task. This is particularly true because the information used by different business entities is usually tightly tied to the business entity itself. Each business entity may have its own program for handling its part of the transaction. These programs differ from each other because they typically are created for different purposes and because each business entity may use semantics that differ from the other business entities. For example, one program may relate to accounting, another program may relate to manufacturing, and a third program may relate to inventory control. Similarly, one program may identify merchandise using the name of the product while another program may identify the same merchandise using its model number. Further, one business entity may use U.S. dollars to represent its currency while another business entity may use Japanese Yen. A simple difference in formatting, e.g., the use of upper-case lettering rather than lower-case or title-case, makes the exchange of information between businesses a difficult task. Unless the individual businesses agree upon particular semantics, human interaction typically is required to facilitate transactions between these businesses. Because these “heterogeneous” programs are used by different companies or by different business areas within a given company, a need exists for a consistent way to exchange information and perform a business transaction between the different business entities.

Currently, many standards exist that offer a variety of interfaces used to exchange business information. Most of these interfaces, however, apply to only one specific industry and are not consistent between the different standards. Moreover, a number of these interfaces are not consistent within an individual standard.

### SUMMARY

In a first aspect, a tangible computer readable medium includes program code for providing a message-based interface for exchanging employee-specific payroll information between an employee information system and a payroll system. The medium comprises program code for receiving via a message-based interface derived from a common business object model, where the common business object model includes business objects having relationships that enable derivation of message-based interfaces and message packages, the message-based interface exposing at least one service as defined in a service registry and from a heterogeneous application executing in an environment of computer systems providing message-based services, a first message for requesting replication of employee-specific Indian payroll information to the payroll system that includes a first message package derived from the common business object model and hierarchically organized in memory as a message header entity, and a collection package comprising an employee payroll input collection entity and an employee payroll input package, where the employee payroll input package includes an employee payroll input entity and an employee package, where the employee package includes an employee entity, where the employee entity includes an action code, a common list complete transmission indicator, an employee workplace address list complete transmission indicator, an address information list complete transmission indicator, an employee tax arrangement period terms information list complete transmission indicator, an employment item list complete transmission indicator, a universal unique identifier, and an employee identifier.

The medium further comprises program code for processing the first message according to the hierarchical organization of the first message package, where processing the first message includes unpacking the first message package based on the common business object model.

The medium further comprises program code for sending a second message to the heterogeneous application responsive to the first message, where the second message includes a second message package derived from the common business object model to provide consistent semantics with the first message package.

Implementations can include the following. The employee package further comprises at least one of the following: a common entity, an employee workplace address information entity, an address information entity, an employee tax arrangement period terms entity, and an employment item package.

In another aspect, a distributed system operates in a landscape of computer systems providing message-based services defined in a service registry. The system comprises a graphical user interface comprising computer readable instructions, embedded on tangible media, for requesting replication of employee-specific Indian payroll information to a payroll system using a request.

The system further comprises a first memory storing a user interface controller for processing the request and involving a message including a message package derived from a common business object model, where the common business object model includes business objects having relationships that enable derivation of message-based service interfaces and message packages, the message package hierarchically organized as a message header entity, and a collection package comprising an employee payroll input collection entity and an employee payroll input package, where the employee payroll input package includes an employee payroll input entity and an employee package, where the employee package includes an employee entity, where the employee entity includes an action code, a common list complete transmission indicator, an employee workplace address list complete transmission indicator, an address information list complete transmission indicator, an employee tax arrangement period terms information list complete transmission indicator, an employment item list complete transmission indicator, a universal unique identifier, and an employee identifier.

The system further comprises a second memory, remote from the graphical user interface, storing a plurality of message-based service interfaces derived from the common business object model to provide consistent semantics with messages derived from the common business object model, where one of the message-based service interfaces processes the message according to the hierarchical organization of the message package, where processing the message includes unpacking the first message package based on the common business object model.

Implementations can include the following. The first memory is remote from the graphical user interface. The first memory is remote from the second memory.

In another aspect, a tangible computer readable medium includes program code for providing a message-based interface for exchanging payroll-related information between an employee information system and a payroll system. The medium comprises program code for receiving via a message-based interface derived from a common business object model, where the common business object model includes business objects having relationships that enable derivation of message-based interfaces and message packages, the message-based interface exposing at least one service as defined in a service registry and from a heterogeneous application executing in an environment of computer systems providing message-based services, a first message for providing notification to the payroll system concerning an employee's Indian social insurance arrangement information that includes a first message package derived from the common business object model and hierarchically organized in memory as a message header entity, and an employee social insurance arrangement package comprising an employee social insurance arrangement entity, where the employee social insurance arrangement entity includes a work agreement item list complete transmission indicator, a reconciliation period counter value, a universal unique identifier, and an employee universal unique identifier.

The medium further comprises program code for processing the first message according to the hierarchical organization of the first message package, where processing the first message includes unpacking the first message package based on the common business object model.

The medium further comprises program code for sending a second message to the heterogeneous application responsive to the first message, where the second message includes a second message package derived from the common business object model to provide consistent semantics with the first message package.

Implementations can include the following. The employee social insurance arrangement package further comprises at least one of the following: a work agreement item package.

In another aspect, a distributed system operates in a landscape of computer systems providing message-based services defined in a service registry. The system comprises a graphical user interface comprising computer readable instructions, embedded on tangible media, for providing notification to a payroll system concerning an employee's Indian social insurance arrangement information using a request.

The system further comprises a first memory storing a user interface controller for processing the request and involving a message including a message package derived from a common business object model, where the common business object model includes business objects having relationships that enable derivation of message-based service interfaces and message packages, the message package hierarchically organized as a message header entity, and an employee social insurance arrangement package comprising an employee social insurance arrangement entity, where the employee social insurance arrangement entity includes a work agreement item list complete transmission indicator, a reconciliation period counter value, a universal unique identifier, and an employee universal unique identifier. The system further comprises a second memory, remote from the graphical user interface, storing a plurality of message-based service interfaces derived from the common business object model to provide consistent semantics with messages derived from the common business object model, where one of the message-based service interfaces processes the message according to the hierarchical organization of the message package, where processing the message includes unpacking the first message package based on the common business object model.

Implementations can include the following. The first memory is remote from the graphical user interface. The first memory is remote from the second memory.

In another aspect, a tangible computer readable medium includes program code for providing a message-based interface for exchanging payroll-related information between an employee information system and a payroll system. The medium comprises program code for receiving via a message-based interface derived from a common business object model, where the common business object model includes business objects having relationships that enable derivation of message-based interfaces and message packages, the message-based interface exposing at least one service as defined in a service registry and from a heterogeneous application executing in an environment of computer systems providing message-based services, a first message for providing notification to the payroll system concerning an employee's Indian tax arrangement information that includes a first message package derived from the common business object model and hierarchically organized in memory as a message header entity, and an employee tax arrangement package comprising an employee tax arrangement payroll notification entity, where the employee tax arrangement payroll notification entity includes a period terms list complete transmission indicator, an employment item list complete transmission indicator, a work agreement item list complete transmission indicator, a universal unique identifier, and an employee universal unique identifier.

The medium further comprises program code for processing the first message according to the hierarchical organization of the first message package, where processing the first message includes unpacking the first message package based on the common business object model.

The medium further comprises program code for sending a second message to the heterogeneous application responsive to the first message, where the second message includes a second message package derived from the common business object model to provide consistent semantics with the first message package.

Implementations can include the following. The employee tax arrangement package further comprises at least one of the following: a period terms package, an employment item package, and a work agreement package. The employee tax arrangement payroll notification entity further comprises at least one of the following: a reconciliation period counter value.

In another aspect, a distributed system operates in a landscape of computer systems providing message-based services defined in a service registry. The system comprises a graphical user interface comprising computer readable instructions, embedded on tangible media, for providing notification to a payroll system concerning an employee's Indian tax arrangement information using a request.

The system further comprises a first memory storing a user interface controller for processing the request and involving a message including a message package derived from a common business object model, where the common business object model includes business objects having relationships that enable derivation of message-based service interfaces and message packages, the message package hierarchically organized as a message header entity, and an employee tax arrangement package comprising an employee tax arrangement entity, where the employee tax arrangement entity includes a work agreement item list complete transmission indicator, a reconciliation period counter value, a universal unique identifier, and an employee universal unique identifier.

The system further comprises a second memory, remote from the graphical user interface, storing a plurality of message-based service interfaces derived from the common business object model to provide consistent semantics with messages derived from the common business object model, where one of the message-based service interfaces processes the message according to the hierarchical organization of the message package, where processing the message includes unpacking the first message package based on the common business object model.

Implementations can include the following. The first memory is remote from the graphical user interface. The first memory is remote from the second memory.

### BRIEF DESCRIPTION OF THE DRAWINGS

FIG. 1 depicts a flow diagram of the overall steps performed by methods and systems consistent with the subject matter described herein.

FIG. 2 depicts a business document flow for an invoice request in accordance with methods and systems consistent with the subject matter described herein.

FIGS. 3A-B illustrate example environments implementing the transmission, receipt, and processing of data between heterogeneous applications in accordance with certain embodiments included in the present disclosure.

FIG. 4 illustrates an example application implementing certain techniques and components in accordance with one embodiment of the system of FIG. 1.

FIG. 5A depicts an example development environment in accordance with one embodiment of FIG. 1.

FIG. 5B depicts a simplified process for mapping a model representation to a runtime representation using the example development environment of FIG. 5A or some other development environment.

FIG. 6 depicts message categories in accordance with methods and systems consistent with the subject matter described herein.

FIG. 7 depicts an example of a package in accordance with methods and systems consistent with the subject matter described herein.

FIG. 8 depicts another example of a package in accordance with methods and systems consistent with the subject matter described herein.

FIG. 9 depicts a third example of a package in accordance with methods and systems consistent with the subject matter described herein.

FIG. 10 depicts a fourth example of a package in accordance with methods and systems consistent with the subject matter described herein.

FIG. 11 depicts the representation of a package in the XML schema in accordance with methods and systems consistent with the subject matter described herein.

FIG. 12 depicts a graphical representation of cardinalities between two entities in accordance with methods and systems consistent with the subject matter described herein.

FIG. 13 depicts an example of a composition in accordance with methods and systems consistent with the subject matter described herein.

FIG. 14 depicts an example of a hierarchical relationship in accordance with methods and systems consistent with the subject matter described herein.

FIG. 15 depicts an example of an aggregating relationship in accordance with methods and systems consistent with the subject matter described herein.

FIG. 16 depicts an example of an association in accordance with methods and systems consistent with the subject matter described herein.

FIG. 17 depicts an example of a specialization in accordance with methods and systems consistent with the subject matter described herein.

FIG. 18 depicts the categories of specializations in accordance with methods and systems consistent with the subject matter described herein.

FIG. 19 depicts an example of a hierarchy in accordance with methods and systems consistent with the subject matter described herein.

FIG. 20 depicts a graphical representation of a hierarchy in accordance with methods and systems consistent with the subject matter described herein.

FIGS. 21A-B depict a flow diagram of the steps performed to create a business object model in accordance with methods and systems consistent with the subject matter described herein.

FIGS. 22A-F depict a flow diagram of the steps performed to generate an interface from the business object model in accordance with methods and systems consistent with the subject matter described herein.

FIG. 23 depicts an example illustrating the transmittal of a business document in accordance with methods and systems consistent with the subject matter described herein.

FIG. 24 depicts an interface proxy in accordance with methods and systems consistent with the subject matter described herein.

FIG. 25 depicts an example illustrating the transmittal of a message using proxies in accordance with methods and systems consistent with the subject matter described herein.

FIG. 26A depicts components of a message in accordance with methods and systems consistent with the subject matter described herein.

FIG. 26B depicts IDs used in a message in accordance with methods and systems consistent with the subject matter described herein.

FIGS. 27A-E depict a hierarchization process in accordance with methods and systems consistent with the subject matter described herein.

FIG. 28 illustrates an example method for service enabling in accordance with one embodiment of the present disclosure.

FIG. 29 is a graphical illustration of an example business object and associated components as may be used in the enterprise service infrastructure system of the present disclosure.

FIG. 30 illustrates an example method for managing a process agent framework in accordance with one embodiment of the present disclosure.

FIG. 31 illustrates an example method for status and action management in accordance with one embodiment of the present disclosure.

FIGS. 32-1 through 32-12 depict an example IN_EmployeePayrollInput Object Model.

FIG. 33 depicts an example IN_EmployeePayrollInputCollectionReplicationRequest Message Data Type.

FIGS. 34-1 through 34-6 depict an example IN_EmployeePayrollInputReplicationRequest Message Data Type.

FIGS. 35-1 through 35-4 depict an example IN_EmployeeRegulatoryComplianceInformationMigrateRequest Message Data Type.

FIGS. 36-1 through 36-154 depict an example IN_EmployeePayrollInputCollectionReplicationRequest Element Structure.

FIGS. 37-1 through 37-133 depict an example IN_EmployeePayrollInputReplicationRequest Element Structure.

FIGS. 38-1 through 38-20 depict an example IN_EmployeeRegulatoryComplianceInformationMigrateRequest Element Structure.

FIG. 39 depicts an example IN_EmployeeSocialInsuranceArrangement Object Model.

FIG. 40 depicts an example IN_EmployeeSocialInsuranceArrangementPayrollNotification Message Data Type.

FIGS. 41-1 through 41-10 depict an example IN_EmployeeSocialInsuranceArrangementPayrollNotification Element Structure.

FIGS. 42-1 through 42-2 depict an example IN_EmployeeTaxArrangement Object Model.

FIGS. 43-1 through 43-2 depict an example IN_EmployeeTaxArrangementPayrollNotification Message Data Type.

FIGS. 44-1 through 44-20 depict an example IN_EmployeeTaxArrangementPayrollNotification Element Structure.

### DETAILED DESCRIPTION

### A. Overview

Methods and systems consistent with the subject matter described herein facilitate e-commerce by providing consistent interfaces that are suitable for use across industries, across businesses, and across different departments within a business during a business transaction. To generate consistent interfaces, methods and systems consistent with the subject matter described herein utilize a business object model, which reflects the data that will be used during a given business transaction. An example of a business transaction is the exchange of purchase orders and order confirmations between a buyer and a seller. The business object model is generated in a hierarchical manner to ensure that the same type of data is represented the same way throughout the business object model. This ensures the consistency of the information in the business object model. Consistency is also reflected in the semantic meaning of the various structural elements. That is, each structural element has a consistent business meaning. For example, the location entity, regardless of in which package it is located, refers to a location.

From this business object model, various interfaces are derived to accomplish the functionality of the business transaction. Interfaces provide an entry point for components to access the functionality of an application. For example, the interface for a Purchase Order Request provides an entry point for components to access the functionality of a Purchase Order, in particular, to transmit and/or receive a Purchase Order Request. One skilled in the art will recognize that each of these interfaces may be provided, sold, distributed, utilized, or marketed as a separate product or as a major component of a separate product. Alternatively, a group of related interfaces may be provided, sold, distributed, utilized, or marketed as a product or as a major component of a separate product. Because the interfaces are generated from the business object model, the information in the interfaces is consistent, and the interfaces are consistent among the business entities. Such consistency facilitates heterogeneous business entities in cooperating to accomplish the business transaction.

Generally, the business object is a representation of a type of a uniquely identifiable business entity (an object instance) described by a structural model. In the architecture, processes may typically operate on business objects. Business objects represent a specific view on some well-defined business content. In other words, business objects represent content, which a typical business user would expect and understand with little explanation. Business objects are further categorized as business process objects and master data objects. A master data object is an object that encapsulates master data (i.e., data that is valid for a period of time). A business process object, which is the kind of business object generally found in a process component, is an object that encapsulates transactional data (i.e., data that is valid for a point in time). The term business object will be used generically to refer to a business process object and a master data object, unless the context requires otherwise. Properly implemented, business objects are implemented free of redundancies.

The architectural elements also include the process component. The process component is a software package that realizes a business process and generally exposes its functionality as services. The functionality contains business transactions. In general, the process component contains one or more semantically related business objects. Often, a particular business object belongs to no more than one process component. Interactions between process component pairs involving their respective business objects, process agents, operations, interfaces, and messages are described as process component interactions, which generally determine the interactions of a pair of process components across a deployment unit boundary. Interactions between process components within a deployment unit are typically not constrained by the architectural design and can be implemented in any convenient fashion. Process components may be modular and context-independent. In other words, process components may not be specific to any particular application and as such, may be reusable. In some implementations, the process component is the smallest (most granular) element of reuse in the architecture. An external process component is generally used to represent the external system in describing interactions with the external system; however, this should be understood to require no more of the external system than that able to produce and receive messages as required by the process component that interacts with the external system. For example, process components may include multiple operations that may provide interaction with the external system. Each operation generally belongs to one type of process component in the architecture. Operations can be synchronous or asynchronous, corresponding to synchronous or asynchronous process agents, which will be described below. The operation is often the smallest, separately-callable function, described by a set of data types used as input, output, and fault parameters serving as a signature.

The architectural elements may also include the service interface, referred to simply as the interface. The interface is a named group of operations. The interface often belongs to one process component and process component might contain multiple interfaces. In one implementation, the service interface contains only inbound or outbound operations, but not a mixture of both. One interface can contain both synchronous and asynchronous operations. Normally, operations of the same type (either inbound or outbound) which belong to the same message choreography will belong to the same interface. Thus, generally, all outbound operations to the same other process component are in one interface.

The architectural elements also include the message. Operations transmit and receive messages. Any convenient messaging infrastructure can be used. A message is information conveyed from one process component instance to another, with the expectation that activity will ensue. Operation can use multiple message types for inbound, outbound, or error messages. When two process components are in different deployment units, invocation of an operation of one process component by the other process component is accomplished by the operation on the other process component sending a message to the first process component.

The architectural elements may also include the process agent. Process agents do business processing that involves the sending or receiving of messages. Each operation normally has at least one associated process agent. Each process agent can be associated with one or more operations. Process agents can be either inbound or outbound and either synchronous or asynchronous. Asynchronous outbound process agents are called after a business object changes such as after a “create”, “update”, or “delete” of a business object instance. Synchronous outbound process agents are generally triggered directly by business object. An outbound process agent will generally perform some processing of the data of the business object instance whose change triggered the event. The outbound agent triggers subsequent business process steps by sending messages using well-defined outbound services to another process component, which generally will be in another deployment unit, or to an external system. The outbound process agent is linked to the one business object that triggers the agent, but it is sent not to another business object but rather to another process component. Thus, the outbound process agent can be implemented without knowledge of the exact business object design of the recipient process component. Alternatively, the process agent may be inbound. For example, inbound process agents may be used for the inbound part of a message-based communication. Inbound process agents are called after a message has been received. The inbound process agent starts the execution of the business process step requested in a message by creating or updating one or multiple business object instances. Inbound process agent is not generally the agent of business object but of its process component. Inbound process agent can act on multiple business objects in a process component. Regardless of whether the process agent is inbound or outbound, an agent may be synchronous if used when a process component requires a more or less immediate response from another process component, and is waiting for that response to continue its work.

The architectural elements also include the deployment unit. Each deployment unit may include one or more process components that are generally deployed together on a single computer system platform. Conversely, separate deployment units can be deployed on separate physical computing systems. The process components of one deployment unit can interact with those of another deployment unit using messages passed through one or more data communication networks or other suitable communication channels. Thus, a deployment unit deployed on a platform belonging to one business can interact with a deployment unit software entity deployed on a separate platform belonging to a different and unrelated business, allowing for business-to-business communication. More than one instance of a given deployment unit can execute at the same time, on the same computing system or on separate physical computing systems. This arrangement allows the functionality offered by the deployment unit to be scaled to meet demand by creating as many instances as needed.

Since interaction between deployment units is through process component operations, one deployment unit can be replaced by other another deployment unit as long as the new deployment unit supports the operations depended upon by other deployment units as appropriate. Thus, while deployment units can depend on the external interfaces of process components in other deployment units, deployment units are not dependent on process component interaction within other deployment units. Similarly, process components that interact with other process components or external systems only through messages, e.g., as sent and received by operations, can also be replaced as long as the replacement generally supports the operations of the original.

Services (or interfaces) may be provided in a flexible architecture to support varying criteria between services and systems. The flexible architecture may generally be provided by a service delivery business object. The system may be able to schedule a service asynchronously as necessary, or on a regular basis. Services may be planned according to a schedule manually or automatically. For example, a follow-up service may be scheduled automatically upon completing an initial service. In addition, flexible execution periods may be possible (e.g. hourly, daily, every three months, etc.). Each customer may plan the services on demand or reschedule service execution upon request.

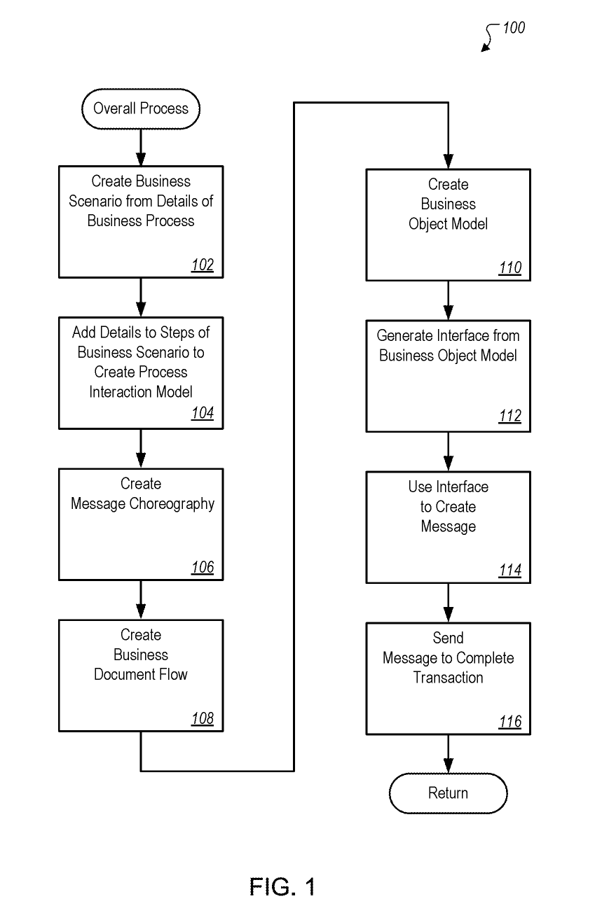

FIG. 1 depicts a flow diagram 100 showing an example technique, perhaps implemented by systems similar to those disclosed herein. Initially, to generate the business object model, design engineers study the details of a business process, and model the business process using a “business scenario” (step 102). The business scenario identifies the steps performed by the different business entities during a business process. Thus, the business scenario is a complete representation of a clearly defined business process.

After creating the business scenario, the developers add details to each step of the business scenario (step 104). In particular, for each step of the business scenario, the developers identify the complete process steps performed by each business entity. A discrete portion of the business scenario reflects a “business transaction,” and each business entity is referred to as a “component” of the business transaction. The developers also identify the messages that are transmitted between the components. A “process interaction model” represents the complete process steps between two components.

After creating the process interaction model, the developers create a “message choreography” (step 106), which depicts the messages transmitted between the two components in the process interaction model. The developers then represent the transmission of the messages between the components during a business process in a “business document flow” (step 108). Thus, the business document flow illustrates the flow of information between the business entities during a business process.

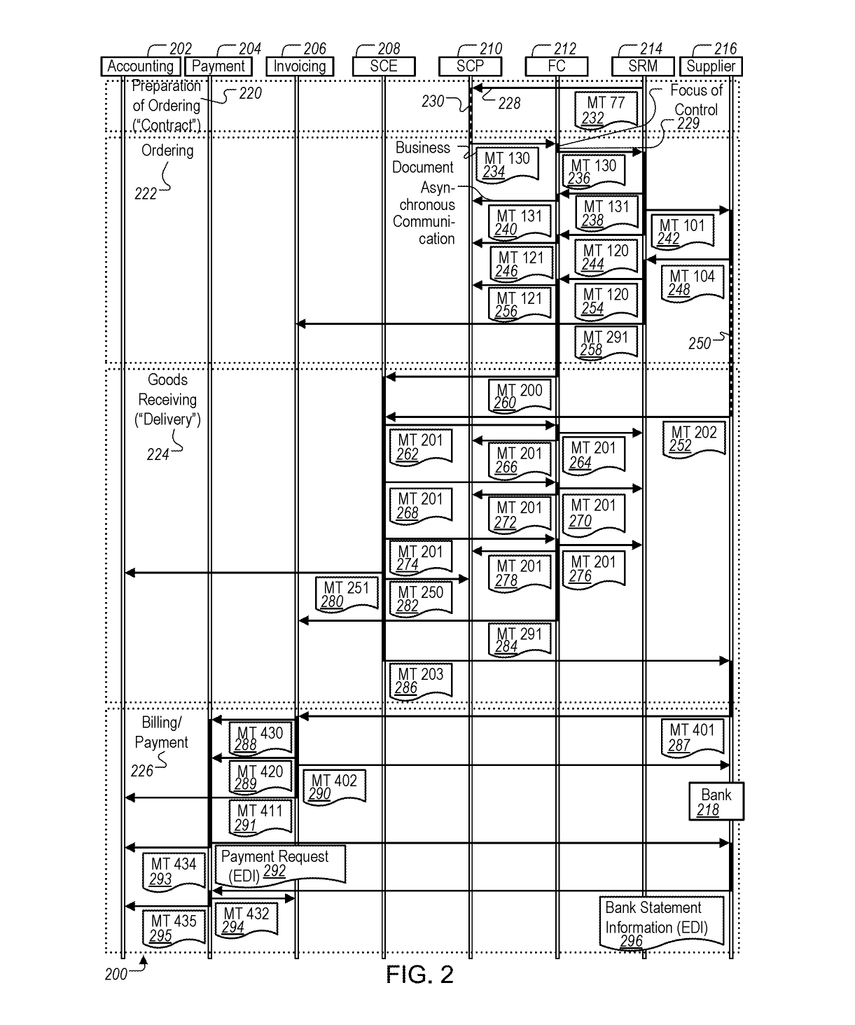

FIG. 2 depicts an example business document flow 200 for the process of purchasing a product or service. The business entities involved with the illustrative purchase process include Accounting 202, Payment 204, Invoicing 206, Supply Chain Execution (“SCE”) 208, Supply Chain Planning (“SCP”) 210, Fulfillment Coordination (“FC”) 212, Supply Relationship Management (“SRM”) 214, Supplier 216, and Bank 218. The business document flow 200 is divided into four different transactions: Preparation of Ordering (“Contract”) 220, Ordering 222, Goods Receiving (“Delivery”) 224, and Billing/Payment 226. In the business document flow, arrows 228 represent the transmittal of documents. Each document reflects a message transmitted between entities. One of ordinary skill in the art will appreciate that the messages transferred may be considered to be a communications protocol. The process flow follows the focus of control, which is depicted as a solid vertical line (e.g., 229) when the step is required, and a dotted vertical line (e.g., 230) when the step is optional.

During the Contract transaction 220, the SRM 214 sends a Source of Supply Notification 232 to the SCP 210. This step is optional, as illustrated by the optional control line 230 coupling this step to the remainder of the business document flow 200. During the Ordering transaction 222, the SCP 210 sends a Purchase Requirement Request 234 to the FC 212, which forwards a Purchase Requirement Request 236 to the SRM 214. The SRM 214 then sends a Purchase Requirement Confirmation 238 to the FC 212, and the FC 212 sends a Purchase Requirement Confirmation 240 to the SCP 210. The SRM 214 also sends a Purchase Order Request 242 to the Supplier 216, and sends Purchase Order Information 244 to the FC 212. The FC 212 then sends a Purchase Order Planning Notification 246 to the SCP 210. The Supplier 216, after receiving the Purchase Order Request 242, sends a Purchase Order Confirmation 248 to the SRM 214, which sends a Purchase Order Information confirmation message 254 to the FC 212, which sends a message 256 confirming the Purchase Order Planning Notification to the SCP 210. The SRM 214 then sends an Invoice Due Notification 258 to Invoicing 206.

During the Delivery transaction 224, the FC 212 sends a Delivery Execution Request 260 to the SCE 208. The Supplier 216 could optionally (illustrated at control line 250) send a Dispatched Delivery Notification 252 to the SCE 208. The SCE 208 then sends a message 262 to the FC 212 notifying the FC 212 that the request for the Delivery Information was created. The FC 212 then sends a message 264 notifying the SRM 214 that the request for the Delivery Information was created. The FC 212 also sends a message 266 notifying the SCP 210 that the request for the Delivery Information was created. The SCE 208 sends a message 268 to the FC 212 when the goods have been set aside for delivery. The FC 212 sends a message 270 to the SRM 214 when the goods have been set aside for delivery. The FC 212 also sends a message 272 to the SCP 210 when the goods have been set aside for delivery.

The SCE 208 sends a message 274 to the FC 212 when the goods have been delivered. The FC 212 then sends a message 276 to the SRM 214 indicating that the goods have been delivered, and sends a message 278 to the SCP 210 indicating that the goods have been delivered. The SCE 208 then sends an Inventory Change Accounting Notification 280 to Accounting 202, and an Inventory Change Notification 282 to the SCP 210. The FC 212 sends an Invoice Due Notification 284 to Invoicing 206, and SCE 208 sends a Received Delivery Notification 286 to the Supplier 216.

During the Billing/Payment transaction 226, the Supplier 216 sends an Invoice Request 287 to Invoicing 206. Invoicing 206 then sends a Payment Due Notification 288 to Payment 204, a Tax Due Notification 289 to Payment 204, an Invoice Confirmation 290 to the Supplier 216, and an Invoice Accounting Notification 291 to Accounting 202. Payment 204 sends a Payment Request 292 to the Bank 218, and a Payment Requested Accounting Notification 293 to Accounting 202. Bank 218 sends a Bank Statement Information 296 to Payment 204. Payment 204 then sends a Payment Done Information 294 to Invoicing 206 and a Payment Done Accounting Notification 295 to Accounting 202.

Within a business document flow, business documents having the same or similar structures are marked. For example, in the business document flow 200 depicted in FIG. 2, Purchase Requirement Requests 234, 236 and Purchase Requirement Confirmations 238, 240 have the same structures. Thus, each of these business documents is marked with an “O6.” Similarly, Purchase Order Request 242 and Purchase Order Confirmation 248 have the same structures. Thus, both documents are marked with an “O1.” Each business document or message is based on a message type.

From the business document flow, the developers identify the business documents having identical or similar structures, and use these business documents to create the business object model (step 110). The business object model includes the objects contained within the business documents. These objects are reflected as packages containing related information, and are arranged in a hierarchical structure within the business object model, as discussed below.

Methods and systems consistent with the subject matter described herein then generate interfaces from the business object model (step 112). The heterogeneous programs use instantiations of these interfaces (called “business document objects” below) to create messages (step 114), which are sent to complete the business transaction (step 116). Business entities use these messages to exchange information with other business entities during an end-to-end business transaction. Since the business object model is shared by heterogeneous programs, the interfaces are consistent among these programs. The heterogeneous programs use these consistent interfaces to communicate in a consistent manner, thus facilitating the business transactions.

Standardized Business-to-Business (“B2B”) messages are compliant with at least one of the e-business standards (i.e., they include the business-relevant fields of the standard). The e-business standards include, for example, RosettaNet for the high-tech industry, Chemical Industry Data Exchange (“CIDX”), Petroleum Industry Data Exchange (“PIDX”) for the oil industry, UCCnet for trade, PapiNet for the paper industry, Odette for the automotive industry, HR-XML for human resources, and XML Common Business Library (“xCBL”). Thus, B2B messages enable simple integration of components in heterogeneous system landscapes. Application-to-Application (“A2A”) messages often exceed the standards and thus may provide the benefit of the full functionality of application components. Although various steps of FIG. 1 were described as being performed manually, one skilled in the art will appreciate that such steps could be computer-assisted or performed entirely by a computer, including being performed by either hardware, software, or any other combination thereof.

### B. Implementation Details

As discussed above, methods and systems consistent with the subject matter described herein create consistent interfaces by generating the interfaces from a business object model. Details regarding the creation of the business object model, the generation of an interface from the business object model, and the use of an interface generated from the business object model are provided below.

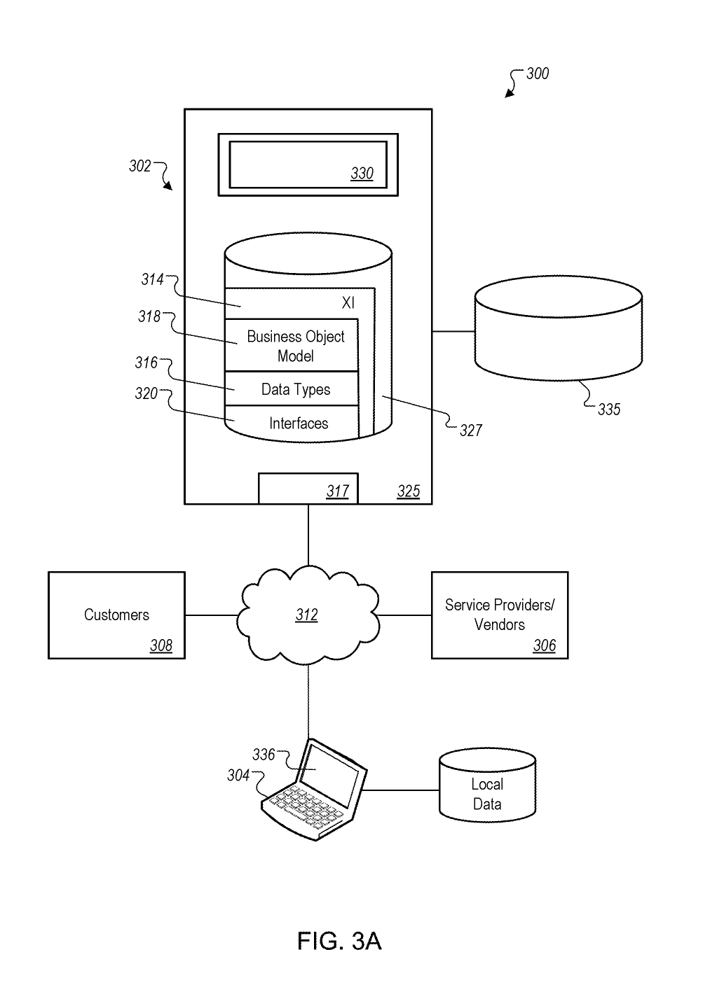

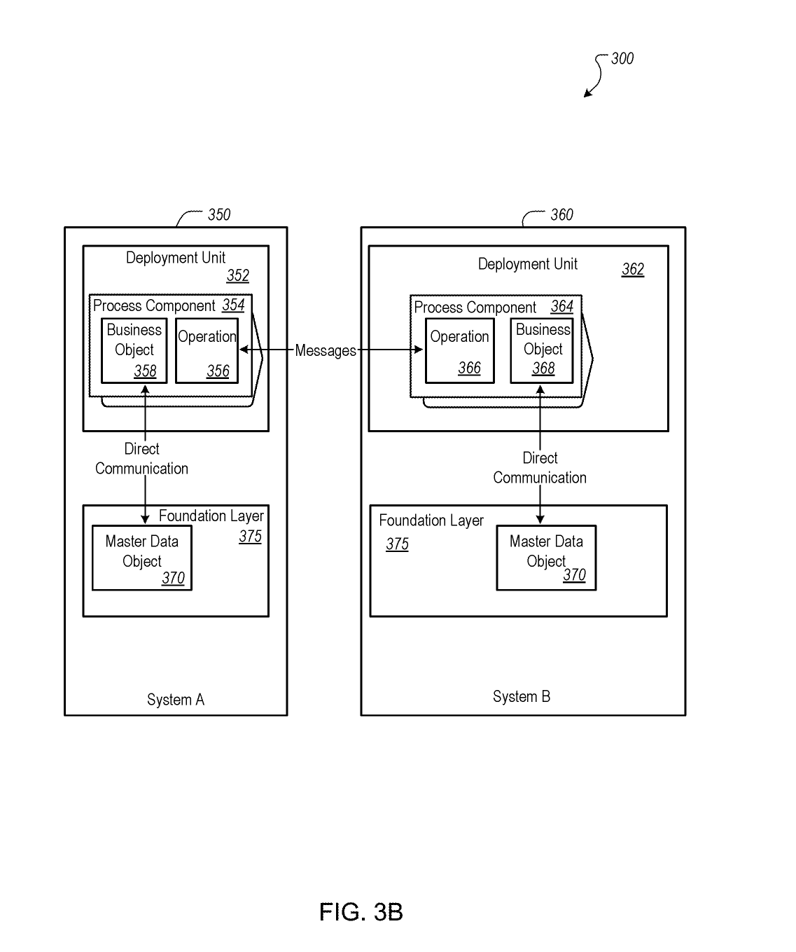

Turning to the illustrated embodiment in FIG. 3A, environment 300 includes or is communicably coupled (such as via a one-, bi- or multi-directional link or network) with server 302, one or more clients 304, one or more or vendors 306, one or more customers 308, at least some of which communicate across network 312. But, of course, this illustration is for example purposes only, and any distributed system or environment implementing one or more of the techniques described herein may be within the scope of this disclosure. Server 302 comprises an electronic computing device operable to receive, transmit, process and store data associated with environment 300. Generally, FIG. 3A provides merely one example of computers that may be used with the disclosure. Each computer is generally intended to encompass any suitable processing device. For example, although FIG. 3A illustrates one server 302 that may be used with the disclosure, environment 300 can be implemented using computers other than servers, as well as a server pool. Indeed, server 302 may be any computer or processing device such as, for example, a blade server, general-purpose personal computer (PC), Macintosh, workstation, Unix-based computer, or any other suitable device. In other words, the present disclosure contemplates computers other than general purpose computers as well as computers without conventional operating systems. Server 302 may be adapted to execute any operating system including Linux, UNIX, Windows Server, or any other suitable operating system. According to one embodiment, server 302 may also include or be communicably coupled with a web server and/or a mail server.

As illustrated (but not required), the server 302 is communicably coupled with a relatively remote repository 335 over a portion of the network 312. The repository 335 is any electronic storage facility, data processing center, or archive that may supplement or replace local memory (such as 327). The repository 335 may be a central database communicably coupled with the one or more servers 302 and the clients 304 via a virtual private network (VPN), SSH (Secure Shell) tunnel, or other secure network connection. The repository 335 may be physically or logically located at any appropriate location including in one of the example enterprises or off-shore, so long as it remains operable to store information associated with the environment 300 and communicate such data to the server 302 or at least a subset of plurality of the clients 304.

Illustrated server 302 includes local memory 327. Memory 327 may include any memory or database module and may take the form of volatile or non-volatile memory including, without limitation, magnetic media, optical media, random access memory (RAM), read-only memory (ROM), removable media, or any other suitable local or remote memory component. Illustrated memory 327 includes an exchange infrastructure (“XI”) 314, which is an infrastructure that supports the technical interaction of business processes across heterogeneous system environments. XI 314 centralizes the communication between components within a business entity and between different business entities. When appropriate, XI 314 carries out the mapping between the messages. XI 314 integrates different versions of systems implemented on different platforms (e.g., Java and ABAP). XI 314 is based on an open architecture, and makes use of open standards, such as eXtensible Markup Language (XML)™ and Java environments. XI 314 offers services that are useful in a heterogeneous and complex system landscape. In particular, XI 314 offers a runtime infrastructure for message exchange, configuration options for managing business processes and message flow, and options for transforming message contents between sender and receiver systems.

XI 314 stores data types 316, a business object model 318, and interfaces 320. The details regarding the business object model are described below. Data types 316 are the building blocks for the business object model 318. The business object model 318 is used to derive consistent interfaces 320. XI 314 allows for the exchange of information from a first company having one computer system to a second company having a second computer system over network 312 by using the standardized interfaces 320.

While not illustrated, memory 327 may also include business objects and any other appropriate data such as services, interfaces, VPN applications or services, firewall policies, a security or access log, print or other reporting files, HTML files or templates, data classes or object interfaces, child software applications or sub-systems, and others. This stored data may be stored in one or more logical or physical repositories. In some embodiments, the stored data (or pointers thereto) may be stored in one or more tables in a relational database described in terms of SQL statements or scripts. In the same or other embodiments, the stored data may also be formatted, stored, or defined as various data structures in text files, XML documents, Virtual Storage Access Method (VSAM) files, flat files, Btrieve files, comma-separated-value (CSV) files, internal variables, or one or more libraries. For example, a particular data service record may merely be a pointer to a particular piece of third party software stored remotely. In another example, a particular data service may be an internally stored software object usable by authenticated customers or internal development. In short, the stored data may comprise one table or file or a plurality of tables or files stored on one computer or across a plurality of computers in any appropriate format. Indeed, some or all of the stored data may be local or remote without departing from the scope of this disclosure and store any type of appropriate data.

Server 302 also includes processor 325. Processor 325 executes instructions and manipulates data to perform the operations of server 302 such as, for example, a central processing unit (CPU), a blade, an application specific integrated circuit (ASIC), or a field-programmable gate array (FPGA). Although FIG. 3A illustrates a single processor 325 in server 302, multiple processors 325 may be used according to particular needs and reference to processor 325 is meant to include multiple processors 325 where applicable. In the illustrated embodiment, processor 325 executes at least business application 330.

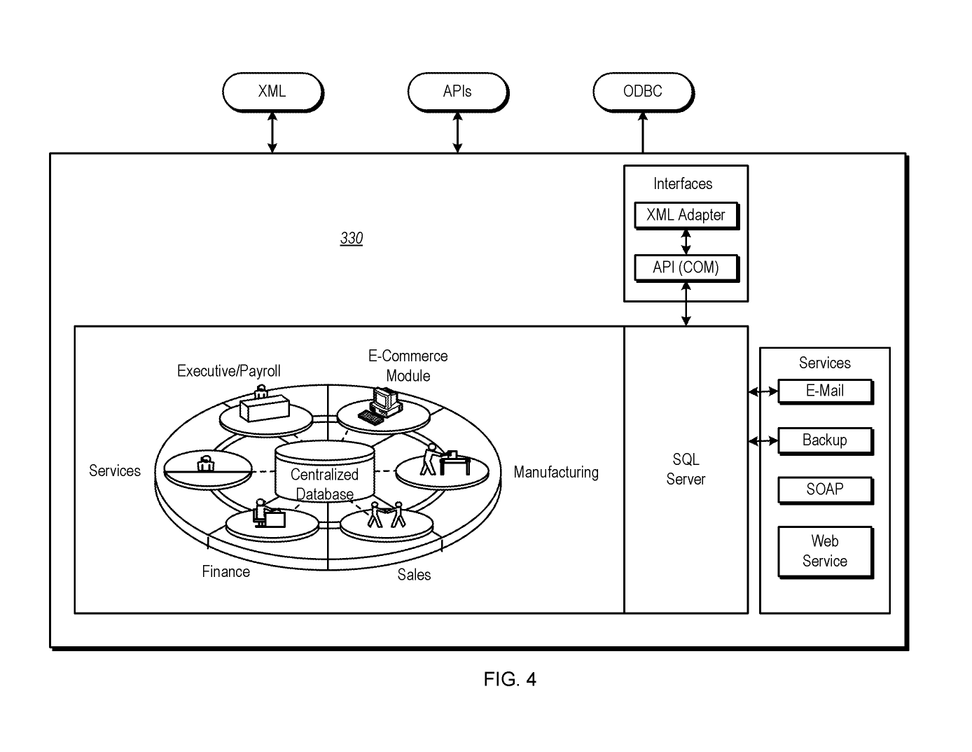

At a high level, business application 330 is any application, program, module, process, or other software that utilizes or facilitates the exchange of information via messages (or services) or the use of business objects. For example, application 330 may implement, utilize or otherwise leverage an enterprise service-oriented architecture (enterprise SOA), which may be considered a blueprint for an adaptable, flexible, and open IT architecture for developing services-based, enterprise-scale business solutions. This example enterprise service may be a series of web services combined with business logic that can be accessed and used repeatedly to support a particular business process. Aggregating web services into business-level enterprise services helps provide a more meaningful foundation for the task of automating enterprise-scale business scenarios Put simply, enterprise services help provide a holistic combination of actions that are semantically linked to complete the specific task, no matter how many cross-applications are involved. In certain cases, environment 300 may implement a composite application 330, as described below in FIG. 4. Regardless of the particular implementation, “software” may include software, firmware, wired or programmed hardware, or any combination thereof as appropriate. Indeed, application 330 may be written or described in any appropriate computer language including C, C++, Java, Visual Basic, assembler, Perl, any suitable version of 4GL, as well as others. For example, returning to the above mentioned composite application, the composite application portions may be implemented as Enterprise Java Beans (EJBs) or the design-time components may have the ability to generate run-time implementations into different platforms, such as J2EE (Java 2 Platform, Enterprise Edition), ABAP (Advanced Business Application Programming) objects, or Microsoft's .NET. It will be understood that while application 330 is illustrated in FIG. 4 as including various sub-modules, application 330 may include numerous other sub-modules or may instead be a single multi-tasked module that implements the various features and functionality through various objects, methods, or other processes. Further, while illustrated as internal to server 302, one or more processes associated with application 330 may be stored, referenced, or executed remotely. For example, a portion of application 330 may be a web service that is remotely called, while another portion of application 330 may be an interface object bundled for processing at remote client 304. Moreover, application 330 may be a child or sub-module of another software module or enterprise application (not illustrated) without departing from the scope of this disclosure. Indeed, application 330 may be a hosted solution that allows multiple related or third parties in different portions of the process to perform the respective processing.

More specifically, as illustrated in FIG. 4, application 330 may be a composite application, or an application built on other applications, that includes an object access layer (OAL) and a service layer. In this example, application 330 may execute or provide a number of application services, such as customer relationship management (CRM) systems, human resources management (HRM) systems, financial management (FM) systems, project management (PM) systems, knowledge management (KM) systems, and electronic file and mail systems. Such an object access layer is operable to exchange data with a plurality of enterprise base systems and to present the data to a composite application through a uniform interface. The example service layer is operable to provide services to the composite application. These layers may help the composite application to orchestrate a business process in synchronization with other existing processes (e.g., native processes of enterprise base systems) and leverage existing investments in the IT platform. Further, composite application 330 may run on a heterogeneous IT platform. In doing so, composite application may be cross-functional in that it may drive business processes across different applications, technologies, and organizations. Accordingly, composite application 330 may drive end-to-end business processes across heterogeneous systems or sub-systems. Application 330 may also include or be coupled with a persistence layer and one or more application system connectors. Such application system connectors enable data exchange and integration with enterprise sub-systems and may include an Enterprise Connector (EC) interface, an Internet Communication Manager/Internet Communication Framework (ICM/ICF) interface, an Encapsulated PostScript (EPS) interface, and/or other interfaces that provide Remote Function Call (RFC) capability. It will be understood that while this example describes a composite application 330, it may instead be a standalone or (relatively) simple software program. Regardless, application 330 may also perform processing automatically, which may indicate that the appropriate processing is substantially performed by at least one component of environment 300. It should be understood that automatically further contemplates any suitable administrator or other user interaction with application 330 or other components of environment 300 without departing from the scope of this disclosure.

Returning to FIG. 3A, illustrated server 302 may also include interface 317 for communicating with other computer systems, such as clients 304, over network 312 in a client-server or other distributed environment. In certain embodiments, server 302 receives data from internal or external senders through interface 317 for storage in memory 327, for storage in DB 335, and/or processing by processor 325. Generally, interface 317 comprises logic encoded in software and/or hardware in a suitable combination and operable to communicate with network 312. More specifically, interface 317 may comprise software supporting one or more communications protocols associated with communications network 312 or hardware operable to communicate physical signals.

Network 312 facilitates wireless or wireline communication between computer server 302 and any other local or remote computer, such as clients 304. Network 312 may be all or a portion of an enterprise or secured network. In another example, network 312 may be a VPN merely between server 302 and client 304 across wireline or wireless link. Such an example wireless link may be via 802.11a, 802.11b, 802.11g, 802.20, WiMax, and many others. While illustrated as a single or continuous network, network 312 may be logically divided into various sub-nets or virtual networks without departing from the scope of this disclosure, so long as at least portion of network 312 may facilitate communications between server 302 and at least one client 304. For example, server 302 may be communicably coupled to one or more “local” repositories through one sub-net while communicably coupled to a particular client 304 or “remote” repositories through another. In other words, network 312 encompasses any internal or external network, networks, sub-network, or combination thereof operable to facilitate communications between various computing components in environment 300. Network 312 may communicate, for example, Internet Protocol (IP) packets, Frame Relay frames, Asynchronous Transfer Mode (ATM) cells, voice, video, data, and other suitable information between network addresses. Network 312 may include one or more local area networks (LANs), radio access networks (RANs), metropolitan area networks (MANs), wide area networks (WANs), all or a portion of the global computer network known as the Internet, and/or any other communication system or systems at one or more locations. In certain embodiments, network 312 may be a secure network associated with the enterprise and certain local or remote vendors 306 and customers 308. As used in this disclosure, customer 308 is any person, department, organization, small business, enterprise, or any other entity that may use or request others to use environment 300. As described above, vendors 306 also may be local or remote to customer 308. Indeed, a particular vendor 306 may provide some content to business application 330, while receiving or purchasing other content (at the same or different times) as customer 308. As illustrated, customer 308 and vendor 06 each typically perform some processing (such as uploading or purchasing content) using a computer, such as client 304.

Client 304 is any computing device operable to connect or communicate with server 302 or network 312 using any communication link. For example, client 304 is intended to encompass a personal computer, touch screen terminal, workstation, network computer, kiosk, wireless data port, smart phone, personal data assistant (PDA), one or more processors within these or other devices, or any other suitable processing device used by or for the benefit of business 308, vendor 306, or some other user or entity. At a high level, each client 304 includes or executes at least GUI 336 and comprises an electronic computing device operable to receive, transmit, process and store any appropriate data associated with environment 300. It will be understood that there may be any number of clients 304 communicably coupled to server 302. Further, “client 304,” “business,” “business analyst,” “end user,” and “user” may be used interchangeably as appropriate without departing from the scope of this disclosure. Moreover, for ease of illustration, each client 304 is described in terms of being used by one user. But this disclosure contemplates that many users may use one computer or that one user may use multiple computers. For example, client 304 may be a PDA operable to wirelessly connect with external or unsecured network. In another example, client 304 may comprise a laptop that includes an input device, such as a keypad, touch screen, mouse, or other device that can accept information, and an output device that conveys information associated with the operation of server 302 or clients 304, including digital data, visual information, or GUI 336. Both the input device and output device may include fixed or removable storage media such as a magnetic computer disk, CD-ROM, or other suitable media to both receive input from and provide output to users of clients 304 through the display, namely the client portion of GUI or application interface 336.

GUI 336 comprises a graphical user interface operable to allow the user of client 304 to interface with at least a portion of environment 300 for any suitable purpose, such as viewing application or other transaction data. Generally, GUI 336 provides the particular user with an efficient and user-friendly presentation of data provided by or communicated within environment 300. For example, GUI 336 may present the user with the components and information that is relevant to their task, increase reuse of such components, and facilitate a sizable developer community around those components. GUI 336 may comprise a plurality of customizable frames or views having interactive fields, pull-down lists, and buttons operated by the user. For example, GUI 336 is operable to display data involving business objects and interfaces in a user-friendly form based on the user context and the displayed data. In another example, GUI 336 is operable to display different levels and types of information involving business objects and interfaces based on the identified or supplied user role. GUI 336 may also present a plurality of portals or dashboards. For example, GUI 336 may display a portal that allows users to view, create, and manage historical and real-time reports including role-based reporting and such. Of course, such reports may be in any appropriate output format including PDF, HTML, and printable text. Real-time dashboards often provide table and graph information on the current state of the data, which may be supplemented by business objects and interfaces. It should be understood that the term graphical user interface may be used in the singular or in the plural to describe one or more graphical user interfaces and each of the displays of a particular graphical user interface. Indeed, reference to GUI 336 may indicate a reference to the front-end or a component of business application 330, as well as the particular interface accessible via client 304, as appropriate, without departing from the scope of this disclosure. Therefore, GUI 336 contemplates any graphical user interface, such as a generic web browser or touchscreen, that processes information in environment 300 and efficiently presents the results to the user. Server 302 can accept data from client 304 via the web browser (e.g., Microsoft Internet Explorer or Netscape Navigator) and return the appropriate HTML or XML responses to the browser using network 312.

More generally in environment 300 as depicted in FIG. 3B, a Foundation Layer 375 can be deployed on multiple separate and distinct hardware platforms, e.g., System A 350 and System B 360, to support application software deployed as two or more deployment units distributed on the platforms, including deployment unit 352 deployed on System A and deployment unit 362 deployed on System B. In this example, the foundation layer can be used to support application software deployed in an application layer. In particular, the foundation layer can be used in connection with application software implemented in accordance with a software architecture that provides a suite of enterprise service operations having various application functionality. In some implementations, the application software is implemented to be deployed on an application platform that includes a foundation layer that contains all fundamental entities that can used from multiple deployment units. These entities can be process components, business objects, and reuse service components. A reuse service component is a piece of software that is reused in different transactions. A reuse service component is used by its defined interfaces, which can be, e.g., local APIs or service interfaces. As explained above, process components in separate deployment units interact through service operations, as illustrated by messages passing between service operations 356 and 366, which are implemented in process components 354 and 364, respectively, which are included in deployment units 352 and 362, respectively. As also explained above, some form of direct communication is generally the form of interaction used between a business object, e.g., business object 358 and 368, of an application deployment unit and a business object, such as master data object 370, of the Foundation Layer 375.

Various components of the present disclosure may be modeled using a model-driven environment. For example, the model-driven framework or environment may allow the developer to use simple drag-and-drop techniques to develop pattern-based or freestyle user interfaces and define the flow of data between them. The result could be an efficient, customized, visually rich online experience. In some cases, this model-driven development may accelerate the application development process and foster business-user self-service. It further enables business analysts or IT developers to compose visually rich applications that use analytic services, enterprise services, remote function calls (RFCs), APIs, and stored procedures. In addition, it may allow them to reuse existing applications and create content using a modeling process and a visual user interface instead of manual coding.

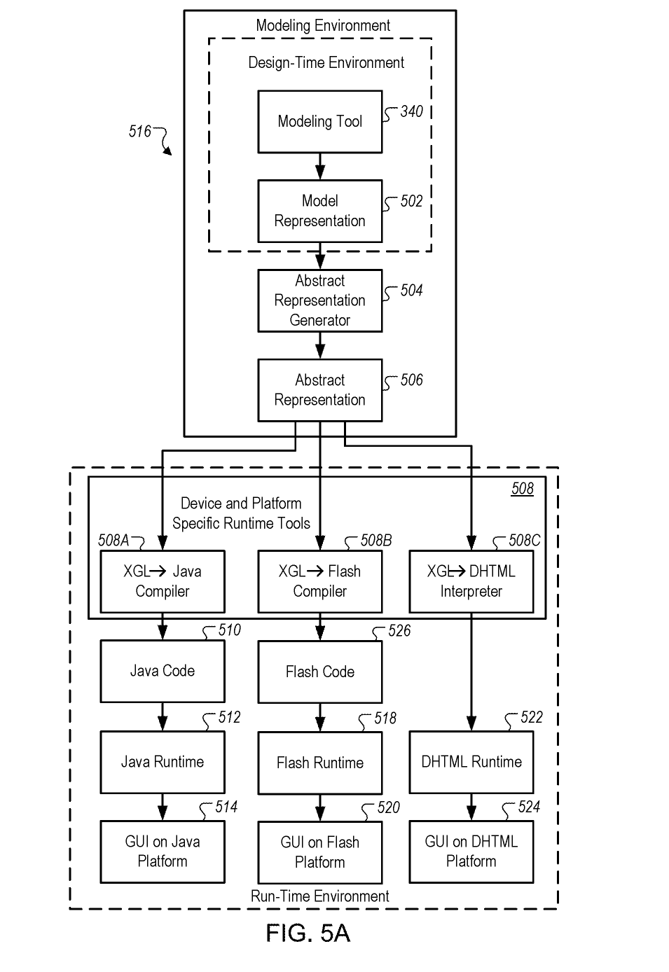

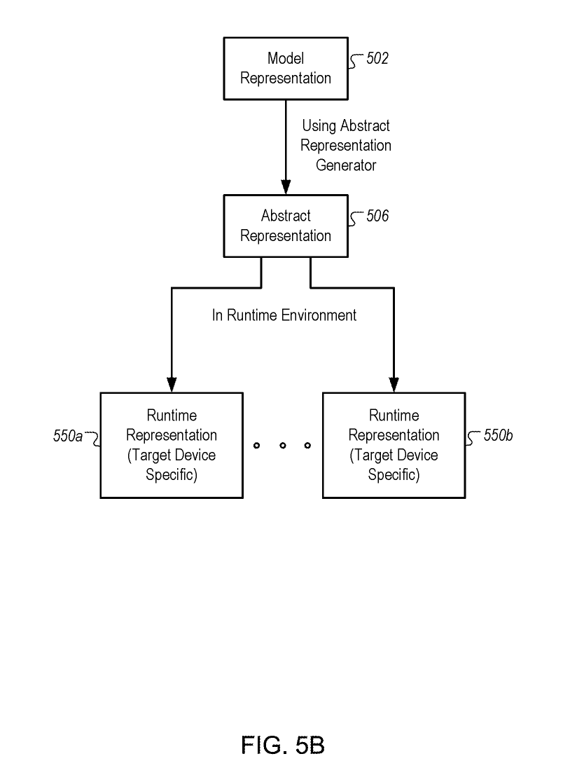

FIG. 5A depicts an example modeling environment 516, namely a modeling environment, in accordance with one embodiment of the present disclosure. Thus, as illustrated in FIG. 5A, such a modeling environment 516 may implement techniques for decoupling models created during design-time from the runtime environment. In other words, model representations for GUIs created in a design time environment are decoupled from the runtime environment in which the GUIs are executed. Often in these environments, a declarative and executable representation for GUIs for applications is provided that is independent of any particular runtime platform, GUI framework, device, or programming language.

According to some embodiments, a modeler (or other analyst) may use the model-driven modeling environment 516 to create pattern-based or freestyle user interfaces using simple drag-and-drop services. Because this development may be model-driven, the modeler can typically compose an application using models of business objects without having to write much, if any, code. In some cases, this example modeling environment 516 may provide a personalized, secure interface that helps unify enterprise applications, information, and processes into a coherent, role-based portal experience. Further, the modeling environment 516 may allow the developer to access and share information and applications in a collaborative environment. In this way, virtual collaboration rooms allow developers to work together efficiently, regardless of where they are located, and may enable powerful and immediate communication that crosses organizational boundaries while enforcing security requirements. Indeed, the modeling environment 516 may provide a shared set of services for finding, organizing, and accessing unstructured content stored in third-party repositories and content management systems across various networks 312. Classification tools may automate the organization of information, while subject-matter experts and content managers can publish information to distinct user audiences. Regardless of the particular implementation or architecture, this modeling environment 516 may allow the developer to easily model hosted business objects 140 using this model-driven approach.

In certain embodiments, the modeling environment 516 may implement or utilize a generic, declarative, and executable GUI language (generally described as XGL). This example XGL is generally independent of any particular GUI framework or runtime platform. Further, XGL is normally not dependent on characteristics of a target device on which the graphic user interface is to be displayed and may also be independent of any programming language. XGL is used to generate a generic representation (occasionally referred to as the XGL representation or XGL-compliant representation) for a design-time model representation. The XGL representation is thus typically a device-independent representation of a GUI. The XGL representation is declarative in that the representation does not depend on any particular GUI framework, runtime platform, device, or programming language. The XGL representation can be executable and therefore can unambiguously encapsulate execution semantics for the GUI described by a model representation. In short, models of different types can be transformed to XGL representations.

The XGL representation may be used for generating representations of various different GUIs and supports various GUI features including full windowing and componentization support, rich data visualizations and animations, rich modes of data entry and user interactions, and flexible connectivity to any complex application data services. While a specific embodiment of XGL is discussed, various other types of XGLs may also be used in alternative embodiments. In other words, it will be understood that XGL is used for example description only and may be read to include any abstract or modeling language that can be generic, declarative, and executable.

Turning to the illustrated embodiment in FIG. 5A, modeling tool 340 may be used by a GUI designer or business analyst during the application design phase to create a model representation 502 for a GUI application. It will be understood that modeling environment 516 may include or be compatible with various different modeling tools 340 used to generate model representation 502. This model representation 502 may be a machine-readable representation of an application or a domain specific model. Model representation 502 generally encapsulates various design parameters related to the GUI such as GUI components, dependencies between the GUI components, inputs and outputs, and the like. Put another way, model representation 502 provides a form in which the one or more models can be persisted and transported, and possibly handled by various tools such as code generators, runtime interpreters, analysis and validation tools, merge tools, and the like. In one embodiment, model representation 502 maybe a collection of XML documents with a well-formed syntax.

Illustrated modeling environment 516 also includes an abstract representation generator (or XGL generator) 504 operable to generate an abstract representation (for example, XGL representation or XGL-compliant representation) 506 based upon model representation 502. Abstract representation generator 504 takes model representation 502 as input and outputs abstract representation 506 for the model representation. Model representation 502 may include multiple instances of various forms or types depending on the tool/language used for the modeling. In certain cases, these various different model representations may each be mapped to one or more abstract representations 506. Different types of model representations may be transformed or mapped to XGL representations. For each type of model representation, mapping rules may be provided for mapping the model representation to the XGL representation 506. Different mapping rules may be provided for mapping a model representation to an XGL representation.

This XGL representation 506 that is created from a model representation may then be used for processing in the runtime environment. For example, the XGL representation 506 may be used to generate a machine-executable runtime GUI (or some other runtime representation) that may be executed by a target device. As part of the runtime processing, the XGL representation 506 may be transformed into one or more runtime representations, which may indicate source code in a particular programming language, machine-executable code for a specific runtime environment, executable GUI, and so forth, which may be generated for specific runtime environments and devices. Since the XGL representation 506, rather than the design-time model representation, is used by the runtime environment, the design-time model representation is decoupled from the runtime environment. The XGL representation 506 can thus serve as the common ground or interface between design-time user interface modeling tools and a plurality of user interface runtime frameworks. It provides a self-contained, closed, and deterministic definition of all aspects of a graphical user interface in a device-independent and programming-language independent manner. Accordingly, abstract representation 506 generated for a model representation 502 is generally declarative and executable in that it provides a representation of the GUI of model representation 502 that is not dependent on any device or runtime platform, is not dependent on any programming language, and unambiguously encapsulates execution semantics for the GUI. The execution semantics may include, for example, identification of various components of the GUI, interpretation of connections between the various GUI components, information identifying the order of sequencing of events, rules governing dynamic behavior of the GUI, rules governing handling of values by the GUI, and the like. The abstract representation 506 is also not GUI runtime-platform specific. The abstract representation 506 provides a self-contained, closed, and deterministic definition of all aspects of a graphical user interface that is device independent and language independent.

Abstract representation 506 is such that the appearance and execution semantics of a GUI generated from the XGL representation work consistently on different target devices irrespective of the GUI capabilities of the target device and the target device platform. For example, the same XGL representation may be mapped to appropriate GUIs on devices of differing levels of GUI complexity (i.e., the same abstract representation may be used to generate a GUI for devices that support simple GUIs and for devices that can support complex GUIs), the GUI generated by the devices are consistent with each other in their appearance and behavior.

Abstract representation generator 504 may be configured to generate abstract representation 506 for models of different types, which may be created using different modeling tools 340. It will be understood that modeling environment 516 may include some, none, or other sub-modules or components as those shown in this example illustration. In other words, modeling environment 516 encompasses the design-time environment (with or without the abstract generator or the various representations), a modeling toolkit (such as 340) linked with a developer's space, or any other appropriate software operable to decouple models created during design-time from the runtime environment. Abstract representation 506 provides an interface between the design time environment and the runtime environment. As shown, this abstract representation 506 may then be used by runtime processing.

As part of runtime processing, modeling environment 516 may include various runtime tools 508 and may generate different types of runtime representations based upon the abstract representation 506. Examples of runtime representations include device or language-dependent (or specific) source code, runtime platform-specific machine-readable code, GUIs for a particular target device, and the like. The runtime tools 508 may include compilers, interpreters, source code generators, and other such tools that are configured to generate runtime platform-specific or target device-specific runtime representations of abstract representation 506. The runtime tool 508 may generate the runtime representation from abstract representation 506 using specific rules that map abstract representation 506 to a particular type of runtime representation. These mapping rules may be dependent on the type of runtime tool, characteristics of the target device to be used for displaying the GUI, runtime platform, and/or other factors. Accordingly, mapping rules may be provided for transforming the abstract representation 506 to any number of target runtime representations directed to one or more target GUI runtime platforms. For example, XGL-compliant code generators may conform to semantics of XGL, as described below. XGL-compliant code generators may ensure that the appearance and behavior of the generated user interfaces is preserved across a plurality of target GUI frameworks, while accommodating the differences in the intrinsic characteristics of each and also accommodating the different levels of capability of target devices.

For example, as depicted in example FIG. 5A, an XGL-to-Java compiler 508A may take abstract representation 506 as input and generate Java code 510 for execution by a target device comprising a Java runtime 512. Java runtime 512 may execute Java code 510 to generate or display a GUI 514 on a Java-platform target device. As another example, an XGL-to-Flash compiler 508B may take abstract representation 506 as input and generate Flash code 526 for execution by a target device comprising a Flash runtime 518. Flash runtime 518 may execute Flash code 516 to generate or display a GUI 520 on a target device comprising a Flash platform. As another example, an XGL-to-DHTML (dynamic HTML) interpreter 508C may take abstract representation 506 as input and generate DHTML statements (instructions) on the fly which are then interpreted by a DHTML runtime 522 to generate or display a GUI 524 on a target device comprising a DHTML platform.

It should be apparent that abstract representation 506 may be used to generate GUIs for Extensible Application Markup Language (XAML) or various other runtime platforms and devices. The same abstract representation 506 may be mapped to various runtime representations and device-specific and runtime platform-specific GUIs. In general, in the runtime environment, machine executable instructions specific to a runtime environment may be generated based upon the abstract representation 506 and executed to generate a GUI in the runtime environment. The same XGL representation may be used to generate machine executable instructions specific to different runtime environments and target devices.

According to certain embodiments, the process of mapping a model representation 502 to an abstract representation 506 and mapping an abstract representation 506 to some runtime representation may be automated. For example, design tools may automatically generate an abstract representation for the model representation using XGL and then use the XGL abstract representation to generate GUIs that are customized for specific runtime environments and devices. As previously indicated, mapping rules may be provided for mapping model representations to an XGL representation. Mapping rules may also be provided for mapping an XGL representation to a runtime platform-specific representation.

Since the runtime environment uses abstract representation 506 rather than model representation 502 for runtime processing, the model representation 502 that is created during design-time is decoupled from the runtime environment. Abstract representation 506 thus provides an interface between the modeling environment and the runtime environment. As a result, changes may be made to the design time environment, including changes to model representation 502 or changes that affect model representation 502, generally to not substantially affect or impact the runtime environment or tools used by the runtime environment. Likewise, changes may be made to the runtime environment generally to not substantially affect or impact the design time environment. A designer or other developer can thus concentrate on the design aspects and make changes to the design without having to worry about the runtime dependencies such as the target device platform or programming language dependencies.

FIG. 5B depicts an example process for mapping a model representation 502 to a runtime representation using the example modeling environment 516 of FIG. 5A or some other modeling environment. Model representation 502 may comprise one or more model components and associated properties that describe a data object, such as hosted business objects and interfaces. As described above, at least one of these model components is based on or otherwise associated with these hosted business objects and interfaces. The abstract representation 506 is generated based upon model representation 502. Abstract representation 506 may be generated by the abstract representation generator 504. Abstract representation 506 comprises one or more abstract GUI components and properties associated with the abstract GUI components. As part of generation of abstract representation 506, the model GUI components and their associated properties from the model representation are mapped to abstract GUI components and properties associated with the abstract GUI components. Various mapping rules may be provided to facilitate the mapping. The abstract representation encapsulates both appearance and behavior of a GUI. Therefore, by mapping model components to abstract components, the abstract representation not only specifies the visual appearance of the GUI but also the behavior of the GUI, such as in response to events whether clicking/dragging or scrolling, interactions between GUI components and such.

One or more runtime representations 550a, including GUIs for specific runtime environment platforms, may be generated from abstract representation 506. A device-dependent runtime representation may be generated for a particular type of target device platform to be used for executing and displaying the GUI encapsulated by the abstract representation. The GUIs generated from abstract representation 506 may comprise various types of GUI elements such as buttons, windows, scrollbars, input boxes, etc. Rules may be provided for mapping an abstract representation to a particular runtime representation. Various mapping rules may be provided for different runtime environment platforms.

Methods and systems consistent with the subject matter described herein provide and use interfaces 320 derived from the business object model 318 suitable for use with more than one business area, for example different departments within a company such as finance, or marketing. Also, they are suitable across industries and across businesses. Interfaces 320 are used during an end-to-end business transaction to transfer business process information in an application-independent manner. For example the interfaces can be used for fulfilling a sales order.

1. Message Overview

To perform an end-to-end business transaction, consistent interfaces are used to create business documents that are sent within messages between heterogeneous programs or modules.

a) Message Categories

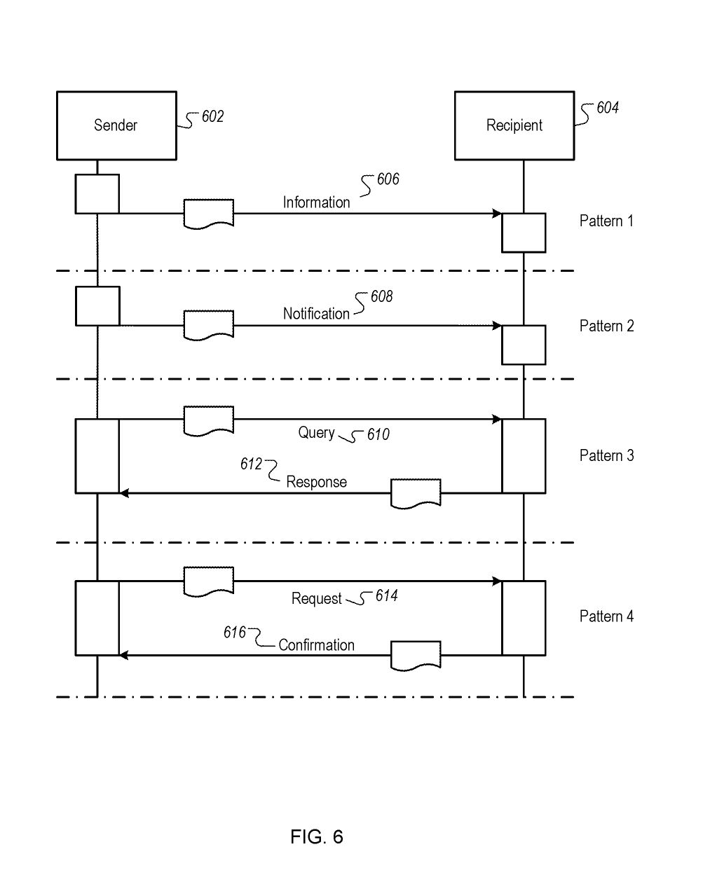

As depicted in FIG. 6, the communication between a sender 602 and a recipient 604 can be broken down into basic categories that describe the type of the information exchanged and simultaneously suggest the anticipated reaction of the recipient 604. A message category is a general business classification for the messages. Communication is sender-driven. In other words, the meaning of the message categories is established or formulated from the perspective of the sender 602. The message categories include information 606, notification 608, query 610, response 612, request 614, and confirmation 616.

(1) Information

Information 606 is a message sent from a sender 602 to a recipient 604 concerning a condition or a statement of affairs. No reply to information is expected. Information 606 is sent to make business partners or business applications aware of a situation. Information 606 is not compiled to be application-specific. Examples of “information” are an announcement, advertising, a report, planning information, and a message to the business warehouse.

(2) Notification

A notification 608 is a notice or message that is geared to a service. A sender 602 sends the notification 608 to a recipient 604. No reply is expected for a notification. For example, a billing notification relates to the preparation of an invoice while a dispatched delivery notification relates to preparation for receipt of goods.

(3) Query

A query 610 is a question from a sender 602 to a recipient 604 to which a response 612 is expected. A query 610 implies no assurance or obligation on the part of the sender 602. Examples of a query 610 are whether space is available on a specific flight or whether a specific product is available. These queries do not express the desire for reserving the flight or purchasing the product.

(4) Response

A response 612 is a reply to a query 610. The recipient 604 sends the response 612 to the sender 602. A response 612 generally implies no assurance or obligation on the part of the recipient 604. The sender 602 is not expected to reply. Instead, the process is concluded with the response 612. Depending on the business scenario, a response 612 also may include a commitment, i.e., an assurance or obligation on the part of the recipient 604. Examples of responses 612 are a response stating that space is available on a specific flight or that a specific product is available. With these responses, no reservation was made.

(5) Request

A request 614 is a binding requisition or requirement from a sender 602 to a recipient 604. Depending on the business scenario, the recipient 604 can respond to a request 614 with a confirmation 616. The request 614 is binding on the sender 602. In making the request 614, the sender 602 assumes, for example, an obligation to accept the services rendered in the request 614 under the reported conditions. Examples of a request 614 are a parking ticket, a purchase order, an order for delivery and a job application.

(6) Confirmation

A confirmation 616 is a binding reply that is generally made to a request 614. The recipient 604 sends the confirmation 616 to the sender 602. The information indicated in a confirmation 616, such as deadlines, products, quantities and prices, can deviate from the information of the preceding request 614. A request 614 and confirmation 616 may be used in negotiating processes. A negotiating process can consist of a series of several request 614 and confirmation 616 messages. The confirmation 616 is binding on the recipient 604. For example, 100 units of X may be ordered in a purchase order request; however, only the delivery of 80 units is confirmed in the associated purchase order confirmation.

b) Message Choreography

A message choreography is a template that specifies the sequence of messages between business entities during a given transaction. The sequence with the messages contained in it describes in general the message “lifecycle” as it proceeds between the business entities. If messages from a choreography are used in a business transaction, they appear in the transaction in the sequence determined by the choreography. This illustrates the template character of a choreography, i.e., during an actual transaction, it is not necessary for all messages of the choreography to appear. Those messages that are contained in the transaction, however, follow the sequence within the choreography. A business transaction is thus a derivation of a message choreography. The choreography makes it possible to determine the structure of the individual message types more precisely and distinguish them from one another.

2. Components of the Business Object Model

The overall structure of the business object model ensures the consistency of the interfaces that are derived from the business object model. The derivation ensures that the same business-related subject matter or concept is represented and structured in the same way in all interfaces.

The business object model defines the business-related concepts at a central location for a number of business transactions. In other words, it reflects the decisions made about modeling the business entities of the real world acting in business transactions across industries and business areas. The business object model is defined by the business objects and their relationship to each other (the overall net structure).

Each business object is generally a capsule with an internal hierarchical structure, behavior offered by its operations, and integrity constraints. Business objects are semantically disjoint, i.e., the same business information is represented once. In the business object model, the business objects are arranged in an ordering framework. From left to right, they are arranged according to their existence dependency to each other. For example, the customizing elements may be arranged on the left side of the business object model, the strategic elements may be arranged in the center of the business object model, and the operative elements may be arranged on the right side of the business object model. Similarly, the business objects are arranged from the top to the bottom based on defined order of the business areas, e.g., finance could be arranged at the top of the business object model with CRM below finance and SRM below CRM.

To ensure the consistency of interfaces, the business object model may be built using standardized data types as well as packages to group related elements together, and package templates and entity templates to specify the arrangement of packages and entities within the structure.

a) Data Types

Data types are used to type object entities and interfaces with a structure. This typing can include business semantic. Such data types may include those generally described at pages 96 through 1642 (which are incorporated by reference herein) of U.S. patent application Ser. No. 11/803,178, filed on May 11, 2007 and entitled “Consistent Set Of Interfaces Derived From A Business Object Model”. For example, the data type BusinessTransactionDocumentID is a unique identifier for a document in a business transaction. Also, as an example, Data type BusinessTransactionDocumentParty contains the information that is exchanged in business documents about a party involved in a business transaction, and includes the party's identity, the party's address, the party's contact person and the contact person's address. BusinessTransactionDocumentParty also includes the role of the party, e.g., a buyer, seller, product recipient, or vendor.

The data types are based on Core Component Types (“CCTs”), which themselves are based on the World Wide Web Consortium (“W3C”) data types. “Global” data types represent a business situation that is described by a fixed structure. Global data types include both context-neutral generic data types (“GDTs”) and context-based context data types (“CDTs”). GDTs contain business semantics, but are application-neutral, i.e., without context. CDTs, on the other hand, are based on GDTs and form either a use-specific view of the GDTs, or a context-specific assembly of GDTs or CDTs. A message is typically constructed with reference to a use and is thus a use-specific assembly of GDTs and CDTs. The data types can be aggregated to complex data types.

To achieve a harmonization across business objects and interfaces, the same subject matter is typed with the same data type. For example, the data type “GeoCoordinates” is built using the data type “Measure” so that the measures in a GeoCoordinate (i.e., the latitude measure and the longitude measure) are represented the same as other “Measures” that appear in the business object model.

b) Entities

Entities are discrete business elements that are used during a business transaction. Entities are not to be confused with business entities or the components that interact to perform a transaction. Rather, “entities” are one of the layers of the business object model and the interfaces. For example, a Catalogue entity is used in a Catalogue Publication Request and a Purchase Order is used in a Purchase Order Request. These entities are created using the data types defined above to ensure the consistent representation of data throughout the entities.

c) Packages

Packages group the entities in the business object model and the resulting interfaces into groups of semantically associated information. Packages also may include “sub”-packages, i.e., the packages may be nested.

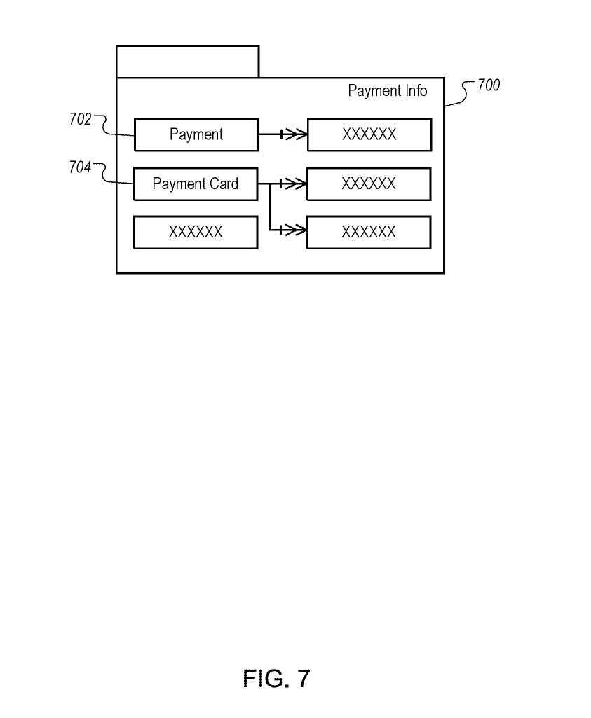

Packages may group elements together based on different factors, such as elements that occur together as a rule with regard to a business-related aspect. For example, as depicted in FIG. 7, in a Purchase Order, different information regarding the purchase order, such as the type of payment 702, and payment card 704, are grouped together via the PaymentInformation package 700.

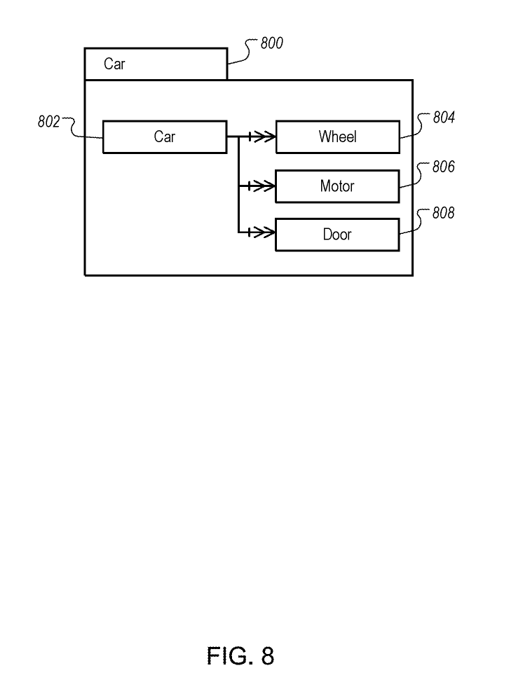

Packages also may combine different components that result in a new object. For example, as depicted in FIG. 8, the components wheels 804, motor 806, and doors 808 are combined to form a composition “Car” 802. The “Car” package 800 includes the wheels, motor and doors as well as the composition “Car.”

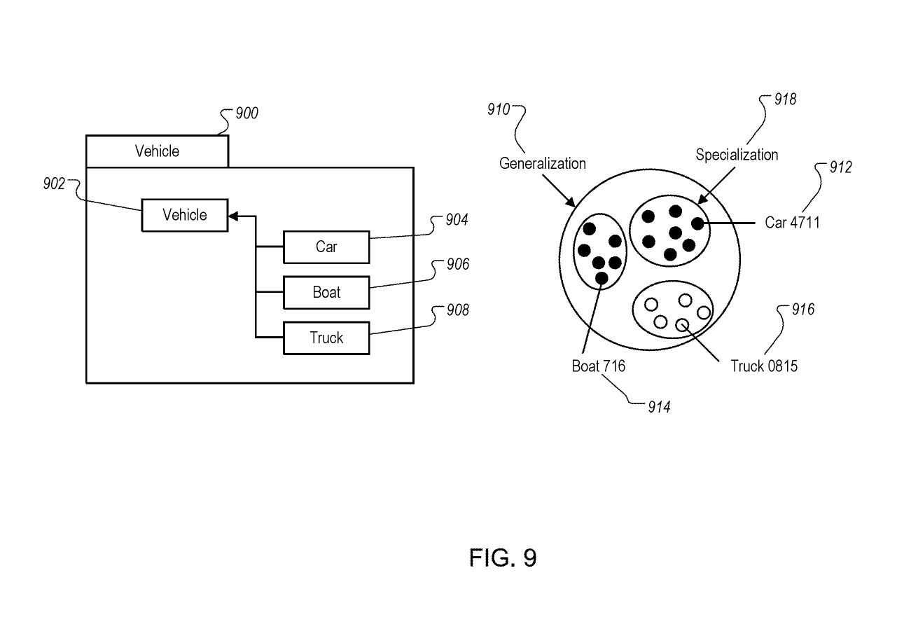

Another grouping within a package may be subtypes within a type. In these packages, the components are specialized forms of a generic package. For example, as depicted in FIG. 9, the components Car 904, Boat 906, and Truck 908 can be generalized by the generic term Vehicle 902 in Vehicle package 900. Vehicle in this case is the generic package 910, while Car 912, Boat 914, and Truck 916 are the specializations 918 of the generalized vehicle 910.

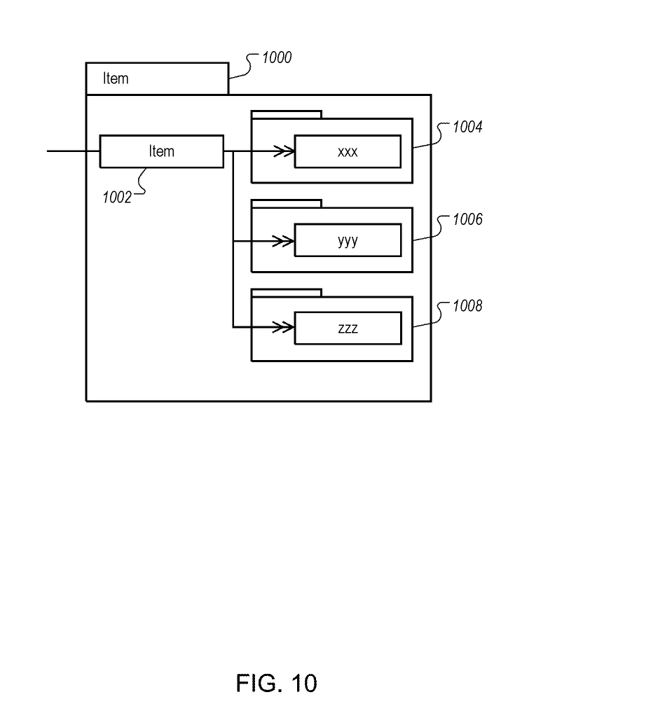

Packages also may be used to represent hierarchy levels. For example, as depicted in FIG. 10, the Item Package 1000 includes Item 1002 with subitem xxx 1004, subitem yyy 1006, and subitem zzz 1008.

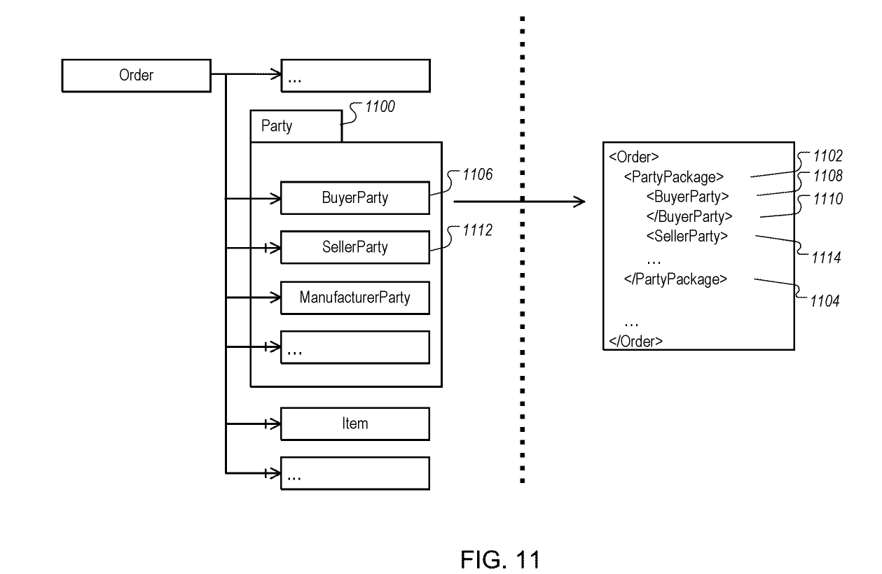

Packages can be represented in the XML schema as a comment. One advantage of this grouping is that the document structure is easier to read and is more understandable. The names of these packages are assigned by including the object name in brackets with the suffix “Package.” For example, as depicted in FIG. 11, Party package 1100 is enclosed by <PartyPackage> 1102 and </PartyPackage> 1104. Party package 1100 illustratively includes a Buyer Party 1106, identified by <BuyerParty> 1108 and </BuyerParty> 1110, and a Seller Party 1112, identified by <SellerParty> 1114 and </SellerParty>, etc.

d) Relationships

Relationships describe the interdependencies of the entities in the business object model, and are thus an integral part of the business object model.

(1) Cardinality of Relationships

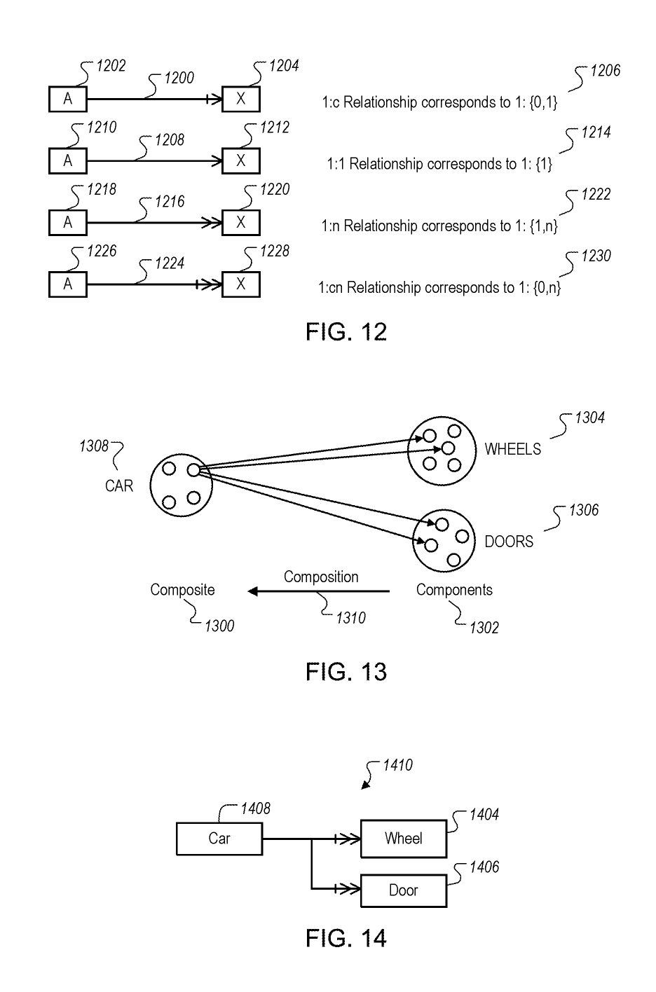

FIG. 12 depicts a graphical representation of the cardinalities between two entities. The cardinality between a first entity and a second entity identifies the number of second entities that could possibly exist for each first entity. Thus, a 1:c cardinality 1200 between entities A 1202 and X 1204 indicates that for each entity A 1202, there is either one or zero 1206 entity X 1204. A 1:1 cardinality 1208 between entities A 1210 and X 1212 indicates that for each entity A 1210, there is exactly one 1214 entity X 1212. A 1:n cardinality 1216 between entities A 1218 and X 1220 indicates that for each entity A 1218, there are one or more 1222 entity Xs 1220. A 1:cn cardinality 1224 between entities A 1226 and X 1228 indicates that for each entity A 1226, there are any number 1230 of entity Xs 1228 (i.e., 0 through n Xs for each A).

(2) Types of Relationships

(a) Composition

A composition or hierarchical relationship type is a strong whole-part relationship which is used to describe the structure within an object. The parts, or dependent entities, represent a semantic refinement or partition of the whole, or less dependent entity. For example, as depicted in FIG. 13, the components 1302, wheels 1304, and doors 1306 may be combined to form the composite 1300 “Car” 1308 using the composition 1310. FIG. 14 depicts a graphical representation of the composition 1410 between composite Car 1408 and components wheel 1404 and door 1406.

(b) Aggregation

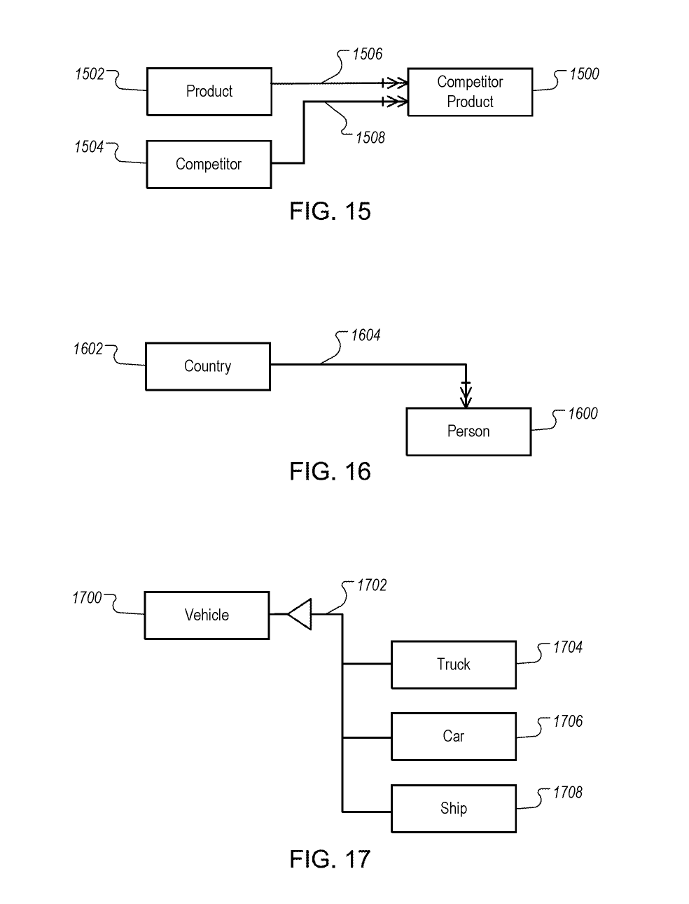

An aggregation or an aggregating relationship type is a weak whole-part relationship between two objects. The dependent object is created by the combination of one or several less dependent objects. For example, as depicted in FIG. 15, the properties of a competitor product 1500 are determined by a product 1502 and a competitor 1504. A hierarchical relationship 1506 exists between the product 1502 and the competitor product 1500 because the competitor product 1500 is a component of the product 1502. Therefore, the values of the attributes of the competitor product 1500 are determined by the product 1502. An aggregating relationship 1508 exists between the competitor 1504 and the competitor product 1500 because the competitor product 1500 is differentiated by the competitor 1504. Therefore the values of the attributes of the competitor product 1500 are determined by the competitor 1504.

(c) Association

An association or a referential relationship type describes a relationship between two objects in which the dependent object refers to the less dependent object. For example, as depicted in FIG. 16, a person 1600 has a nationality, and thus, has a reference to its country 1602 of origin. There is an association 1604 between the country 1602 and the person 1600. The values of the attributes of the person 1600 are not determined by the country 1602.

(3) Specialization

Entity types may be divided into subtypes based on characteristics of the entity types. For example, FIG. 17 depicts an entity type “vehicle” 1700 specialized 1702 into subtypes “truck” 1704, “car” 1706, and “ship” 1708. These subtypes represent different aspects or the diversity of the entity type.

Subtypes may be defined based on related attributes. For example, although ships and cars are both vehicles, ships have an attribute, “draft,” that is not found in cars. Subtypes also may be defined based on certain methods that can be applied to entities of this subtype and that modify such entities. For example, “drop anchor” can be applied to ships. If outgoing relationships to a specific object are restricted to a subset, then a subtype can be defined which reflects this subset.

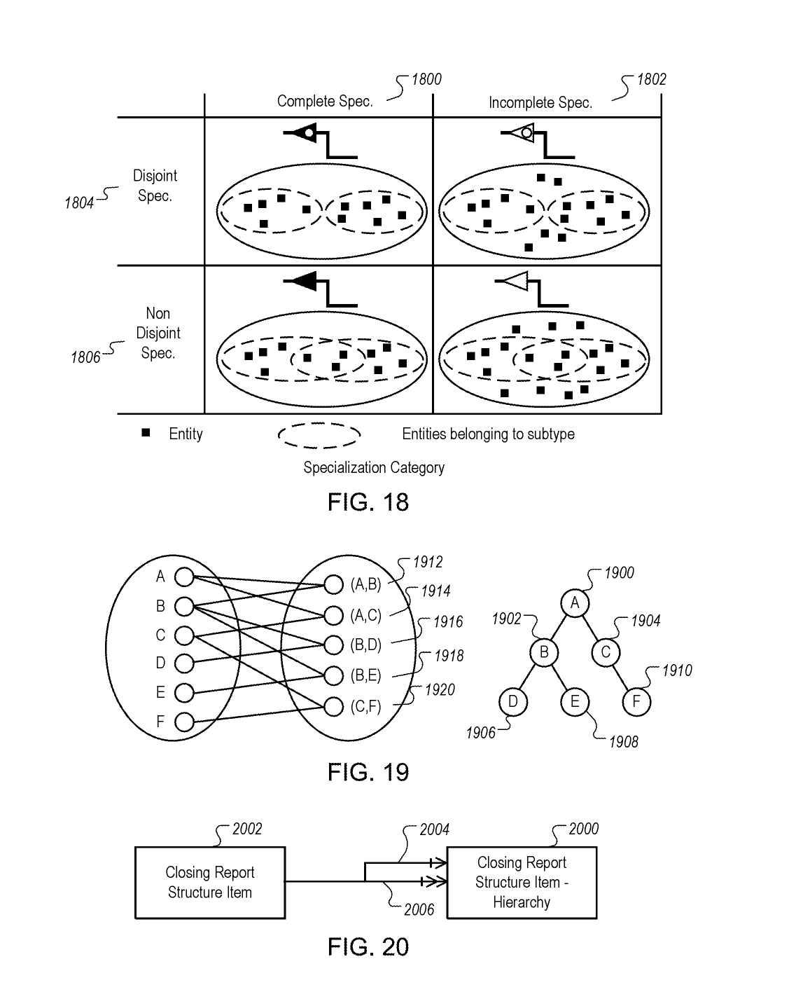

As depicted in FIG. 18, specializations may further be characterized as complete specializations 1800 or incomplete specializations 1802. There is a complete specialization 1800 where each entity of the generalized type belongs to at least one subtype. With an incomplete specialization 1802, there is at least one entity that does not belong to a subtype. Specializations also may be disjoint 1804 or nondisjoint 1806. In a disjoint specialization 1804, each entity of the generalized type belongs to a maximum of one subtype. With a nondisjoint specialization 1806, one entity may belong to more than one subtype. As depicted in FIG. 18, four specialization categories result from the combination of the specialization characteristics.

e) Structural Patterns

(1) Item

An item is an entity type which groups together features of another entity type. Thus, the features for the entity type chart of accounts are grouped together to form the entity type chart of accounts item. For example, a chart of accounts item is a category of values or value flows that can be recorded or represented in amounts of money in accounting, while a chart of accounts is a superordinate list of categories of values or value flows that is defined in accounting.

The cardinality between an entity type and its item is often either 1:n or 1:cn. For example, in the case of the entity type chart of accounts, there is a hierarchical relationship of the cardinality 1:n with the entity type chart of accounts item since a chart of accounts has at least one item in all cases.

(2) Hierarchy

A hierarchy describes the assignment of subordinate entities to superordinate entities and vice versa, where several entities of the same type are subordinate entities that have, at most, one directly superordinate entity. For example, in the hierarchy depicted in FIG. 19, entity B 1902 is subordinate to entity A 1900, resulting in the relationship (A,B) 1912. Similarly, entity C 1904 is subordinate to entity A 1900, resulting in the relationship (A,C) 1914. Entity D 1906 and entity E 1908 are subordinate to entity B 1902, resulting in the relationships (B,D) 1916 and (B,E) 1918, respectively. Entity F 1910 is subordinate to entity C 1904, resulting in the relationship (C,F) 1920.

Because each entity has at most one superordinate entity, the cardinality between a subordinate entity and its superordinate entity is 1:c. Similarly, each entity may have 0, 1 or many subordinate entities. Thus, the cardinality between a superordinate entity and its subordinate entity is 1:cn. FIG. 20 depicts a graphical representation of a Closing Report Structure Item hierarchy 2000 for a Closing Report Structure Item 2002. The hierarchy illustrates the 1:c cardinality 2004 between a subordinate entity and its superordinate entity, and the 1:cn cardinality 2006 between a superordinate entity and its subordinate entity.

3. Creation of the Business Object Model

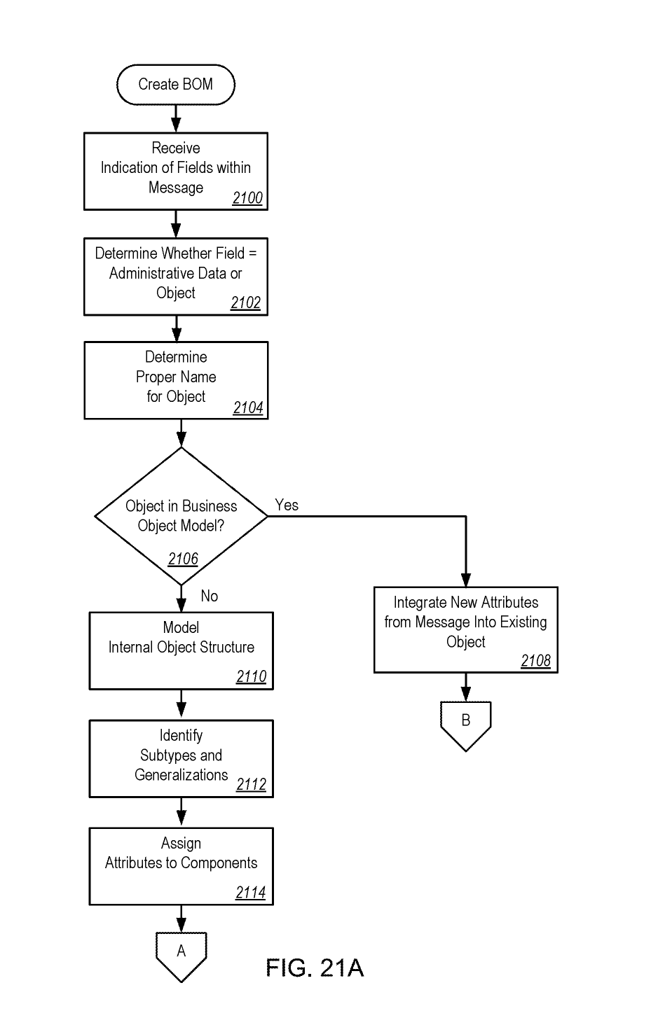

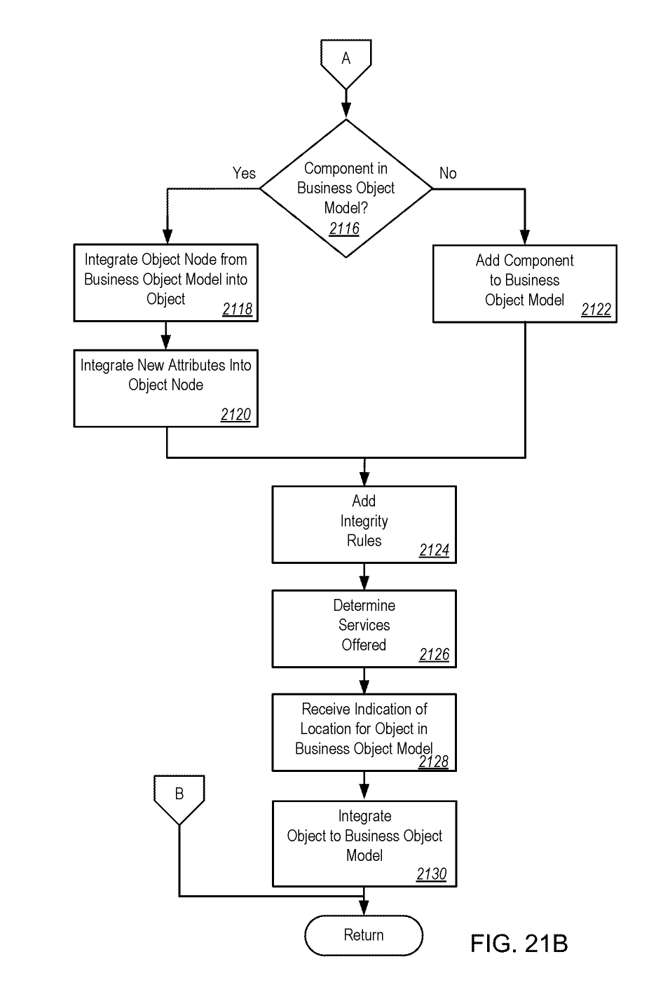

FIGS. 21A-B depict the steps performed using methods and systems consistent with the subject matter described herein to create a business object model. Although some steps are described as being performed by a computer, these steps may alternatively be performed manually, or computer-assisted, or any combination thereof. Likewise, although some steps are described as being performed by a computer, these steps may also be computer-assisted, or performed manually, or any combination thereof.

As discussed above, the designers create message choreographies that specify the sequence of messages between business entities during a transaction. After identifying the messages, the developers identify the fields contained in one of the messages (step 2100, FIG. 21A). The designers then determine whether each field relates to administrative data or is part of the object (step 2102). Thus, the first eleven fields identified below in the left column are related to administrative data, while the remaining fields are part of the object.

| | |
|---|---|
| MessageID | Admin |
| ReferenceID | |
| CreationDate | |
| SenderID | |
| AdditionalSenderID | |
| ContactPersonID | |
| SenderAddress | |
| RecipientID | |
| AdditionalRecipientID | |
| ContactPersonID | |
| RecipientAddress | |
| ID | Main Object |
| AdditionalID | |
| PostingDate | |
| LastChangeDate | |
| AcceptanceStatus | |
| Note | |
| CompleteTransmission Indicator | |
| Buyer | |
| BuyerOrganisationName | |
| Person Name | |
| FunctionalTitle | |
| DepartmentName | |
| CountryCode | |
| StreetPostalCode | |
| POBox Postal Code | |
| Company Postal Code | |
| City Name | |
| DistrictName | |
| PO Box ID | |
| PO Box Indicator | |
| PO Box Country Code | |
| PO Box Region Code | |
| PO Box City Name | |
| Street Name | |
| House ID | |
| Building ID | |
| Floor ID | |
| Room ID | |
| Care Of Name | |
| AddressDescription | |
| Telefonnumber | |
| MobileNumber | |
| Facsimile | |
| Email | |
| Seller | |
| SellerAddress | |
| Location | |
| LocationType | |
| DeliveryItemGroupID | |
| DeliveryPriority | |
| DeliveryCondition | |
| TransferLocation | |
| NumberofPartialDelivery | |
| QuantityTolerance | |
| MaximumLeadTime | |
| TransportServiceLevel | |
| TranportCondition | |
| TransportDescription | |
| CashDiscountTerms | |
| PaymentForm | |
| PaymentCardID | |
| PaymentCardReferenceID | |
| SequenceID | |
| Holder | |
| ExpirationDate | |
| AttachmentID | |
| AttachmentFilename | |
| DescriptionofMessage | |
| ConfirmationDescriptionof Message | |
| FollowUpActivity | |
| ItemID | |
| ParentItemID | |
| HierarchyType | |
| ProductID | |
| ProductType | |
| ProductNote | |
| ProductCategoryID | |
| Amount | |
| BaseQuantity | |
| ConfirmedAmount | |
| ConfirmedBaseQuantity | |
| ItemBuyer | |
| ItemBuyerOrganisationName | |
| Person Name | |
| FunctionalTitle | |
| DepartmentName | |
| CountryCode | |
| StreetPostalCode | |
| POBox Postal Code | |
| Company Postal Code | |
| City Name | |
| DistrictName | |
| PO Box ID | |
| PO Box Indicator | |
| PO Box Country Code | |
| PO Box Region Code | |
| PO Box City Name | |
| Street Name | |
| House ID | |
| Building ID | |
| Floor ID | |
| Room ID | |
| Care Of Name | |
| AddressDescription | |
| Telefonnumber | |
| MobilNumber | |
| Facsimile | |
| Email | |
| ItemSeller | |
| ItemSellerAddress | |
| ItemLocation | |
| ItemLocationType | |
| ItemDeliveryItemGroupID | |
| ItemDeliveryPriority | |
| ItemDeliveryCondition | |
| ItemTransferLocation | |
| ItemNumberofPartialDelivery | |
| ItemQuantityTolerance | |
| ItemMaximumLeadTime | |
| ItemTransportServiceLevel | |
| ItemTranportCondition | |
| ItemTransportDescription | |
| ContractReference | |
| QuoteReference | |
| CatalogueReference | |
| ItemAttachmentID | |
| ItemAttachmentFilename | |
| ItemDescription | |
| ScheduleLineID | |
| DeliveryPeriod | |
| Quantity | |
| ConfirmedScheduleLineID | |
| ConfirmedDeliveryPeriod | |
| ConfirmedQuantity | |

Next, the designers determine the proper name for the object according to the ISO 11179 naming standards (step 2104). In the example above, the proper name for the “Main Object” is “Purchase Order.” After naming the object, the system that is creating the business object model determines whether the object already exists in the business object model (step 2106). If the object already exists, the system integrates new attributes from the message into the existing object (step 2108), and the process is complete.

If at step 2106 the system determines that the object does not exist in the business object model, the designers model the internal object structure (step 2110). To model the internal structure, the designers define the components. For the above example, the designers may define the components identified below.

| | | | |
|---|---|---|---|
| ID | Purchase | | |
| AdditionalID | Order | | |
| PostingDate | | | |
| LastChangeDate | | | |
| AcceptanceStatus | | | |
| Note | | | |
| CompleteTransmission | | | |
| Indicator | | | |
| Buyer | | Buyer | |
| BuyerOrganisationName | | | |
| Person Name | | | |
| FunctionalTitle | | | |
| DepartmentName | | | |
| CountryCode | | | |
| StreetPostalCode | | | |
| POBox Postal Code | | | |
| Company Postal Code | | | |
| City Name | | | |
| DistrictName | | | |
| PO Box ID | | | |
| PO Box Indicator | | | |
| PO Box Country Code | | | |
| PO Box Region Code | | | |
| PO Box City Name | | | |
| Street Name | | | |
| House ID | | | |
| Building ID | | | |
| Floor ID | | | |
| Room ID | | | |
| Care Of Name | | | |
| AddressDescription | | | |
| Telefonnumber | | | |
| MobileNumber | | | |
| Facsimile | | | |
| Email | | | |
| Seller | | Seller | |
| SellerAddress | | | |
| Location | | Location | |
| LocationType | | | |
| DeliveryItemGroupID | | Delivery- | |
| DeliveryPriority | | Terms | |
| DeliveryCondition | | | |
| TransferLocation | | | |
| NumberofPartialDelivery | | | |
| QuantityTolerance | | | |
| MaximumLeadTime | | | |
| TransportServiceLevel | | | |
| TranportCondition | | | |
| TransportDescription | | | |
| CashDiscountTerms | | | |
| PaymentForm | | Payment | |
| PaymentCardID | | | |
| PaymentCardReferenceID | | | |
| SequenceID | | | |
| Holder | | | |
| ExpirationDate | | | |
| AttachmentID | | | |
| AttachmentFilename | | | |
| DescriptionofMessage | | | |
| ConfirmationDescriptionof | | | |
| Message | | | |
| FollowUpActivity | | | |
| ItemID | | Purchase | |
| ParentItemID | | Order | |
| HierarchyType | | Item | |
| ProductID | | | Product |
| ProductType | | | |
| ProductNote | | | |
| ProductCategoryID | | | ProductCategory |
| Amount | | | |
| BaseQuantity | | | |
| ConfirmedAmount | | | |
| ConfirmedBaseQuantity | | | |
| ItemBuyer | | | Buyer |
| ItemBuyerOrganisation | | | |
| Name | | | |
| Person Name | | | |
| FunctionalTitle | | | |
| DepartmentName | | | |
| CountryCode | | | |
| StreetPostalCode | | | |
| POBox Postal Code | | | |
| Company Postal Code | | | |
| City Name | | | |
| DistrictName | | | |
| PO Box ID | | | |
| PO Box Indicator | | | |
| PO Box Country Code | | | |
| PO Box Region Code | | | |
| PO Box City Name | | | |
| Street Name | | | |
| House ID | | | |
| Building ID | | | |
| Floor ID | | | |
| Room ID | | | |
| Care Of Name | | | |
| AddressDescription | | | |
| Telefonnumber | | | |
| MobilNumber | | | |
| Facsimile | | | |
| Email | | | |
| ItemSeller | | | Seller |
| ItemSellerAddress | | | |
| ItemLocation | | | Location |
| ItemLocationType | | | |
| ItemDeliveryItemGroupID | | | |
| ItemDeliveryPriority | | | |
| ItemDeliveryCondition | | | |
| ItemTransferLocation | | | |
| ItemNumberofPartial | | | |
| Delivery | | | |
| ItemQuantityTolerance | | | |
| ItemMaximumLeadTime | | | |
| ItemTransportServiceLevel | | | |
| ItemTranportCondition | | | |
| ItemTransportDescription | | | |
| ContractReference | | | Contract |
| QuoteReference | | | Quote |
| CatalogueReference | | | Catalogue |
| ItemAttachmentID | | | |
| ItemAttachmentFilename | | | |
| ItemDescription | | | |
| ScheduleLineID | | | |
| DeliveryPeriod | | | |
| Quantity | | | |
| ConfirmedScheduleLineID | | | |
| ConfirmedDeliveryPeriod | | | |
| ConfirmedQuantity | | | |

During the step of modeling the internal structure, the designers also model the complete internal structure by identifying the compositions of the components and the corresponding cardinalities, as shown below.

| | | | | |
|---|---|---|---|---|
| PurchaseOrder | | | | 1 |
| | Buyer | | | 0 . . . 1 |
| | | Address | | 0 . . . 1 |
| | | ContactPerson | | 0 . . . 1 |
| | | | Address | 0 . . . 1 |
| | Seller | | | 0 . . . 1 |
| | Location | | | 0 . . . 1 |
| | | Address | | 0 . . . 1 |
| | DeliveryTerms | | | 0 . . . 1 |
| | | Incoterms | | 0 . . . 1 |
| | | PartialDelivery | | 0 . . . 1 |
| | | QuantityTolerance | | 0 . . . 1 |
| | | Transport | | 0 . . . 1 |
| | CashDiscount | | | 0 . . . 1 |
| | Terms | | | |
| | | MaximumCashDiscount | | 0 . . . 1 |
| | | NormalCashDiscount | | 0 . . . 1 |
| | PaymentForm | | | 0 . . . 1 |
| | | PaymentCard | | 0 . . . 1 |
| | Attachment | | | 0 . . . n |
| | Description | | | 0 . . . 1 |
| | Confirmation | | | 0 . . . 1 |
| | Description | | | |
| | Item | | | 0 . . . n |
| | | HierarchyRelationship | | 0 . . . 1 |
| | | Product | | 0 . . . 1 |
| | | ProductCategory | | 0 . . . 1 |
| | | Price | | 0 . . . 1 |
| | | | NetunitPrice | 0 . . . 1 |
| | | ConfirmedPrice | | 0 . . . 1 |
| | | | NetunitPrice | 0 . . . 1 |
| | | Buyer | | 0 . . . 1 |
| | | Seller | | 0 . . . 1 |
| | | Location | | 0 . . . 1 |
| | | DeliveryTerms | | 0 . . . 1 |
| | | Attachment | | 0 . . . n |
| | | Description | | 0 . . . 1 |
| | | ConfirmationDescription | | 0 . . . 1 |
| | | ScheduleLine | | 0 . . . n |
| | | | DeliveryPeriod | 1 |
| | | ConfirmedScheduleLine | | 0 . . . n |

After modeling the internal object structure, the developers identify the subtypes and generalizations for all objects and components (step 2112). For example, the Purchase Order may have subtypes Purchase Order Update, Purchase Order Cancellation and Purchase Order Information. Purchase Order Update may include Purchase Order Request, Purchase Order Change, and Purchase Order Confirmation. Moreover, Party may be identified as the generalization of Buyer and Seller. The subtypes and generalizations for the above example are shown below.

| | | | | | |
|---|---|---|---|---|---|
| Purchase | | | | | 1 |
| Order | | | | | |
| | PurchaseOrder | | | | |
| | Update | | | | |
| | | PurchaseOrder Request | | | |
| | | PurchaseOrder Change | | | |
| | | PurchaseOrder | | | |
| | | Confirmation | | | |
| | PurchaseOrder | | | | |
| | Cancellation | | | | |
| | PurchaseOrder | | | | |
| | Information | | | | |
| | Party | | | | |
| | | BuyerParty | | | 0 . . . 1 |
| | | | Address | | 0 . . . 1 |
| | | | ContactPerson | | 0 . . . 1 |
| | | | | Address | 0 . . . 1 |
| | | SellerParty | | | 0 . . . 1 |
| | Location | | | | |
| | | ShipToLocation | | | 0 . . . 1 |
| | | | Address | | 0 . . . 1 |
| | | ShipFromLocation | | | 0 . . . 1 |
| | | | Address | | 0 . . . 1 |
| | DeliveryTerms | | | | 0 . . . 1 |
| | | Incoterms | | | 0 . . . 1 |
| | | PartialDelivery | | | 0 . . . 1 |
| | | QuantityTolerance | | | 0 . . . 1 |
| | | Transport | | | 0 . . . 1 |
| | CashDiscount | | | | 0 . . . 1 |
| | Terms | | | | |
| | | MaximumCash Discount | | | 0 . . . 1 |
| | | NormalCashDiscount | | | 0 . . . 1 |
| | PaymentForm | | | | 0 . . . 1 |
| | | PaymentCard | | | 0 . . . 1 |
| | Attachment | | | | 0 . . . n |
| | Description | | | | 0 . . . 1 |
| | Confirmation | | | | 0 . . . 1 |
| | Description | | | | |
| | Item | | | | 0 . . . n |
| | | HierarchyRelationship | | | 0 . . . 1 |
| | | Product | | | 0 . . . 1 |
| | | ProductCategory | | | 0 . . . 1 |
| | | Price | | | 0 . . . 1 |
| | | | NetunitPrice | | 0 . . . 1 |
| | | ConfirmedPrice | | | 0 . . . 1 |
| | | | NetunitPrice | | 0 . . . 1 |
| | | Party | | | |
| | | | BuyerParty | | 0 . . . 1 |
| | | | SellerParty | | 0 . . . 1 |
| | | Location | | | |
| | | | ShipTo | | 0 . . . 1 |
| | | | Location | | |
| | | | ShipFrom | | 0 . . . 1 |
| | | | Location | | |
| | | DeliveryTerms | | | 0 . . . 1 |
| | | Attachment | | | 0 . . . n |
| | | Description | | | 0 . . . 1 |
| | | Confirmation | | | 0 . . . 1 |
| | | Description | | | |
| | | ScheduleLine | | | 0 . . . n |
| | | | Delivery | | 1 |
| | | | Period | | |
| | | ConfirmedScheduleLine | | | 0 . . . n |

After identifying the subtypes and generalizations, the developers assign the attributes to these components (step 2114). The attributes for a portion of the components are shown below.

| | | | | |
|---|---|---|---|---|
| Purchase | | | | 1 |
| Order | | | | |
| | ID | | | 1 |
| | SellerID | | | 0 . . . 1 |
| | BuyerPosting | | | 0 . . . 1 |
| | DateTime | | | |
| | BuyerLast | | | 0 . . . 1 |
| | ChangeDate | | | |
| | Time | | | |
| | SellerPosting | | | 0 . . . 1 |
| | DateTime | | | |
| | SellerLast | | | 0 . . . 1 |
| | ChangeDate | | | |
| | Time | | | |
| | Acceptance | | | 0 . . . 1 |
| | StatusCode | | | |
| | Note | | | 0 . . . 1 |
| | ItemList | | | 0 . . . 1 |
| | Complete | | | |
| | Transmission | | | |
| | Indicator | | | |
| | BuyerParty | | | 0 . . . 1 |
| | | StandardID | | 0 . . . n |
| | | BuyerID | | 0 . . . 1 |
| | | SellerID | | 0 . . . 1 |
| | | Address | | 0 . . . 1 |
| | | ContactPerson | | 0 . . . 1 |
| | | | BuyerID | 0 . . . 1 |
| | | | SellerID | 0 . . . 1 |
| | | | Address | 0 . . . 1 |
| | SellerParty | | | 0 . . . 1 |
| | Product | | | 0 . . . 1 |
| | RecipientParty | | | |
| | VendorParty | | | 0 . . . 1 |
| | Manufacturer | | | 0 . . . 1 |
| | Party | | | |
| | BillToParty | | | 0 . . . 1 |
| | PayerParty | | | 0 . . . 1 |
| | CarrierParty | | | 0 . . . 1 |
| | ShipTo | | | 0 . . . 1 |
| | Location | | | |
| | | StandardID | | 0 . . . n |
| | | BuyerID | | 0 . . . 1 |
| | | SellerID | | 0 . . . 1 |
| | | Address | | 0 . . . 1 |
| | ShipFrom | | | 0 . . . 1 |
| | Location | | | |

The system then determines whether the component is one of the object nodes in the business object model (step 2116, FIG. 21B). If the system determines that the component is one of the object nodes in the business object model, the system integrates a reference to the corresponding object node from the business object model into the object (step 2118). In the above example, the system integrates the reference to the Buyer party represented by an ID and the reference to the ShipToLocation represented by an into the object, as shown below. The attributes that were formerly located in the PurchaseOrder object are now assigned to the new found object party. Thus, the attributes are removed from the PurchaseOrder object.

| | | |
|---|---|---|
| PurchaseOrder | | |
| | ID | |
| | SellerID | |
| | BuyerPostingDateTime | |
| | BuyerLastChangeDateTime | |
| | SellerPostingDateTime | |
| | SellerLastChangeDateTime | |
| | AcceptanceStatusCode | |
| | Note | |
| | ItemListComplete | |
| | TransmissionIndicator | |
| | BuyerParty | |
| | | ID |
| | SellerParty | |
| | ProductRecipientParty | |
| | VendorParty | |
| | ManufacturerParty | |
| | BillToParty | |
| | PayerParty | |
| | CarrierParty | |
| | ShipToLocation | |
| | | ID |
| | ShipFromLocation | |

During the integration step, the designers classify the relationship (i.e., aggregation or association) between the object node and the object being integrated into the business object model. The system also integrates the new attributes into the object node (step 2120). If at step 2116, the system determines that the component is not in the business object model, the system adds the component to the business object model (step 2122).

Regardless of whether the component was in the business object model at step 2116, the next step in creating the business object model is to add the integrity rules (step 2124). There are several levels of integrity rules and constraints which should be described. These levels include consistency rules between attributes, consistency rules between components, and consistency rules to other objects. Next, the designers determine the services offered, which can be accessed via interfaces (step 2126). The services offered in the example above include PurchaseOrderCreateRequest, PurchaseOrderCancellationRequest, and PurchaseOrderReleaseRequest. The system then receives an indication of the location for the object in the business object model (step 2128). After receiving the indication of the location, the system integrates the object into the business object model (step 2130).

4. Structure of the Business Object Model

The business object model, which serves as the basis for the process of generating consistent interfaces, includes the elements contained within the interfaces. These elements are arranged in a hierarchical structure within the business object model.

5. Interfaces Derived from Business Object Model

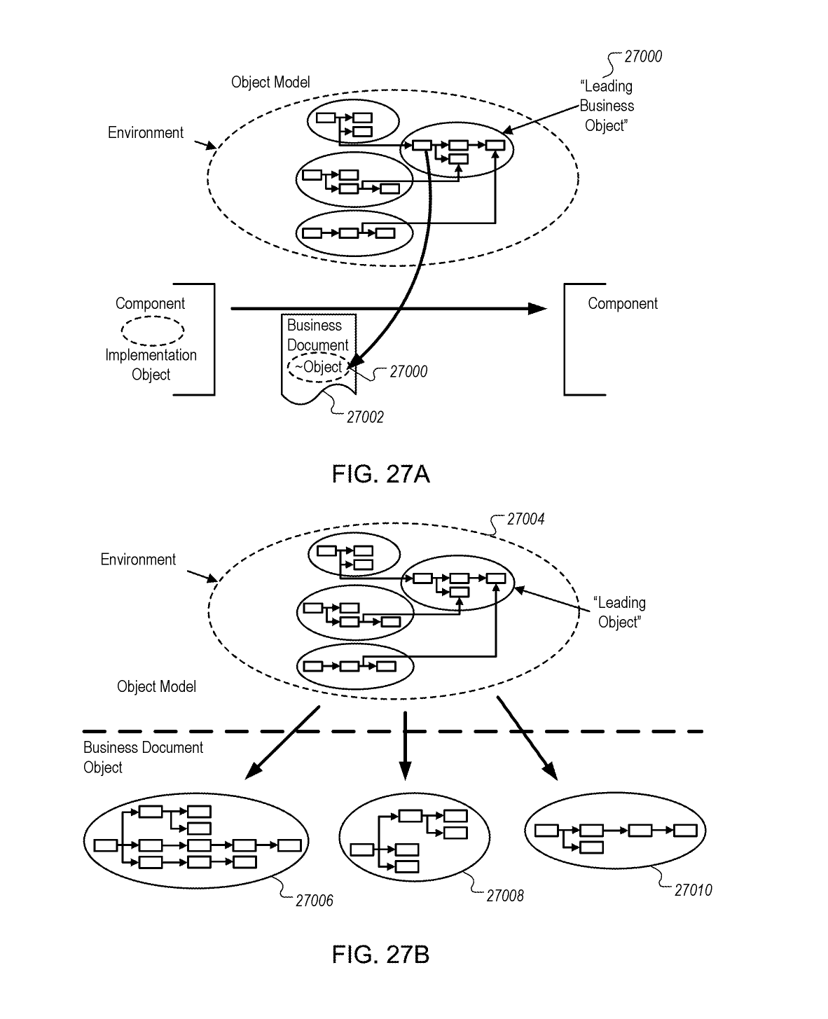

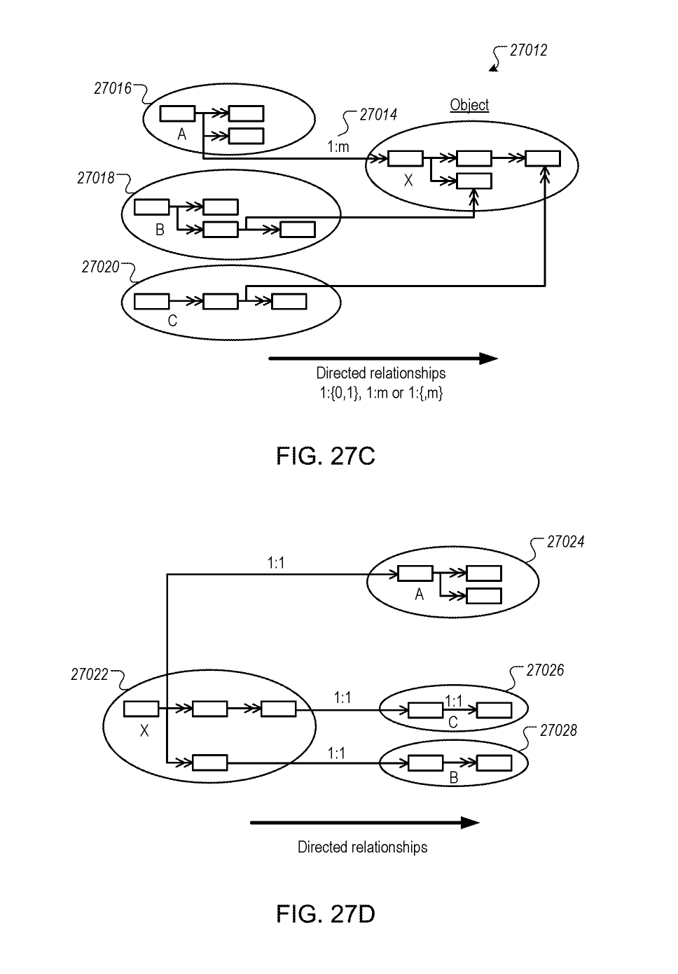

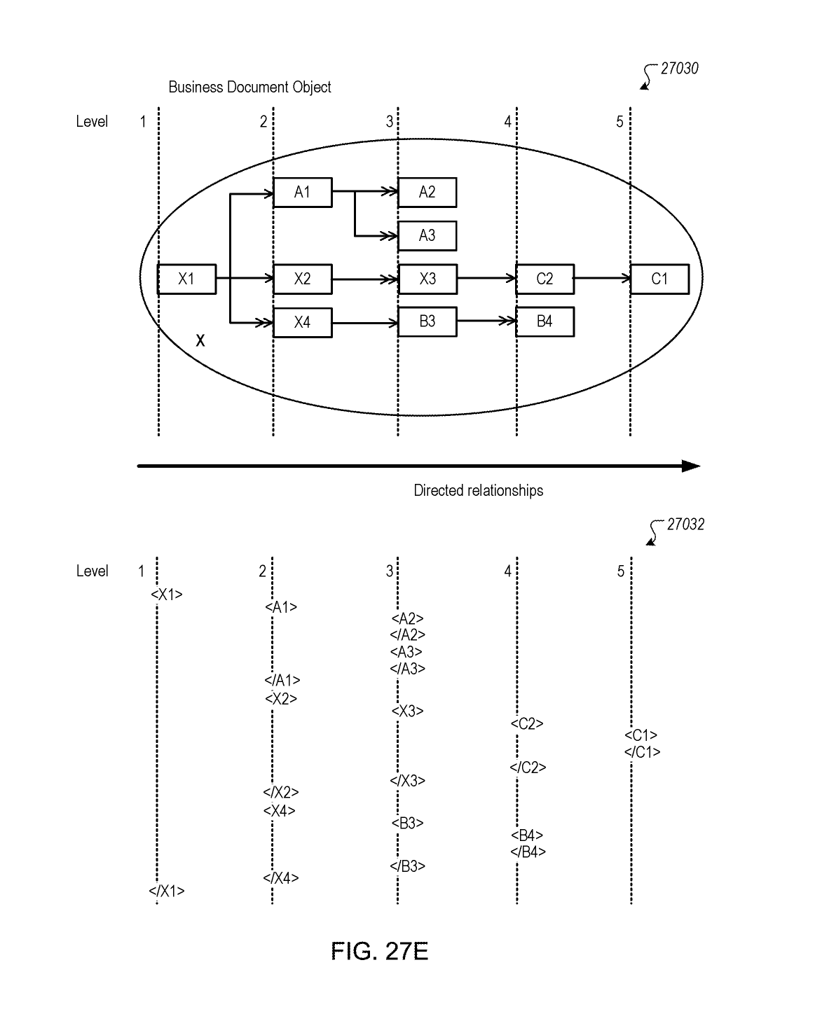

Interfaces are the starting point of the communication between two business entities. The structure of each interface determines how one business entity communicates with another business entity. The business entities may act as a unified whole when, based on the business scenario, the business entities know what an interface contains from a business perspective and how to fill the individual elements or fields of the interface. As illustrated in FIG. 27A, communication between components takes place via messages that contain business documents (e.g., business document 27002). The business document 27002 ensures a holistic business-related understanding for the recipient of the message. The business documents are created and accepted or consumed by interfaces, specifically by inbound and outbound interfaces. The interface structure and, hence, the structure of the business document are derived by a mapping rule. This mapping rule is known as “hierarchization.” An interface structure thus has a hierarchical structure created based on the leading business object 27000. The interface represents a usage-specific, hierarchical view of the underlying usage-neutral object model.

As illustrated in FIG. 27B, several business document objects 27006, 27008, and 27010 as overlapping views may be derived for a given leading object 27004. Each business document object results from the object model by hierarchization.

To illustrate the hierarchization process, FIG. 27C depicts an example of an object model 27012 (i.e., a portion of the business object model) that is used to derive a service operation signature (business document object structure). As depicted, leading object X 27014 in the object model 27012 is integrated in a net of object A 27016, object B 27018, and object C 27020. Initially, the parts of the leading object 27014 that are required for the business object document are adopted. In one variation, all parts required for a business document object are adopted from leading object 27014 (making such an operation a maximal service operation). Based on these parts, the relationships to the superordinate objects (i.e., objects A, B, and C from which object X depends) are inverted. In other words, these objects are adopted as dependent or subordinate objects in the new business document object.

For example, object A 27016, object B 27018, and object C 27020 have information that characterize object X. Because object A 27016, object B 27018, and object C 27020 are superordinate to leading object X 27014, the dependencies of these relationships change so that object A 27016, object B 27018, and object C 27020 become dependent and subordinate to leading object X 27014. This procedure is known as “derivation of the business document object by hierarchization.”

Business-related objects generally have an internal structure (parts). This structure can be complex and reflect the individual parts of an object and their mutual dependency. When creating the operation signature, the internal structure of an object is strictly hierarchized. Thus, dependent parts keep their dependency structure, and relationships between the parts within the object that do not represent the hierarchical structure are resolved by prioritizing one of the relationships.

Relationships of object X to external objects that are referenced and whose information characterizes object X are added to the operation signature. Such a structure can be quite complex (see, for example, FIG. 27D). The cardinality to these referenced objects is adopted as 1:1 or 1:C, respectively. By this, the direction of the dependency changes. The required parts of this referenced object are adopted identically, both in their cardinality and in their dependency arrangement.

The newly created business document object contains all required information, including the incorporated master data information of the referenced objects. As depicted in FIG. 27D, components Xi in leading object X 27022 are adopted directly. The relationship of object X 27022 to object A 27024, object B 27028, and object C 27026 are inverted, and the parts required by these objects are added as objects that depend from object X 27022. As depicted, all of object A 27024 is adopted. B3 and B4 are adopted from object B 27028, but B1 is not adopted. From object C 27026, C2 and C1 are adopted, but C3 is not adopted.

FIG. 27E depicts the business document object X 27030 created by this hierarchization process. As shown, the arrangement of the elements corresponds to their dependency levels, which directly leads to a corresponding representation as an XML structure 27032.

The following provides certain rules that can be adopted singly or in combination with regard to the hierarchization process. A business document object always refers to a leading business document object and is derived from this object. The name of the root entity in the business document entity is the name of the business object or the name of a specialization of the business object or the name of a service specific view onto the business object. The nodes and elements of the business object that are relevant (according to the semantics of the associated message type) are contained as entities and elements in the business document object.

The name of a business document entity is predefined by the name of the corresponding business object node. The name of the superordinate entity is not repeated in the name of the business document entity. The “full” semantic name results from the concatenation of the entity names along the hierarchical structure of the business document object.

The structure of the business document object is, except for deviations due to hierarchization, the same as the structure of the business object. The cardinalities of the business document object nodes and elements are adopted identically or more restrictively to the business document object. An object from which the leading business object is dependent can be adopted to the business document object. For this arrangement, the relationship is inverted, and the object (or its parts, respectively) are hierarchically subordinated in the business document object.

Nodes in the business object representing generalized business information can be adopted as explicit entities to the business document object (generally speaking, multiply TypeCodes out). When this adoption occurs, the entities are named according to their more specific semantic (name of TypeCode becomes prefix). Party nodes of the business object are modeled as explicit entities for each party role in the business document object. These nodes are given the name <Prefix><Party Role>Party, for example, BuyerParty, ItemBuyerParty. BTDReference nodes are modeled as separate entities for each reference type in the business document object. These nodes are given the name <Qualifier><BO><Node>Reference, for example SalesOrderReference, OriginSalesOrderReference, SalesOrderItemReference. A product node in the business object comprises all of the information on the Product, ProductCategory, and Batch. This information is modeled in the business document object as explicit entities for Product, ProductCategory, and Batch.

Entities which are connected by a 1:1 relationship as a result of hierarchization can be combined to a single entity, if they are semantically equivalent. Such a combination can often occurs if a node in the business document object that results from an assignment node is removed because it does not have any elements.

The message type structure is typed with data types. Elements are typed by GDTs according to their business objects. Aggregated levels are typed with message type specific data types (Intermediate Data Types), with their names being built according to the corresponding paths in the message type structure. The whole message type structured is typed by a message data type with its name being built according to the root entity with the suffix “Message”. For the message type, the message category (e.g., information, notification, query, response, request, confirmation, etc.) is specified according to the suited transaction communication pattern.

In one variation, the derivation by hierarchization can be initiated by specifying a leading business object and a desired view relevant for a selected service operation. This view determines the business document object. The leading business object can be the source object, the target object, or a third object. Thereafter, the parts of the business object required for the view are determined. The parts are connected to the root node via a valid path along the hierarchy. Thereafter, one or more independent objects (object parts, respectively) referenced by the leading object which are relevant for the service may be determined (provided that a relationship exists between the leading object and the one or more independent objects).

Once the selection is finalized, relevant nodes of the leading object node that are structurally identical to the message type structure can then be adopted. If nodes are adopted from independent objects or object parts, the relationships to such independent objects or object parts are inverted. Linearization can occur such that a business object node containing certain TypeCodes is represented in the message type structure by explicit entities (an entity for each value of the TypeCode). The structure can be reduced by checking all 1:1 cardinalities in the message type structure. Entities can be combined if they are semantically equivalent, one of the entities carries no elements, or an entity solely results from an n:m assignment in the business object.

After the hierarchization is completed, information regarding transmission of the business document object (e.g., CompleteTransmissionIndicator, ActionCodes, message category, etc.) can be added. A standardized message header can be added to the message type structure and the message structure can be typed. Additionally, the message category for the message type can be designated.

Invoice Request and Invoice Confirmation are examples of interfaces. These invoice interfaces are used to exchange invoices and invoice confirmations between an invoicing party and an invoice recipient (such as between a seller and a buyer) in a B2B process. Companies can create invoices in electronic as well as in paper form. Traditional methods of communication, such as mail or fax, for invoicing are cost intensive, prone to error, and relatively slow, since the data is recorded manually. Electronic communication eliminates such problems. The motivating business scenarios for the Invoice Request and Invoice Confirmation interfaces are the Procure to Stock (PTS) and Sell from Stock (SFS) scenarios. In the PTS scenario, the parties use invoice interfaces to purchase and settle goods. In the SFS scenario, the parties use invoice interfaces to sell and invoice goods. The invoice interfaces directly integrate the applications implementing them and also form the basis for mapping data to widely-used XML standard formats such as RosettaNet, PIDX, xCBL, and CIDX.

The invoicing party may use two different messages to map a B2B invoicing process: (1) the invoicing party sends the message type InvoiceRequest to the invoice recipient to start a new invoicing process; and (2) the invoice recipient sends the message type InvoiceConfirmation to the invoicing party to confirm or reject an entire invoice or to temporarily assign it the status “pending.”

An InvoiceRequest is a legally binding notification of claims or liabilities for delivered goods and rendered services—usually, a payment request for the particular goods and services. The message type InvoiceRequest is based on the message data type InvoiceMessage. The InvoiceRequest message (as defined) transfers invoices in the broader sense. This includes the specific invoice (request to settle a liability), the debit memo, and the credit memo.

InvoiceConfirmation is a response sent by the recipient to the invoicing party confirming or rejecting the entire invoice received or stating that it has been assigned temporarily the status “pending.” The message type InvoiceConfirmation is based on the message data type InvoiceMessage. An InvoiceConfirmation is not mandatory in a B2B invoicing process, however, it automates collaborative processes and dispute management.

Usually, the invoice is created after it has been confirmed that the goods were delivered or the service was provided. The invoicing party (such as the seller) starts the invoicing process by sending an InvoiceRequest message. Upon receiving the InvoiceRequest message, the invoice recipient (for instance, the buyer) can use the InvoiceConfirmation message to completely accept or reject the invoice received or to temporarily assign it the status “pending.” The InvoiceConfirmation is not a negotiation tool (as is the case in order management), since the options available are either to accept or reject the entire invoice. The invoice data in the InvoiceConfirmation message merely confirms that the invoice has been forwarded correctly and does not communicate any desired changes to the invoice. Therefore, the InvoiceConfirmation includes the precise invoice data that the invoice recipient received and checked. If the invoice recipient rejects an invoice, the invoicing party can send a new invoice after checking the reason for rejection (AcceptanceStatus and ConfirmationDescription at Invoice and InvoiceItem level). If the invoice recipient does not respond, the invoice is generally regarded as being accepted and the invoicing party can expect payment.

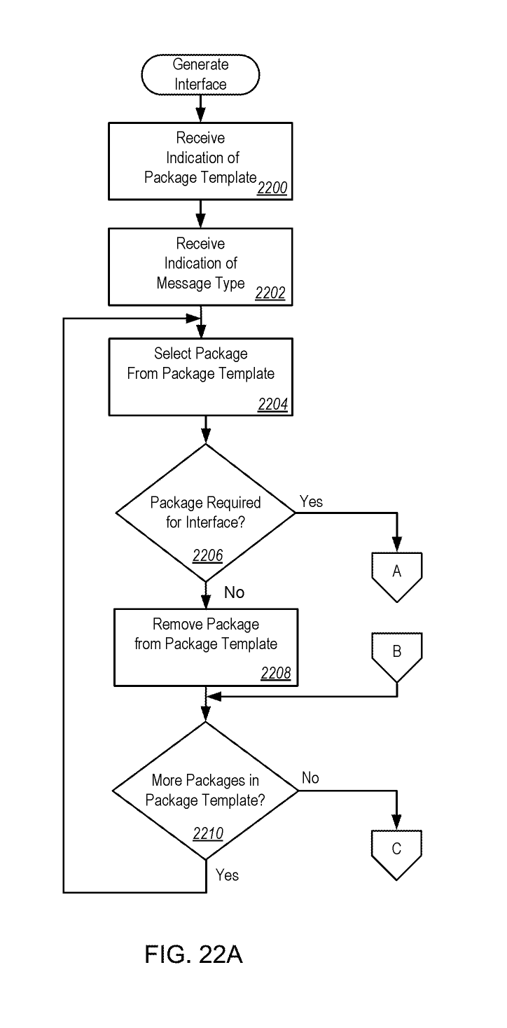

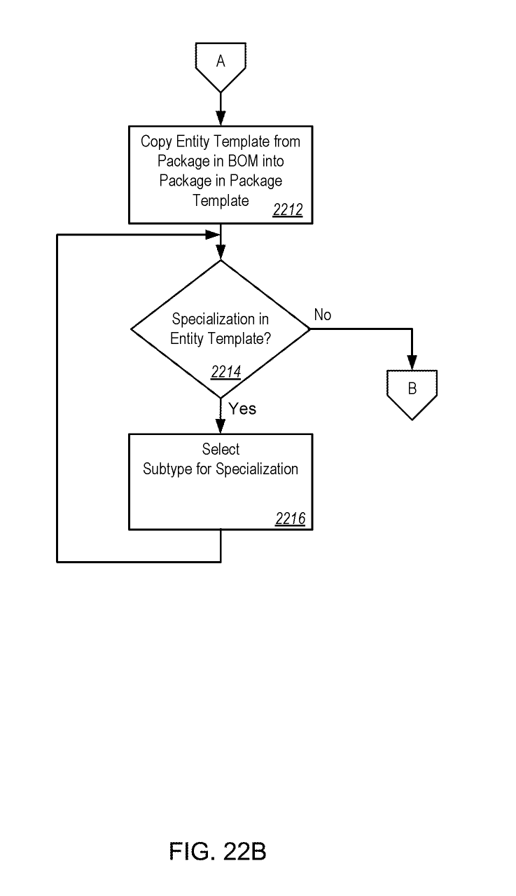

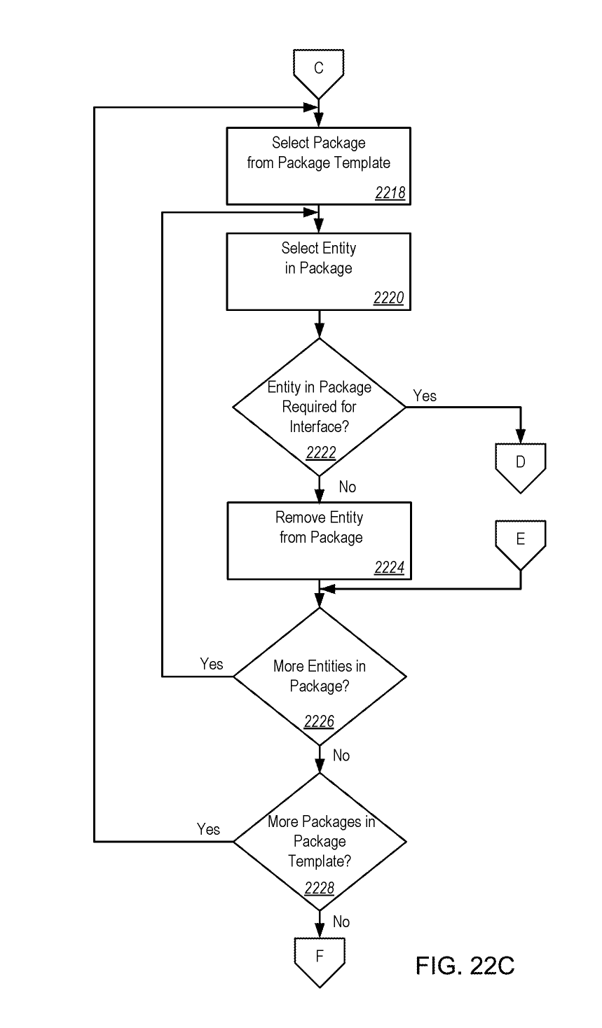

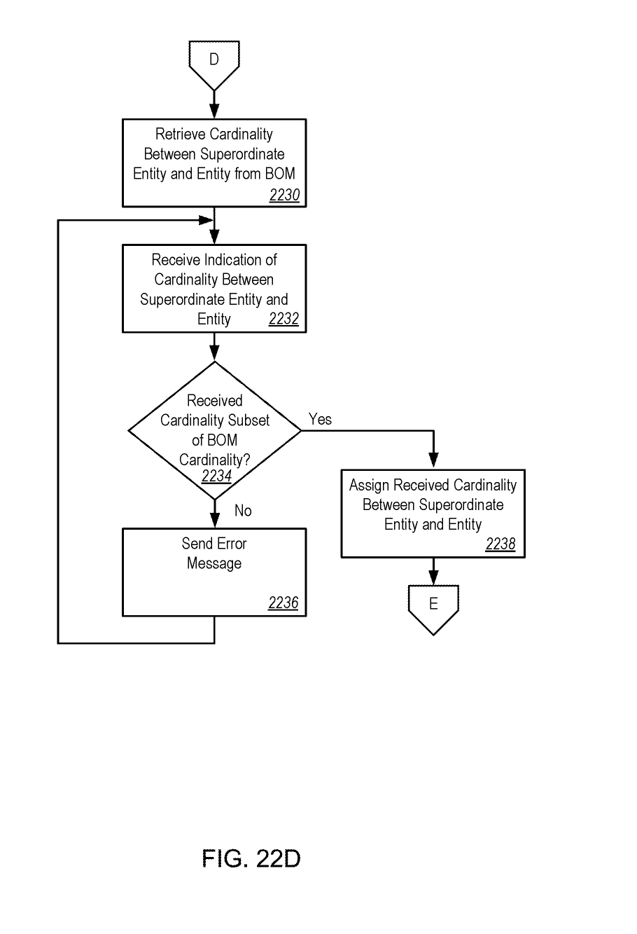

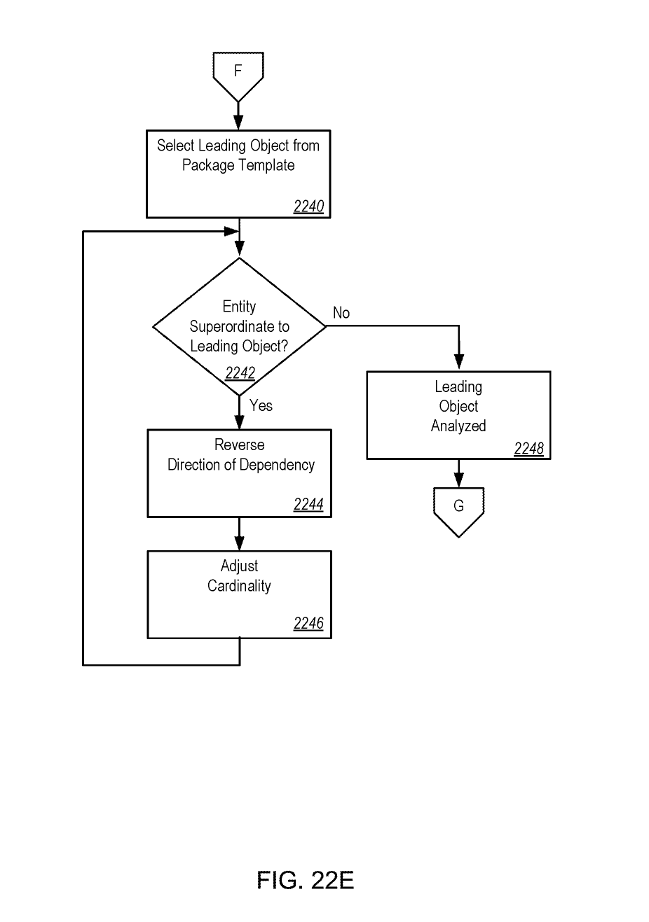

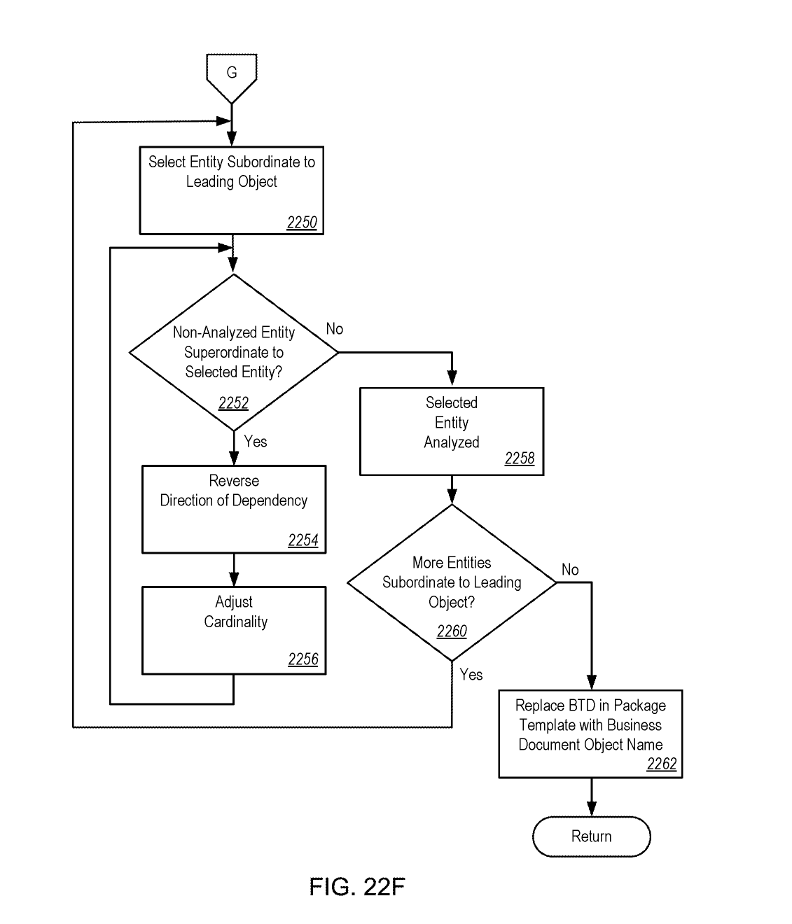

FIGS. 22A-F depict a flow diagram of the steps performed by methods and systems consistent with the subject matter described herein to generate an interface from the business object model. Although described as being performed by a computer, these steps may alternatively be performed manually, or using any combination thereof. The process begins when the system receives an indication of a package template from the designer, i.e., the designer provides a package template to the system (step 2200).

Package templates specify the arrangement of packages within a business transaction document. Package templates are used to define the overall structure of the messages sent between business entities. Methods and systems consistent with the subject matter described herein use package templates in conjunction with the business object model to derive the interfaces.

The system also receives an indication of the message type from the designer (step 2202). The system selects a package from the package template (step 2204), and receives an indication from the designer whether the package is required for the interface (step 2206). If the package is not required for the interface, the system removes the package from the package template (step 2208). The system then continues this analysis for the remaining packages within the package template (step 2210).

If, at step 2206, the package is required for the interface, the system copies the entity template from the package in the business object model into the package in the package template (step 2212, FIG. 22B). The system determines whether there is a specialization in the entity template (step 2214). If the system determines that there is a specialization in the entity template, the system selects a subtype for the specialization (step 2216). The system may either select the subtype for the specialization based on the message type, or it may receive this information from the designer. The system then determines whether there are any other specializations in the entity template (step 2214). When the system determines that there are no specializations in the entity template, the system continues this analysis for the remaining packages within the package template (step 2210, FIG. 22A).

At step 2210, after the system completes its analysis for the packages within the package template, the system selects one of the packages remaining in the package template (step 2218, FIG. 22C), and selects an entity from the package (step 2220). The system receives an indication from the designer whether the entity is required for the interface (step 2222). If the entity is not required for the interface, the system removes the entity from the package template (step 2224). The system then continues this analysis for the remaining entities within the package (step 2226), and for the remaining packages within the package template (step 2228).

If, at step 2222, the entity is required for the interface, the system retrieves the cardinality between a superordinate entity and the entity from the business object model (step 2230, FIG. 22D). The system also receives an indication of the cardinality between the superordinate entity and the entity from the designer (step 2232). The system then determines whether the received cardinality is a subset of the business object model cardinality (step 2234). If the received cardinality is not a subset of the business object model cardinality, the system sends an error message to the designer (step 2236). If the received cardinality is a subset of the business object model cardinality, the system assigns the received cardinality as the cardinality between the superordinate entity and the entity (step 2238). The system then continues this analysis for the remaining entities within the package (step 2226, FIG. 22C), and for the remaining packages within the package template (step 2228).

The system then selects a leading object from the package template (step 2240, FIG. 22E). The system determines whether there is an entity superordinate to the leading object (step 2242). If the system determines that there is an entity superordinate to the leading object, the system reverses the direction of the dependency (step 2244) and adjusts the cardinality between the leading object and the entity (step 2246). The system performs this analysis for entities that are superordinate to the leading object (step 2242). If the system determines that there are no entities superordinate to the leading object, the system identifies the leading object as analyzed (step 2248).

The system then selects an entity that is subordinate to the leading object (step 2250, FIG. 22F). The system determines whether any non-analyzed entities are superordinate to the selected entity (step 2252). If a non-analyzed entity is superordinate to the selected entity, the system reverses the direction of the dependency (step 2254) and adjusts the cardinality between the selected entity and the non-analyzed entity (step 2256). The system performs this analysis for non-analyzed entities that are superordinate to the selected entity (step 2252). If the system determines that there are no non-analyzed entities superordinate to the selected entity, the system identifies the selected entity as analyzed (step 2258), and continues this analysis for entities that are subordinate to the leading object (step 2260). After the packages have been analyzed, the system substitutes the BusinessTransactionDocument (“BTD”) in the package template with the name of the interface (step 2262). This includes the “BTD” in the BTDItem package and the “BTD” in the BTDItemScheduleLine package.

6. Use of an Interface

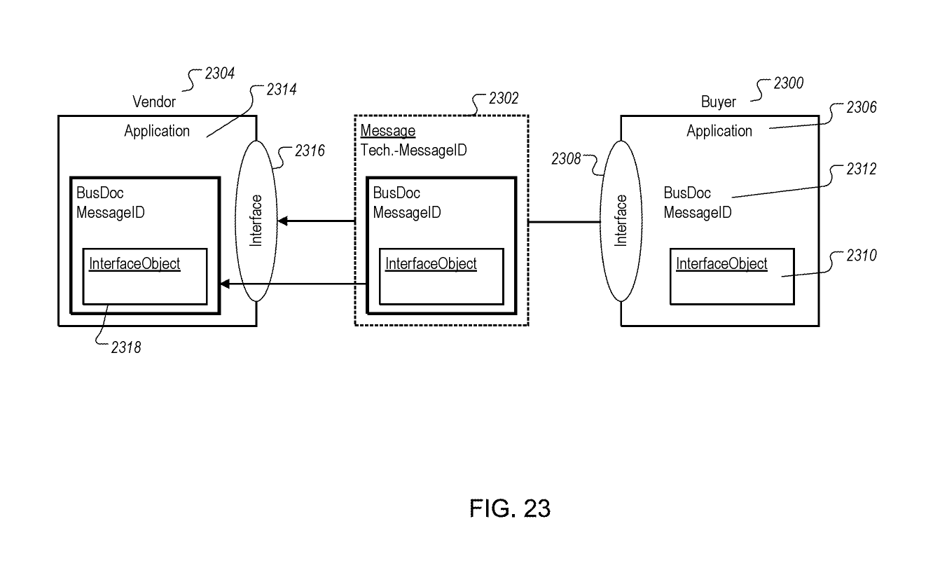

The XI stores the interfaces (as an interface type). At runtime, the sending party's program instantiates the interface to create a business document, and sends the business document in a message to the recipient. The messages are preferably defined using XML. In the example depicted in FIG. 23, the Buyer 2300 uses an application 2306 in its system to instantiate an interface 2308 and create an interface object or business document object 2310. The Buyer's application 2306 uses data that is in the sender's component-specific structure and fills the business document object 2310 with the data. The Buyer's application 2306 then adds message identification 2312 to the business document and places the business document into a message 2302. The Buyer's application 2306 sends the message 2302 to the Vendor 2304. The Vendor 2304 uses an application 2314 in its system to receive the message 2302 and store the business document into its own memory. The Vendor's application 2314 unpacks the message 2302 using the corresponding interface 2316 stored in its XI to obtain the relevant data from the interface object or business document object 2318.

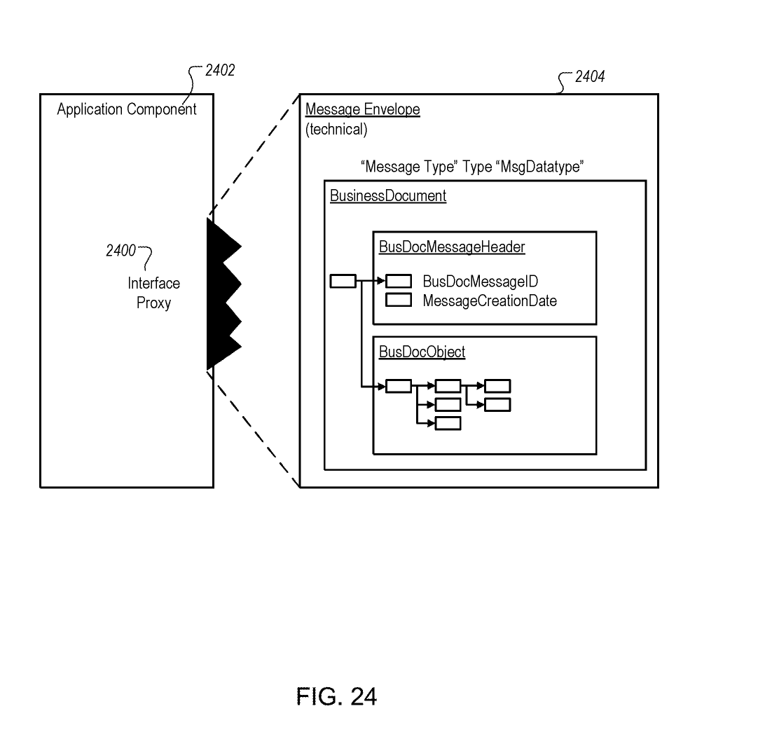

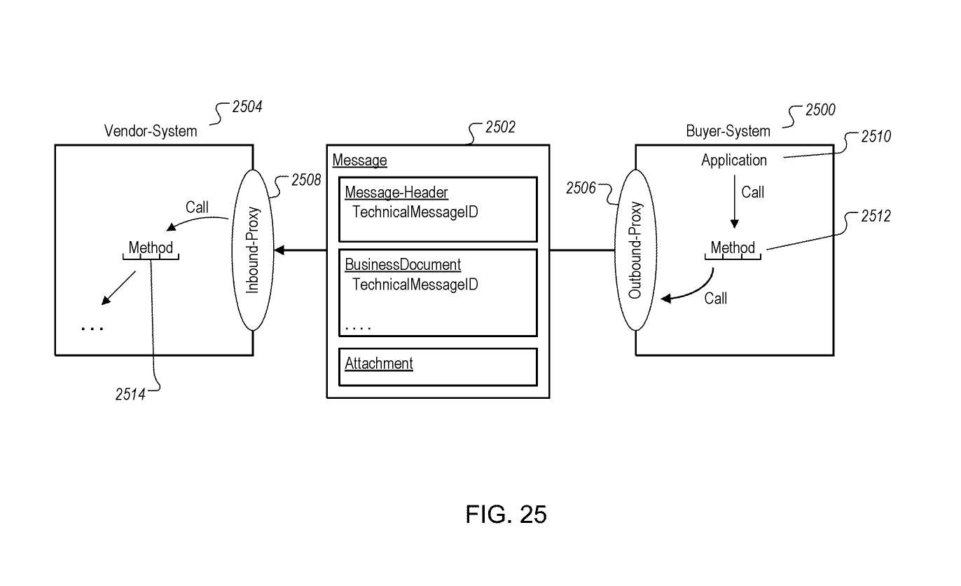

From the component's perspective, the interface is represented by an interface proxy 2400, as depicted in FIG. 24. The proxies 2400 shield the components 2402 of the sender and recipient from the technical details of sending messages 2404 via XI. In particular, as depicted in FIG. 25, at the sending end, the Buyer 2500 uses an application 2510 in its system to call an implemented method 2512, which generates the outbound proxy 2506. The outbound proxy 2506 parses the internal data structure of the components and converts them to the XML structure in accordance with the business document object. The outbound proxy 2506 packs the document into a message 2502. Transport, routing and mapping the XML message to the recipient 28304 is done by the routing system (XI, modeling environment 516, etc.).

When the message arrives, the recipient's inbound proxy 2508 calls its component-specific method 2514 for creating a document. The proxy 2508 at the receiving end downloads the data and converts the XML structure into the internal data structure of the recipient component 2504 for further processing.

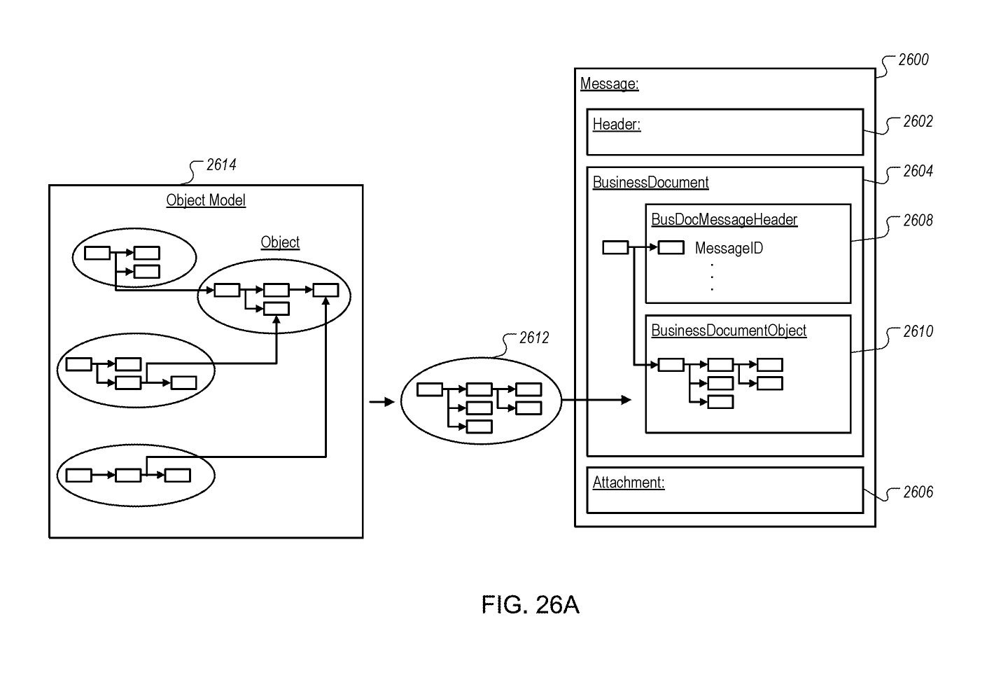

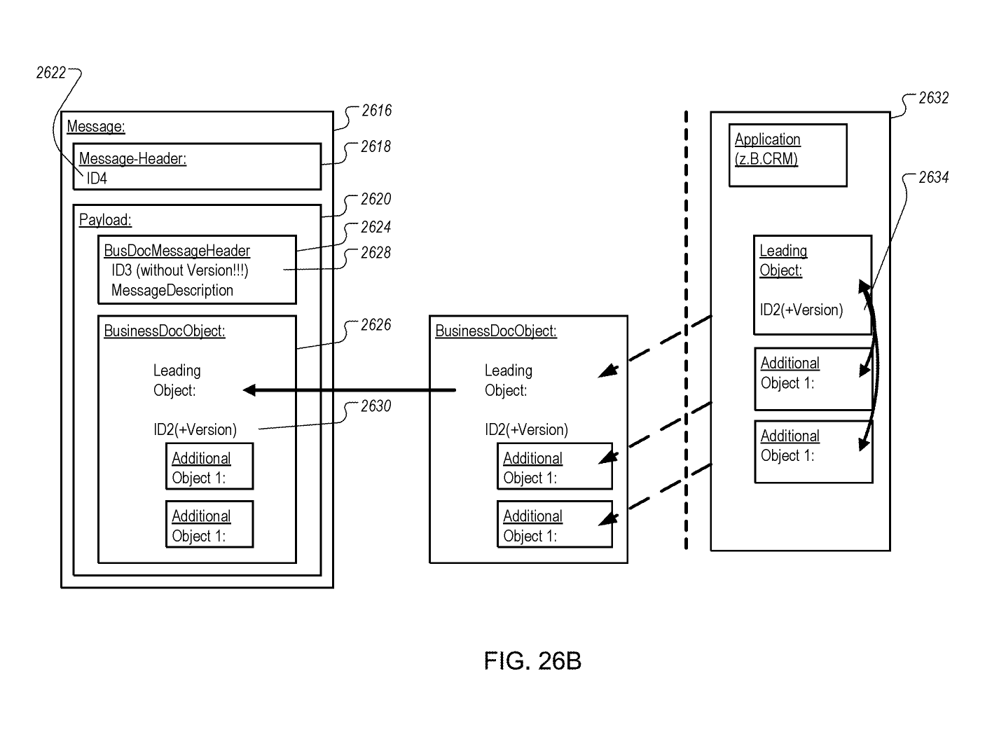

As depicted in FIG. 26A, a message 2600 includes a message header 2602 and a business document 2604. The message 2600 also may include an attachment 2606. For example, the sender may attach technical drawings, detailed specifications or pictures of a product to a purchase order for the product. The business document 2604 includes a business document message header 2608 and the business document object 2610. The business document message header 2608 includes administrative data, such as the message ID and a message description. As discussed above, the structure 2612 of the business document object 2610 is derived from the business object model 2614. Thus, there is a strong correlation between the structure of the business document object and the structure of the business object model. The business document object 2610 forms the core of the message 2600.

In collaborative processes as well as Q&A processes, messages should refer to documents from previous messages. A simple business document object ID or object ID is insufficient to identify individual messages uniquely because several versions of the same business document object can be sent during a transaction. A business document object ID with a version number also is insufficient because the same version of a business document object can be sent several times. Thus, messages require several identifiers during the course of a transaction.

As depicted in FIG. 26B, the message header 2618 in message 2616 includes a technical ID (“ID4”) 2622 that identifies the address for a computer to route the message. The sender's system manages the technical ID 2622.

The administrative information in the business document message header 2624 of the payload or business document 2620 includes a BusinessDocumentMessageID (“ID3”) 2628. The business entity or component 2632 of the business entity manages and sets the BusinessDocumentMessageID 2628. The business entity or component 2632 also can refer to other business documents using the BusinessDocumentMessageID 2628. The receiving component 2632 requires no knowledge regarding the structure of this ID. The BusinessDocumentMessageID 2628 is, as an ID, unique. Creation of a message refers to a point in time. No versioning is typically expressed by the ID. Besides the BusinessDocumentMessageID 2628, there also is a business document object ID 2630, which may include versions.

The component 2632 also adds its own component object ID 2634 when the business document object is stored in the component. The component object ID 2634 identifies the business document object when it is stored within the component. However, not all communication partners may be aware of the internal structure of the component object ID 2634. Some components also may include a versioning in their ID 2634.

7. Use of Interfaces Across Industries

Methods and systems consistent with the subject matter described herein provide interfaces that may be used across different business areas for different industries. Indeed, the interfaces derived using methods and systems consistent with the subject matter described herein may be mapped onto the interfaces of different industry standards. Unlike the interfaces provided by any given standard that do not include the interfaces required by other standards, methods and systems consistent with the subject matter described herein provide a set of consistent interfaces that correspond to the interfaces provided by different industry standards. Due to the different fields provided by each standard, the interface from one standard does not easily map onto another standard. By comparison, to map onto the different industry standards, the interfaces derived using methods and systems consistent with the subject matter described herein include most of the fields provided by the interfaces of different industry standards. Missing fields may easily be included into the business object model. Thus, by derivation, the interfaces can be extended consistently by these fields. Thus, methods and systems consistent with the subject matter described herein provide consistent interfaces or services that can be used across different industry standards.

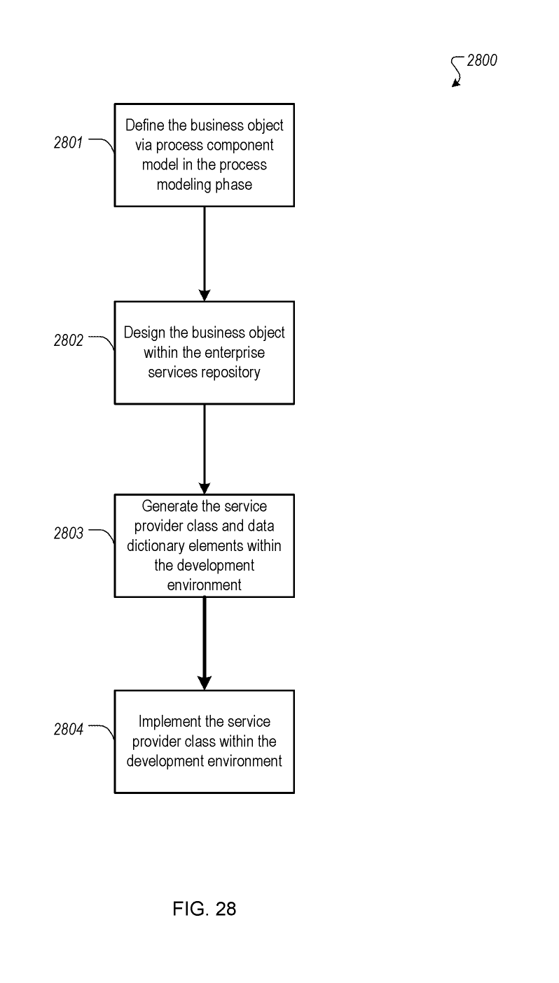

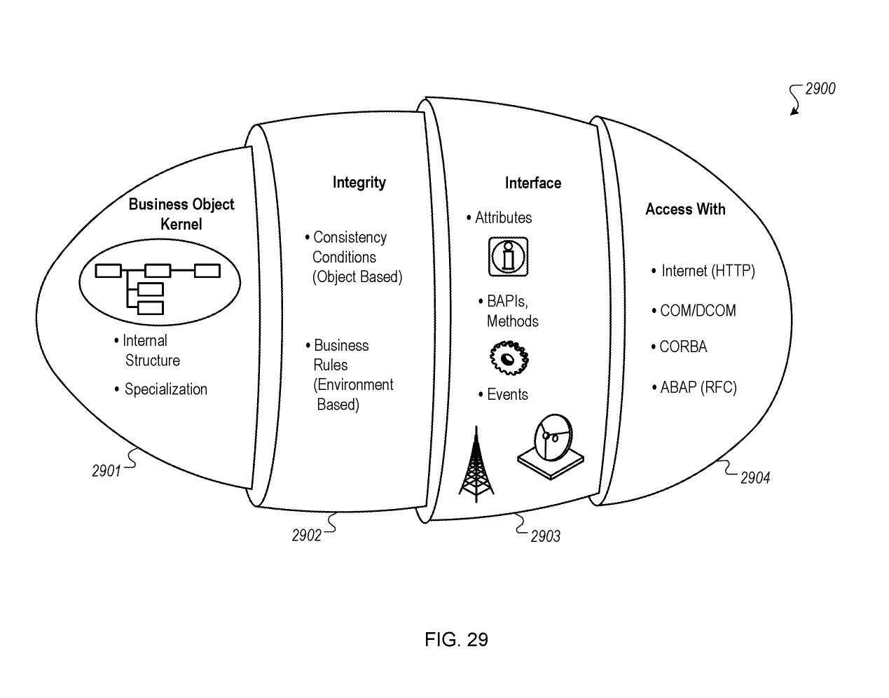

For example, FIG. 28 illustrates an example method 2800 for service enabling. In this example, the enterprise services infrastructure may offer one common and standard-based service infrastructure. Further, one central enterprise services repository may support uniform service definition, implementation and usage of services for user interface, and cross-application communication. In step 2801, a business object is defined via a process component model in a process modeling phase. Next, in step 2802, the business object is designed within an enterprise services repository. For example, FIG. 29 provides a graphical representation of one of the business objects 2900. As shown, an innermost layer or kernel 2901 of the business object may represent the business object's inherent data. Inherent data may include, for example, an employee's name, age, status, position, address, etc. A second layer 2902 may be considered the business object's logic. Thus, the layer 2902 includes the rules for consistently embedding the business object in a system environment as well as constraints defining values and domains applicable to the business object. For example, one such constraint may limit sale of an item only to a customer with whom a company has a business relationship. A third layer 2903 includes validation options for accessing the business object. For example, the third layer 2903 defines the business object's interface that may be interfaced by other business objects or applications. A fourth layer 2904 is the access layer that defines technologies that may externally access the business object.

Accordingly, the third layer 2903 separates the inherent data of the first layer 2901 and the technologies used to access the inherent data. As a result of the described structure, the business object reveals only an interface that includes a set of clearly defined methods. Thus, applications access the business object via those defined methods. An application wanting access to the business object and the data associated therewith usually includes the information or data to execute the clearly defined methods of the business object's interface. Such clearly defined methods of the business object's interface represent the business object's behavior. That is, when the methods are executed, the methods may change the business object's data. Therefore, an application may utilize any business object by providing the information or data without having any concern for the details related to the internal operation of the business object. Returning to method 2800, a service provider class and data dictionary elements are generated within a development environment at step 2803. In step 2804, the service provider class is implemented within the development environment.

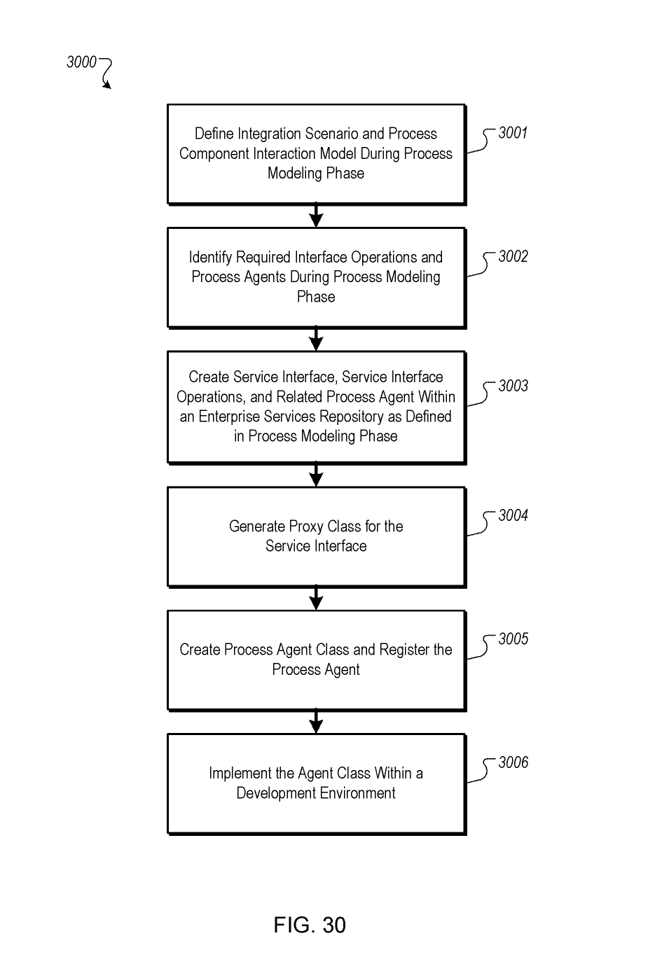

FIG. 30 illustrates an example method 3000 for a process agent framework. For example, the process agent framework may be the basic infrastructure to integrate business processes located in different deployment units. It may support a loose coupling of these processes by message based integration. A process agent may encapsulate the process integration logic and separate it from business logic of business objects. As shown in FIG. 30, an integration scenario and a process component interaction model are defined during a process modeling phase in step 3001. In step 3002, required interface operations and process agents are identified during the process modeling phase also. Next, in step 3003, a service interface, service interface operations, and the related process agent are created within an enterprise services repository as defined in the process modeling phase. In step 3004, a proxy class for the service interface is generated. Next, in step 3005, a process agent class is created and the process agent is registered. In step 3006, the agent class is implemented within a development environment.

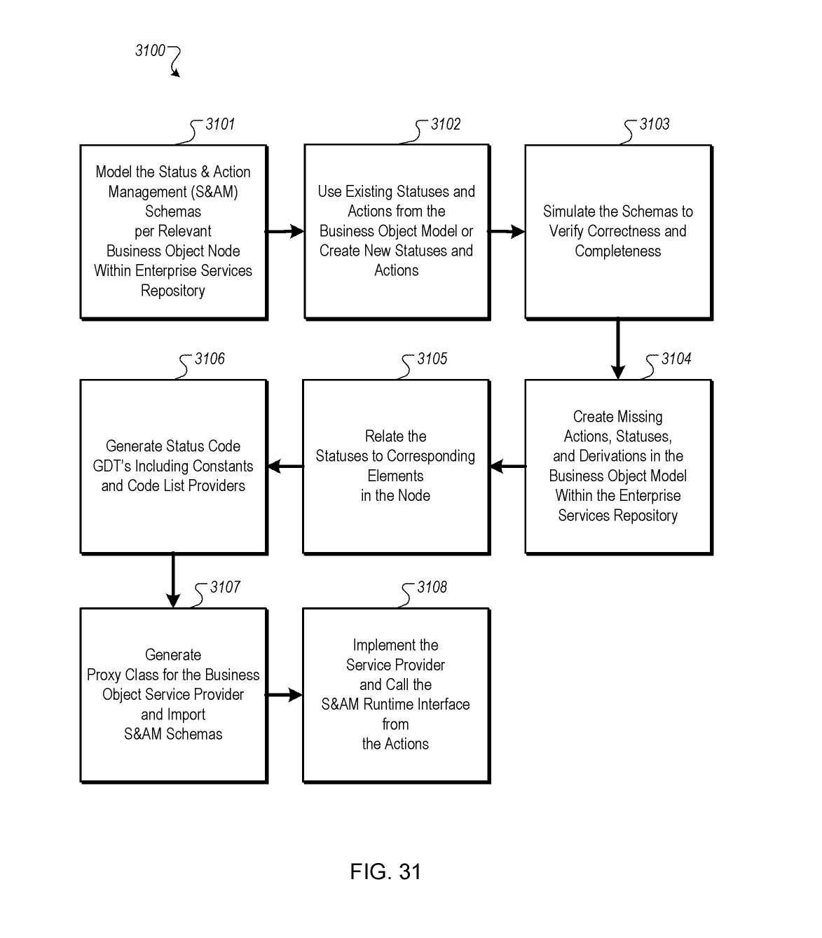

FIG. 31 illustrates an example method 3100 for status and action management (S&AM). For example, status and action management may describe the life cycle of a business object (node) by defining actions and statuses (as their result) of the business object (node), as well as, the constraints that the statuses put on the actions. In step 3101, the status and action management schemas are modeled per a relevant business object node within an enterprise services repository. In step 3102, existing statuses and actions from the business object model are used or new statuses and actions are created. Next, in step 3103, the schemas are simulated to verify correctness and completeness. In step 3104, missing actions, statuses, and derivations are created in the business object model with the enterprise services repository. Continuing with method 3100, the statuses are related to corresponding elements in the node in step 3105. In step 3106, status code GDT's are generated, including constants and code list providers. Next, in step 3107, a proxy class for a business object service provider is generated and the proxy class S&AM schemas are imported. In step 3108, the service provider is implemented and the status and action management runtime interface is called from the actions.

Regardless of the particular hardware or software architecture used, the disclosed systems or software are generally capable of implementing business objects and deriving (or otherwise utilizing) consistent interfaces that are suitable for use across industries, across businesses, and across different departments within a business in accordance with some or all of the following description. In short, system 100 contemplates using any appropriate combination and arrangement of logical elements to implement some or all of the described functionality.

Moreover, the preceding flowcharts and accompanying description illustrate example methods. The present services environment contemplates using or implementing any suitable technique for performing these and other tasks. It will be understood that these methods are for illustration purposes only and that the described or similar techniques may be performed at any appropriate time, including concurrently, individually, or in combination. In addition, many of the steps in these flowcharts may take place simultaneously and/or in different orders than as shown. Moreover, the services environment may use methods with additional steps, fewer steps, and/or different steps, so long as the methods remain appropriate.

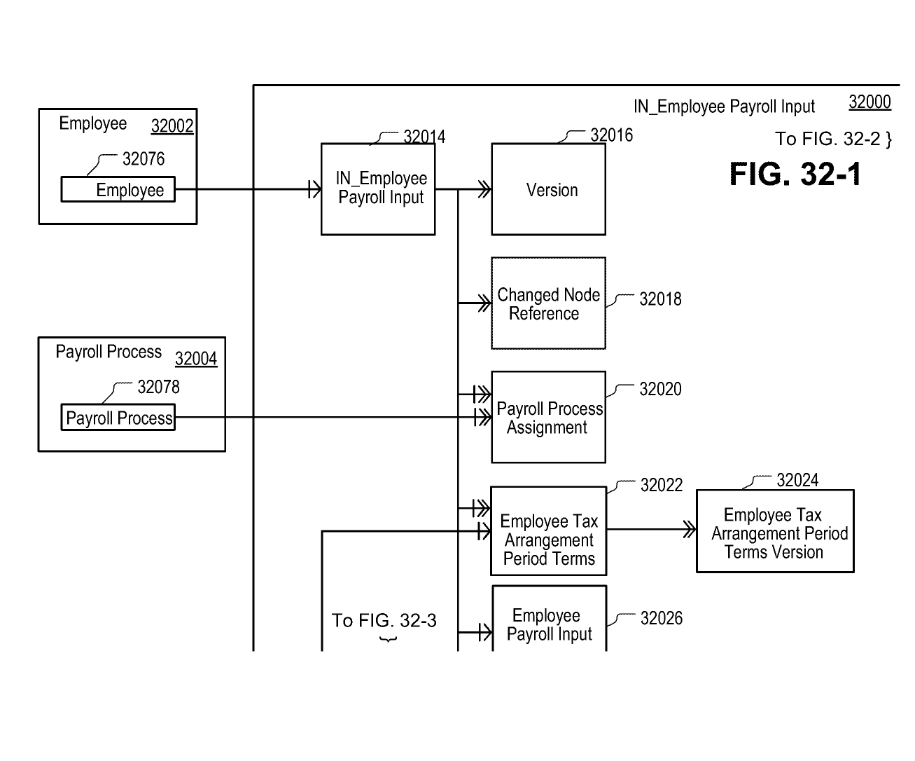

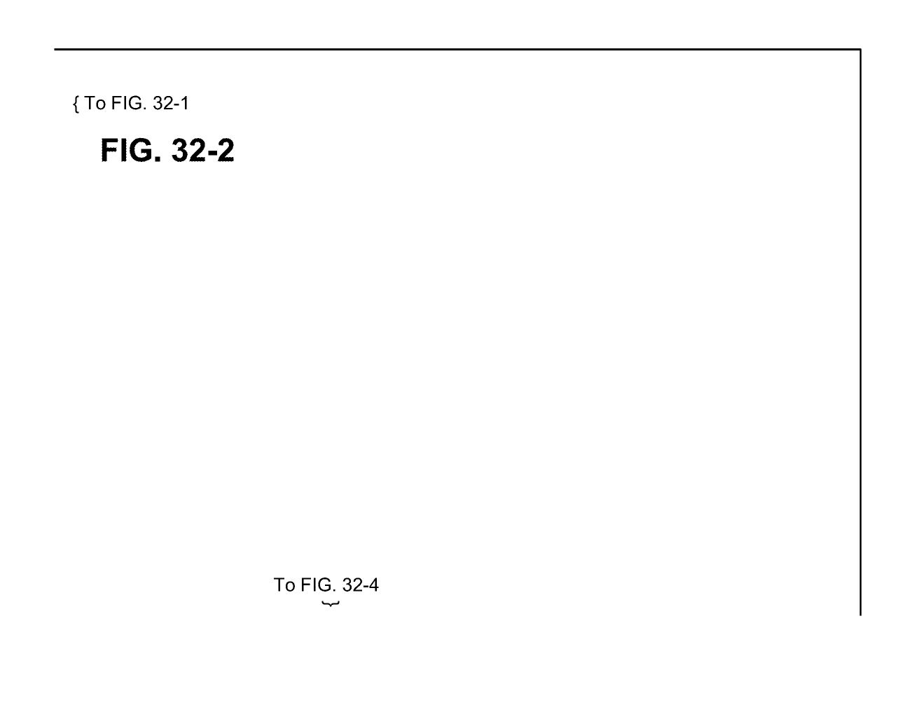

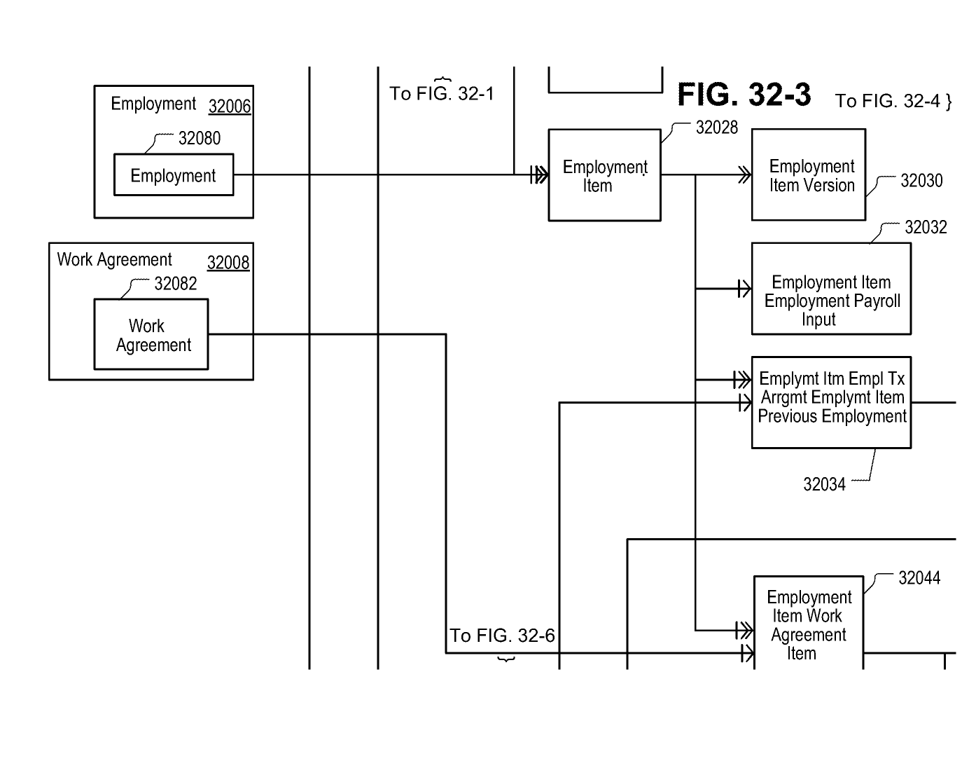

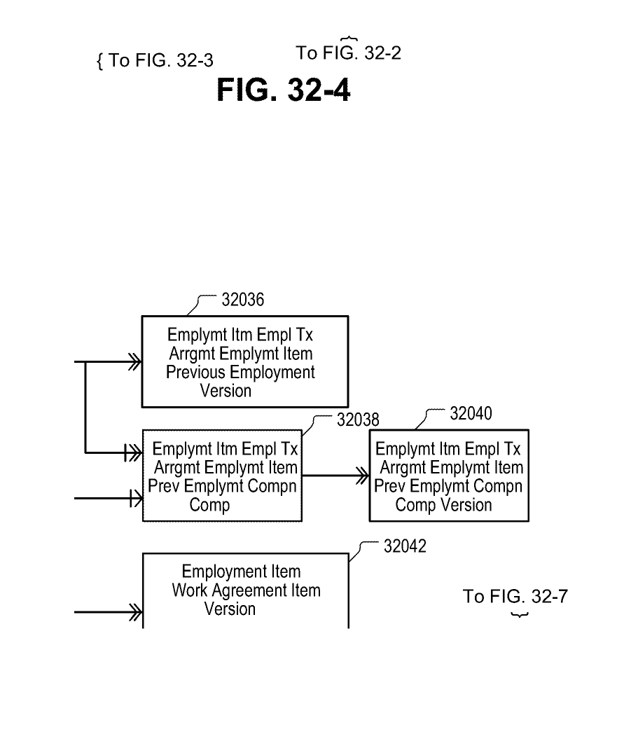

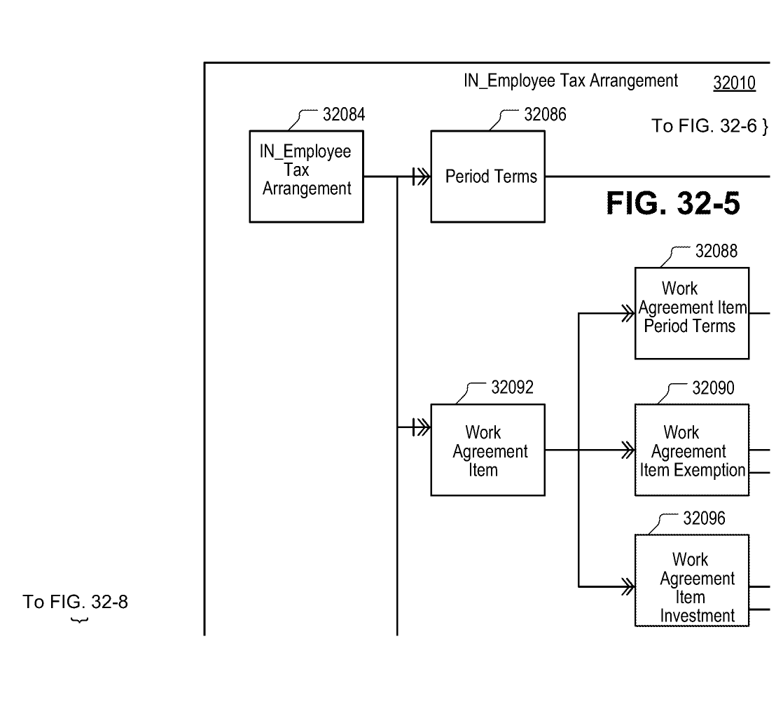

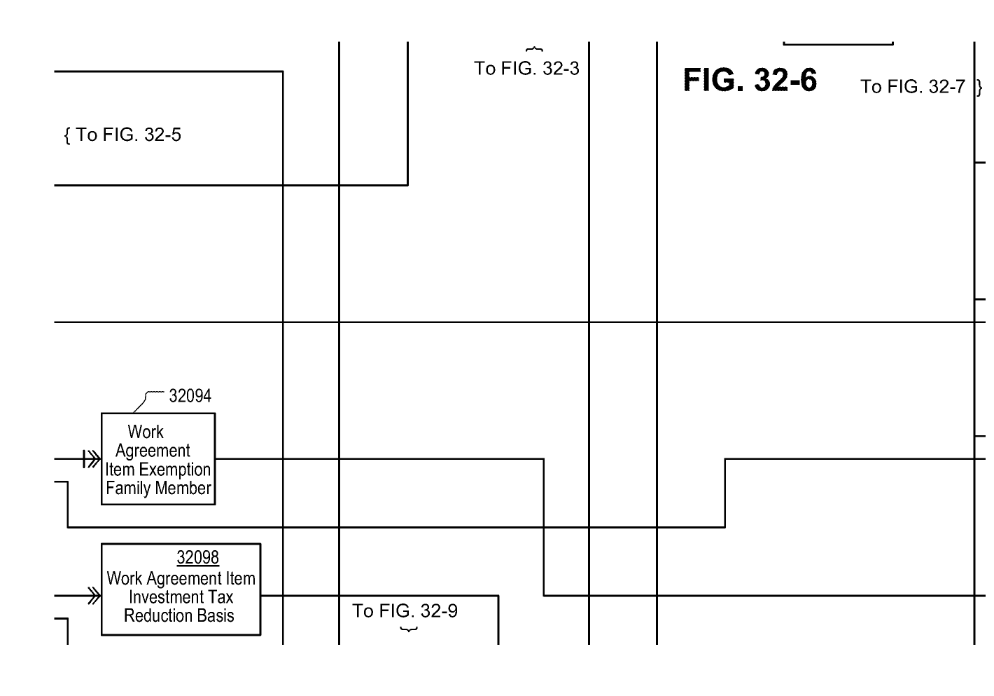

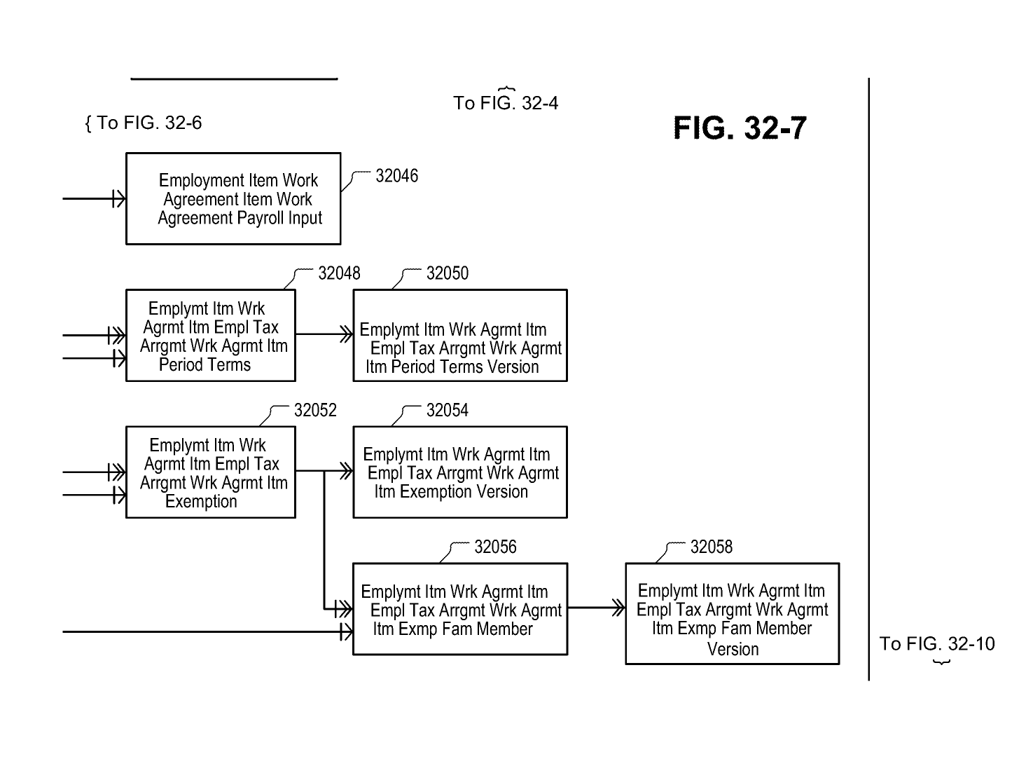

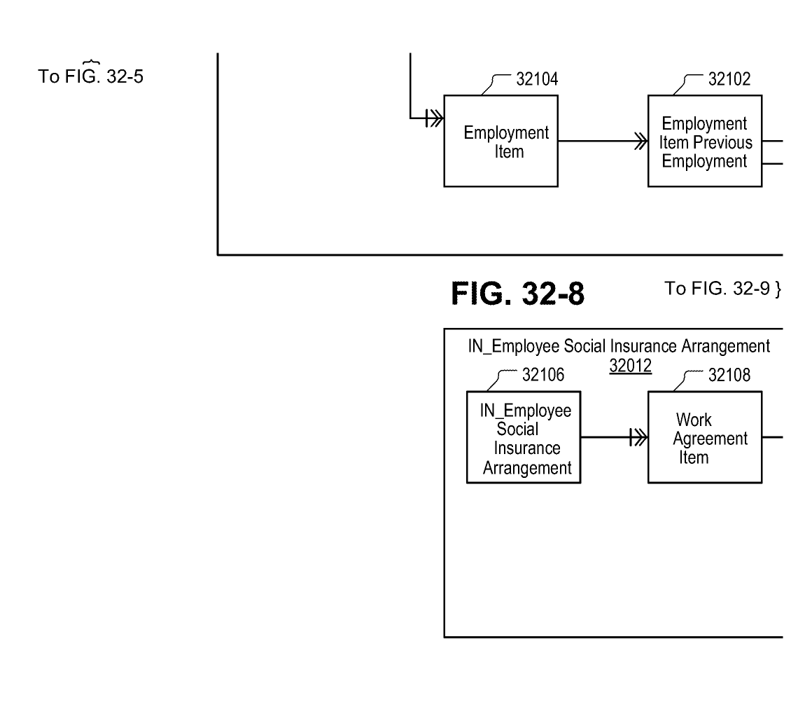

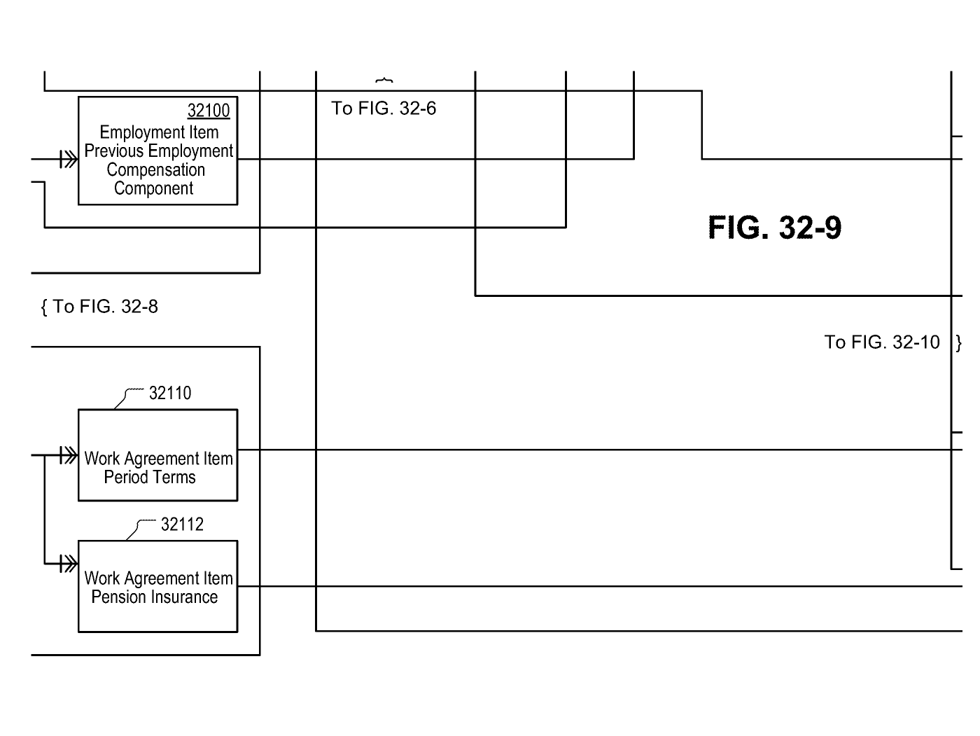

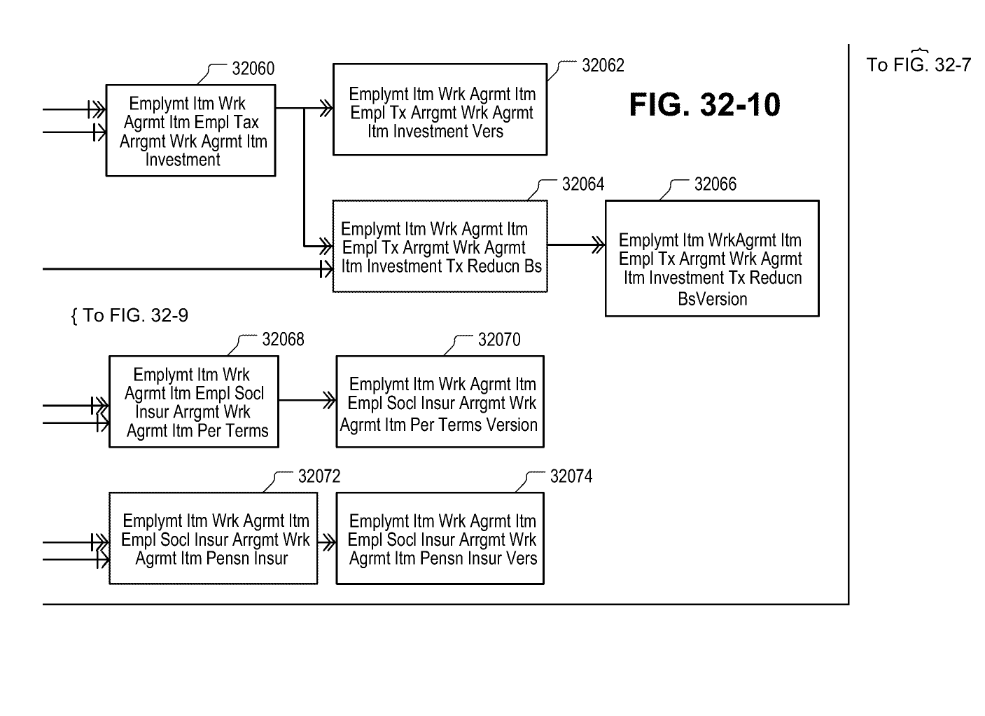

FIGS. 32-1 through 32-12 depict an example Business Object IN_Employee Payroll Input 32000. The object model 32000 has relationships with other objects 32002-32012, as shown with lines and arrows. The object model 32000 hierarchically comprises elements 32014-32074. The other objects 32002-32012 include respective elements 32076-32112 as shown.

The business object IN_Employee Payroll Input is a summary of employee specific input for Indian payroll for an employee. The business object IN_Employee Payroll Input belongs to the process component Payroll Processing. The payroll input for Indian payroll includes compensation information, reported employee working times, and legally required data (e.g., tax, social insurance information). The business object IN_Employee Payroll Input includes payroll relevant information related to employee(s), employment, work agreement(s), and Indian tax and social insurance. The business object IN_Employee Payroll Input is involved in the following process component interaction models: Compensation Management_Payroll Processing_Payroll Input Maintenance, Employee Payroll Administration_Payroll Processing_Payroll Input Maintenance, IN Employer Regulatory Compliance_Payroll Processing_Payroll Input Maintenance, Payroll Processing_Employee Payroll Administration_IN_ProviderDetails, Payroll Processing_Payroll Processing at Provider_IN Payroll Input Replication, and Time and Labour Management_Payroll Processing_Agreement. A service interface Employee Compensation Agreement in Payroll Input Maintenance In may have a technical name of PayrollProcessingEmployeeCompensationAgreementInPayrollInputMaintenanceIn. The Service Interface Employee Compensation Agreement in Payroll Input Maintenance In is part of the following Process Component Interaction Models: Compensation Management_Payroll Processing_Payroll Input Maintenance. The service interface PayrollProcessingEmployeeCompensationAgreementInPayrollInputMaintenanceIn is an interface to maintain Employee Compensation Agreement information in the Employee Payroll Input business object. The service interface PayrollProcessingEmployeeCompensationAgreementInPayrollInputMaintenanceIn may include a Maintain Employee Payroll Input based on Employee Compensation Agreement operation, which may have a technical name of

PayrollProcessingEmployeeCompensationAgreementInPayrollInputMaintenanceIn.MaintainBasedOnCompensationAgreement, may be used to maintain information on an Employee's Compensation Agreement in the Employee Payroll Input business object, and may be based on message type Employee Compensation Agreement Payroll Notification (derived from business object Employee Compensation Agreement).

A service interface Employee Payroll Agreement in Payroll Input Maintenance In may have a technical name of PayrollProcessingEmployeePayrollAgreementInPayrollInputMaintenanceIn. The service interface Employee Payroll Agreement in Payroll Input Maintenance In is part of the following Process Component Interaction Models: Employee Payroll Administration_Payroll Processing_Payroll Input Maintenance. The service interface PayrollProcessingEmployeePayrollAgreementInPayrollInputMaintenanceIn is an interface to maintain Employee Payroll Agreement information in the Employee Payroll Input business object. The service interface PayrollProcessingEmployeePayrollAgreementInPayrollInputMaintenanceIn may include a Maintain Employee Payroll Input based on Employee Payroll Agreement operation, which may have a technical name of PayrollProcessingEmployeePayrollAgreementInPayrollInputMaintenanceIn. MaintainBasedOnEmployeePayrollAgreement, may be used to maintain the business objects named with a pattern of “XX_EmployeePayrollInput” based on changes made to business object EmployeePayrollAgreement, where “XX” represents the country in which the employee is employed. The PayrollProcessingEmployeePayrollAgreementInPayrollInputMaintenanceIn. MaintainBasedOnEmployeePayrollAgreement operation may be based on message type Employee Payroll Agreement Payroll Notification (derived from business object Employee Payroll Agreement).

A service interface IN Employer Regulatory Compliance in Payroll Input Maintenance In may have a technical name of

PayrollProcessingINEmployerRegulatoryComplianceInPayrollInputMaintenanceIn. The Service Interface IN Employer Regulatory Compliance in Payroll Input Maintenance In is part of the following Process Component Interaction Models: IN Employer Regulatory Compliance_Payroll Processing_Payroll Input Maintenance. The service interface PayrollProcessingINEmployerRegulatoryComplianceInPayrollInputMaintenanceIn may include a Maintain IN_Employee Payroll Input based on Tax Arrangement operation, which may have a technical name of PayrollProcessingINEmployerRegulatoryComplianceInPayrollInputMaintenanceIn. MaintainBasedOnEmployeeTaxArrangement, may be used to maintain information on an employee's IN tax arrangement in the IN_Employee Payroll Input business object, and may be based on message type IN_Employee Tax Arrangement Payroll Notification (derived from business object IN_Employee Tax Arrangement). The service interface PayrollProcessingINEmployerRegulatoryComplianceInPayrollInputMaintenanceIn may include a Maintain IN_Employee Payroll Input based on Social Insurance Arrangement operation, which may have a technical name of PayrollProcessingINEmployerRegulatoryComplianceInPayrollInputMaintenanceIn. MaintainBasedOnEmployeeSocialInsuranceArmnt, may be used to maintain information on an employee's IN social insurance arrangement in the IN_Employee Payroll Input business object, and may be based on based on message type IN_Employee Social Insurance Arrangement Payroll Notification (derived from business object IN_Employee Social Insurance Arrangement).

A service interface IN_Employee Payroll Input Replication In may have a technical name of PayrollProcessingIN_EmployeePayrollInputReplicationIn. The service interface IN_Employee Payroll Input Replication In is part of the following Process Component Interaction Models Payroll Processing_Payroll Processing at Provider_IN Payroll Input Replication. The service interface PayrollProcessingIN_EmployeePayrollInputReplicationIn is an interface to maintain the replication and status of the IN_Employee Payroll Input business object. The service interface PayrollProcessingIN_EmployeePayrollInputReplicationIn may include a Maintain IN_Employee Payroll Input Status operation, which may have a technical name of PayrollProcessingIN_EmployeePayrollInputReplicationIn. MaintainIN_EmployeePayrollInputStatus, may be used to maintain information on the status of the IN_Employee Payroll Input business object, and may be based on message type Employee Payroll Input Replication Confirmation (derived from business object DE_Employee Payroll Input).

A service interface IN_Employee Payroll Input Replication Out may have a technical name of

PayrollProcessingIN_EmployeePayrollInputReplicationOut. The Service Interface IN_Employee Payroll Input Replication Out is part of the following Process Component Interaction Models: Payroll Processing_Payroll Processing at Provider_IN Payroll Input Replication. The service interface PayrollProcessingIN_EmployeePayrollInputReplicationOut groups the operations that maintain the replication and status of the IN_Employee Payroll Input business object. The service interface PayrollProcessingIN_EmployeePayrollInputReplicationOut may include a Request IN_Employee Payroll Input Replication operation, which may have a technical name of PayrollProcessingIN_EmployeePayrollInputReplicationOut. RequestIN_EmployeePayrollInputReplication, may be used to request replication of the IN_Employee Payroll Input business object to the payroll provider. and may be based on message type IN_Employee Payroll Input Replication Request (derived from business object IN_Employee Payroll Input).

A service interface Employee Time Agreement in Payroll Input Maintenance In may have a technical name of PayrollProcessingEmployeeTimeAgreementInPayrollInputMaintenanceIn. The service interface Employee Time Agreement in Payroll Input Maintenance In is part of the following Process Component Interaction Models: Time and Labour Management_Payroll Processing_Agreement. The service interface PayrollProcessingEmployeeTimeAgreementInPayrollInputMaintenanceIn is an interface to maintain Employee Time Agreement (e.g., planned working time) information in the Employee Payroll Input business object. The service interface PayrollProcessingEmployeeTimeAgreementInPayrollInputMaintenanceIn may include a Maintain Employee Payroll Input based on Planned Working Times operation, which may have a technical name of PayrollProcessingEmployeeTimeAgreementInPayrollInputMaintenanceIn. MaintainEmployeePayrollInputBasedOnPlannedWorkingTimes, which may be used to maintain business objects named with a pattern of “XX_EmployeePayrollInput” based on changes to the business object EmployeeTimeAgreement, where “XX” represents the country in which the employee is employed. The PayrollProcessingEmployeeTimeAgreementInPayrollInputMaintenanceIn. MaintainEmployeePayrollInputBasedOnPlannedWorkingTimes operation is based on message type Employee Time Agreement Planned Working Times Payroll Notification (derived from business object Employee Time Agreement).

The business object IN_Employee Payroll Input may include an IN_Employee Payroll Input root node, which may include a summary of employee-specific input for Indian payroll for an employee. An IN_Employee Payroll Input includes an accumulation of information for one employee that is used for the successful running of payroll. The IN_Employee Payroll Input business object also keeps a history of what was last sent and what needs to be sent on the next transfer of data to the payroll provider, thus ensuring accurate and synchronized record keeping of employee data in payroll provider systems. Information may be copied from original information in the business objects Employee, Employment, Work Agreement, Employee Payroll Agreement, Employee Time Agreement, Employee Time, Employee Compenstion Agreement, IN_Employee Social Insurance Arrangement, and IN_Employee Tax Arrangement (these business objects may be referred to as “primary” business objects). The data from IN_Employee Social Insurance Arrangement may be included in IN_Employee Payroll Input directly while other data may be included in dependent objects. The data in the IN_Employee Payroll Input object may never be created or modified directly; rather, it may be maintained in synchronisation processes by inbound agents or a master data change interface. The business object IN_Employee Payroll Input includes administrative information and a versioning mechanism. The version mechanism works as follows: 1) The structure of IN_Employee Social Insurance Arrangement corresponds to that of the primary business objects; 2) A business object node <NodeName> in a primary object has a corresponding business object node <NodeName> in IN_Employee Payroll Input; 3) The corresponding business object node in IN_Employee Payroll Input has a subnode <NodeName> Version which contains versions of actual data copied from the primary business object; and 4) The node <NodeName> holds administrative data as well as associations to three distinct versions, namely NewVersion, ToBeReplicatedVersion, and LastSuccesfullyReplicatedVersion.

The elements located at the node IN_Employee Payroll Input are defined by the data type: IN_EmployeePayrollInputElements, and may include UUID, EmployeeUUID, Status, and EmployeePayrollInputVersionReferences. UUID may be an alternative key, is a universally unique identifier that identifies an IN_Employment Payroll Input, and may be based on datatype GDT: UUID. EmployeeUUID may be an alternative key, is a universally unique identifier of an employee for whom the IN_EmployeePayroll Input is valid, and may be based on datatype GDT: UUID. Status may be optional, and defines a current status in a lifecycle of IN_EmployeePayrollInput. IN_EmployeePayrollInputStatus may include ToBeReplicatedVersionsUpToDatenessStatusCode, ToBeReplicatedVersionsConsistencyStatusCode, ReplicationUpdateStatusCode, and DataSynchronizationUpdateStatusCode. ToBeReplicatedVersionsUpToDatenessStatusCode is a status variable that identifies the status of ToBeReplicated data of the business object, and may be based on datatype GDT: UPTODATEOUTOFDATE_UpToDatenessStatusCode, with a qualifier of Versions. ToBeReplicatedVersionsConsistencyStatusCode is a status variable that identifies the consistency of ToBeReplicated data of the business object, and may be based on datatype GDT: ConsistencyStatusCode with a Qualifier of Versions. ReplicationUpdateStatusCode is a status variable that identifies the status of the replication of data to the Payroll Provider, and may be based on datatype GDT: UpdateStatusCode, with a qualifier of Replication. DataSynchronizationUpdateStatusCode is a coded representation of the status of a data synchronization update, and may be based on datatype GDT: UpdateStatusCode, with a qualifier of Synchronization. EmployeePayrollInputVersionReferences include references to a version of the node. EmployeePayrollInputVersionReferences may include ObjectID, ToBeReplicatedVersionDeletedIndicator, ToBeReplicatedVersionValidityPeriod, ToBeReplicatedVersionUUID, NewVersionUUID, and LastSuccessfullyReplicatedVersionUUID. ObjectID may be optional, is an identifier of a node in an object, and may be based on datatype GDT: ObjectID. ObjectID may be a primary object node ID if there is one node from where the information comes in one of the primary objectIDs. If the node is a derived node and a primary node does not exist, ObjectID may include a generated ID. ToBeReplicatedVersionDeletedIndicator is an indicator that a primary node for a version that is about to be replicated to a provider or has already been replicated to a provider but not yet confirmed as successful has been deleted on a primary object. ToBeReplicatedVersionDeletedIndicator may be based on datatype GDT: Indicator, with a qualifier of Deleted. ToBeReplicatedVersionValidityPeriod may be optional, and is a validity period of a version that is about to be replicated to a provider or has already been replicated to a provider but not yet confirmed as successful. ToBeReplicatedVersionValidityPeriod may be based on datatype GDT: CLOSED_DatePeriod, with a qualifier of Validity. ToBeReplicatedVersionUUID may be optional, and is a universally unique identifier for a version that is about to be replicated to a provider or has already been replicated to a provider but not yet confirmed as successful. The identifier is created or adjusted when a payroll administrator decides to start replication to the provider. ToBeReplicatedVersionUUID may be based on datatype GDT: UUID. NewVersionUUID is a universally unique identifier for a version that reflects the latest changes of a primary object, and may be based on datatype GDT: UUID. LastSuccessfullyreplicatedVersionUUID may be optional, and is a universally unique identifier for a version last replicated to a provider where the provider has confirmed that the replication was successful. The identifier is created or adjusted when the provider confirms successful replication of the data. LastSuccessfullyreplicatedVersionUUID may be based on datatype GDT: UUID.

The following composition relationships to subordinate nodes may exist: Version, with a cardinality of 1:N; Changed Node Reference, with a cardinality of 1:N; Payroll Process Assignment, with a cardinality of 1:CN; Employee Tax Arrangement Period Terms, with a cardinality of 1:CN; Employee Payroll Input, with a cardinality of 1:C; and Employment Item, with a cardinality of 1:CN. From the business object Employee/node Employee, an inbound aggregation relationship may exist, with a cardinality of 1:C, for an employee for whom the IN_Employee Payroll Input is valid. To business object IN_EmployeePayrollInput/Version, specialization associations for navigation may exist, including LastSuccessfullyReplicatedVersion, NewVersion, and ToBeReplicatedVersion. LastSuccessfullyReplicatedVersion, with a target cardinality of C, may be associated with a version last replicated to a provider where the provider has confirmed that the replication was successful. The association LastSuccessfullyReplicatedVersion is created or adjusted when the provider confirms successful replication of the data. NewVersion, with a target cardinality of C, may be associated with a version that reflects the latest changes of a primary object. ToBeReplicatedVersion, with a target cardinality of C, may be associated with a version that is about to be replicated to a provider or has already been replicated to the provider but not yet been confirmed as a successful replication. The association ToBeReplicatedVersion is created or adjusted when a payroll administrator decides to start replication to the provider. To business object Payroll Process/Employee, a specialization association for navigation PayrollProcessEmployee may exist, with a target cardinality of CN. The association may be associated with a payroll process employee for an employee payroll input, identifying a payroll process which is currently processing an input object.

Enterprise Service Infrastructure actions include Generate To Be Replicated Versions, Check To Be Replicated Versions Consistency, Replicate, Notify Of Replication Success, Clean Up, Notify Of Replication Failure, Notify Of Change, Notify Of To Be Replicated Version Update, Notify Of Replication Confirmation, Notify Of To Be Replicated Versions Out Of Dateness, Reconcile, Synchronize Data, Notify Of Data Synchronization Success, and Notify Of Data Synchronization Failure. The Generate To Be Replicated Versions action controls a process that creates a ToBeReplicatedVersion. A precondition of Generate To Be Replicated Versions may be that the ReplicationUpdateStatusCode does not have the value “in process”. The action Generate To Be Replicated Versions can call methods on business objects to derive data, can call DeriveData actions, and can call action NotifyOfToBeReplicatedVersionUpdate. The action Generate To Be Replicated Versions can set the status of ToBeReplicatedVersionsUpToDatenessStatusCode to “Up-to-Date”. The action Generate To Be Replicated Versions may be defined by the data type IN_EmployeePayrollInputGenerateToBeReplicatedVersionsActionElements, and may include the element PayrollProcessID. PayrollProcessID is an ID of a Payroll Process, and may be based on datatype GDT: BusinessTransactionDocumentID. The action Generate To Be Replicated Versions may be triggered from PayrollProcess. The Check To Be Replicated Versions Consistency action carries out a completeness check for Tax and Social Insurance data. A precondition of Check To Be Replicated Versions Consistency may be that ToBeReplicatedConsistencyStatusCode is set to “inconsistent” or “check pending”. If data is inconsistent or consistent the value of ToBeReplicatedConsistencyStatusCode may be set to “Inconsistent” or “Consistent” respectively. The action Check To Be Replicated Versions Consistency may be triggered by the user from the payroll process, to check if the data that will be sent to the Payroll Provider is consistent from a business perspective. The Replicate action sends data to a Payroll Provider. A preconditions of Replicate may be that ToBeReplicatedVersionsConsistencyStatusCode does not have the value “check pending”. Changes to the status: The action Replicate can set the status of ReplicationUpdateStatusCode to “in process”. The action Replicate may be triggered by the PayrollProcess. The Notify Of Replication Success action calls relevant actions when replication of data to the Payroll Provider was successful. The action Notify Of Replication Success can call NotifyOfReplicationConfirmation and CleanUp, and can call NotifyOfReplicationSuccess on the PayrollProcess. The action Notify Of Replication Success can set the status of ReplicationUpdate to “successful”. The Clean Up action cleans up the business object of data relevant during the replication of data to the Payroll Provider. NotifyOfReplicationResult may call the action Clean Up. Changes to the business object may include the deletion of subnodes associated with PayrollProcessAssignment. The Notify Of Replication Failure action calls relevant actions when replication of data to the Payroll Provider failed. NotifyOfReplicatiionResult may call the action Notify Of Replication Failure. NotifyOfReplicationFailure can be called on the PayrollProcess. Status changes include setting ReplicationUpdate to “failed”. The Notify Of Change action updates ChangeNodeReference when changes to nodes in the object occur. The Notify Of Change action may be configured such that a user cannot call it. Upon changes to the object, a new ChangeNodeReference node is created. The elements ObjectNodeReference and ParentObjectNodeReference are filled with the NewVersionUUID and its parent node UUID (when not a root node) respectively. ActionCode is set according to the information in the message ActionCode. ToBeReplicatedInformationOutdatedIndicator is set to “true”. ReplicationRequiredIndicator is set to “false”. The Notify Of Change action elements are defined by the data type: IN_EmployeePayrollInputNotifyOfChangeActionElements, and may include ObjectNodeReference, OriginalObjectNodeReference, ValidityPeriod, and ActionCode. ObjectNodeReference locates a particular node within the business object, and may be based on datatype GDT: ObjectNodeReference. ObjectNodeReference includes the VersionIUUID from the node, and the ObjectID form the VersionReferences in its parent node. OriginalObjectNodeReference may be optional, defines the original node from which a changed node reference is created, and may be based on datatype GDT: ObjectNodeReference, with a qualifier of Original. ValidityPeriod may be optional and may be based on datatype GDT: CLOSED_DatePeriod with a qualifier of Validity. ActionCode is a coded representation of an instruction to a recipient of a message telling it how to process a transmitted element, and may be based on datatype GDT: ActionCode. The service ModifyNewVersion may call the Notify Of Change action, whenever it is called by inbound agents for Employee, Employment or WorkAgreement. The Notify Of To Be Replicated Version Update action updates ChangeNodeReference when the ToBeReplicatedVersion is up to date in preparation for sending data to the provider. The Notify Of To Be Replicated Version Update action may be configured such that a user cannot call it. Upon changes to the object, ToBeReplicatedInformationOutdatedIndicator is set to “false”, and ReplicationRequiredIndicator is set to “true”. The action elements are defined by the data type: IN_EmployeePayrollInputNotifyOfToBeReplicatedVersionUpdateActionElements, and may include ObjectNodeReference, ParentObjectNodeReference, and ActionCode. ObjectNodeReference locates a particular node within the business object, and may be based on datatype GDT: ObjectNodeReference. ObjectNodeReference includes the VersionIUUID from the node, and the ObjectID form the VersionReferences in its parent node. ParentObjectNodeReference may be optional, is the parent of the ObjectNodeReference, and may be based on datatype GDT: ObjectNodeReference with a qualifier of Parent. ParentObjectNodeReference is the parent of the VersionIUUID and the ObjectID form the VersionReferences in that parent's parent node. ActionCode is a coded representation of an instruction to the recipient of a message telling it how to process a transmitted element, and may be based on datatype GDT: ActionCode. The action GenerateToBeReplicatedVersion calls the Notify Of To Be Replicated Version Update action. The Notify Of Replication Confirmation action updates ChangeNodeReference when replication was successful. The Notify Of Replication Confirmation action may be configured such that a user cannot call it. Upon changes to the object, ToBeReplicatedInformationOutdatedIndicator is set to “false”, and ReplicationRequiredIndicator is set to “false”. The action elements are defined by the data type: IN_EmployeePayrollInputNotifyOfReplicationConfirmationActionElements, and may include ObjectNodeReference, ParentObjectNodeReference, and ActionCode. ObjectNodeReference locates a particular node within the business object, and may be based on datatype GDT: ObjectNodeReference. ObjectNodeReference includes the VersionIUUID from the node, and the ObjectID form the VersionReferences in its parent node. ParentObjectNodeReference may be optional, is the parent of the ObjectNodeReference, and may be based on datatype GDT: ObjectNodeReference with a qualifier of Parent. ParentObjectNodeReference is the parent of the VersionIUUID, and the ObjectID form the VersionReferences in that parent's parent node. ActionCode is a coded representation of an instruction to the recipient of a message telling it how to process a transmitted element, and may be based on datatype GDT: ActionCode. The Notify Of Replication Confirmation action is called by action NotifyOfReplicationResult when payroll provider has reported a successful replication of data in provider system. The Notify Of To Be Replicated Versions Out Of Dateness action updates ToBeReplicatedVersionsUpToDatenessStatusCode when changes to nodes in the object occur. Status changes may include setting the ToBeReplicatedVersionsUpToDatenessStatusCode to “Out-of-Date”. The Reconcile action reconciles the data in the object with the primary objects. This action may instigate changes to the object, for example, by triggering the service ModifyNewVersion. The action elements are defined by the data type: IN_EmployeePayrollInputReconcileActionElements. These elements may include EmployeeUUID and EmployeeID. EmployeeUUID is a universally unique identifier of an Employee to whom the IN_EmployeePayrollInput applies. EmployeeUUID may be optional and may be based on datatype GDT: UUID. EmployeeID is the ID of an assigned employee. EmployeeID may be optional and may be based on datatype GDT: EmployeeID. An EmployeeID element is stored on the Employee projection of the BusinessPartner business object, in the node Identification, in the element EmployeeID. The user may call the Reconcile action if data in the business object is inconsistent. This may occur, for example, when the action CheckToBeReplicatedConsistency has returned errors, or errors have been detected manually by the user. The action triggers the generation of NewVersions so that data in a business object reflects what is stored in the primary objects. The Extract To Payroll Process Attachment action extracts data to a file and puts it in an Attachment Folder of a relevant Payroll Process. The Extract To Payroll Process Attachment action creates a file ready to be sent to a Payroll Provider, and may be used for a Payroll Provider with file based communication. The action elements are defined by the data type: IN_EmployeePayrollInputExtractToPayrollProcessAttachmentActionElements, and may include PayrollProcessID. PayrollProcessID may be based on datatype GDT: BusinessTransactionDocumentID. The Synchronize Data action is triggered by PayrolSetupExecutionRun. The Synchronize Data action picks up for version nodes associated with the LastSucessfullyReplicatedVersion, formulates these into a message and sends it to a payroll provider. Changes to other objects include updating a corresponding Employee node on a PayrolProcess business object. Status changes include changing DataSynchronizationUpdateStatusCode from “Not Started” to “In Process”. The Notify Of Data Synchronization Success action is triggered by an Inbound Process Agent when a successful confirmation message arrives from a provider for an employee. Changes to other objects include updating a corresponding Employee node on a PayrolProcess business object. Status changes include changing DataSynchronizationUpdateStatusCode from “In Process” to “Successful”. The Notify Of Data Synchronization Failure action is triggered by an Inbound Process Agent or by an administration report, whenever a failed confirmation of data synchronization is received from a provider for an employee. Changes to other objects include updating a corresponding Employee node on a PayrolProcess business object. Status changes include changing DataSynchronizationUpdateStatusCode from “In Process” to “Failed”. The business object IN_Employee Payroll Input includes a Select All query that provides the NodeIDs of instances of a node. Such a query may be used to enable an initial load of data for a fast search infrastructure.

The node Version represents a version of the root node. Versions may be created to make comparisons of data over a period of time. The elements located at the node Version are defined by the data type: IN_EmployeePayrollInputVersionElements, and may include UUID, LastChangeDateTime, and DeletedIndicator. UUID is a universally unique identifier that identifies a Version node, and may be based on datatype GDT: UUID. LastChangeDateTime is a date and time stamp of the last change, and may be based on datatype GDT: GLOBAL_DateTime with a qualifier of LastChange. DeletedIndicator is an indicator that a node has been deleted, and may be based on datatype GDT: Indicator, with a qualifier of Deleted.

The Changed Node Reference is a reference to a changed node. The Changed Node Reference may be dependent on a Validity Period. The Changed Node Reference includes information about the changes that have taken place in a node that is versioned, and allows quick access of changed nodes. The elements located at the node Changed Node Reference are defined by the data type: IN_EmployeePayrollInputChangedNodeReferenceElements. These elements may include ObjectNodeReference, OriginalObjectNodeReference, ValidityPeriod, ReplicationRequiredIndicator, ToBeReplicatedVersionInformationOutdatedIndicator, DeletionRequiredIndicator, and ActionCode. ObjectNodeReference defines the node that has been changed, and may be based on datatype GDT: ObjectNodeReference. OriginalObjectNodeReference may be optional, defines a node from which a changed node reference is created, and may be based on datatype GDT: ObjectNodeReference, with a qualifier of Original. OriginalObjectNodeReference is populated for changed node references which are derived, inclusive of Version References. OriginalObjectNodeReference establishes a link between a derived Node to an original (primary) node at a change node reference for a derived node. While replicating to provider, the original node is held back and the derived node is sent to a provider. ValidityPeriod may be optional, defines a validity period of a changed node, and may be based on datatype GDT: CLOSED_DatePeriod with a qualifier of Validity. ReplicationRequiredIndicator is an indicator that determines that a replication to provider is required for a changed node, and may be based on datatype GDT: Indicator, with a qualifier of Required. ToBeReplicatedVersionOutdatedInformationIndicator is an indicator that determines that a ToBeReplicated version is outdated, and may be based on datatype GDT: Indicator, with a qualifier of Outdated. DeletionRequiredIndicator is an indicator that determines that a replication to provider is a deletion, and may be based on datatype GDT: Indicator, with a qualifier of Required.

DeletionRequiredIndicator may be used by providers that do not have the concept of time dependency in their record keeping. ActionCode may be optional, defines the action code for the node in the replication request that is sent to the provider, and may be based on datatype GDT: ActionCode.

The Changed Node Reference includes a Query By Elements. Query By Elements is a query that provides a list of changed nodes that satisfy selection criteria specified by query elements, combined by a logical “AND”. The query elements are defined by the data type: IN_EmployeePayrollInputChangedNodeReferenceElementsQueryElements, and may include IN_EmployeePayrollInputEmployeeUUID, ObjectNodeReferenceUUID, ObjectNodeReferenceObjectTypeCode, ObjectNodeReferenceObjectNodeTypeCode, Date,

ToBeReplicatedVersionInformationOutdatedIndicator, Rep licationRequiredIndicator, and OriginalObjectNodeReference. IN_EmployeePayrollInputEmployeeUUID is a universally unique identifier of an employee for whom an AT Employee Payroll Input applies, and may be based on datatype GDT: UUID. ObjectNodeReferenceUUID may be optional, is an identifier a referenced object's nodes, and may be based on datatype GDT: UUID. ObjectNodeReferenceObjectTypeCode is a type of a referenced object, and may be based on datatype GDT: ObjectTypeCode. ObjectNodeReferenceObjectNodeTypeCode is a type of node in a referenced object, and may be based on datatype GDT: ObjectNodeTypeCode. Date may be optional, represents a date that a change occurs on, and may be based on datatype GDT: Date. ToBeReplicatedVersionInformationOutdatedIndicator may be optional, is a indicator that determines that a ToBeReplicated version is outdated, and may be based on datatype GDT: Indicator, with a qualifier of Outdated. ReplicationRequiredIndicator may be optional, indicates whether a replication of data is required at a provider for a changed node, and may be based on datatype GDT: Indicator, with a qualifier of Required. OriginalObjectNodeReference may be optional, defines an original node from which a changed node reference is created, and may be based on datatype GDT: ObjectNodeReference, with a qualifier of Original.

Payroll Process Assignment is an assignment of an employee to a payroll process. The elements located at the node Payroll Process Assignment are defined by the data type: IN_EmployeePayrollInputPayrollProcessAssignmentElements. These elements include PayrollProcessID. A PayrollProcessID is an ID of a PayrollProcess, and may be based on datatype GDT: BusinessTransactionDocumentID. From the business object Payroll Process/node Payroll Process, a Payroll Process inbound aggregation relationship may exist, with a cardinality of 1:CN.

An Employee Tax Arrangement Period Terms is a set of information relevant to tax calculation for Indian payroll and reporting purposes for an Employee for a particular validity period. An Employee Tax Arrangement Period Terms may be time dependent on Validity Period. The elements located at the node Employee Tax Arrangement Period Terms are defined by the data type: IN_EmployeePayrollInputEmployeeTaxArrangementPeriodTermsElements, and may include EmployeePayrollInputVersionReferences. EmployeePayrollInputVersionReferences are references to a version of a Employee Tax Arrangement Period node, and may include ObjectID, ToBeReplicatedVersionDeletedIndicator, ToBeReplicatedVersionValidityPeriod, ToBeReplicatedVersionUUID, NewVersionUUID, and LastSuccessfullyReplicatedVersionUUID. ObjectID may be optional, is an identifier of a node in an object, and may be based on datatype GDT: ObjectID. ObjectID may be a primary object node ID if there is one node from where the information comes in one of the primary objectIDs. If the node is a derived node and a primary node does not exist, ObjectID may include a generated ID. ToBeReplicatedVersionDeletedIndicator is an indicator that a primary node for a version that is about to be replicated to a provider or has already been replicated to a provider but not yet confirmed as successful has been deleted on a primary object. ToBeReplicatedVersionDeletedIndicator may be based on datatype GDT: Indicator, with a qualifier of Deleted. ToBeReplicatedVersionValidityPeriod may be optional, and is a validity period of a version that is about to be replicated to a provider or has already been replicated to a provider but not yet confirmed as successful. ToBeReplicatedVersionValidityPeriod may be based on datatype GDT: CLOSED_DatePeriod, with a qualifier of Validity. ToBeReplicatedVersionUUID may be optional, and is a universally unique identifier for a version that is about to be replicated to a provider or has already been replicated to a provider but not yet confirmed as successful. The identifier is created or adjusted when a payroll administrator decides to start replication to the provider. ToBeReplicatedVersionUUID may be based on datatype GDT: UUID. NewVersionUUID is a universally unique identifier for a version that reflects the latest changes of a primary object, and may be based on datatype GDT: UUID. LastSuccessfullyreplicatedVersionUUID may be optional, and is a universally unique identifier for a version last replicated to a provider where the provider has confirmed that the replication was successful. The identifier is created or adjusted when the provider confirms successful replication of the data. LastSuccessfullyreplicatedVersionUUID may be based on datatype GDT: UUID. An Employee Tax Arrangement Period Terms Version composition relationship to subordinate nodes may exist, with a cardinality of 1:N. RelationshipsFrom the business object IN_Employee Tax Arrangement/node Period Terms, a Primary IN_Employee Tax Arrangement Period Terms inbound aggregation relationship may exist, with a cardinality of 1:C. To business object IN_Employee Payroll Input/Employee Tax Arrangement Period Terms Version, specialization associations for navigation may exist, including LastSuccesfullyReplicatedEmployeeTaxArrangementPeriodTermsVersion, NewEmployeeTaxArrangementPeriodTermsVersion, and ToBeReplicatedEmployeeTaxArrangementPeriodTermsVersion. LastSuccesfullyReplicatedEmployeeTaxArrangementPeriodTermsVersion has a target cardinality of C, and is associated with employee tax arrangement period terms last replicated to a provider where the provider has confirmed that the replication was successful. The association is created or adjusted when the provider confirms successful replication of the data. NewEmployeeTaxArrangementPeriodTermsVersion has a target cardinality of C, and is associated with employee social insurance arrangement period terms that reflects the latest changes of the primary object. ToBeReplicatedEmployeeTaxArrangementPeriodTermsVersion has a target cardinality of C, and is associated with employee tax arrangement period terms that are about to be replicated to a provider or has already been replicated to the provider but not yet been confirmed as a successful replication. The association is created or adjusted when a payroll administrator decides to start replication to the provider.

An Employee Tax Arrangement Period Terms Version is a version of an Employee Tax Arrangement Period Terms relevant for calculation of Indian payroll. Employee Tax Arrangement Period Terms Version may be time dependent on Validity Period. The elements located at the node Employee Tax Arrangement Period Terms Version are defined by the data type: IN_EmployeePayrollInputEmployeeTaxArrangementPeriodTermsVersionElements, and may include UUID, LastChangeDateTime, DeletedIndicator, ValidityPeriod, and EmployeeTaxID. UUID is a universally unique identifier that identifies an Employee Tax Arrangement Period Terms Version node. UUID may be an alternative key and may be based on datatype GDT: UUID. LastChangeDateTime is a date and time stamp of the last change, and may be based on datatype GDT: GLOBAL_DateTime with a qualifier of LastChange. DeletedIndicator is an indicator that a node has been logically deleted, and may be based on datatype GDT: Indicator, with a qualifier of Deleted. ValidityPeriod is a validity period of an Employee Tax Arrangement Period Terms Version node, and may be based on datatype GDT: CLOSED_DatePeriod with a qualifier of Validity. EmployeeTaxID is an identifier of an Employee for tax purposes, and may be based on datatype GDT: PartyTaxID.

Employee Payroll Input includes a summary of country independent payroll guidelines for input for an employee. These payroll guidelines for input include an employee's name or bank details. As payroll guidelines are generally meaningful in a country specific context, an Employee Payroll Input can be used as part of a host object that provides a country-specific context. An Employment Item is the set of information for Indian payroll and reporting purposes for an Employment. The elements located at the node Employment Item are defined by the data type: IN_EmployeePayrollInputEmploymentItemElements, and may include EmploymentUUID and EmployeePayrollInputVersionReferences. EmploymentUUID is a unique identifier that identifies an employment, for which the IN_Employee Payroll Input is valid. EmploymentUUID may be based on datatype GDT: UUID. EmployeePayrollInputVersionReferences are references to a version of the node, and may include ObjectID, ToBeReplicatedVersionDeletedIndicator, ToBeReplicatedVersionValidityPeriod, ToBeReplicatedVersionUUID, NewVersionUUID, and LastSuccessfullyReplicatedVersionUUID. ObjectID may be optional, is an identifier of a node in an object, and may be based on datatype GDT: ObjectID. ObjectID may be a primary object node ID if there is one node from where the information comes in one of the primary objectIDs. If the node is a derived node and a primary node does not exist, ObjectID may include a generated ID. ToBeReplicatedVersionDeletedIndicator is an indicator that a primary node for a version that is about to be replicated to a provider or has already been replicated to a provider but not yet confirmed as successful has been deleted on a primary object. ToBeReplicatedVersionDeletedIndicator may be based on datatype GDT: Indicator, with a qualifier of Deleted. ToBeReplicatedVersionValidityPeriod may be optional, and is a validity period of a version that is about to be replicated to a provider or has already been replicated to a provider but not yet confirmed as successful. ToBeReplicatedVersionValidityPeriod may be based on datatype GDT: CLOSED_DatePeriod, with a qualifier of Validity. ToBeReplicatedVersionUUID may be optional, and is a universally unique identifier for a version that is about to be replicated to a provider or has already been replicated to a provider but not yet confirmed as successful. The identifier is created or adjusted when a payroll administrator decides to start replication to the provider. ToBeReplicatedVersionUUID may be based on datatype GDT: UUID. NewVersionUUID is a universally unique identifier for a version that reflects the latest changes of a primary object, and may be based on datatype GDT: UUID. LastSuccessfullyreplicatedVersionUUID may be optional, and is a universally unique identifier for a version last replicated to a provider where the provider has confirmed that the replication was successful. The identifier is created or adjusted when the provider confirms successful replication of the data. LastSuccessfullyreplicatedVersionUUID may be based on datatype GDT: UUID. The following composition relationships to subordinate nodes may exist: Employment Item Version, with a cardinality of 1:N; Employment Item Employment Payroll Input, with a cardinality of 1:C; Employment Item Employee Tax Arrangement Employment Item Previous Employment, with a cardinality of 1:CN; and Employment Item Work Agreement Item, with a cardinality of 1:CN. From the business object Employment/node Employment, an Employment inbound aggregation relationship may exist, with a cardinality of 1:C. To business object IN_EmployeePayrollInput/EmploymentItemVersion, specialization associations for navigation may exist, including LastSuccesfullyReplicatedEmploymentItemVersion, NewEmploymentItemVersion, and ToBeReplicatedEmploymentItemVersion. LastSuccesfullyReplicatedEmploymentItemVersion has a target cardinality of C, and is associated with an employment item version last replicated to a provider where the provider has confirmed that the replication was successful. The association is created or adjusted when the provider confirms successful replication of the data. NewEmploymentItemVersion has a target cardinality of C, and is associated with an employment item version that reflects the latest changes of the primary object. ToBeReplicatedEmploymentItemVersion has a target cardinality of C, and is associated with an employment item version that is about to be replicated to a provider or has already been replicated to the provider but not yet been confirmed as a successful replication. The association is created or adjusted when a payroll administrator decides to start replication to the provider.

An Employment Item Version is a version of an Employment Item. The elements located at the node Employment Item Version are defined by the data type: IN_EmployeePayrollInputEmploymentItemVersionElements, and may include UUID, LastChangeDateTime, DeletedIndicator, and EmploymentUUID. UUID is a universally unique identifier that identifies an Employment Item Version. UUID may be based on datatype GDT: UUID. LastChangeDateTime is a date and time stamp of the last change, and may be based on datatype GDT: GLOBAL_DateTime. DeletedIndicator may be optional, is an indicator that a node has been logically deleted, and may be based on datatype GDT: Indicator, with a qualifier of Deleted. EmploymentUUID is a universally unique identifier that identifies an employment for which the IN_Employee Payroll Input is valid, and may be based on datatype GDT: UUID.

Employment Item Employment Payroll Input is a summary of country independent payroll guidelines for input for an employment. These payroll guidelines for input include statements about an employee's level of disability. As payroll guidelines are generally meaningful in a country specific context, an EmploymentPayrollInput can be used as part of a host object, such as IN_Employee Payroll Input, that provides country-specific context. Country independent payroll guidelines that refer to a work agreement are recorded in a dependent object WorkAgreementPayrollInput.

Employment Item Employee Tax Arrangement Employment Item Previous Employment is a set of additional information from previous employments in a current tax year relevant to a tax calculation for Indian payroll and reporting purposes for an Employee for a particular validity period. The elements located directly at the node Employment Item Employee Tax Arrangement Employment Item Previous Employment are defined by the data type IN_EmployeePayrollInputEmploymentItemEmployeeTaxArrangementEmploymentItemPreviousEmploymentElements. These elements include: EmployeePayrollInputVersionReferences, ObjectID, ToBeReplicatedVersionDeletedIndicator, ToBeReplicatedVersionValidityPeriod, ToBeReplicatedVersionUUID, NewVersionUUID, and LastSuccessfullyReplicatedVersionUUID. EmployeePayrollInputVersionReferences include references to a version of the Employment Item Employee Tax Arrangement Employment Item Previous Employment node, and may be based on datatype BOIDT: EmployeePayrollInputVersionReferences. ObjectID may be optional, is an identifier of a node in an object, and may be based on datatype GDT: ObjectID. The object node may be a primary object node identifier, or if the node is a derived node and a primary node does not exist, ObjectID may include a generated identifier. ToBeReplicatedVersionDeletedIndicator is an indicator that a primary node for a version that is about to be replicated to a provider or has already been replicated to a provider but has not yet been confirmed as successful has been deleted on a primary object. ToBeReplicatedVersionDeletedIndicator may be based on datatype GDT: Indicator, with a qualifier of Deleted. ToBeReplicatedVersionValidityPeriod may be optional, is a validity period of a version that is about to be replicated to a provider or has already been replicated to the provider but has not yet been confirmed as successful. ToBeReplicatedVersionValidityPeriod may be based on datatype GDT: CLOSED_DatePeriod, with a qualifier of Validity. ToBeReplicatedVersionUUID may be optional, is a universally unique identifier for a version that is about to be replicated to a provider or has already been replicated to the provider but has not yet been confirmed as successful. The identifier may be created or adjusted when a payroll administrator decides to start replication to a provider. ToBeReplicatedVersionUUID may be based on datatype GDT: UUID. NewVersionUUID is a universally unique identifier for a version that reflects the latest changes of a primary object, and may be based on datatype GDT: UUID. LastSuccessfullyReplicatedVersionUUID may be optional, is a universally unique identifier for a version last replicated to a provider where the provider has confirmed that a replication was successful. The identifier may be created or adjusted when a provider confirms successful replication of the data. LastSuccessfullyReplicatedVersionUUID may be based on datatype GDT: UUID. A composition relationship to the subordinate node Employment Item Employee Tax Arrangement Employment Item Previous Employment Version may exist, with a cardinality of 1:N. A composition relationship to the subordinate node Employment Item Employee Tax Arrangement Employment Item Previous Employment Compensation Component may exist, with a cardinality of 1:CN. A Primary IN_Employee Tax Arrangement Employment Item Previous Employment inbound aggregation relationship may exist from the business object IN_Employee Tax Arrangement/node Employment Item Previous Employment Cross DU, with a cardinality of 1:C, which represents the Employment Item Previous Employment node of the IN_Employee Tax Arrangement BO to which the Employment Item Employee Tax Arrangement Employment Item Previous Employment node applies. A LastSuccesfullyReplicatedEmploymentItemEmployeeTaxArrangementEmploymentItemPreviousEmploymentVersion specialization association for navigation may exist to the business object IN_Employee Payroll Input/Employment Item Employee Tax Arrangement Employment Item Previous Employment Version, which represents the Employment Item Employee Tax Arrangement Employment Item Previous Employment Version last replicated to a provider where the provider has confirmed that a replication was successful. The association may be created or adjusted when a provider confirms successful replication of the data. A NewEmploymentItemEmployeeTaxArrangementEmploymentItemPreviousEmploymentVersion association may exist to the business object IN_Employee Payroll Input/Employment Item Employee Tax Arrangement Employment Item Previous Employment Version, which represents the Employment Item Employee Tax Arrangement Employment Item Previous Employment Version that reflects the latest changes of a primary object. A ToBeReplicatedEmploymentItemEmployeeTaxArrangementEmploymentItemPreviousEmploymentVersion association may exist to the business object IN_Employee Payroll Input/Employment Item Employee Tax Arrangement Employment Item Previous Employment Version, which represents the Employment Item Employee Tax Arrangement Employment Item Previous Employment Version that is about to be replicated to a provider or has already been replicated to the provider but has not yet been confirmed as a successful replication. The association may be created or adjusted when a payroll administrator decides to start replication to a provider.

Employment Item Employee Tax Arrangement Employment Item Previous Employment Version is a version of the Employment Item Employee Tax Agreement Employment Item Previous Employment, and may be time dependent on Validity Period. The elements located directly at the node Employment Item Employee Tax Arrangement Employment Item Previous Employment Version are defined by the data type IN_EmployeePayrollInputEmploymentItemEmployeeTaxArrangementEmploymentItemPrevious EmploymentVersionElements. These elements include: UUID, LastChangeDateTime, DeletedIndicator, ValidityPeriod, LeaveTravelAllowanceNumberValue, and LeaveTravelAllowanceRelevanceIndicator. UUID may be an alternative key, is a universally unique identifier that identifies an EmploymentItemWorkAgreementItemEmployeeTaxArrangementWorkAgreementItemPrevious EmploymentVersion node, and may be based on datatype GDT: UUID. LastChangeDateTime is a date and time stamp of a last change, and may be based on datatype GDT: GLOBAL_DateTime, with a qualifier of LastChange. DeletedIndicator indicates that as node has been logically deleted, and may be based on datatype GDT: Indicator, with a qualifier of Deleted. ValidityPeriod is a validity period of the EmploymentItemWorkAgreementItemEmployeeTaxArrangementWorkAgreementItemPrevious EmploymentVersion node, and may be based on datatype GDT: CLOSED_DatePeriod, with a qualifier of Validity. LeaveTravelAllowanceNumberValue may be optional, is a number value of allowances occurring due to travel leave, and may be based on datatype GDT: SMALL_NumberValue. LeaveTravelAllowanceRelevanceIndicator is an indicator to denote a tax relevance of leave travel allowance, and may be based on datatype GDT: Indicator, with a qualifier of Relevance.

Employment Item Employee Tax Arrangement Employment Item Previous Employment Compensation Component is a component that includes tax-related data from previous employments relevant for a current tax year. The elements located directly at the node Employment Item Employee Tax Arrangement Employment Item Previous Employment Compensation Component are defined by the data type IN_EmployeePayrollInputEmploymentItemEmployeeTaxArrangementEmploymentItemPrevious EmploymentCompensationComponentElements. These elements include: EmployeePayrollInputVersionReferences, ObjectID, ToBeReplicatedVersionDeletedIndicator, ToBeReplicatedVersionValidityPeriod, ToBeReplicatedVersionUUID, NewVersionUUID, and LastSuccessfullyReplicatedVersionUUID. EmployeePayrollInputVersionReferences includes references to a version of the Employment Item Employee Tax Arrangement Employment Item Previous Employment Compensation Component, and may be based on datatype BOIDT: EmployeePayrollInputVersionReferences. ObjectID may be optional, is an identifier of a node in an object, and may be based on datatype GDT: ObjectID. ObjectID may be a primary object node identifier, or if the node is a derived node and a primary node does not exist, ObjectID may include a generated identifier. ToBeReplicatedVersionDeletedIndicator is an indicator that a primary node for a version that is about to be replicated to a provider or has already been replicated to a provider but has not yet been confirmed as successful has been deleted on a primary object. ToBeReplicatedVersionDeletedIndicator may be based on datatype GDT: Indicator, with a qualifier of Deleted. ToBeReplicatedVersionValidityPeriod may be optional, is a validity period of a version that is about to be replicated to a provider or has already been replicated to a provider but not yet confirmed as successful, and may be based on datatype GDT: CLOSED_DatePeriod, with a qualifier of Validity. ToBeReplicatedVersionUUID may be optional, is a universally unique identifier for a version that is about to be replicated to a provider or has already been replicated to the provider but has not yet been confirmed as successful. The identifier may be created or adjusted when a payroll administrator decides to start replication to a provider. ToBeReplicatedVersionUUID may be based on datatype GDT: UUID. NewVersionUUID is a universally unique identifier for a version that reflects the latest changes of a primary object, and may be based on datatype GDT: UUID. LastSuccessfullyReplicatedVersionUUID may be optional, is a universally unique identifier for a version last replicated to a provider where the provider has confirmed that a replication was successful. The identifier may be created or adjusted when the provider confirms successful replication of the data. LastSuccessfullyReplicatedVersionUUID may be based on datatype GDT: UUID. A Employment Item Employee Tax Arrangement Employment Item Previous Employment Compensation Component composition relationship to the subordinate node Version may exist, with a cardinality of 1:N. A Primary IN_Employee Tax Arrangement Employment Item Previous Employment Compensation Component inbound aggregation relationship may exist from the business object IN_Employee Tax Arrangement/node Employment Item Previous Employment Compensation Component Cross DU, with a cardinality of 1:C, which represents the Employment Item Previous Employment Compensation Component node of the IN_Employee Tax Arrangement BO to which the Employment Item Employee Tax Arrangement Employment Item Previous Employment Compensation Component node applies. A LastSuccesfullyReplicatedEmploymentItemEmployeeTaxArrangementEmploymentItemPreviousEmploymentCompensationComponentVersion specialization association for navigation may exist to the business object IN_Employee Payroll Input/Employment Item Employee Tax Arrangement Employment Item Previous Employment Compensation Component Version, which represents the Employment Item Employee Tax Arrangement Employment Item Previous Employment Compensation Component Version last replicated to a provider where the provider has confirmed that a replication was successful. The association may be created or adjusted when the provider confirms successful replication of the data. A NewEmploymentItemEmployeeTaxArrangementEmploymentItemPreviousEmploymentCompensationComponentVersion association may exist to the business object IN_Employee Payroll Input/Employment Item Employee Tax Arrangement Employment Item Previous Employment Compensation Component Version, which represents the Employment Item Employee Tax Arrangement Employment Item Previous Employment Compensation Component Version that reflects the latest changes of a primary object. A ToBeReplicatedEmploymentItemEmployeeTaxArrangementEmploymentItemPreviousEmploymentCompensationComponentVersion association may exist to the business object IN_Employee Payroll Input/Empolyment Item Employee Tax Arrangement Employment Item Previous Employment Compensation Component Version, which represents the Employment Item Employee Tax Arrangement Employment Item Previous Employment Compensation Component Version that is about to be replicated to a provider or has already been replicated to the provider but has not yet been confirmed as a successful replication. The association may be created or adjusted when a payroll administrator decides to start replication to the provider.

Employment Item Employee Tax Arrangement Employment Item Previous Employment Compensation Component Version is a version of the Employment Item Employee Tax Agreement Employment Item Previous Employment Compensation Component. The elements located directly at the node Employment Item Employee Tax Arrangement Employment Item Previous Employment Compensation Component Version are defined by the data type IN_EmployeePayrollInputEmploymentItemEmployeeTaxArrangementEmploymentItemPrevious EmploymentCompensationComponentVersionElements. These elements include: UUID, LastChangeDateTime, DeletedIndicator, TaxationCategoryCode, and TaxationCategoryAmount. UUID: may be an alternative key, is a universally unique identifier that identifies an EmploymentItemWorkAgreementItemEmployeeTaxArrangementWorkAgreementItemPrevious EmploymentCompensationComponentVersion node, and may be based on datatype GDT: UUID. LastChangeDateTime is a date and time stamp of a last change, and may be based on datatype GDT: GLOBAL_DateTime, with a qualifier of LastChange. DeletedIndicator is an indicator that as node has been logically deleted, and may be based on datatype GDT: Indicator, with a qualifier of Deleted. TaxationCategoryCode is a coded representation of a taxation category of a Compensation Component, and may be based on datatype GDT: CompensationComponentTaxationCategoryCode. TaxationCategoryAmount is an amount due for a given taxation category, and may be based on datatype GDT: CURRENCYINR_MEDIUM_Amount.

Employment Item Work Agreement Item is a contract between employer and employee according to which the employee is obliged to provide his or her labour while the employer is obliged to provide the agreed compensation. The activities and responsibilities of the employee are specified in the work agreement. The elements located at the node Employment Item Work Agreement Item are defined by the data type: IN_EmployeePayrollInputEmploymentItemWorkAgreementItemElements, and may include WorkAgreementUUID and EmployeePayrollInputVersionReferences. WorkAgreementUUID is a universally unique identifier that identifies a work agreement, for which the IN_Employee Payroll Input is valid. WorkAgreementUUID and may be based on datatype GDT: UUID. EmployeePayrollInputVersionReferences are references to a version of the node, and may include ObjectID, ToBeReplicatedVersionDeletedIndicator, ToBeReplicatedVersionValidityPeriod, ToBeReplicatedVersionUUID, NewVersionUUID, and LastSuccessfullyReplicatedVersionUUID. ObjectID may be optional, is an identifier of a node in an object, and may be based on datatype GDT: ObjectID. ObjectID may be a primary object node ID if there is one node from where the information comes in one of the primary objectIDs. If the node is a derived node and a primary node does not exist, ObjectID may include a generated ID. ToBeReplicatedVersionDeletedIndicator is an indicator that a primary node for a version that is about to be replicated to a provider or has already been replicated to a provider but not yet confirmed as successful has been deleted on a primary object. ToBeReplicatedVersionDeletedIndicator may be based on datatype GDT: Indicator, with a qualifier of Deleted. ToBeReplicatedVersionValidityPeriod may be optional, and is a validity period of a version that is about to be replicated to a provider or has already been replicated to a provider but not yet confirmed as successful. ToBeReplicatedVersionValidityPeriod may be based on datatype GDT: CLOSED_DatePeriod, with a qualifier of Validity. ToBeReplicatedVersionUUID may be optional, and is a universally unique identifier for a version that is about to be replicated to a provider or has already been replicated to a provider but not yet confirmed as successful. The identifier is created or adjusted when a payroll administrator decides to start replication to the provider. ToBeReplicatedVersionUUID may be based on datatype GDT: UUID. NewVersionUUID is a universally unique identifier for a version that reflects the latest changes of a primary object, and may be based on datatype GDT: UUID. LastSuccessfullyreplicatedVersionUUID may be optional, and is a universally unique identifier for a version last replicated to a provider where the provider has confirmed that the replication was successful. The identifier is created or adjusted when the provider confirms successful replication of the data. LastSuccessfullyreplicatedVersionUUID may be based on datatype GDT: UUID.

The following composition relationships to subordinate nodes may exist: Employment Item Work Agreement Item Version, with a cardinality of 1:N; Employment Item Work Agreement Item Work Agreement Payroll Input, with a cardinality of 1:C; Employment Item Work Agreement Item Employee Tax Arrangement Work Agreement Item Period Terms, with a cardinality of 1:CN, Employment Item Work Agreement Item Employee Tax Arrangement Work Agreement Item Exemption, with a cardinality of 1:CN, Employment Item Work Agreement Item Employee Tax Arrangement Work Agreement Item Investment, with a cardinality of 1:CN, Employment Item Work Agreement Item Employee Social Insurance Arrangement Work Agreement Item Period Terms, with a cardinality of 1:CN; and Employment Item Work Agreement Item Employee Social Insurance Arrangement Work Agreement Item Pension Insurance, with a cardinality of 1:CN. From the business object Work Agreement/node Work Agreement, a Work Agreement inbound aggregation relationship may exist, with a cardinality of 1:C.

To business object IN_Employee Payroll Input/Employment Item Work Agreement ItemVersion, specialization associations for navigation may exist, including LastSuccesfullyReplicatedEmploymentItemWorkAgreementItemVersion, NewEmploymentItemWorkAgreementItemVersion, and ToBeReplicatedEmploymentItemWorkAgreementItemVersion. LastSuccesfullyReplicatedEmploymentItemWorkAgreementItemVersion has a target cardinality of C, and may be associated with employment item workagreement item version last replicated to a provider where the provider has confirmed that the replication was successful. The association is created or adjusted when the provider confirms successful replication of the data. NewEmploymentItemWorkAgreementItemVersion has a target cardinality of C, and may be associated with an employment item workagreement item version that reflects the latest changes of the primary object. ToBeReplicatedEmploymentItemWorkAgreementItemVersion has a target cardinality of C, and may be associated with an employment item workagreement item version that is about to be replicated to a provider or has already been replicated to the provider but not yet been confirmed as a successful replication. The association is created or adjusted when the payroll administrator decides to start replication to the provider.

Employment Item Work Agreement Item may include a Query By Payroll Processing Conditions query. The Query By Payroll Processing Conditions query can select a list of Work Agreement Payroll Input instances that satisfy the selection criteria. The query elements are defined by the data type: IN_EmployeePayrollInputEmploymentItemWorkAgreementItemPayrollProcessingConditionsQueryElements, and may include IN_EmployeePayrollInputEmployeeUUID, Date, WorkAgrmtPyrlInputEmplPyrlAgrmtItemPyrlProcgConditionsNewVersionPayrollGroupCode, WAPayrollInputEPAItemPayrollProcessingConditionsNewVersionInactiveIndicator, and WAPayrollInputEPAItemPayrollProcessingConditionsNewVersionDeletedIndicator. IN_EmployeePayrollInputEmployeeUUID is a universally unique identifier of an employee for whom the AT Employee Payroll Input applies.

IN_EmployeePayrollInputEmployeeUUID may be optional and may be based on datatype GDT: UUID. Date represents a date for which a selected EmployeePayrollAgreementItemPayrolProcessingConditions is valid, and may be based on datatype GDT: Date. WorkAgrmtPyrlInputEmplPyrlAgrmtItemPyrlProcgConditionsNewVersionPayrollGroupCode is a code for a payroll group, and may be based on datatype GDT: PayrollGroupCode. WAPayrollInputEPAItemPayrollProcessingConditionsNewVersionInactiveIndicator is an indicator that an employee is inactive for inclusion in payroll processing. WAPayrollInputEPAItemPayrollProcessingConditionsNewVersionInactiveIndicator may be based on datatype GDT: Indicator, with a qualifier of Inactive. WAPayrollInputEPAItemPayrollProcessingConditionsNewVersionDeletedIndicator is an indicator that a primary node for an Employee Payroll Agreement Item Payroll Processing Conditions Version has been deleted on a primary object. WAPayrollInputEPAItemPayrollProcessingConditionsNewVersionDeletedIndicator may be optional and may be based on datatype GDT: Indicator, with a qualifier of Deleted.

An Employment Item Work Agreement Item Version is a version of an Employment Item Work Agreement Item. Employment Item Work Agreement Item Version may be time dependent on Validity Period. The elements located at the node Employment Item Work Agreement Item Version are defined by the data type: IN_EmployeePayrollInputEmploymentItemWorkAgreementItemVersionElements, and may include UUID, LastChangeDateTime, DeletedIndicator, ValidityPeriod, and WorkAgreementUUID. UUID is a universally unique identifier that identifies an Employment Item Work Agreement Item Version node. UUID may be based on datatype GDT: UUID. LastChangeDateTime is a date and time stamp of the last change, and may be based on datatype GDT: GLOBAL_DateTime with a qualifier of LastChange. DeletedIndicator is an indicator that a primary node for a Version has been deleted on a primary object. DeletedIndicator may be based on datatype GDT: Indicator, with a qualifier of Deleted. ValidityPeriod is a validity period of a Work Agreement, and may be based on datatype GDT: CLOSED_DatePeriod, with a qualifier of Validity. WorkAgreementUUID is a universally unique ID that identifies a work agreement, for which the IN_EmployeePayrollInput is valid. WorkAgreementUUID may be based on datatype GDT: UUID.

Employment Item Work Agreement Item Work Agreement Payroll Input is a summary of country independent payroll guidelines for input for a work agreement. These payroll guidelines for input include compensation information and reported employee working times. As payroll guidelines are generally meaningful in a country specific context, a WorkAgreementPayrollInput is used in IN_Employee Payroll Input, which defines the context of the country.

An Employment Item Work Agreement Item Employee Tax Arrangement Work Agreement Item Period Terms is a set of additional information relevant to a tax calculation for Indian payroll and reporting purposes for an Employee, in a particular validity period. The elements located at the node Employment Item Work Agreement Item Employee Tax Arrangement Work Agreement Item Period Terms are defined by the data type: IN_EmployeePayrollInputEmploymentItemWorkAgreementItemEmployeeTaxArrangementWorkAgreementItemPeriodTermsElements, and may include EmployeePayrollInputVersionReferences. EmployeePayrollInputVersionReferences are references to a version of the node, and may include ObjectID, ToBeReplicatedVersionDeletedIndicator, ToBeReplicatedVersionValidityPeriod, ToBeReplicatedVersionUUID, NewVersionUUID, and LastSuccessfullyReplicatedVersionUUID. ObjectID may be optional, is an identifier of a node in an object, and may be based on datatype GDT: ObjectID. ObjectID may be a primary object node ID if there is one node from where the information comes in one of the primary objectIDs. If the node is a derived node and a primary node does not exist, ObjectID may include a generated ID. ToBeReplicatedVersionDeletedIndicator is an indicator that a primary node for a version that is about to be replicated to a provider or has already been replicated to a provider but not yet confirmed as successful has been deleted on a primary object. ToBeReplicatedVersionDeletedIndicator may be based on datatype GDT: Indicator, with a qualifier of Deleted. ToBeReplicatedVersionValidityPeriod may be optional, and is a validity period of a version that is about to be replicated to a provider or has already been replicated to a provider but not yet confirmed as successful. ToBeReplicatedVersionValidityPeriod may be based on datatype GDT: CLOSED_DatePeriod, with a qualifier of Validity. ToBeReplicatedVersionUUID may be optional, and is a universally unique identifier for a version that is about to be replicated to a provider or has already been replicated to a provider but not yet confirmed as successful. The identifier is created or adjusted when a payroll administrator decides to start replication to the provider. ToBeReplicatedVersionUUID may be based on datatype GDT: UUID. NewVersionUUID is a universally unique identifier for a version that reflects the latest changes of a primary object, and may be based on datatype GDT: UUID. LastSuccessfullyreplicatedVersionUUID may be optional, and is a universally unique identifier for a version last replicated to a provider where the provider has confirmed that the replication was successful. The identifier is created or adjusted when the provider confirms successful replication of the data. LastSuccessfullyreplicatedVersionUUID may be based on datatype GDT: UUID. An Employment Item Work Agreement Item Employee Tax Arrangement Work Agreement Item Period Terms Version composition relationship to subordinate nodes may exist, with a cardinality of 1:N. From the business object IN_Employee Tax Arrangement/node Work Agreement Item Period Terms, a Primary IN_Employee Tax Arrangement Work Agreement Item Period Terms inbound aggregation relationship may exist, with a cardinality of 1:C. To business object IN_Employee Payroll Input/Employment Item Work Agreement Item Employee Tax Arrangement Work Agreement Item Period Terms Version, specialization associations for navigation may exist, including LastSuccesfullyReplicatedEmploymentItemWorkAgreementItemEmployeeTaxArrangementWorkAgreementItemPeriodTermsVersion, NewEmploymentItemWorkAgreementItemEmployeeTaxArrangementWorkAgreementItemPeriodTermsVersion, and ToBeReplicatedEmploymentItemWorkAgreementItemEmployeeTaxArrangementWorkAgreementItemPeriodTermsVersion. LastSuccesfullyReplicatedEmploymentItemWorkAgreementItemEmployeeTaxArrangementWorkAgreementItemPeriodTermsVersion has a target cardinality of C, and may be associated with an employment item work agreement item employee tax arrangement work agreement item period terms last replicated to a provider where the provider has confirmed that the replication was successful. The association is created or adjusted when the provider confirms successful replication of the data. NewEmploymentItemWorkAgreementItemEmployeeTaxArrangementWorkAgreementItemPeriodTermsVersion has a target cardinality of C, and may be associated with an employment item work agreement item employee tax arrangement work agreement item period terms that reflects the latest changes of a primary object. ToBeReplicatedEmploymentItemWorkAgreementItemEmployeeTaxArrangementWorkAgreementItemPeriodTermsVersion has a target cardinality of C, and may be associated with an employment item work agreement item employee tax arrangement work agreement item period terms that is about to be replicated to a provider or has already been replicated to the provider but not yet been confirmed as a successful replication. The association is created or adjusted when a payroll administrator decides to start replication to the provider. Employment Item Work Agreement Item Employee Tax Arrangement Work Agreement Item Period Terms Version is a version of the Employment Item Work Agreement Item Employee Tax Agreement Work Agreement Item Period Terms, and may be time dependent on Validity Period. The elements located directly at the node Employment Item Work Agreement Item Employee Tax Arrangement Work Agreement Item Period Terms Version are defined by the data type: IN_EmployeePayrollInputEmploymentItemWorkAgreementItemEmployeeTaxArrangementWorkAgreementItemPeriodTermsVersionElements. These elements include: UUID, LastChangeDateTime, DeletedIndicator, ValidityPeriod, CityTaxationCategoryCode, HouseRentAmount, ExemptedIndicator, and ProfessionalTaxRelevanceIndicator. UUID may be an alternative key, is a universally unique identifier that identifies a EmploymentItemWorkAgreementItemEmployeeTaxArrangementWorkAgreementItemPeriodTermsVersion node, and may be based on datatype GDT: UUID. LastChangeDateTime is a date and time stamp of a last change, and may be based on datatype GDT: GLOBAL_DateTime, with a qualifier of LastChange. DeletedIndicator is an indicator that a node has been logically deleted, and may be based on datatype GDT: Indicator, with a qualifier of Deleted. ValidityPeriod is a validity period of the EmploymentItemWorkAgreementItemEmployeeTaxArrangementWorkAgreementItemPeriodTermsVersion node, and may be based on datatype GDT: CLOSED_DatePeriod, with a qualifier of Validity. CityTaxationCategoryCode may be optional, is a coded representation of a city category for taxation purposes of an employees residence, and may be based on datatype GDT: CityTaxationCategoryCode. HouseRentAmount may be optional, indicates an amount paid per month as rent towards employee accommodation, and may be based on datatype GDT: CURRENCYINR_MEDIUM_Amount, with a qualifier of Rent. ExemptedIndicator is an indicator to denote whether a special exemption for taxes applies, and may be based on datatype GDT: Indicator, with a qualifier of Exempted. ProfessionalTaxRelevanceIndicator indicates whether a tax is relevant for a given profession, and may be based on datatype GDT: Indicator, with a qualifier of Relevance.

Employment Item Work Agreement Item Employee Tax Arrangement Work Agreement Item Exemption is a set of tax relevant exemptions to a tax calculation for Indian payroll and reporting purposes for an Employee for a particular validity period. The elements located directly at the node Employment Item Work Agreement Item Employee Tax Arrangement Work Agreement Item Exemption are defined by the data type IN_EmployeePayrollInputEmploymentItemWorkAgreementItemEmployeeTaxArrangementWorkAgreementItemExemptionElements. These elements include: EmployeePayrollInputVersionReferences, ObjectID, ToBeReplicatedVersionDeletedIndicator, ToBeReplicatedVersionValidityPeriod, ToBeReplicatedVersionUUID, NewVersionUUID, and LastSuccessfullyReplicatedVersionUUID. EmployeePayrollInputVersionReferences includes references to a version of the EmploymentItemWorkAgreementItemEmployeeTaxArrangementWorkAgreementItemExemption node, and may be based on datatype BOIDT: EmployeePayrollInputVersionReferences. ObjectID may be optional. is an identifier of a node in an object, and may be based on datatype GDT: ObjectID. ObjectID may be a primary object node identifier, or, if the node is a derived node and a primary node does not exist, ObjectID may be a generated identifier. ToBeReplicatedVersionDeletedIndicator is an indicator that a primary node for a version that is about to be replicated to a provider or has already been replicated to a provider but has not yet been confirmed as successful has been deleted on a primary object. ToBeReplicatedVersionDeletedIndicator may be based on datatype GDT: Indicator, with a qualifier of Deleted. ToBeReplicatedVersionValidityPeriod may be optional and is a validity period of a version that is about to be replicated to a provider or has already been replicated to a provider but not yet confirmed as successful. ToBeReplicatedVersionValidityPeriod may be based on datatype GDT: CLOSED_DatePeriod, with a qualifier of Validity. ToBeReplicatedVersionUUID may be optional and is a universally unique identifier for a version that is about to be replicated to a provider or has already been replicated to a provider but has not yet been confirmed as successful. The identifier may be created or adjusted when a payroll administrator decides to start replication to the provider. ToBeReplicatedVersionUUID may be based on datatype GDT: UUID. NewVersionUUID is a universally unique identifier for a version that reflects the latest changes of a primary object, and may be based on datatype GDT: UUID. LastSuccessfullyReplicatedVersionUUID may be optional and is a universally unique identifier for a version last replicated to a provider where the provider has confirmed that a replication was successful. The identifier may be created or adjusted when a provider confirms successful replication of the data. LastSuccessfullyReplicatedVersionUUID may be based on datatype GDT: UUID. An Employment Item Work Agreement Item Employee Tax Arrangement Work Agreement Item Exemption Family composition relationship to the subordinate node Employment Item Work Agreement Item Employee Tax Arrangement Work Agreement Item Exemption Version may exist with a cardinality of 1:N, and a composition relationship may exist to the Member node with a cardinality of 1:CN. A Primary IN_Employee Tax Arrangement Work Agreement Item Exemption inbound aggregation relationship may exist from the business object IN_Employee Tax Arrangement/node Work Agreement Item Exemption Cross DU, with a cardinality of 1:C, which represents the Work Agreement Item Exemption node of the IN_Employee Tax Arrangement BO to which the Employment Item Work Agreement Item Employee Tax Arrangement Exemption node applies. A LastSuccesfullyReplicatedEmploymentItemWorkAgreementItemEmployeeTaxArrangementWorkAgreementItemExemptionVersion specialization association for navigation may exist to the business object IN_Employee Payroll Input/Employment Item Work Agreement Item Employee Tax Arrangement Work Agreement Item Exemption Version, which represents the employment item work agreement item employee tax arrangement work agreement item exemption version last replicated to a provider where the provider has confirmed that a replication was successful. The association may be created or adjusted when a provider confirms successful replication of the data. A NewEmploymentItemWorkAgreementItemEmployeeTaxArrangementWorkAgreementItemExemptionVersion association may exist to the business object IN_Employee Payroll Input/Employment Item Work Agreement Item Employee Tax Arrangement Work Agreement Item Exemption Version, which represents the employment item work agreement item employee tax arrangement work agreement item exemption version that reflects the latest changes of a primary object. A ToBeReplicatedEmploymentItemWorkAgreementItemEmployeeTaxArrangementWorkAgreementItemExemptionVersion association may exist to the business object IN_Employee Payroll Input/Employment Item Work Agreement Item Employee Tax Arrangement Work Agreement Item Exemption Version, which represents the employment item work agreement item employee tax arrangement work agreement item exemption version that is about to be replicated to a provider or has already been replicated to the provider but that has not yet been confirmed as a successful replication. The association may be created or adjusted when a payroll administrator decides to start replication to a provider.

Employment Item Work Agreement Item Employee Tax Arrangement Work Agreement Item Exemption Version is a version of the Employment Item Work Agreement Item Employee Tax Agreement Work Agreement Item Exemption, and may be time dependent on Validity Period. The elements located directly at the node Employment Item Work Agreement Item Employee Tax Arrangement Work Agreement Item Exemption Version are defined by the data type IN_EmployeePayrollInputEmploymentItemWorkAgreementItemEmployeeTaxArrangementWorkAgreementItemExemptionVersionElements. These elements include: UUID, LastChangeDateTime, DeletedIndicator, ValidityPeriod, EmployeeTaxationExemptionTypeCode, and EmployeeTaxationExemptionAmount. UUID may be an alternative key, is a universally unique identifier that identifies an EmploymentItemWorkAgreementItemEmployeeTaxArrangementWorkAgreementItemExemptionVersion node, and may be based on datatype GDT: UUID. LastChangeDateTime is a date and time stamp of a last change, and may be based on datatype GDT: GLOBAL_DateTime, with a qualifier of LastChange. DeletedIndicator is an indicator that a node has been logically deleted, and may be based on datatype GDT: Indicator, with a qualifier of Deleted. ValidityPeriod is a validity period of the EmploymentItemWorkAgreementItemEmployeeTaxArrangementWorkAgreementItemExemptionVersion node, and may be based on datatype GDT: CLOSED_DatePeriod, with a qualifier of Validity. EmployeeTaxationExemptionTypeCode is a coded representation of a taxation exemption type for an employee and may be based on datatype GDT: EmployeeTaxationExemptionTypeCode. EmployeeTaxationExemptionAmount is an amount exempted for an employee taxation, and may be based on datatype GDT: CURRENCYINR_MEDIUM_Amount.

Employment Item Work Agreement Item Employee Tax Arrangement Work Agreement Item Exemption Family Member is a family member for whom tax relevant exemptions to a tax calculation for Indian payroll and reporting purposes for an Employee for a particular validity period are applicable. The elements located directly at the node Employment Item Work Agreement Item Employee Tax Arrangement Work Agreement Item Exemption Family Member are defined by the data type IN_EmployeePayrollInputEmploymentItemWorkAgreementItemEmployeeTaxArrangementWorkAgreementItemExemptionFamilyMemberElements. These elements include: EmployeePayrollInputVersionReferences, ObjectID, ToBeReplicatedVersionDeletedIndicator, ToBeReplicatedVersionValidityPeriod, ToBeReplicatedVersionUUID, NewVersionUUID, and LastSuccessfullyReplicatedVersionUUID. EmployeePayrollInputVersionReferences include references to a version of the EmploymentItemWorkAgreementItemEmployeeTaxArrangementWorkAgreementItemExemptionFamilyMember, and may be based on datatype BOIDT: EmployeePayrollInputVersionReferences. ObjectID may be optional, is an identifier of a node in an object, and may be based on datatype GDT: ObjectID. ObjectID may be a primary object node identifier, or, if the node is a derived node and a primary node does not exist, ObjectID may include a generated identifier. ToBeReplicatedVersionDeletedIndicator is an indicator that a primary node for a version that is about to be replicated to a provider or has already been replicated to a provider but has not yet been confirmed as successful has been deleted on a primary object. ToBeReplicatedVersionDeletedIndicator may be based on datatype GDT: Indicator, with a qualifier of Deleted. ToBeReplicatedVersionValidityPeriod may be optional, is a validity period of a version that is about to be replicated to a provider or has already been replicated to a provider but has not yet been confirmed as successful, and may be based on datatype GDT: CLOSED_DatePeriod, with a qualifier of Validity. ToBeReplicatedVersionUUID may be optional, is a universally unique identifier for a version that is about to be replicated to a provider or has already been replicated to the provider but has not yet been confirmed as successful. The identifier may be created or adjusted when a payroll administrator decides to start replication to a provider. ToBeReplicatedVersionUUID may be based on datatype GDT: UUID. NewVersionUUID is a universally unique identifier for a version that reflects the latest changes of a primary object, and may be based on datatype GDT: UUID. LastSuccessfullyReplicatedVersionUUID may be optional, is a universally unique identifier for a version last replicated to a provider where the provider has confirmed that a replication was successful. The identifier may be created or adjusted when a provider confirms successful replication of the data. LastSuccessfullyReplicatedVersionUUID may be based on datatype GDT: UUID. A Employment Item Work Agreement Item Employee Tax Arrangement Work Agreement Item Exemption Family composition relationship to the subordinate node Member Version may exist, with a cardinality of 1:N. A Primary IN_Employee Tax Arrangement Work Agreement Item Exemption Family Member inbound aggregation relationship may exist from the business object IN_Employee Tax Arrangement/node Work Agreement Item Exemption Family Member Cross DU, with a cardinality of 1:C, which represents the Work Agreement Item Exemption Family Member node of the IN_Employee Tax Arrangement BO to which the Employment Item Work Agreement Item Employee Tax Arrangement Exemption Family Member node applies. A LastSuccesfullyReplicatedEmploymentItemWorkAgreementItemEmployeeTaxArrangementWorkAgreementItemExemptionFamilyMemberVersion specialization association for navigation may exist to the business object IN_Employee Payroll Input/Employment Item Work Agreement Item Employee Tax Arrangement Work Agreement Item Exemption Family Member Version, which represents the employment item work agreement item employee tax arrangement work agreement item exemption family member version last replicated to a provider where the provider has confirmed that a replication was successful. The association may be created or adjusted when a provider confirms successful replication of the data. A NewEmploymentItemWorkAgreementItemEmployeeTaxArrangementWorkAgreementItemExemptionFamilyMemberVersion association may exist to the business object IN_Employee Payroll Input/Employment Item Work Agreement Item Employee Tax Arrangement Work Agreement Item Exemption Family Member Version, which represents the employment item work agreement item employee tax arrangement work agreement item exemption family member version that reflects the latest changes of a primary object. A ToBeReplicatedEmploymentItemWorkAgreementItemEmployeeTaxArrangementWorkAgreementItemExemptionFamilyMemberVersion association may exist to the business object IN_Employee Payroll Input/Employment Item Work Agreement Item Employee Tax Arrangement Work Agreement Item Exemption Family Member Version, which represents the employment item work agreement item employee tax arrangement work agreement item exemption family member version that is about to be replicated to a provider or has already been replicated to the provider but has not yet been confirmed as a successful replication. The association may be created or adjusted when a payroll administrator decides to start replication to a provider.

Employment Item Work Agreement Item Employee Tax Arrangement Work Agreement Item Exemption Family Member Version is a version of the Employment Item Work Agreement Item Employee Tax Agreement Work Agreement Item Exemption Family Member, and may be time dependent on Validity Period. The elements located directly at the node Employment Item Work Agreement Item Employee Tax Arrangement Work Agreement Item Exemption Family Member Version are defined by the data type IN_EmployeePayrollInputEmploymentItemWorkAgreementItemEmployeeTaxArrangementWorkAgreementItemExemptionFamilyMemberVersionElements. These elements include: UUID, LastChangeDateTime, DeletedIndicator, and BusinessPartnerUUID. UUID may be an alternative key, is a universally unique identifier that identifies a WorkAgreementItemExemptionFamilyMemberVersion node, and may be based on datatype GDT: UUID. LastChangeDateTime is a date and time stamp of a last change, and may be based on datatype GDT: GLOBAL_DateTime, with a qualifier of LastChange. DeletedIndicator is an indicator that a node has been logically deleted, and may be based on datatype GDT: Indicator, with a qualifier of Deleted. BusinessPartnerUUID is a universally unique identifier that identifies a Family Member, and may be based on datatype GDT: UUID.

Employment Item Work Agreement Item Employee Tax Arrangement Work Agreement Item Investment is a set of tax-relevant investment details to a tax calculation for Indian payroll and reporting purposes for an Employee for a particular validity period. The elements located directly at the node Employment Item Work Agreement Item Employee Tax Arrangement Work Agreement Item Investment are defined by the data type IN_EmployeePayrollInputEmploymentItemWorkAgreementItemEmployeeTaxArrangementWorkAgreementItemInvestmentElements. These elements include: EmployeePayrollInputVersionReferences, ObjectID, ToBeReplicatedVersionDeletedIndicator, ToBeReplicatedVersionValidityPeriod, ToBeReplicatedVersionUUID, NewVersionUUID, and LastSuccessfullyReplicatedVersionUUID. EmployeePayrollInputVersionReferences includes references to a version of the EmploymentItemWorkAgreementItemEmployeeTaxArrangementWorkAgreementItemInvestment node and may be based on datatype BOIDT: EmployeePayrollInputVersionReferences. ObjectID may be optional, is an identifier of a node in an object, and may be based on datatype GDT: ObjectID. ObjectID may be a primary object node identifier, or, if the node is a derived node and a primary node does not exist, ObjectID may include a generated identifier.

ToBeReplicatedVersionDeletedIndicator is an indicator that a primary node for a version that is about to be replicated to a provider or has already been replicated to a provider but has not yet been confirmed as successful has been deleted on a primary object. ToBeReplicatedVersionDeletedIndicator may be based on datatype GDT: Indicator, with a qualifier of Deleted. ToBeReplicatedVersionValidityPeriod may be optional, is a validity period of a version that is about to be replicated to a provider or has already been replicated to a provider but has not yet been confirmed as successful, and may be based on datatype GDT: CLOSED_DatePeriod, with a qualifier of Validity. ToBeReplicatedVersionUUID may be optional, is a universally unique identifier for a version that is about to be replicated to a provider or has already been replicated to a provider but has not yet been confirmed as successful. The identifier may be created or adjusted when a payroll administrator decides to start replication to a provider. ToBeReplicatedVersionUUID may be based on datatype GDT: UUID. NewVersionUUID is a universally unique identifier for a version that reflects the latest changes of a primary object, and may be based on datatype GDT: UUID. LastSuccessfullyReplicatedVersionUUID may be optional and is a universally unique identifier for a version last replicated to a provider where the provider has confirmed that a replication was successful. The identifier may be created or adjusted when a provider confirms successful replication of the data. LastSuccessfullyReplicatedVersionUUID may be based on datatype GDT: UUID. The following composition relationships to subordinate nodes may exist: Employment Item Work Agreement Item Employee Tax Arrangement Work Agreement Item Investment Version, with a cardinality of 1:N; and Employment Item Work Agreement Item Employee Tax Arrangement Work Agreement Item Investment Tax Reduction Basis, with a cardinality of 1:N. A Primary IN_Employee Tax Arrangement Work Agreement Item Investment inbound aggregation relationship may exist from the business object IN_Employee Tax Arrangement/node Work Agreement Item Investment Cross DU, with a cardinality of 1:C, which represents the Work Agreement Item Investment node of the IN_Employee Tax Arrangement BO to which the Employment Item Work Agreement Item Employee Tax Arrangement Investment node applies. A LastSuccesfullyReplicatedEmploymentItemWorkAgreementItemEmployeeTaxArrangementWorkAgreementItemInvestmentVersion specialization association for navigation may exist to the business object IN_Employee Payroll Input/Employment Item Work Agreement Item Employee Tax Arrangement Work Agreement Item Investment Version, which represents the employment item work agreement item employee tax arrangement work agreement item investment version last replicated to the provider where the provider has confirmed that a replication was successful. The association may be created or adjusted when a provider confirms successful replication of the data. A NewEmploymentItemWorkAgreementItemEmployeeTaxArrangementWorkAgreementItemInvestmentVersion may exist to the business object IN_Employee Payroll Input/Employment Item Work Agreement Item Employee Tax Arrangement Work Agreement Item Investment Version, which represents the employment item work agreement item employee tax arrangement work agreement item investment version that reflects the latest changes of the primary object. A ToBeReplicatedEmploymentItemWorkAgreementItemEmployeeTaxArrangementWorkAgreementhemInvestmentVersion association may exist to the business object IN_Employee Payroll Input/Employment Item Work Agreement Item Employee Tax Arrangement Work Agreement Item Investment Version, which represents the employment item work agreement item employee tax arrangement work agreement item investment version that is about to be replicated to a provider or has already been replicated to the provider but has not yet been confirmed as a successful replication. The association may be created or adjusted when a payroll administrator decides to start replication to a provider.

Employment Item Work Agreement Item Employee Tax Arrangement Work Agreement Item Investment Version is a version of the Employment Item Work Agreement Item Employee Tax Agreement Work Agreement Item Investment, and may be time dependent on Validity Period. The elements located directly at the node Employment Item Work Agreement Item Employee Tax Arrangement Work Agreement Item Investment Version are defined by the data type IN_EmployeePayrollInputEmploymentItemWorkAgreementItemEmployeeTaxArrangementWorkAgreementItemInvestmentVersionElements. These elements include: UUID, LastChangeDateTime, DeletedIndicator, ValidityPeriod, and FixedIndicator. UUID may be an alternative key, is a universally unique identifier that identifies a WorkAgreementItemInvestmentVersion node, and may be based on datatype GDT: UUID. LastChangeDateTime is a date and time stamp of a last change, and may be based on datatype GDT: GLOBAL_DateTime, with a qualifier of LastChange. DeletedIndicator is an indicator that a node has been logically deleted, and may be based on datatype GDT: Indicator, with a qualifier of Deleted. ValidityPeriod is a validity period of the WorkAgreementItemnvestmentVersion node, and may be based on datatype GDT: CLOSED_DatePeriod, with a qualifier of Validity. FixedIndicator indicates whether an employee has fixed an investment, and may be based on datatype GDT: Indicator, with a qualifier of Fixed.

Employment Item Work Agreement Item Employee Tax Arrangement Work Agreement Item Investment Tax Reduction Basis is a tax reduction basis due to an investment of an employee relevant to a tax calculation for Indian payroll and reporting purposes for an Employee for a particular validity period. The elements located directly at the node Employment Item Work Agreement Item Employee Tax Arrangement Work Agreement Item Investment Tax Reduction Basis are defined by the data type IN_EmployeePayrollInputEmploymentItemWorkAgreementItemEmployeeTaxArrangementWorkAgreementItemInvestmentTaxReductionBasisElements. These elements include: EmployeePayrollInputVersionReferences, ObjectID, ToBeReplicatedVersionDeletedIndicator, ToBeReplicatedVersionValidityPeriod, ToBeReplicatedVersionUUID, NewVersionUUID, and LastSuccessfullyReplicatedVersionUUID. EmployeePayrollInputVersionReferences includes references to a version of the EmploymentItemWorkAgreementItemEmployeeTaxArrangementWorkAgreementItemInvestmentTaxReductionBasis node, and may be based on datatype BOIDT: EmployeePayrollInputVersionReferences. ObjectID may be optional, is an identifier of the node in an object, and may be based on datatype GDT: ObjectID. ObjectID may be a primary object node ID if there is one node from where the information comes in one of the primary objectIDs. If the node is a derived node and a primary node does not exist, ObjectID may include a generated ID. ToBeReplicatedVersionDeletedIndicator is an indicator that a primary node for a version that is about to be replicated to a provider or has already been replicated to a provider but has not yet been confirmed as successful has been deleted on a primary object. ToBeReplicatedVersionDeletedIndicator may be based on datatype GDT: Indicator, with a qualifier of Deleted. ToBeReplicatedVersionValidityPeriod may be optional, is a validity period of a version that is about to be replicated to a provider or has already been replicated to a provider but has not yet been confirmed as successful. ToBeReplicatedVersionValidityPeriod may be based on datatype GDT: CLOSED_DatePeriod, with a qualifier of Validity. ToBeReplicatedVersionUUID may be optional, is a universally unique identifier for a version that is about to be replicated to a provider or has already been replicated to the provider but has not yet been confirmed as successful. The identifier may be created or adjusted when a payroll administrator decides to start replication to a provider. ToBeReplicatedVersionUUID may be based on datatype GDT: UUID. NewVersionUUID is a universally unique identifier for a version that reflects the latest changes of a primary object, and may be based on datatype GDT: UUID. LastSuccessfullyReplicatedVersionUUID may be optional, is a universally unique identifier for a version last replicated to a provider where the provider has confirmed that a replication was successful. The identifier may be created or adjusted when a provider confirms successful replication of the data. LastSuccessfullyReplicatedVersionUUID may be based on datatype GDT: UUID. A Reduction Basis Version composition relationship to the subordinate node Employment Item Work Agreement Item Employee Tax Arrangement Work Agreement Item Investment Tax may exist, with a cardinality of 1:N. A Primary IN_Employee Tax Arrangement Work Agreement Item Investment Tax Reduction Basis inbound aggregation relationship from the business object IN_Employee Tax Arrangement/node Work Agreement Item Investment Tax Reduction Basis Cross DU may exist, with a cardinality of 1:C, which represents the Work Agreement Item Investment Tax Reduction Basis node of the IN_Employee Tax Arrangement BO to which the Employment Item Work Agreement Item Employee Tax Arrangement Investment Tax Reduction Basis node applies. A LastSuccesfullyReplicatedEmploymentItemWorkAgreementItemEmployeeTaxArrangementWorkAgreementItemInvestmentTaxReductionBasisVersion specialization association for navigation may exist to the business object IN_Employee Payroll Input/Employment Item Work Agreement Item Employee Tax Arrangement Work Agreement Item Investment Tax Reduction Basis Version, which represents the employment item work agreement item employee tax arrangement work agreement item investment tax reduction basis version last replicated to a provider where the provider has confirmed that a replication was successful. The association may be created or adjusted when a provider confirms successful replication of the data. A NewEmploymentItemWorkAgreementItemEmployeeTaxArrangementWorkAgreementItemInvestmentTaxReductionBasisVersion association may exist to the business object IN_Employee Payroll Input/Employment Item Work Agreement Item Employee Tax Arrangement Work Agreement Item Investment Tax Reduction Basis Version, which represents the employment item work agreement item employee tax arrangement work agreement item investment tax reduction basis version that reflects the latest changes of a primary object. A ToBeReplicatedEmploymentItemWorkAgreementItemEmployeeTaxArrangementWorkAgreementhemInvestmentTaxReductionBasisVersion may exist to the business object IN_Employee Payroll Input/Employment Item Work Agreement Item Employee Tax Arrangement Work Agreement Item Investment Tax Reduction Basis Version, which represents the employment item work agreement item employee tax arrangement work agreement item investment tax reduction basis version that is about to be replicated to a provider or has already been replicated to the provider but not yet been confirmed as a successful replication. The association may be created or adjusted when a payroll administrator decides to start replication to a provider.

Employment Item Work Agreement Item Employee Tax Arrangement Work Agreement Item Investment Tax Reduction Basis Version is a version of the Employment Item Work Agreement Item Employee Tax Agreement Work Agreement Item Investment Tax Reduction Basis, and may be time dependent on Validity Period. The elements located directly at the node Employment Item Work Agreement Item Employee Tax Arrangement Work Agreement Item Investment Tax Reduction Basis Version are defined by the data type IN_EmployeePayrollInputEmploymentItemWorkAgreementItemEmployeeTaxArrangementWorkAgreementItemInvestmentTaxReductionBasisVersionElements. These elements include: UUID, LastChangeDateTime, DeletedIndicator, EmployeeTaxationBasisReductionTypeCode, PlannedInvestmentAmount, and FinalInvestmentAmount. UUID may be an alternative key, is a universally unique identifier that identifies an EmploymentItemWorkAgreementItemEmployeeTaxArrangementWorkAgreementItemInvestmentTaxReductionBasisVersion node, and may be based on datatype GDT: UUID. LastChangeDateTime is a date and time stamp of a last change, and may be based on datatype GDT: GLOBAL_DateTime, with a qualifier of LastChange. DeletedIndicator is an indicator that a node has been logically deleted, and may be based on datatype GDT: Indicator, with a qualifier of Deleted. EmployeeTaxationBasisReductionTypeCode is a coded representation of a reduction type which may be applied to a tax basis of an employee, and may be based on datatype GDT: EmployeeTaxationBasisReductionTypeCode. PlannedInvestmentAmount may be optional, is a planned amount of an investment over a tax year, and may be based on datatype GDT: CURRENCYINR_MEDIUM_Amount, with a qualifier of Investment. FinalInvestmentAmount may be optional, is a final amount of an investment over a tax year, and may be based on datatype GDT: CURRENCYINR_MEDIUM_Amount, with a qualifier of Investment.

An Employment Item WorkAgreement Item Employee Social Insurance Arrangement Work Agreement Item Period Terms is a set of generic social insurance relevant to a social insurance calculation for Indian payroll and reporting purposes for an Employee, in a particular validity period. The elements located at the node Employment Item Work Agreement Item Employee Social Insurance Arrangement Work Agreement Item Period Terms are defined by the data type: IN_EmployeePayrollInputEmploymentItemWorkAgreementItemEmployeeSocialInsuranceArrangementWorkAgreementItemPeriodTermsElements, and may include EmployeePayrollInputVersionReferences. EmployeePayrollInputVersionReferences are references to a version of the node, and may include ObjectID, ToBeReplicatedVersionDeletedIndicator, ToBeReplicatedVersionValidityPeriod, ToBeReplicatedVersionUUID, NewVersionUUID, and LastSuccessfullyReplicatedVersionUUID. ObjectID may be optional, is an identifier of a node in an object, and may be based on datatype GDT: ObjectID. ObjectID may be a primary object node ID if there is one node from where the information comes in one of the primary objectIDs. If the node is a derived node and a primary node does not exist, ObjectID may include a generated ID. ToBeReplicatedVersionDeletedIndicator is an indicator that a primary node for a version that is about to be replicated to a provider or has already been replicated to a provider but not yet confirmed as successful has been deleted on a primary object. ToBeReplicatedVersionDeletedIndicator may be based on datatype GDT: Indicator, with a qualifier of Deleted. ToBeReplicatedVersionValidityPeriod may be optional, and is a validity period of a version that is about to be replicated to a provider or has already been replicated to a provider but not yet confirmed as successful. ToBeReplicatedVersionValidityPeriod may be based on datatype GDT: CLOSED_DatePeriod, with a qualifier of Validity. ToBeReplicatedVersionUUID may be optional, and is a universally unique identifier for a version that is about to be replicated to a provider or has already been replicated to a provider but not yet confirmed as successful. The identifier is created or adjusted when a payroll administrator decides to start replication to the provider. ToBeReplicatedVersionUUID may be based on datatype GDT: UUID. NewVersionUUID is a universally unique identifier for a version that reflects the latest changes of a primary object, and may be based on datatype GDT: UUID. LastSuccessfullyreplicatedVersionUUID may be optional, and is a universally unique identifier for a version last replicated to a provider where the provider has confirmed that the replication was successful. The identifier is created or adjusted when the provider confirms successful replication of the data. LastSuccessfullyreplicatedVersionUUID may be based on datatype GDT: UUID. A composition relationship Employment Item Work Agreement Item Employee Social Insurance Arrangement Work Agreement Item Period Terms Version to subordinate nodes may exist, with a cardinality of 1:N. From the business object IN_Employee Social Insurance Arrangement/node Work Agreement Item Period Terms, an inbound aggregation relationship Primary IN_Employee Social Insurance Arrangement Work Agreement Item Period Terms, with a cardinality of 1:C. To business object IN_Employee Payroll Input/Employment Item Work Agreement Item Employee Social Insurance Arrangement Work Agreement Item Period Terms Version, specialization associations for navigation may exist, including LastSuccesfullyReplicatedEmploymentItemWorkAgreementItemEmployeeSocialInsuranceArrangementWorkAgreementItemPeriodTermsVersion, NewEmploymentItemWorkAgreementItemEmployeeSocialInsuranceArrangementWorkAgreementItemPeriodTermsVersion, and ToBeReplicatedEmploymentItemWorkAgreementItemEmployeeSocialInsuranceArrangementWorkAgreementItemPeriodTermsVersion. LastSuccesfullyReplicatedEmploymentItemWorkAgreementItemEmployeeSocialInsuranceArrangementWorkAgreementItemPeriodTermsVersion has a target cardinality of C, and may be associated with employment item work agreement item employee social insurance arrangement work agreement item period terms last replicated to a provider where the provider has confirmed that the replication was successful. The association is created or adjusted when the provider confirms successful replication of the data. NewEmploymentItemWorkAgreementItemEmployeeSocialInsuranceArrangementWorkAgreementItemPeriodTermsVersion has a target cardinality of C, and may be associated with employment item work agreement item employee social insurance arrangement work agreement item period terms that reflects the latest changes of the primary object. ToBeReplicatedEmploymentItemWorkAgreementItemEmployeeSocialInsuranceArrangementWorkAgreementItemPeriodTermsVersion has a target cardinality of C, and may be associated with employment item work agreement item employee social insurance arrangement work agreement item period terms that are about to be replicated to a provider or have already been replicated to the provider but not yet been confirmed as a successful replication. The association is created or adjusted when a payroll administrator decides to start replication to the provider.

Employment Item Work Agreement Item Employee Social Insurance Arrangement Work Agreement Item Period Terms Version is a version of the Employment Item Work Agreement Item Employee Social Insurance Agreement Work Agreement Item Period Terms, and may be time dependent on Validity Period. The elements located directly at the node Employment Item Work Agreement Item Employee Social Insurance Arrangement Work Agreement Item Period Terms Version are defined by the data type IN_EmployeePayrollInputEmploymentItemWorkAgreementItemEmployeeSocialInsuranceArrangementWorkAgreementItemPeriodTermsVersionElements. These elements include: UUID, LastChangeDateTime, DeletedIndicator, ValidityPeriod, EmployeeSocialInsuranceID, TemporaryEmployeeSocialInsuranceID, HospitaNameText, LabourWelfareFundRelevanceIndicator, and GratuityEmployeeSocialInsuranceContributionAccountID. UUID may be an alternative key, is a universally unique identifier that identifies a EmploymentItemWorkAgreementItemEmployeeSocialInsuranceArrangementWorkAgreementItemPeriodTermsVersion node, and may be based on datatype GDT: UUID. LastChangeDateTime is a date and time stamp of a last change, and may be based on datatype GDT: GLOBAL_DateTime, with a qualifier of LastChange. DeletedIndicator is an indicator that a node has been logically deleted, and may be based on datatype GDT: Indicator, with a qualifier of Deleted. ValidityPeriod is a validity period of the EmploymentItemWorkAgreementItemEmployeeSocialInsuranceArrangementWorkAgreementItemPeriodTermsVersion node, and may be based on datatype GDT: CLOSED_DatePeriod, with a qualifier of Validity. EmployeeSocialInsuranceID may be optional, is a Social Insurance Arrangement account identification for an Employee, and may be based on datatype GDT: SocialInsuranceID. TemporaryEmployeeSocialInsuranceID may be optional, is a Temporary Social Insurance Arrangement account identification for an Employee, and may be based on datatype GDT: SocialInsuranceID. HospitalNameText may be optional, is a name of a Hospital recognized by a Social Insurance Arrangement of an Employee, and may be based on datatype GDT: LANGUAGEINDEPENDENT_MEDIUM_Text. LabourWelfareFundRelevanceIndicator indicates a relevance for a Labour Welfare Fund and may be based on datatype GDT: Indicator, with a qualifier of Relevance. GratuityEmployeeSocialInsuranceContributionAccountID may be optional, is a gratuity account identification of a Social Insurance Arrangement of an Employee, and may be based on datatype GDT: EmployeeSocialInsuranceContributionAccountID.

An Employment Item Work Agreement Item Employee Social Insurance Arrangement Work Agreement Item Pension Insurance is a set of relevant attributes of the Indian Pension Insurance for an Employee, in a particular validity period. The elements located at the node Employment Item Work Agreement Item Employee Social Insurance Arrangement Work Agreement Item Pension Insurance are defined by the data type: IN_EmployeePayrollInputEmploymentItemWorkAgreementItemEmployeeSocialInsuranceArrangementWorkAgreementItemPensionInsuranceElements, and may include EmployeePayrollInputVersionReferences. EmployeePayrollInputVersionReferences are references to a version of the node, and may include ObjectID, ToBeReplicatedVersionDeletedIndicator, ToBeReplicatedVersionValidityPeriod, ToBeReplicatedVersionUUID, NewVersionUUID, and LastSuccessfullyReplicatedVersionUUID. ObjectID may be may be optional, is an identifier of a node in an object, and may be based on datatype and may be based on datatype GDT: ObjectID. ObjectID may be a primary object node ID if there is one node from where the information comes in one of the primary objectIDs. If the node is a derived node and a primary node does not exist, ObjectID may include a generated ID. ToBeReplicatedVersionDeletedIndicator is an indicator that a primary node for a version that is about to be replicated to a provider or has already been replicated to a provider but not yet confirmed as successful has been deleted on a primary object. ToBeReplicatedVersionDeletedIndicator may be based on datatype and may be based on datatype GDT: Indicator, with a qualifier of Deleted. ToBeReplicatedVersionValidityPeriod may be may be optional, and is a validity period of a version that is about to be replicated to a provider or has already been replicated to a provider but not yet confirmed as successful. ToBeReplicatedVersionValidityPeriod may be based on datatype and may be based on datatype GDT: CLOSED_DatePeriod, with a qualifier of Validity. ToBeReplicatedVersionUUID may be may be optional, and is a universally unique identifier for a version that is about to be replicated to a provider or has already been replicated to a provider but not yet confirmed as successful. The identifier is created or adjusted when a payroll administrator decides to start replication to the provider. ToBeReplicatedVersionUUID may be based on datatype and may be based on datatype GDT: UUID. NewVersionUUID is a universally unique identifier for a version that reflects the latest changes of a primary object, and may be based on datatype and may be based on datatype GDT: UUID. LastSuccessfullyreplicatedVersionUUID may be may be optional, and is a universally unique identifier for a version last replicated to a provider where the provider has confirmed that the replication was successful. The identifier is created or adjusted when the provider confirms successful replication of the data. LastSuccessfullyreplicatedVersionUUID may be based on datatype and may be based on datatype GDT: UUID. A composition relationship Employment Item Work Agreement Item Employee Social Insurance Arrangement Work Agreement Item Pension Insurance Version to subordinate nodes may exist, with a cardinality of 1:N. From the business object IN_Employee Social Insurance Arrangement/node Work Agreement Item Pension Insurance, a Primary IN_Employee Social Insurance Arrangement Work Agreement Item Pension Insurance inbound aggregation relationship may exist, with a cardinality of 1:C. To business object IN_Employee Payroll Input/Employment Item Work Agreement Item Employee Social Insurance Arrangement Work Agreement Item Pension Insurance Version, specialization associations for navigation may exist, including LastSuccesfullyReplicatedEmploymentItemWorkAgreementItemEmployeeSocialInsuranceArrangementWorkAgreementItemPensionInsuranceVersion, NewEmploymentItemWorkAgreementItemEmployeeSocialInsuranceArrangementWorkAgreementItemPensionInsuranceVersion, and ToBeReplicatedEmploymentItemWorkAgreemenfitemEmployeeSocialInsuranceArrangementWorkAgreementItemPensionInsuranceVersion. LastSuccesfullyReplicatedEmploymentItemWorkAgreementItemEmployeeSocialInsuranceArrangementWorkAgreementItemPensionInsuranceVersion has a target cardinality of C, and may be associated with an employment item work agreement item employee social insurance arrangement work agreement item pension insurance last replicated to a provider where the provider has confirmed that the replication was successful. The association is created or adjusted when the provider confirms successful replication of the data. NewEmploymentItemWorkAgreementItemEmployeeSocialInsuranceArrangementWorkAgreementItemPensionInsuranceVersion has a target cardinality of C, and may be associated with an employment item work agreement item employee social insurance arrangement work agreement item pension insurance that reflects the latest changes of the primary object. ToBeReplicatedEmploymentItemWorkAgreementItemEmployeeSocialInsuranceArrangementWorkAgreementItemPensionInsuranceVersion has a target cardinality of C, and may be associated with an employment item work agreement item employee social insurance arrangement work agreement item pension insurance that is about to be replicated to a provider or has already been replicated to the provider but not yet been confirmed as a successful replication. The association is created or adjusted when a payroll administrator decides to start replication to the provider.

An Employment Item Work Agreement Item Employee Social Insurance Arrangement Work Agreement Item Pension Insurance Version is a version of the Employment Item Work Agreement Item Employee Social Insurance Arrangement Work Agreement Item Pension Insurance, and may be time dependent on validity period. The elements located directly at the node Employment Item Work Agreement Item Employee Social Insurance Arrangement Work Agreement Item Pension Insurance Version are defined by the data type: IN_EmployeePayrollInputEmploymentItemWorkAgreementItemEmployeeSocialInsuranceArrangementWorkAgreementItemPensionInsuranceVersionElements. These elements include: UUID, LastChangeDateTime, DeletedIndicator, ValidityPeriod, PensionFund, and ProvidentFund. UUID may be an alternative key, is a universally unique identifier that identifies an Employment Item Work Agreement Item Employee Social Insurance Arrangement Work Agreement Item Pension Insurance Version Elements node, and may be based on datatype GDT: UUID. LastChangeDateTime is a date and time stamp of a last change, and may be based on datatype GDT: GLOBAL_DateTime, with a qualifier of LastChange. DeletedIndicator is an indicator that a node has been logically deleted, and may be based on datatype GDT: Indicator, with a qualifier of Deleted. ValidityPeriod is a validity period of Employment Item Work Agreement Item Employee Social Insurance Arrangement Work Agreement Item Pension Insurance Version Elements, and may be based on datatype GDT: CLOSED_DatePeriod, with a qualifier of Validity. PensionFund may be optional, is a set of relevant attributes of a pension fund where contributions towards pension are deposited, and may be based on datatype BOIDT: IN_EmployeePayrollInputEmploymentItemWorkAgreementItemEmployeeSocialInsuranceAgreementWorkAgreementItemPensionInsuranceVersionPensionFund. Pension may include the following attributes: BusinessPartnerUUID, EmployeeSocialInsuranceContributionAccountID, and EmployerPaymentIndicator. BusinessPartnerUUID is a universally unique identifier that identifies a Pension Insurance Business Partner, and may be based on datatype GDT: UUID. EmployeeSocialInsuranceContributionAccountID may be optional, is an identifier of a contribution account of an employee assigned by a Pension Insurance Authority, and may be based on datatype GDT: EmployeeSocialInsuranceContributionAccountID. EmployerPaymentIndicator indicates whether an employer contributes to a Pension fund, and may be based on datatype GDT: Indicator, with a qualifier of EmployerPayment. ProvidentFund may be optional, is a set of relevant attributes of a Provident Fund trust where contributions towards Pension Insurance are deposited, and may be based on datatype BOIDT: IN_EmployeePayrollInputEmploymentItemWorkAgreementItemEmployeeSocialInsuranceAgreementWorkAgreementItemPensionInsuranceVersionProvidentFund. ProvidentFund may include the following attributes: BusinessPartnerUUID, EmployeeSocialInsuranceContributionAccountID, AdditionalEmployeeContributionPercent, and AdditionalEmployeeContributionAmount. BusinessPartnerUUID is a universally unique identifier that identifies a Provident Fund Business Partner, and may be based on datatype GDT: UUID. EmployeeSocialInsuranceContributionAccountID may be optional, is an identifier of a contribution account of an employee assigned by a Provident Fund, and may be based on datatype GDT: EmployeeSocialInsuranceContributionAccountID. AdditionalEmployeeContributionPercent may be optional, is a contribution percent for an additional contribution for a Provident Fund of an Employee, and may be based on datatype GDT: SMALLNONNEGATIVE_Percent, with a qualifier of Contribution. AdditionalEmployeeContributionAmount may be optional, is a contribution amount for an additional contribution for a Provident Fund of an Employee, and may be based on datatype GDT: CURRENCYINR_MEDIUM_Amount, with a qualifier of Contribution.

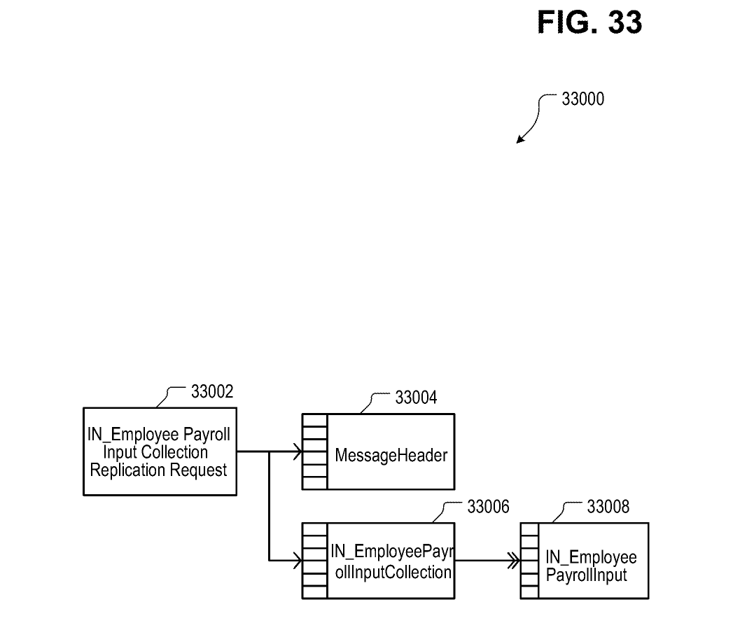

FIG. 33 depicts an example IN_Employee Payroll Input Replication Request Message Data Type 33000, which comprises 33002-33008, hierarchically related as shown. For example, the IN_Employee Payroll Input Replication Request 33002 includes a MessageHeader 33004.

The message type IN_Employee Payroll Input Collection Replication Request is derived from a business object as a leading object together with its operation signature. The structure of the message type IN_Employee Payroll Input Collection Replication Request is determined by the message data type IN_EmployeePayrollInputCollectionReplicationRequestMessage. The message data type IN_EmployeePayrollInputCollectionReplicationRequestMessage includes the object IN_EmployeePayrollInputCollection which is included in a business document, business information that is relevant for sending a business document in a message, the MessageHeader package, and the IN_EmployeePayrollInputCollection package. The message data type IN_EmployeePayrollInputCollectionReplicationRequestMessage provides a structure for the IN_Employee Payroll Input Collection Replication Request message type and for associated operations.

The MessageHeader package is a grouping of business information that is relevant for sending a business document in a message. The MessageHeader package includes the MessageHeader node. The MessageHeader node is a grouping of business information from the perspective of a sending application, such as information to identify the business document in a message, information about the sender, and optionally information about the recipient. The MessageHeader includes SenderParty and RecipientParty. MessageHeader may be based on the datatype GDT:BusinessDocumentMessageHeader.

The following elements of the GDT may be used: RecipientParty, BusinessScope, SenderParty, SenderBusinessSystemID, TestDataIndicator, RecipientBusinessSystemID, ReferenceID, ReferenceUUID, ReconciliationIndicator, ID, UUID, and CreationDateTime.

SenderParty is the partner responsible for sending a business document at a business application level. The SenderParty is of the type GDT:BusinessDocumentMessageHeaderParty. RecipientParty is of the type GDT:BusinessDocumentMessageHeaderParty. RecipientParty is the partner responsible for receiving a business document at a business application level.

The IN_EmployeePayrollInputCollection package is a grouping of IN_EmployeePayrollInputCollection with its IN_EmployeePayrollInput package and with the IN_EmployeePayrollInputCollection entity. IN_EmployeePayrollInputCollection includes the node element IN_EmployeePayrollInput in a 1:N cardinality relationship. The IN_EmployeePayrollInputCollectionIN_EmployeePayrollInput package is a grouping of the packages IN_EmployeePayrollInputReplicationRequest and Employee.

IN_EmployeePayrollInput includes the ObjectNodeReference non-node element. ObjectNodeReference is a unique reference to a IN_EmployeePayrollInputReplicationRequest node and may be based on datatype GDT:ObjectNodeReference. IN_EmployeePayrollInput includes the node element PayrollProcessAssignment in a 1:C cardinality relationship and the node element Employee in a 1:1 cardinality relationship.

The IN_EmployeePayrollInputCollectionIN_EmployeePayrollInputIN_EmployeePayrollInputReplicationRequest package includes the PayrollProcessAssignment entity. PayrollProcessAssignment includes the following non-node elements: PayrollProcessID, PayrollProcessPayrollProviderID, and PayrollProcessCurrentStepID. PayrollProcessID may be based on datatype GDT:BusinessTransactionDocumentID. PayrollProcessPayrollProviderID may be based on datatype GDT:BusinessTransactionDocumentID. PayrollProcessCurrentStepID may be based on datatype GDT:PayrollProcessStepID.

The IN_EmployeePayrollInputCollectionIN_EmployeePayrollInputEmployee package includes the Employee entity. Employee includes the following attributes: ActionCode, CommonListCompleteTransmissionIndicator, EmployeeWorkplaceAddressListCompleteTransmissionIndicator, AddressInformationListCompleteTransmissionIndicator, EmployeeTaxArrangementPeriodTermsInformationListCompleteTransmissionIndicator, and EmploymentItemListCompleteTransmissionIndicator, ActionCode is a coded representation of an instruction to a recipient of a message describing how to process a transmitted element and may be based on datatype GDT:ActionCode. CommonListCompleteTransmissionIndicator specifies whether common data in a message is transmitted in its entirety. “Complete transmission” may mean a complete transmission of all child elements of an element that are relevant for a message. When an element is deleted, all child elements are regarded as also deleted. With a complete transmission in this case, only an identification of an object is transferred. CommonListCompleteTransmissionIndicator may be based on datatype CDT:Indicator with a qualifier of CompleteTransmission. EmployeeWorkplaceAddressListCompleteTransmissionIndicator specifies whether employeeWorkplaceAddressList data in a message is transmitted in its entirety and may be based on datatype CDT:Indicator with a qualifier of CompleteTransmission. AddressInformationListCompleteTransmissionIndicator specifies whether addressInformationList data in a message is transmitted in its entirety and may be based on datatype CDT:Indicator with a qualifier of CompleteTransmission. EmployeeTaxArrangementPeriodTermsInformationListCompleteTransmissionIndicator specifies whether employeeTaxArrangementPeriodTermsInformationList data in a message is transmitted in its entirety and may be based on datatype CDT:Indicator with a qualifier of CompleteTransmission. EmploymentItemListCompleteTransmissionIndicator specifies whether employmentItemList data in a message is transmitted in its entirety and may be based on datatype CDT:Indicator with a qualifier of CompleteTransmission.

The IN_EmployeePayrollInputReplicationRequestEmployee package includes the non-node elements: UUID and EmployeeID. UUID may be based on datatype GDT:UUID. EmployeeID may be based on datatype GDT:EmployeeID. The IN_EmployeePayrollInputReplicationRequestEmployee package includes a node element Common in a 1:CN cardinality relationship, a node element EmployeeWorkplaceAddressInformation in a 1:CN cardinality relationship, a node element AddressInformation in a 1:CN cardinality relationship, a node element EmployeeTaxArrangementPeriodTerms in a 1:CN cardinality relationship, and a node element EmploymentItem in a 1:CN cardinality relationship.

Common includes general time-dependent information for an employee. Common includes the ActionCode attribute. ActionCode is a coded representation of an instruction to a recipient of a message describing how to process a transmitted element and may be based on datatype GDT:ActionCode. Common includes the following non-node elements: ObjectNodeReference and ValidityPeriod. ObjectNodeReference is a unique reference to an IN_EmployeePayrollInputReplicationRequestEmployeeCommon node and may be based on datatype GDT:ObjectNodeReference. ValidityPeriod may be optional and may be based on datatype GDT:CLOSED_DatePeriod with a qualifier of Validity. In some implementations, if the value of the attribute ActionCode is “Delete”, only the ObjectNodeReference is filled. In some implementations, if the value of the attribute @ActionCode is “Save” or “Create and No Action” then ValidityPeriod is filled.

Common may include the node element Person in a 1:C cardinality relationship. Person is an employee of a category Person. Person includes the NameListCompleteTransmissionIndicator attribute, which specifies whether the nameList data in a message is transmitted in its entirety and which may be based on datatype CDT:Indicator with a qualifier of CompleteTransmission. Common includes the following non-node elements: GenderCode, BirthPlaceName, BirthDate, MaritalStatusCode, NonVerbalCommunicationLanguageCode, and NationalityCountryCode. GenderCode may be optional and may be based on datatype GDT:GenderCode. BirthPlaceName may be optional and may be based on datatype CDT:LANGUAGEINDEPENDENT_MEDIUM_Name with a qualifier of BirthPlace. BirthDate may be optional and may be based on datatype CDT:Date with a qualifier of Birth. MaritalStatusCode may be optional and may be based on datatype GDT:MaritalStatusCode. NonVerbalCommunicationLanguageCode may be optional and may be based on datatype GDT:LanguageCode. NationalityCountryCode may be optional and may be based on datatype GDT:CountryCode.

Person includes the node element Name in a 1:CN cardinality relationship. Name Is the name of an Employee. Name includes the ActionCode attribute. ActionCode is a coded representation of an instruction to a recipient of a message describing how to process a transmitted element and may be based on datatype GDT:ActionCode. Person includes the non-node element PersonName, which may be optional and which may be based on datatype GDT:PersonName.

The IN_EmployeePayrollInputCollectionIN_EmployeePayrollInputEmploymentItem package includes the EmploymentItem EmploymentItem includes the following attributes: ActionCode, DisabilityListCompleteTransmissionIndicator, EmployeeTaxArrangementPreviousEmploymentListCompleteTransmissionIndicator, and WorkAgreementItemListCompleteTransmissionIndicator. ActionCode is a coded representation of an instruction to a recipient of a message describing how to process a transmitted element, and may be based on datatype GDT:ActionCode. DisabilityListCompleteTransmissionIndicator may be based on datatype CDT:Indicator with a qualifier of CompleteTransmission. EmployeeTaxArrangementPreviousEmploymentListCompleteTransmissionIndicator specifies whether employeeTaxArrangementPreviousEmploymentList data in a message is transmitted in its entirety, and may be based on datatype CDT:Indicator with a qualifier of CompleteTransmission. WorkAgreementItemListCompleteTransmissionIndicator specifies whether workAgreementItemList data in a message is transmitted in its entirety, and may be based on datatype CDT:Indicator with a qualifier of CompleteTransmission. EmploymentItem includes the following non-node elements: ObjectNodeReference and CountryCode. ObjectNodeReference is a unique reference to an EmploymentItemVersion node and may be based on datatype GDT:ObjectNodeReference. CountryCode may be optional and may be based on datatype GDT:CountryCode.

EmploymentItem includes the node element EmployeeTaxArrangementPreviousEmployment in a 1:CN cardinality relationship. EmployeeTaxArrangementPreviousEmployment includes the following attributes: ActionCode and EmploymentItemPreviousEmploymentCompensationComponentListCompleteTransmissionIndicator. EmploymentItemPreviousEmploymentCompensationComponentListCompleteTransmissionIndicator specifies whether employmentItemPreviousEmploymentCompensationComponent data in a message is transmitted in its entirety, and may be based on datatype CDT:Indicator with a qualifier of CompleteTransmission. ActionCode is a coded representation of an instruction to a recipient of a message describing how to process a transmitted element, and may be based on datatype GDT:ActionCode. EmployeeTaxArrangementPreviousEmployment includes the following non-node elements: ObjectNodeReference, LeaveTravelAllowanceNumberValue, LeaveTravelAllowanceRelevanceIndicator, ValidityPeriod, and EmploymentItemEmployeeTaxArrangementEmploymentItemPreviousEmploymentVersion. ObjectNodeReference is a unique reference to an EmploymentItemEmployeeTaxArrangementEmploymentItemPreviousEmploymentVersion node and may be based on datatype GDT:ObjectNodeReference. ValidityPeriod may be based on datatype GDT:CLOSED_DatePeriod. LeaveTravelAllowanceNumberValue may be optional and may be based on datatype GDT:SMALL_NumberValue. LeaveTravelAllowanceRelevanceIndicator may be based on datatype CDT:Indicator with a qualifier of Relevance. EmploymentItemPreviousEmploymentCompensationComponent may be on datatype MIDT:IN_EmplPyrlInptRplctnReqEmplEmplymtItmEmplTxArrgmtPrevEmplymtCompnComponent. EmploymentItemPreviousEmploymentCompensationComponent may include the following elements: ActionCode, UUID, ObjectNodeReference, TaxationCategoryCode, and TaxationCategoryAmount. ActionCode may be optional, is a coded representation of an instruction to a recipient of a message describing how to process a transmitted element, and may be based on datatype GDT:ActionCode. UUID may be based on datatype GDT:UUID. ObjectNodeReference may be based on datatype GDT:ObjectNodeReference. TaxationCategoryCode may be based on datatype GDT:CompensationComponentTaxationCategoryCode. TaxationCategoryAmount may be based on datatype CDT:CURRENCYINR_MEDIUM_Amount. In some implementations, if the value of the attribute ActionCode is “Delete”, only an ObjectNodeReference is filled. In some implementations, if the value of the attribute ActionCode is other than “Delete”, then ValidityPeriod is also be filled.

The IN_EmployeePayrollInputCollectionIN_EmployeePayrollInputEmploymentItemWorkAgreementItem package includes the WorkAgreementItem entity. WorkAgreementItem is information relevant for payroll processing for an employee who applies for a specific WorkAgreement. WorkAgreementItem includes the following attributes: ActionCode, EmployeePayrollAgreementItemListCompleteTransmissionIndicator, PermanentEstablishmentListCompleteTransmissionIndicator, WageSeperationListCompleteTransmissionIndicator, EmployeeTimeCalendarValuatedTimeListCompleteTransmissionIndicator, EmployeeTimeCalendarPlannedWorkingTimeListCompleteTransmissionIndicator, EmployeeTimeCalendarAggregatedPlannedWorkingTimePerPayrollPeriodListCompleteTransmissionIndicator, ValuatedAverageWorkingTimetListCompleteTransmissionIndicator, EmployeeTimeCalendarTimeAccountPayoutListCompleteTransmissionIndicator, EmployeeTimeAccountBalanceListCompleteTransmissionIndicator, EmplCompnAgrmtItemCompensationComponentDetailListCompleteTransmissionIndicator, EmployeeTaxArrangementPeriodTermsListCompleteTransmissionIndicator, EmployeeTaxArrangementExemptionListCompleteTransmissionIndicator, EmployeeTaxArrangementInvestmentListCompleteTransmissionIndicator, EmployeeSocialInsuranceArrangementPeriodTermsListCompleteTransmissionIndicator, EmployeeSocialInsuranceArrangementPensionInsuranceListCompleteTransmissionIndicator, and ExpenseReportSettlementResultDetailListCompleteTransmissionIndicator.

ActionCode may be optional, is a coded representation of an instruction to a recipient of a message describing how to process a transmitted element and may be based on datatype GDT:ActionCode. EmployeePayrollAgreementItemListCompleteTransmissionIndicator specifies whether employeePayrollAgreementItemList data in a message is transmitted in its entirety and may be based on datatype CDT:Indicator with a qualifier of CompleteTransmission. PermanentEstablishmentListCompleteTransmissionIndicator specifies whether permanentEstablishmentList data in a message is transmitted in its entirety and may be based on datatype CDT:Indicator with a qualifier of CompleteTransmission. WageSeperationListCompleteTransmissionIndicator specifies whether wageSeperationListdata in a message is transmitted in its entirety and may be based on datatype CDT:Indicator with a qualifier of CompleteTransmission. EmployeeTimeCalendarValuatedTimeListCompleteTransmissionIndicator specifies whether employeeTimeCalendarValuatedTimeList data in a message is transmitted in its entirety and may be based on datatype CDT:Indicator with a qualifier of CompleteTransmission. EmployeeTimeCalendarPlannedWorkingTimeListCompleteTransmissionIndicator specifies whether employeeTimeCalendarPlannedWorkingTimeList data in a message is transmitted in its entirety and may be based on datatype CDT:Indicator with a qualifier of CompleteTransmission. EmployeeTimeCalendarAggregatedPlannedWorkingTimePerPayrollPeriodListCompleteTransmissionIndicator may be based on datatype CDT:Indicator. ValuatedAverageWorkingTimetListCompleteTransmissionIndicator specifies whether valuatedAverageWorkingTimetList data in a message is transmitted in its entirety and may be based on datatype CDT:Indicator with a qualifier of CompleteTransmission. EmployeeTimeCalendarTimeAccountPayoutListCompleteTransmissionIndicator specifies whether employeeSocialInsuranceArrangementPeriodTermsList data in a message is transmitted in its entirety and may be based on datatype CDT:Indicator with a qualifier of CompleteTransmission. EmployeeTimeAccountBalanceListCompleteTransmissionIndicator specifies whether employeeSocialInsuranceArrangementPeriodTermsList data in a message is transmitted in its entirety and may be based on datatype CDT:Indicator with a qualifier of CompleteTransmission. EmplCompnAgrmtItemCompensationComponentDetailListCompleteTransmissionIndicator specifies whether employeeSocialInsuranceArrangementPeriodTermsList data in a message is transmitted in its entirety and may be based on datatype CDT:Indicator with a qualifier of CompleteTransmission. EmployeeTaxArrangementPeriodTermsListCompleteTransmissionIndicator specifies whether employeeSocialInsuranceArrangementPeriodTermsList data in a message is transmitted in its entirety and may be based on datatype CDT:Indicator with a qualifier of CompleteTransmission. EmployeeTaxArrangementExemptionListCompleteTransmissionIndicator specifies whether employeeSocialInsuranceArrangementPeriodTermsList data in a message is transmitted in its entirety and may be based on datatype CDT:Indicator with a qualifier of CompleteTransmission. EmployeeTaxArrangementInvestmentListCompleteTransmissionIndicator specifies whether employeeSocialInsuranceArrangementPeriodTermsList data in a message is transmitted in its entirety and may be based on datatype CDT:Indicator with a qualifier of CompleteTransmission. EmployeeSocialInsuranceArrangementPeriodTermsListCompleteTransmissionIndicator specifies whether employeeSocialInsuranceArrangementPeriodTermsList data in a message is transmitted in its entirety and may be based on datatype CDT:Indicator with a qualifier of CompleteTransmission. EmployeeSocialInsuranceArrangementPensionInsuranceListCompleteTransmissionIndicator specifies whether employeeSocialInsuranceArrangementPensionInsuranceList data in a message is transmitted in its entirety and may be based on datatype CDT:Indicator with a qualifier of CompleteTransmission. ExpenseReportSettlementResultDetailListCompleteTransmissionIndicator may be based on datatype CDT:Indicator with a qualifier of Complete Transmission.

WorkAgreementItem includes the following non-node elements: ObjectNodeReference, ValidityPeriod, PayrollProviderWorkAgreementID, WorkAgreementTypeCode, and AdministrativeCategoryCode. ObjectNodeReference is a unique reference to a WorkAgreementItem node and may be based on datatype GDT:ObjectNodeReference. ValidityPeriod may be optional and may be based on datatype GDT:CLOSED_DatePeriod with a qualifier of Validity. An associated Duration might not be used. PayrollProviderWorkAgreementID may be optional, is a unique identifier for an employee or work agreement at a payroll provider. A work agreement may be originally stored in a ByDesign element at the EmployeePayrollAgreementItem. PayrollProviderWorkAgreementID may be based on datatype GDT:WorkAgreementID with a qualifier of PayrollProvider. WorkAgreementTypeCode may be optional and may be based on datatype GDT:WorkAgreementTypeCode. AdministrativeCategoryCode may be optional and may be based on datatype GDT:WorkAgreementAdministrativeCategoryCode. In some implementations, if the value of the attribute ActionCode is “Delete”, only the ObjectNodeReference is filled. In some implementations, if the value of the attribute @ActionCode is “Save” or “Create and No Action”, then ValidityPeriod, WorkAgreementTypeCode and AdministrativeCategoryCode may be filled.

WorkAgreementItem includes the node element EmployeePayrollAgreementItem in a 1:CN cardinality relationship, the node element PermanentEstablishment in a 1:CN cardinality relationship, the node element CostCentre in a 1:CN cardinality relationship, the node element WageSeparation in a 1:CN cardinality relationship, the node element EmployeeTimeCalendarValuatedTime in a 1:CN cardinality relationship, the node element EmployeeTimeCalendarPlannedWorkingTime in a 1:CN cardinality relationship, the node element EmployeeTimeCalendarAggregatedPlannedWorkingTimePerPayrollPeriod in a 1:CN cardinality relationship, the node element ValuatedAverageWorkingTime in a 1:CN cardinality relationship, the node element EmployeeTimeCalendarTimeAccountPayout in a 1:CN cardinality relationship, the node element EmployeeTimeAccountBalance in a 1:CN cardinality relationship, the node element EmployeeCompensationAgreementItemCompensationComponentDetail in a 1:CN cardinality relationship, the node element EmployeeTaxArrangementPeriodTerms in a 1:CN cardinality relationship, the node element EmployeeTaxArrangementExemption in a 1:CN cardinality relationship, the node element EmployeeTaxArrangementInvestment in a 1:CN cardinality relationship, the node element EmployeeSocialInsuranceArrangementPeriodTerms in a 1:CN cardinality relationship, the node element EmployeeSocialInsuranceArrangementPensionInsurance in a 1:CN cardinality relationship, and the node element ExpenseReportSettlementResult in a 1:CN cardinality relationship.

EmployeePayrollAgreementItem includes the following attributes: ActionCode, PayrollProcessingConditionsListCompleteTransmissionIndicator, MainPaymentListCompleteTransmissionIndicator, and FurtherPaymentsPlanListCompleteTransmissionIndicator. ActionCode is a coded representation of an instruction to a recipient of a message describing how to process a transmitted element and may be based on datatype GDT:ActionCode. PayrollProcessingConditionsListCompleteTransmissionIndicator specifies whether payrollProcessingConditionsList data in a message is transmitted in its entirety and may be based on datatype CDT:Indicator with a qualifier of CompleteTransmission. MainPaymentListCompleteTransmissionIndicator specifies whether mainPaymentList data in a message is transmitted in its entirety and may be based on datatype CDT:Indicator with a qualifier of CompleteTransmission. FurtherPaymentsPlanListCompleteTransmissionIndicator specifies whether furtherPaymentsPlanList data in a message is transmitted in its entirety and may be based on datatype CDT:Indicator with a qualifier of CompleteTransmission.

EmployeePayrollAgreementItem includes the following non-node elements: ObjectNodeReference and PayrollProviderWorkAgreementID. ObjectNodeReference is a unique reference to an EmployeePayrollAgreementItemVersion node and may be based on datatype GDT:ObjectNodeReference. PayrollProviderWorkAgreementID may be optional and may be based on datatype GDT:WorkAgreementID with a qualifier of PayrollProvider.

EmployeePayrollAgreementItem includes the node element PayrollProcessingConditions in a 1:CN cardinality relationship, the node element MainPayment in a 1:CN cardinality relationship, and the node element FurtherPaymentsPlan in a 1:CN cardinality relationship.

PayrollProcessingConditions is a set of conditions which apply for processing an Employee through payroll.

PayrollProcessingConditions includes the ActionCode attribute. ActionCode is a coded representation of an instruction to a recipient of a message describing how to process a transmitted element and may be based on datatype GDT:ActionCode. PayrollProcessingConditions includes the following non-node elements: ObjectNodeReference, ValidityPeriod, PayrollGroupCode, and PayrollInactiveIndicator. ObjectNodeReference is a unique reference to a PayrollProcessingConditionsVersion node and may be based on datatype GDT:ObjectNodeReference. ValidityPeriod may be optional and may be based on datatype GDT:CLOSED_DatePeriod with a qualifier of Validity. PayrollGroupCode may be optional and may be based on datatype GDT:PayrollGroupCode. PayrollInactiveIndicator may be based on datatype CDT:Indicator with a qualifier of Inactive. In some implementations, a default is that an employee is active for payroll.

MainPayment is a main payment of a net amount calculated in payroll processing for a validity period. MainPayment includes the ActionCode attribute. ActionCode is a coded representation of an instruction to a recipient of a message describing how to process a transmitted element and may be based on datatype GDT:ActionCode. MainPayment includes the following non-node elements: ObjectNodeReference, ValidityPeriod, PaymentFormCode, and PaymentComponentBusinessTransactionDocumentBankAccount. ObjectNodeReference is a unique reference to a MainPaymentVersion node and may be based on datatype GDT:ObjectNodeReference. ValidityPeriod may be optional and may be based on datatype GDT:CLOSED_DatePeriod with a qualifier of Validity. PaymentFormCode may be optional and may be based on datatype GDT:PaymentFormCode. PaymentComponentBusinessTransactionDocumentBankAccount may be optional and may be based on datatype GDT:ADDRESSINDEPENDENT_BusinessTransactionDocumentBankAccount_V1.

FurtherPaymentsPlan is a plan for payment of a portion of a net amount calculated in payroll processing to one or more further bank accounts or recipients other than that recorded in a MainPayment for a validity period. FurtherPaymentsPlan includes the following attributes: ActionCode and ComponentListCompleteTransmissionIndicator. ActionCode is a coded representation of an instruction to a recipient of a message describing how to process a transmitted element and may be based on datatype GDT:ActionCode. ComponentListCompleteTransmissionIndicator specifies whether componentList data in a message is transmitted in its entirety and may be based on datatype CDT:Indicator with a qualifier of CompleteTransmission. FurtherPaymentsPlan includes the following non-node elements: ObjectNodeReference, ValidityPeriod, and Component. ObjectNodeReference is a unique reference to a FurtherPaymentsPlan node and may be based on datatype GDT:ObjectNodeReference. ValidityPeriod may be optional and may be based on datatype GDT:CLOSED_DatePeriod with a qualifier of Validity. Component may be based on datatype MIDT:IN_EmplPyrlInptRplctnReqEmplEmplymtlimWrkAgrmtItemFurtherPaymentPlanComponent. Component may include the following elements: ActionCode, Description, Amount, Percent, PaymentFormCode, and PaymentComponentBusinessTransactionDocumentBankAccount. ActionCode is a coded representation of an instruction to a recipient of a message describing how to process a transmitted element and may be based on datatype GDT:ActionCode. Description may be optional and may be based on datatype GDT:MEDIUM_Description. Percent may be optional and may be based on datatype CDT:SMALLNONNEGATIVE_Percent. Amount may be optional and may be based on datatype CDT:Amount. PaymentFormCode may be optional and may be based on datatype GDT:PaymentFormCode. PaymentComponentBusinessTransactionDocumentBankAccount may be optional and may be based on datatype GDT:ADDRESSINDEPENDENT_BusinessTransactionDocumentBankAccount_V1.

PermanentEstablishment is an organizational center that represents a geographically bound area of a company whose business activity is subject to uniform tax processing. PermanentEstablishment includes the ActionCode attribute. ActionCode is a coded representation of an instruction to a recipient of a message describing how to process a transmitted element and may be based on datatype GDT:ActionCode. PermanentEstablishment includes the following non-node elements: ObjectNodeReference, ValidityPeriod, and PermanentEstablishmentID. ObjectNodeReference is a unique reference to a PermanentEstablishment node and may be based on datatype GDT:ObjectNodeReference. ValidityPeriod may be based on datatype GDT:CLOSED_DatePeriod with a qualifier of Validity. An associated Duration might not be used. PermanentEstablishmentID may be based on datatype GDT:OrganisationalCentreID. In some implementations, if the value of the attribute ActionCode is “Delete”, only an ObjectNodeReference is filled.

CostCentre is an organizational center that represents a geographically bound area of a company whose business activity is subject to uniform tax processing. CostCentre includes the ActionCode attribute. ActionCode is a coded representation of an instruction to a recipient of a message describing how to process a transmitted element and may be based on datatype GDT:ActionCode. CostCentre includes the following non-node elements: ObjectNodeReference, ValidityPeriod, and CostCentreID. ObjectNodeReference is a unique reference to a CostCentre node and may be based on datatype GDT:ObjectNodeReference. ValidityPeriod may be optional and may be based on datatype GDT:CLOSED_DatePeriod. CostCentreID may be based on datatype GDT:OrganisationalCentreID. In some implementations, if the value of the attribute ActionCode is “Delete”, only an ObjectNodeReference is filled.

WageSeparation is a separation of wages. WageSeparation includes the ActionCode attribute. ActionCode is a coded representation of an instruction to a recipient of a message describing how to process a transmitted element and may be based on datatype GDT:ActionCode. WageSeparation includes the following non-node elements: ObjectNodeReference and Date. ObjectNodeReference is a unique reference to a WageSeparation node and may be based on datatype GDT:ObjectNodeReference. Date may be optional and may be based on datatype CDT:Date. In some implementations, if the value of the attribute ActionCode is “Delete” only an ObjectNodeReference is filled.

EmployeeTimeCalendarValuatedTime is an employee time which is enriched by information defining its monetary value in terms of payroll. EmployeeTimeCalendarValuatedTime includes the following attributes: ActionCode and PaymentListCompleteTransmissionIndicator. ActionCode is a coded representation of an instruction to a recipient of a message describing how to process a transmitted element and may be based on datatype GDT:ActionCode. PaymentListCompleteTransmissionIndicator specifies whether paymentList data in a message is transmitted in its entirety and may be based on datatype CDT:Indicator with a qualifier of CompleteTransmission. EmployeeTimeCalendarValuatedTime includes the following non-node elements: ObjectNodeReference, EmployeeTimeItemPayrollCategoryCode, EmployeeTimeItemPayrollTypeCode, Date, HourQuantity, HourQuantityTypeCode, DayQuantity, DayQuantityTypeCode, OriginalEmployeeTimeItemUUID, and OriginaIDatePeriod. ObjectNodeReference is a unique reference to an EmployeeTimeCalendarValuatedTime node and may be based on datatype GDT:ObjectNodeReference. EmployeeTimeItemPayrollCategoryCode may be optional and may be based on datatype GDT:EmployeeTimeItemPayrollCategoryCode. EmployeeTimeItemPayrollTypeCode may be optional and may be based on datatype GDT:EmployeeTimeItemPayrollTypeCode. Date may be optional and may be based on datatype CDT:Date. HourQuantity may be optional and may be based on datatype CDT:UNITHOUR_SMALL_Quantity. HourQuantityTypeCode may be optional and may be based on datatype GDT:QuantityTypeCode. DayQuantity may be optional and may be based on datatype CDT:Quantity. DayQuantityTypeCode may be optional and may be based on datatype GDT:QuantityTypeCode. OriginalEmployeeTimeItemUUID may be optional and may be based on datatype GDT:UUID. OriginalDatePeriod may be optional and may be based on datatype GDT:CLOSED_DatePeriod. In some implementations, if the value of the attribute ActionCode is “Delete”, only an ObjectNodeReference is filled. In some implementations, if the value of the attribute ActionCode is “Save” or “Create and No Action”, then EmployeeTimeItemPayrollCategoryCode, Date, HourQuantity, HourQuantityTypeCode may be filled.

EmployeeTimeCalendarValuatedTime includes the node element Payment in a 1:CN cardinality relationship. Payment is a payment for a EmployeeTimeCalendarValuatedTime. Payment includes the ActionCode attribute. ActionCode is a coded representation of an instruction to a recipient of a message describing how to process a transmitted element and may be based on datatype GDT:ActionCode. Payment includes the following non-node elements: EmployeeTimePayment and CompensationComponentPayrollCategoryCode. EmployeeTimePayment may be optional and may be based on datatype GDT:EmployeeTimePayment. CompensationComponentPayrollCategoryCode may be optional, is a coded representation of a Payroll Category, and may be based on datatype GDT:CompensationComponentPayrollCategoryCode.

EmployeeTimeCalendarPlannedWorkingTime is a time at which an employee is supposed to work according to his working time schedule. EmployeeTimeCalendarPlannedWorkingTime includes the ActionCode attribute. ActionCode is a coded representation of an instruction to a recipient of a message describing how to process a transmitted element and may be based on datatype GDT:ActionCode. EmployeeTimeCalendarPlannedWorkingTime includes the following non-node elements: ObjectNodeReference, EmployeeTimePlanningCategoryCode, Date, HourQuantity, HourQuantityTypeCode, PublicHolidayIndicator, and EmployeeTimePlanningCategoryCode. ObjectNodeReference is a unique reference to an EmployeeTimeCalendarPlannedWorkingTime node and may be based on datatype GDT:ObjectNodeReference. EmployeeTimePlanningCategoryCode may be optional and may be based on datatype GDT:EmployeeTimePlanningCategoryCode. Date may be optional and may be based on datatype CDT:Date. HourQuantity may be optional and may be based on datatype CDT:UNITHOUR_SMALL_Quantity. HourQuantityTypeCode may be optional and may be based on datatype GDT:QuantityTypeCode. PublicHolidayIndicator may be optional and may be based on datatype CDT:Indicator. EmployeePlannedWorkingTimeDayTypeCode may be optional and may be based on datatype GDT:EmployeePlannedWorkingTimeDayTypeCode. In some implementations, if the value of the attribute ActionCode is “Delete”, only the ObjectNodeReference is filled. In some implementations, if the value of the attribute ActionCode is “Save” or “Create and No Action”, then Date, HourQuantity, and HourQuantityTypeCode are filled.

ValuatedAverageWorkingTime represents periods with appropriate rates, which cover information about a valuated working time of a work agreement. ValuatedAverageWorkingTime includes the following attributes: ActionCode and PeriodListCompleteTransmissionIndicator. ActionCode is a coded representation of an instruction to a recipient of a message describing how to process a transmitted element and may be based on datatype GDT:ActionCode. PeriodListCompleteTransmissionIndicator specifies whether PeriodList data in a message is transmitted in its entirety and may be based on datatype CDT:Indicator with a qualifier of CompleteTransmission. ValuatedAverageWorkingTime includes ObjectNodeReference, which is a unique reference to an EmployeeTimeAgreementAverageWorkingTime node and which may be based on datatype GDT:ObjectNodeReference. In some implementations, if the value of the attribute ActionCode is “Delete”, only the Object is filled.

ValuatedAverageWorkingTime includes the node element Period in a 1:C cardinality relationship. Period includes special information for payroll accounting and a validity period regarding a subordinate node. Period includes the following attributes: ActionCode and RateListCompleteTransmissionIndicator. ActionCode is a coded representation of an instruction to a recipient of a message describing how to process a transmitted element and may be based on datatype GDT:ActionCode. RateListCompleteTransmissionIndicator specifies whether rateList data in a message is transmitted in its entirety and may be based on datatype CDT:Indicator with a qualifier of CompleteTransmission. ValuatedAverageWorkingTime includes the following non-node elements: ValidityPeriod and PayPeriodWorkingTimeRate. ValidityPeriod may be optional and may be based on datatype GDT:CLOSED_DatePeriod with a qualifier of Validity. PayPeriodWorkingTimeRate may be optional and may be based on datatype GDT:Rate. ValuatedAverageWorkingTime includes the node element Rate in a 1:C cardinality relationship.

EmployeeTimeCalendarTimeAccountPayout is a document on a payout of a monetary amount due to available time account balance of an Employee Time Account. EmployeeTimeCalendarTimeAccountPayout includes the following attributes: ActionCode and PaymentListCompleteTransmissionIndicator. ActionCode is a coded representation of an instruction to a recipient of a message describing how to process a transmitted element and may be based on datatype GDT:ActionCode. PaymentListCompleteTransmissionIndicator specifies whether paymentList data in a message is transmitted in its entirety and may be based on datatype CDT:Indicator. EmployeeTimeCalendarTimeAccountPayout includes the following non-node elements: ObjectNodeReference, Date, Quantity, and QuantityTypeCode. ObjectNodeReference is a unique reference to an EmployeeTimeAgreementAverageWorkingTime node and may be based on datatype GDT:ObjectNodeReference. Date may be optional and may be based on datatype CDT:Date. Quantity may be optional and may be based on datatype CDT:Quantity. QuantityTypeCode may be optional and may be based on datatype GDT:QuantityTypeCode. In some implementations, if the value of the attribute ActionCode is “Delete”, only an ObjectNodeReference is filled. In some implementations, if the value of the attribute ActionCode is “Save” or “Create and No Action”, then Date, Quantity, and QuantityTypeCode are filled.

EmployeeTimeCalendarTimeAccountPayout includes the node element Payment in a 1:C cardinality relationship. Payment documents amounts being paid out. Payment includes the ActionCode attribute. ActionCode is a coded representation of an instruction to a recipient of a message describing how to process a transmitted element and may be based on datatype GDT:ActionCode. Payment includes the following non-node elements: EmployeeTimePayment and CompensationComponentPayrollCategoryCode. EmployeeTimePayment may be optional and may be based on datatype GDT:EmployeeTimePayment. CompensationComponentPayrollCategoryCode may be optional, is a coded representation of a Payroll Category, and may be based on datatype GDT: CompensationComponentPayrollCategoryCode.

EmployeeTimeAccountBalance documents balances of an Employee Time Account. EmployeeTimeAccountBalance includes the ActionCode attribute. ActionCode is a coded representation of an instruction to a recipient of a message describing how to process a transmitted element and may be based on datatype GDT:ActionCode. EmployeeTimeAccountBalance includes the following non-node elements: ObjectNodeReference, TypeCode, Date, EmployeeTimeAccountPayrollTypeCode, IdentifyingPeriod, Quantity, and QuantityTypeCode. ObjectNodeReference is a unique reference to an EmployeeTimeAccountBalance node and may be based on datatype GDT:ObjectNodeReference. TypeCode may be optional and may be based on datatype GDT:EmployeeTimeAccountBalanceTypeCode. Date may be optional and may be based on datatype CDT:Date. EmployeeTimeAccountPayrollTypeCode may be optional and may be based on datatype GDT:EmployeeTimeAccountPayrollTypeCode. IdentifyingPeriod may be optional and may be based on datatype GDT:CLOSED_DatePeriod. Quantity may be optional and may be based on datatype CDT:Quantity. QuantityTypeCode may be optional and may be based on datatype GDT:QuantityTypeCode. In some implementations, if the value of the attribute ActionCode is “Delete”, only an ObjectNodeReference is filled. In some implementations, if the value of the attribute ActionCode is “Save” or “Create and No Action”, then Type, Quantity, and QuantityTypeCode are filled.

EmployeeCompensationAgreementItemCompensationComponentDetail is a time-dependent detail pertaining to a compensation component. EmployeeCompensationAgreementItemCompensationComponentDetail includes the ActionCode attribute. ActionCode is a coded representation of an instruction to a recipient of a message describing how to process a transmitted element and may be based on datatype GDT:ActionCode. EmployeeCompensationAgreementItemCompensationComponentDetail includes the following non-node elements: ObjectNodeReference, ValidityPeriod, CompensationComponentTypeUUID, CompensationComponentRecurrenceFrequencyCode, CompensationComponentPercent, CompensationComponentBusinessTransactionDocumentBankAccount, NoteToPayeeNote, EmployeeTimePaymentResultCompensationComponentTypePayrollCategoryCode, EmployeeTimePaymentResultCompensationComponentTypePayrollCategoryCode, CompensationComponentQuantity, and CompensationComponentQuantityTypeCode. ObjectNodeReference is a unique reference to an EmployeeCompensationAgreementItemCompensationComponentDetail node and may be based on datatype GDT:ObjectNodeReference. ValidityPeriod may be optional and may be based on datatype GDT:CLOSED_DatePeriod. CompensationComponentTypeID may be optional and may be based on datatype GDT:CompensationComponentTypeID. CompensationComponentTypeUUID may be optional and may be based on datatype GDT:UUID. CompensationComponentAmount may be optional and may be based on datatype CDT:Amount with a qualifier of CompensationComponent. CompensationComponentRecurrenceFrequencyCode may be optional and may be based on datatype GDT:COMPENSATIONCOMPONENT_RecurrenceFrequencyCode. CompensationComponentPercent may be optional and may be based on datatype CDT:Percent. CompensationComponentBusinessTransactionDocumentBankAccount may be optional and may be based on datatype GDT:ADDRESSINDEPENDENT_BusinessTransactionDocumentBankAccount_V1. NoteToPayeeNote may be optional and may be based on datatype GDT:MEDIUM_Note. In some implementations, for providers that can't handle the full functionality of CalendarDayRecurrence, only fields Value, RecurrenceFrequencyCode and FreqencyValue are filled. In some implementations, for providers that can't handle recurring payments, a CalendarDayRecurrence might not be filled. EmployeeTimePaymentResultCompensationComponentTypePayrollCategoryCode may be optional, is a coded representation of a Payroll Category and may be based on datatype GDT: CompensationComponentPayrollCategoryCode. CompensationComponentQuantity may be optional and may be based on datatype CDT:Quantity. CompensationComponentQuantityTypeCode may be optional and may be based on datatype GDT:QuantityTypeCode. In some implementations, if the value of the attribute ActionCode is “Delete”, only an ObjectNodeReference is filled. EmployeeCompensationAgreementItemCompensationComponentDetail includes the node element CompensationComponentCalendarDayRecurrence in a 1:C cardinality relationship. CompensationComponentCalendarDayRecurrence may be typed by CalendarDayRecurrence.

EmployeeTaxArrangementPeriodTerms includes the ActionCode attribute. ActionCode is a coded representation of an instruction to a recipient of a message describing how to process a transmitted element and may be based on datatype GDT:ActionCode. EmployeeTaxArrangementPeriodTerms includes the following non-node elements: ObjectNodeReference, UUID, ValidityPeriod, CityTaxationCategoryCode, ExemptedIndicator, and ProfessionalTaxRelevanceIndicator. ObjectNodeReference is a unique reference to an EmploymentItemWorkAgreementItemEmployeeTaxArrangementWorkAgreementItemPeriodTermsVersion node and may be based on datatype GDT:ObjectNodeReference. UUID may be based on datatype GDT:UUID. ValidityPeriod may be based on datatype GDT:CLOSED_DatePeriod. CityTaxationCategoryCode may be optional and may be based on datatype GDT:CityTaxationCategoryCode. HouseRentAmount may be based on datatype CDT:CURRENCYINR_MEDIUM_Amount with a qualifier of Rent. ExemptedIndicator may be based on datatype CDT:Indicator with a qualifier of Exempted. ProfessionalTaxRelevanceIndicator may be based on datatype CDT:Indicator with a qualifier of Relevance. In some implementations, if the value of the attribute ActionCode is “Delete”, only an ObjectNodeReference is filled. In some implementations, if the value of the attribute ActionCode is other than “Delete”, then ValidityPeriod, MonthlyAdjustmentIndicator, SpecialTaxExemptionIndicator and MunicipalityTaxRelevantIndicator are filled.

EmployeeTaxArrangementExemption includes the following attributes: ActionCode and WorkAgreementItemExemptionFamilyMemberListCompleteTransmissionIndicator. WorkAgreementItemExemptionFamilyMemberListCompleteTransmissionIndicator specifies whether workAgreementItemExemptionFamilyMember data in a message is transmitted in its entirety and may be based on datatype CDT:Indicator. ActionCode is a coded representation of an instruction to a recipient of a message describing how to process a transmitted element and may be based on datatype GDT:ActionCode. EmployeeTaxArrangementExemption includes the following non-node elements: ObjectNodeReference, ValidityPeriod, EmployeeTaxationExemptionTypeCode, EmployeeTaxationExemptionAmount, and EmployeeTaxArrangementExemptionFamilyMember. ObjectNodeReference is a unique reference to an EmploymentItemWorkAgreementItemEmployeeTaxArrangementWorkAgreementItemExemptionVersion node and may be based on datatype GDT:ObjectNodeReference. ValidityPeriod may be based on datatype GDT:CLOSED_DatePeriod. EmployeeTaxationExemptionTypeCode may be based on datatype GDT:EmployeeTaxationExemptionTypeCode. EmployeeTaxationExemptionAmount may be based on datatype CDT:CURRENCYINR_MEDIUM_Amount. EmployeeTaxArrangementExemptionFamilyMember may be based on datatype MIDT:IN_EmplPyrlInptRplctnReqEmplEmplymtItmWrkAgrmtItmEmplTxArrgmtExmpFamilyMember. EmployeeTaxArrangementExemptionFamilyMember includes the following elements: ActionCode, ObjectNodeReference, UUID, BusinessPartnerUUID, and BusinessPartnerInternalID. ActionCode may be optional, is a coded representation of an instruction to a recipient of a message describing how to process a transmitted element and may be based on datatype GDT:ActionCode. ObjectNodeReference may be based on datatype GDT:ObjectNodeReference. UUID may be based on datatype GDT:UUID. BusinessPartnerUUID may be based on datatype GDT:UUID. BusinessPartnerInternalID may be based on datatype GDT:BusinessPartnerInternalID.

EmployeeTaxArrangementInvestment includes the following attributes: ActionCode and WorkAgreementItemInvestmentTaxReductionBasisListCompleteTransmissionIndicator. WorkAgreementItemInvestmentTaxReductionBasisListCompleteTransmissionIndicator specifies whether workAgreementItemInvestmentTaxReductionBasis data in a message is transmitted in its entirety and may be based on datatype CDT:Indicator. ActionCode is a coded representation of an instruction to a recipient of a message describing how to process a transmitted element and may be based on datatype GDT:ActionCode. EmployeeTaxArrangementInvestment includes the following non-node elements: ObjectNodeReference, UUID, ValidityPeriod, FixedIndicator, and WorkAgreementItemInvestmentTaxReductionBasis. ObjectNodeReference is a unique reference to an EmploymentItemWorkAgreementItemEmployeeTaxArrangementWorkAgreementItemInvestmentVersion node and may be based on datatype GDT:ObjectNodeReference. UUID may be based on datatype GDT:UUID. ValidityPeriod may be based on datatype GDT:CLOSED_DatePeriod. FixedIndicator may be based on datatype CDT:Indicator with a qualifier of Fixed. WorkAgreementItemInvestmentTaxReductionBasis may be based on datatype MIDT:IN_EmployeeTaxArrangementWorkAgreementItemInvestmentTaxReductionBasis. WorkAgreementItemInvestmentTaxReductionBasis includes the following elements: ActionCode, ObjectNodeReference, UUID, EmployeeTaxationBasisReductionTypeCode, PlannedInventmentAmount, and FinalInvestmentAmount. ActionCode is a coded representation of an instruction to a recipient of a message describing how to process a transmitted element and may be based on datatype GDT:ActionCode. ObjectNodeReference may be based on datatype GDT:ObjectNodeReference. UUID may be based on datatype GDT:UUID. EmployeeTaxationBasisReductionTypeCode may be based on datatype GDT:EmployeeTaxationBasisReductionTypeCode. PlannedInvestmentAmount may be optional and may be based on datatype CDT:CURRENCYINR_MEDIUM_Amount with a qualifier of Investment. FinalInvestmentAmount may be optional and may be based on datatype CDT:CURRENCYINR_MEDIUM_Amount with a qualifier of Investment.

EmployeeSocialInsuranceArrangementPeriodTerms includes the ActionCode attribute. ActionCode is a coded representation of an instruction to a recipient of a message describing how to process a transmitted element and may be based on datatype GDT:ActionCode. EmployeeSocialInsuranceArrangementPeriodTerms includes the following non-node elements: ObjectNodeReference, UUID, ValidityPeriod, EmployeeSocialInsuranceID, TemporaryEmployeeSocialInsuranceID, HospitaNameText, LabourWelfareFundRelevanceIndicator and GratuityEmployeeSocialInsuranceContributionAccountID. ObjectNodeReference is a unique reference to an EmploymentItemWorkAgreementItemEmployeeSocialInsuranceArrangementWorkAgreementItemPeriodTermsVersion node and may be based on datatype GDT:ObjectNodeReference. UUID may be based on datatype GDT:UUID. ValidityPeriod may be based on datatype GDT:CLOSED_DatePeriod with a qualifier of Validity. EmployeeSocialInsuranceID may be optional and may be based on datatype GDT:SocialInsuranceID with a qualifier of Employee. TemporaryEmployeeSocialInsuranceID may be optional and may be based on datatype GDT:SocialInsuranceID. HospitalNameText may be optional and may be based on datatype CDT:LANGUAGEINDEPENDENT_MEDIUM_Text. LabourWelfareFundRelevanceIndicator may be based on datatype CDT:Indicator with a qualifier of Relevance. GratuityEmployeeSocialInsuranceContributionAccountID may be optional and may be based on datatype GDT:EmployeeSocialInsuranceContributionAccountID.

Employee SocialInsuranceArrangementPensionInsurance includes the following attributes: ActionCode, WorkAgreementItemPensionInsurancePensionFundListCompleteTransmissionIndicator, and WorkAgreementItemPensionInsuranceProvidentFundListCompleteTransmissionIndicator. WorkAgreementItemPensionInsurancePensionFundListCompleteTransmissionIndicator specifies whether WorkAgreementItemPensionInsurancePensionFund data in a message is transmitted in its entirety and may be based on datatype CDT:Indicator. WorkAgreementItemPensionInsuranceProvidentFundListCompleteTransmissionIndicator specifies whether WorkAgreementItemPensionInsuranceProvidentFund data in a message is transmitted in its entirety and may be based on datatype CDT:Indicator. ActionCode is a coded representation of an instruction to a recipient of a message describing how to process a transmitted element and may be based on datatype GDT:ActionCode. EmployeeSocialInsuranceArrangementPensionInsurance includes the following non-node elements: ObjectNodeReference, ValidityPeriod, UUID, PensionFund, and ProvidentFund. ObjectNodeReference is a unique reference to an mploymentItemWorkAgreementItemEmployeeSocialInsuranceArrangementWorkAgreementItemPensionInsuranceVersion node and may be based on datatype GDT:ObjectNodeReference. UUID may be based on datatype GDT:UUID. ValidityPeriod may be based on datatype GDT:CLOSED_DatePeriod with a qualifier of Validity. PensionFund may be based on datatype MIDT:IN_EmployeeSocialInsuranceArrangementWorkAgreementItemPensionInsurancePension Fund. ProvidentFund may be optional and may be based on datatype MIDT:IN_EmplSocialInsuranceArrangementWorkAgreementItemPensionInsuranceProvidentFund.

PensionFund includes the following elements: ActionCode, BusinessPartnerUUID, BusinessPartnerInternalID, EmployeeSocialInsuranceContributionAccountID, and EmployerPaymentIndicator. ActionCode may be optional, is a coded representation of an instruction to a recipient of a message describing how to process a transmitted element, and may be based on datatype GDT:ActionCode. BusinessPartnerUUID may be based on datatype GDT:UUID. BusinessPartnerInternalID may be based on datatype GDT:BusinessPartnerInternalID. EmployeeSocialInsuranceContributionAccountID may be optional and may be based on datatype GDT:EmployeeSocialInsuranceContributionAccountID. EmployerPaymentIndicator may be optional and may be based on datatype CDT:Indicator with a qualifier of EmployerPayment.

ProvidentFund includes the following elements: ActionCode, BusinessPartnerUUID, BusinessPartnerInternalID, EmployeeSocialInsuranceContributionAccountID, AdditionalEmployeeContributionPercent, and AdditionalEmployeeContributionAmount. ActionCode may be optional, is a coded representation of an instruction to a recipient of a message describing how to process a transmitted element and may be based on datatype GDT:ActionCode. BusinessPartnerUUID may be based on datatype GDT:UUID. BusinessPartnerInternalID may be based on datatype GDT:BusinessPartnerInternalID. EmployeeSocialInsuranceContributionAccountID may be optional and may be based on datatype GDT:EmployeeSocialInsuranceContributionAccountID. AdditionalEmployeeContributionPercent may be optional and may be based on datatype CDT:SMALLNONNEGATIVE_Percent with a qualifier of Contribution. AdditionalEmployeeContributionAmount may be optional and may be based on datatype CDT:CURRENCYINR_MEDIUM_Amount.

ExpenseReportSettlementResult includes the following attributes: ActionCode and PayrollTotalItemListCompleteTransmissionIndicator. ActionCode may be based on datatype GDT:ActionCode. PayrollTotalItemListCompleteTransmissionIndicator may be based on datatype CDT:Indicator with a qualifier of CompleteTransmission. ExpenseReportSettlementResult includes the following non-node elements: ObjectNodeReference, ExpenseReportID, ExpenseReportStartDate, ExpenseReportEndDate, and PostingTransactionBasePostingDate. ObjectNodeReference may be optional and may be based on datatype GDT:ObjectNodeReference. ExpenseReportID may be optional and may be based on datatype GDT:ExpenseReportID. ExpenseReportStartDate may be optional and may be based on datatype CDT:Date. ExpenseReportEndDate may be based on datatype CDT:Date. PostingTransactionBasePostingDate may be optional and may be based on datatype CDT:Date. In some implementations, if the value of the attribute ActionCode is “Delete”, only an ObjectNodeReference is filled.

ExpenseReportSettlementResult includes the node element PayrollTotalItem in a 1:CN cardinality relationship. PayrollTotalItem includes the components of an ExpenseReport that are subject to taxation and reporting in Payroll Processing. PayrollTotalItem includes the ActionCode attribute, which may be based on datatype GDT:ActionCode. PayrollTotalItem includes the following non-node elements: Amount, PayrollExpenseGroupCode, MealReceiptNumberValue, and Note. Amount may be optional and may be based on datatype CDT:Amount. PayrollExpenseGroupCode may be optional and may be based on datatype GDT:PayrollExpenseGroupCode. MealReceiptNumberValue may be based on datatype GDT:NumberValue. Note may be optional and may be based on datatype GDT:Note.

The EmployeeWorkAgreementItemWorkingAgreementItem package includes the Rate entity. Rate includes information about an average working time. Rate includes the ActionCode attribute. ActionCode is a coded representation of an instruction to a recipient of a message describing how to process a transmitted element and may be based on datatype GDT:ActionCode. Rate includes the non-node elements: Rate and PayPeriodWorkingTimeRate. Rate may be optional and may be based on datatype GDT:Rate. PayPeriodWorkingTimeRate may be optional and may be based on datatype GDT:WorkingTimeRate.

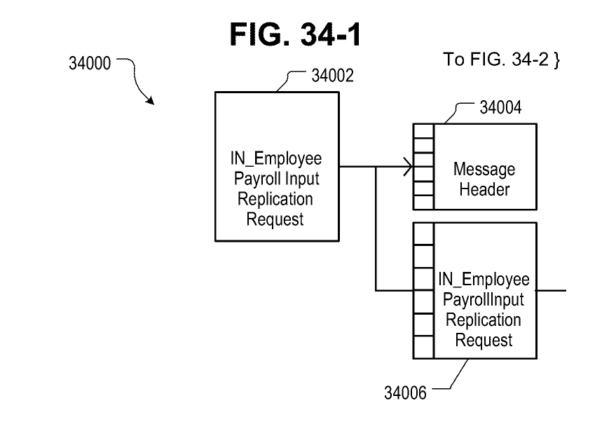

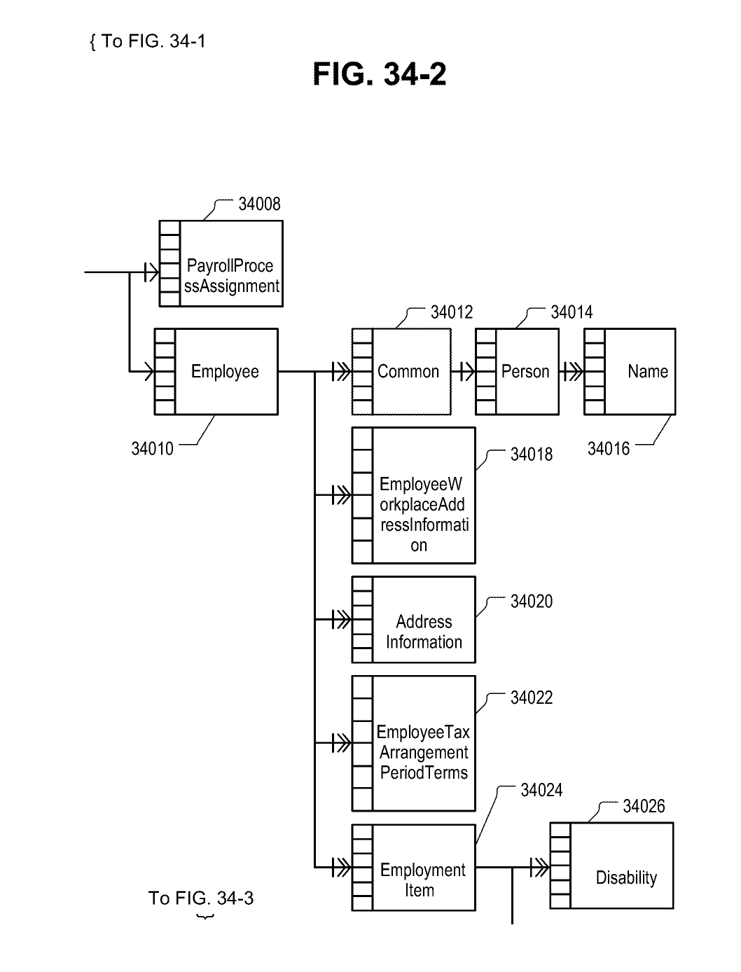

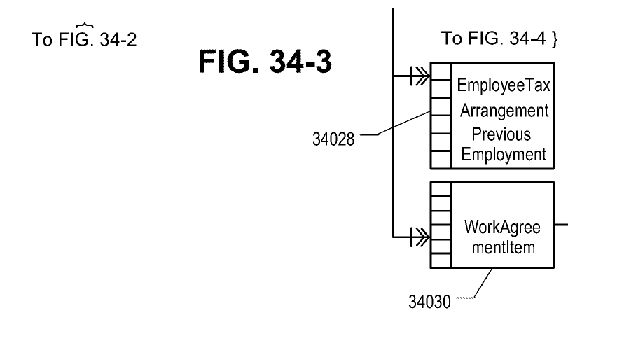

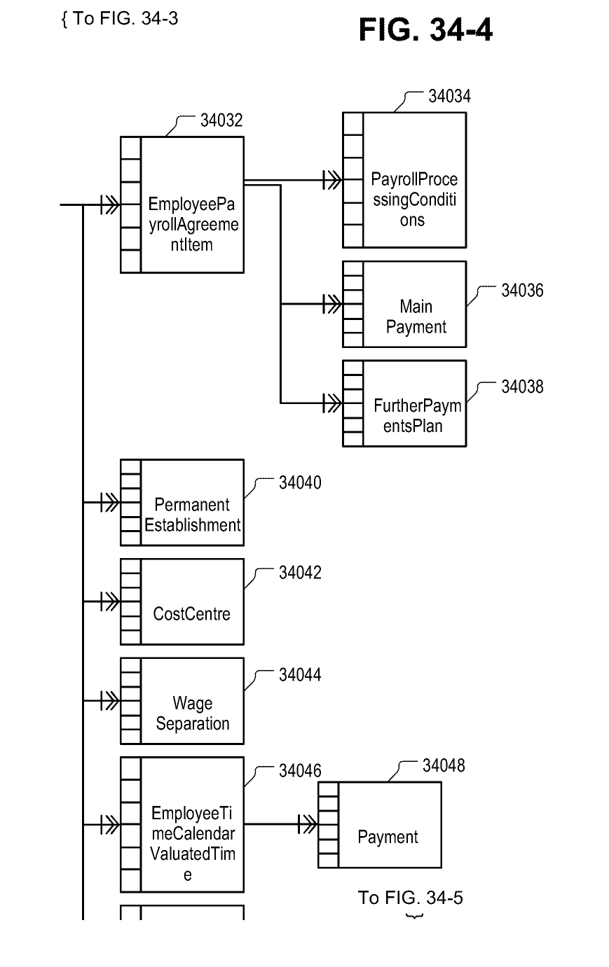

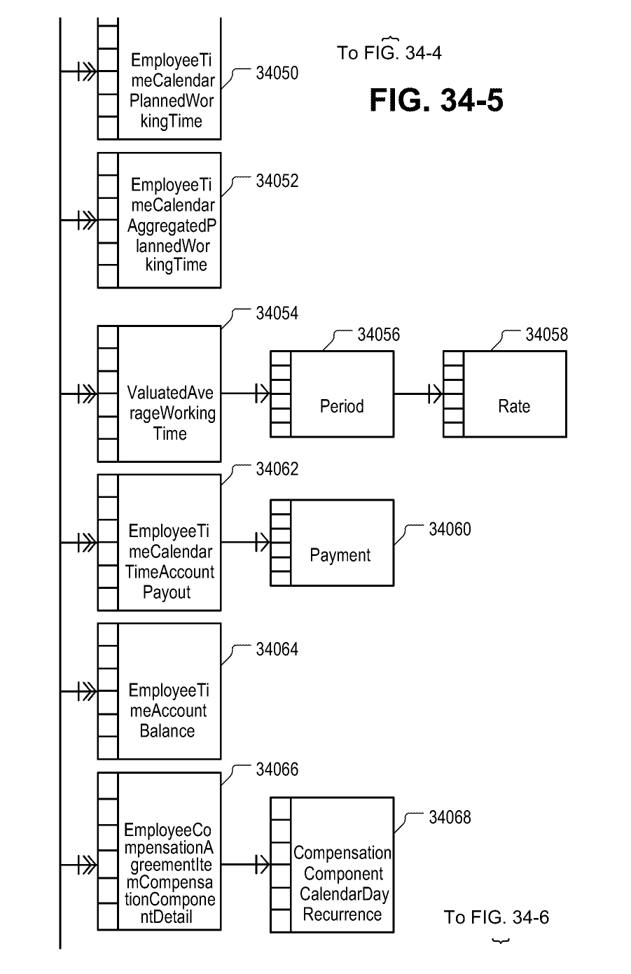

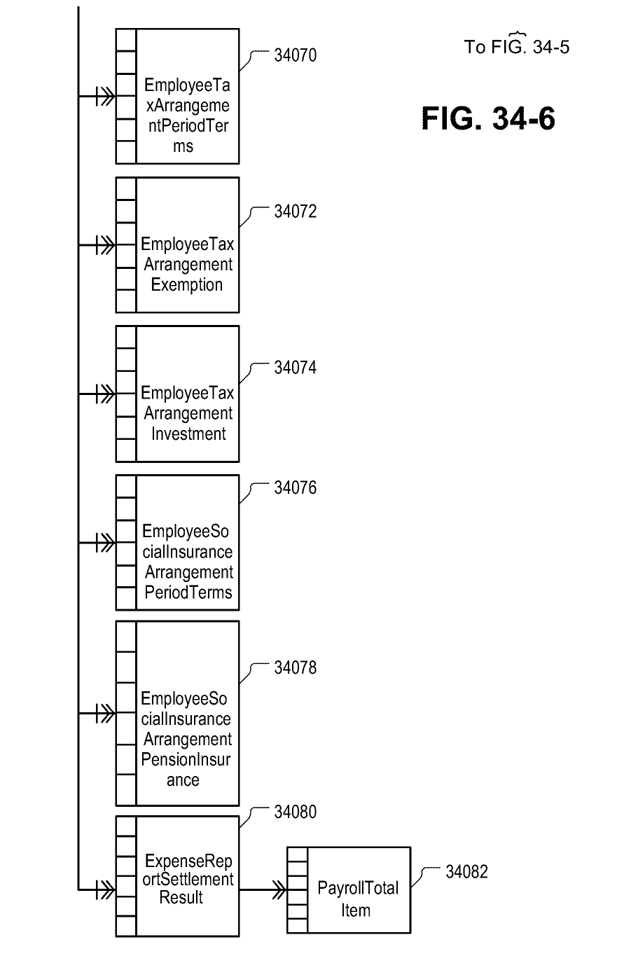

FIGS. 34-1 through 34-6 depict an example IN_Employee Payroll Input Collection Replication Request Message Data Type 34000, which comprises 34002-34082, hierarchically related as shown. For example, the IN_Employee Payroll Input Collection Replication Request 34002 includes a MessageHeader 34004.

The message type IN_Employee Payroll Input Replication Request is derived from the business object IN_Employee Payroll Input as a leading object together with its operation signature. The message type IN_Employee Payroll Input Replication Request is a replication request of an employee's payroll relevant data to an Indian Payroll Provider. Employee personal, tax, compensation, time and other information is used to correctly calculate his pay and produce pay checks. In addition an employee's bundle information is used for legal reporting purposes. The structure of the message type IN_Employee Payroll Input Replication Request is determined by the message data type IN_EmployeePayrollInputMessage. The IN_EmployeePayrollInputMessage message data type includes the object IN_EmployeePayrollInputReplicationRequest which is included in a business document, business information that is relevant for sending a business document in a message, the MessageHeader package, and the IN_EmployeePayrollInputReplicationRequest package. The message data type IN_EmployeePayrollInputMessage provides a structure for the IN_Employee Payroll Input Replication Request message type and for associated operations.

The MessageHeader package is a grouping of business information that is relevant for sending a business document in a message. The MessageHeader package includes the MessageHeader node. The MessageHeader node is a grouping of business information from the perspective of a sending application, such as information to identify the business document in a message, information about the sender, and optionally information about the recipient. The MessageHeader includes SenderParty and RecipientParty. MessageHeader may be based on the datatype GDT:BusinessDocumentMessageHeader.

The following elements of the GDT may be used: RecipientParty, BusinessScope, SenderParty, SenderBusinessSystemID, TestDataIndicator, RecipientBusinessSystemID, ReferenceID, ReferenceUUID, ReconciliationIndicator, ID, UUID, and CreationDateTime.

SenderParty is the partner responsible for sending a business document at a business application level. The SenderParty is of the type GDT:BusinessDocumentMessageHeaderParty. RecipientParty is of the type GDT:BusinessDocumentMessageHeaderParty. RecipientParty is the partner responsible for receiving a business document at a business application level.

The IN_EmployeePayrollInputReplicationRequest package is a grouping of IN_EmployeePayrollInputReplicationRequest with its Employee package and with the IN_EmployeePayrollInputReplicationRequest entity. IN_EmployeePayrollInputReplicationRequest includes employee specific guidelines that are used for a payroll provider to start a payroll run. IN_EmployeePayrollInputReplicationRequest includes the ObjectNodeReference non-node element. ObjectNodeReference is a unique reference to an IN_EmployeePayrollInputReplicationRequest node and may be based on datatype GDT:ObjectNodeReference. IN_EmployeePayrollInputReplicationRequest includes the node element PayrollProcessAssignment in a 1:C cardinality relationship and the Employee node element in a 1:1 cardinality relationship.

PayrollProcessAssignment includes the following non-node elements: PayrollProcessID, PayrollProcessPayrollProviderID, and PayrollProcessCurrentStepID. PayrollProcessID may be based on datatype GDT:BusinessTransactionDocumentID. PayrollProcessPayrollProviderID may be based on datatype GDT:BusinessTransactionDocumentID. PayrollProcessCurrentStepID may be based on datatype GDT:PayrollProcessStepID.

The IN_EmployeePayrollInputReplicationRequestEmployee package includes the Employee entity. Employee includes the following attributes: ActionCode, CommonListCompleteTransmissionIndicator, EmployeeWorkplaceAddressListCompleteTransmissionIndicator, AddressInformationListCompleteTransmissionIndicator, EmployeeTaxArrangementPeriodTermsInformationListCompleteTransmissionIndicator, and EmploymentItemListCompleteTransmissionIndicator, ActionCode is a coded representation of an instruction to a recipient of a message describing how to process a transmitted element and may be based on datatype GDT:ActionCode. CommonListCompleteTransmissionIndicator specifies whether common data in a message is transmitted in its entirety. “Complete transmission” may mean a complete transmission of all child elements of an element that are relevant for a message. When an element is deleted, all child elements are regarded as also deleted. With a complete transmission in this case, only an identification of an object is transferred. CommonListCompleteTransmissionIndicator may be based on datatype CDT:Indicator with a qualifier of CompleteTransmission. EmployeeWorkplaceAddressListCompleteTransmissionIndicator specifies whether employeeWorkplaceAddressList data in a message is transmitted in its entirety and may be based on datatype CDT:Indicator with a qualifier of CompleteTransmission. AddressInformationListCompleteTransmissionIndicator specifies whether addressInformationList data in a message is transmitted in its entirety and may be based on datatype CDT:Indicator with a qualifier of CompleteTransmission. EmployeeTaxArrangementPeriodTermsInformationListCompleteTransmissionIndicator specifies whether employeeTaxArrangementPeriodTermsInformationList data in a message is transmitted in its entirety and may be based on datatype CDT:Indicator with a qualifier of CompleteTransmission. EmploymentItemListCompleteTransmissionIndicator specifies whether employmentItemList data in a message is transmitted in its entirety and may be based on datatype CDT:Indicator with a qualifier of CompleteTransmission.

The IN_EmployeePayrollInputReplicationRequestEmployee package includes the non-node elements: UUID and EmployeeID. UUID may be based on datatype GDT:UUID. EmployeeID may be based on datatype GDT:EmployeeID. The IN_EmployeePayrollInputReplicationRequestEmployee package includes a node element Common in a 1:CN cardinality relationship, a node element EmployeeWorkplaceAddressInformation in a 1:CN cardinality relationship, a node element AddressInformation in a 1:CN cardinality relationship, a node element EmployeeTaxArrangementPeriodTerms in a 1:CN cardinality relationship, and a node element EmploymentItem in a 1:CN cardinality relationship.

Common includes general time-dependent information for an employee. Common includes the ActionCode attribute. ActionCode is a coded representation of an instruction to a recipient of a message describing how to process a transmitted element and may be based on datatype GDT:ActionCode. Common includes the following non-node elements: ObjectNodeReference and ValidityPeriod. ObjectNodeReference is a unique reference to an IN_EmployeePayrollInputReplicationRequestEmployeeCommon node and may be based on datatype GDT:ObjectNodeReference. ValidityPeriod may be optional and may be based on datatype GDT:CLOSED_DatePeriod with a qualifier of Validity. In some implementations, if the value of the attribute ActionCode is “Delete”, only the ObjectNodeReference is filled. In some implementations, if the value of the attribute @ActionCode is “Save” or “Create and No Action” then ValidityPeriod is filled.

Common may include the node element Person in a 1:C cardinality relationship. Person is an employee of a category Person. Person includes the NameListCompleteTransmissionIndicator attribute, which specifies whether the nameList data in a message is transmitted in its entirety and which may be based on datatype CDT:Indicator with a qualifier of CompleteTransmission. Common includes the following non-node elements: GenderCode, BirthPlaceName, BirthDate, MaritalStatusCode, NonVerbalCommunicationLanguageCode, and NationalityCountryCode. GenderCode may be optional and may be based on datatype GDT:GenderCode. BirthPlaceName may be optional and may be based on datatype CDT:LANGUAGEINDEPENDENT_MEDIUM_Name with a qualifier of BirthPlace. BirthDate may be optional and may be based on datatype CDT:Date with a qualifier of Birth. MaritalStatusCode may be optional and may be based on datatype GDT:MaritalStatusCode. NonVerbalCommunicationLanguageCode may be optional and may be based on datatype GDT:LanguageCode. NationalityCountryCode may be optional and may be based on datatype GDT:CountryCode.

Person includes the node element Name in a 1:CN cardinality relationship. Name Is the name of an Employee. Name includes the ActionCode attribute. ActionCode is a coded representation of an instruction to a recipient of a message describing how to process a transmitted element and may be based on datatype GDT:ActionCode. Person includes the non-node element PersonName, which may be optional and which may be based on datatype GDT:PersonName.

EmployeeWorkplaceAddressInformation includes an employee workplace address. EmployeeWorkplaceAddressInformation includes the following attributes: ActionCode and AddressUsageListCompleteTransmissionIndicator. ActionCode is a coded representation of an instruction to a recipient of a message describing how to process a transmitted element, and may be based on datatype GDT:ActionCode. AddressUsageListCompleteTransmissionIndicator specifies whether addressUsageList data in a message is transmitted in its entirety, and may be based on datatype CDT:Indicator with a qualifier of CompleteTransmission.

EmployeeWorkplaceAddressInformation includes the following non-node elements: ObjectNodeReference, ValidityPeriod, AddressUsage, OrganisationAddress, and WorkplaceAddress. ObjectNodeReference is a unique reference to an EmployeeWorkplaceAddressInformation node and may be based on datatype GDT:ObjectNodeReference. ValidityPeriod may be optional and may be based on datatype GDT:CLOSED_DatePeriod with a qualifier of Validity. AddressUsage may be optional and may be based on datatype MIDT:IN_EmplPyrlInptReplicationRequestEmployeeWorkplaceAddressInformationAddressUsage. OrganisationAddress may be optional and may be based on datatype GDT:OrganisationAddress. WorkplaceAddress may be optional and may be based on datatype GDT: WorkplaceAddress.

AddressUsage may include the following elements: ActionCode, ObjectNodeReference, AddressUsageCode, ValidityPeriod, and DefaultIndicator. ActionCode may be optional, is a coded representation of an instruction to a recipient of a message describing how to process a transmitted element, and may be based on datatype GDT:ActionCode. ObjectNodeReference is a unique reference to an AddressUsage node and may be based on datatype GDT:ObjectNodeReference. AddressUsageCode may be optional and may be based on datatype GDT:AddressUsageCode. ValidityPeriod may be optional and may be based on datatype GDT:CLOSED_DatePeriod with a qualifier of Validity. DefaultIndicator may be based on datatype CDT:Indicator.

AddressInformation is an address of an employee. AddressInformation includes the following attributes: ActionCode and AddressUsageListCompleteTransmissionIndicator. ActionCode is a coded representation of an instruction to a recipient of a message describing how to process a transmitted element, and may be based on datatype GDT:ActionCode. AddressUsageListCompleteTransmissionIndicator specifies whether addressUsageList data in a message is transmitted in its entirety, and may be based on datatype CDT:Indicator with a qualifier of CompleteTransmission. AddressInformation includes the following non-node elements: ObjectNodeReference, ValidityPeriod, AddressUsage, and PersonalAddress. ObjectNodeReference is a unique reference to an AddressInformation node and may be based on datatype GDT:ObjectNodeReference. ValidityPeriod may be optional and may be based on datatype GDT:CLOSED_DatePeriod with a qualifier of Validity. AddressUsage may be based on datatype MIDT:IN_EmployeePayrollInputReplicationRequestEmployeeAddressInformationAdressUsage. PersonalAddress may be optional and may be based on datatype GDT:PersonalAddress.

AddressUsage may include the following elements: ActionCode, ObjectNodeReference, AddressUsageCode, ValidityPeriod, and DefaultIndicator. ActionCode may be optional, is a coded representation of an instruction to a recipient of a message describing how to process a transmitted element, and may be based on datatype GDT:ActionCode. ObjectNodeReference is a unique reference to an AddressInformation node and may be based on datatype GDT:ObjectNodeReference. AddressUsageCode may be optional and may be based on datatype GDT:AddressUsageCode. ValidityPeriod may be optional and may be based on datatype GDT:CLOSED_DatePeriod with a qualifier of Validity. DefaultIndicator may be based on datatype CDT:Indicator. In some implementations, in the element AddressUsageCode, a code for a private address of an employee may only be maintained in the business object Employee. In some implementations, if the value of the attribute ActionCode is “Save” or “Create and No Action”, then AddressUsageCode, ValidityPeriod, and PersonalAddress are filled. In some implementations, if the value of the attribute ActionCode is “Delete” all other fields are not required to be filled.

EmployeeTaxArrangementPeriodTerms includes the ActionCode attribute. ActionCode is a coded representation of an instruction to a recipient of a message describing how to process a transmitted element, and may be based on datatype GDT:ActionCode. EmployeeTaxArrangementPeriodTerms includes the following non-node elements: ObjectNodeReference, ValidityPeriod, and EmployeeTaxID. ObjectNodeReference is a unique reference to a PeriodTermsVersion node and may be based on datatype GDT:ObjectNodeReference. ValidityPeriod may be based on datatype GDT:CLOSED_DatePeriod. EmployeeTaxID may be based on datatype GDT:PartyTaxID. In some implementations, if the value of the attribute ActionCode is “Save” or “Create and No Action”, then ValidityPeriod and EmployeeTaxID are filled. In some implementations, if the value of the attribute ActionCode is “Delete”, all other fields are not required to be filled.

The IN_EmployeePayrollInputReplicationRequestEmployeeEmploymentItem package includes the EmploymentItem entity. EmploymentItem includes the following attributes: ActionCode, DisabilityListCompleteTransmissionIndicator, EmployeeTaxArrangementPreviousEmploymentListCompleteTransmissionIndicator, and WorkAgreementItemListCompleteTransmissionIndicator. ActionCode is a coded representation of an instruction to a recipient of a message describing how to process a transmitted element, and may be based on datatype GDT:ActionCode. DisabilityListCompleteTransmissionIndicator may be based on datatype CDT:Indicator with a qualifier of CompleteTransmission. EmployeeTaxArrangementPreviousEmploymentListCompleteTransmissionIndicator specifies whether employeeTaxArrangementPreviousEmploymentList data in a message is transmitted in its entirety, and may be based on datatype CDT:Indicator with a qualifier of CompleteTransmission. WorkAgreementItemListCompleteTransmissionIndicator specifies whether workAgreementItemList data in a message is transmitted in its entirety, and may be based on datatype CDT:Indicator with a qualifier of CompleteTransmission. EmploymentItem includes the following non-node elements: ObjectNodeReference and CountryCode. ObjectNodeReference is a unique reference to an EmploymentItemVersion node and may be based on datatype GDT:ObjectNodeReference. CountryCode may be optional and may be based on datatype GDT:CountryCode.

EmploymentItem includes the node element Disability in a 1:CN cardinality relationship, the node element EmployeeTaxArrangementPreviousEmployment in a 1:CN cardinality relationship, and the node element WorkAgreementItem in a 1:CN cardinality relationship. An EmploymentItemDisability is a description of an employee's physical or mental disability in a Disability node for a validity period. Disability includes the ActionCode attribute, which may be based on datatype GDT:ActionCode. Disablility includes the following non-node elements: ObjectNodeReference, ValidityPeriod, DisabledPersonGroupCode, and PersonDisabilityPercent. ObjectNodeReference may be based on datatype GDT:ObjectNodeReference. ValidityPeriod may be optional and may be based on datatype GDT:CLOSED_DatePeriod with a qualifier of Validity. An associated Duration may or may not be used. DisabledPersonGroupCode may be optional and may be based on datatype GDT:DisabledPersonGroupCode. PersonDisabilityPercent may be optional and may be based on datatype CDT:Percent with a qualifier of PersonDisability.

EmployeeTaxArrangementPreviousEmployment includes the following attributes: ActionCode and EmploymentItemPreviousEmploymentCompensationComponentListCompleteTransmissionIndicator. EmploymentItemPreviousEmploymentCompensationComponentListCompleteTransmissionIndicator specifies whether employmentItemPreviousEmploymentCompensationComponent data in a message is transmitted in its entirety, and may be based on datatype CDT:Indicator with a qualifier of CompleteTransmission. ActionCode is a coded representation of an instruction to a recipient of a message describing how to process a transmitted element, and may be based on datatype GDT:ActionCode. EmployeeTaxArrangementPreviousEmployment includes the following non-node elements: ObjectNodeReference, LeaveTravelAllowanceNumberValue, LeaveTravelAllowanceRelevanceIndicator, ValidityPeriod, and EmploymentItemEmployeeTaxArrangementEmploymentItemPreviousEmploymentVersion. ObjectNodeReference is a unique reference to an EmploymentItemEmployeeTaxArrangementEmploymentItemPreviousEmploymentVersion node and may be based on datatype GDT:ObjectNodeReference. ValidityPeriod may be based on datatype GDT:CLOSED_DatePeriod. LeaveTravelAllowanceNumberValue may be optional and may be based on datatype GDT:SMALL_NumberValue. LeaveTravelAllowanceRelevanceIndicator may be based on datatype CDT:Indicator with a qualifier of Relevance. EmploymentItemPreviousEmploymentCompensationComponent may be on datatype MIDT:IN_EmplPyrlInptRplctnReqEmplEmplymtItmEmplTxArrgmtPrevEmplymtCompnComponent. EmploymentItemPreviousEmploymentCompensationComponent may include the following elements: ActionCode, UUID, ObjectNodeReference, TaxationCategoryCode, and TaxationCategoryAmount. ActionCode may be optional, is a coded representation of an instruction to a recipient of a message describing how to process a transmitted element, and may be based on datatype GDT:ActionCode. UUID may be based on datatype GDT:UUID. ObjectNodeReference may be based on datatype GDT:ObjectNodeReference. TaxationCategoryCode may be based on datatype GDT:CompensationComponentTaxationCategoryCode. TaxationCategoryAmount may be based on datatype CDT:CURRENCYINR_MEDIUM_Amount. In some implementations, if the value of the attribute ActionCode is “Delete”, only an ObjectNodeReference is filled. In some implementations, if the value of the attribute ActionCode is other than “Delete”, then ValidityPeriod is also be filled.

The IN_EmployeePayrollInputReplicationRequestEmployeeEmploymentItemWorkAgreementItem package includes the WorkAgreementItem entity. WorkAgreementItem is information relevant for payroll processing for an employee who applies for a specific WorkAgreement. WorkAgreementItem includes the following attributes: ActionCode, EmployeePayrollAgreementItemListCompleteTransmissionIndicator, PermanentEstablishmentListCompleteTransmissionIndicator, WageSeperationListCompleteTransmissionIndicator, EmployeeTimeCalendarValuatedTimeListCompleteTransmissionIndicator, EmployeeTimeCalendarPlannedWorkingTimeListCompleteTransmissionIndicator, EmployeeTimeCalendarAggregatedPlannedWorkingTimePerPayrollPeriodListCompleteTransmissionIndicator, ValuatedAverageWorkingTimetListCompleteTransmissionIndicator, EmployeeTimeCalendarTimeAccountPayoutListCompleteTransmissionIndicator, EmployeeTimeAccountBalanceListCompleteTransmissionIndicator, EmplCompnAgrmtItemCompensationComponentDetailListCompleteTransmissionIndicator, EmployeeTaxArrangementPeriodTermsListCompleteTransmissionIndicator, EmployeeTaxArrangementExemptionListCompleteTransmissionIndicator, EmployeeTaxArrangementInvestmentListCompleteTransmissionIndicator, EmployeeSocialInsuranceArrangementPeriodTermsListCompleteTransmissionIndicator, EmployeeSocialInsuranceArrangementPensionInsuranceListCompleteTransmissionIndicator, and ExpenseReportSettlementResultDetailListCompleteTransmissionIndicator. ActionCode may be optional, is a coded representation of an instruction to a recipient of a message describing how to process a transmitted element and may be based on datatype GDT:ActionCode. EmployeePayrollAgreementItemListCompleteTransmissionIndicator specifies whether employeePayrollAgreementItemList data in a message is transmitted in its entirety and may be based on datatype CDT:Indicator with a qualifier of CompleteTransmission. PermanentEstablishmentListCompleteTransmissionIndicator specifies whether permanentEstablishmentList data in a message is transmitted in its entirety and may be based on datatype CDT:Indicator with a qualifier of CompleteTransmission. WageSeperationListCompleteTransmissionIndicator specifies whether wageSeperationListdata in a message is transmitted in its entirety and may be based on datatype CDT:Indicator with a qualifier of CompleteTransmission. EmployeeTimeCalendarValuatedTimeListCompleteTransmissionIndicator specifies whether employeeTimeCalendarValuatedTimeList data in a message is transmitted in its entirety and may be based on datatype CDT:Indicator with a qualifier of CompleteTransmission. EmployeeTimeCalendarPlannedWorkingTimeListCompleteTransmissionIndicator specifies whether employeeTimeCalendarPlannedWorkingTimeList data in a message is transmitted in its entirety and may be based on datatype CDT:Indicator with a qualifier of CompleteTransmission. EmployeeTimeCalendarAggregatedPlannedWorkingTimePerPayrollPeriodListCompleteTransmissionIndicator may be based on datatype CDT:Indicator. ValuatedAverageWorkingTimetListCompleteTransmissionIndicator specifies whether valuatedAverageWorkingTimetList data in a message is transmitted in its entirety and may be based on datatype CDT:Indicator with a qualifier of CompleteTransmission. EmployeeTimeCalendarTimeAccountPayoutListCompleteTransmissionIndicator specifies whether employeeSocialInsuranceArrangementPeriodTermsList data in a message is transmitted in its entirety and may be based on datatype CDT:Indicator with a qualifier of CompleteTransmission. EmployeeTimeAccountBalanceListCompleteTransmissionIndicator specifies whether employeeSocialInsuranceArrangementPeriodTermsList data in a message is transmitted in its entirety and may be based on datatype CDT:Indicator with a qualifier of CompleteTransmission. EmplCompnAgrmtItemCompensationComponentDetailListCompleteTransmissionIndicator specifies whether employeeSocialInsuranceArrangementPeriodTermsList data in a message is transmitted in its entirety and may be based on datatype CDT:Indicator with a qualifier of CompleteTransmission. EmployeeTaxArrangementPeriodTermsListCompleteTransmissionIndicator specifies whether employeeSocialInsuranceArrangementPeriodTermsList data in a message is transmitted in its entirety and may be based on datatype CDT:Indicator with a qualifier of CompleteTransmission. EmployeeTaxArrangementExemptionListCompleteTransmissionIndicator specifies whether employeeSocialInsuranceArrangementPeriodTermsList data in a message is transmitted in its entirety and may be based on datatype CDT:Indicator with a qualifier of CompleteTransmission. EmployeeTaxArrangementInvestmentListCompleteTransmissionIndicator specifies whether employeeSocialInsuranceArrangementPeriodTermsList data in a message is transmitted in its entirety and may be based on datatype CDT:Indicator with a qualifier of CompleteTransmission. EmployeeSocialInsuranceArrangementPeriodTermsListCompleteTransmissionIndicator specifies whether employeeSocialInsuranceArrangementPeriodTermsList data in a message is transmitted in its entirety and may be based on datatype CDT:Indicator with a qualifier of CompleteTransmission. EmployeeSocialInsuranceArrangementPensionInsuranceListCompleteTransmissionIndicator specifies whether employeeSocialInsuranceArrangementPensionInsuranceList data in a message is transmitted in its entirety and may be based on datatype CDT:Indicator with a qualifier of CompleteTransmission. ExpenseReportSettlementResultDetailListCompleteTransmissionIndicator may be based on datatype CDT:Indicator with a qualifier of Complete Transmission.

WorkAgreementItem includes the following non-node elements: ObjectNodeReference, ValidityPeriod, PayrollProviderWorkAgreementID, WorkAgreementTypeCode, and AdministrativeCategoryCode. ObjectNodeReference is a unique reference to a WorkAgreementItem node and may be based on datatype GDT:ObjectNodeReference. ValidityPeriod may be optional and may be based on datatype GDT:CLOSED_DatePeriod with a qualifier of Validity. An associated Duration might not be used. PayrollProviderWorkAgreementID may be optional, is a unique identifier for an employee or work agreement at a payroll provider. A work agreement may be originally stored in a ByDesign element at the EmployeePayrollAgreementItem. PayrollProviderWorkAgreementID may be based on datatype GDT:WorkAgreementID with a qualifier of PayrollProvider. WorkAgreementTypeCode may be optional and may be based on datatype GDT:WorkAgreementTypeCode. AdministrativeCategoryCode may be optional and may be based on datatype GDT:WorkAgreementAdministrativeCategoryCode. In some implementations, if the value of the attribute ActionCode is “Delete”, only the ObjectNodeReference is filled. In some implementations, if the value of the attribute @ActionCode is “Save” or “Create and No Action”, then ValidityPeriod, WorkAgreementTypeCode and AdministrativeCategoryCode may be filled.

WorkAgreementItem includes the node element EmployeePayrollAgreementItem in a 1:CN cardinality relationship, the node element PermanentEstablishment in a 1:CN cardinality relationship, the node element CostCentre in a 1:CN cardinality relationship, the node element WageSeparation in a 1:CN cardinality relationship, the node element EmployeeTimeCalendarValuatedTime in a 1:CN cardinality relationship, the node element EmployeeTimeCalendarPlannedWorkingTime in a 1:CN cardinality relationship, the node element EmployeeTimeCalendarAggregatedPlannedWorkingTimePerPayrollPeriod in a 1:CN cardinality relationship, the node element ValuatedAverageWorkingTime in a 1:CN cardinality relationship, the node element EmployeeTimeCalendarTimeAccountPayout in a 1:CN cardinality relationship, the node element EmployeeTimeAccountBalance in a 1:CN cardinality relationship, the node element EmployeeCompensationAgreementItemCompensationComponentDetail in a 1:CN cardinality relationship, the node element EmployeeTaxArrangementPeriodTerms in a 1:CN cardinality relationship, the node element EmployeeTaxArrangementExemption in a 1:CN cardinality relationship, the node element EmployeeTaxArrangementInvestment in a 1:CN cardinality relationship, the node element EmployeeSocialInsuranceArrangementPeriodTerms in a 1:CN cardinality relationship, the node element EmployeeSocialInsuranceArrangementPensionInsurance in a 1:CN cardinality relationship, and the node element ExpenseReportSettlementResult in a 1:CN cardinality relationship.

EmployeePayrollAgreementItem includes the following attributes: ActionCode, PayrollProcessingConditionsListCompleteTransmissionIndicator, MainPaymentListCompleteTransmissionIndicator, and FurtherPaymentsPlanListCompleteTransmissionIndicator. ActionCode is a coded representation of an instruction to a recipient of a message describing how to process a transmitted element and may be based on datatype GDT:ActionCode. PayrollProcessingConditionsListCompleteTransmissionIndicator specifies whether payrollProcessingConditionsList data in a message is transmitted in its entirety and may be based on datatype CDT:Indicator with a qualifier of CompleteTransmission. MainPaymentListCompleteTransmissionIndicator specifies whether mainPaymentList data in a message is transmitted in its entirety and may be based on datatype CDT:Indicator with a qualifier of CompleteTransmission. FurtherPaymentsPlanListCompleteTransmissionIndicator specifies whether furtherPaymentsPlanList data in a message is transmitted in its entirety and may be based on datatype CDT:Indicator with a qualifier of CompleteTransmission.

EmployeePayrollAgreementItem includes the following non-node elements: ObjectNodeReference and PayrollProviderWorkAgreementID. ObjectNodeReference is a unique reference to an EmployeePayrollAgreementItemVersion node and may be based on datatype GDT:ObjectNodeReference. PayrollProviderWorkAgreementID may be optional and may be based on datatype GDT:WorkAgreementID with a qualifier of PayrollProvider. EmployeePayrollAgreementItem includes the node element PayrollProcessingConditions in a 1:CN cardinality relationship, the node element MainPayment in a 1:CN cardinality relationship, and the node element FurtherPaymentsPlan in a 1:CN cardinality relationship.

PayrollProcessingConditions is a set of conditions which apply for processing an Employee through payroll. PayrollProcessingConditions includes the ActionCode attribute. ActionCode is a coded representation of an instruction to a recipient of a message describing how to process a transmitted element and may be based on datatype GDT:ActionCode. PayrollProcessingConditions includes the following non-node elements: ObjectNodeReference, ValidityPeriod, PayrollGroupCode, and PayrollInactiveIndicator. ObjectNodeReference is a unique reference to a PayrollProcessingConditionsVersion node and may be based on datatype GDT:ObjectNodeReference. ValidityPeriod may be optional and may be based on datatype GDT:CLOSED_DatePeriod with a qualifier of Validity. PayrollGroupCode may be optional and may be based on datatype GDT:PayrollGroupCode. PayrollInactiveIndicator may be based on datatype CDT:Indicator with a qualifier of Inactive. In some implementations, a default is that an employee is active for payroll.

MainPayment is a main payment of a net amount calculated in payroll processing for a validity period. MainPayment includes the ActionCode attribute. ActionCode is a coded representation of an instruction to a recipient of a message describing how to process a transmitted element and may be based on datatype GDT:ActionCode. MainPayment includes the following non-node elements: ObjectNodeReference, ValidityPeriod, PaymentFormCode, and PaymentComponentBusinessTransactionDocumentBankAccount. ObjectNodeReference is a unique reference to a MainPaymentVersion node and may be based on datatype GDT:ObjectNodeReference. ValidityPeriod may be optional and may be based on datatype GDT:CLOSED_DatePeriod with a qualifier of Validity. PaymentFormCode may be optional and may be based on datatype GDT:PaymentFormCode. PaymentComponentBusinessTransactionDocumentBankAccount may be optional and may be based on datatype GDT:ADDRESSINDEPENDENT_BusinessTransactionDocumentBankAccount_V1.

FurtherPaymentsPlan is a plan for payment of a portion of a net amount calculated in payroll processing to one or more further bank accounts or recipients other than that recorded in a MainPayment for a validity period. FurtherPaymentsPlan includes the following attributes: ActionCode and ComponentListCompleteTransmissionIndicator. ActionCode is a coded representation of an instruction to a recipient of a message describing how to process a transmitted element and may be based on datatype GDT:ActionCode. ComponentListCompleteTransmissionIndicator specifies whether componentList data in a message is transmitted in its entirety and may be based on datatype CDT:Indicator with a qualifier of CompleteTransmission. FurtherPaymentsPlan includes the following non-node elements: ObjectNodeReference, ValidityPeriod, and Component. ObjectNodeReference is a unique reference to a FurtherPaymentsPlan node and may be based on datatype GDT:ObjectNodeReference. ValidityPeriod may be optional and may be based on datatype GDT:CLOSED_DatePeriod with a qualifier of Validity. Component may be based on datatype MIDT:IN_EmplPyrlInptRplctnReqEmplEmplymtlimWrkAgrmtItemFurtherPaymentPlanComponent. Component may include the following elements: ActionCode, Description, Amount, Percent, PaymentFormCode, and PaymentComponentBusinessTransactionDocumentBankAccount. ActionCode is a coded representation of an instruction to a recipient of a message describing how to process a transmitted element and may be based on datatype GDT:ActionCode. Description may be optional and may be based on datatype GDT:MEDIUM_Description. Percent may be optional and may be based on datatype CDT:SMALLNONNEGATIVE_Percent. Amount may be optional and may be based on datatype CDT:Amount. PaymentFormCode may be optional and may be based on datatype GDT:PaymentFormCode. PaymentComponentBusinessTransactionDocumentBankAccount may be optional and may be based on datatype GDT:ADDRESSINDEPENDENT_BusinessTransactionDocumentBankAccount_V1.

PermanentEstablishment is an organizational center that represents a geographically bound area of a company whose business activity is subject to uniform tax processing. PermanentEstablishment includes the ActionCode attribute. ActionCode is a coded representation of an instruction to a recipient of a message describing how to process a transmitted element and may be based on datatype GDT:ActionCode. PermanentEstablishment includes the following non-node elements: ObjectNodeReference, ValidityPeriod, and PermanentEstablishmentID. ObjectNodeReference is a unique reference to a PermanentEstablishment node and may be based on datatype GDT:ObjectNodeReference. ValidityPeriod may be based on datatype GDT:CLOSED_DatePeriod with a qualifier of Validity. An associated Duration might not be used. PermanentEstablishmentID may be based on datatype GDT:OrganisationalCentreID. In some implementations, if the value of the attribute ActionCode is “Delete”, only an ObjectNodeReference is filled.

CostCentre is an organizational center that represents a geographically bound area of a company whose business activity is subject to uniform tax processing. CostCentre includes the ActionCode attribute. ActionCode is a coded representation of an instruction to a recipient of a message describing how to process a transmitted element and may be based on datatype GDT:ActionCode. CostCentre includes the following non-node elements: ObjectNodeReference, ValidityPeriod, and CostCentreID. ObjectNodeReference is a unique reference to a CostCentre node and may be based on datatype GDT:ObjectNodeReference. ValidityPeriod may be optional and may be based on datatype GDT:CLOSED_DatePeriod. CostCentreID may be based on datatype GDT:OrganisationalCentreID. In some implementations, if the value of the attribute ActionCode is “Delete”, only an ObjectNodeReference is filled.

WageSeparation is a separation of wages. WageSeparation includes the ActionCode attribute. ActionCode is a coded representation of an instruction to a recipient of a message describing how to process a transmitted element and may be based on datatype GDT:ActionCode. WageSeparation includes the following non-node elements: ObjectNodeReference and Date. ObjectNodeReference is a unique reference to a WageSeparation node and may be based on datatype GDT:ObjectNodeReference. Date may be optional and may be based on datatype CDT:Date. In some implementations, if the value of the attribute ActionCode is “Delete” only an ObjectNodeReference is filled.

EmployeeTimeCalendarValuatedTime is an employee time which is enriched by information defining its monetary value in terms of payroll. EmployeeTimeCalendarValuatedTime includes the following attributes: ActionCode and PaymentListCompleteTransmissionIndicator. ActionCode is a coded representation of an instruction to a recipient of a message describing how to process a transmitted element and may be based on datatype GDT:ActionCode. PaymentListCompleteTransmissionIndicator specifies whether paymentList data in a message is transmitted in its entirety and may be based on datatype CDT:Indicator with a qualifier of CompleteTransmission. EmployeeTimeCalendarValuatedTime includes the following non-node elements: ObjectNodeReference, EmployeeTimeItemPayrollCategoryCode, EmployeeTimeItemPayrollTypeCode, Date, HourQuantity, HourQuantityTypeCode, DayQuantity, DayQuantityTypeCode, OriginalEmployeeTimeItemUUID, and OriginaIDatePeriod. ObjectNodeReference is a unique reference to an EmployeeTimeCalendarValuatedTime node and may be based on datatype GDT:ObjectNodeReference. EmployeeTimeItemPayrollCategoryCode may be optional and may be based on datatype GDT:EmployeeTimeItemPayrollCategoryCode. EmployeeTimeItemPayrollTypeCode may be optional and may be based on datatype GDT:EmployeeTimeItemPayrollTypeCode. Date may be optional and may be based on datatype CDT:Date. HourQuantity may be optional and may be based on datatype CDT:UNITHOUR_SMALL_Quantity. HourQuantityTypeCode may be optional and may be based on datatype GDT:QuantityTypeCode. DayQuantity may be optional and may be based on datatype CDT:Quantity. DayQuantityTypeCode may be optional and may be based on datatype GDT:QuantityTypeCode. OriginalEmployeeTimeItemUUID may be optional and may be based on datatype GDT:UUID. OriginaIDatePeriod may be optional and may be based on datatype GDT:CLOSED_DatePeriod. In some implementations, if the value of the attribute ActionCode is “Delete”, only an ObjectNodeReference is filled. In some implementations, if the value of the attribute ActionCode is “Save” or “Create and No Action”, then EmployeeTimeItemPayrollCategoryCode, Date, HourQuantity, HourQuantityTypeCode may be filled.

EmployeeTimeCalendarValuatedTime includes the node element Payment in a 1:CN cardinality relationship. Payment is a payment for a EmployeeTimeCalendarValuatedTime. Payment includes the ActionCode attribute. ActionCode is a coded representation of an instruction to a recipient of a message describing how to process a transmitted element and may be based on datatype GDT:ActionCode. Payment includes the following non-node elements: EmployeeTimePayment and CompensationComponentPayrollCategoryCode. EmployeeTimePayment may be optional and may be based on datatype GDT:EmployeeTimePayment. CompensationComponentPayrollCategoryCode may be optional, is a coded representation of a Payroll Category, and may be based on datatype GDT:CompensationComponentPayrollCategoryCode.

EmployeeTimeCalendarPlannedWorkingTime is a time at which an employee is supposed to work according to his working time schedule. EmployeeTimeCalendarPlannedWorkingTime includes the ActionCode attribute. ActionCode is a coded representation of an instruction to a recipient of a message describing how to process a transmitted element and may be based on datatype GDT:ActionCode. EmployeeTimeCalendarPlannedWorkingTime includes the following non-node elements: ObjectNodeReference, EmployeeTimePlanningCategoryCode, Date, HourQuantity, HourQuantityTypeCode, PublicHolidayIndicator, and EmployeeTimePlanningCategoryCode. ObjectNodeReference is a unique reference to an EmployeeTimeCalendarPlannedWorkingTime node and may be based on datatype GDT:ObjectNodeReference. EmployeeTimePlanningCategoryCode may be optional and may be based on datatype GDT:EmployeeTimePlanningCategoryCode. Date may be optional and may be based on datatype CDT:Date. HourQuantity may be optional and may be based on datatype CDT:UNITHOUR_SMALL_Quantity. HourQuantityTypeCode may be optional and may be based on datatype GDT:QuantityTypeCode. PublicHolidayIndicator may be optional and may be based on datatype CDT:Indicator. EmployeePlannedWorkingTimeDayTypeCode may be optional and may be based on datatype GDT:EmployeePlannedWorkingTimeDayTypeCode. In some implementations, if the value of the attribute ActionCode is “Delete”, only the ObjectNodeReference is filled. In some implementations, if the value of the attribute ActionCode is “Save” or “Create and No Action”, then Date, HourQuantity, and HourQuantityTypeCode are filled.

EmployeeTimeCalendarAggregatedPlannedWorkingTimePerPayrollPeriod represents an aggregated time per payroll period which an employee is supposed to work according to a working time schedule. EmployeeTimeCalendarAggregatedPlannedWorkingTimePerPayrollPeriod includes the ActionCode attribute, which may be based on datatype GDT:ActionCode. EmployeeTimeCalendarAggregatedPlannedWorkingTimePerPayrollPeriod includes the following non-node elements: ObjectNodeReference, DatePeriod, HourQuantity, HourQuantityTypeCode, DayQuantity, DayQuantityTypeCode, and PayrolIDatePeriod. ObjectNodeReference may be based on datatype GDT: ObjectNodeReference. DatePeriod may be optional and may be based on datatype GDT:CLOSED_DatePeriod. HourQuantity may be optional and may be based on datatype CDT:UNITHOUR_SMALL_Quantity. HourQuantityTypeCode may be optional and may be based on datatype GDT:QuantityTypeCode. DayQuantity may be optional and may be based on datatype CDT:Quantity with a qualifier of Day. DayQuantityTypeCode may be optional and may be based on datatype GDT:QuantityTypeCode. PayrolIDatePeriod may be optional and may be based on datatype GDT:CLOSED_DatePeriod.

ValuatedAverageWorkingTime represents periods with appropriate rates, which cover information about a valuated working time of a work agreement. ValuatedAverageWorkingTime includes the following attributes: ActionCode and PeriodListCompleteTransmissionIndicator. ActionCode is a coded representation of an instruction to a recipient of a message describing how to process a transmitted element and may be based on datatype GDT:ActionCode. PeriodListCompleteTransmissionIndicator specifies whether PeriodList data in a message is transmitted in its entirety and may be based on datatype CDT:Indicator with a qualifier of CompleteTransmission. ValuatedAverageWorkingTime includes ObjectNodeReference, which is a unique reference to an EmployeeTimeAgreementAverageWorkingTime node and which may be based on datatype GDT:ObjectNodeReference. In some implementations, if the value of the attribute ActionCode is “Delete”, only the Object is filled.

ValuatedAverageWorkingTime includes the node element Period in a 1:C cardinality relationship. Period includes special information for payroll accounting and a validity period regarding a subordinate node. Period includes the following attributes: ActionCode and RateListCompleteTransmissionIndicator. ActionCode is a coded representation of an instruction to a recipient of a message describing how to process a transmitted element and may be based on datatype GDT:ActionCode. RateListCompleteTransmissionIndicator specifies whether rateList data in a message is transmitted in its entirety and may be based on datatype CDT:Indicator with a qualifier of CompleteTransmission. ValuatedAverageWorkingTime includes the following non-node elements: ValidityPeriod and PayPeriodWorkingTimeRate. ValidityPeriod may be optional and may be based on datatype GDT:CLOSED_DatePeriod with a qualifier of Validity. PayPeriodWorkingTimeRate may be optional and may be based on datatype GDT:Rate. ValuatedAverageWorkingTime includes the node element Rate in a 1:C cardinality relationship.

The IN_EmployeePayrollInputReplicationRequestEmployeeEmploymentItemWorkAgreementItemWorkingAgreementItem package includes the Rate entity. Rate includes information about an average working time. Rate includes the ActionCode attribute. ActionCode is a coded representation of an instruction to a recipient of a message describing how to process a transmitted element and may be based on datatype GDT:ActionCode. Rate includes the non-node elements: Rate and PayPeriodWorkingTimeRate. Rate may be optional and may be based on datatype GDT:Rate. PayPeriodWorkingTimeRate may be optional and may be based on datatype GDT:WorkingTimeRate.

EmployeeTimeCalendarTimeAccountPayout is a document on a payout of a monetary amount due to available time account balance of an Employee Time Account. EmployeeTimeCalendarTimeAccountPayout includes the following attributes: ActionCode and PaymentListCompleteTransmissionIndicator. ActionCode is a coded representation of an instruction to a recipient of a message describing how to process a transmitted element and may be based on datatype GDT:ActionCode. PaymentListCompleteTransmissionIndicator specifies whether paymentList data in a message is transmitted in its entirety and may be based on datatype CDT:Indicator. EmployeeTimeCalendarTimeAccountPayout includes the following non-node elements: ObjectNodeReference, Date, Quantity, and QuantityTypeCode. ObjectNodeReference is a unique reference to an EmployeeTimeAgreementAverageWorkingTime node and may be based on datatype GDT:ObjectNodeReference. Date may be optional and may be based on datatype CDT:Date. Quantity may be optional and may be based on datatype CDT:Quantity. QuantityTypeCode may be optional and may be based on datatype GDT:QuantityTypeCode. In some implementations, if the value of the attribute ActionCode is “Delete”, only an ObjectNodeReference is filled. In some implementations, if the value of the attribute ActionCode is “Save” or “Create and No Action”, then Date, Quantity, and QuantityTypeCode are filled.

EmployeeTimeCalendarTimeAccountPayout includes the node element Payment in a 1:C cardinality relationship. Payment documents amounts being paid out. Payment includes the ActionCode attribute. ActionCode is a coded representation of an instruction to a recipient of a message describing how to process a transmitted element and may be based on datatype GDT:ActionCode. Payment includes the following non-node elements: EmployeeTimePayment and CompensationComponentPayrollCategoryCode. EmployeeTimePayment may be optional and may be based on datatype GDT:EmployeeTimePayment. CompensationComponentPayrollCategoryCode may be optional, is a coded representation of a Payroll Category, and may be based on datatype GDT:Comp ensationComponentPayrollCategoryCode.

EmployeeTimeAccountBalance documents balances of an Employee Time Account. EmployeeTimeAccountBalance includes the ActionCode attribute. ActionCode is a coded representation of an instruction to a recipient of a message describing how to process a transmitted element and may be based on datatype GDT:ActionCode. EmployeeTimeAccountBalance includes the following non-node elements: ObjectNodeReference, TypeCode, Date, EmployeeTimeAccountPayrollTypeCode, IdentifyingPeriod, Quantity, and QuantityTypeCode. ObjectNodeReference is a unique reference to an EmployeeTimeAccountBalance node and may be based on datatype GDT:ObjectNodeReference. TypeCode may be optional and may be based on datatype GDT:EmployeeTimeAccountBalanceTypeCode. Date may be optional and may be based on datatype CDT:Date. EmployeeTimeAccountPayrollTypeCode may be optional and may be based on datatype GDT:EmployeeTimeAccountPayrollTypeCode. IdentifyingPeriod may be optional and may be based on datatype GDT:CLOSED_DatePeriod. Quantity may be optional and may be based on datatype CDT:Quantity. QuantityTypeCode may be optional and may be based on datatype GDT:QuantityTypeCode. In some implementations, if the value of the attribute ActionCode is “Delete”, only an ObjectNodeReference is filled. In some implementations, if the value of the attribute ActionCode is “Save” or “Create and No Action”, then Type, Quantity, and QuantityTypeCode are filled.

EmployeeCompensationAgreementItemCompensationComponentDetail is a time-dependent detail pertaining to a compensation component. EmployeeCompensationAgreementItemCompensationComponentDetail includes the ActionCode attribute. ActionCode is a coded representation of an instruction to a recipient of a message describing how to process a transmitted element and may be based on datatype GDT:ActionCode. EmployeeCompensationAgreementItemCompensationComponentDetail includes the following non-node elements: ObjectNodeReference, ValidityPeriod, CompensationComponentTypeUUID, CompensationComponentRecurrenceFrequencyCode, CompensationComponentPercent, CompensationComponentBusinessTransactionDocumentBankAccount, NoteToPayeeNote, EmployeeTimePaymentResultCompensationComponentTypePayrollCategoryCode, EmployeeTimePaymentResultCompensationComponentTypePayrollCategoryCode, CompensationComponentQuantity, and CompensationComponentQuantityTypeCode. ObjectNodeReference is a unique reference to an EmployeeCompensationAgreementItemCompensationComponentDetail node and may be based on datatype GDT:ObjectNodeReference. ValidityPeriod may be optional and may be based on datatype GDT:CLOSED_DatePeriod. CompensationComponentTypeID may be optional and may be based on datatype GDT:CompensationComponentTypeID. CompensationComponentTypeUUID may be optional and may be based on datatype GDT:UUID. CompensationComponentAmount may be optional and may be based on datatype CDT:Amount with a qualifier of CompensationComponent. CompensationComponentRecurrenceFrequencyCode may be optional and may be based on datatype GDT:COMPENSATIONCOMPONENT_RecurrenceFrequencyCode. CompensationComponentPercent may be optional and may be based on datatype CDT:Percent. CompensationComponentBusinessTransactionDocumentBankAccount may be optional and may be based on datatype GDT:ADDRESSINDEPENDENT_BusinessTransactionDocumentBankAccount_V1. NoteToPayeeNote may be optional and may be based on datatype GDT:MEDIUM_Note. In some implementations, for providers that can't handle the full functionality of CalendarDayRecurrence, only fields Value, RecurrenceFrequencyCode and FreqencyValue are filled. In some implementations, for providers that can't handle recurring payments, a CalendarDayRecurrence might not be filled. EmployeeTimePaymentResultCompensationComponentTypePayrollCategoryCode may be optional, is a coded representation of a Payroll Category and may be based on datatype GDT:CompensationComponentPayrollCategoryCode. CompensationComponentQuantity may be optional and may be based on datatype CDT:Quantity. CompensationComponentQuantityTypeCode may be optional and may be based on datatype GDT:QuantityTypeCode. In some implementations, if the value of the attribute ActionCode is “Delete”, only an ObjectNodeReference is filled. EmployeeCompensationAgreementItemCompensationComponentDetail includes the node elementCompensationComponentCalendarDayRecurrence in a 1:C cardinality relationship. CompensationComponentCalendarDayRecurrence may be typed by CalendarDayRecurrence.

EmployeeTaxArrangementPeriodTerms includes the ActionCode attribute. ActionCode is a coded representation of an instruction to a recipient of a message describing how to process a transmitted element and may be based on datatype GDT:ActionCode. EmployeeTaxArrangementPeriodTerms includes the following non-node elements: ObjectNodeReference, UUID, ValidityPeriod, CityTaxationCategoryCode, ExemptedIndicator, and ProfessionalTaxRelevanceIndicator. ObjectNodeReference is a unique reference to an EmploymentItemWorkAgreementItemEmployeeTaxArrangementWorkAgreementItemPeriodTermsVersion node and may be based on datatype GDT:ObjectNodeReference. UUID may be based on datatype GDT:UUID. ValidityPeriod may be based on datatype GDT:CLOSED_DatePeriod. CityTaxationCategoryCode may be optional and may be based on datatype GDT:CityTaxationCategoryCode. HouseRentAmount may be based on datatype CDT:CURRENCYINR_MEDIUM_Amount with a qualifier of Rent. ExemptedIndicator may be based on datatype CDT:Indicator with a qualifier of Exempted. ProfessionalTaxRelevanceIndicator may be based on datatype CDT:Indicator with a qualifier of Relevance. In some implementations, if the value of the attribute ActionCode is “Delete”, only an ObjectNodeReference is filled. In some implementations, if the value of the attribute ActionCode is other than “Delete”, then ValidityPeriod, MonthlyAdjustmentIndicator, SpecialTaxExemptionIndicator and MunicipalityTaxRelevantIndicator are filled.

EmployeeTaxArrangementExemption includes the following attributes: ActionCode and WorkAgreementItemExemptionFamilyMemberListCompleteTransmissionIndicator. WorkAgreementItemExemptionFamilyMemberListCompleteTransmissionIndicator specifies whether workAgreementItemExemptionFamilyMember data in a message is transmitted in its entirety and may be based on datatype CDT:Indicator. ActionCode is a coded representation of an instruction to a recipient of a message describing how to process a transmitted element and may be based on datatype GDT:ActionCode. EmployeeTaxArrangementExemption includes the following non-node elements: ObjectNodeReference, ValidityPeriod, EmployeeTaxationExemptionTypeCode, EmployeeTaxationExemptionAmount, and EmployeeTaxArrangementExemptionFamilyMember. ObjectNodeReference is a unique reference to an EmploymentItemWorkAgreementItemEmployeeTaxArrangementWorkAgreementItemExemptionVersion node and may be based on datatype GDT:ObjectNodeReference. ValidityPeriod may be based on datatype GDT:CLOSED_DatePeriod. EmployeeTaxationExemptionTypeCode may be based on datatype GDT:EmployeeTaxationExemptionTypeCode. EmployeeTaxationExemptionAmount may be based on datatype CDT:CURRENCYINR_MEDIUM_Amount. EmployeeTaxArrangementExemptionFamilyMember may be based on datatype MIDT:IN_EmplPyrlInptRplctnReqEmplEmplymtItmWrkAgrmtItmEmplTxArrgmtExmpFamilyMember. EmployeeTaxArrangementExemptionFamilyMember includes the following elements: ActionCode, ObjectNodeReference, UUID, BusinessPartnerUUID, and BusinessPartnerInternalID. ActionCode may be optional, is a coded representation of an instruction to a recipient of a message describing how to process a transmitted element and may be based on datatype GDT:ActionCode. ObjectNodeReference may be based on datatype GDT:ObjectNodeReference. UUID may be based on datatype GDT:UUID. BusinessPartnerUUID may be based on datatype GDT:UUID. BusinessPartnerInternalID may be based on datatype GDT:BusinessPartnerInternalID.

EmployeeTaxArrangementInvestment includes the following attributes: ActionCode and WorkAgreementItemInvestmentTaxReductionBasisListCompleteTransmissionIndicator. WorkAgreementItemInvestmentTaxReductionBasisListCompleteTransmissionIndicator specifies whether workAgreementItemInvestmentTaxReductionBasis data in a message is transmitted in its entirety and may be based on datatype CDT:Indicator. ActionCode is a coded representation of an instruction to a recipient of a message describing how to process a transmitted element and may be based on datatype GDT:ActionCode. EmployeeTaxArrangementInvestment includes the following non-node elements: ObjectNodeReference, UUID, ValidityPeriod, FixedIndicator, and WorkAgreementItemInvestmentTaxReductionBasis. ObjectNodeReference is a unique reference to an EmploymentItemWorkAgreementItemEmployeeTaxArrangementWorkAgreementItemInvestmentVersion node and may be based on datatype GDT:ObjectNodeReference. UUID may be based on datatype GDT:UUID. ValidityPeriod may be based on datatype GDT:CLOSED_DatePeriod. FixedIndicator may be based on datatype CDT:Indicator with a qualifier of Fixed. WorkAgreementItemInvestmentTaxReductionBasis may be based on datatype MIDT:IN_EmployeeTaxArrangementWorkAgreementItemInvestmentTaxReductionBasis. WorkAgreementItemInvestmentTaxReductionBasis includes the following elements: ActionCode, ObjectNodeReference, UUID, EmployeeTaxationBasisReductionTypeCode, PlannedinventmentAmount, and FinalInvestmentAmount. ActionCode is a coded representation of an instruction to a recipient of a message describing how to process a transmitted element and may be based on datatype GDT:ActionCode. ObjectNodeReference may be based on datatype GDT:ObjectNodeReference. UUID may be based on datatype GDT:UUID. EmployeeTaxationBasisReductionTypeCode may be based on datatype GDT:EmployeeTaxationBasisReductionTypeCode. PlannedInvestmentAmount may be optional and may be based on datatype CDT:CURRENCYINR_MEDIUM_Amount with a qualifier of Investment. FinalInvestmentAmount may be optional and may be based on datatype CDT:CURRENCYINR_MEDIUM_Amount with a qualifier of Investment.

EmployeeSocialInsuranceArrangementPeriodTerms includes the ActionCode attribute. ActionCode is a coded representation of an instruction to a recipient of a message describing how to process a transmitted element and may be based on datatype GDT:ActionCode. EmployeeSocialInsuranceArrangementPeriodTerms includes the following non-node elements: ObjectNodeReference, UUID, ValidityPeriod, EmployeeSocialInsuranceID, TemporaryEmployeeSocialInsuranceID, HospitalNameText, LabourWelfareFundRelevanceIndicator and GratuityEmployeeSocialInsuranceContributionAccountID. ObjectNodeReference is a unique reference to an EmploymentItemWorkAgreementItemEmployeeSocialInsuranceArrangementWorkAgreementItemPeriodTermsVersion node and may be based on datatype GDT:ObjectNodeReference. UUID may be based on datatype GDT:UUID. ValidityPeriod may be based on datatype GDT:CLOSED_DatePeriod with a qualifier of Validity. EmployeeSocialInsuranceID may be optional and may be based on datatype GDT:SocialInsuranceID with a qualifier of Employee. TemporaryEmployeeSocialInsuranceID may be optional and may be based on datatype GDT:SocialInsuranceID. HospitalNameText may be optional and may be based on datatype CDT:LANGUAGEINDEPENDENT_MEDIUM_Text. LabourWelfareFundRelevanceIndicator may be based on datatype CDT:Indicator with a qualifier of Relevance. GratuityEmployeeSocialInsuranceContributionAccountID may be optional and may be based on datatype GDT:EmployeeSocialInsuranceContributionAccountID.

Employee SocialInsuranceArrangementPensionInsurance includes the following attributes: ActionCode, WorkAgreementItemPensionInsurancePensionFundListCompleteTransmissionIndicator, and WorkAgreementItemPensionInsuranceProvidentFundListCompleteTransmissionIndicator. WorkAgreementItemPensionInsurancePensionFundListCompleteTransmissionIndicator specifies whether WorkAgreementItemPensionInsurancePensionFund data in a message is transmitted in its entirety and may be based on datatype CDT:Indicator. WorkAgreementItemPensionInsuranceProvidentFundListCompleteTransmissionIndicator specifies whether WorkAgreementItemPensionInsuranceProvidentFund data in a message is transmitted in its entirety and may be based on datatype CDT:Indicator. ActionCode is a coded representation of an instruction to a recipient of a message describing how to process a transmitted element and may be based on datatype GDT:ActionCode. EmployeeSocialInsuranceArrangementPensionInsurance includes the following non-node elements: ObjectNodeReference, ValidityPeriod, UUID, PensionFund, and ProvidentFund. ObjectNodeReference is a unique reference to an mploymentItemWorkAgreementItemEmployeeSocialInsuranceArrangementWorkAgreementItemPensionInsuranceVersion node and may be based on datatype GDT:ObjectNodeReference. UUID may be based on datatype GDT:UUID. ValidityPeriod may be based on datatype GDT:CLOSED_DatePeriod with a qualifier of Validity. PensionFund may be based on datatype MIDT:IN_EmployeeSocialInsuranceArrangementWorkAgreementItemPensionInsurancePension Fund. ProvidentFund may be optional and may be based on datatype MIDT:IN_EmplSocialInsuranceArrangementWorkAgreementItemPensionInsuranceProvidentFund.

PensionFund includes the following elements: ActionCode, BusinessPartnerUUID, BusinessPartnerInternalID, EmployeeSocialInsuranceContributionAccountID, and EmployerPaymentIndicator. ActionCode may be optional, is a coded representation of an instruction to a recipient of a message describing how to process a transmitted element, and may be based on datatype GDT:ActionCode. BusinessPartnerUUID may be based on datatype GDT:UUID. BusinessPartnerInternalID may be based on datatype GDT:BusinessPartnerInternalID. EmployeeSocialInsuranceContributionAccountID may be optional and may be based on datatype GDT:EmployeeSocialInsuranceContributionAccountID. EmployerPaymentIndicator may be optional and may be based on datatype CDT:Indicator with a qualifier of EmployerPayment.

ProvidentFund includes the following elements: ActionCode, BusinessPartnerUUID, BusinessPartnerInternalID, EmployeeSocialInsuranceContributionAccountID, AdditionalEmployeeContributionPercent, and AdditionalEmployeeContributionAmount. ActionCode may be optional, is a coded representation of an instruction to a recipient of a message describing how to process a transmitted element and may be based on datatype GDT:ActionCode. BusinessPartnerUUID may be based on datatype GDT:UUID. BusinessPartnerInternalID may be based on datatype GDT:BusinessPartnerInternalID. EmployeeSocialInsuranceContributionAccountID may be optional and may be based on datatype GDT:EmployeeSocialInsuranceContributionAccountID. AdditionalEmployeeContributionPercent may be optional and may be based on datatype CDT:SMALLNONNEGATIVE_Percent with a qualifier of Contribution. AdditionalEmployeeContributionAmount may be optional and may be based on datatype CDT:CURRENCYINR_MEDIUM_Amount.

ExpenseReportSettlementResult includes the following attributes: ActionCode and PayrollTotalItemListCompleteTransmissionIndicator. ActionCode may be based on datatype GDT:ActionCode. PayrollTotalItemListCompleteTransmissionIndicator may be based on datatype CDT:Indicator with a qualifier of CompleteTransmission. ExpenseReportSettlementResult includes the following non-node elements: ObjectNodeReference, ExpenseReportID, ExpenseReportStartDate, ExpenseReportEndDate, and PostingTransactionBasePostingDate. ObjectNodeReference may be optional and may be based on datatype GDT:ObjectNodeReference. ExpenseReportID may be optional and may be based on datatype GDT:ExpenseReportID. ExpenseReportStartDate may be optional and may be based on datatype CDT:Date. ExpenseReportEndDate may be based on datatype CDT:Date. PostingTransactionBasePostingDate may be optional and may be based on datatype CDT:Date. In some implementations, if the value of the attribute ActionCode is “Delete”, only an ObjectNodeReference is filled.

ExpenseReportSettlementResult includes the node element PayrollTotalItem in a 1:CN cardinality relationship. PayrollTotalItem includes the components of an ExpenseReport that are subject to taxation and reporting in Payroll Processing. PayrollTotalItem includes the ActionCode attribute, which may be based on datatype GDT:ActionCode. PayrollTotalItem includes the following non-node elements: Amount, PayrollExpenseGroupCode, MealReceiptNumberValue, and Note. Amount may be optional and may be based on datatype CDT:Amount. PayrollExpenseGroupCode may be optional and may be based on datatype GDT:PayrollExpenseGroupCode. MealReceiptNumberValue may be based on datatype GDT:NumberValue. Note may be optional and may be based on datatype GDT:Note.

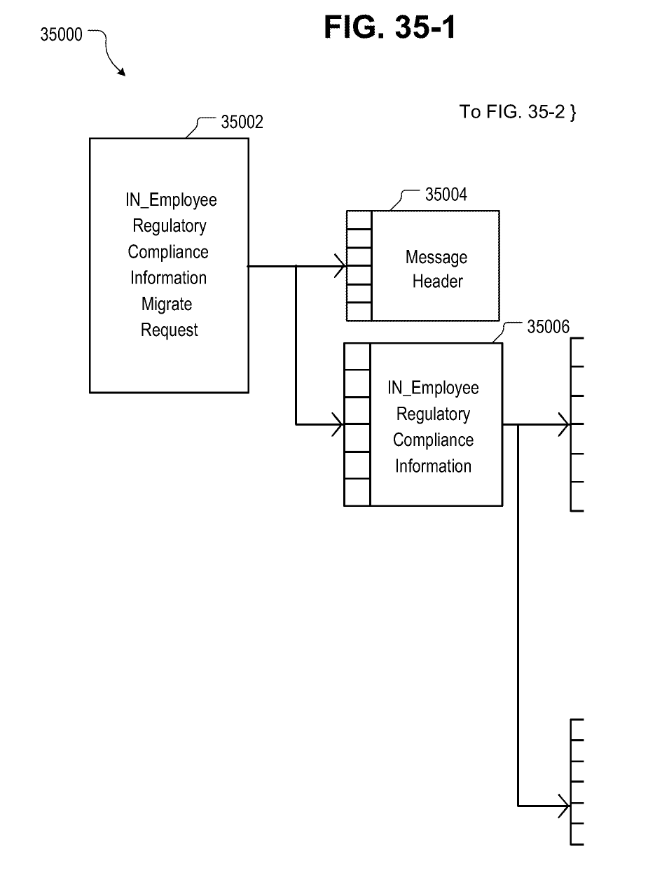

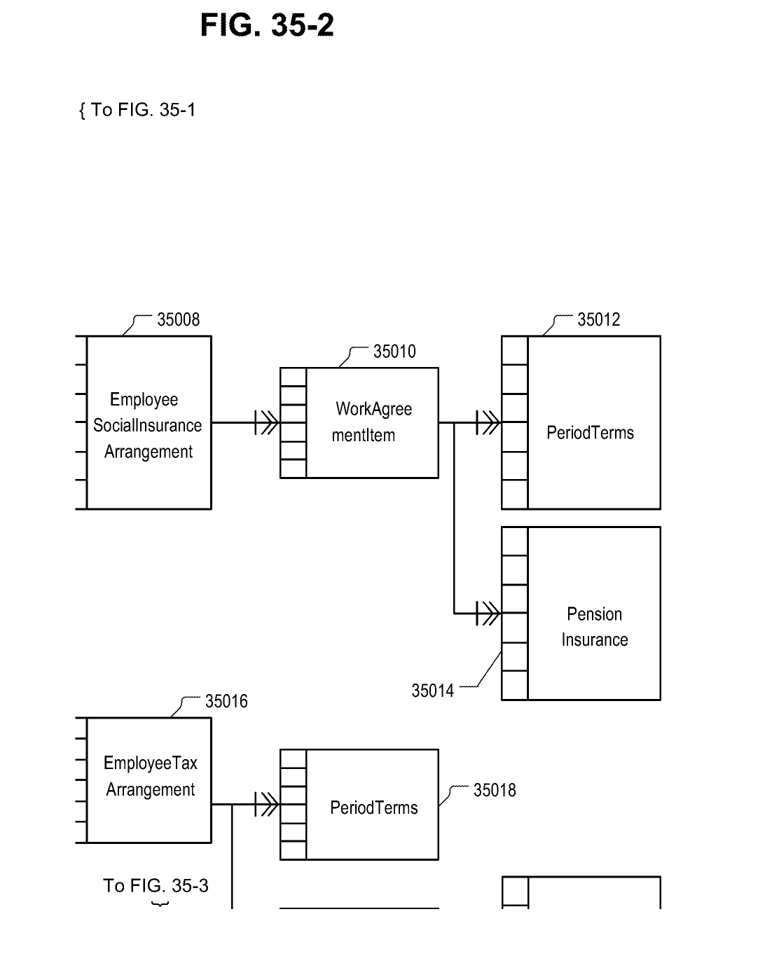

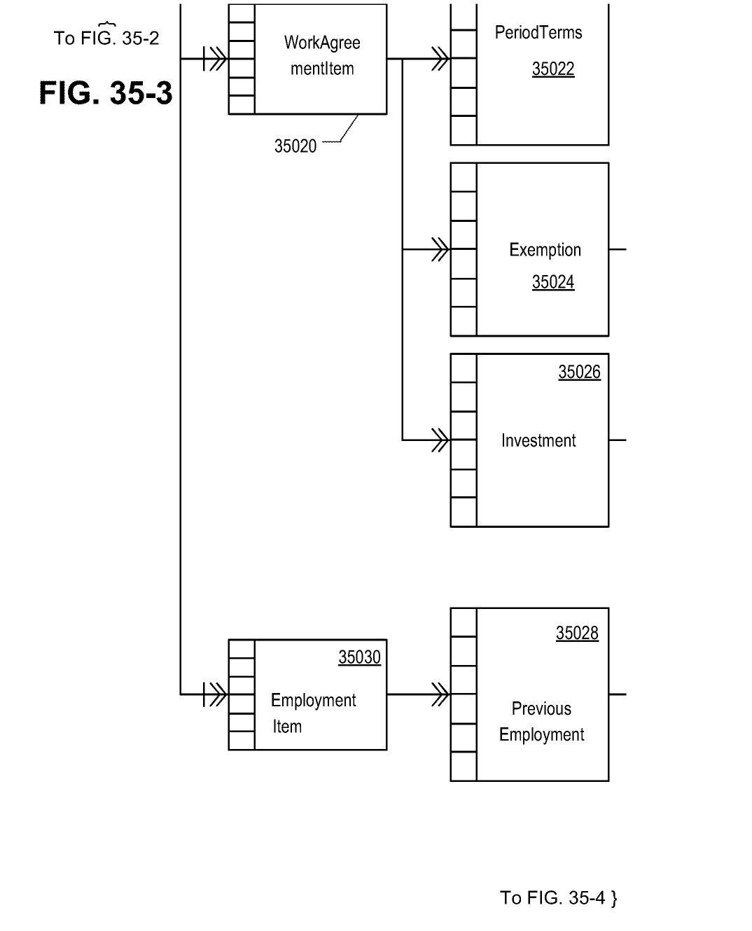

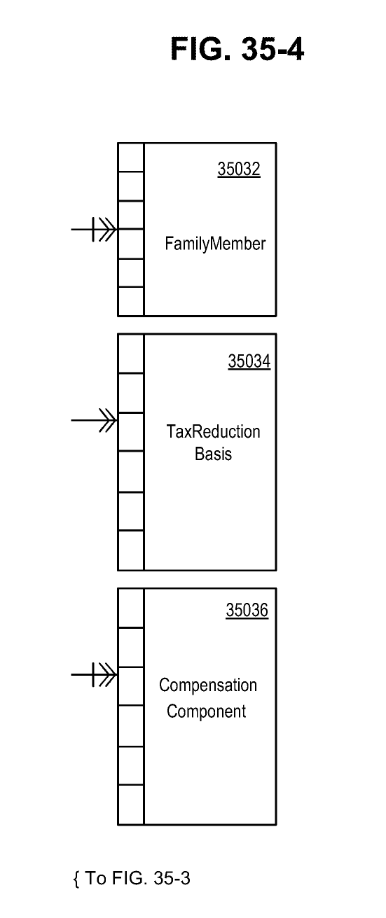

FIGS. 35-1 through 35-4 depict an example IN_Employee Regulatory Compliance Information Migrate Request Message Data Type 35000, which comprises 35002-35036, hierarchically related as shown. For example, the IN_Employee Regulatory Compliance Information Migrate Request 35002 includes a MessageHeader 35004.

The message type IN_Employee Regulatory Compliance Information Migrate Request is derived from the business object IN_Employee Regulatory Compliance Information_Virtual Object as a leading object together with its operation signature. The message type IN_Employee Regulatory Compliance Information Migrate Request is a request to migrate information regarding employee regulatory compliance. A structure of the message type IN_Employee Regulatory Compliance Information Migrate Request is determined by a message data type IN_EmployeeRegulatoryComplianceInformationMigrateRequestMessage. The message data type IN_EmployeeRegulatoryComplianceInformationMigrateRequestMessage includes an object IN_EmployeeRegulatoryComplianceInformation which is included in a business document, business information that is relevant for sending a business document in a message, the MessageHeader package, and the IN_EmployeeRegulatoryComplianceInformation package. The messagedata type IN_EmployeeRegulatoryComplianceInformationMigrateRequestMessage provides a structure for the IN_Employee Regulatory Compliance Information Migrate Request message type and for associated operations.

The MessageHeader package is a grouping of business information that is relevant for sending a business document in a message. The MessageHeader package includes the MessageHeader node. The MessageHeader node is a grouping of business information from the perspective of a sending application, such as information to identify the business document in a message, information about the sender, and optionally information about the recipient. The MessageHeader includes SenderParty and RecipientParty. MessageHeader may be based on the datatype GDT:BusinessDocumentMessageHeader. SenderParty is the partner responsible for sending a business document at a business application level. The SenderParty is of the type GDT:BusinessDocumentMessageHeaderParty. RecipientParty is of the type GDT:BusinessDocumentMessageHeaderParty. RecipientParty is the partner responsible for receiving a business document at a business application level.

The IN_EmployeeRegulatoryComplianceInformation package is a grouping of IN_EmployeeRegulatoryComplianceInformation with its EmployeeSocialInsuranceArrangement and EmployeeTaxArrangement packages and with the IN_EmployeeRegulatoryComplianceInformation entity. IN_EmployeeRegulatoryComplianceInformation includes information that is kept in HR (Human Resources) for an employee due to Indian legal obligations and prescribed legal reporting (e.g., social insurance and tax data required for record-keeping and correct calculation of legal deductions). IN_EmployeeRegulatoryComplianceInformation includes the EmployeeID non-node element, which may be optional and which may be based on datatype GDT:EmployeeID. IN_EmployeeRegulatoryComplianceInformation may include the node elements EmployeeSocialInsuranceArrangement in a 1:1 cardinality relationship and the node element EmployeeTaxArrangement in a 1:1 cardinality relationship.

The IN_EmployeeRegulatoryComplianceInformationEmployeeSocialInsuranceArrangement package includes the EmployeeSocialInsuranceArrangement entity. EmployeeSocialInsuranceArrangement is an arrangement for an employee by Indian bodies that are legally responsible for administering an employee's social insurance contributions. This arrangement concerns information from one employee and from all work agreements required for calculation of Indian social insurance contributions and reporting according to Indian legal requirements. EmployeeSocialInsuranceArrangement includes the WorkAgreementItem node element in a 1:CN cardinality relationship.

WorkAgreementItem is a set of information required for Indian Social Insurance calculation and reporting purposes for one Work Agreement. WorkAgreementItem includes the WorkAgreementID non-node element, which may be based on datatype GDT:WorkAgreementID. WorkAgreementItem may include the node element PeriodTerms in a 1:CN cardinality relationship and the node element PensionInsurance in a 1:CN cardinality relationship.

PeriodTerms is a set of generic social insurance attributes which are valid for one work agreement relevant to a social insurance deduction calculation and reporting for a particular validity period. PeriodTerms includes the following non-node elements: ValidityPeriod, EmployeeSocialInsuranceID, TemporaryEmployeeSocialInsuranceID, HospitalNameText, LabourWelfareFundRelevanceIndicator, and GratuityEmployeeSocialInsuranceContributionAccountID.

ValidityPeriod is a validity period of a one Work Agreement Item Period Terms, and may be based on datatype GDT:CLOSED_DatePeriod with a qualifier of Validity. EmployeeSocialInsuranceID is a Social Insurance Arrangement account identification for an Employee and may be based on datatype GDT:SocialInsuranceID. TemporaryEmployeeSocialInsuranceID is a Temporary Social Insurance Arrangement account identification for an Employee and may be based on datatype GDT:SocialInsuranceID. HospitalNameText is a name of a Hospital recognized by a Social Insurance Arrangement of an Employee and may be based on datatype CDT:LANGUAGEINDEPENDENT_MEDIUM_Text. LabourWelfareFundRelevanceIndicator indicates a relevance for a Labour Welfare Fund and may be based on datatype CDT:Indicator with a qualifier of Relevance. GratuityEmployeeSocialInsuranceContributionAccountID is a gratuity account identification of a Social Insurance Arrangement of an Employee and may be based on datatype GDT:EmployeeSocialInsuranceContributionAccountID.

PensionInsurance is a set of relevant attributes of an Indian Pension Insurance that an employee has for a validity period. PensionInsurance includes the following non-node elements: ValidityPeriod, PensionFund, BusinessPartnerUUID, BusinessPartnerInternalID, EmployeeSocialInsuranceContributionAccountID, EmployerPaymentIndicator, and ProvidentFund. BusinessPartnerUUID may be based on datatype GDT:UUID. BusinessPartnerInternalID is a unique identifier that identifies exactly one Provident Fund Business Partner and may be based on datatype GDT:BusinessPartnerInternalID. EmployeeSocialInsuranceContributionAccountID may be optional, is an identifier of a contribution account of an employee assigned by a Provident Fund, and may be based on datatype GDT:EmployeeSocialInsuranceContributionAccountID. AdditionalEmployeeContributionPercent may be optional, is a contribution percent for an additional contribution for a Provident Fund of an Employee, and may be based on datatype CDT:SMALLNONNEGATIVE_Percent with a qualifier of Contribution. AdditionalEmployeeContributionAmount may be optional, is a contribution amount for an additional contribution for a Provident Fund of an Employee, and may be based on datatype CDT:CURRENCYINR_MEDIUM_Amount with a qualifier of Contribution. ValidityPeriod is a validity period of a Work Agreement Item Pension Insurance and may be based on datatype GDT:CLOSED_DatePeriod with a qualifier of Validity. PensionFund may be optional and may be based on datatype MIDT:IN_EmplRgtyCmpincInfoMigrtReqEmplSoclInsurArrgmtWrkAgrmtItmPensnInsurPensionFund. EmployerPaymentIndicator indicates whether an employer contributes to a Pension fund and may be based on datatype CDT:Indicator with a qualifier of EmployerPayment. ProvidentFund may be optional and may be based on datatype MIDT:IN_EmplRgtyCmpincInfoMigrtReqEmplSoclInsurArrgmtWrkAgrmtItmPensnInsurPrvdtFund.

The IN_EmployeeRegulatoryComplianceInformationEmployeeTaxArrangement package includes the EmployeeTaxArrangement entity. EmployeeTaxArrangement is an arrangement between an employee and Indian tax authorities that defines rules of how an employer calculates and reports taxes for an employee to be compliant with Indian legal requirements. EmployeeTaxArrangement includes information recorded from a tax card submitted by an employee (e.g. tax identifier, tax area, employee tax type) and supplementary details (e.g., taxation category, indicator for tax exempted). EmployeeTaxArrangement includes the PeriodTerms node element in a 1:CN cardinality relationship, the WorkAgreementItem node element in a 1:CN cardinality relationship, and the node element EmploymentItem in a 1:CN cardinality relationship.

PeriodTerms is a set of information relevant for Indian tax calculation and reporting purposes for an employee for a validity period. PeriodTerms includes the following non-node elements: Validity Period, EmployeeTaxID, and WorkAgreementItem. Validity Period is a validity period of a Period Terms and may be based on datatype GDT:CLOSED_DatePeriod. EmployeeTaxID is an identifier of an Employee for tax purposes and may be based on datatype GDT:PartyTaxID.

WorkAgreementItem is a set of information required for Indian tax calculation and reporting purposes for a Work Agreement. WorkAgreementItem includes the WorkAgreementID non-node element which may be based on datatype GDT:WorkAgreementID. WorkAgreementItem may include the node element PeriodTerms in a 1:N cardinality relationship, the node element Exemption in a 1:N cardinality relationship, and the node element Investment in a 1:N cardinality relationship.

PeriodTerms is a set of tax relevant attributes which are valid for a work agreement for a validity period. PeriodTerms includes the following non-node elements: ValidityPeriod, CityTaxationCategoryCode, HouseRentAmount, ExemptedIndicator, and ProfessionalTaxRelevanceIndicator.

ValidityPeriod is a validity period of a WorkAgreementItemPeriodTerms node and may be based on datatype GDT:CLOSED_DatePeriod with a qualifier of Validity. CityTaxationCategoryCode may be optional, a coded representation of a city category for taxation purposes of an employees residence and may be based on datatype GDT:CityTaxationCategoryCode. HouseRentAmount may be optional, indicates an amount paid per month as rent towards employee accommodation and may be based on datatype CDT:CURRENCYINR_MEDIUM_Amount with a qualifier of Rent. ExemptedIndicator is an indicator to denote whether a special exemption for taxes applies and may be based on datatype CDT:Indicator with a qualifier of Exempted. ProfessionalTaxRelevanceIndicator indicates whether a tax is relevant for a given profession and may be based on datatype CDT:Indicator with a qualifier of Relevance.

Exemption is a set of tax relevant exemptions which are valid for a work agreement for a validity period. Exemption includes the following non-node elements: ValidityPeriod, EmployeeTaxationExemptionTypeCode, and EmployeeTaxationExemptionAmount. ValidityPeriod is a validity period of a WorkAgreementItemExemptAllowances node and may be based on datatype GDT:CLOSED_DatePeriod with a qualifier of Validity. EmployeeTaxationExemptionTypeCode is a coded representation of a taxation exemption type for an employee and may be based on datatype GDT:EmployeeTaxationExemptionTypeCode. EmployeeTaxationExemptionAmount is an amount exempted for an employee taxation and may be based on datatype CDT:CURRENCYINR_MEDIUM_Amount.

Exemption may include the FamilyMember node element in a 1:CN cardinality relationship. FamilyMember is a family member for whom a tax exemption is applicable. FamilyMember includes the following non-node elements: BusinessPartnerUUID and BusinessPartnerInternalID. BusinessPartnerUUID may be based on datatype GDT:UUID. BusinessPartnerInternalID is an identifier that identifies exactly one Family Member and may be based on datatype GDT:BusinessPartnerInternalID.

Investment is a set of tax-relevant investment details which are valid for a work agreement for a validity period. Investment includes the following non-node elements: ValidityPeriod and FixedIndicator. ValidityPeriod is a validity period of a WorkAgreementItemnvestment node and may be based on datatype GDT:CLOSED_DatePeriod with a qualifier of Validity. FixedIndicator indicates whether an employee has fixed an investment and may be based on datatype CDT:Indicator with a qualifier of Fixed.

Investment may include the node element TaxReductionBasis in a 1:N cardinality relationship. TaxReductionBasis is a tax reduction basis due to an investment of an employee valid for a Work Agreement Item Investment node. TaxReductionBasis includes the following non-node elements: EmployeeTaxationBasisReductionTypeCode, PlannedInvestmentAmount, and FinalInvestmentAmount. EmployeeTaxationBasisReductionTypeCode is a coded representation of a reduction type which may be applied to a tax basis of an employee and may be based on datatype GDT:EmployeeTaxationBasisReductionTypeCode. PlannedInvestmentAmount may be optional, is a planned amount of an investment over a tax year, and may be based on datatype CDT:CURRENCYINR_MEDIUM_Amount with a qualifier of Investment. FinalInvestmentAmount may be optional, is a final amount of an investment over a tax year, and may be based on datatype CDT:CURRENCYINR_MEDIUM_Amount with a qualifier of Investment.

EmploymentItem is a set of information relevant for Indian tax calculation and reporting purposes for an employment. EmploymentItem includes the following non-node elements: CompanyID and CountryCode. CompanyID may be based on datatype GDT:OrganisationalCentreID. CountryCode may be based on datatype GDT:CountryCode. EmploymentItem may include the node element PreviousEmployment in a 1:N cardinality relationship. PreviousEmployment is a set of tax relevant attributes from previous employments in a current tax year. PreviousEmployment includes the following non-node elements: ValidityPeriod, LeaveTravelAllowanceNumberValue, and LeaveTravelAllowanceRelevanceIndicator. ValidityPeriod is a validity period of an Employment Item Previous Employer and may be based on datatype GDT:CLOSED_DatePeriod with a qualifier of Validity. LeaveTravelAllowanceNumberValue is a number value of allowances due to travel leave and may be based on datatype GDT:SMALL_NumberValue. LeaveTravelAllowanceRelevanceIndicator indicates a tax relevance of leave travel allowance and may be based on datatype CDT:Indicator with a qualifier of Relevance.

EmploymentItem may include the node element CompensationComponent in a 1:1 cardinality relationship. CompensationComponent is a component that includes a taxation category code and amount from previous employments in a current tax year. CompensationComponent includes the following non-node elements: TaxationCategoryCode and TaxationCategoryAmount. TaxationCategoryCode is a coded representation of a taxation category of a Compensation Component and may be based on datatype GDT:CompensationComponentTaxationCategoryCode. TaxationCategoryAmount is an amount due for a given taxation category and may be based on datatype CDT:CURRENCYINR_MEDIUM_Amount.

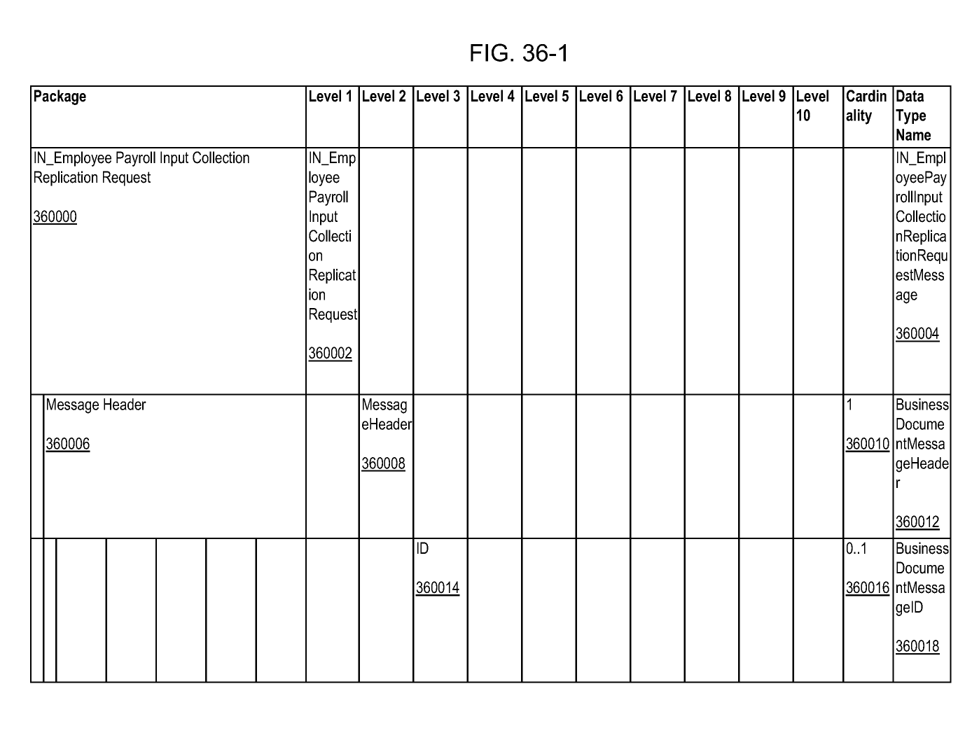

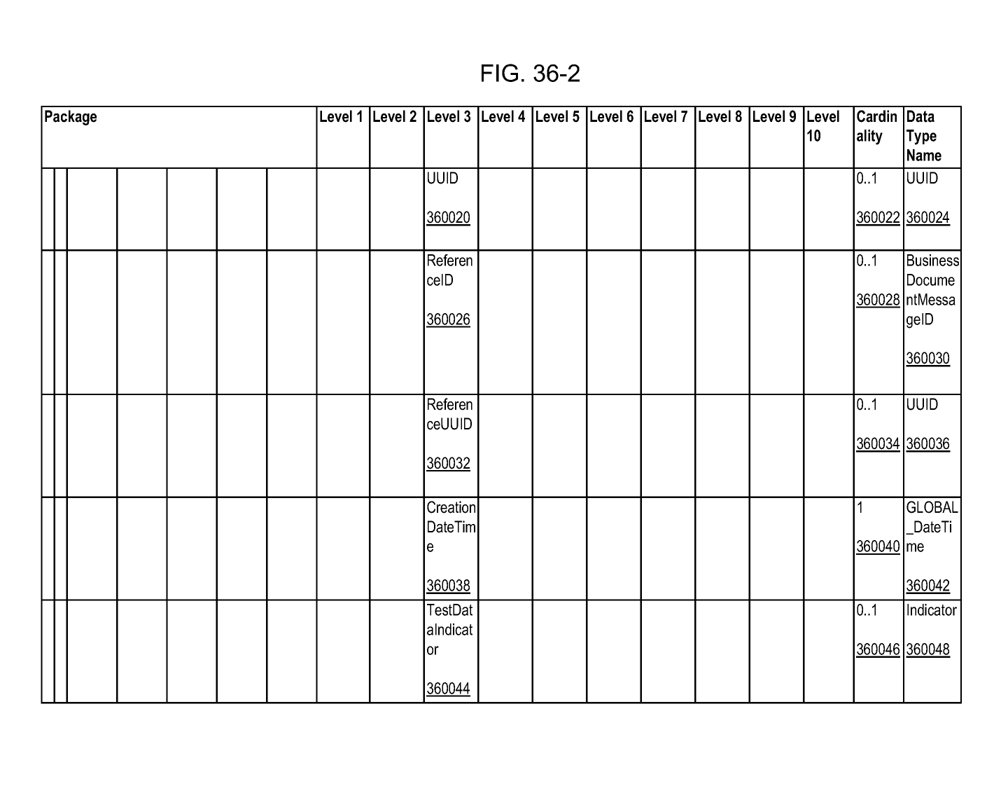

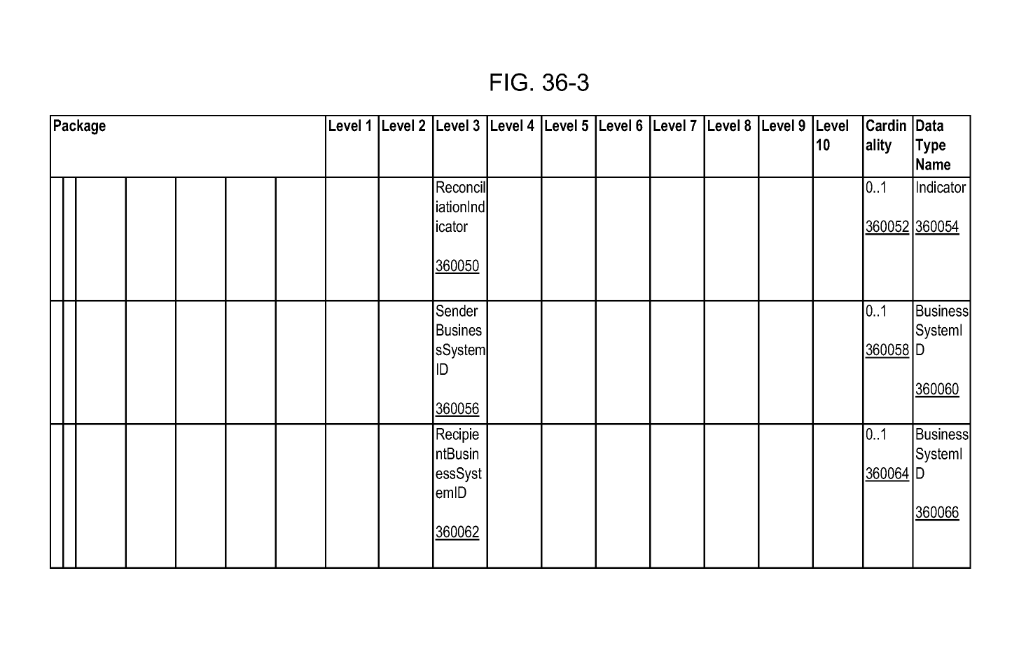

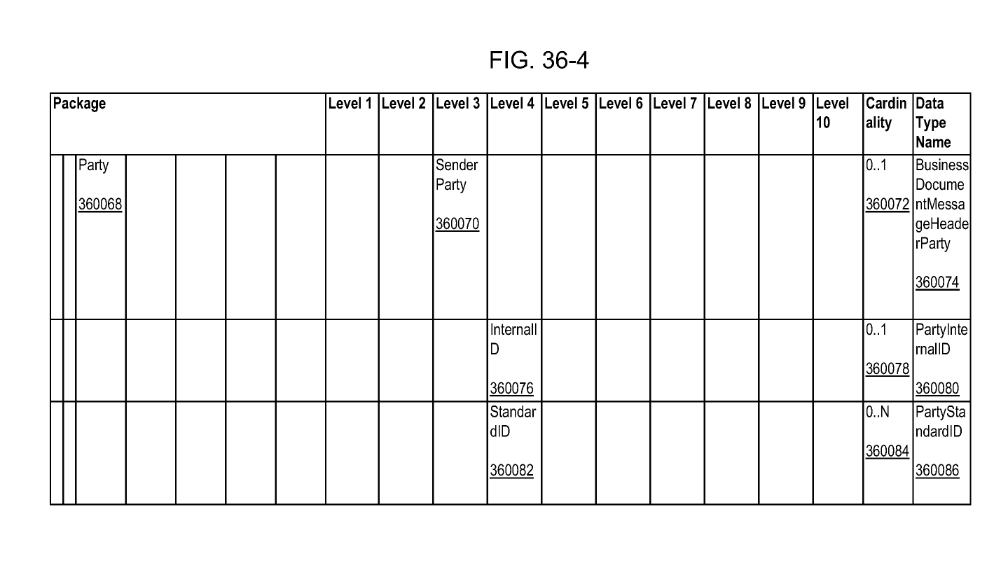

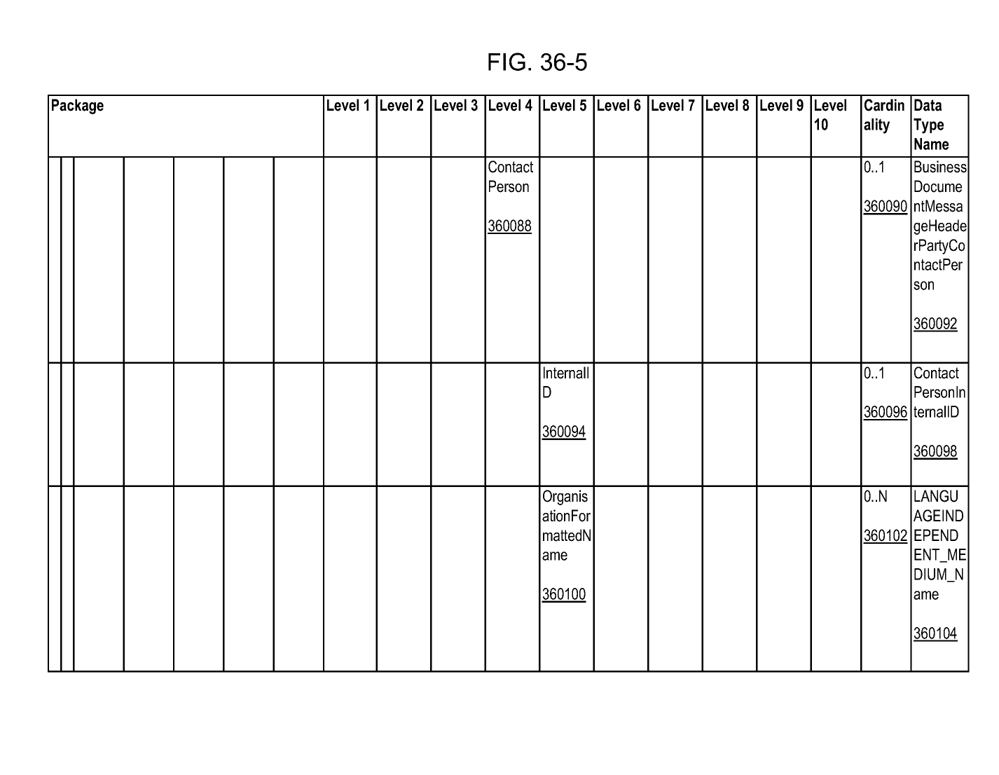

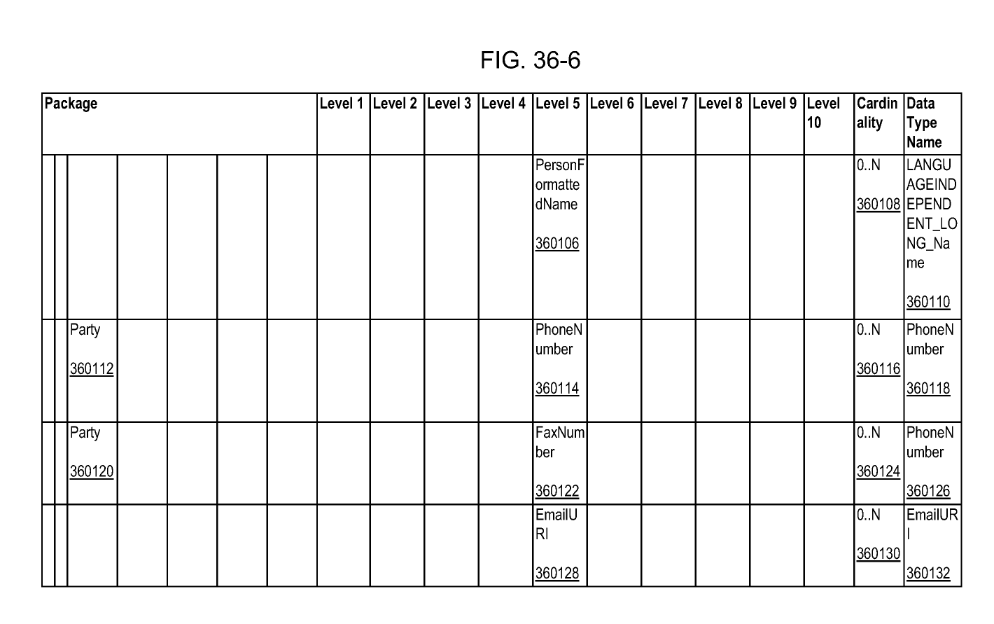

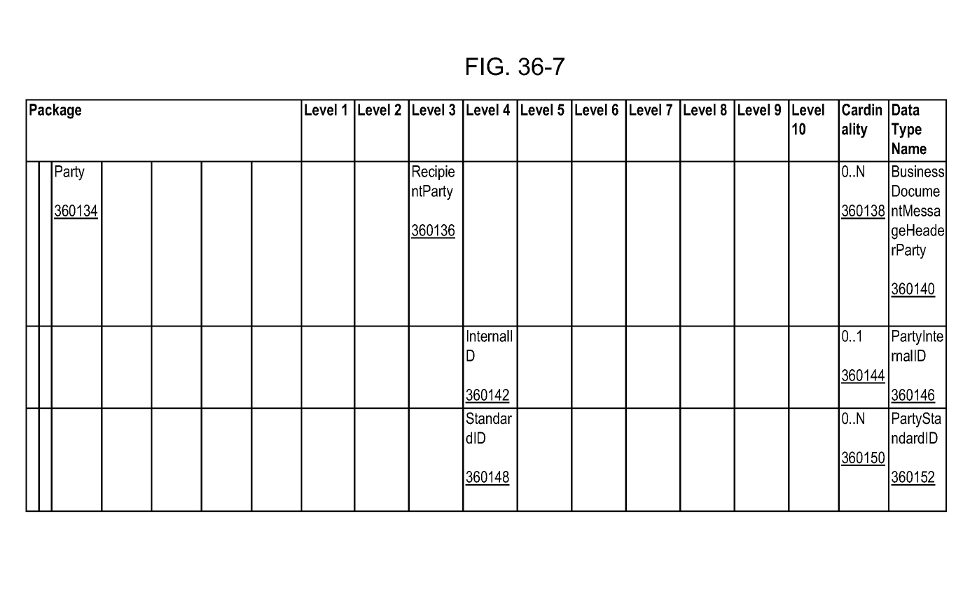

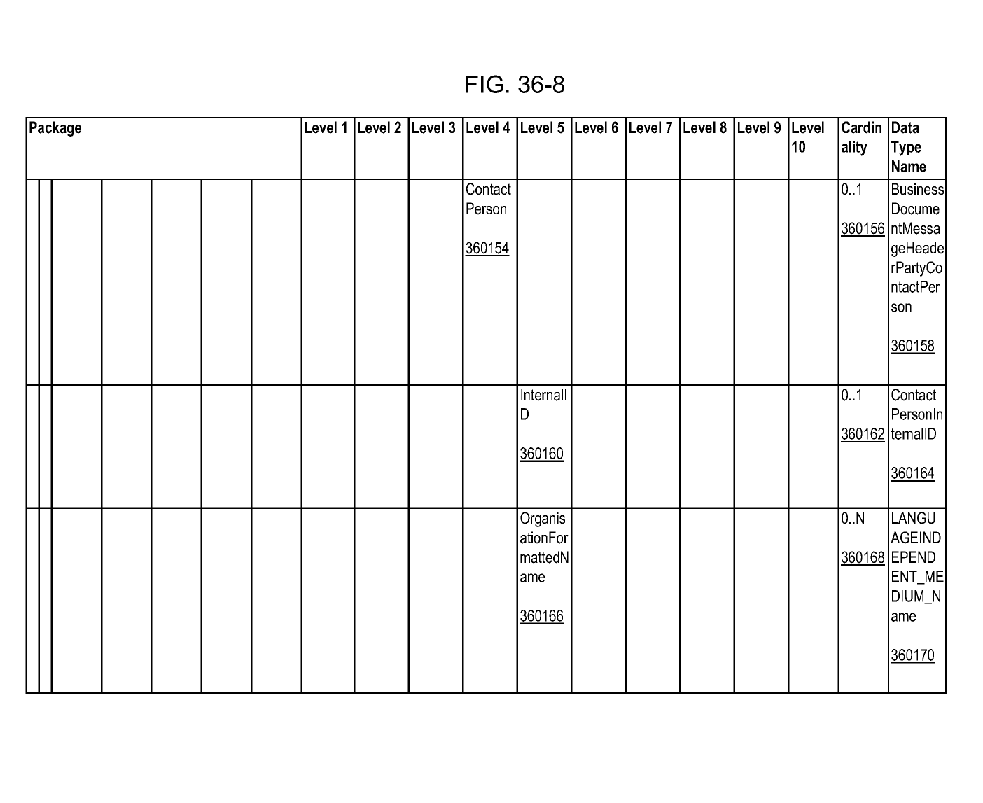

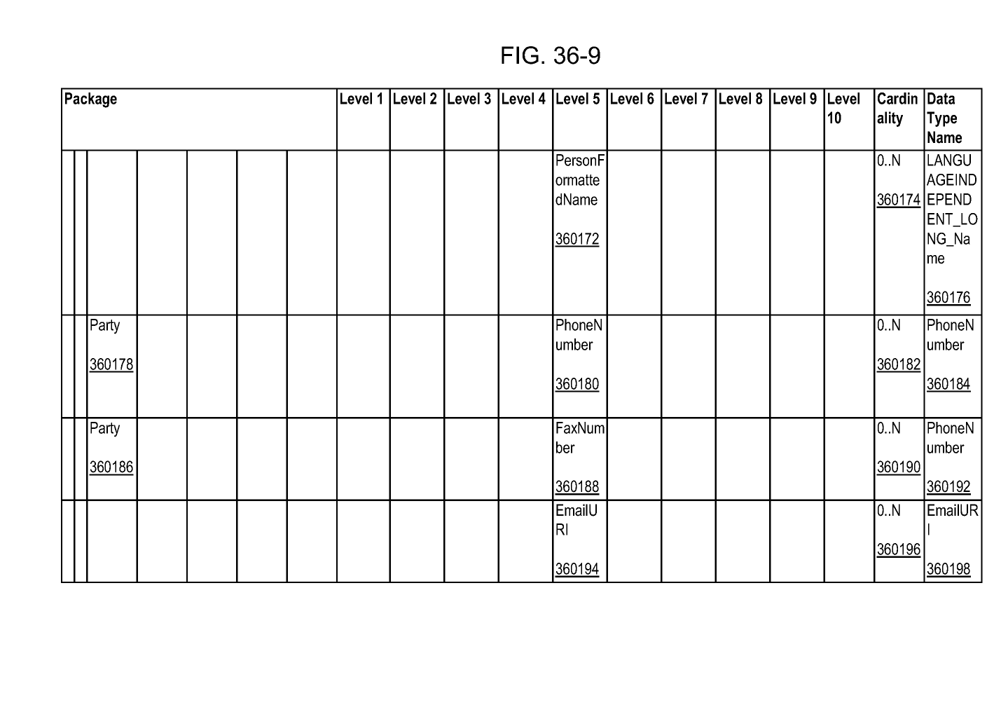

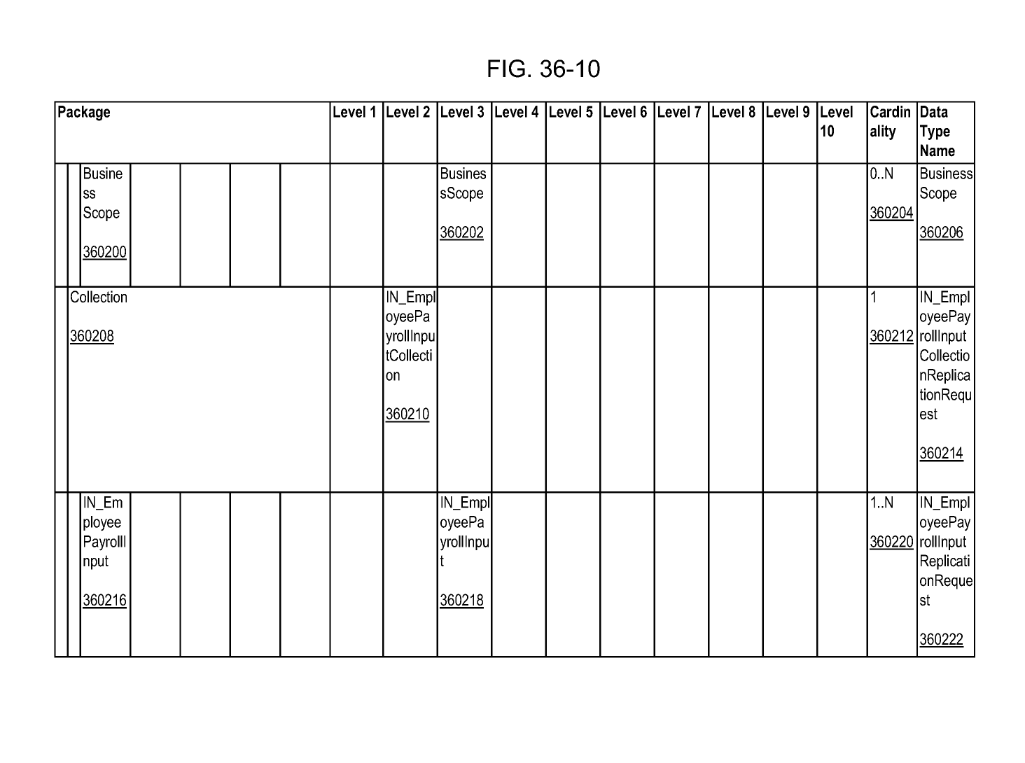

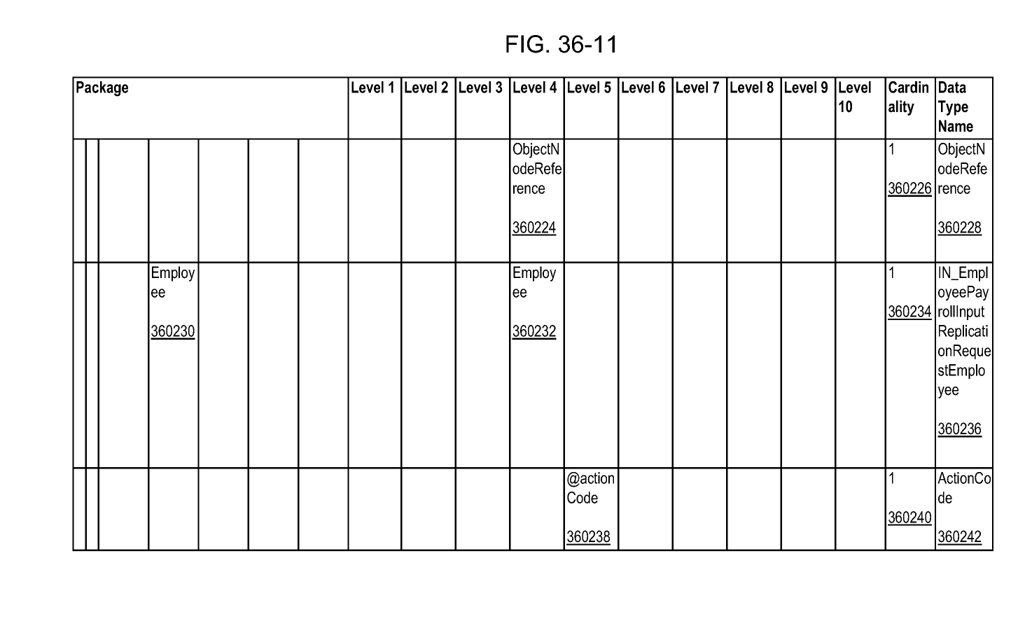

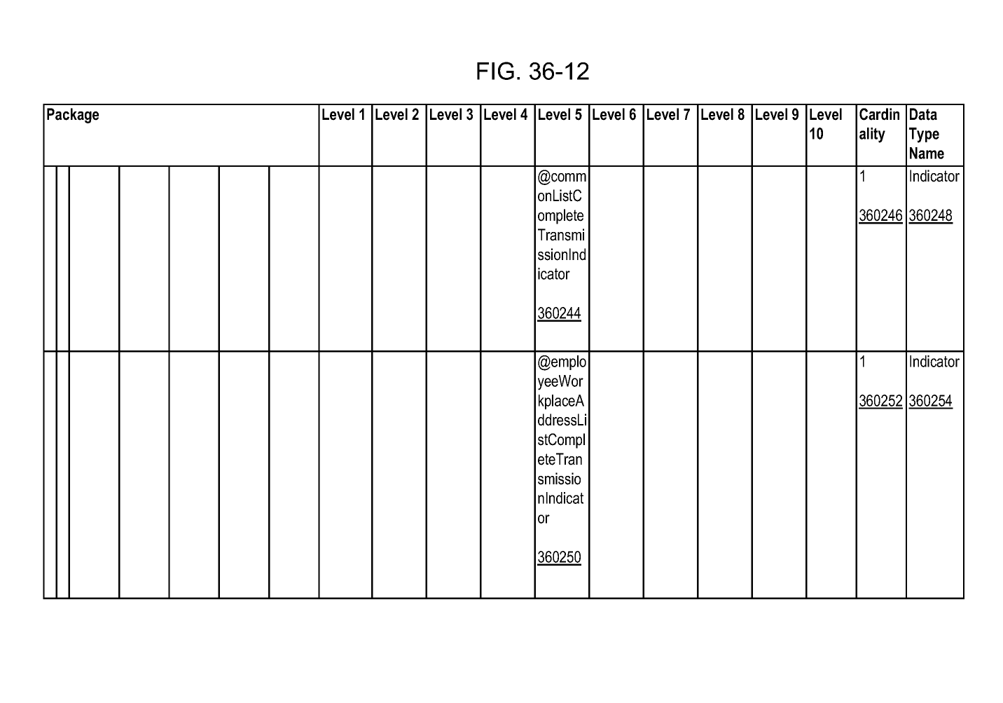

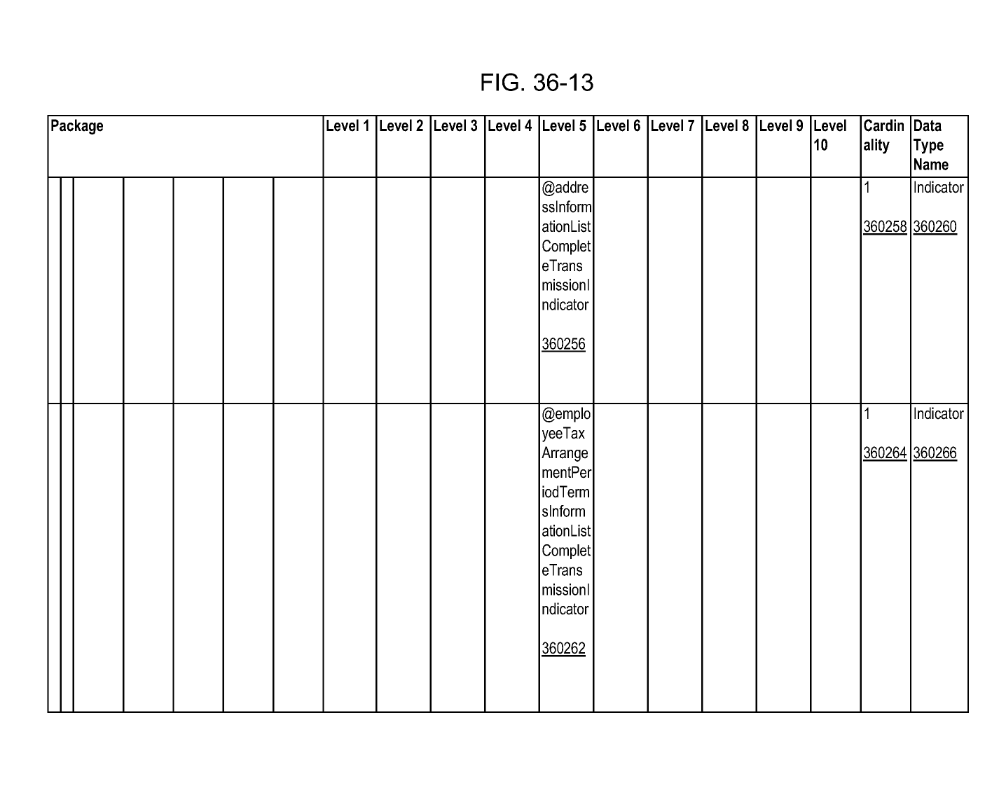

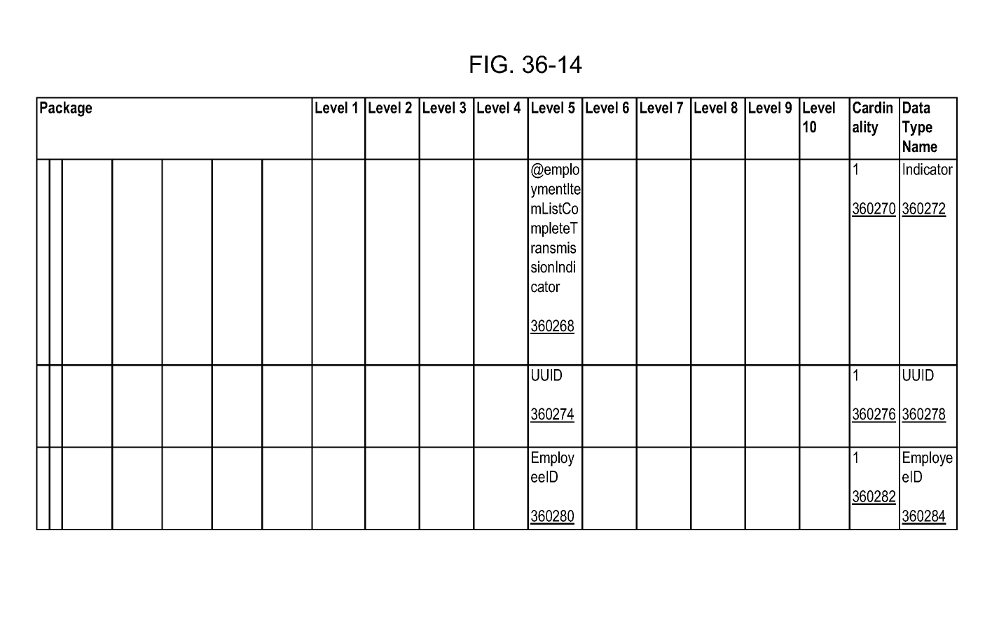

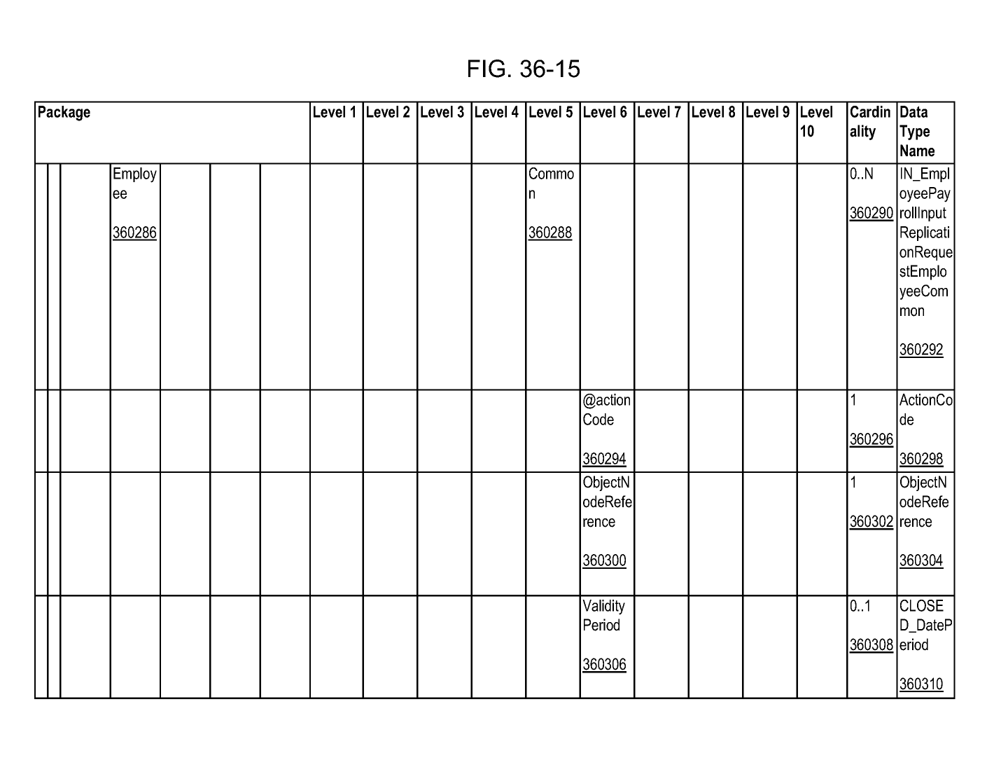

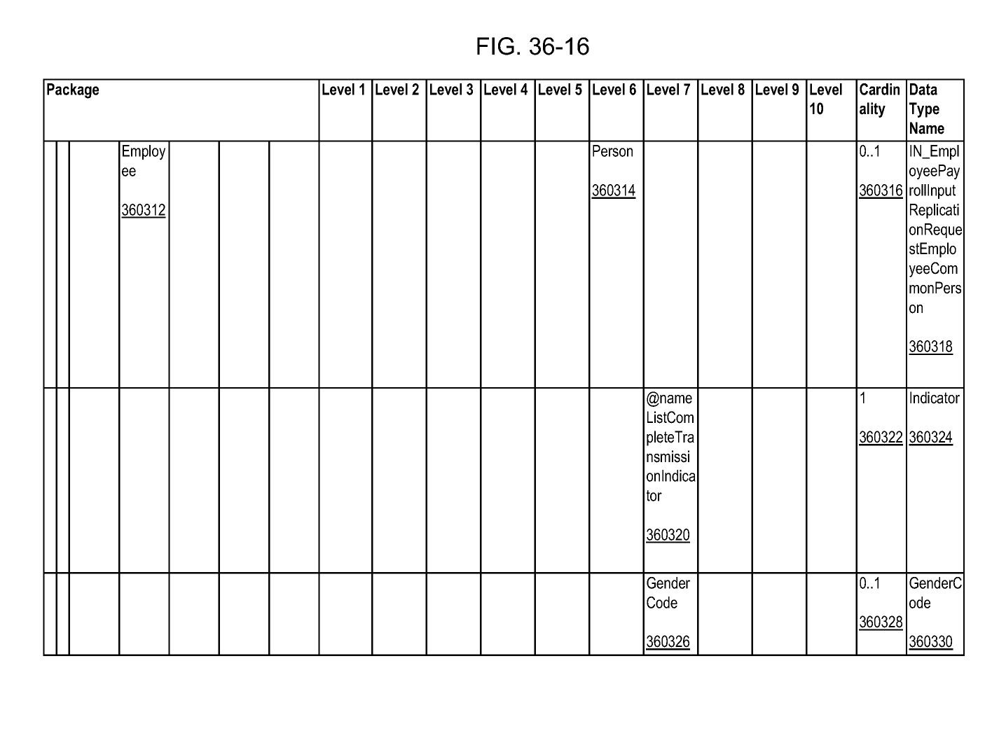

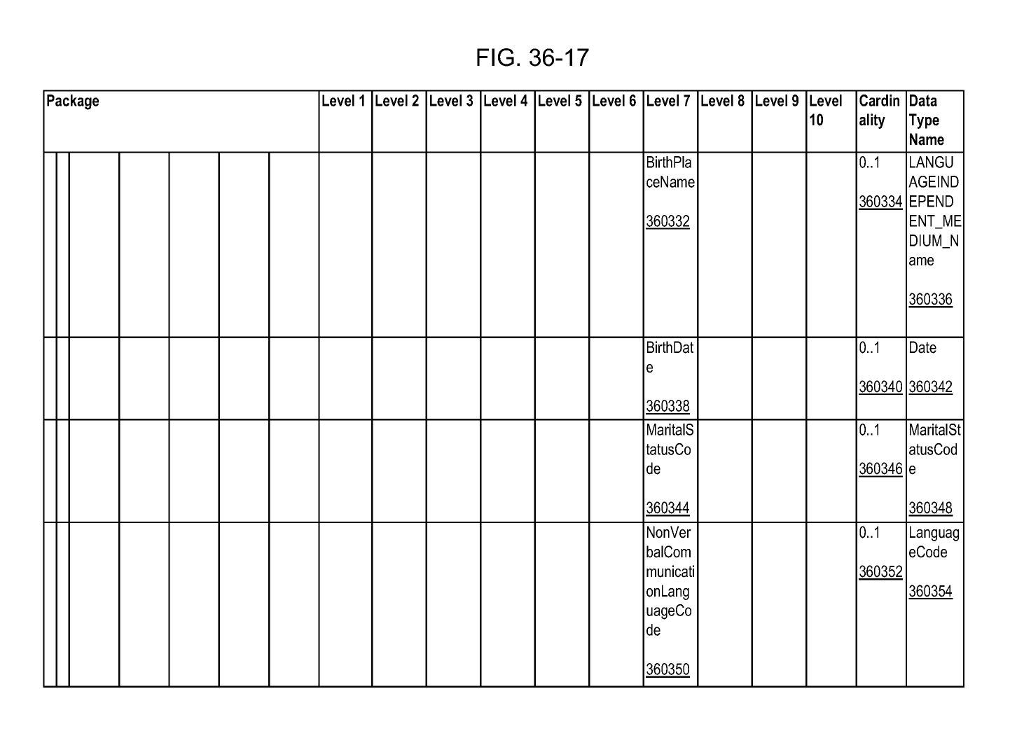

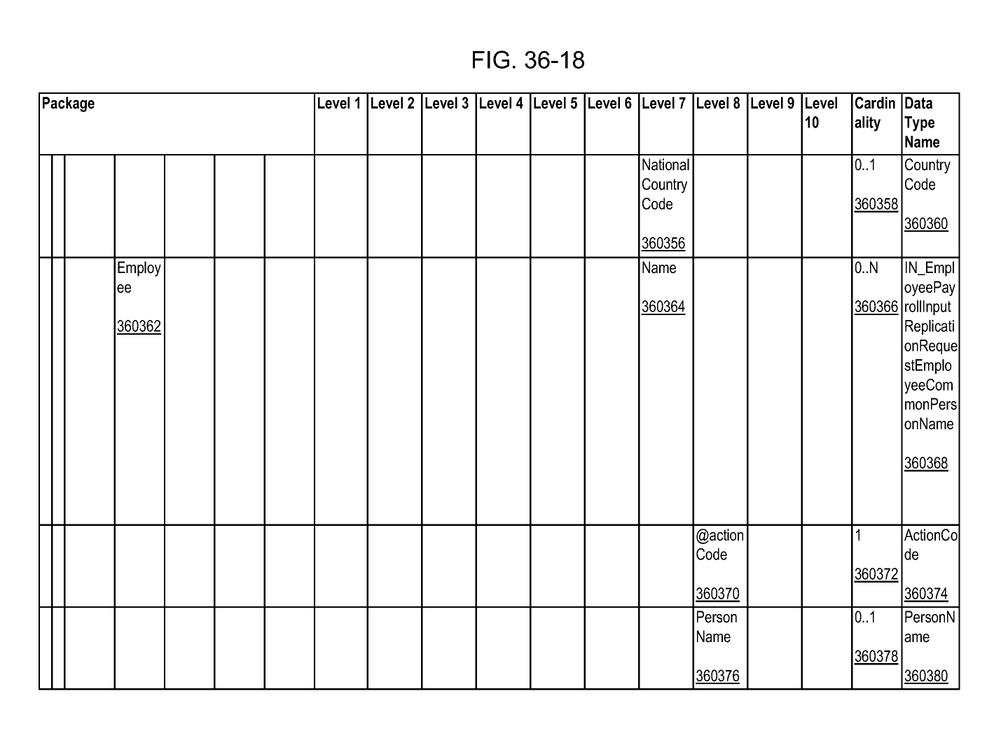

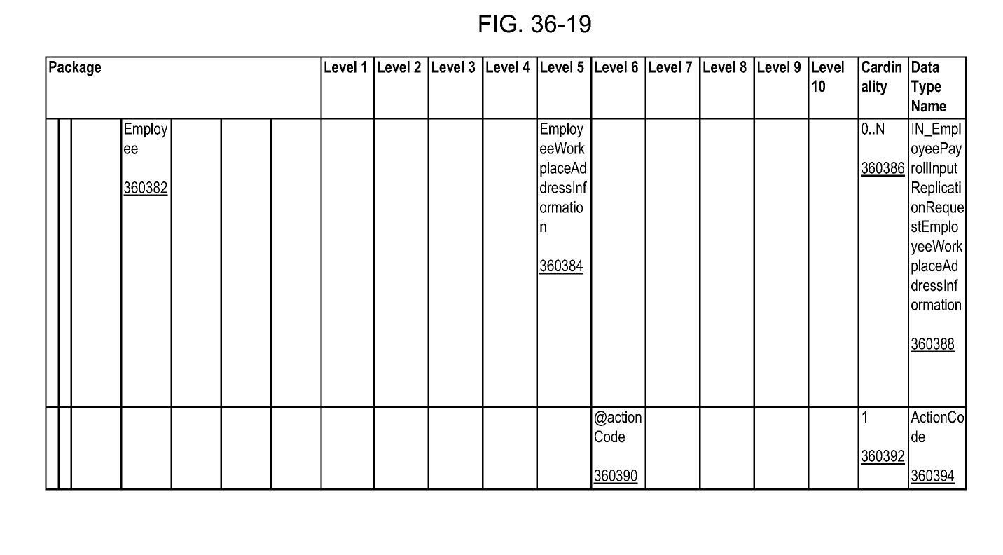

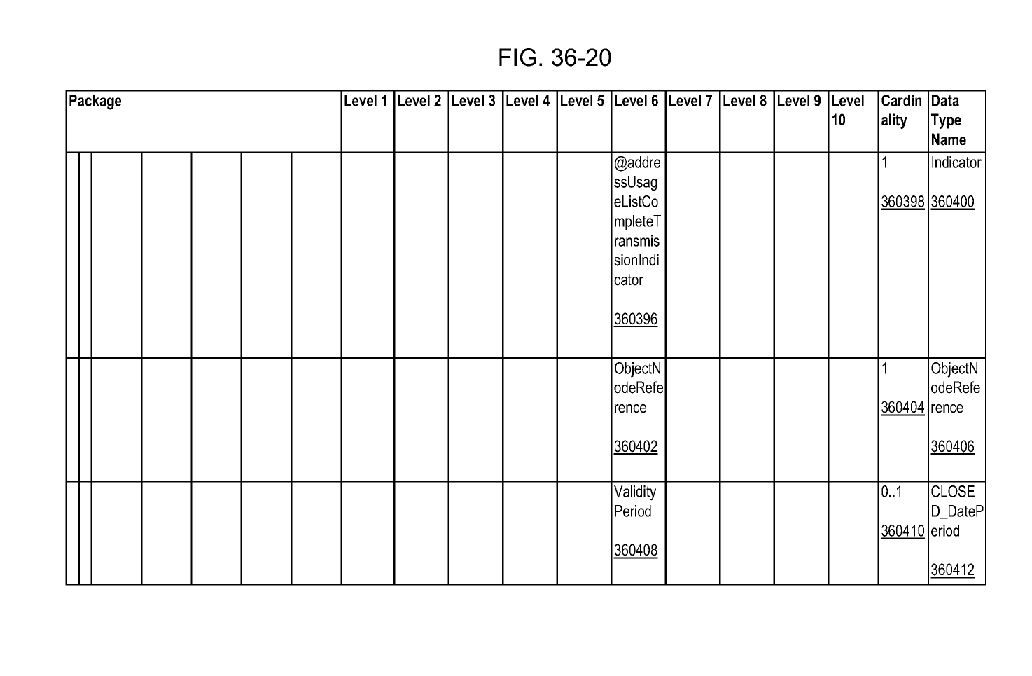

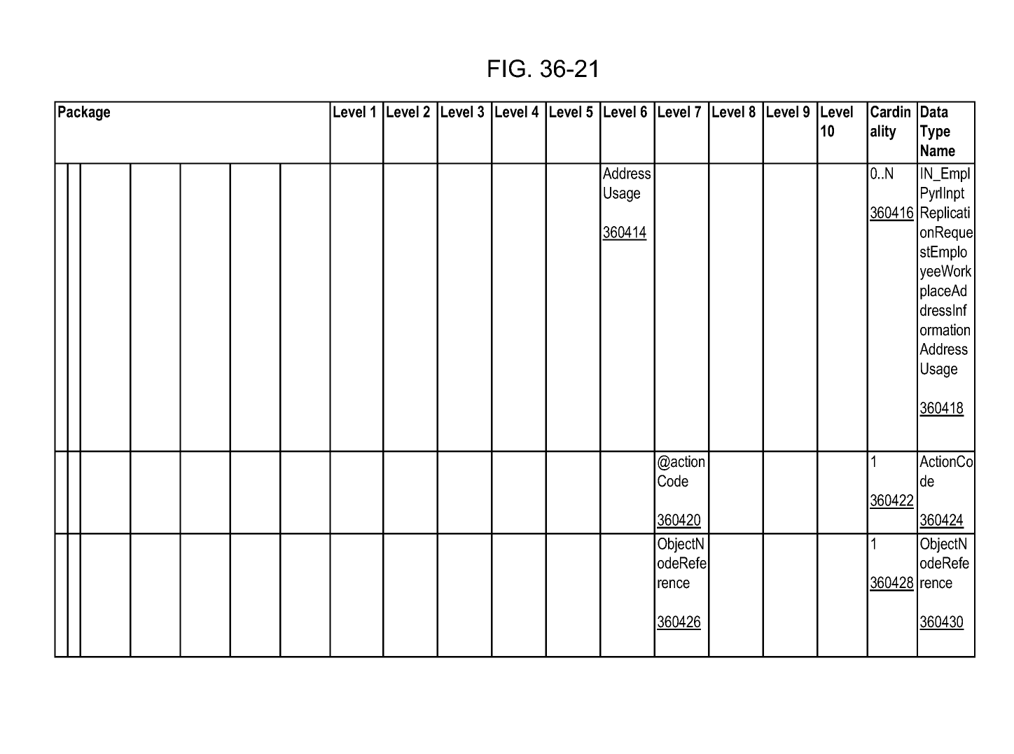

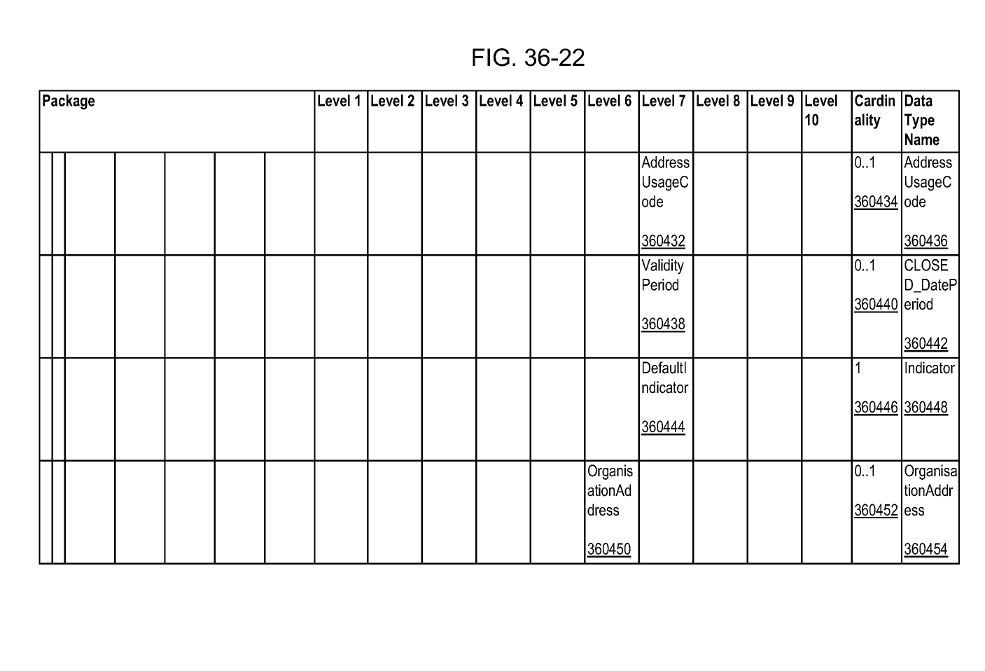

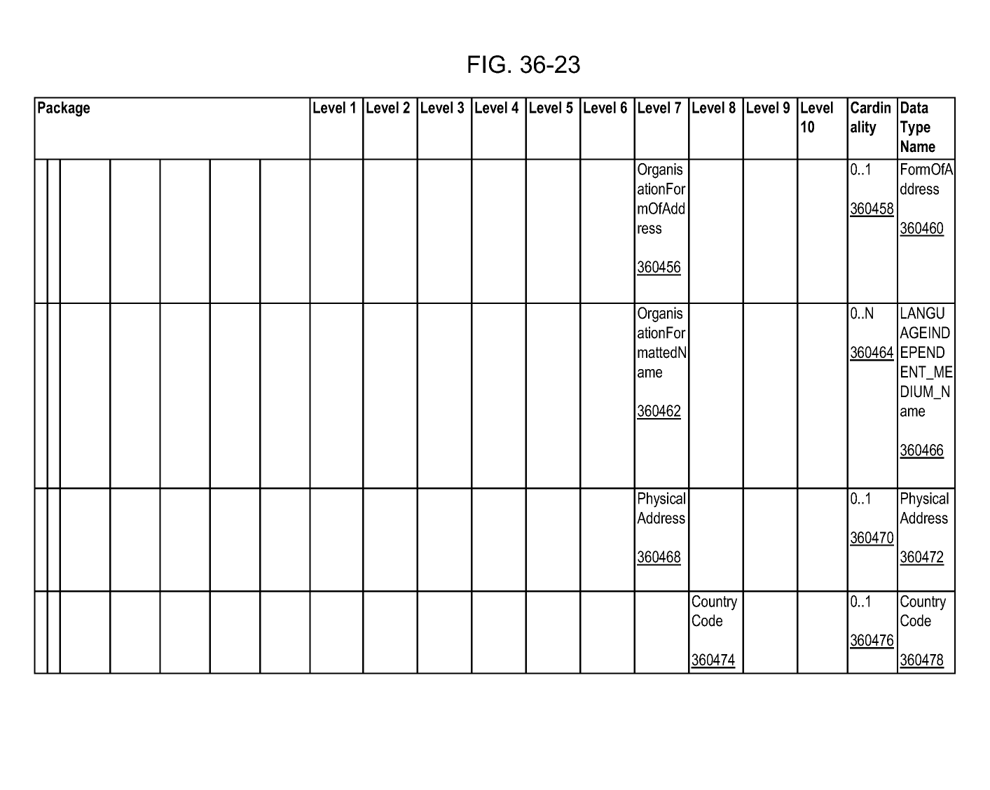

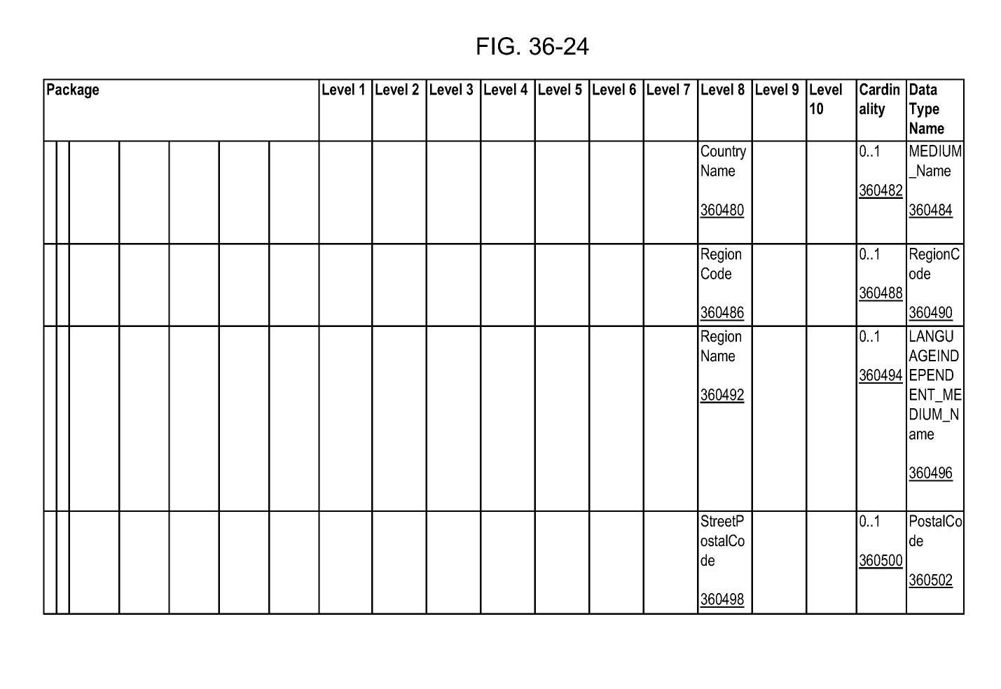

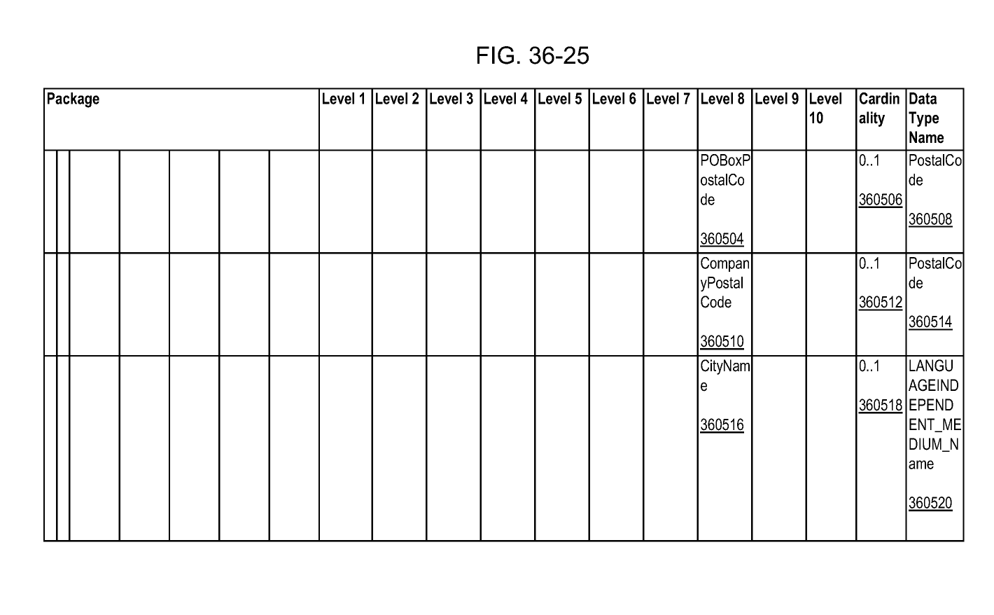

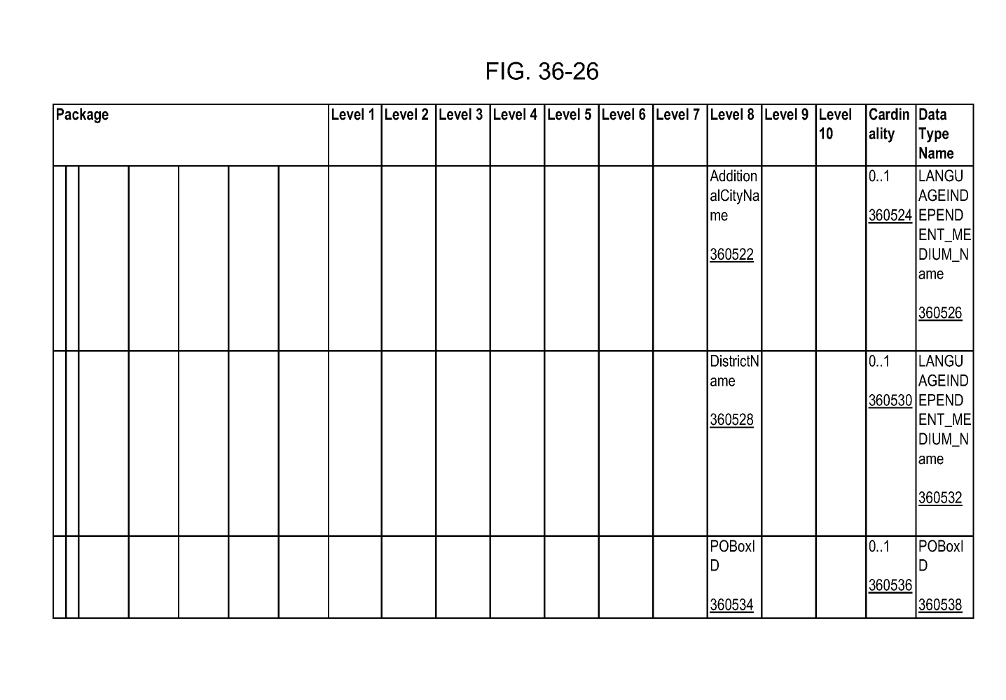

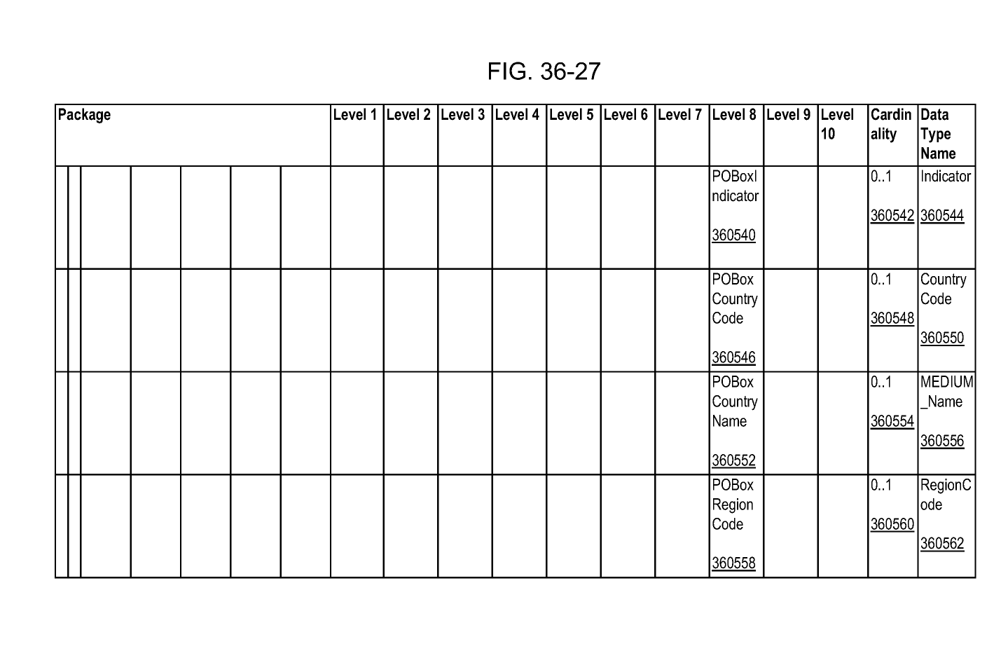

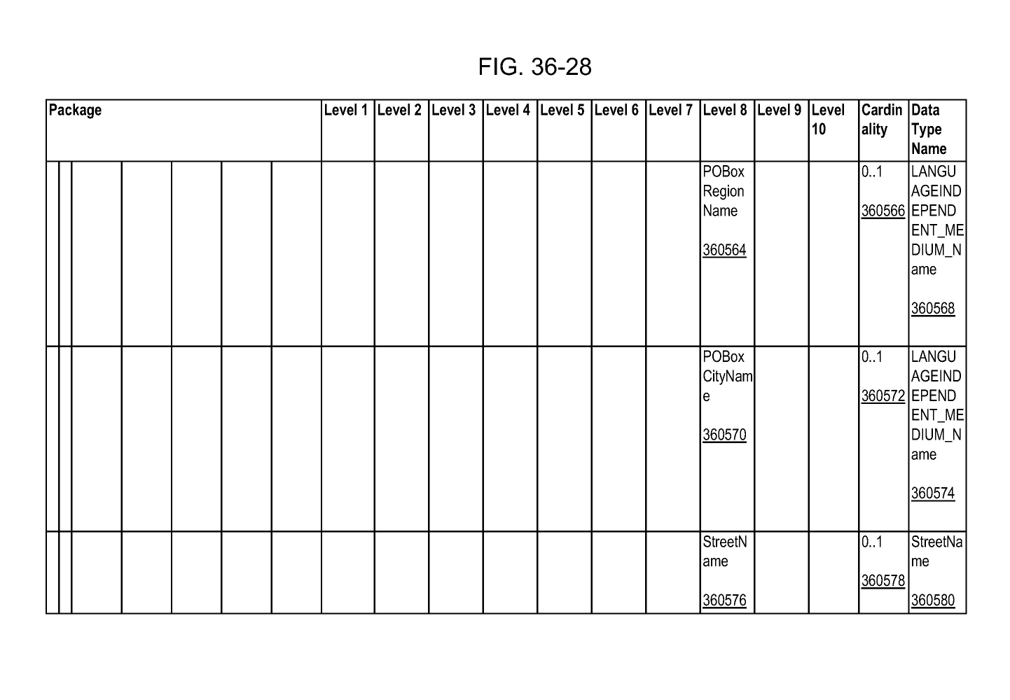

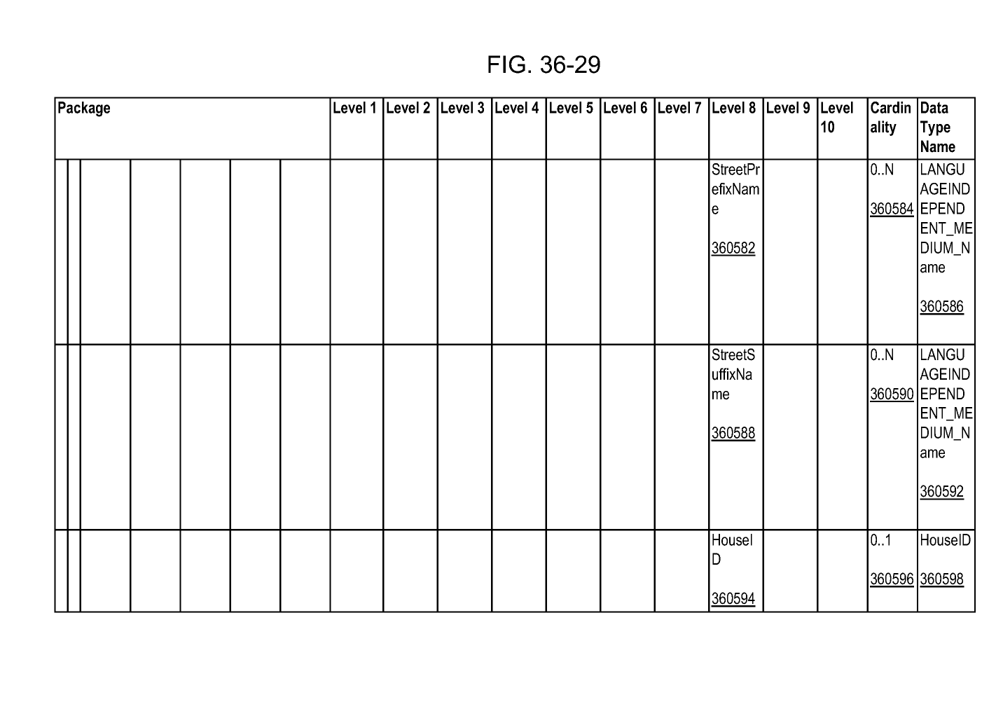

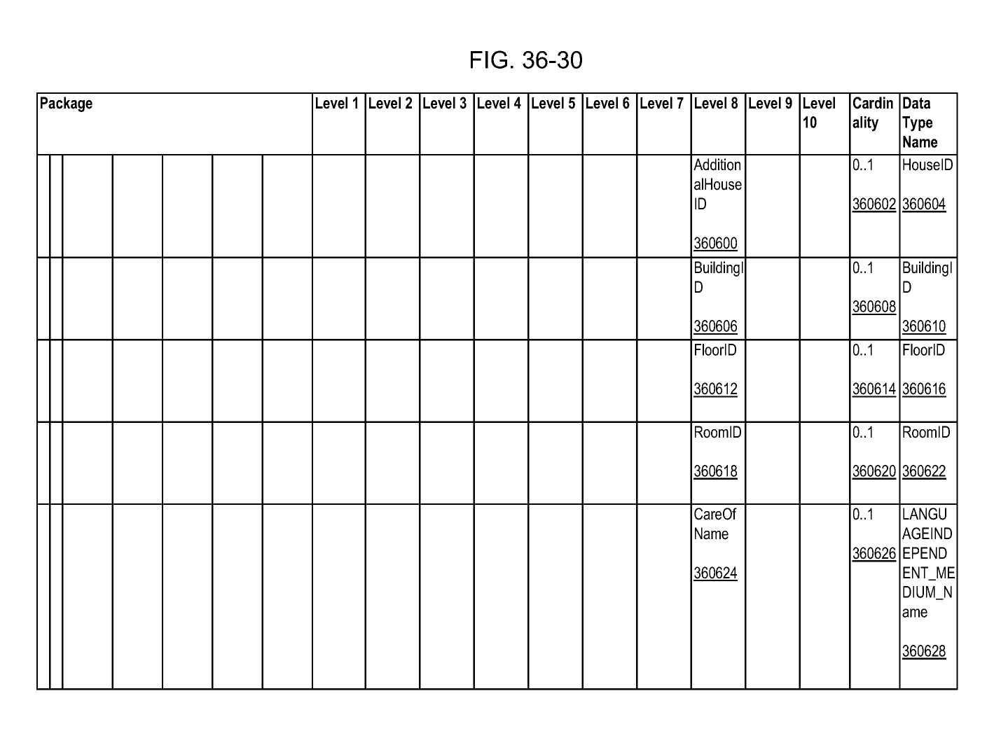

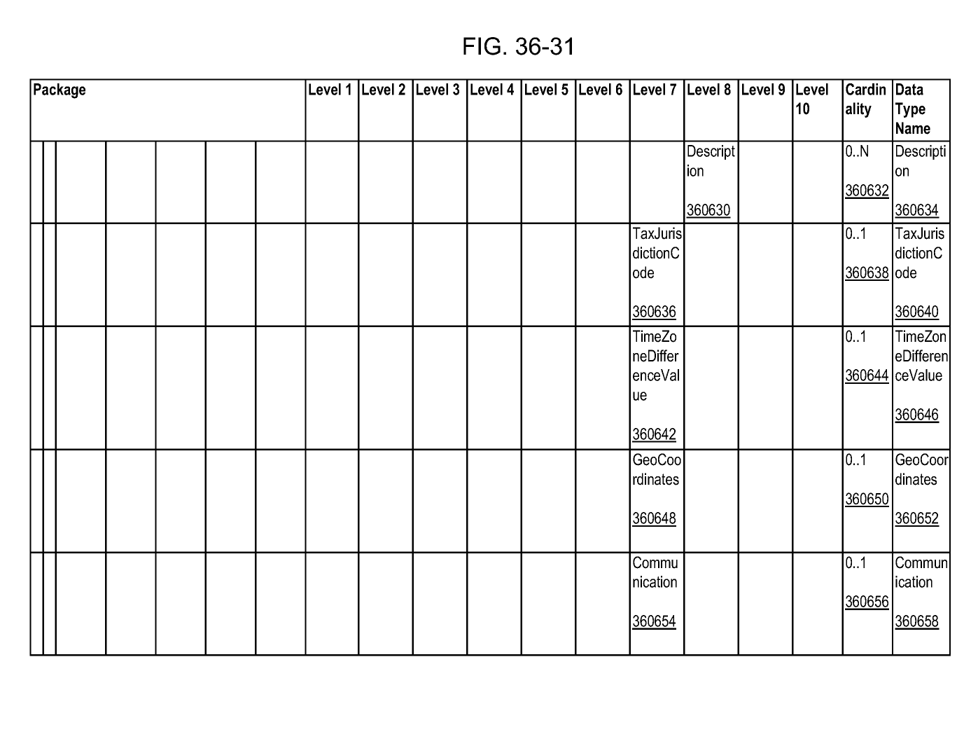

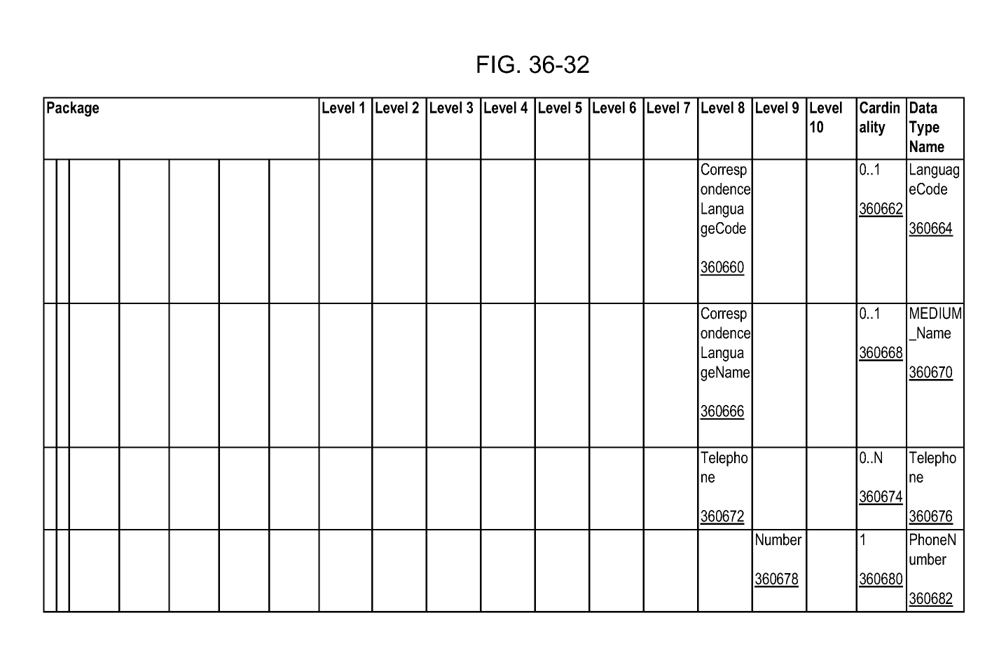

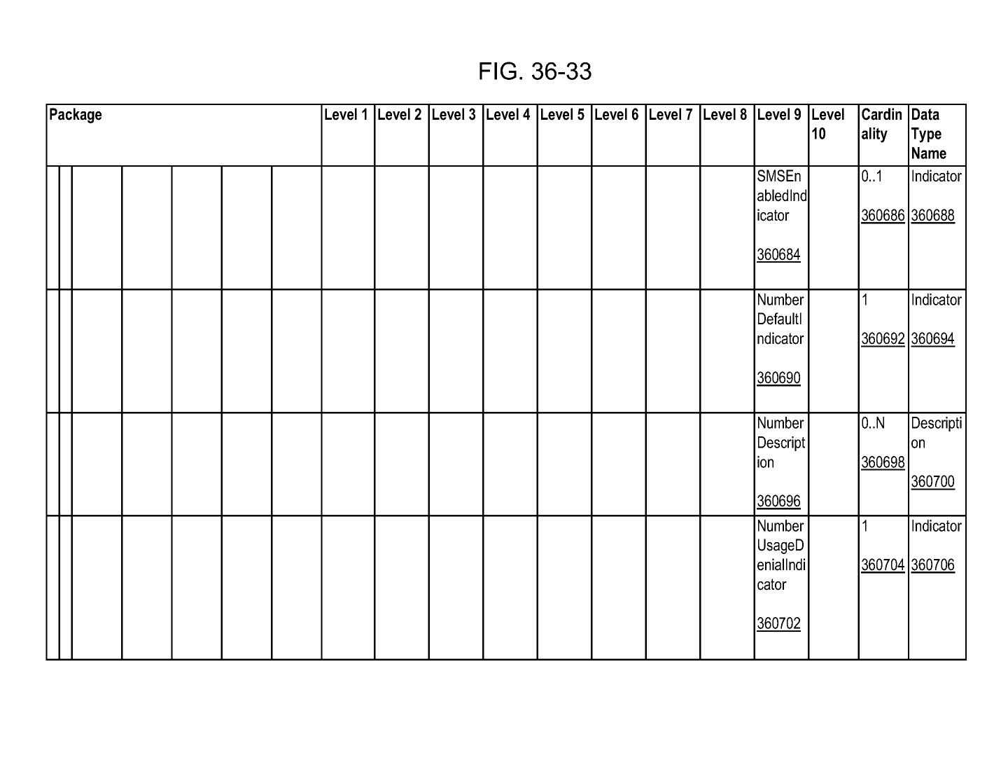

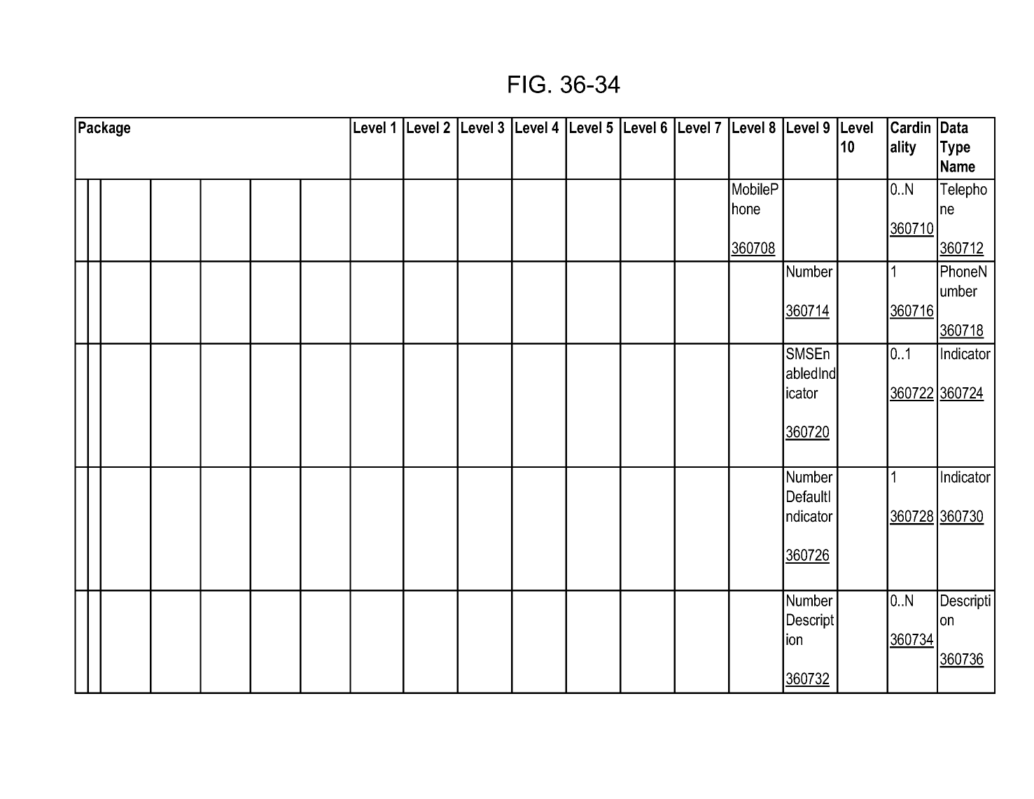

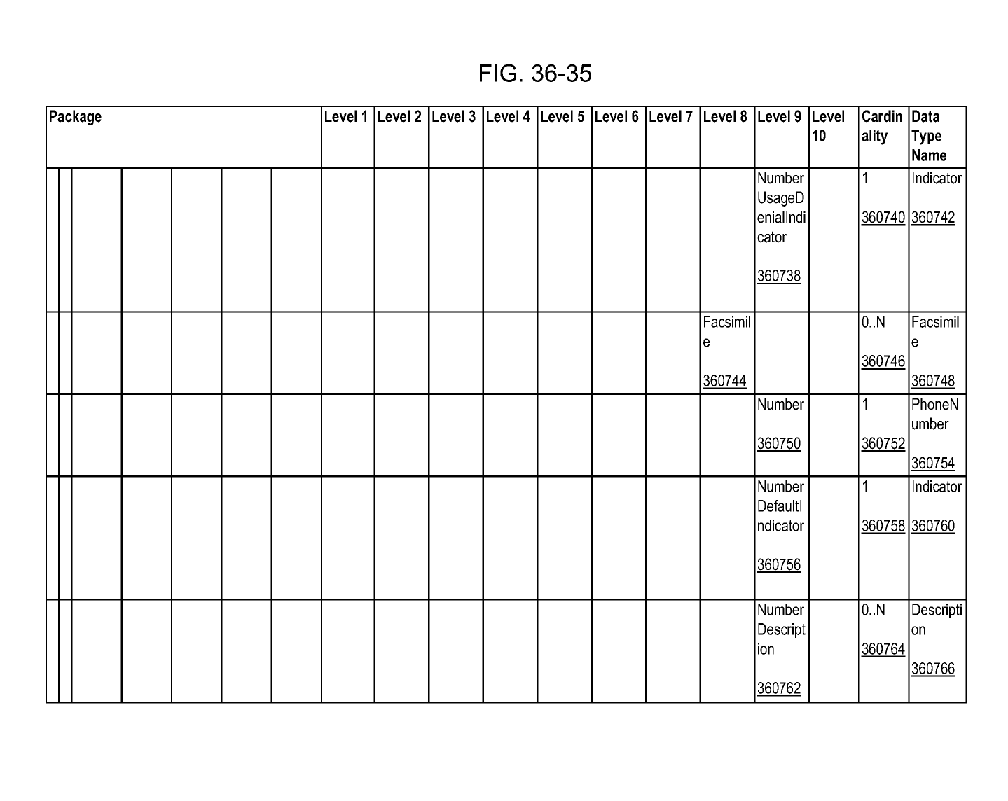

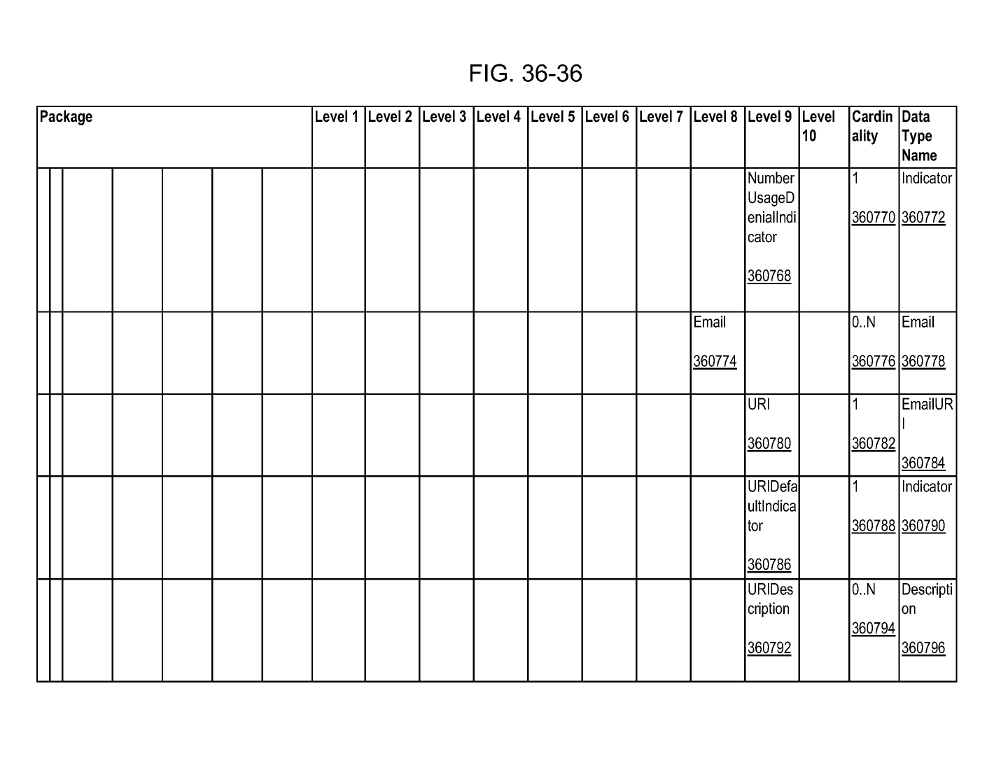

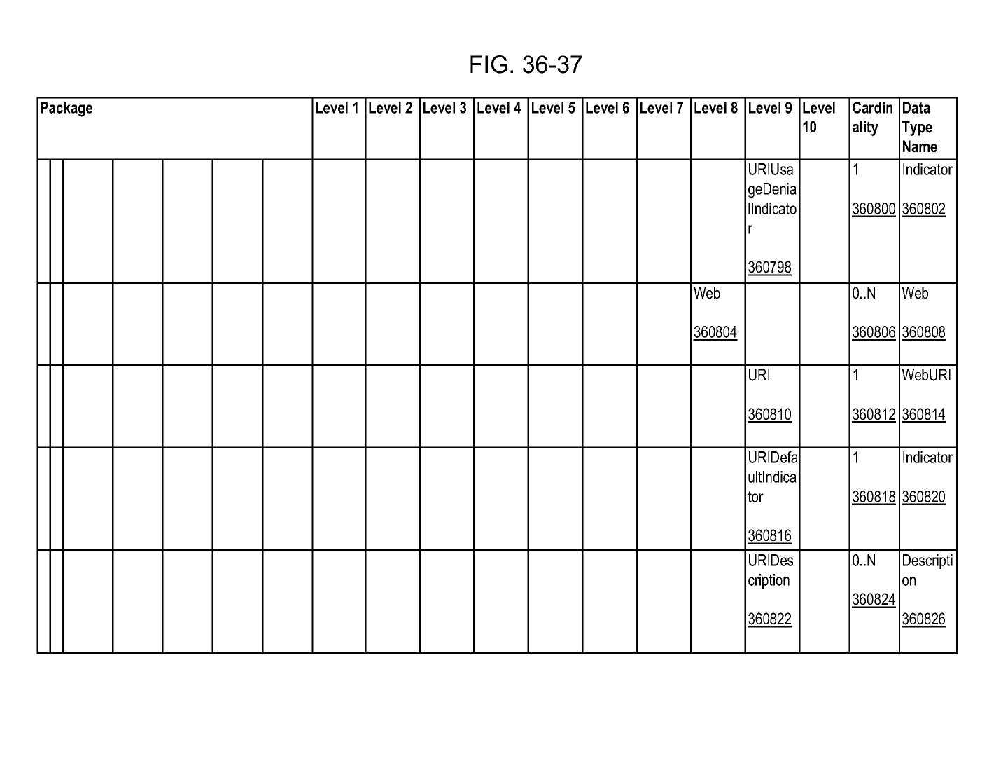

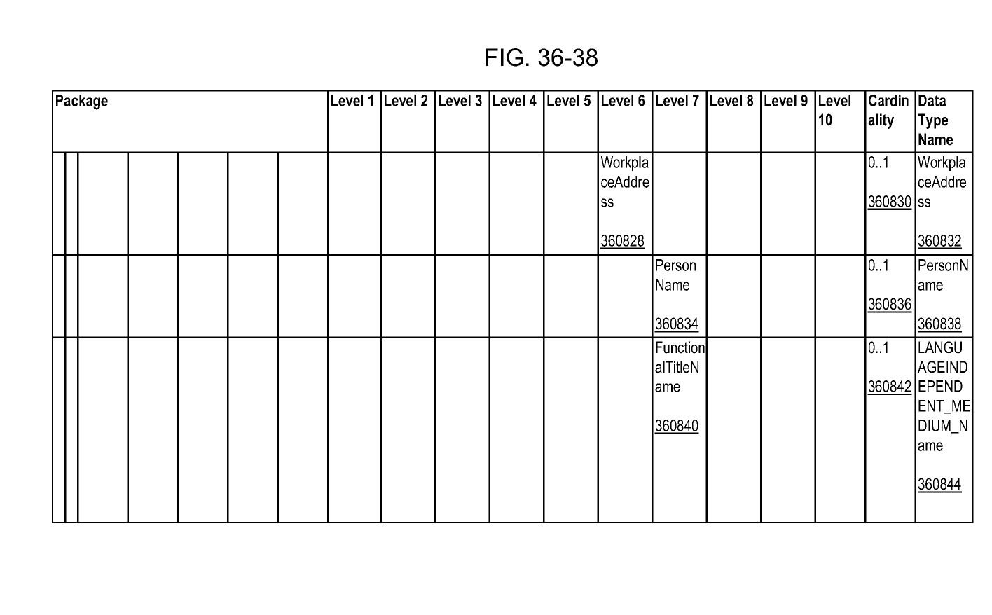

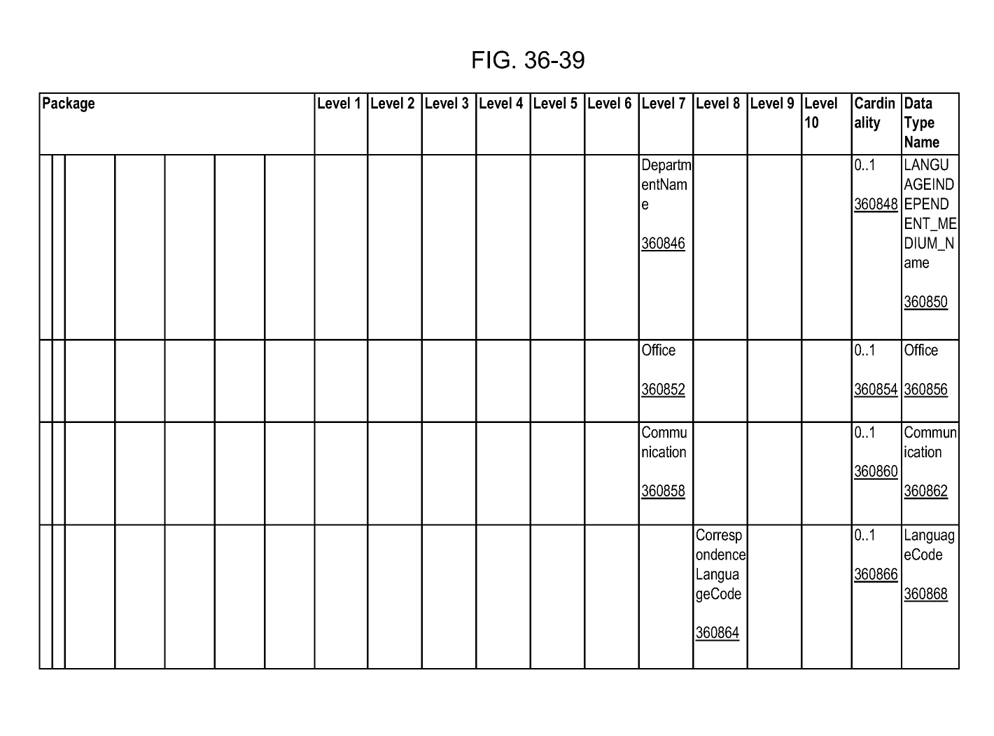

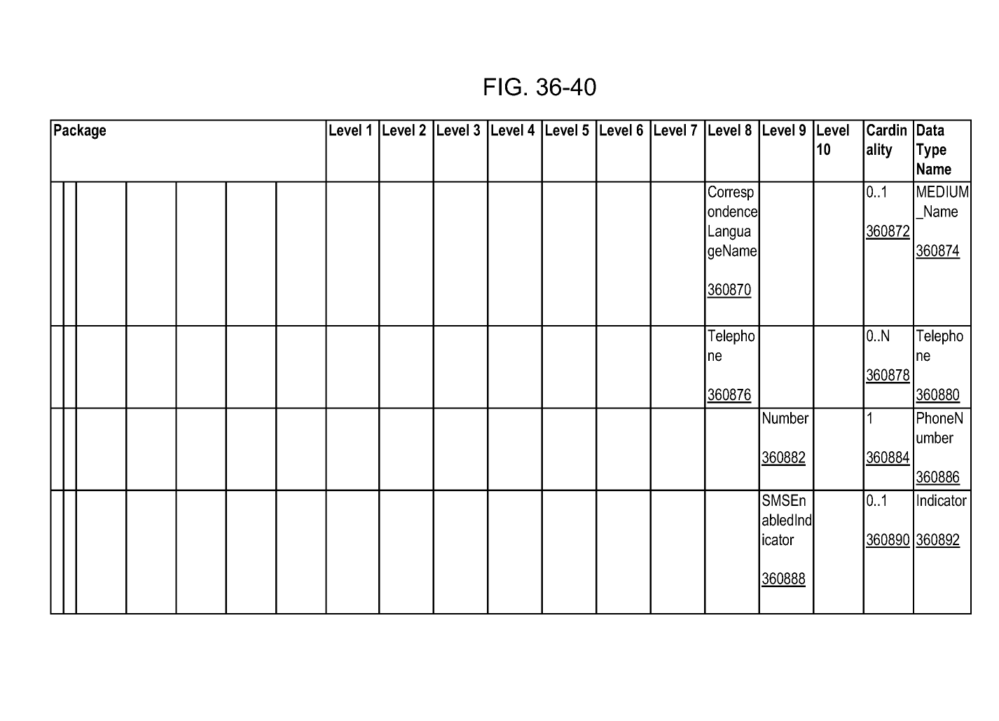

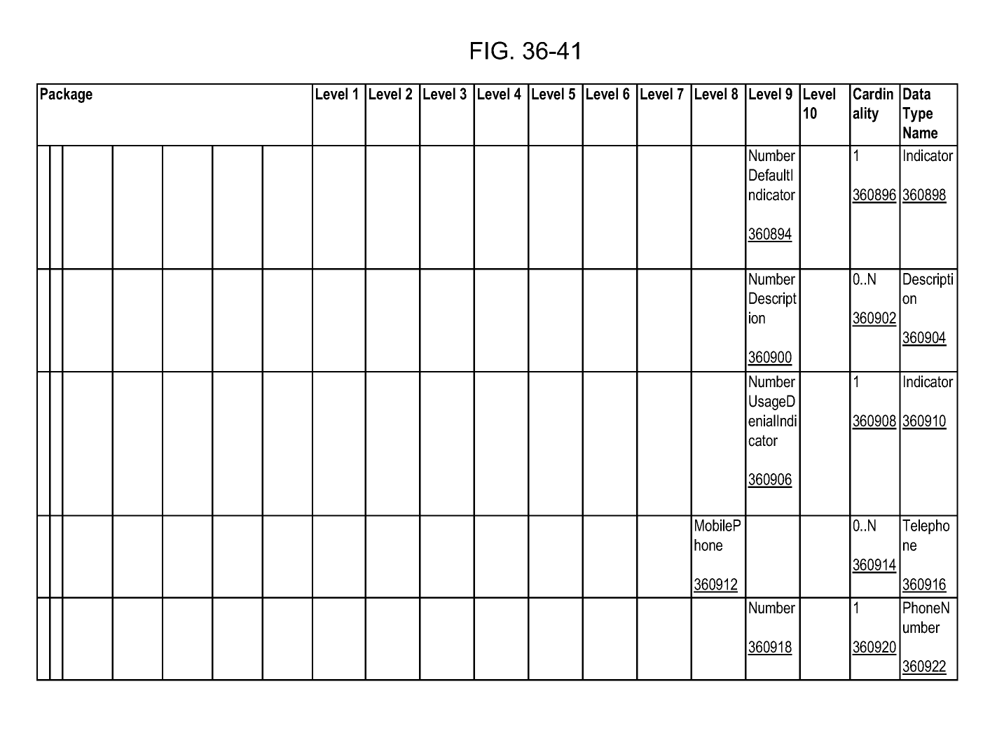

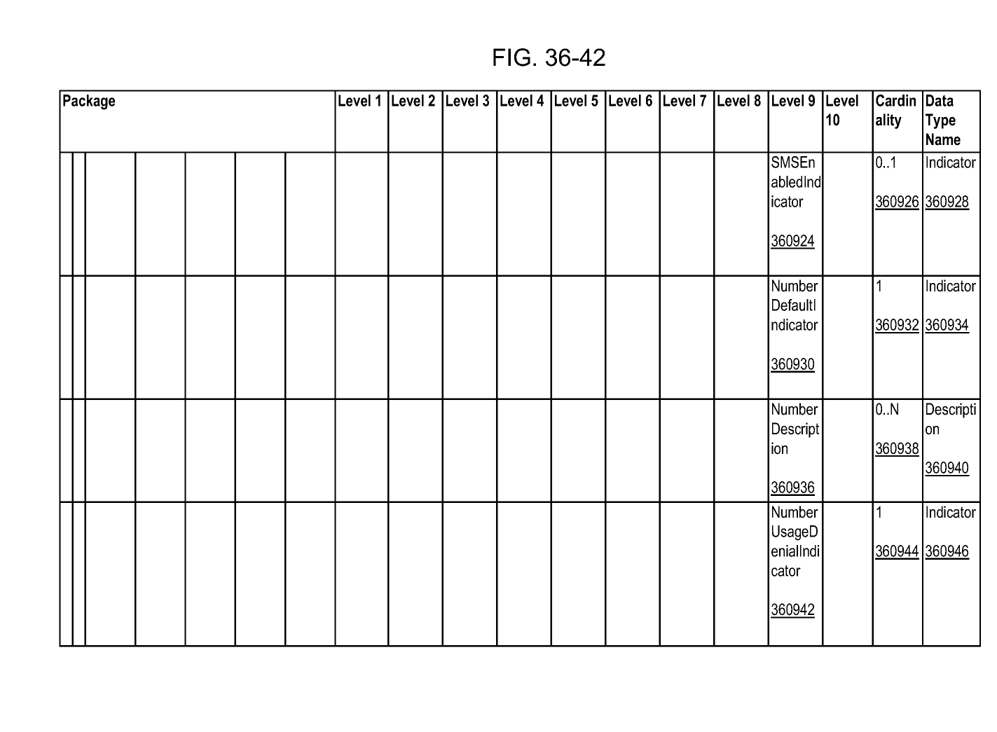

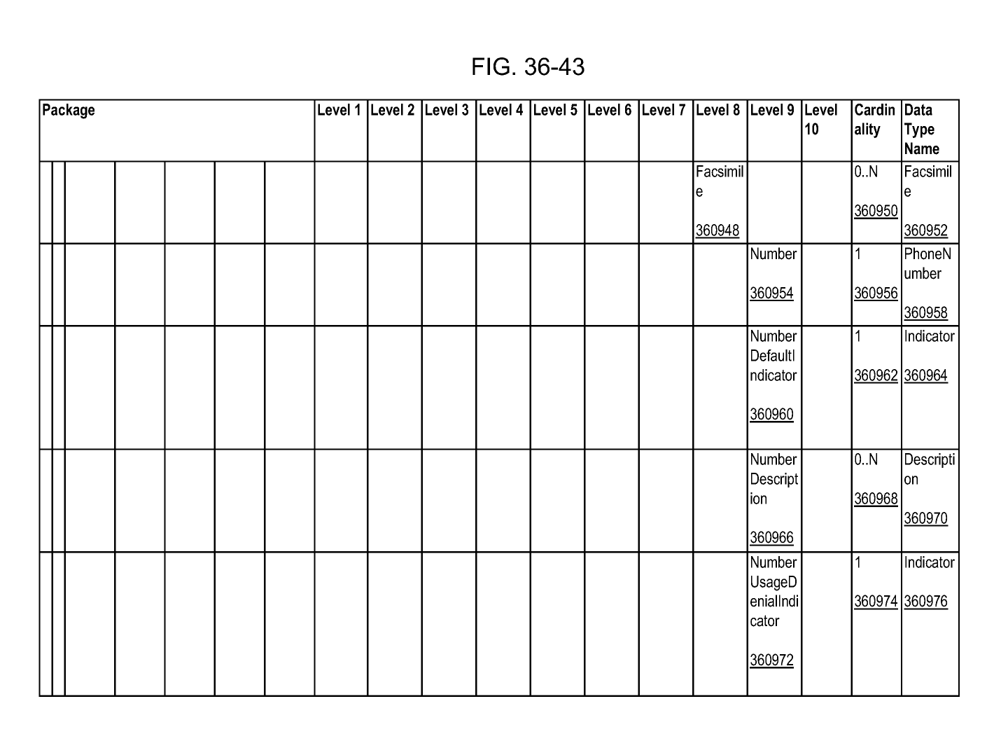

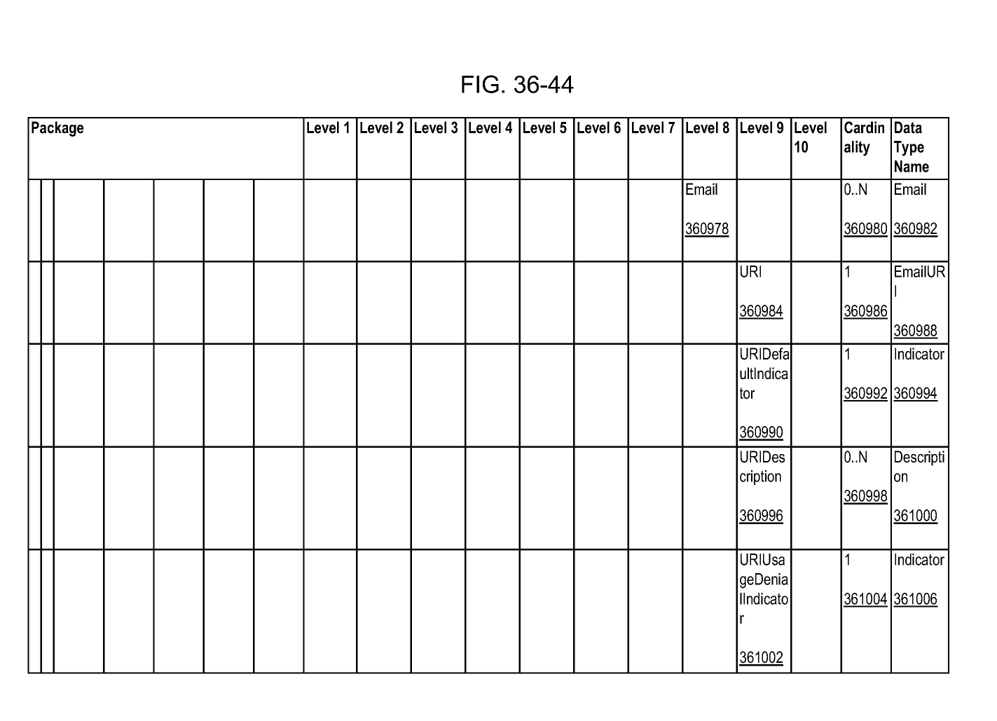

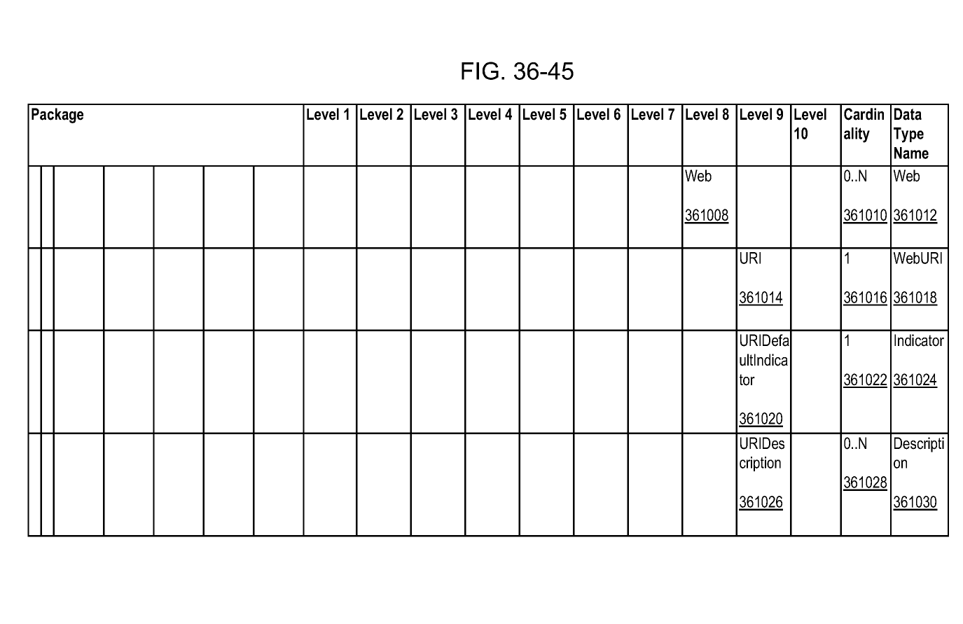

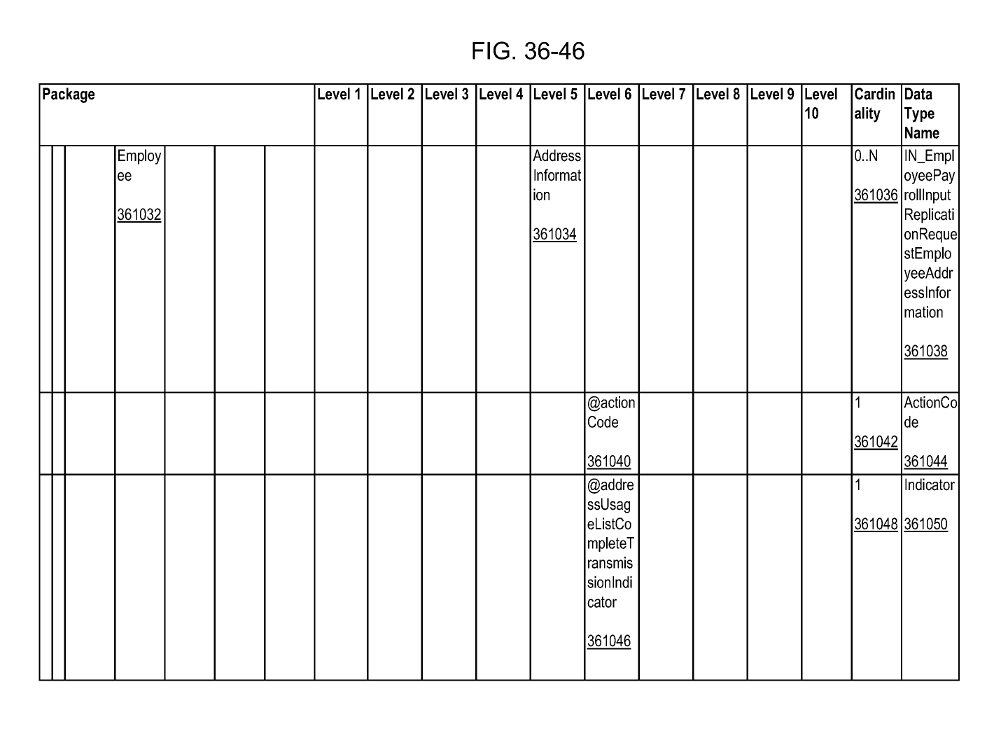

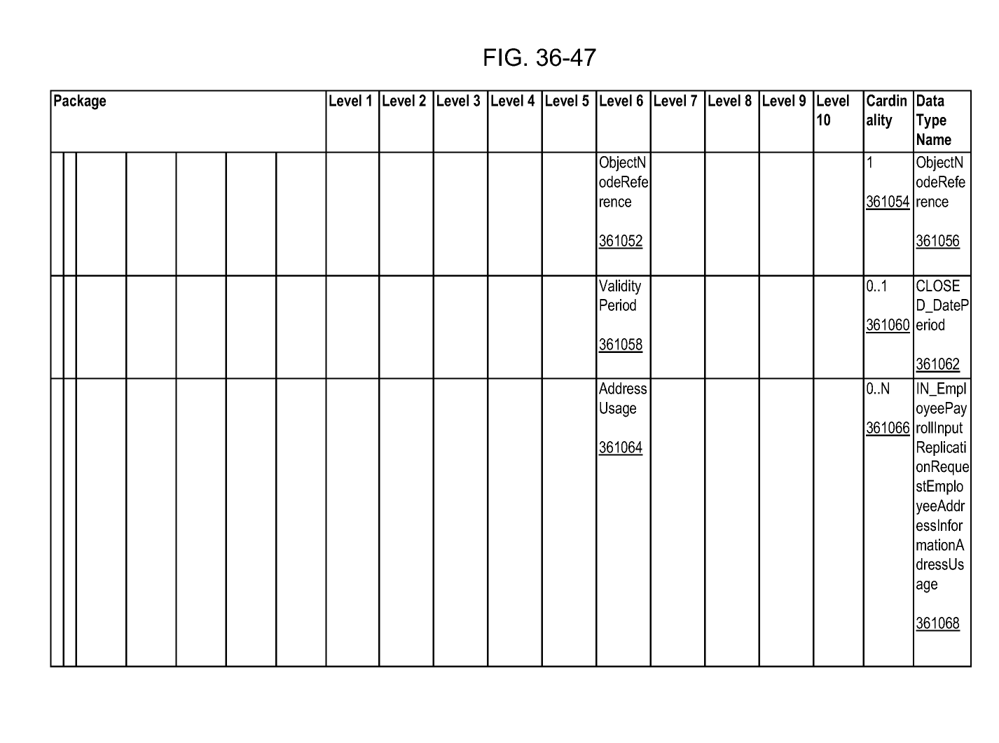

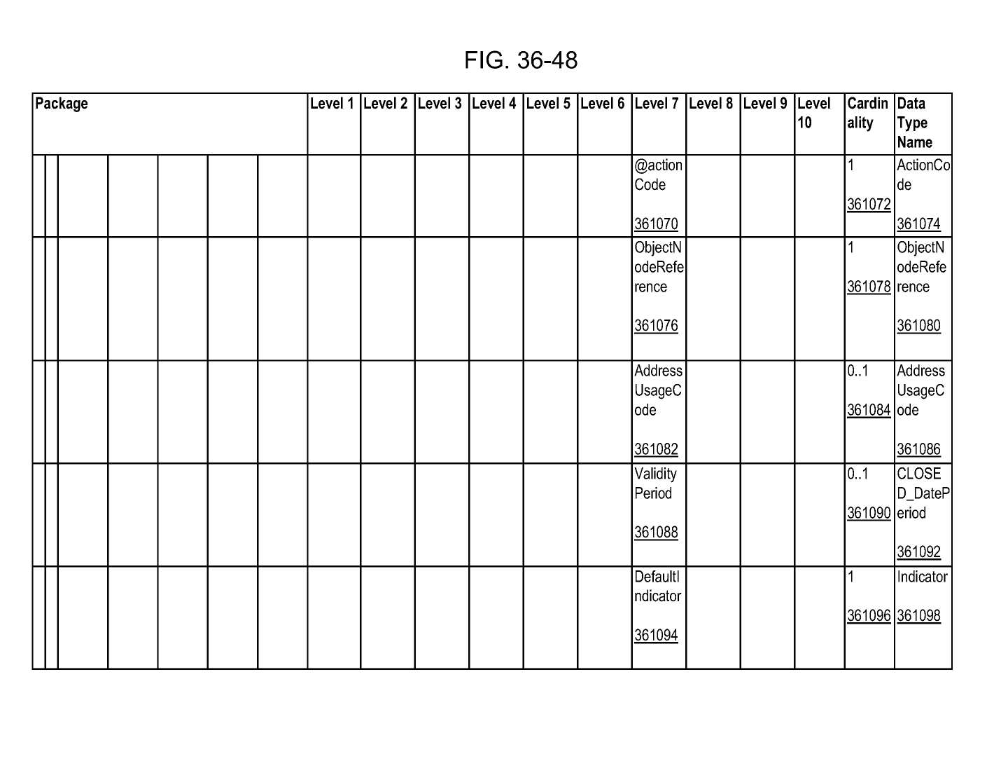

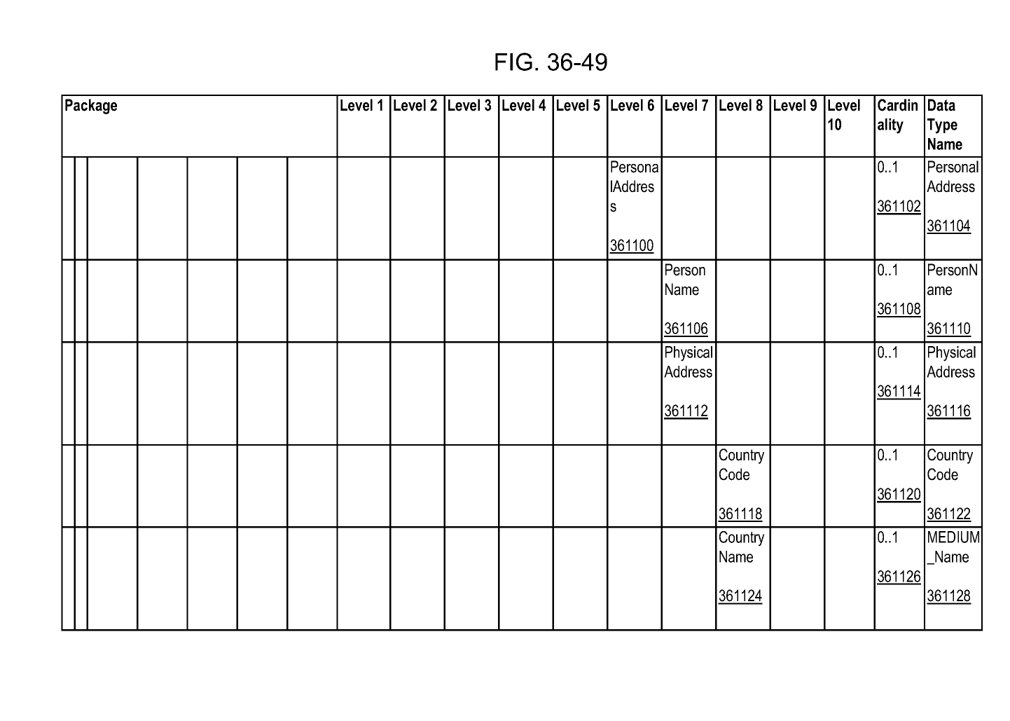

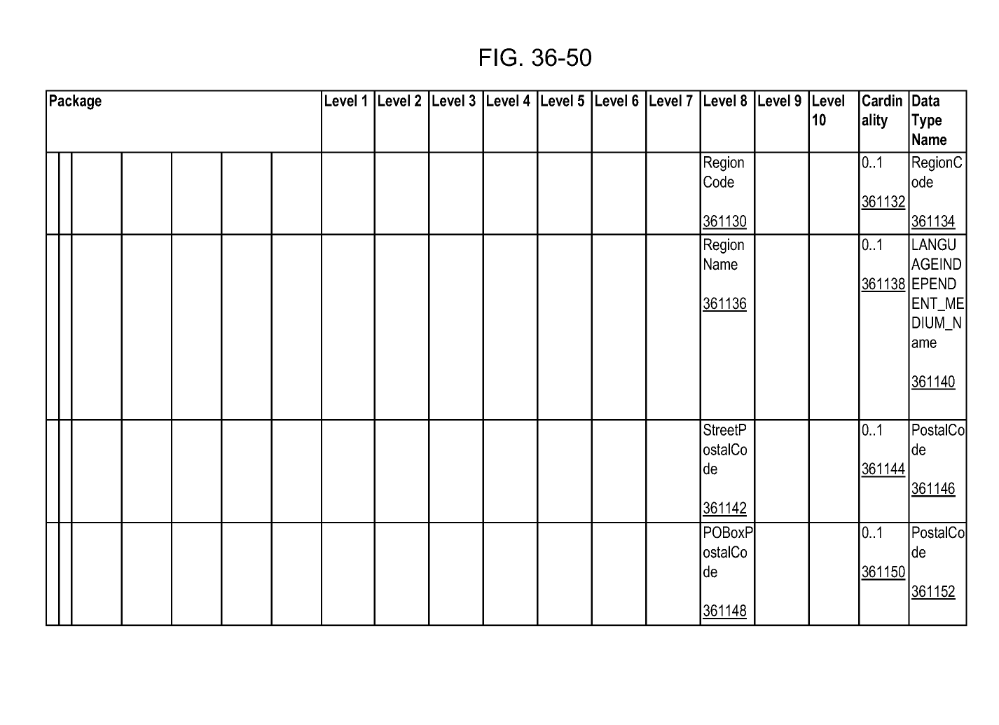

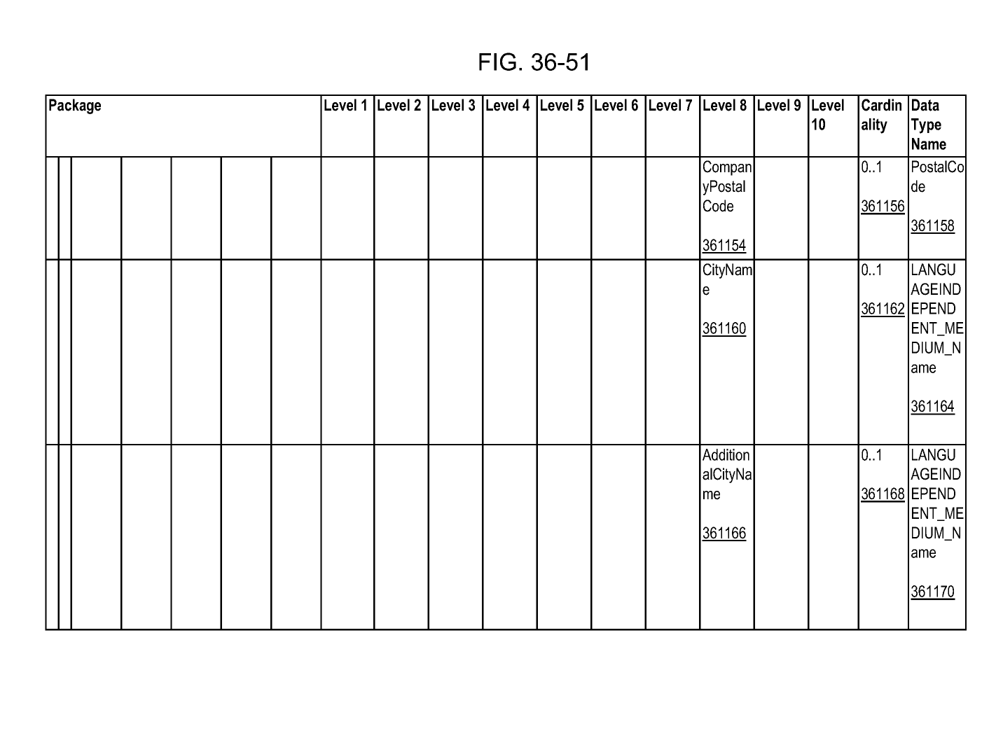

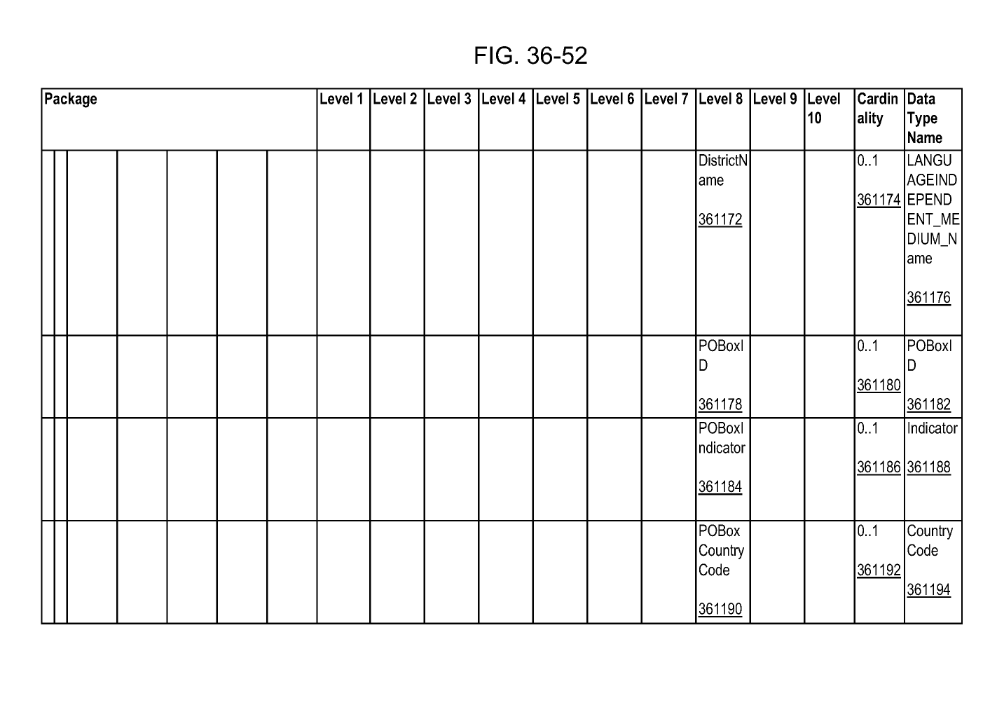

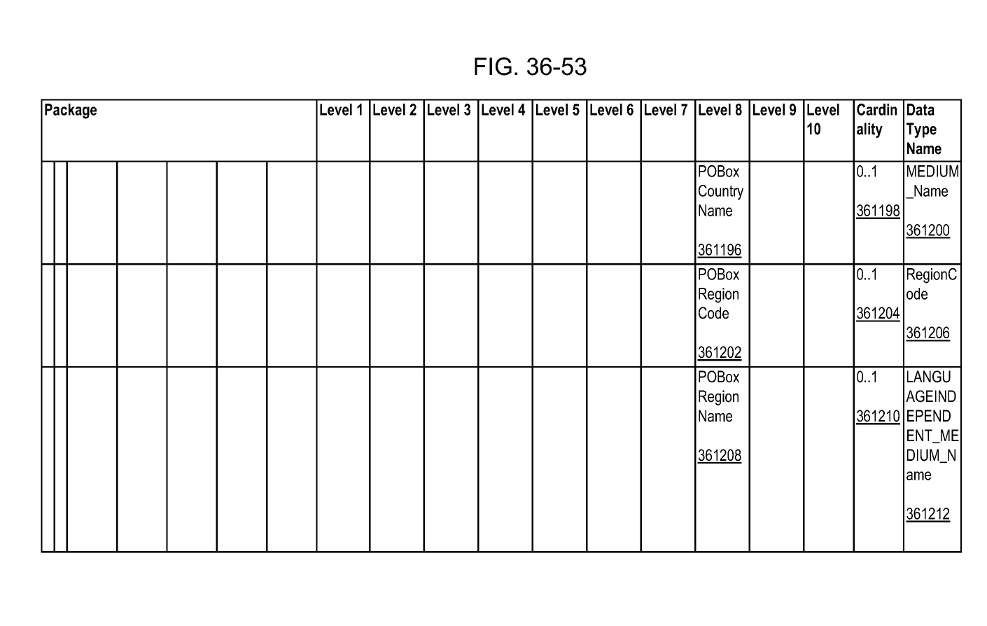

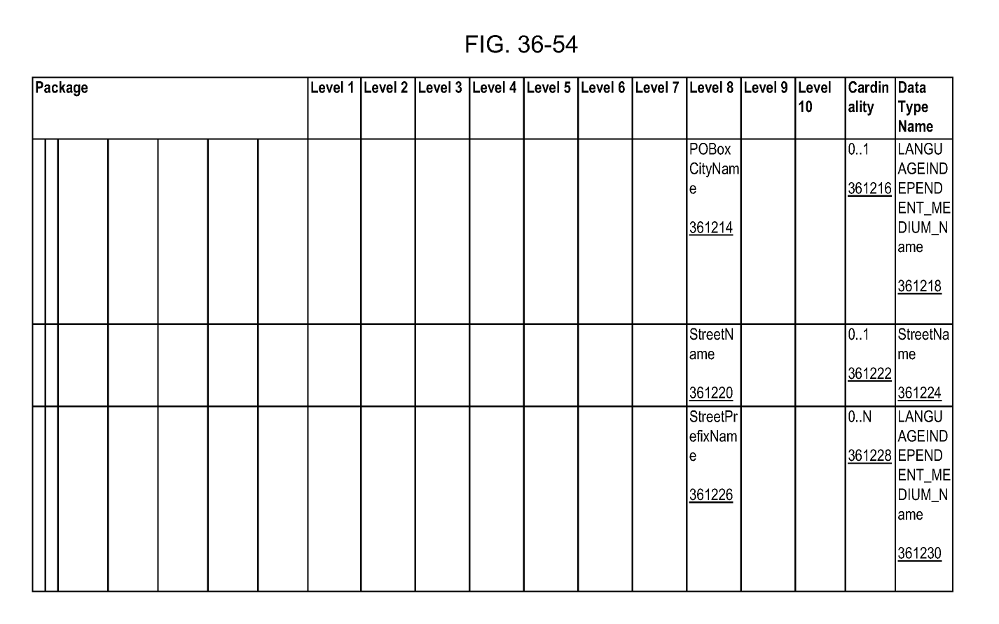

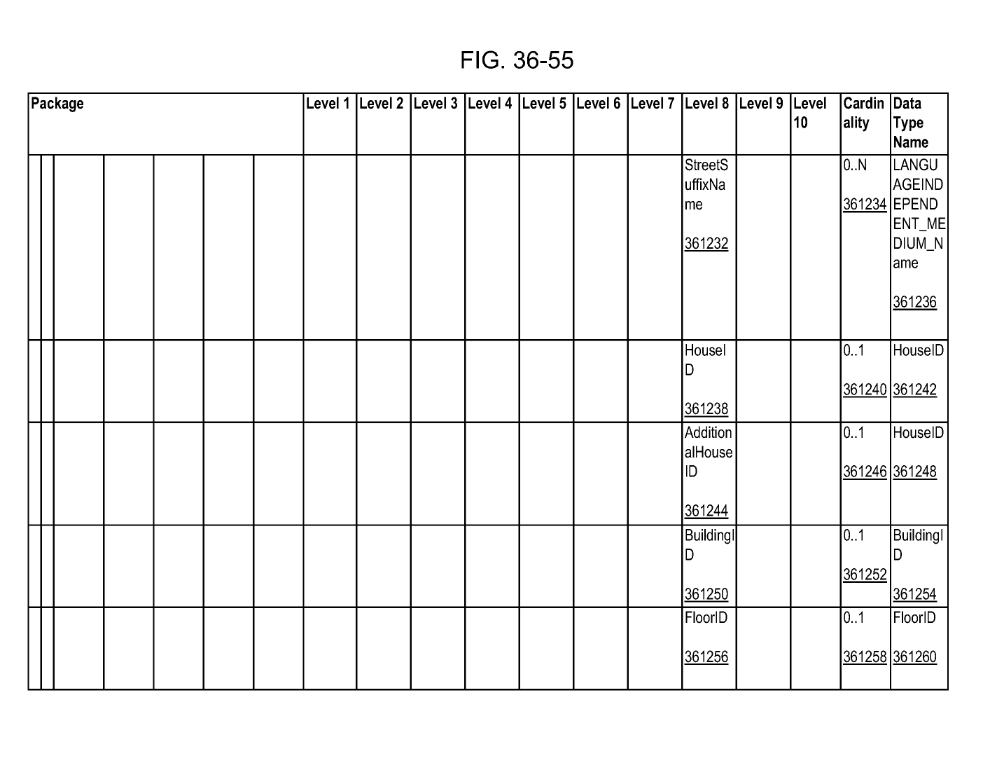

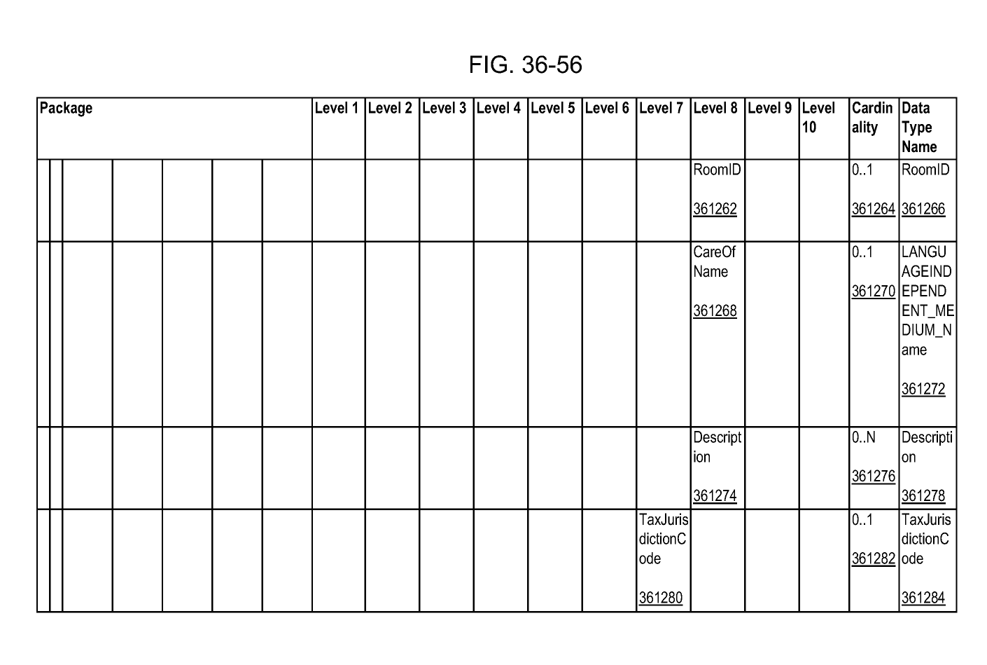

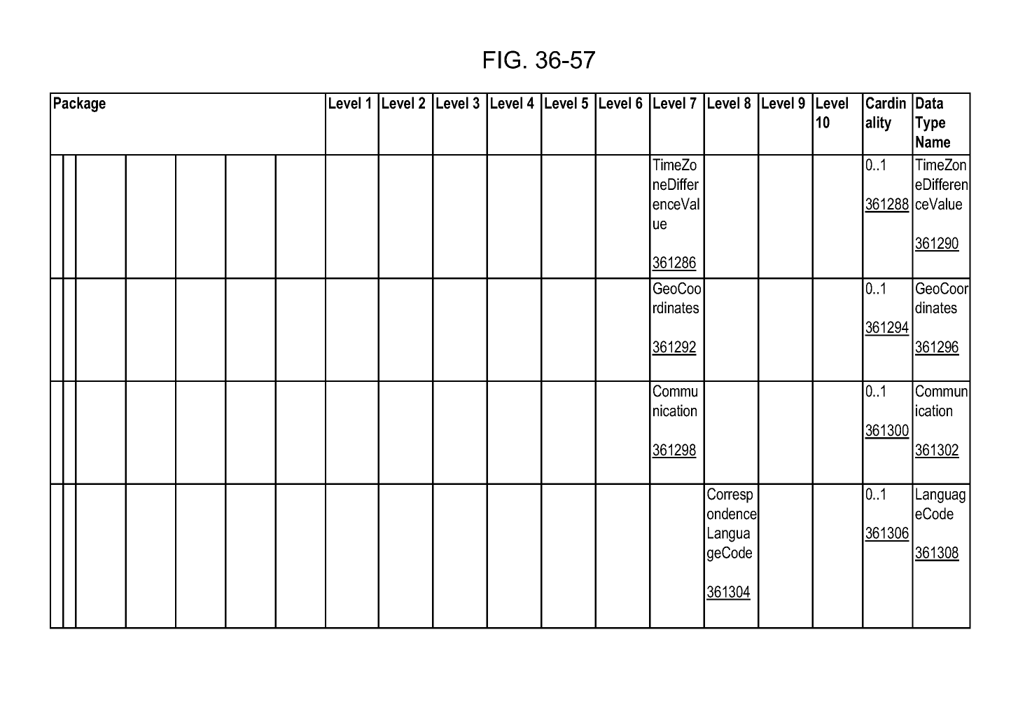

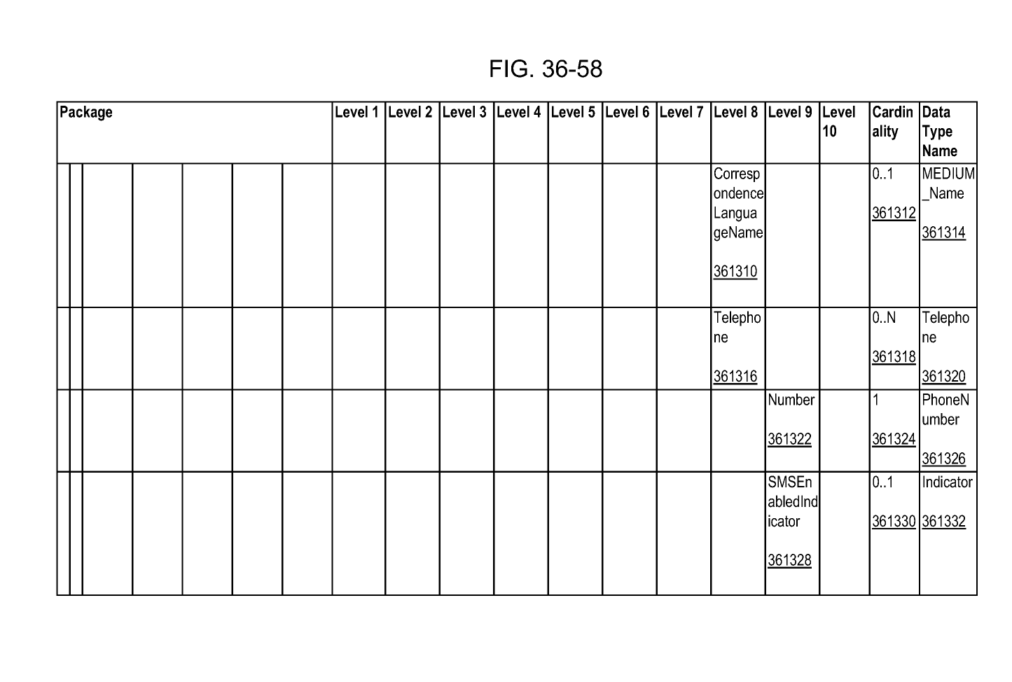

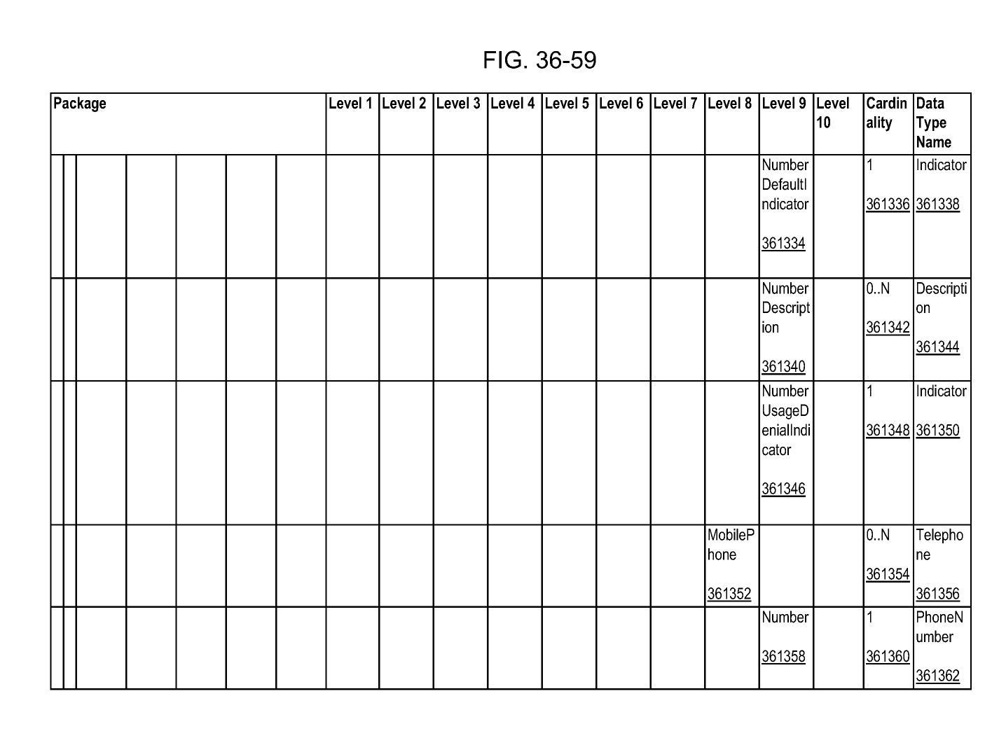

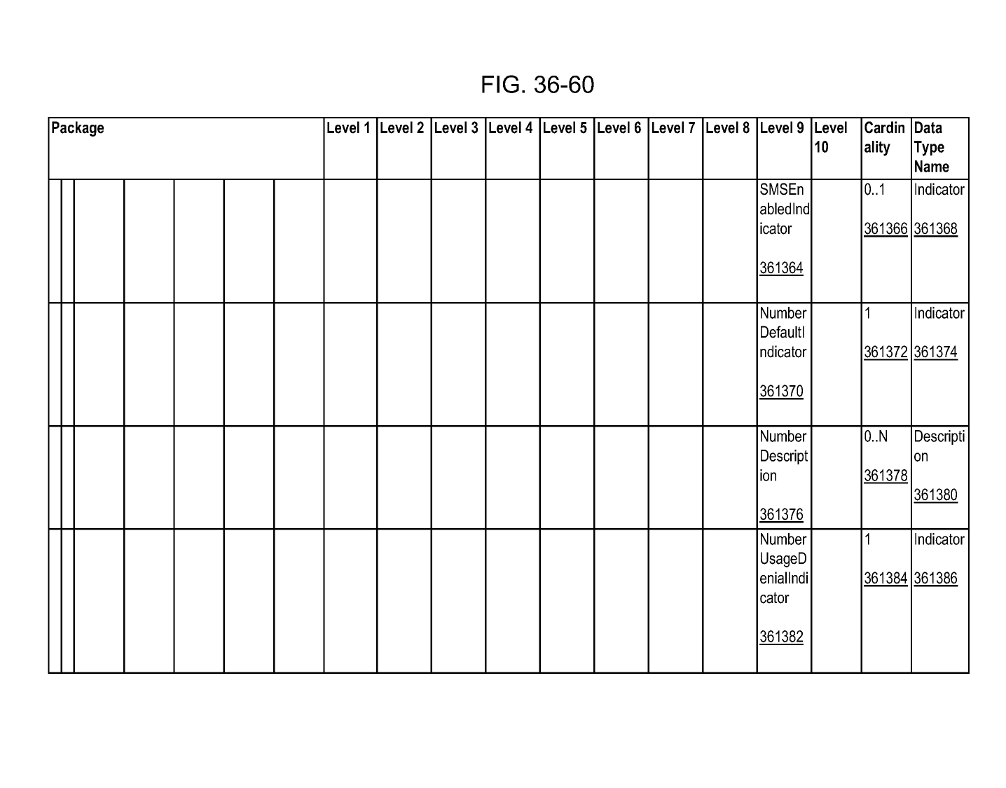

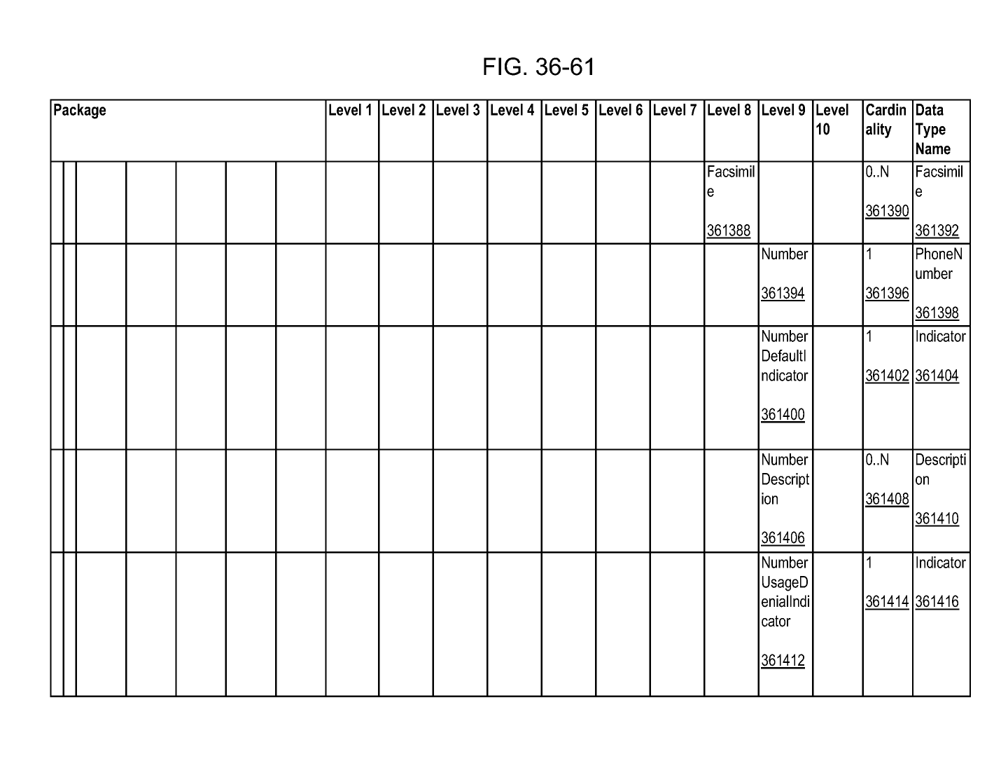

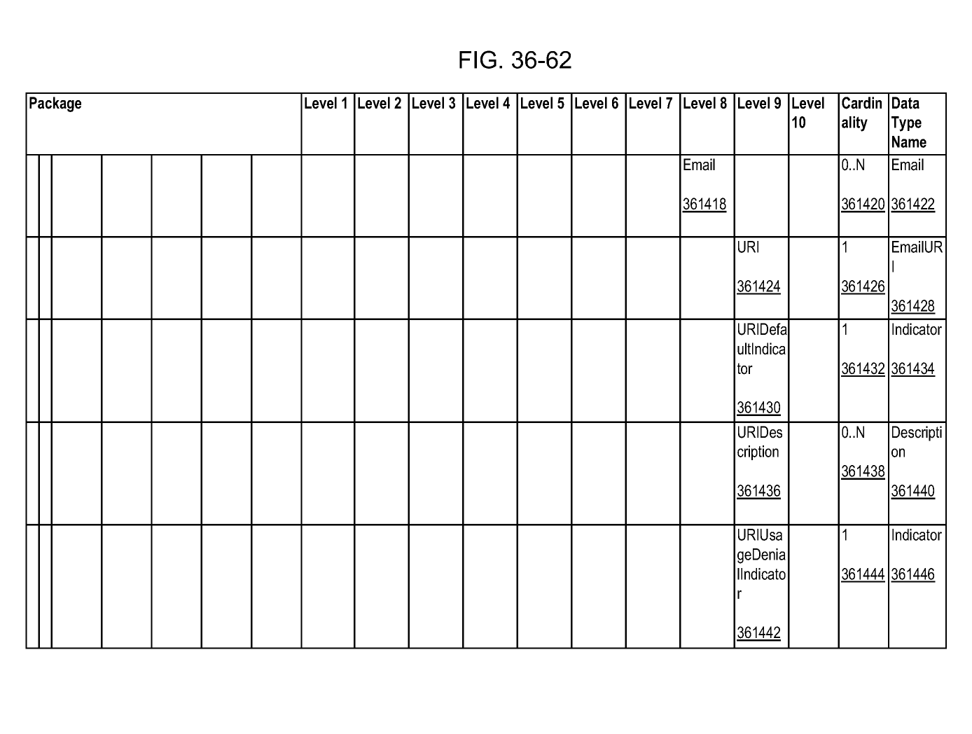

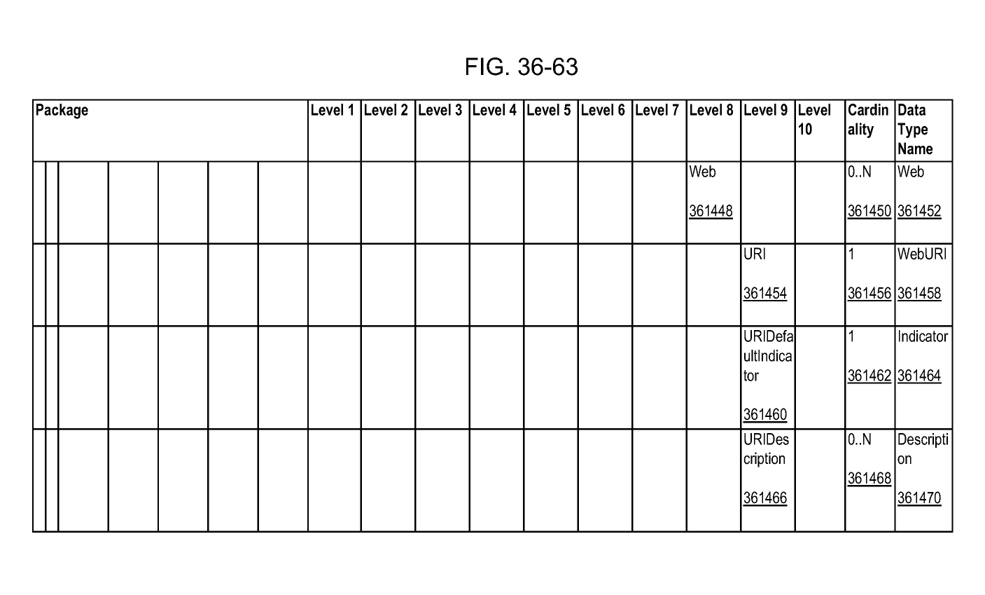

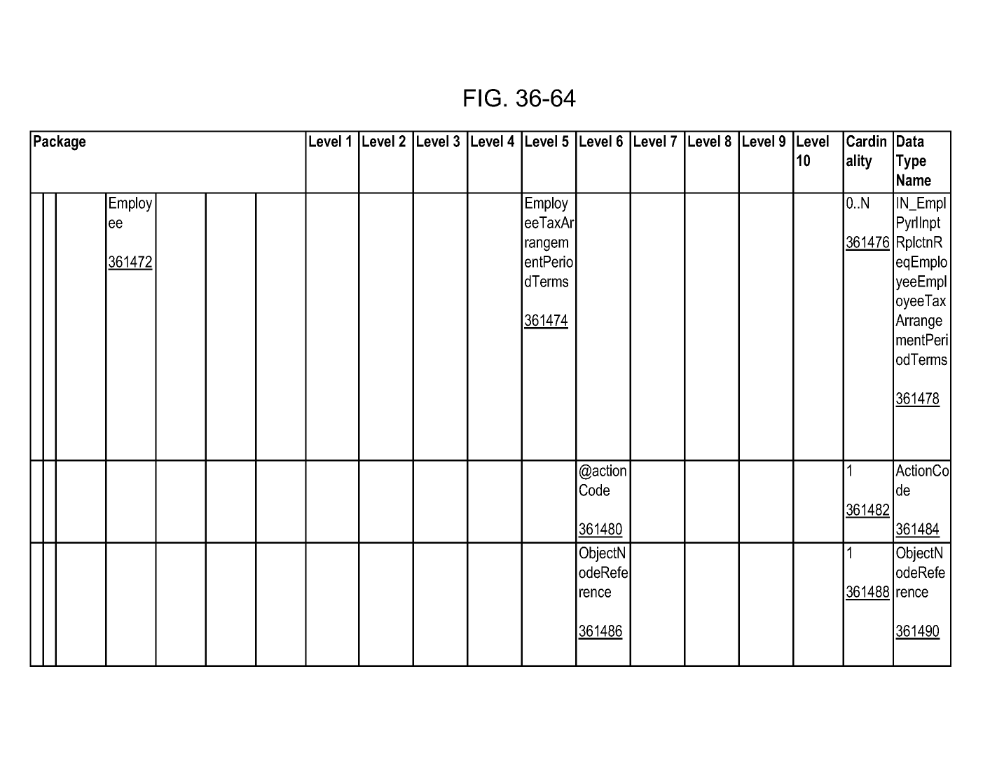

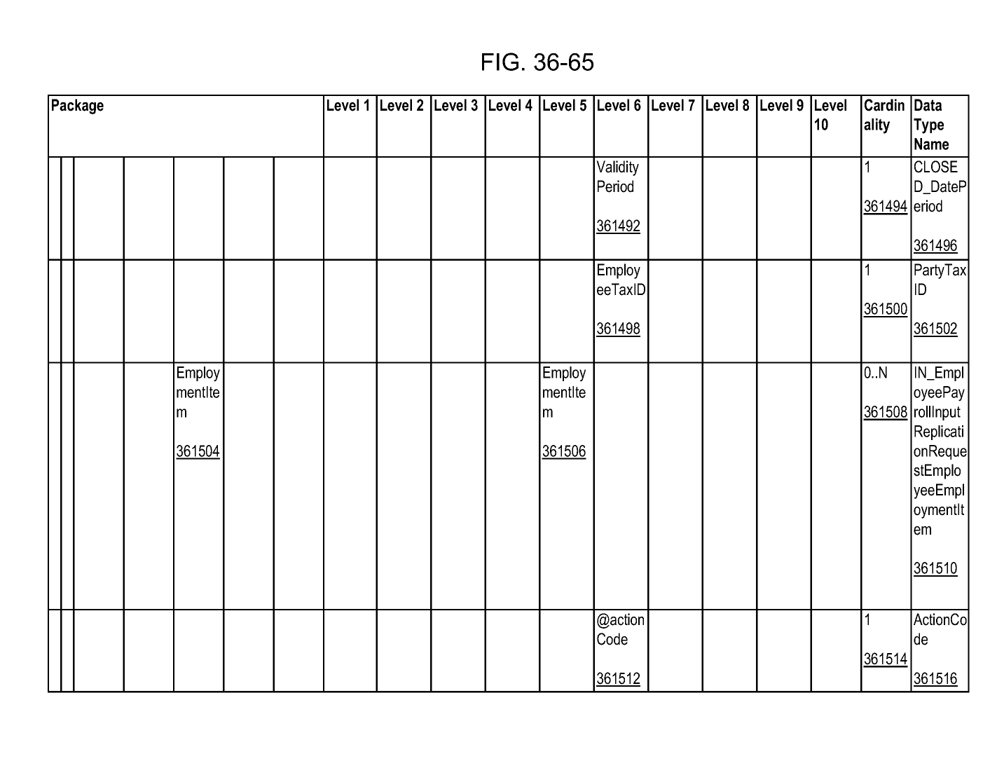

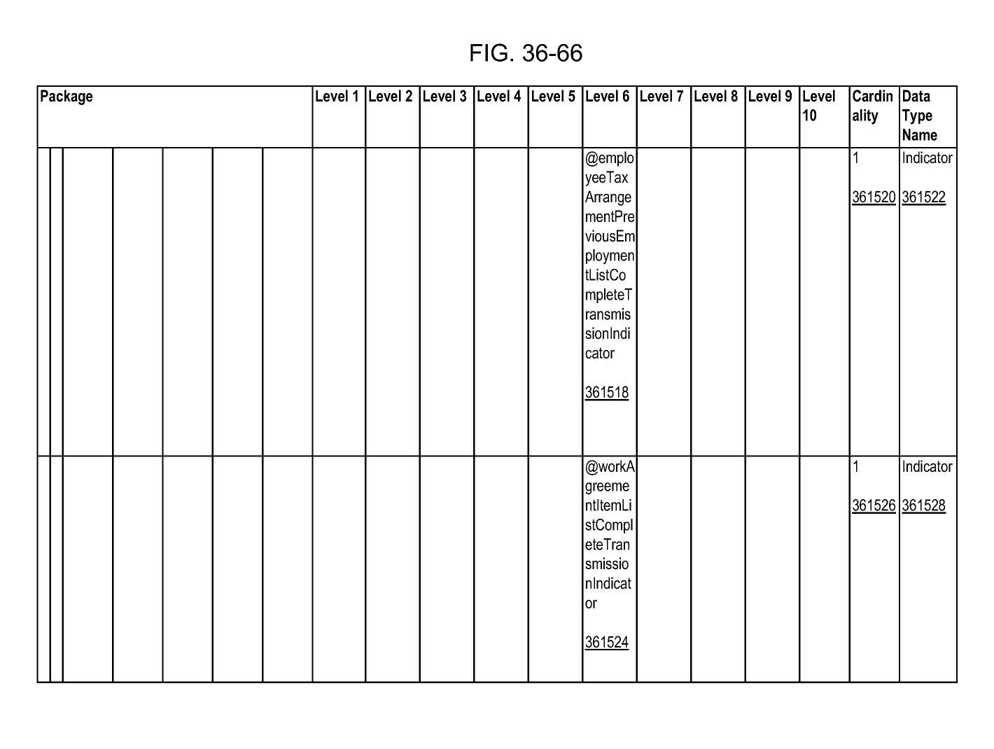

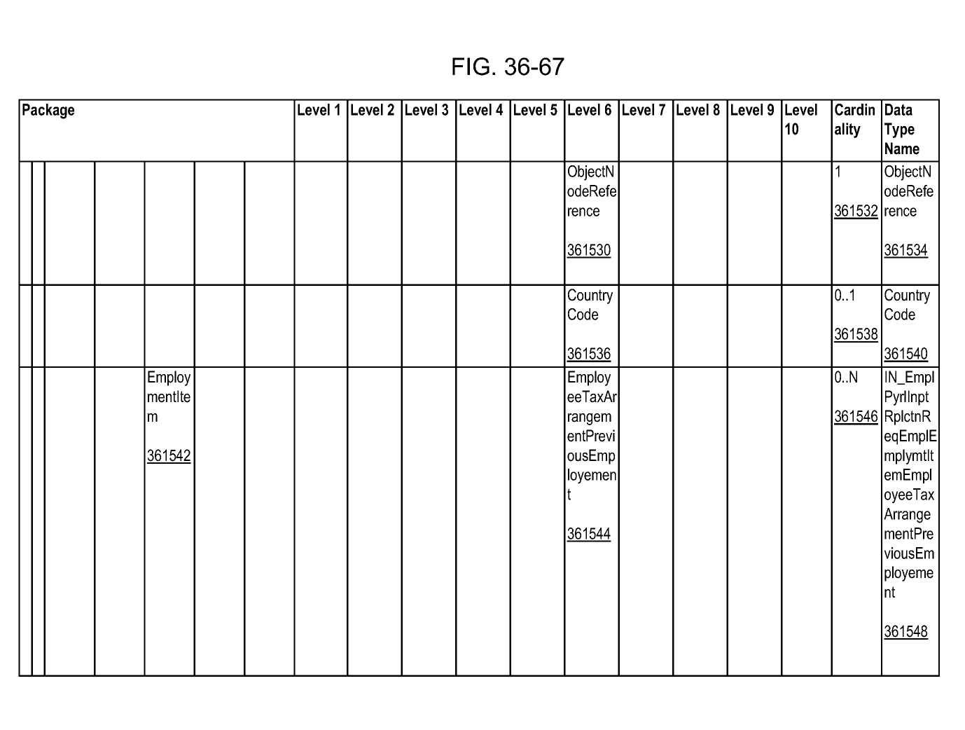

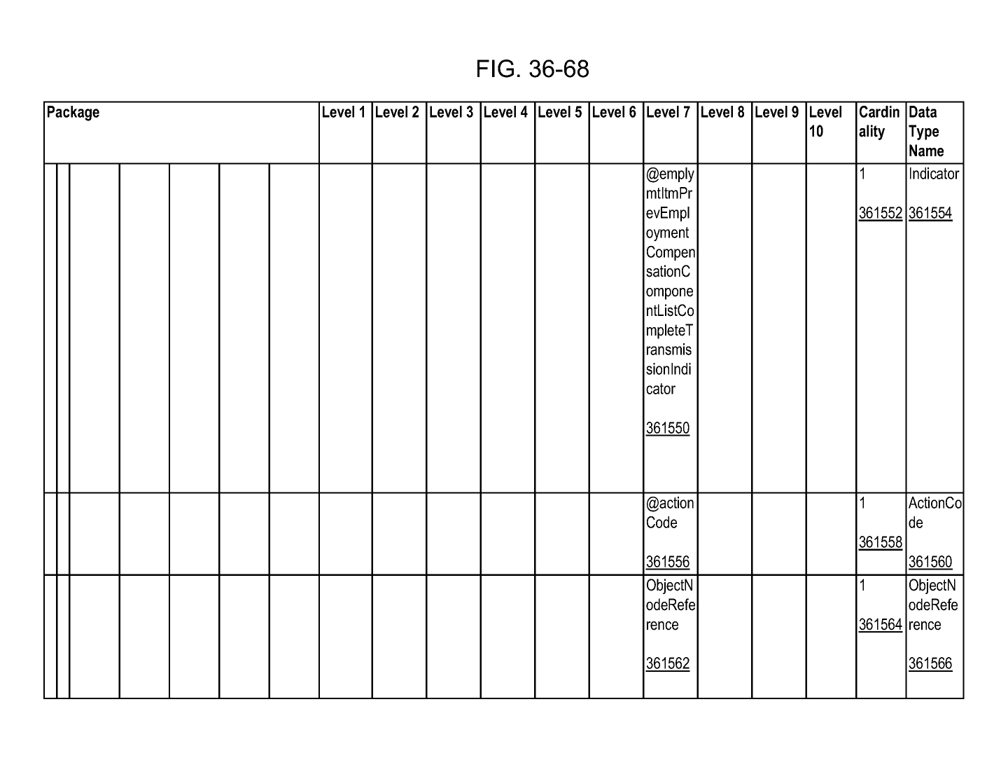

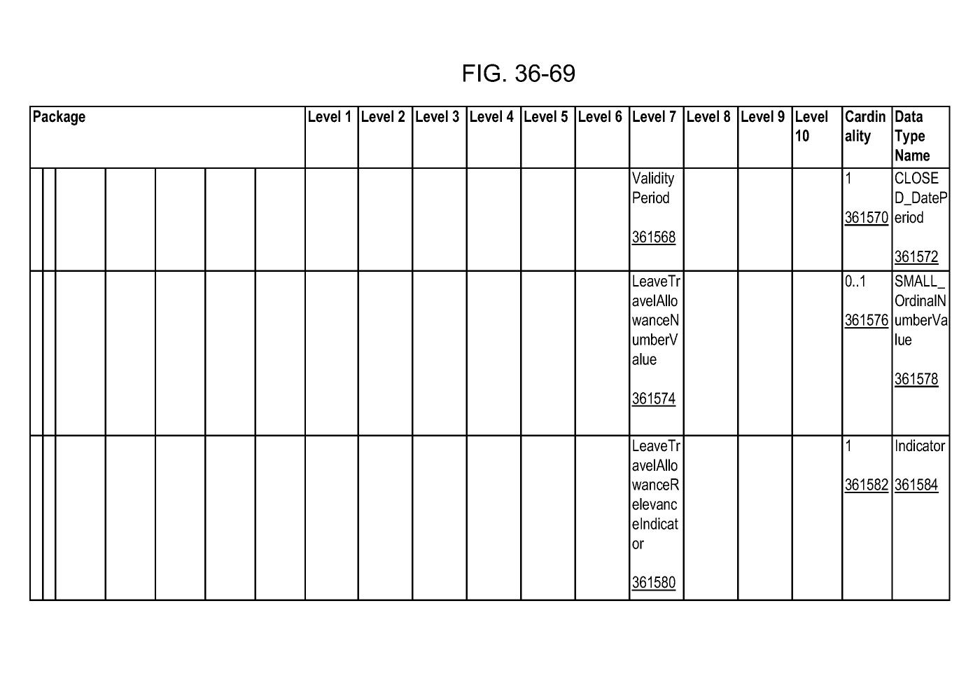

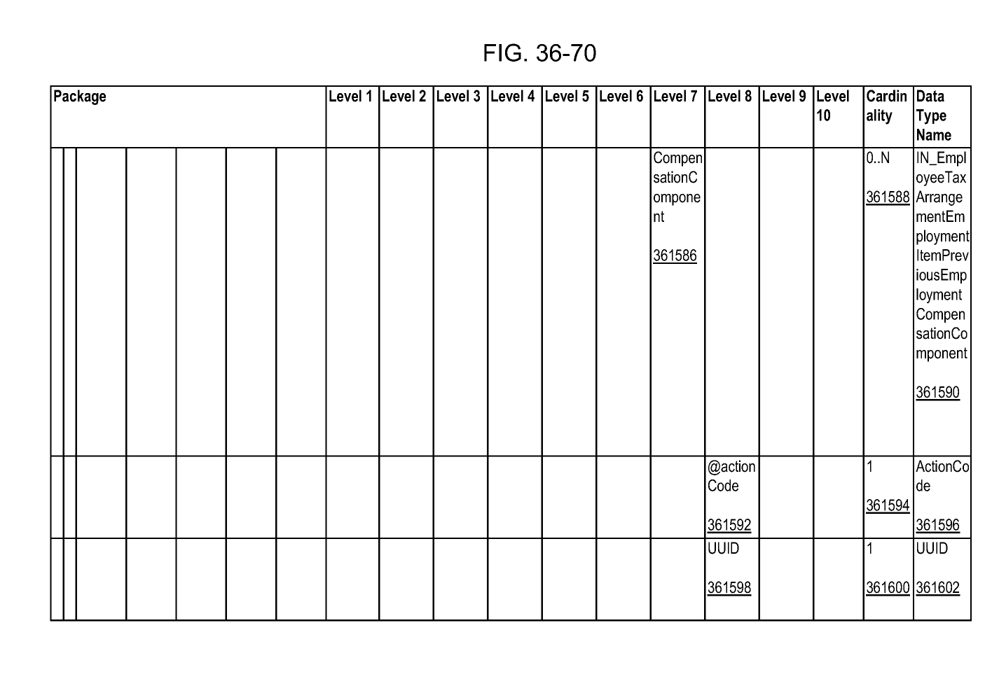

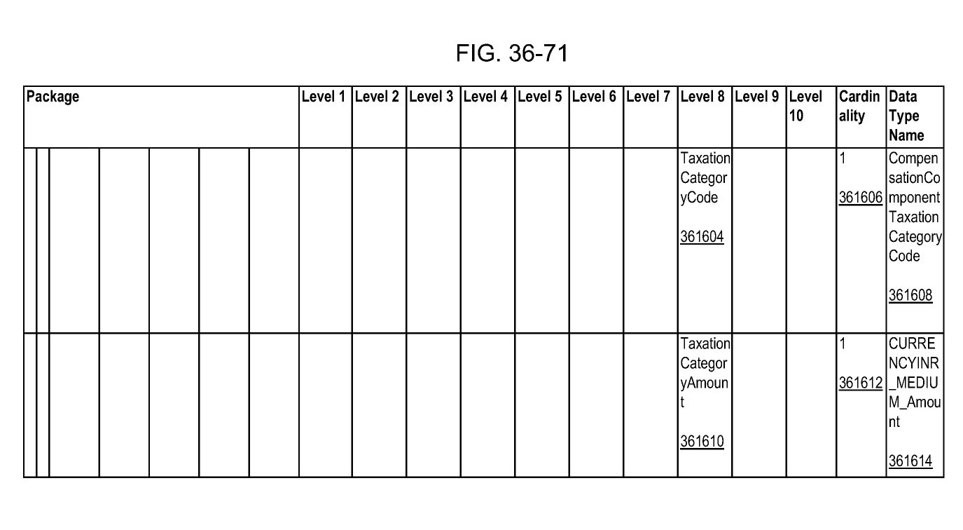

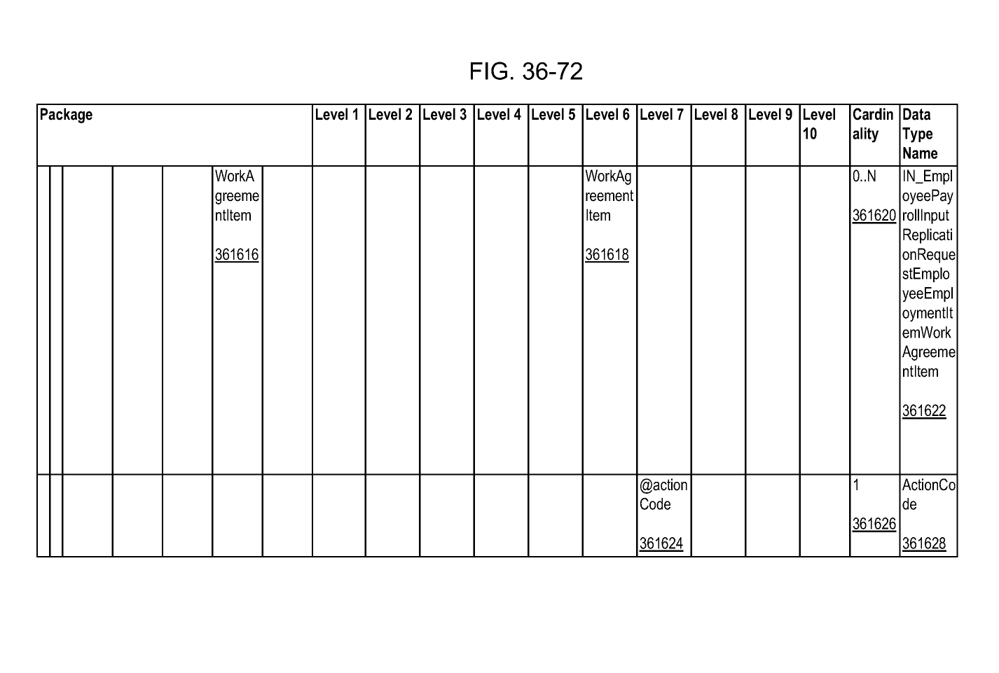

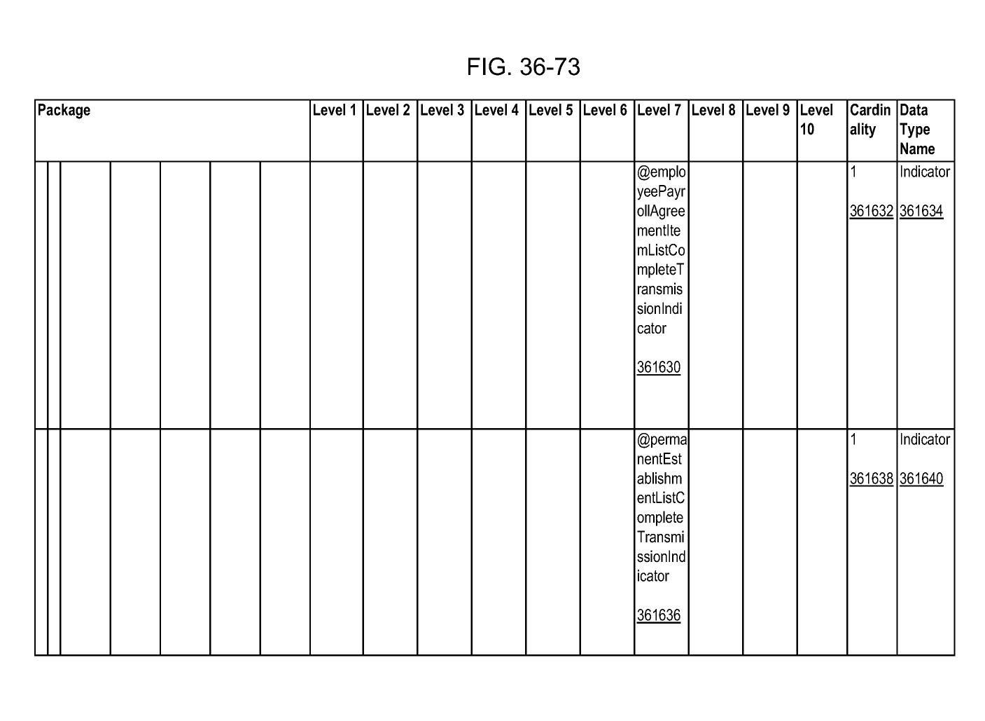

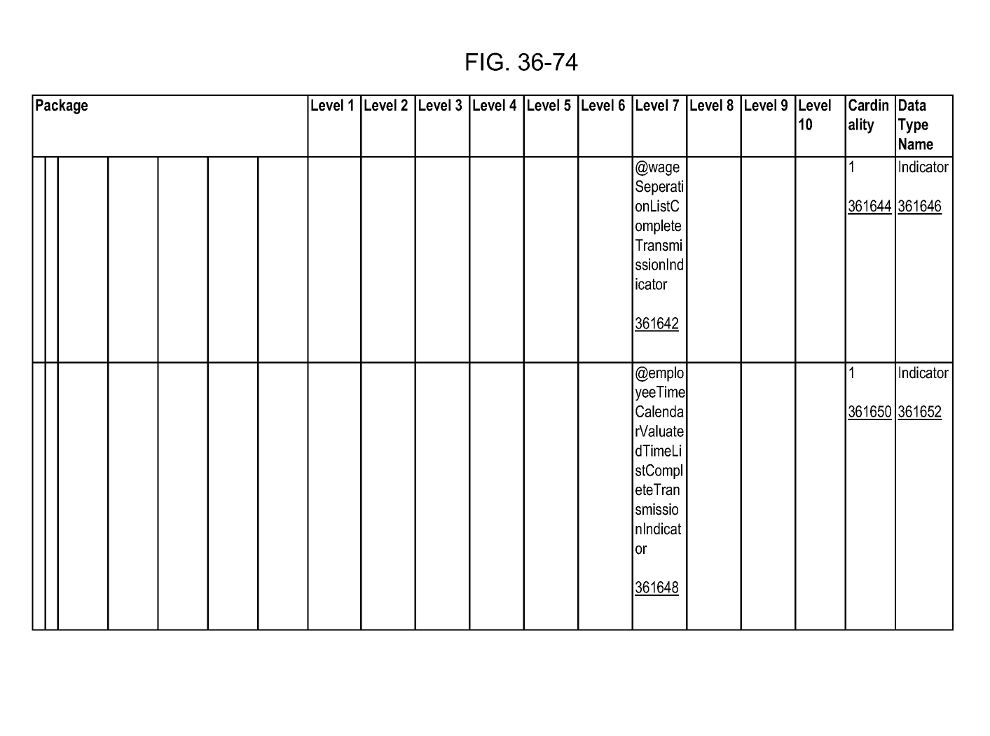

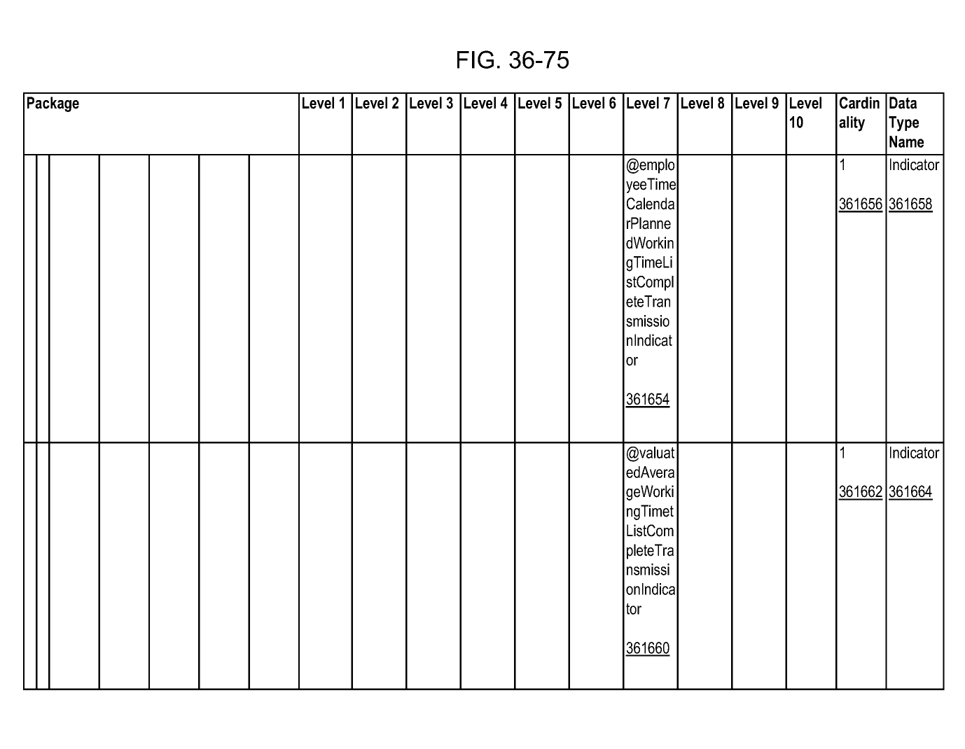

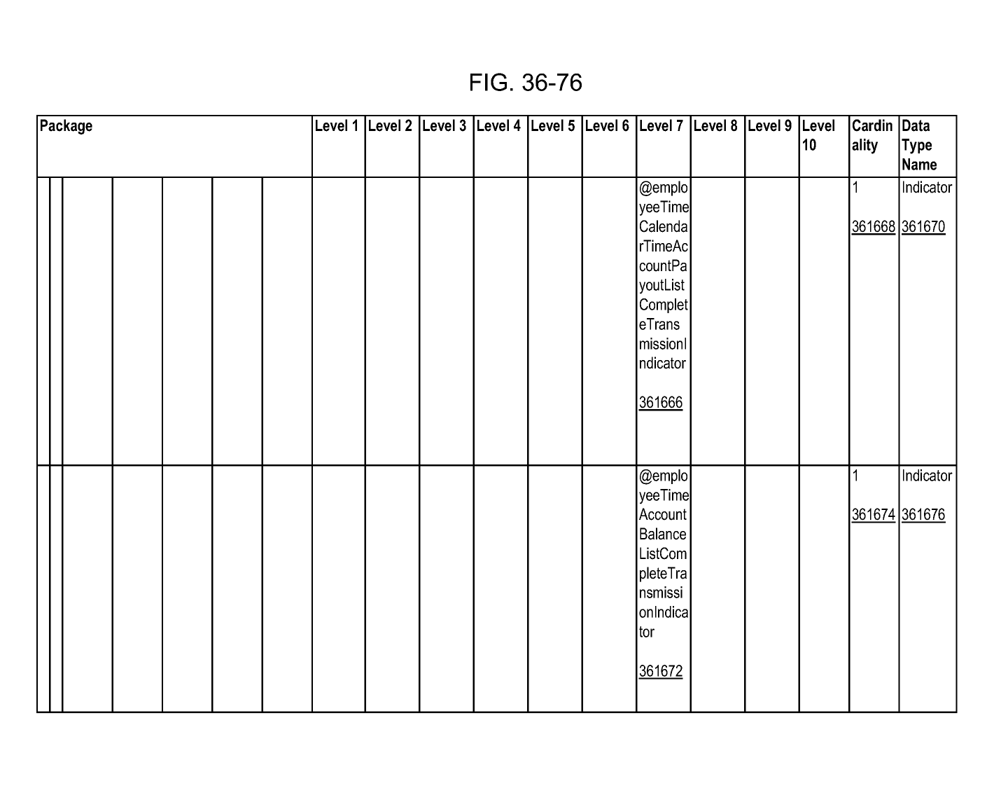

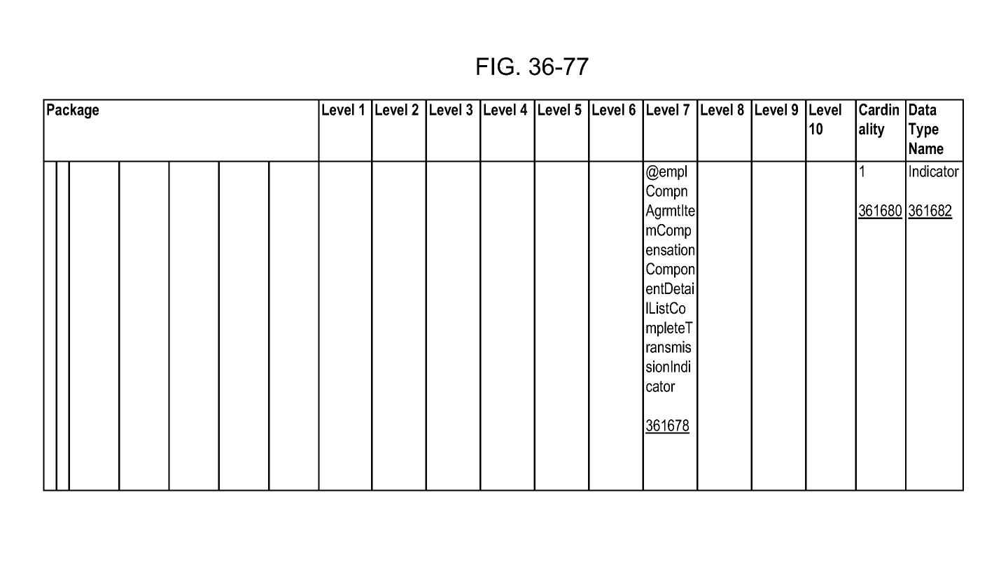

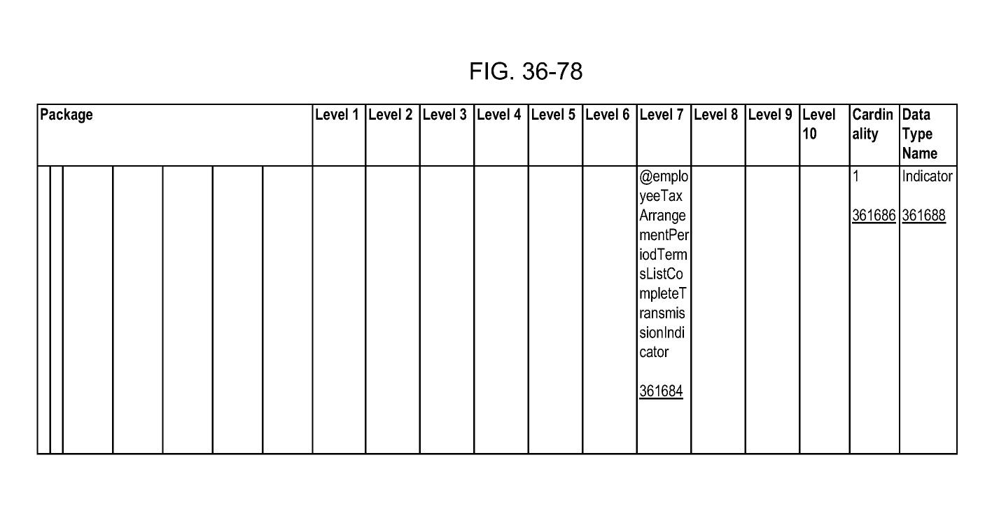

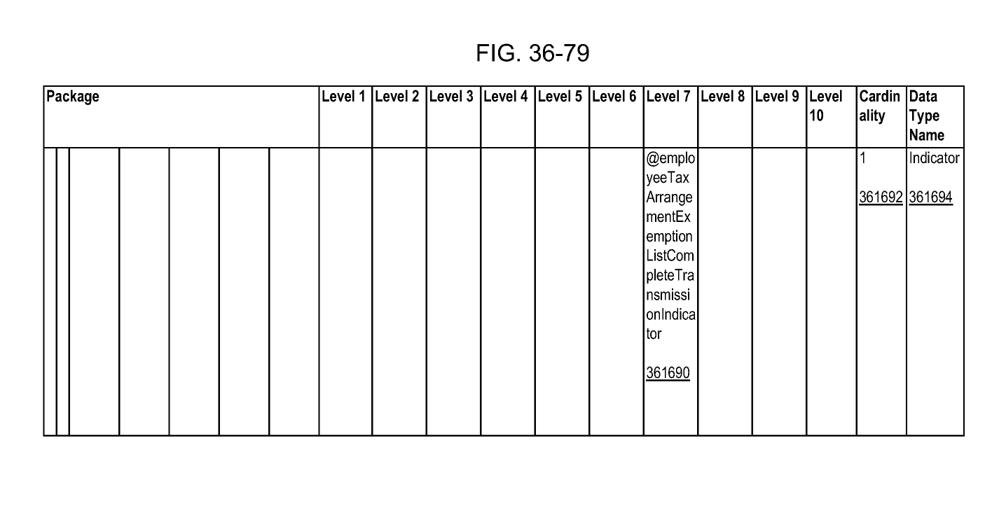

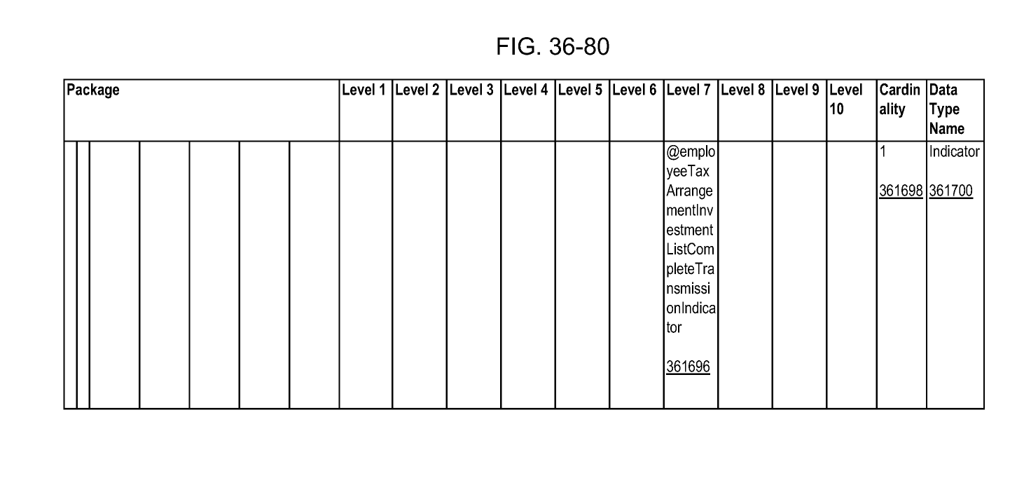

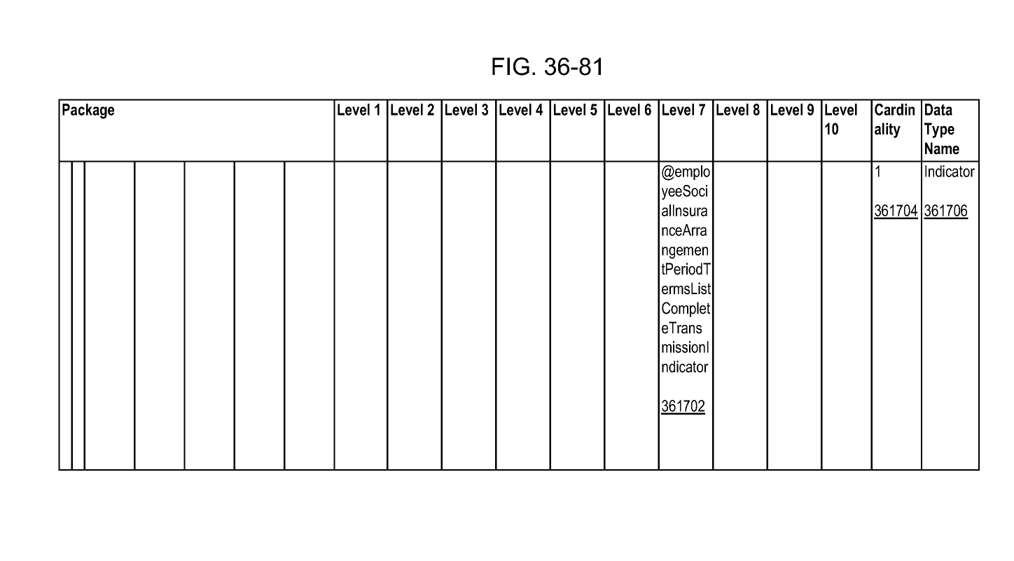

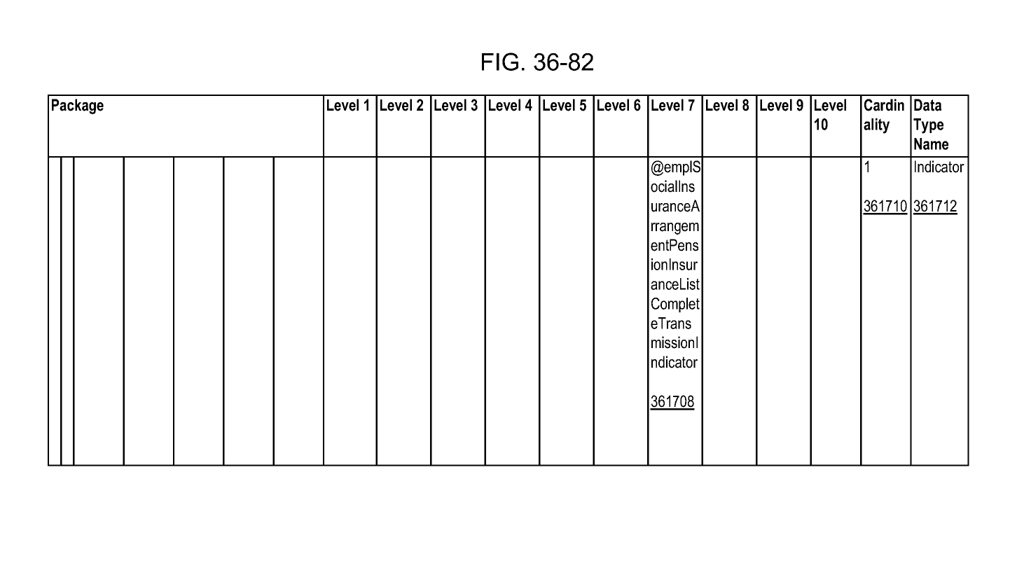

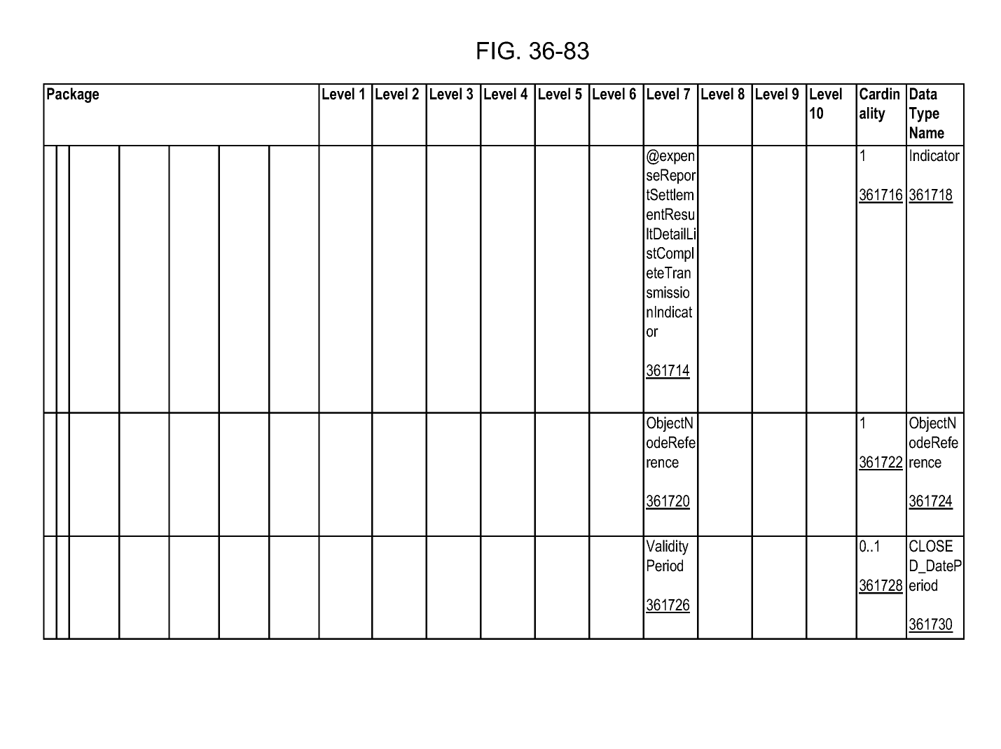

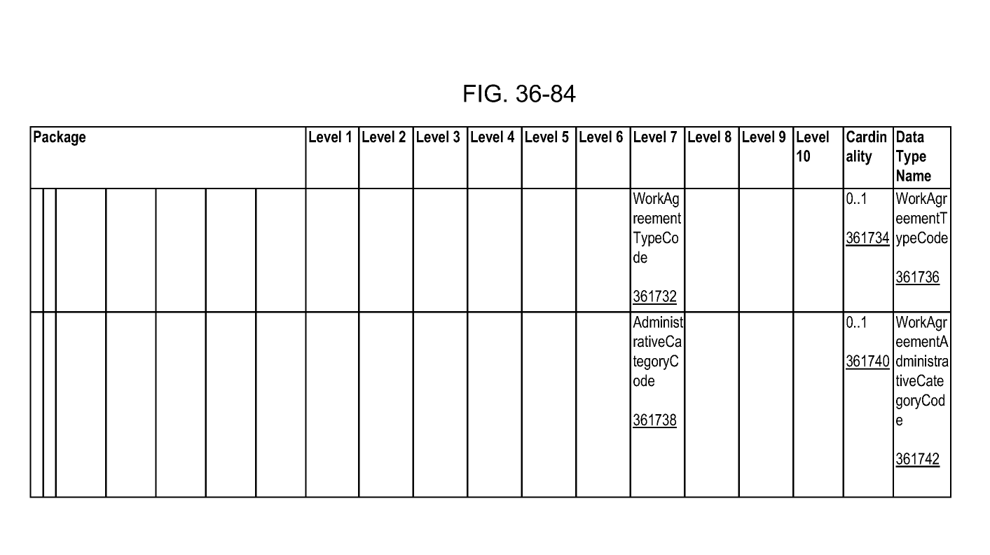

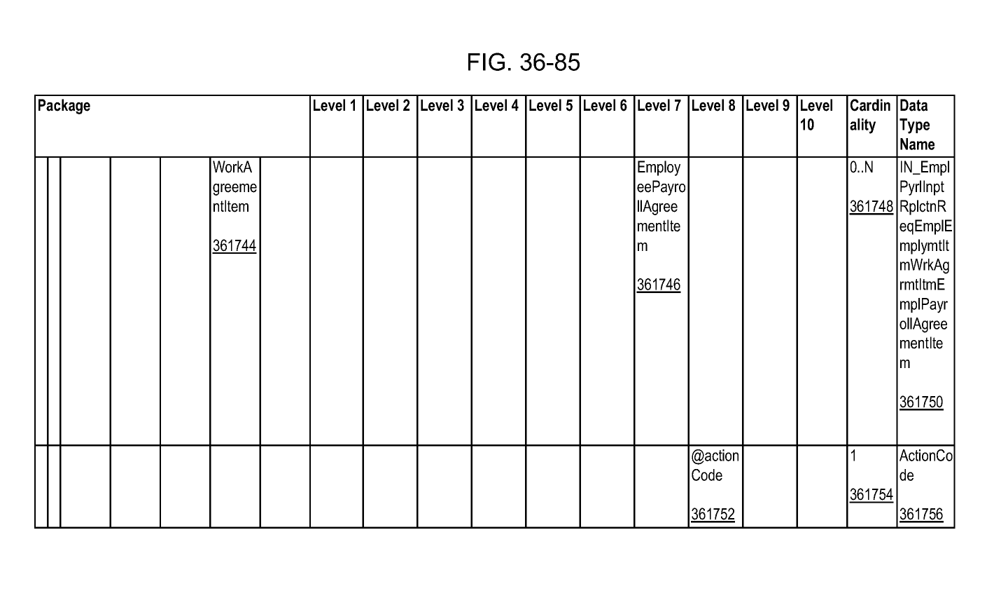

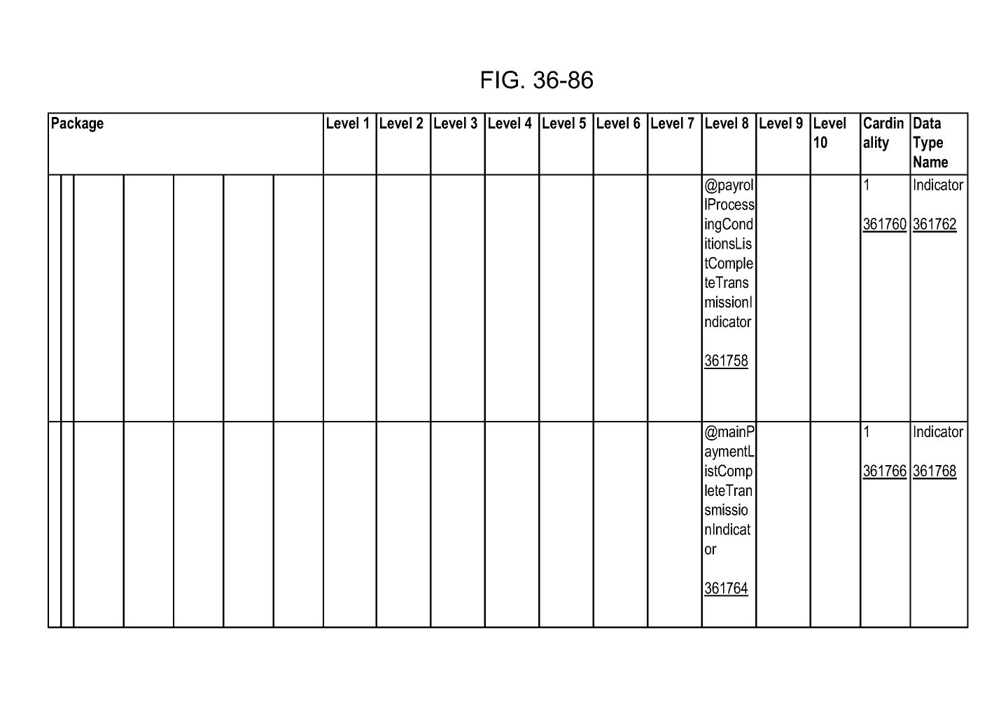

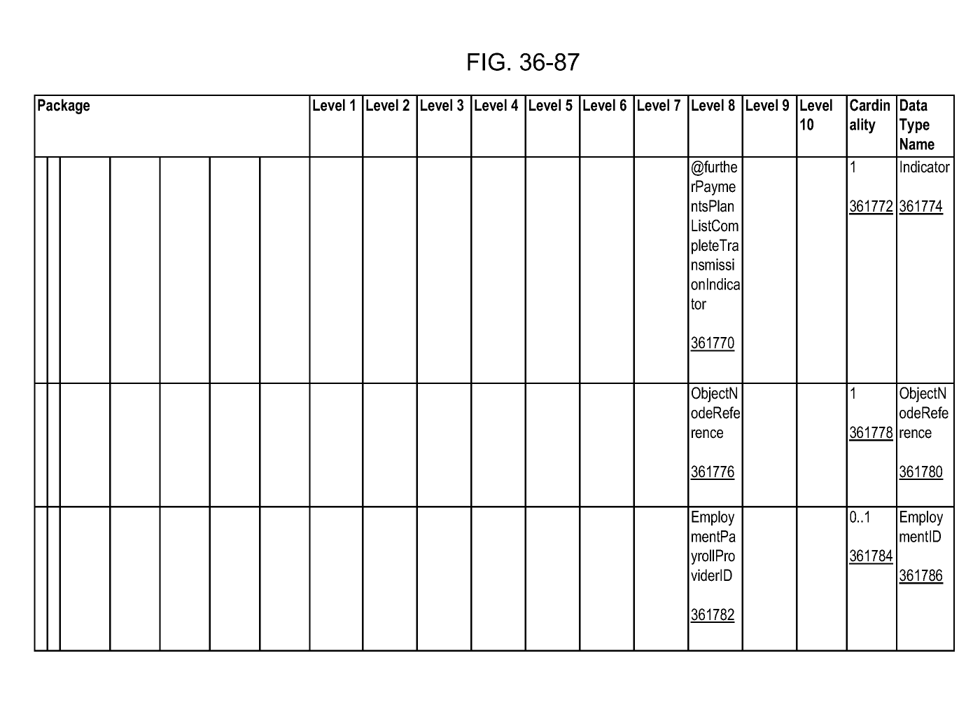

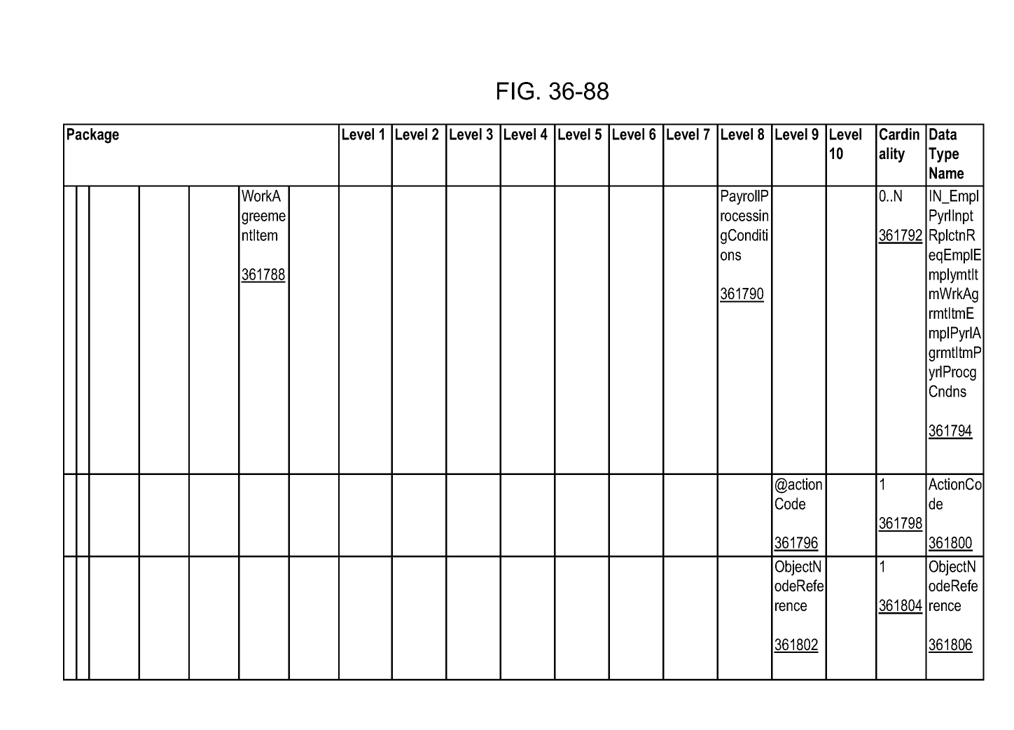

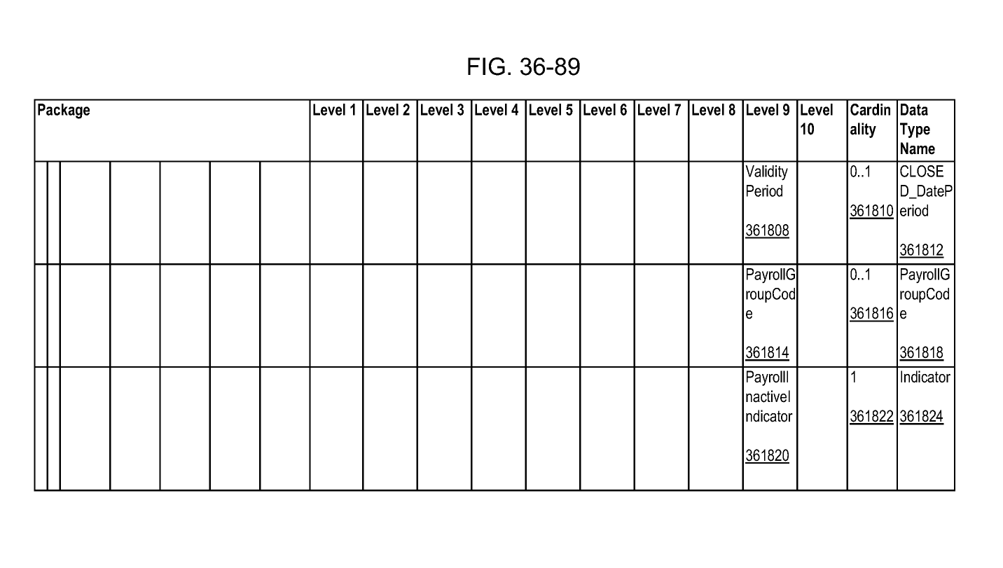

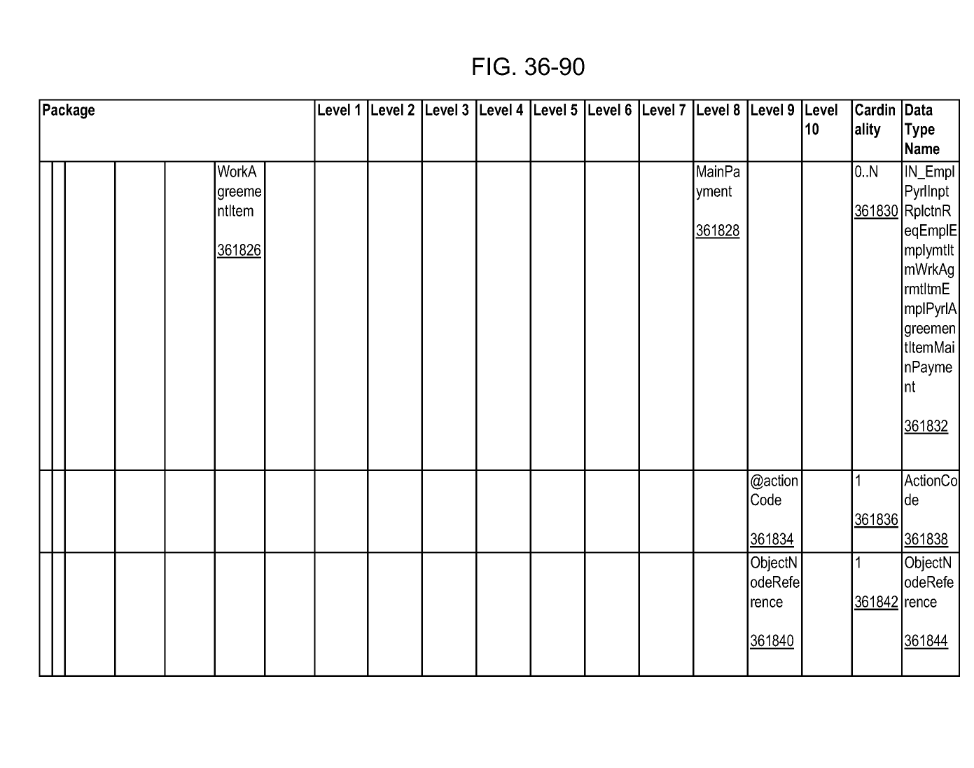

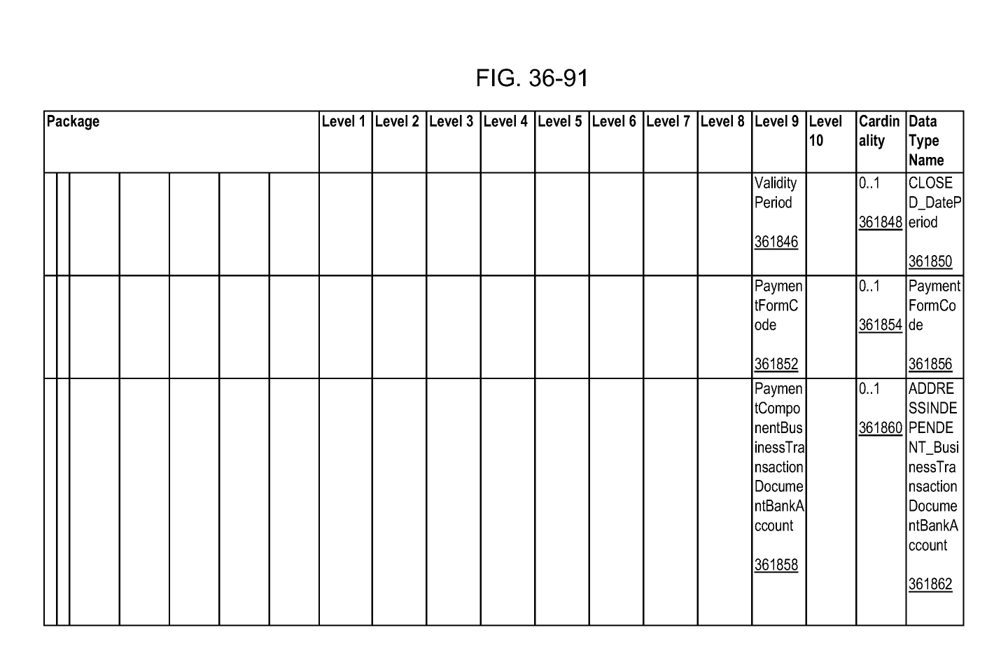

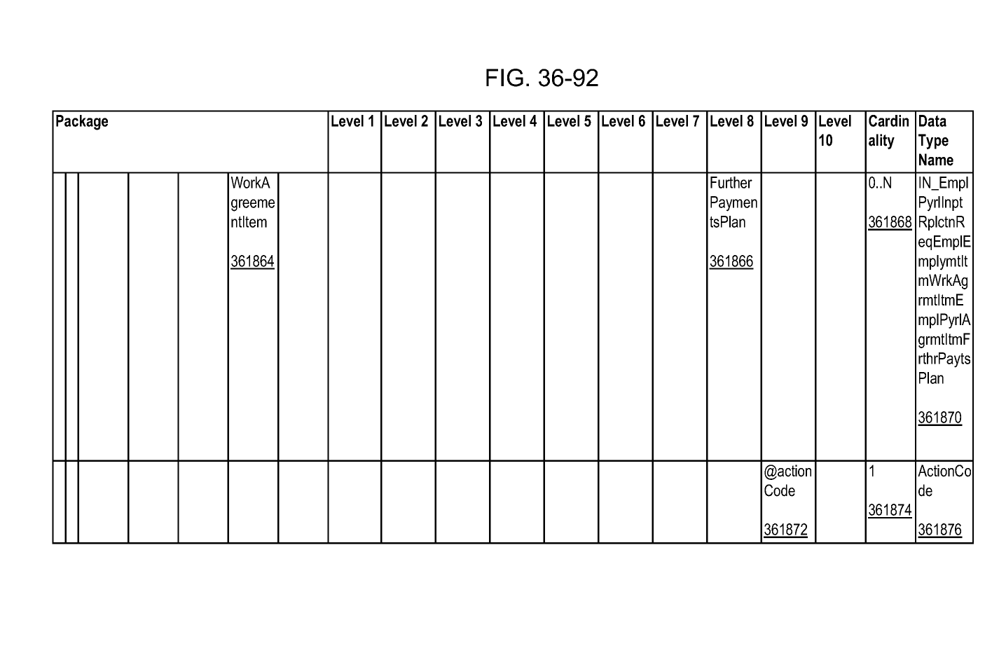

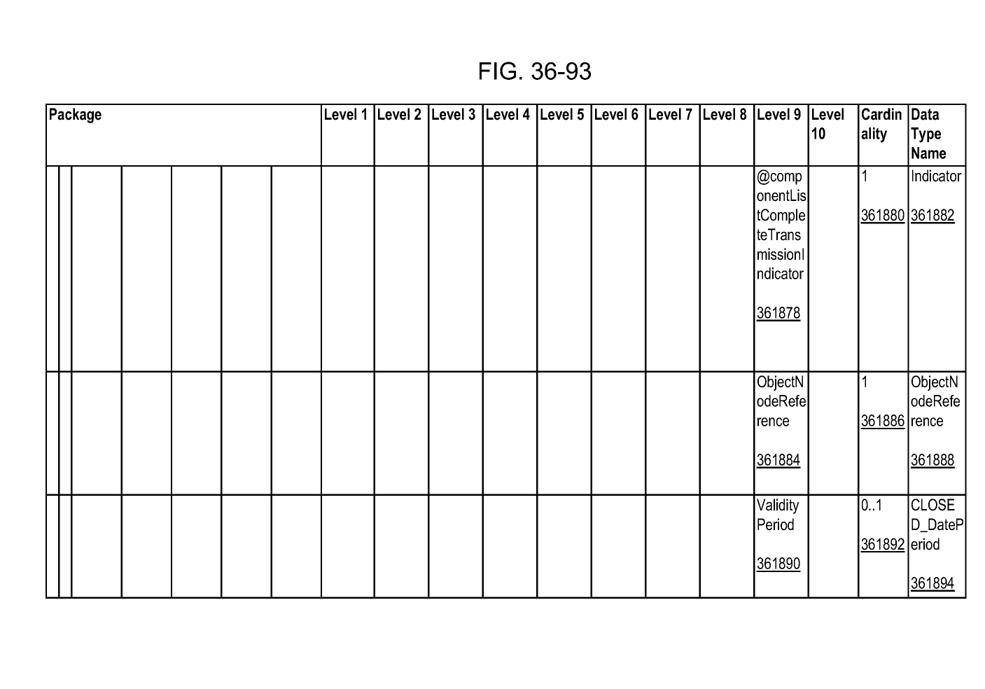

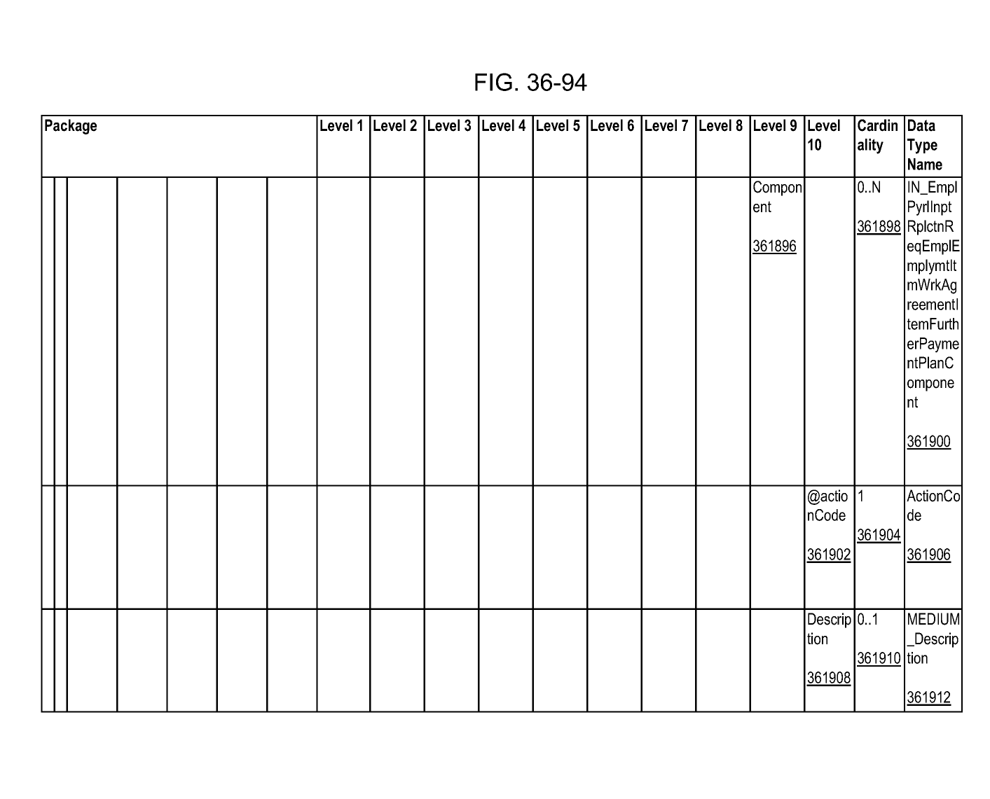

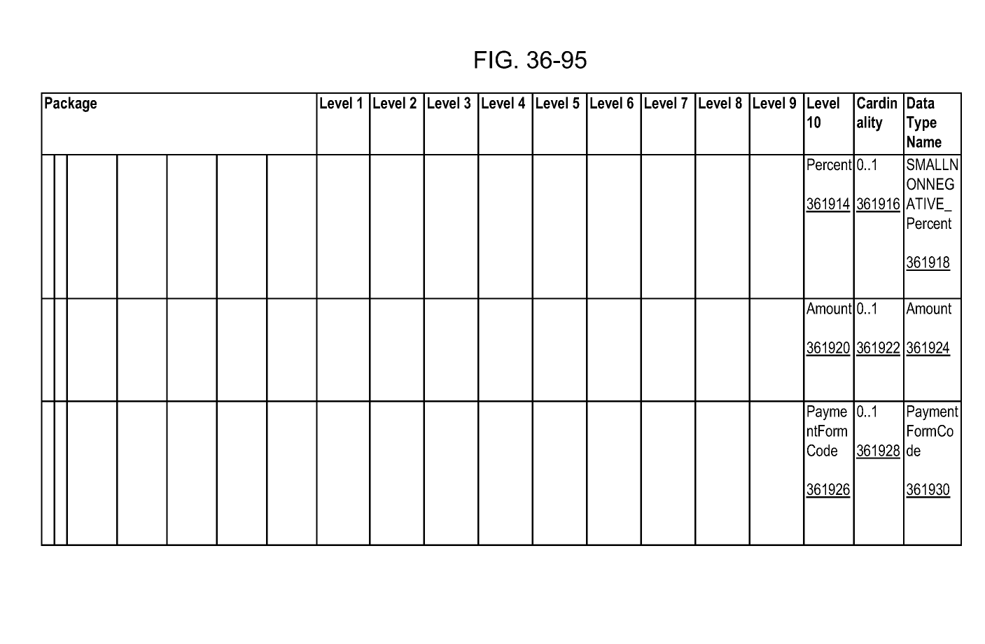

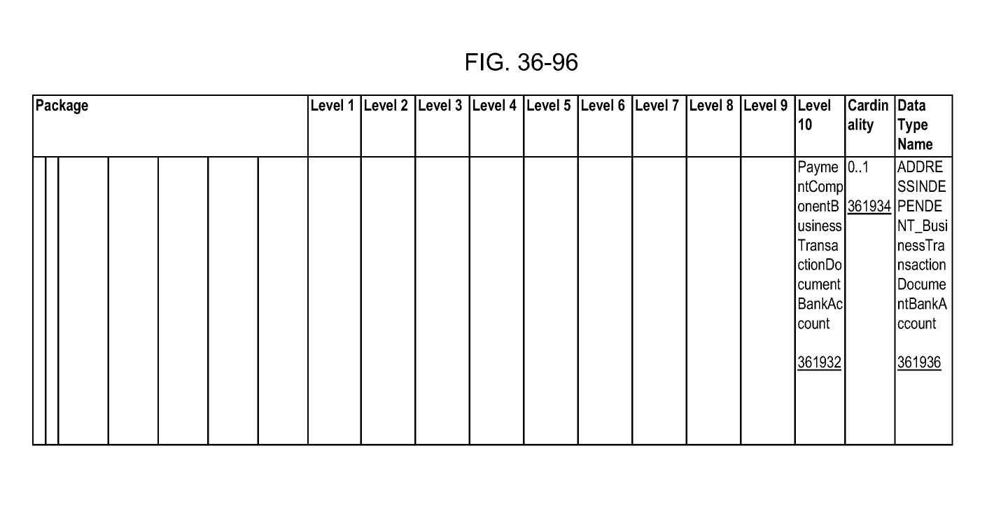

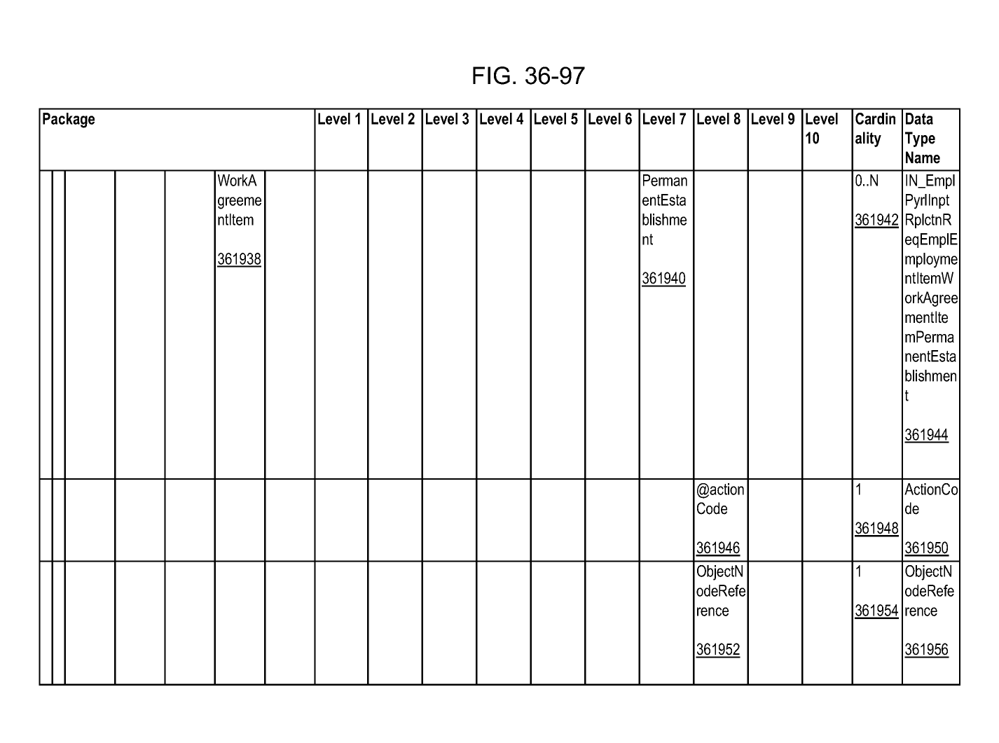

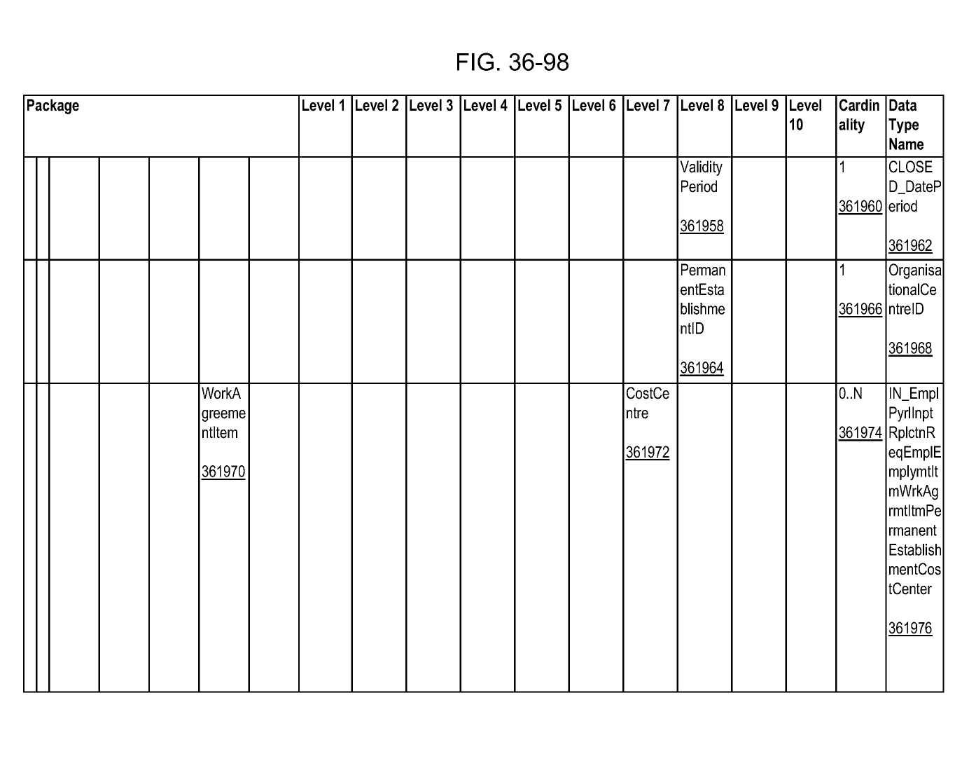

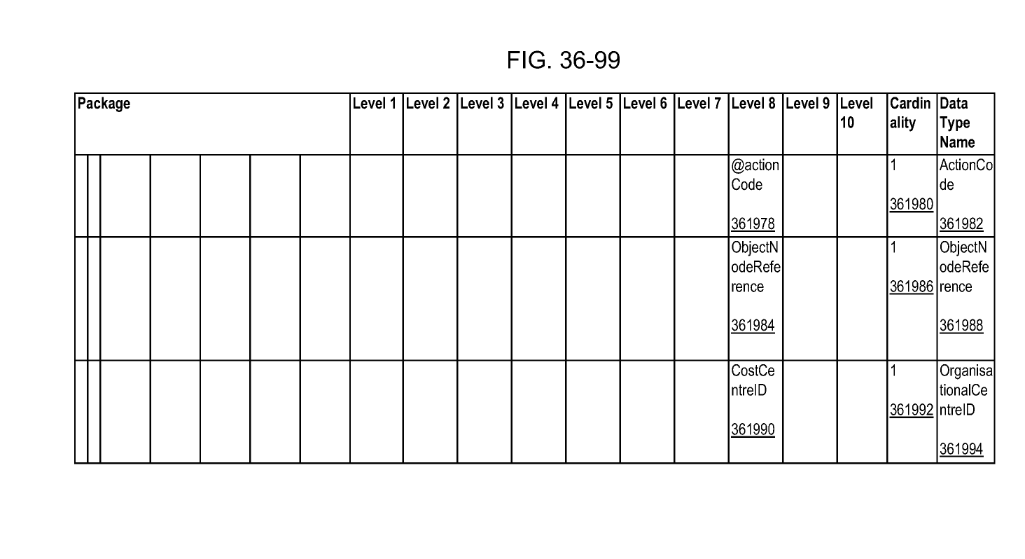

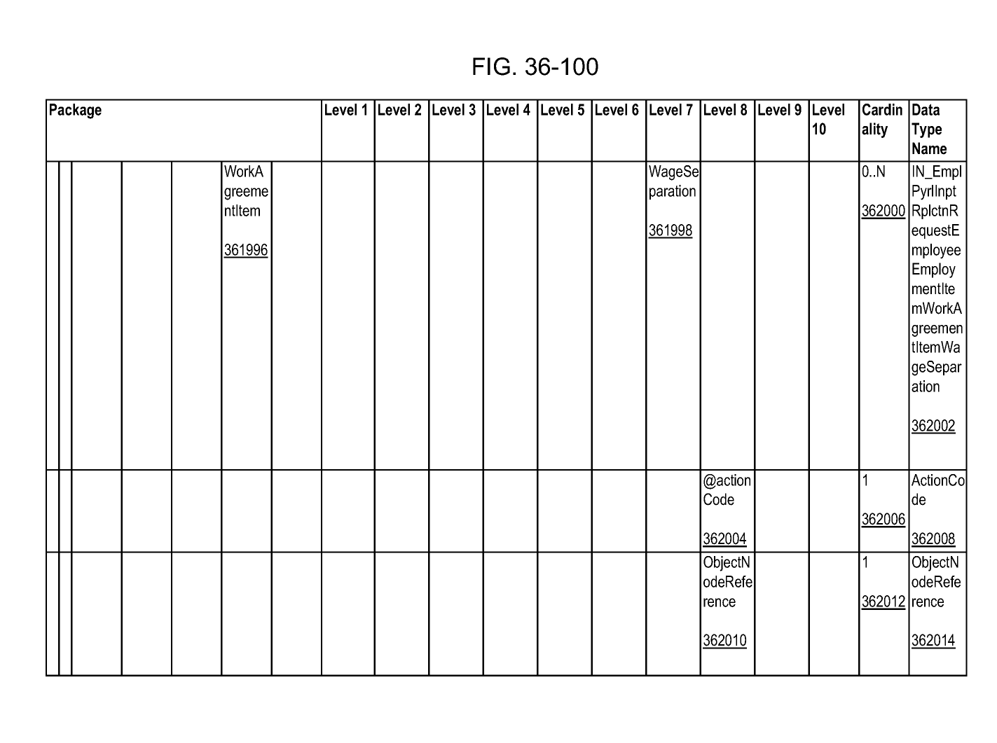

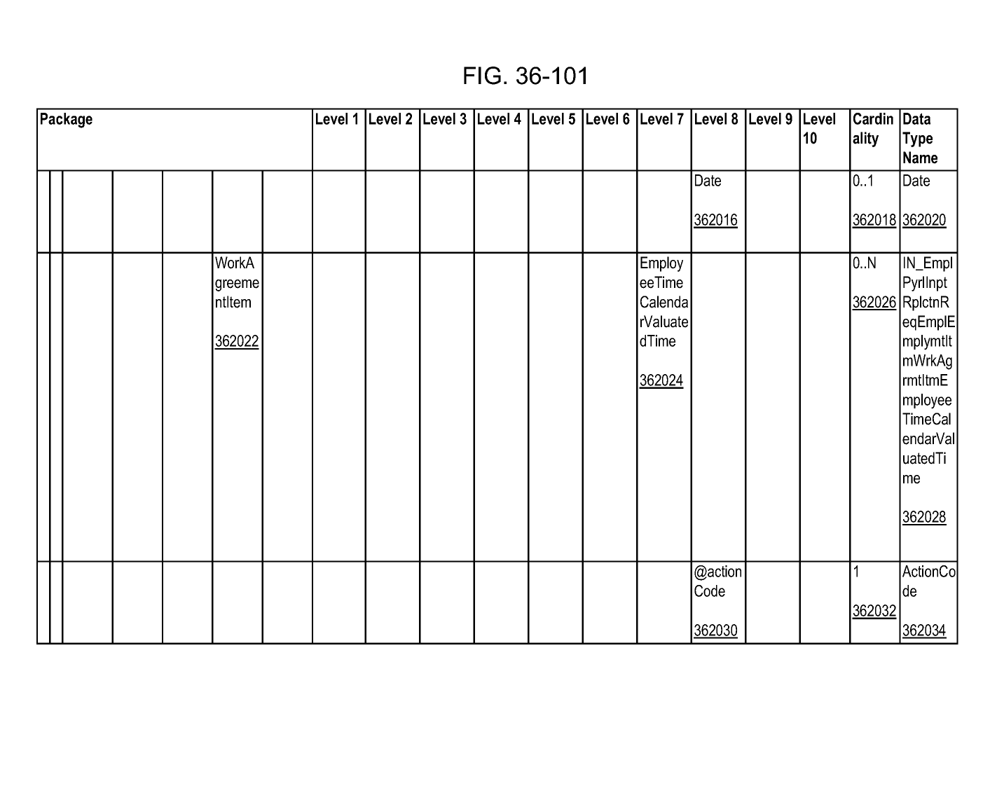

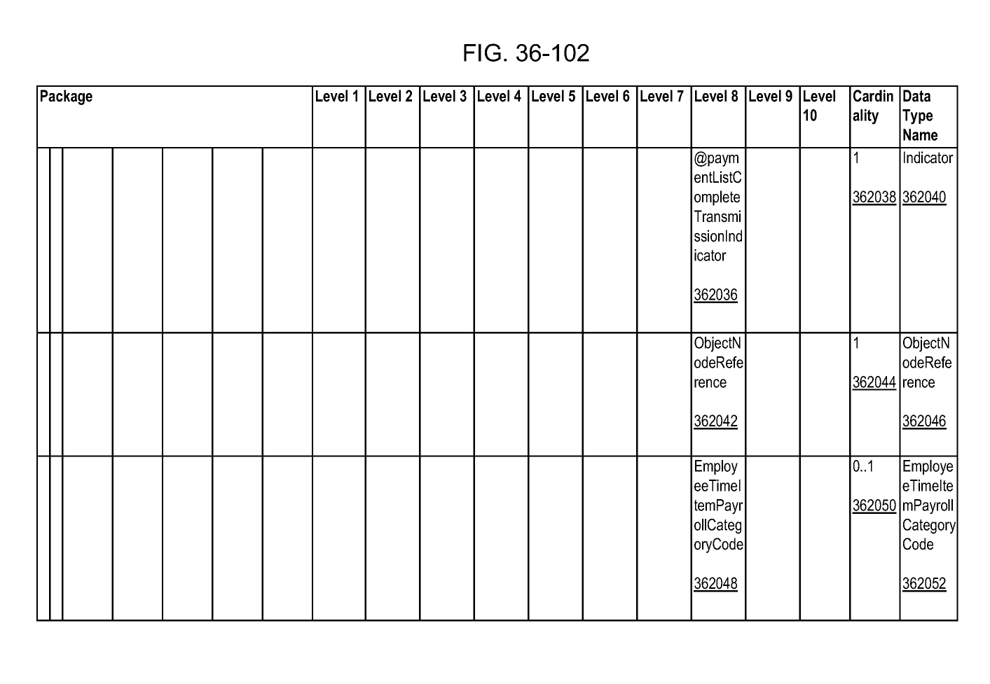

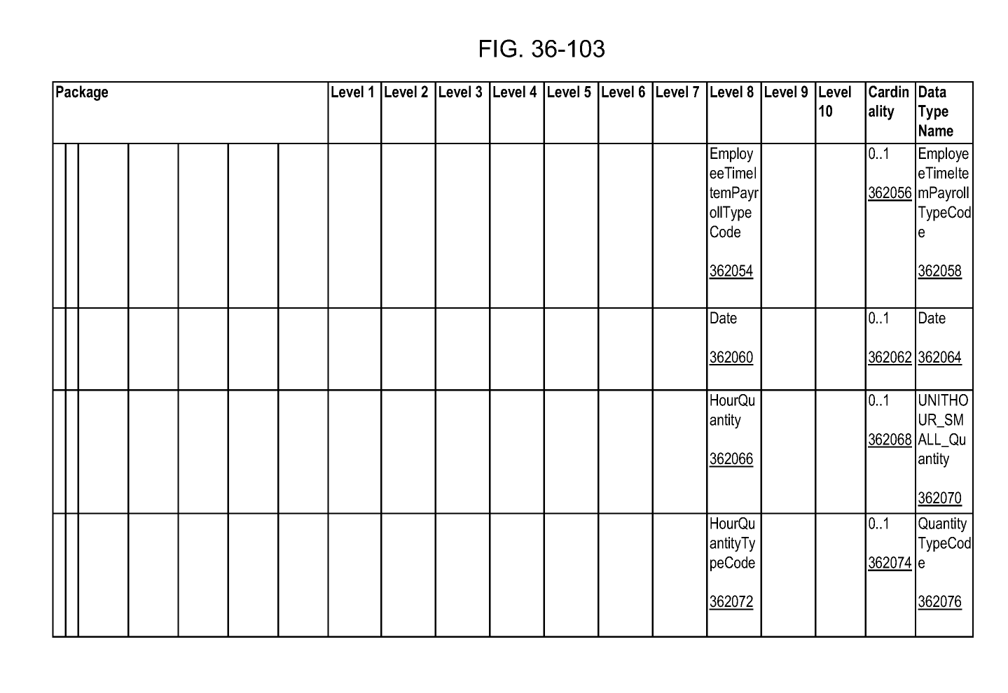

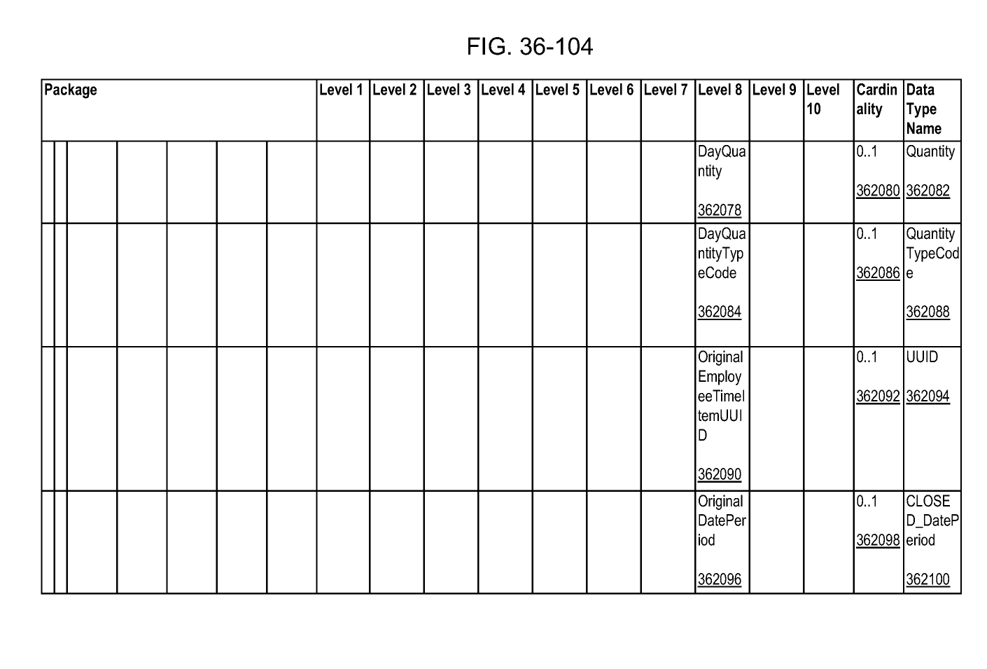

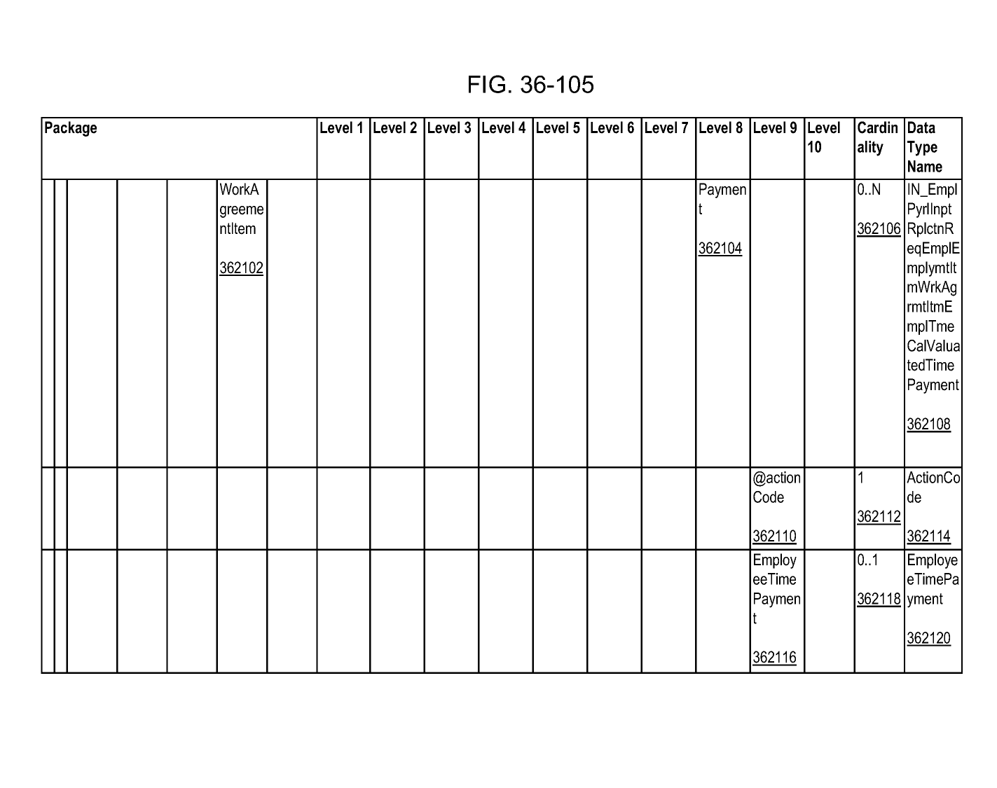

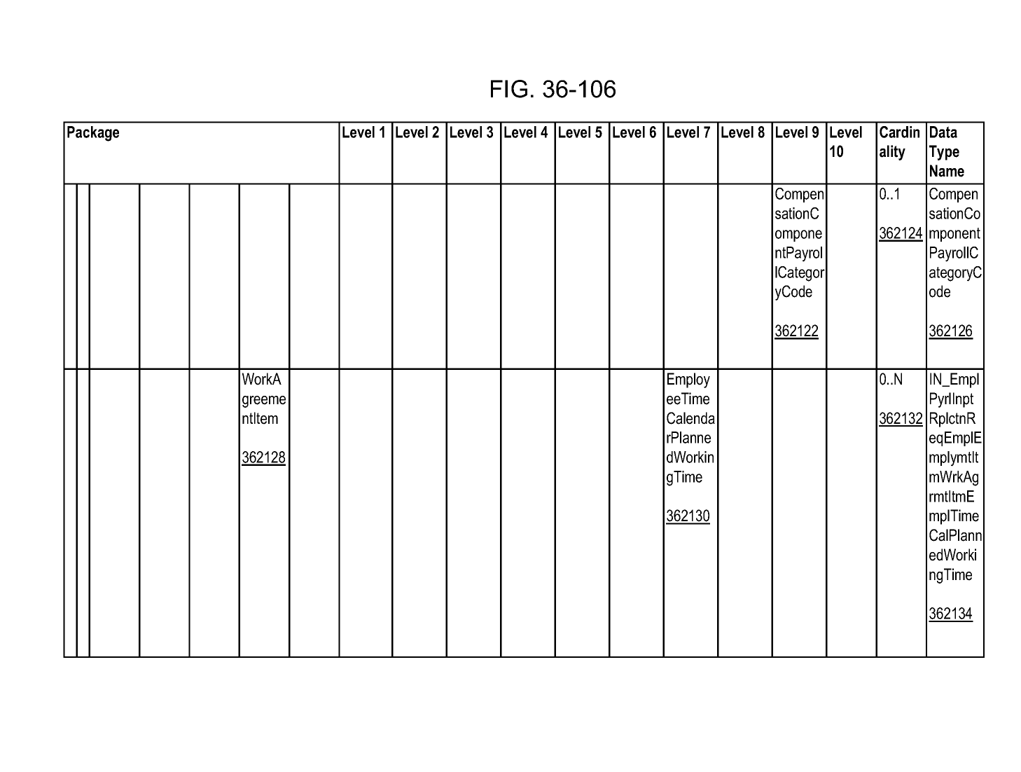

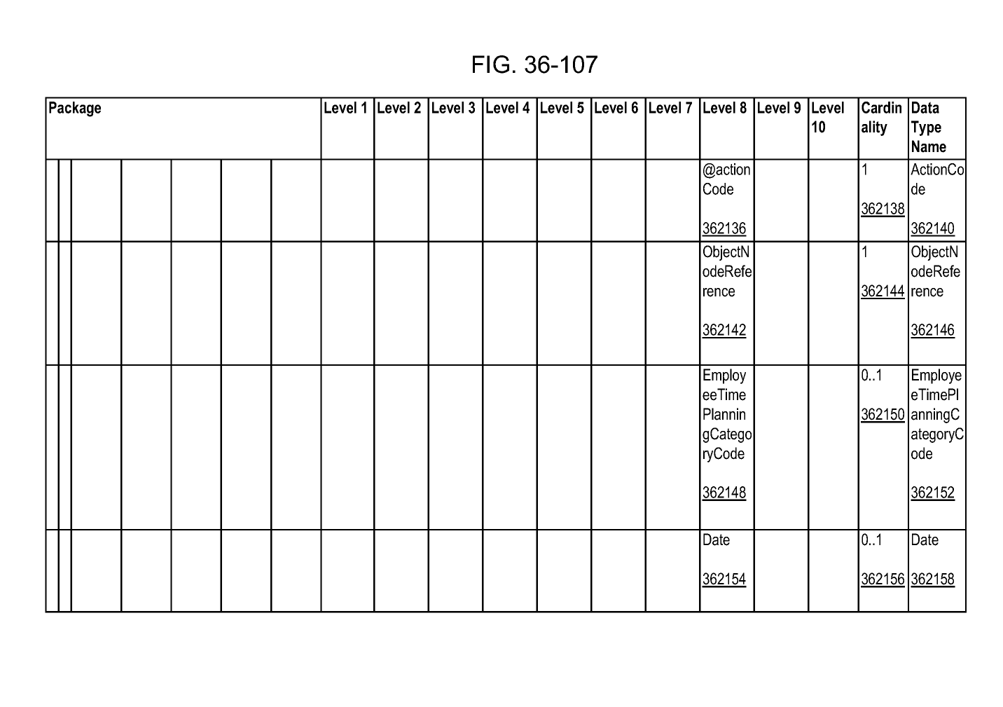

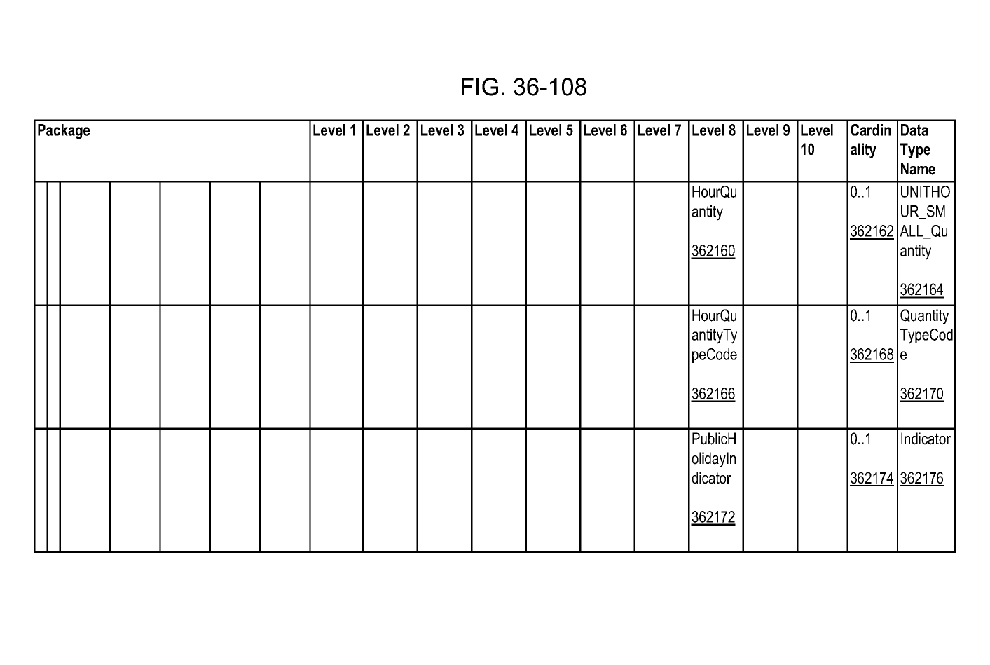

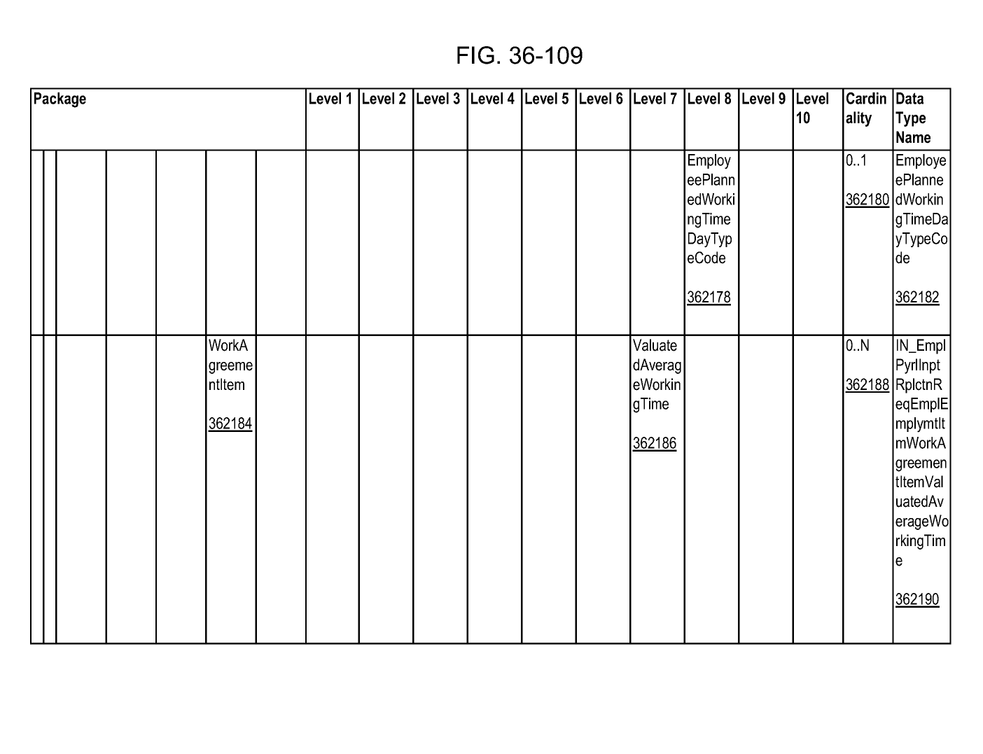

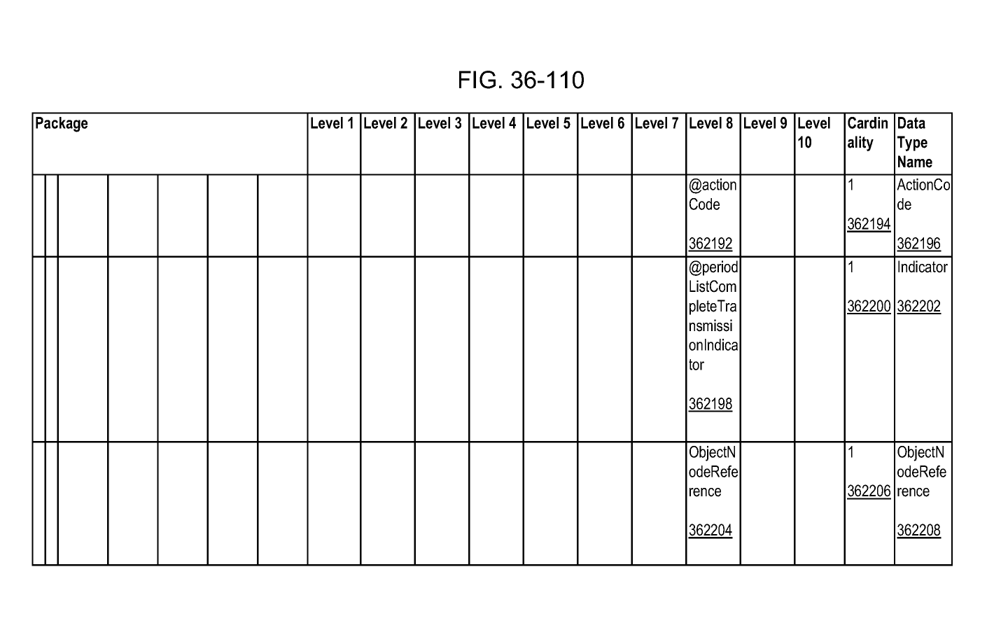

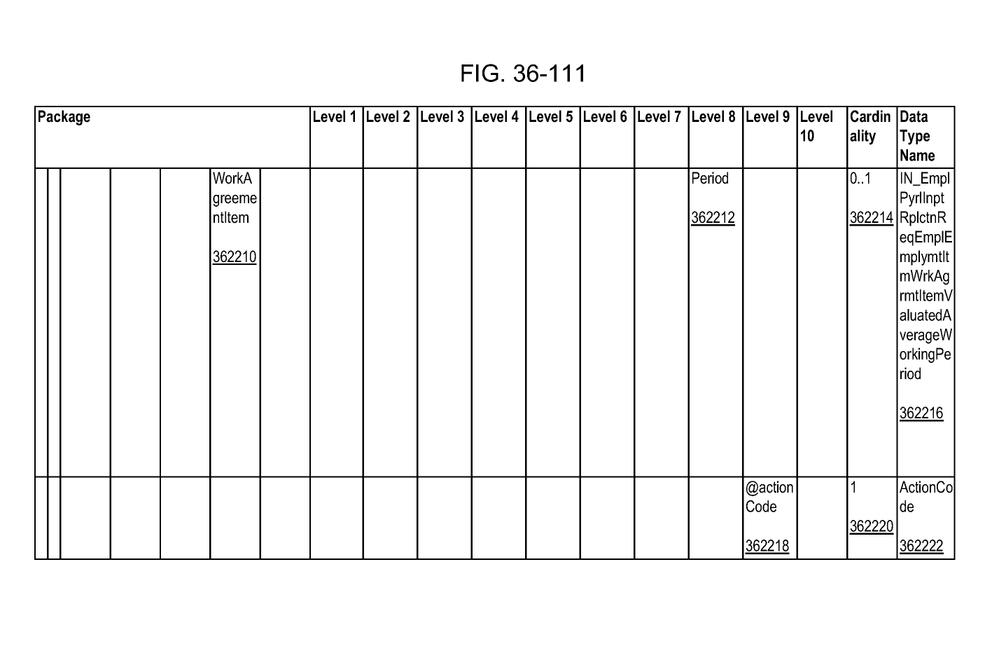

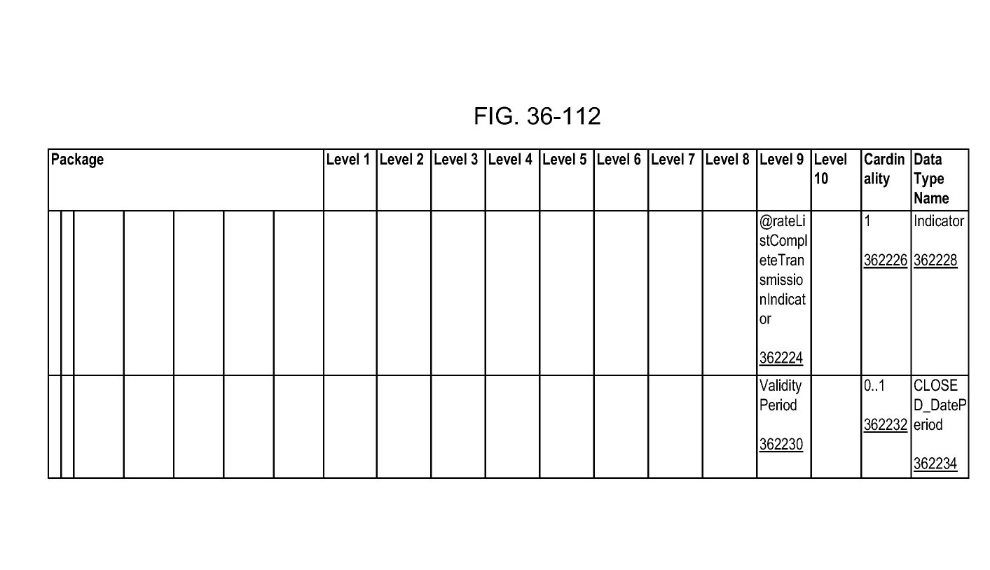

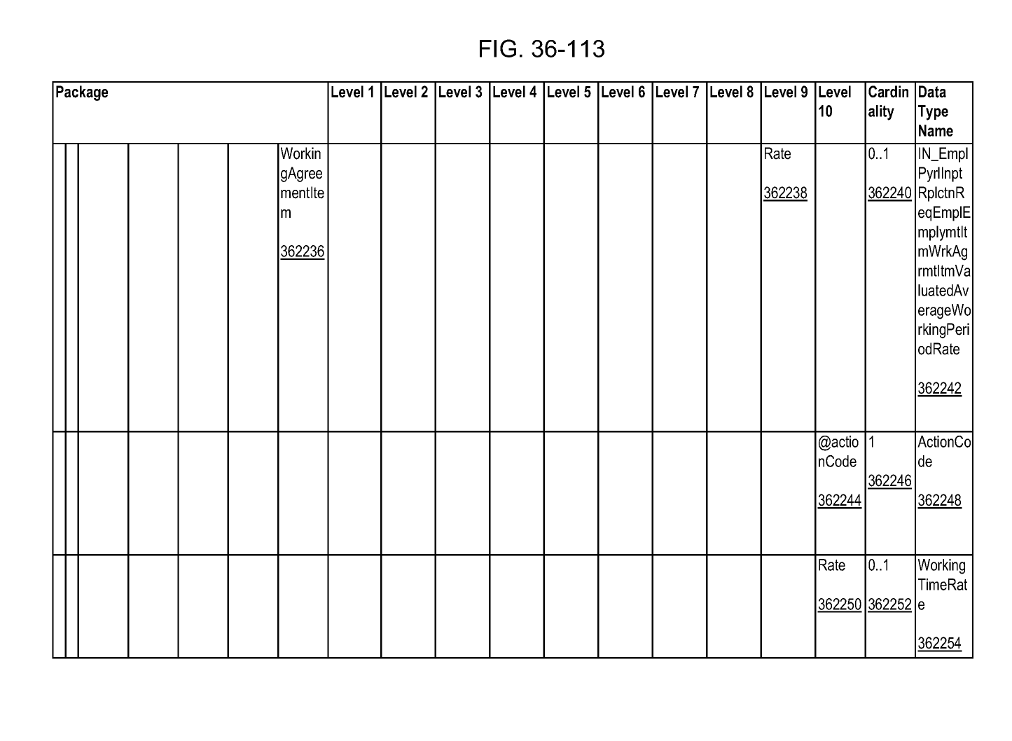

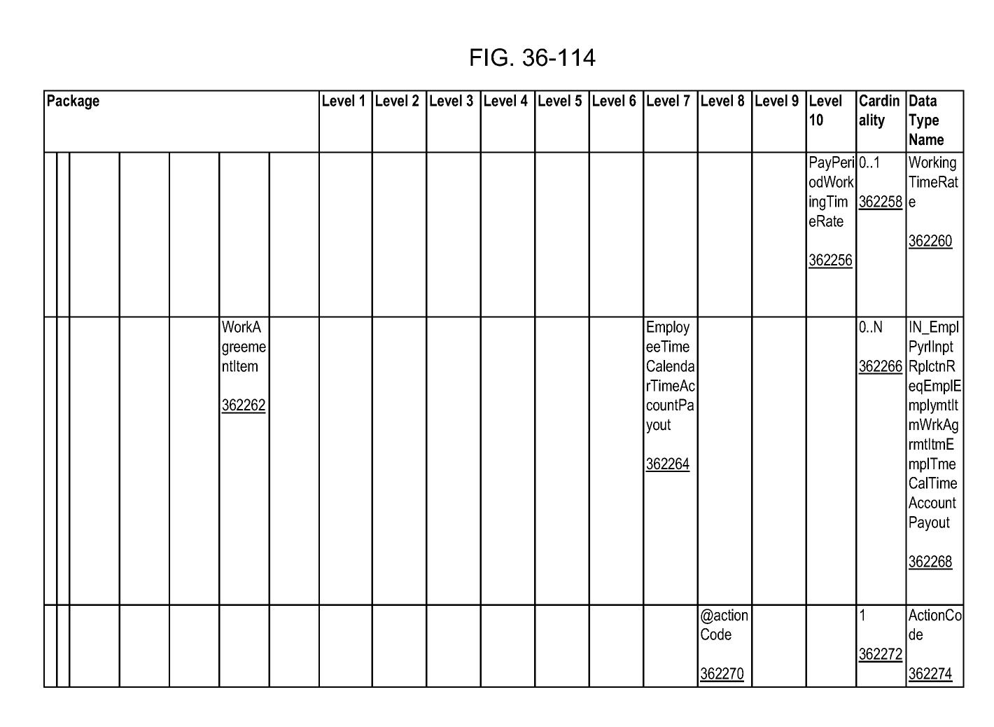

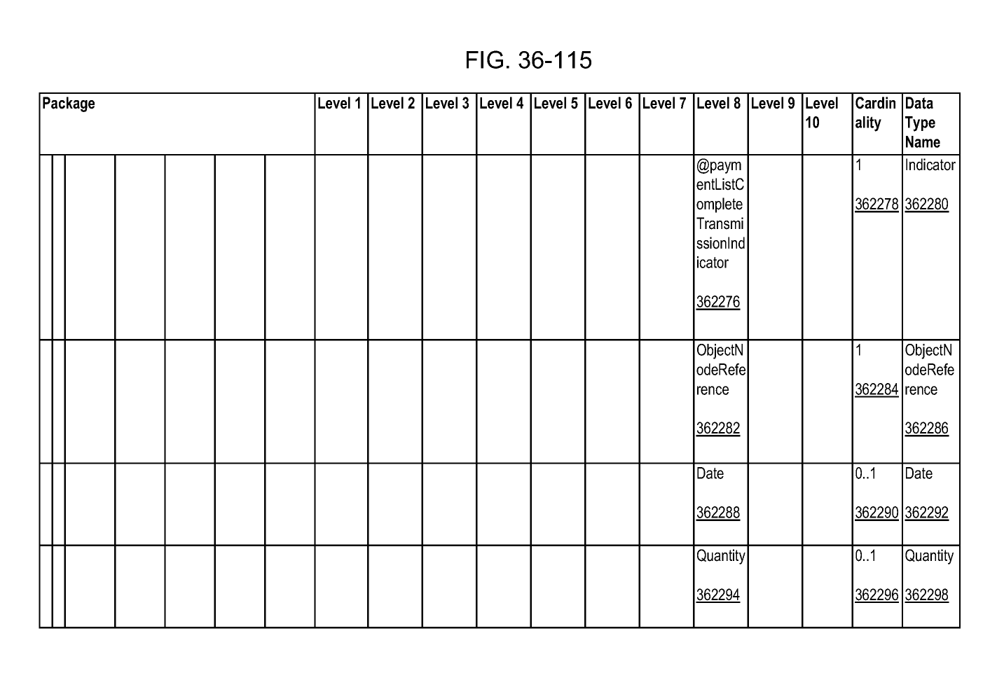

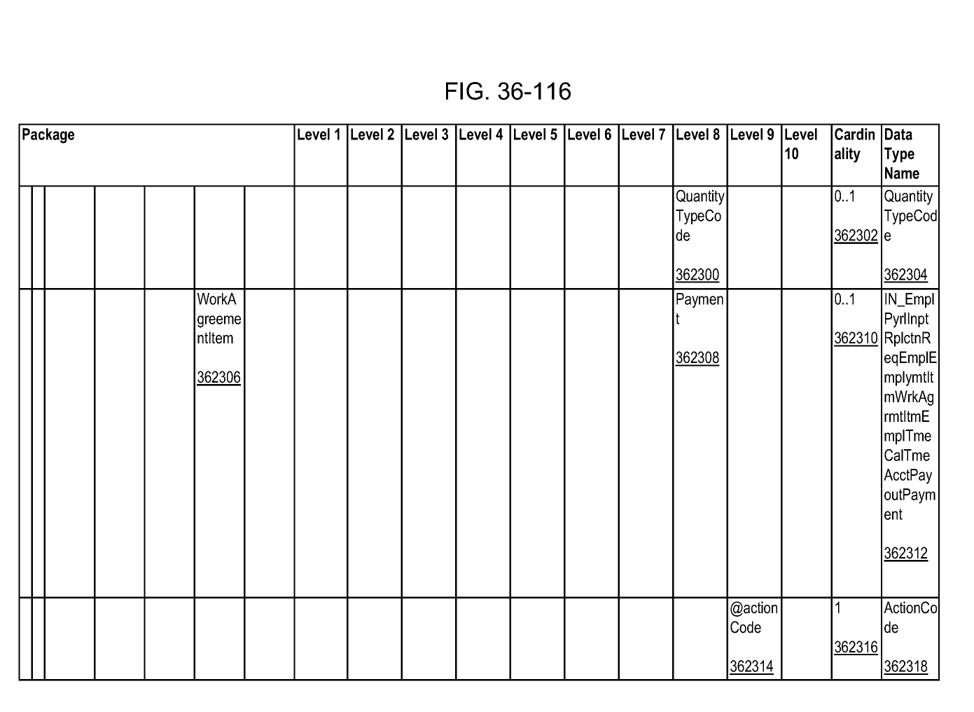

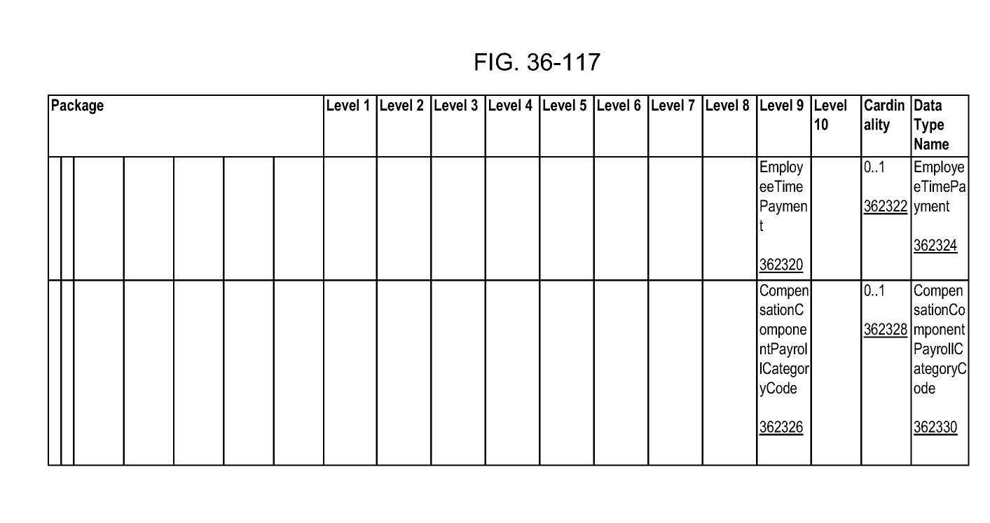

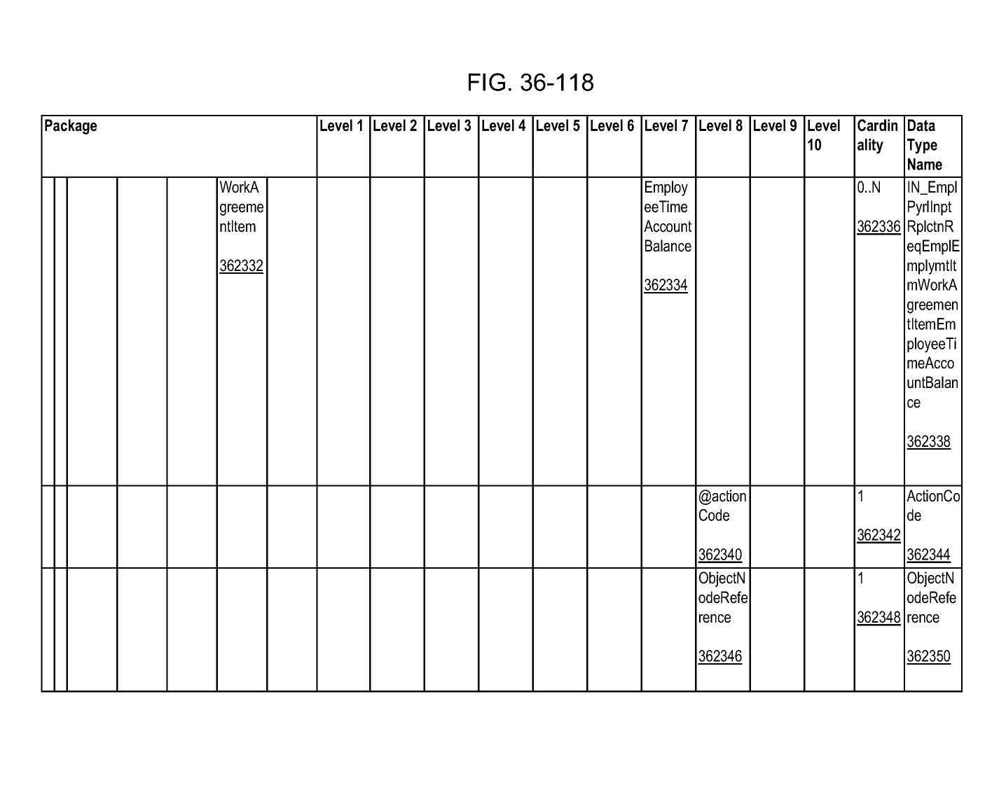

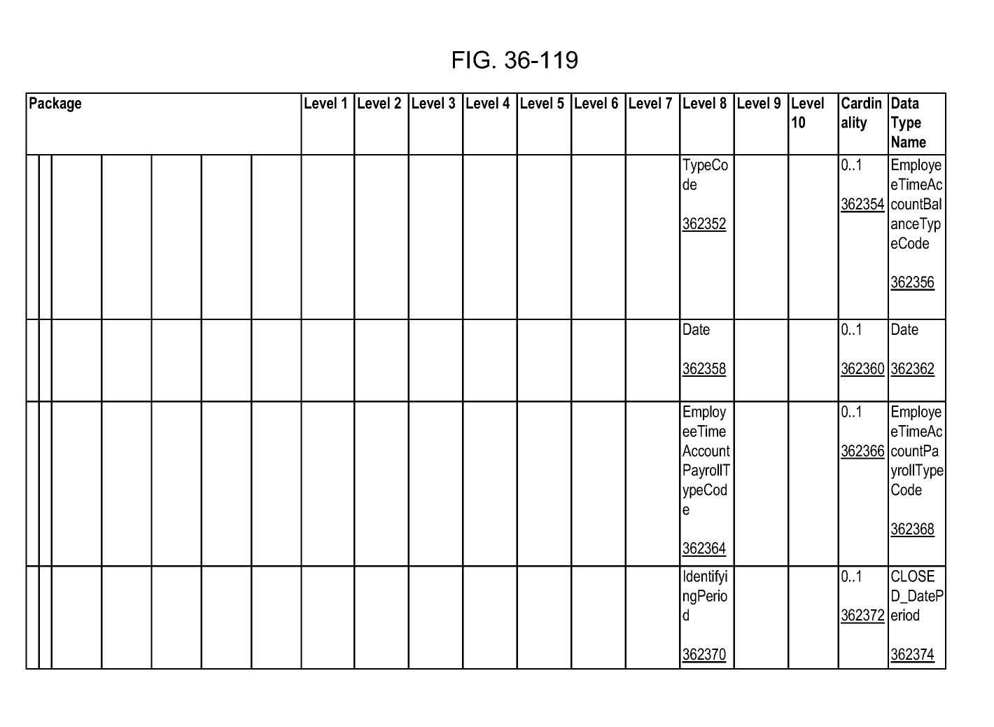

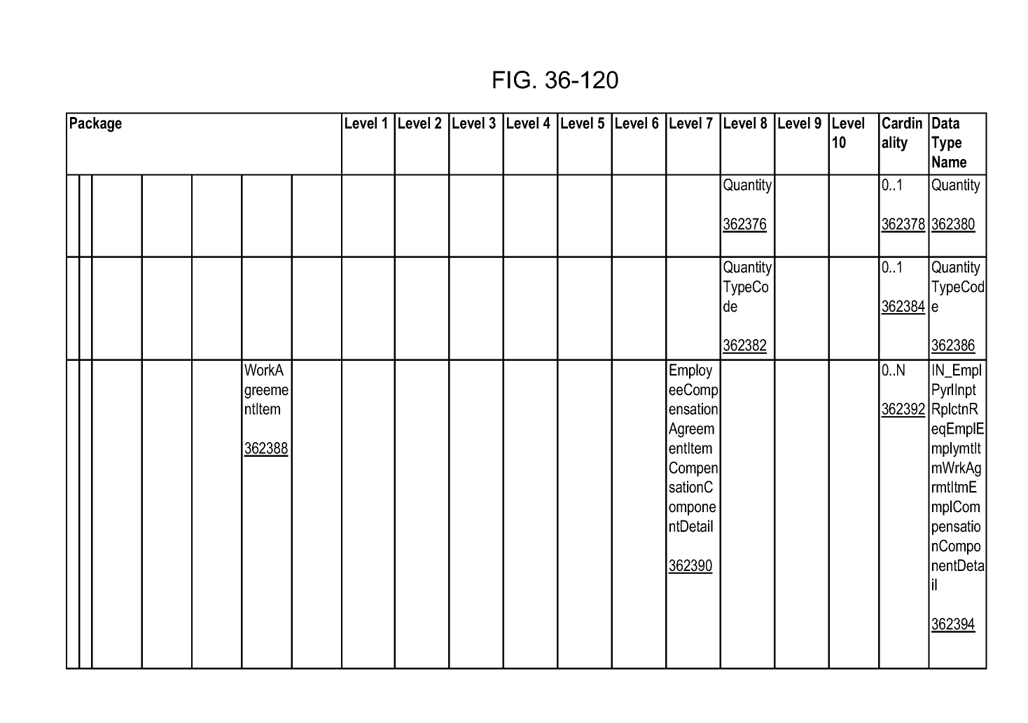

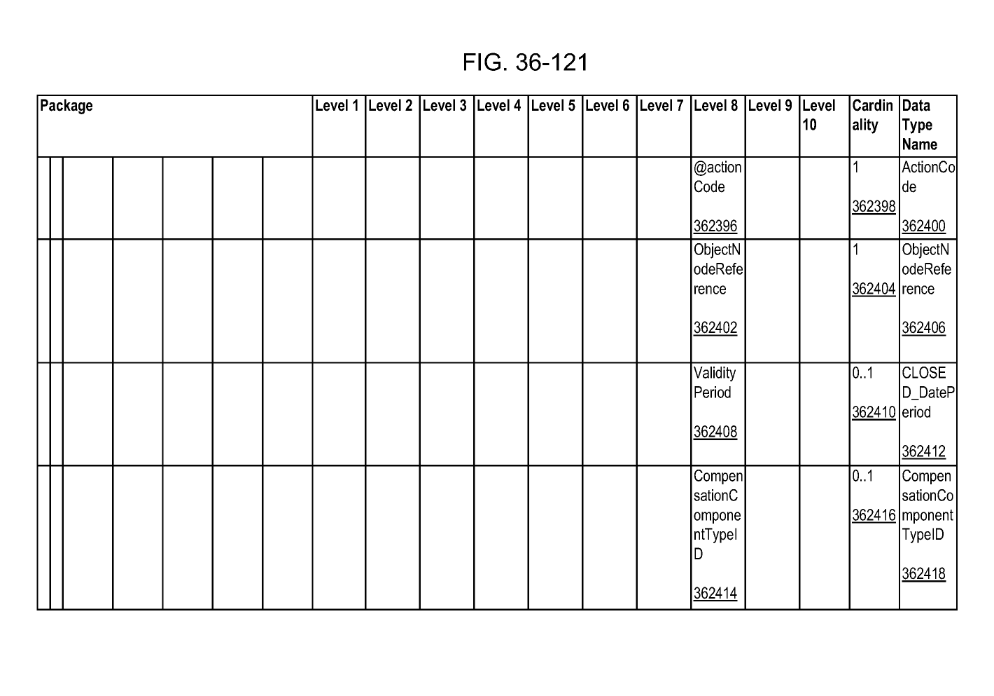

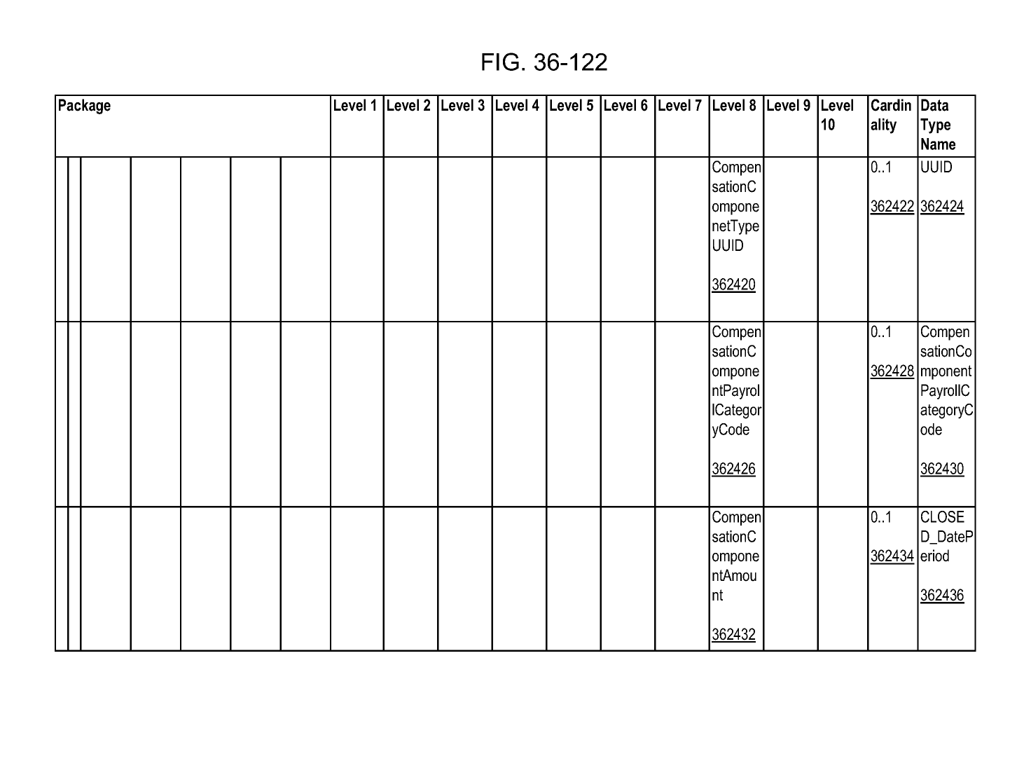

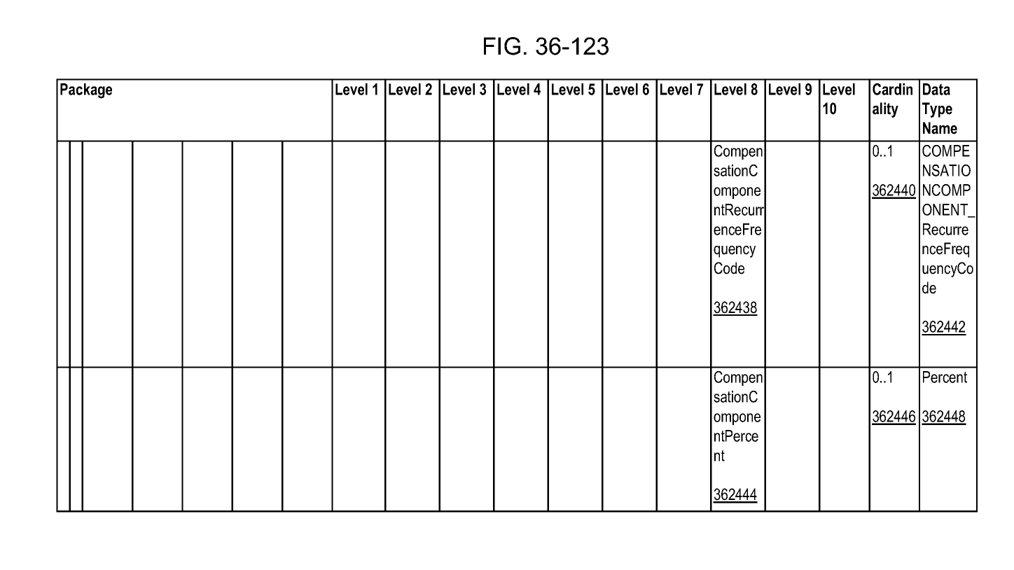

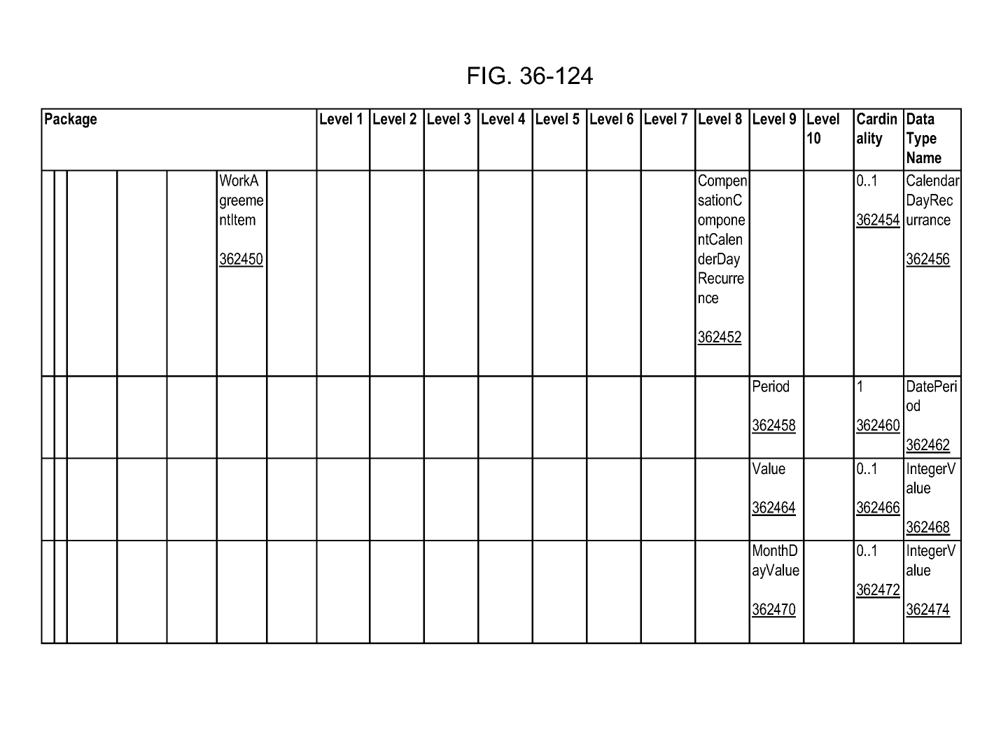

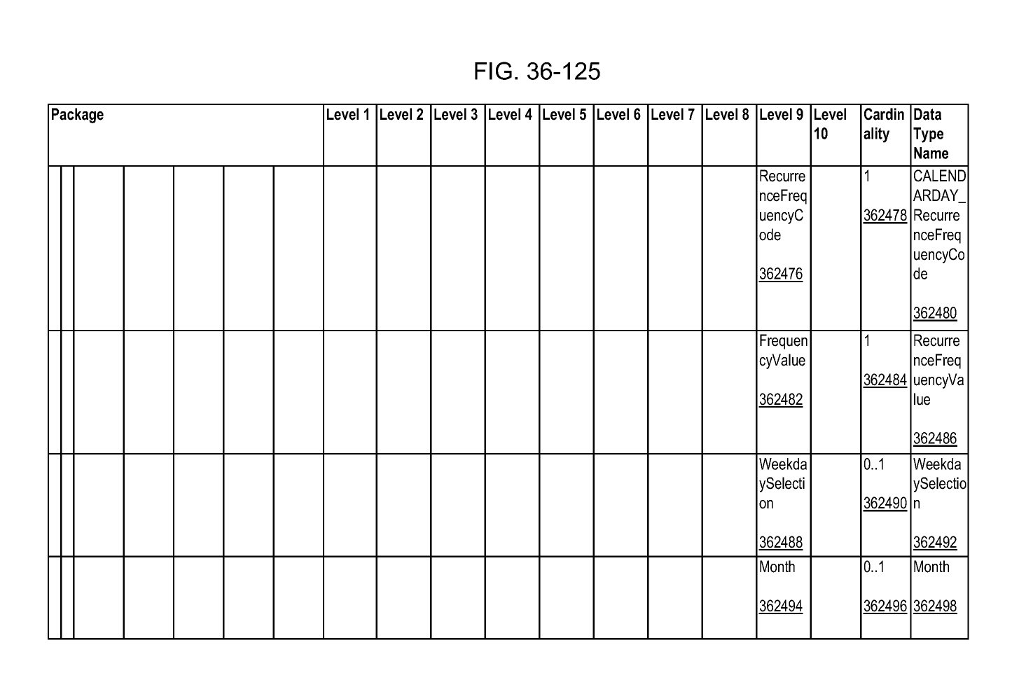

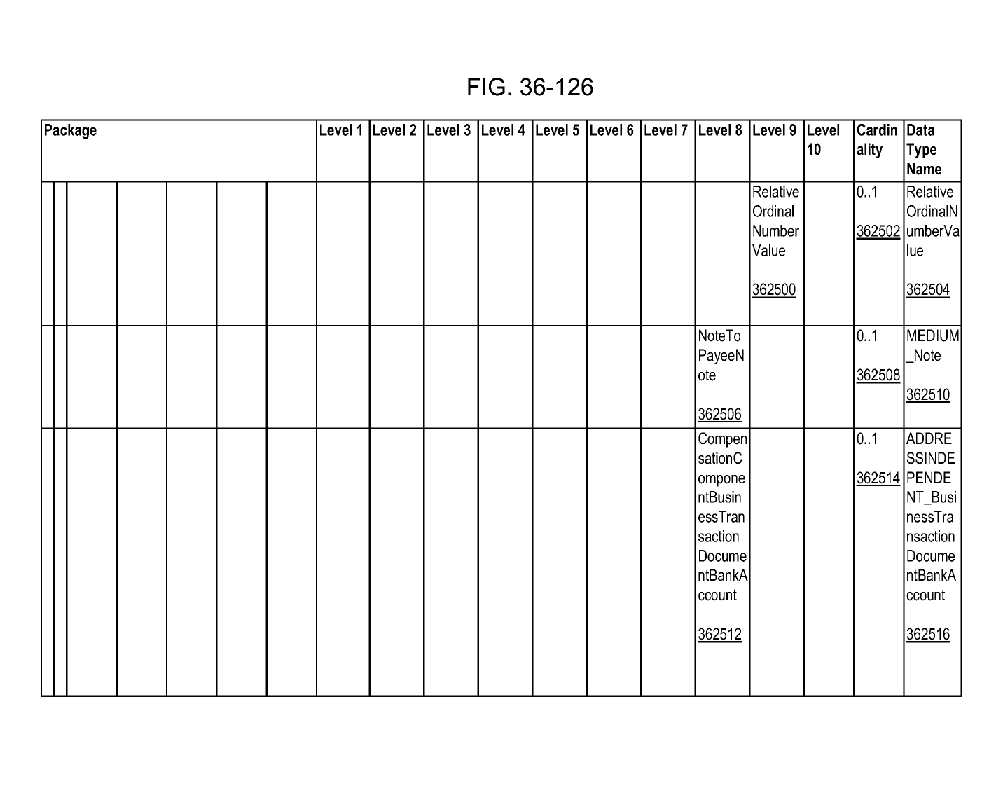

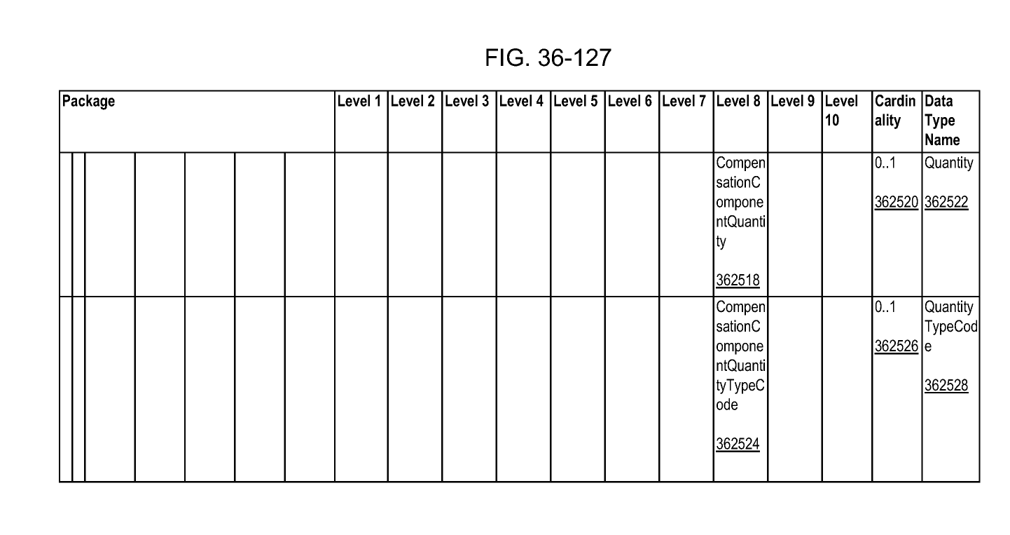

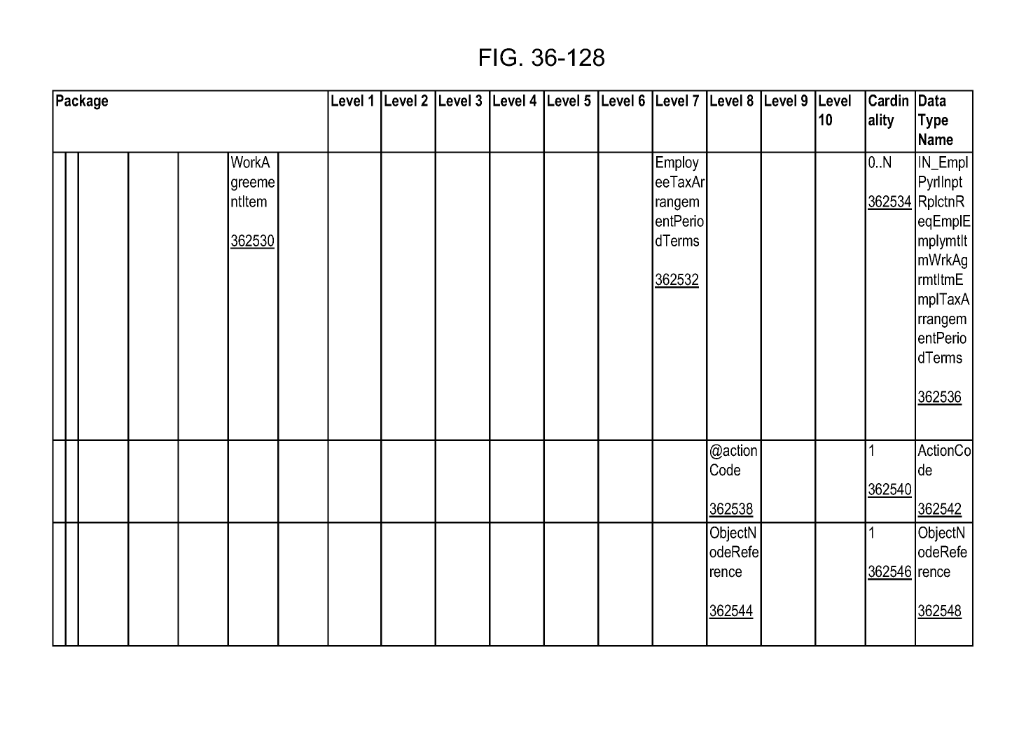

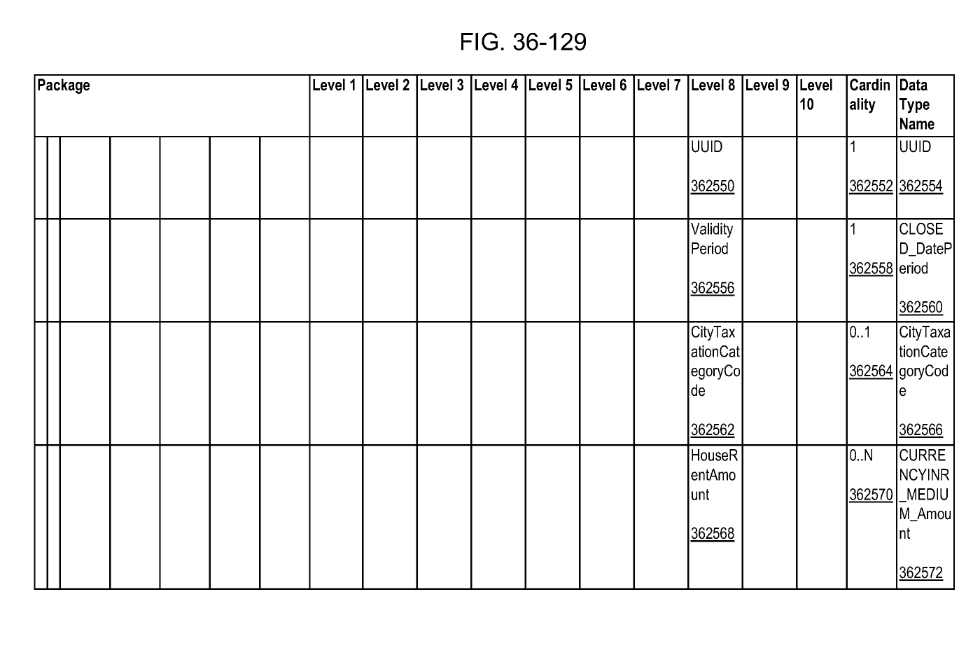

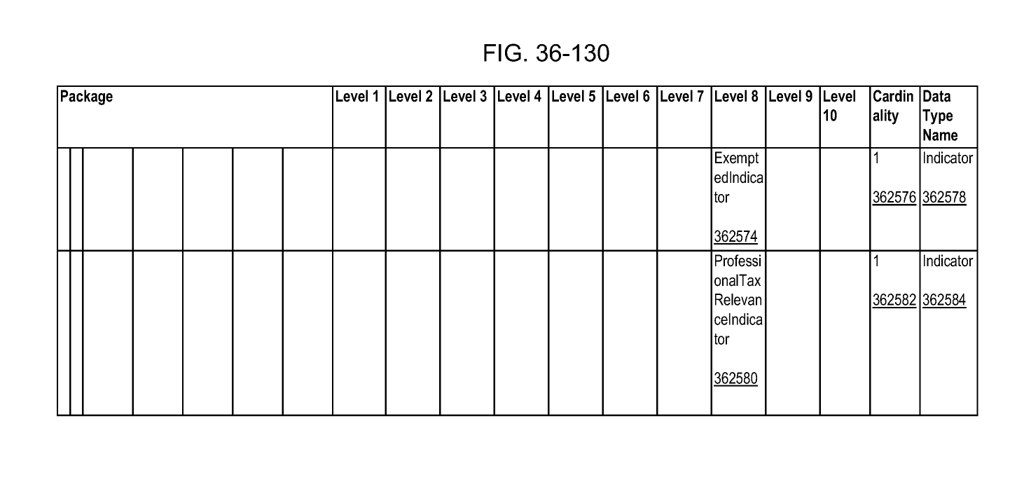

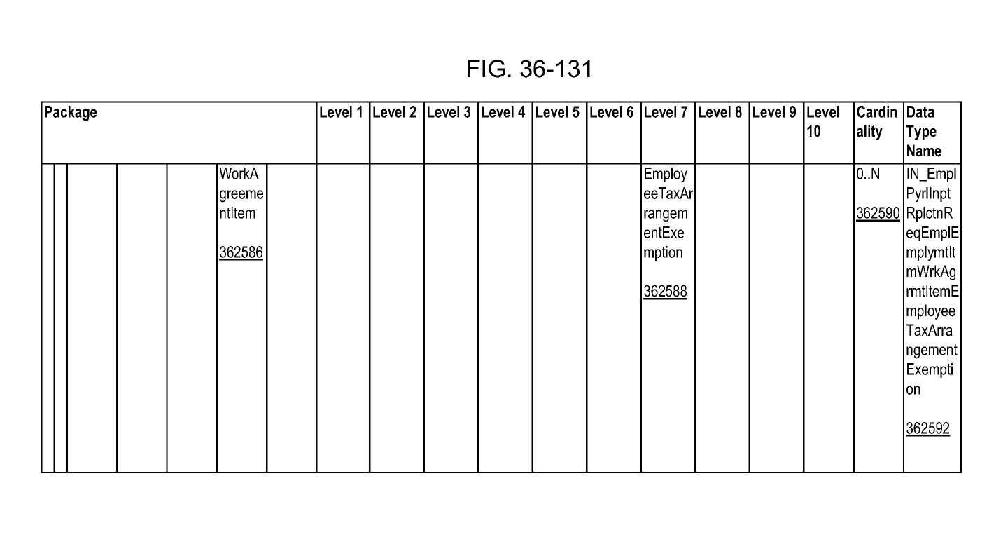

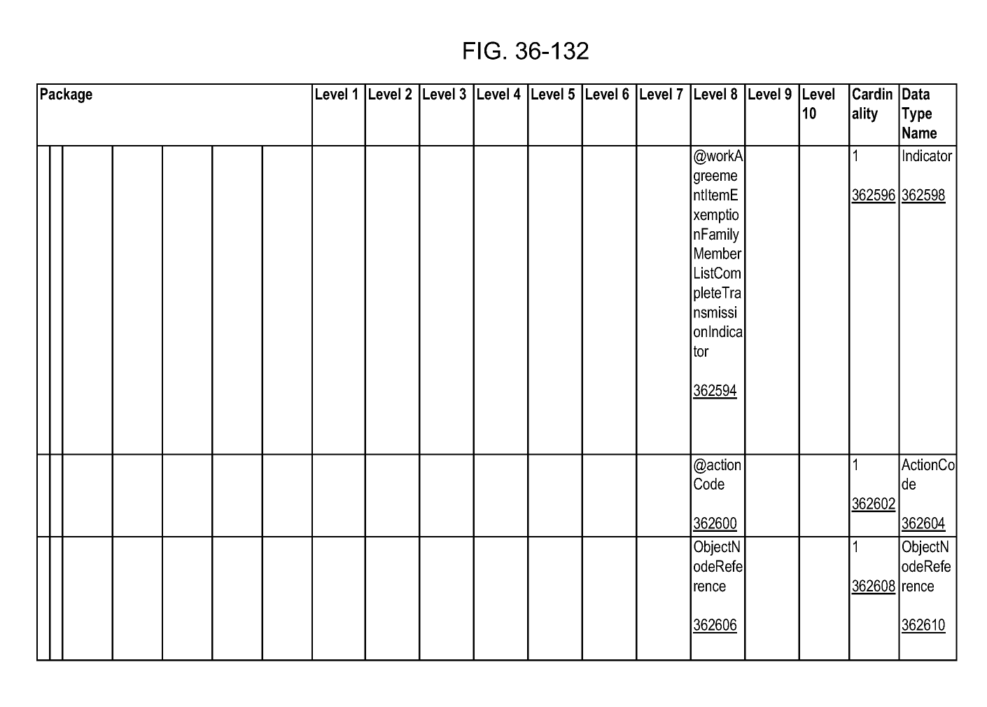

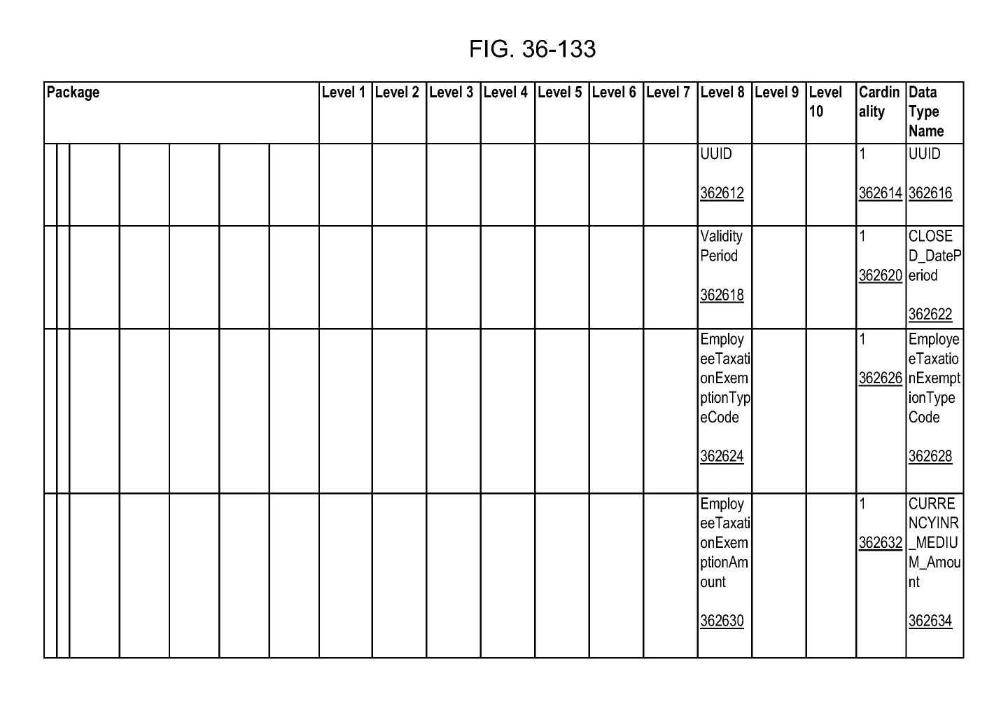

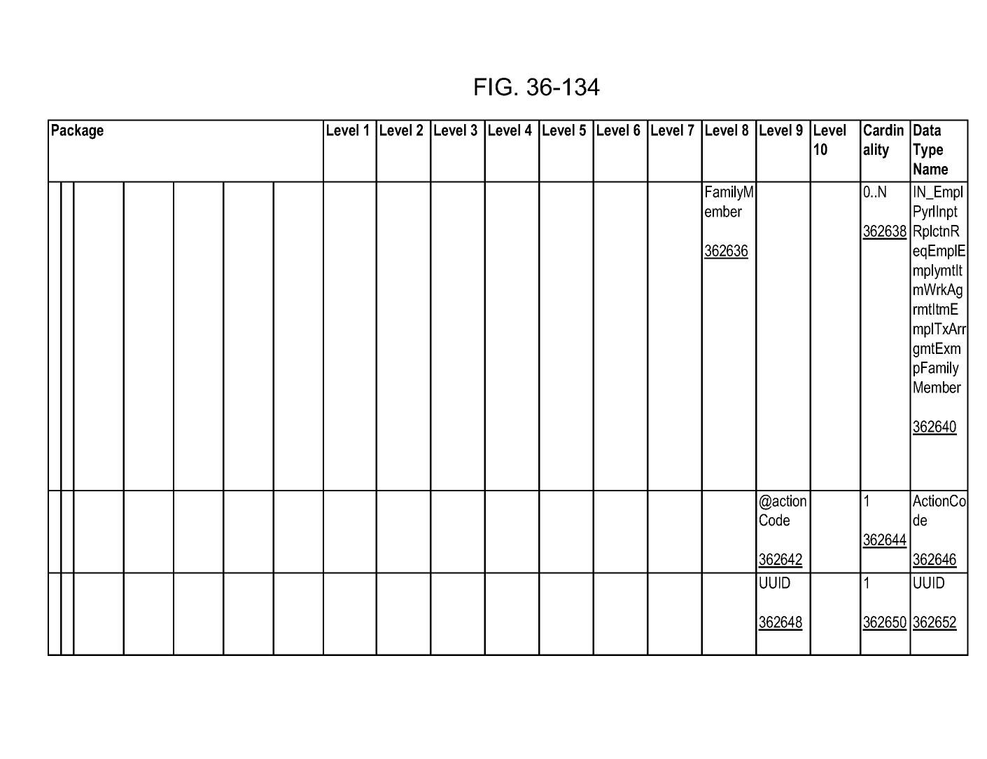

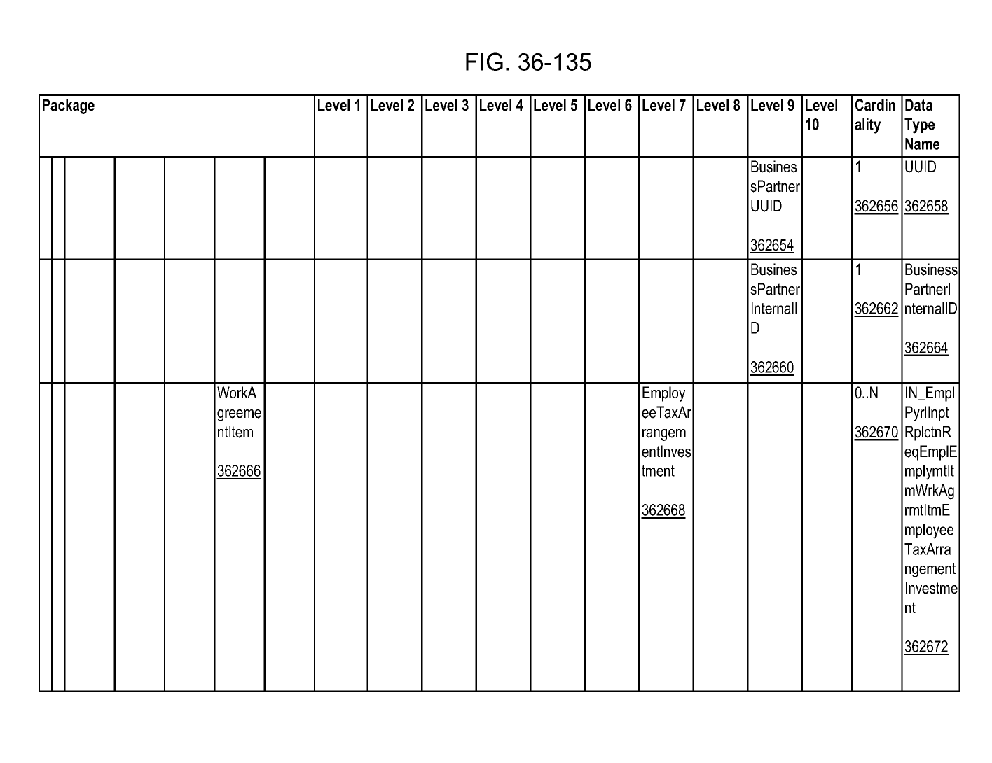

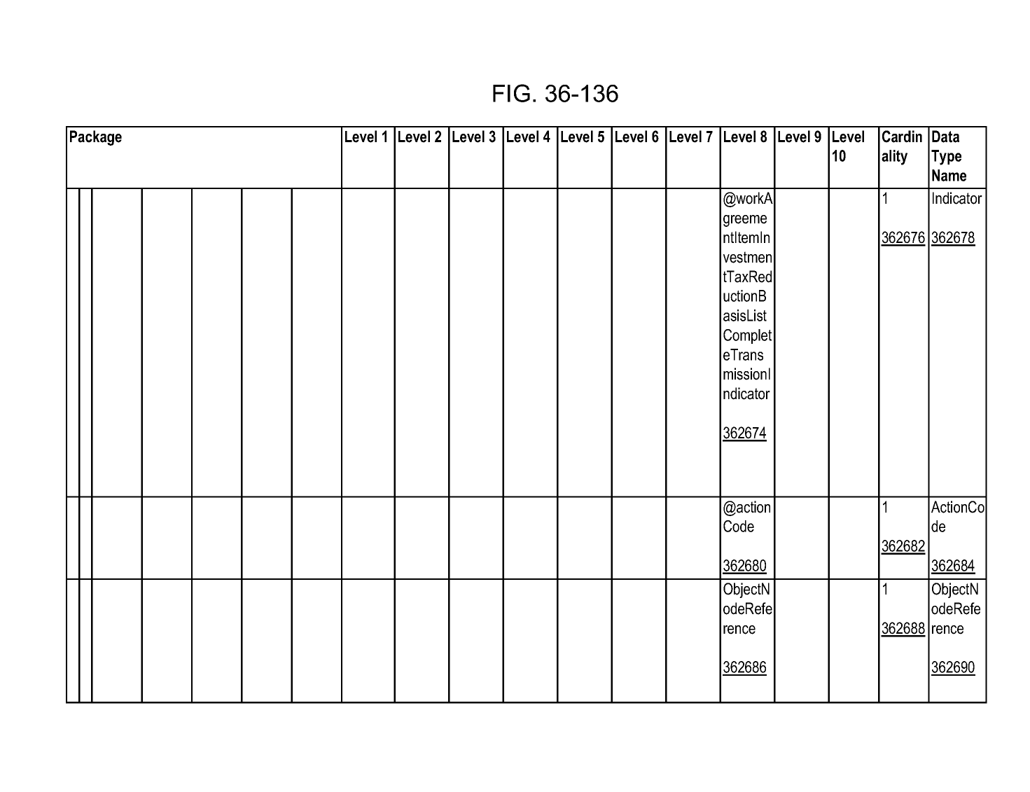

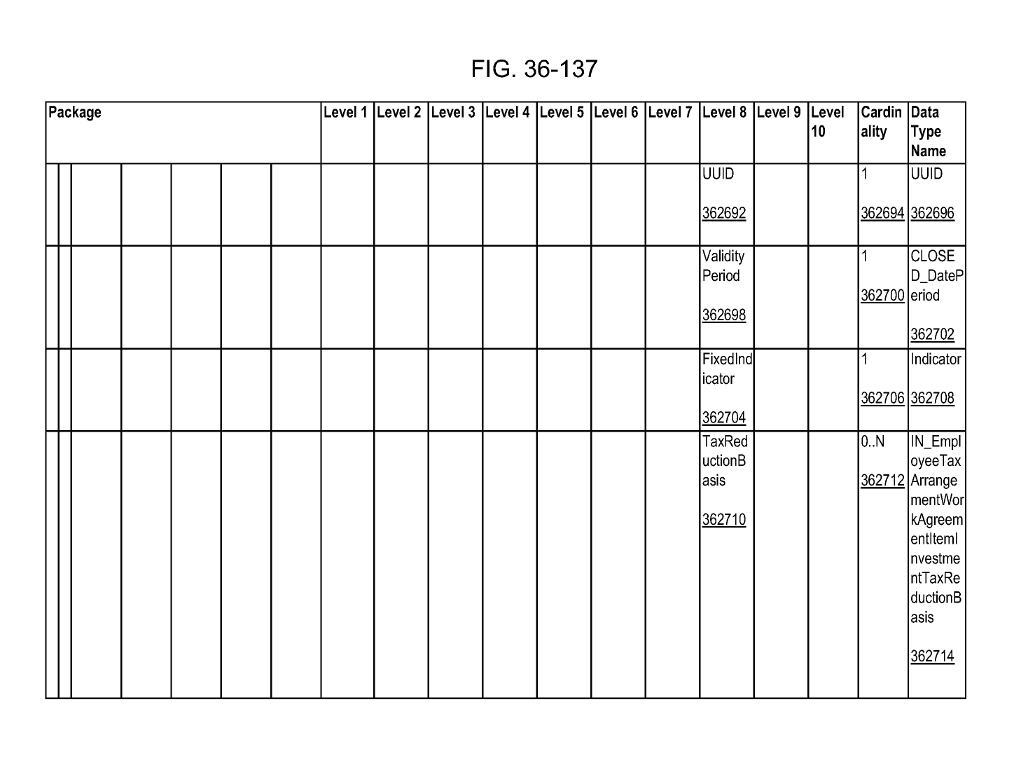

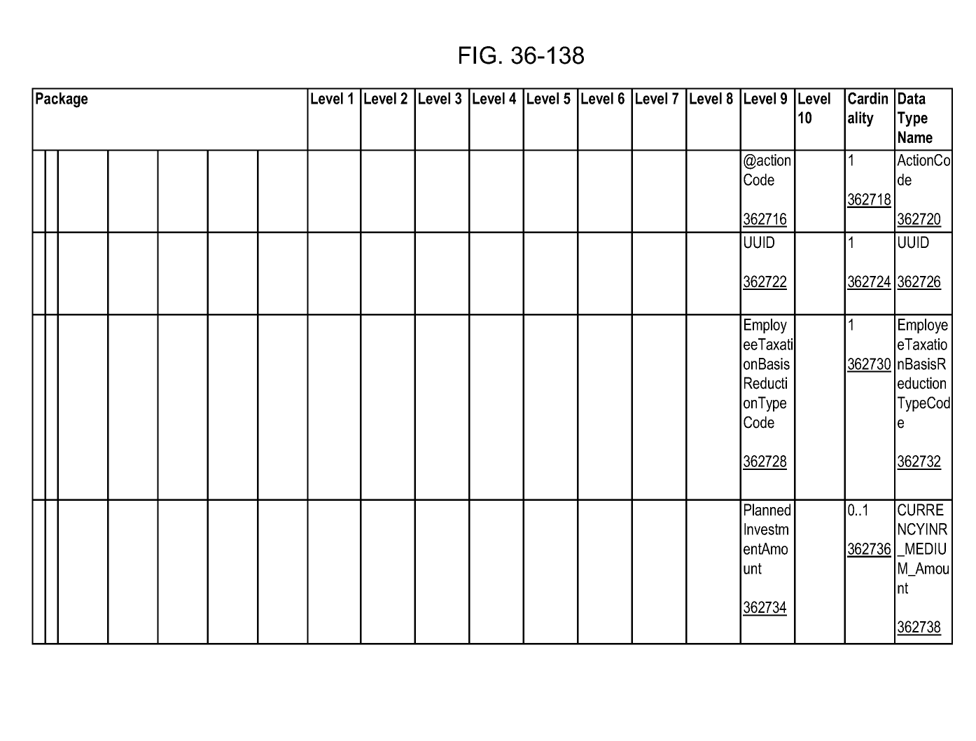

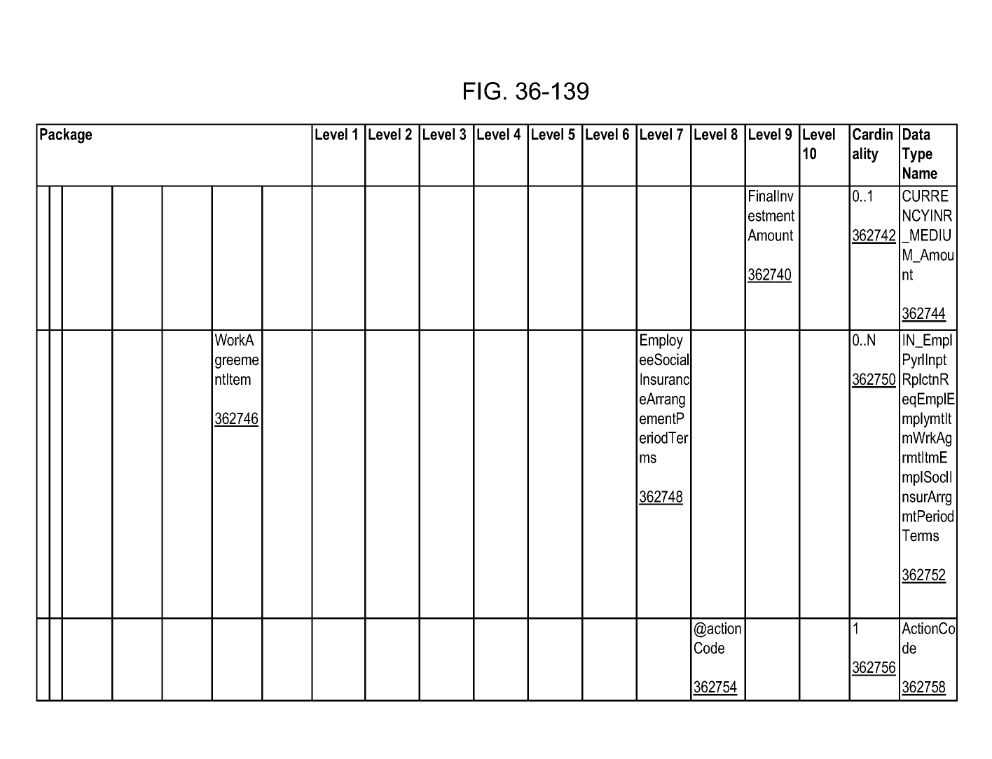

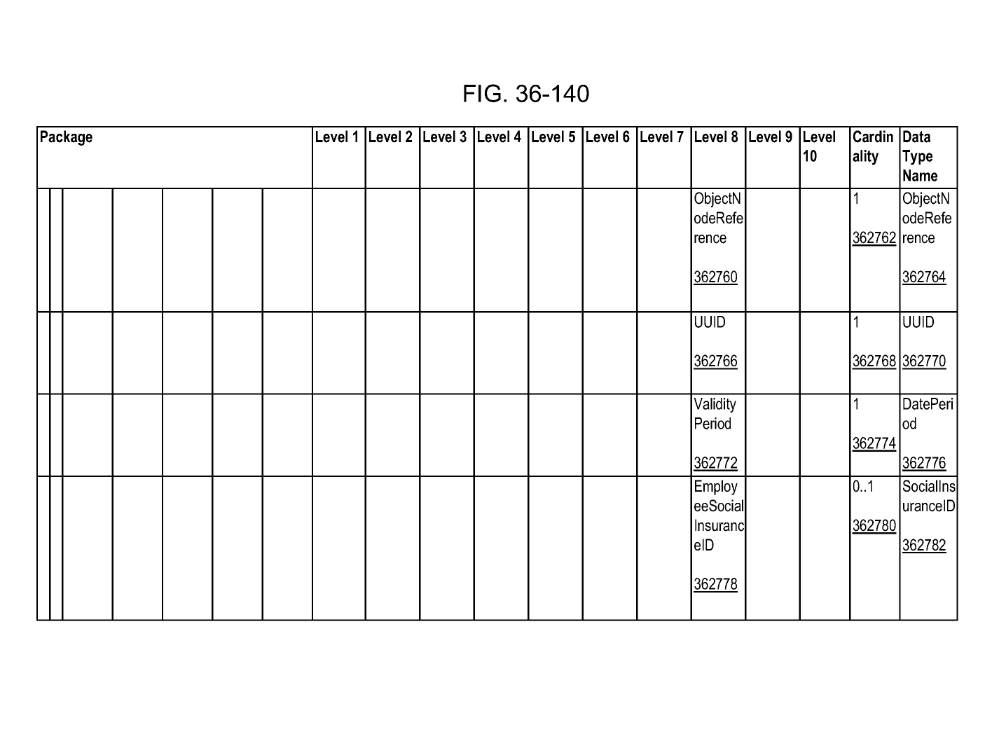

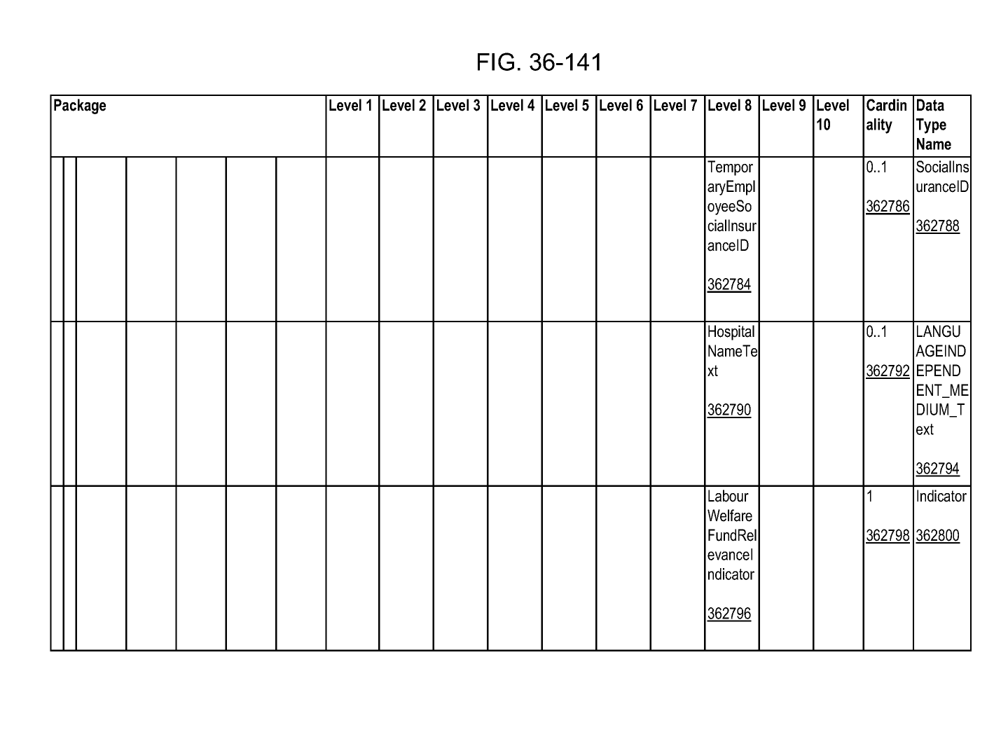

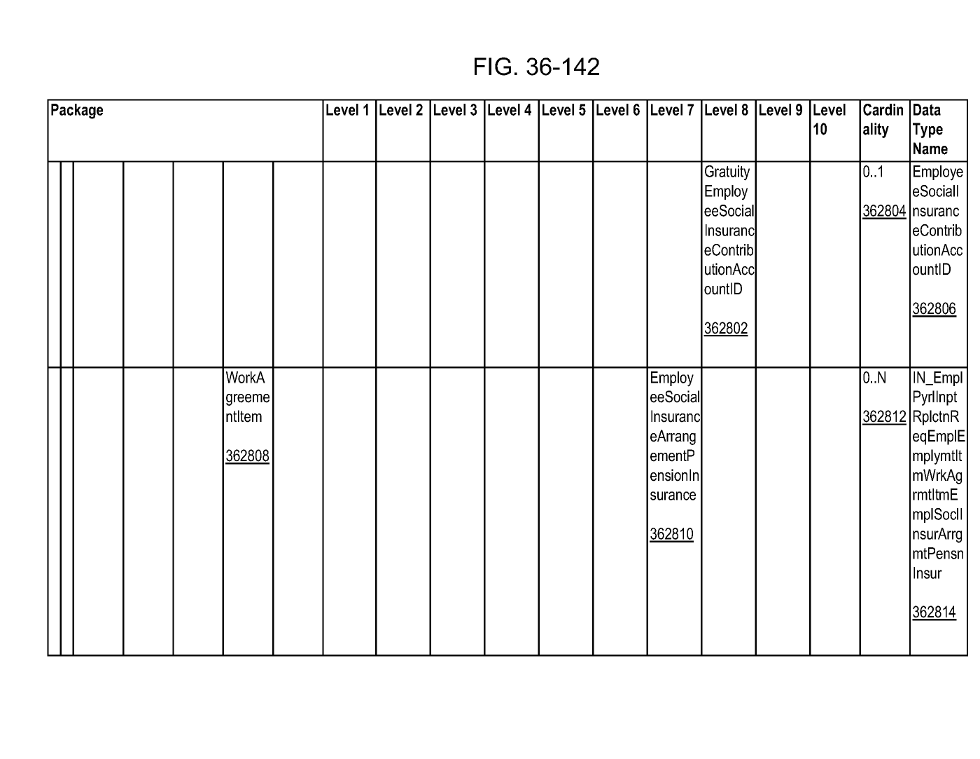

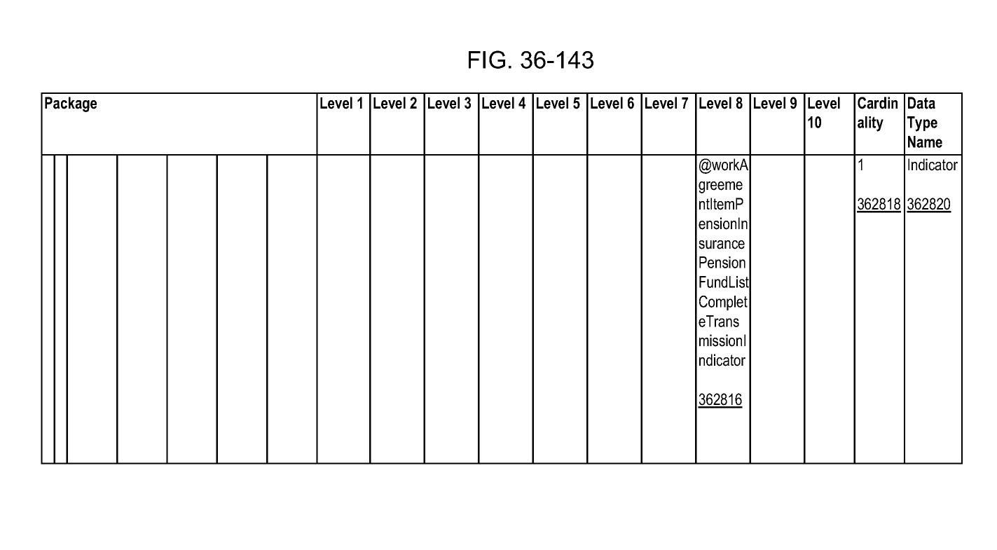

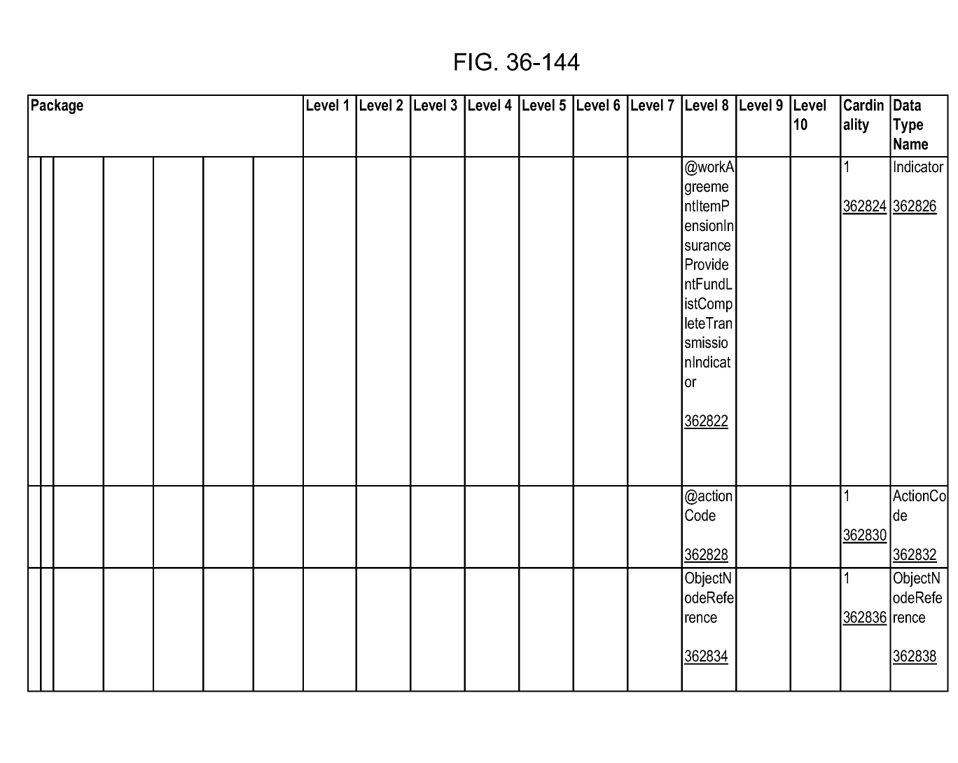

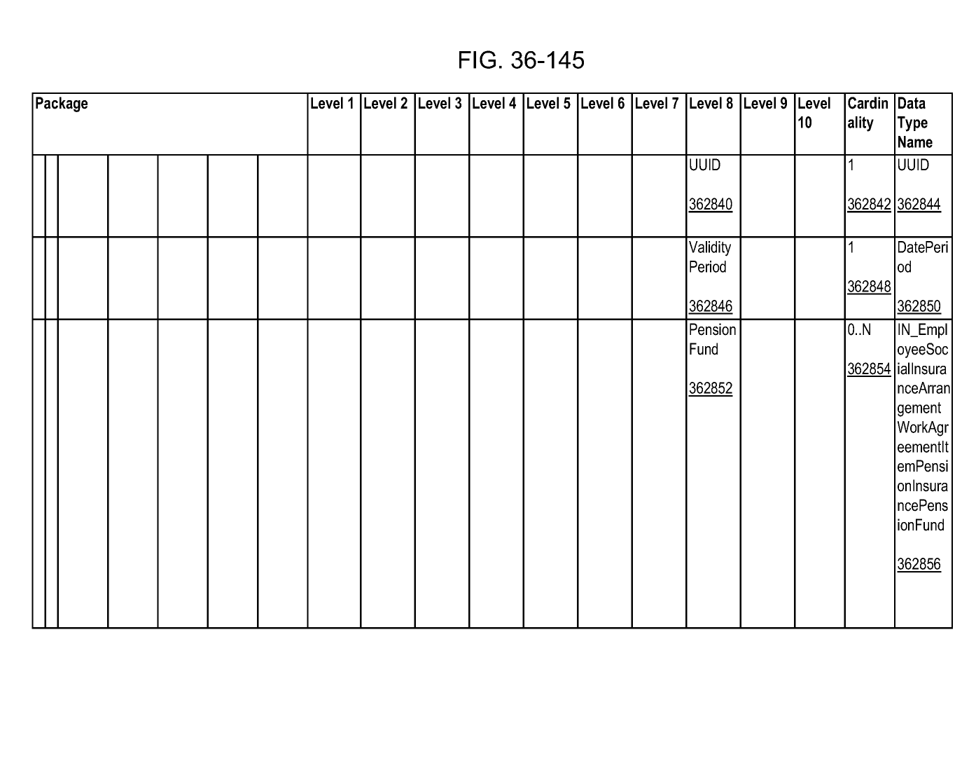

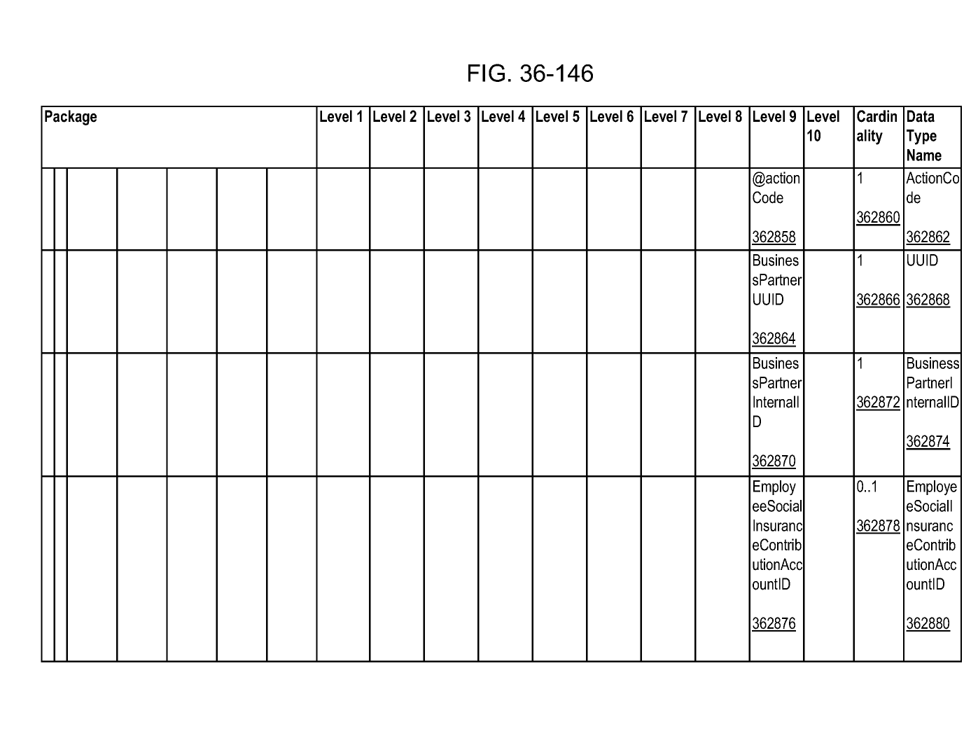

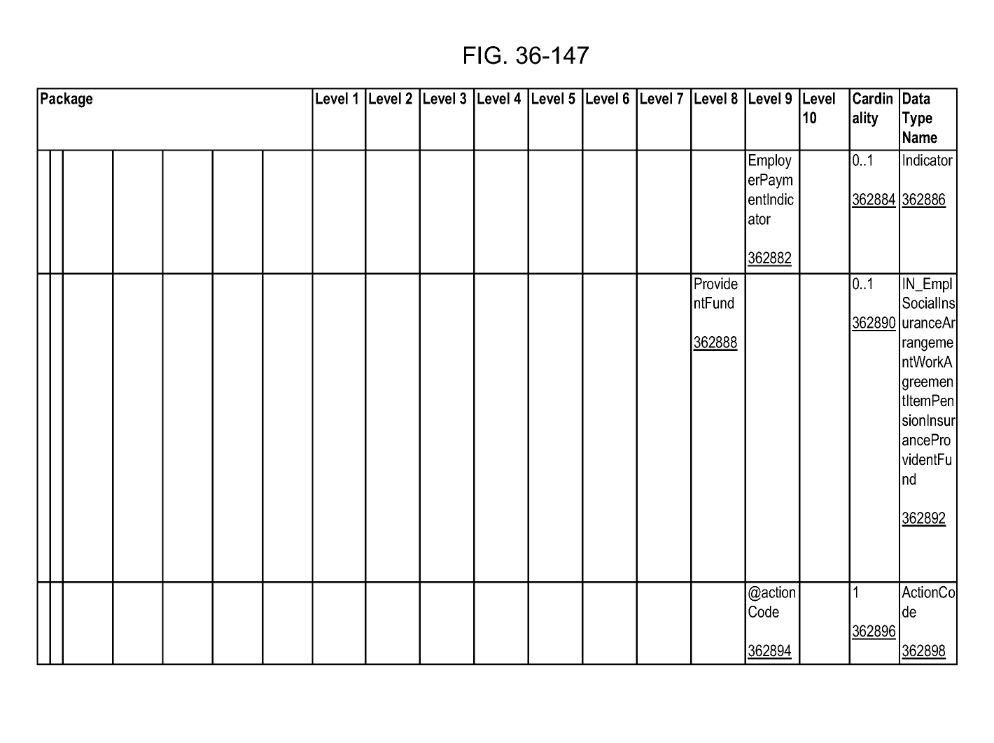

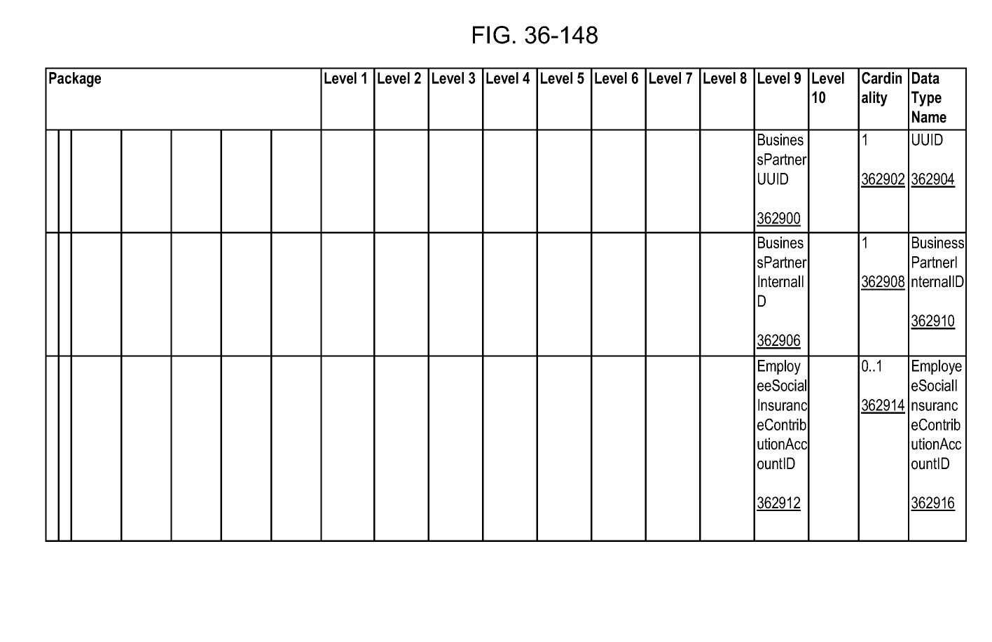

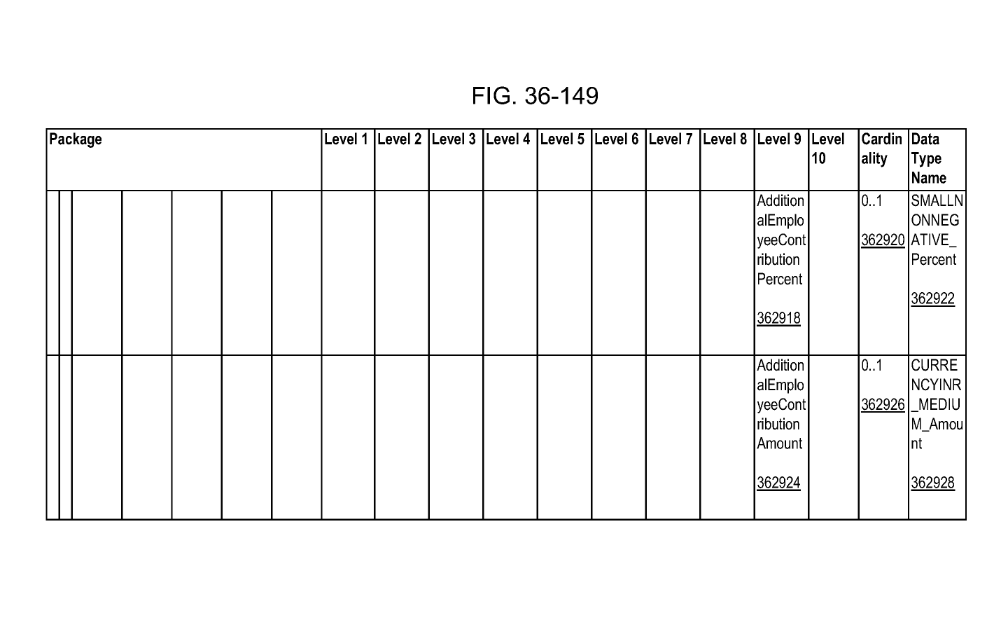

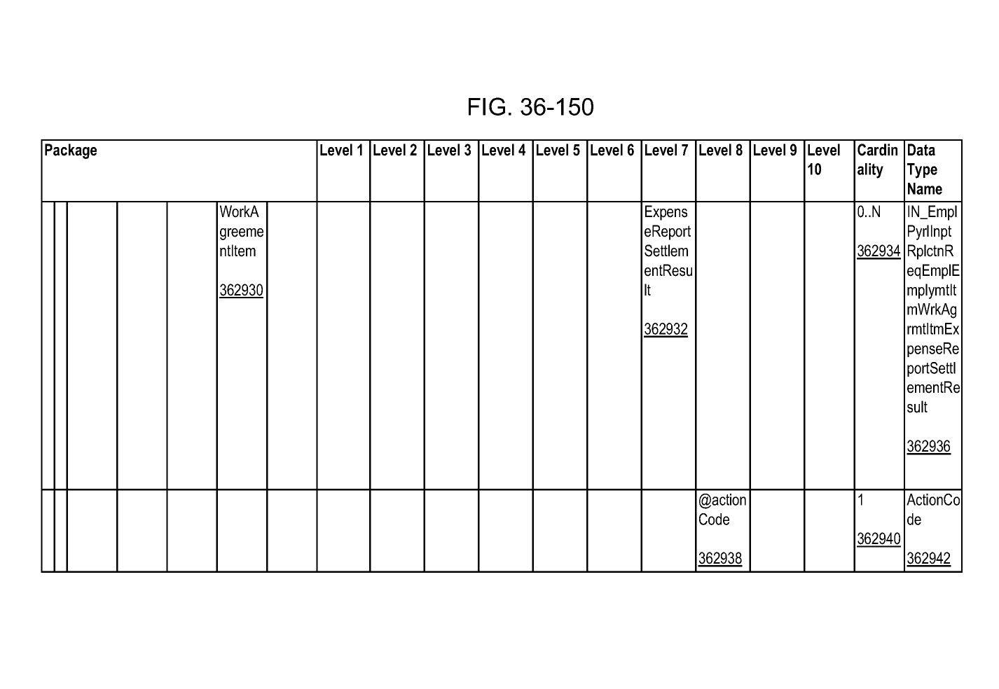

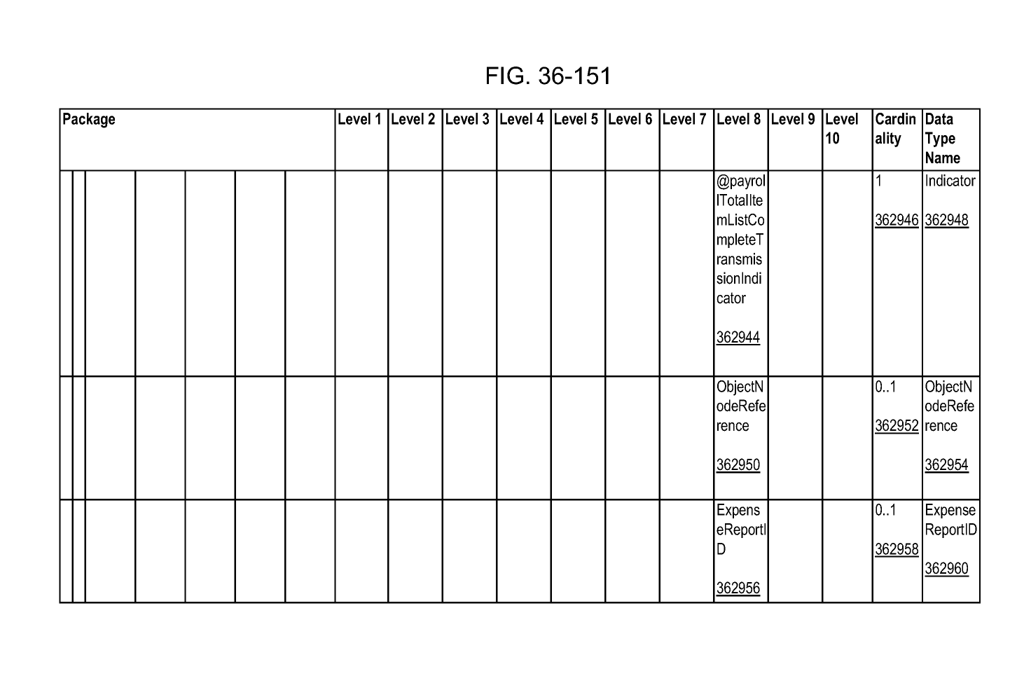

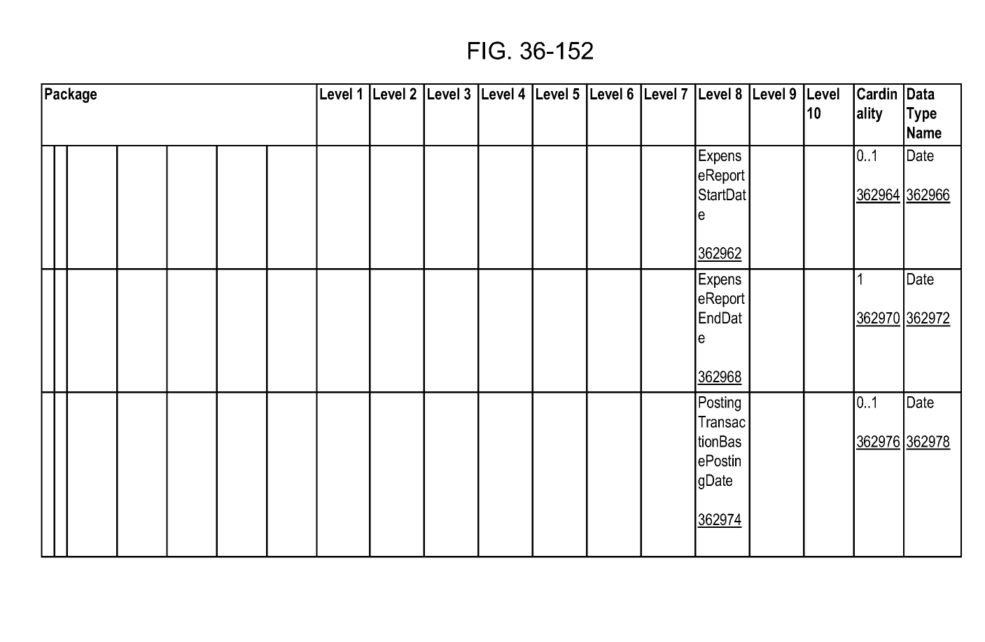

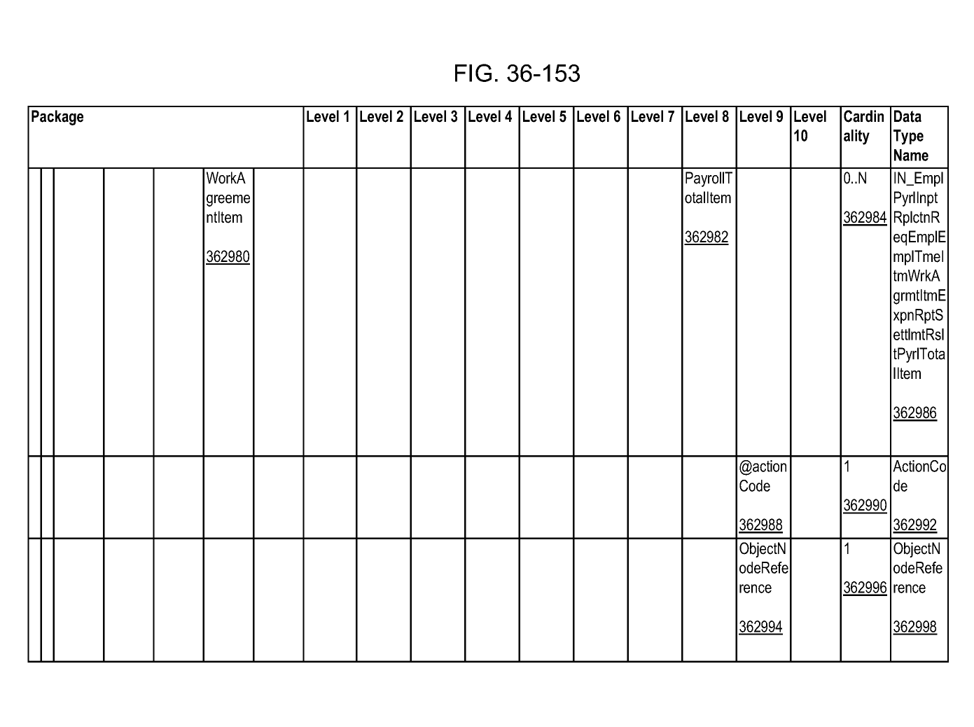

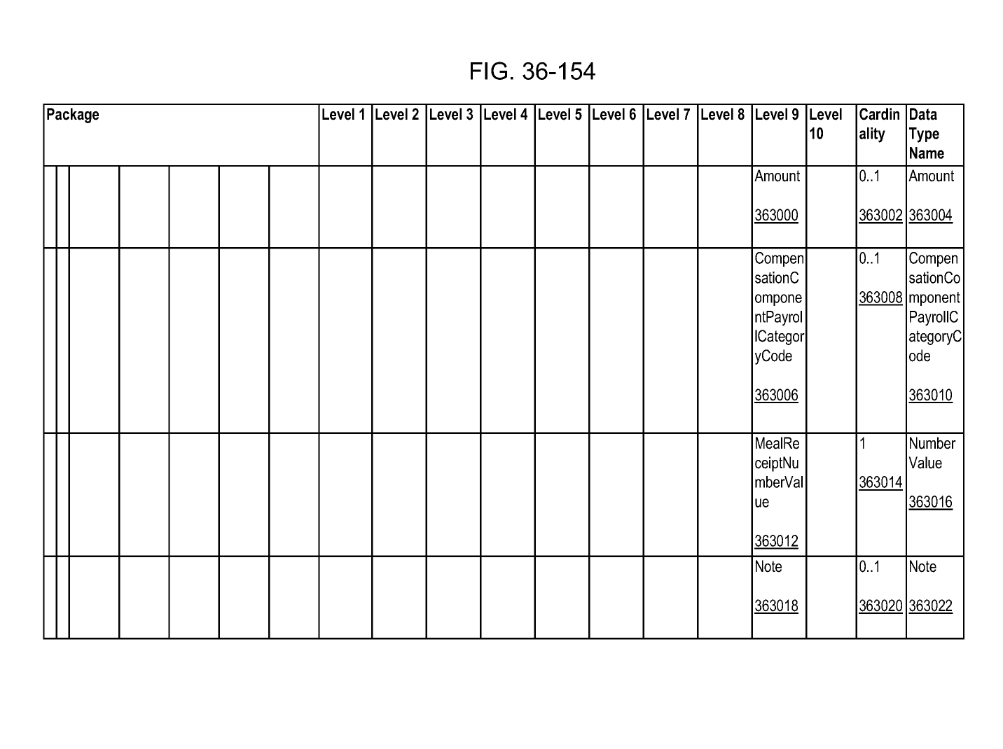

FIGS. 36-1 through 36-154 show an example configuration of an Element Structure that includes an IN_Employee Payroll Input Collection Replication Request 360000 package. Specifically, these figures depict the arrangement and hierarchy of various components such as one or more levels of packages, entities, and datatypes, shown here as 360000 through 363022. As described above, packages may be used to represent hierarchy levels. Entities are discrete business elements that are used during a business transaction. Data types are used to type object entities and interfaces with a structure. For example, the IN_Employee Payroll Input Collection Replication Request 360000 includes, among other things, an IN_Employee Payroll Input Collection Replication Request 360002. Accordingly, heterogeneous applications may communicate using this consistent message configured as such.

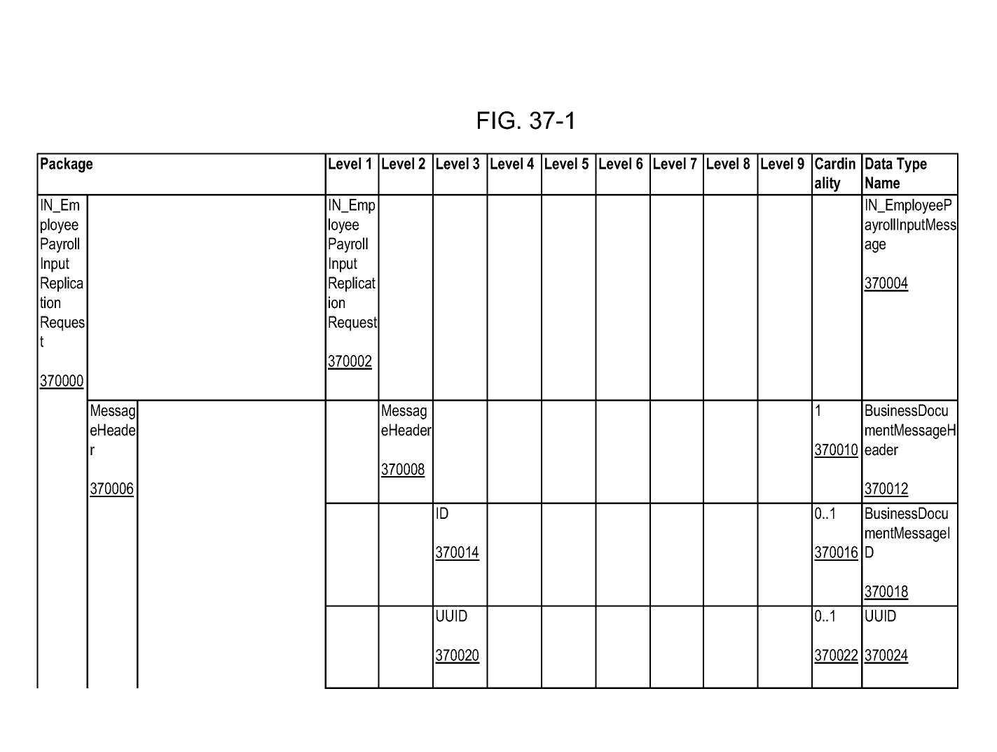

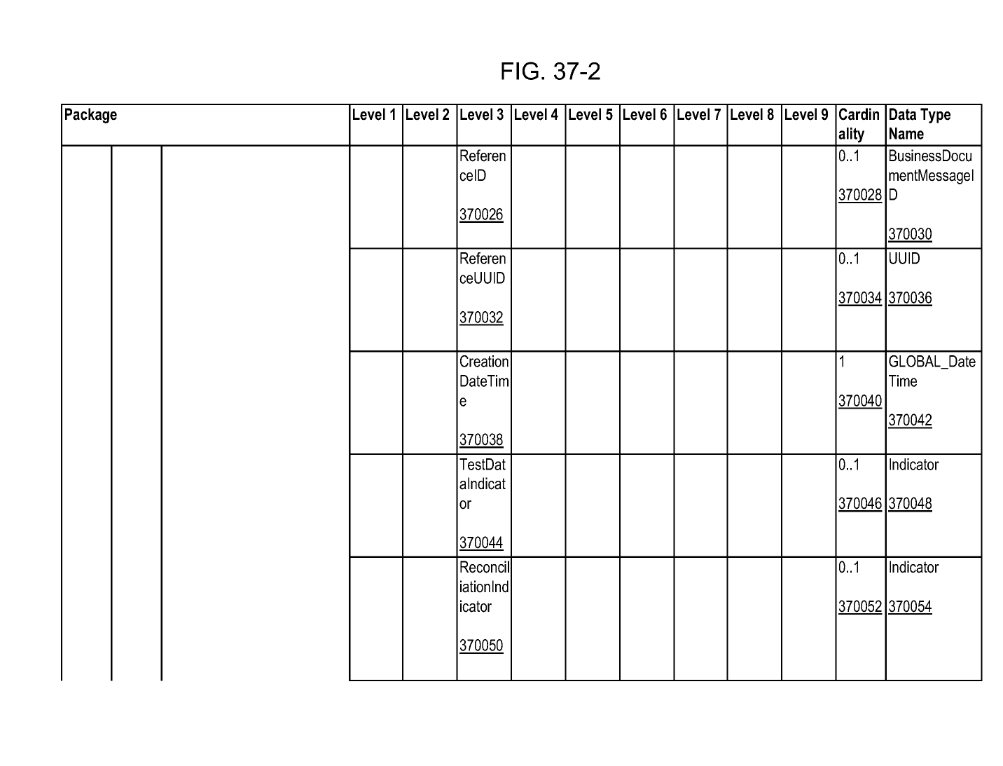

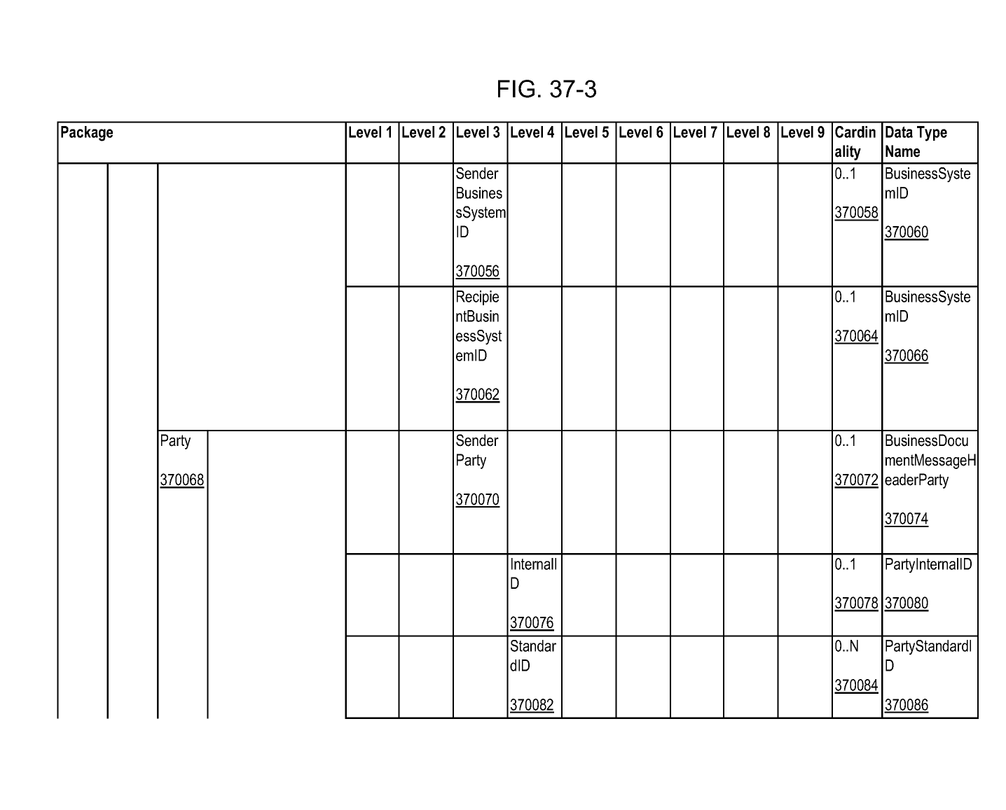

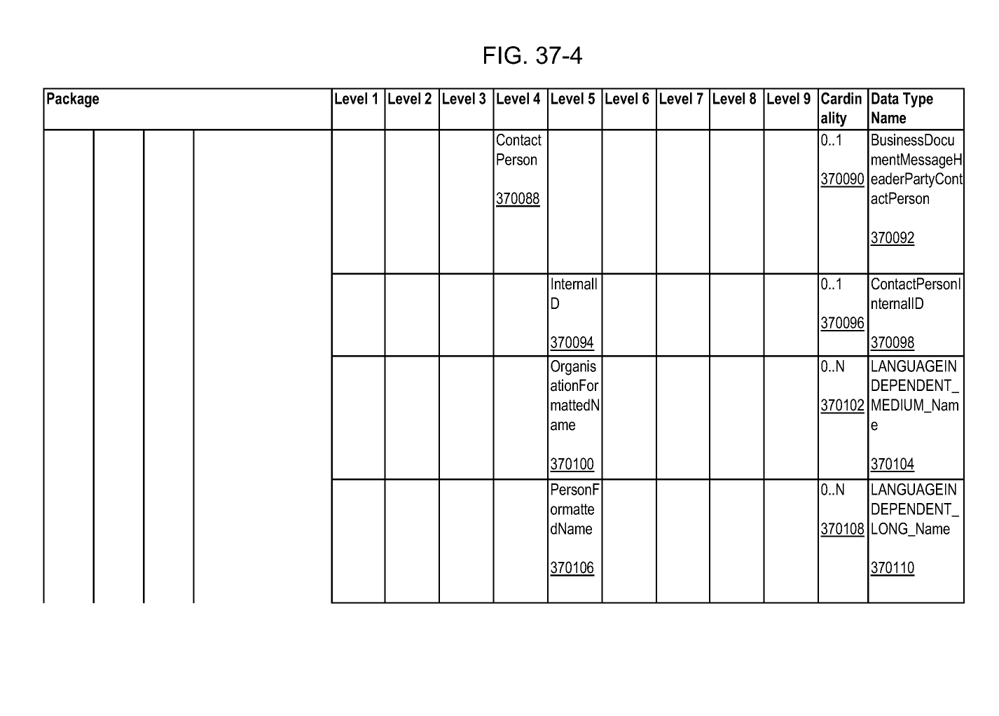

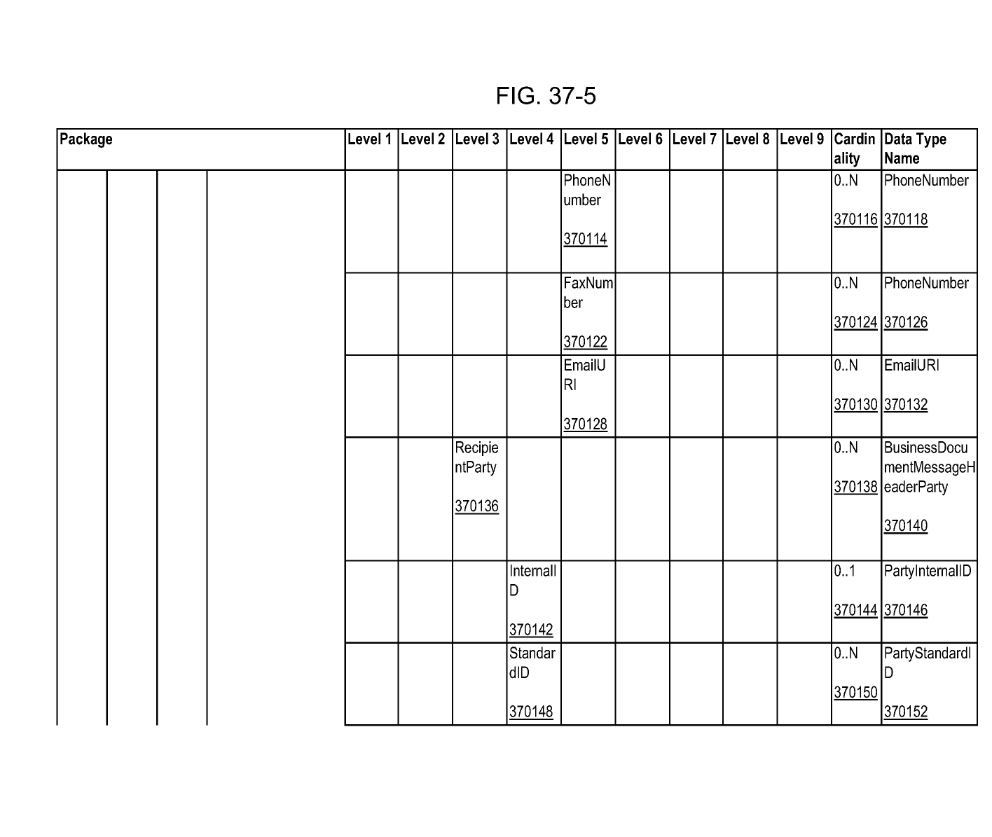

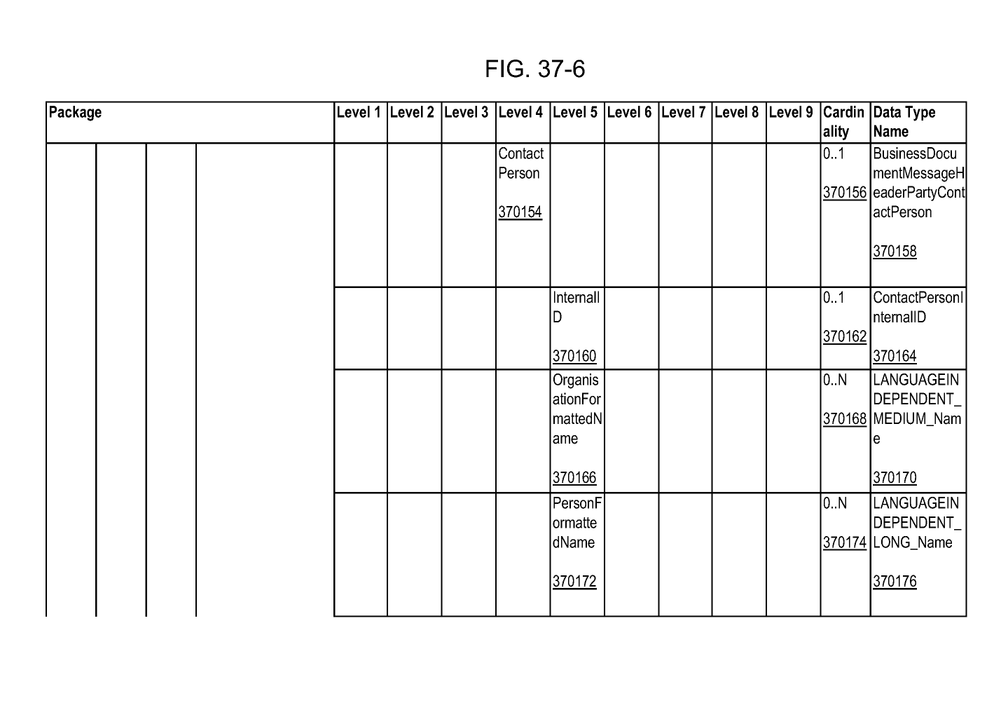

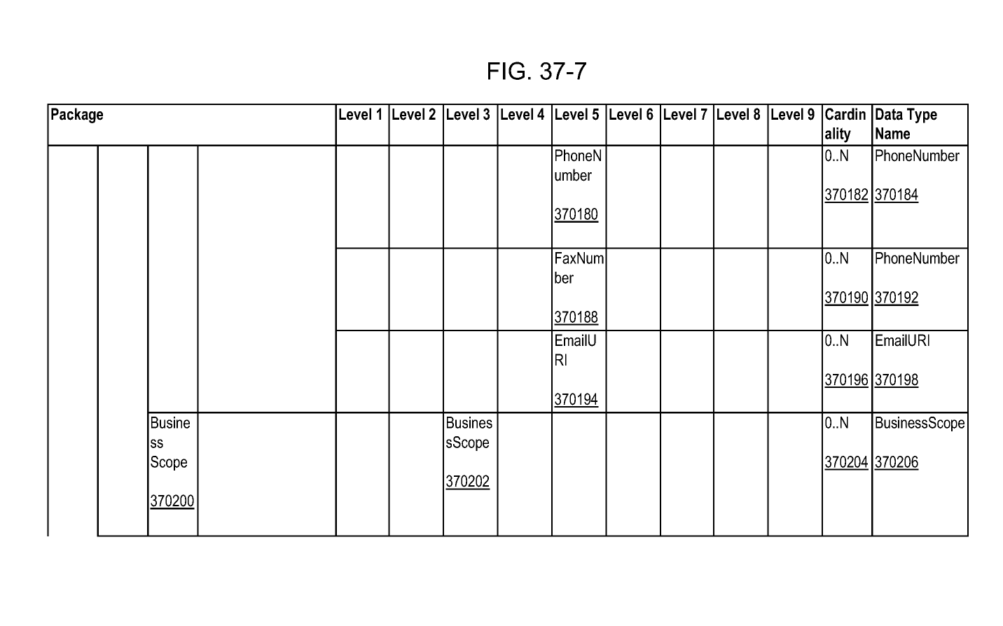

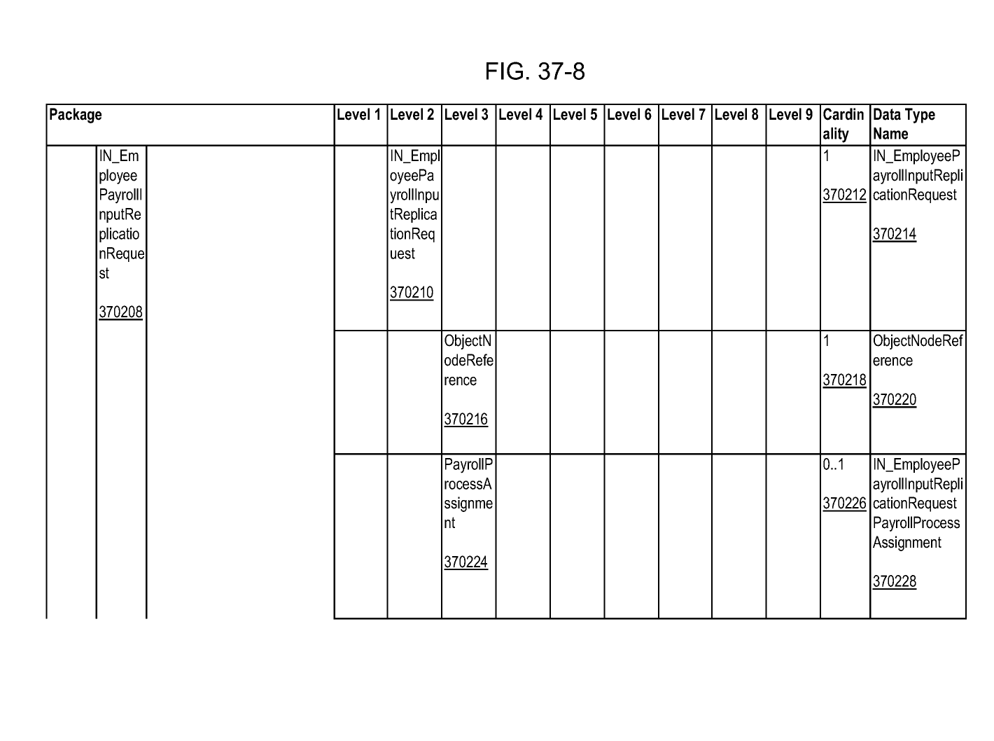

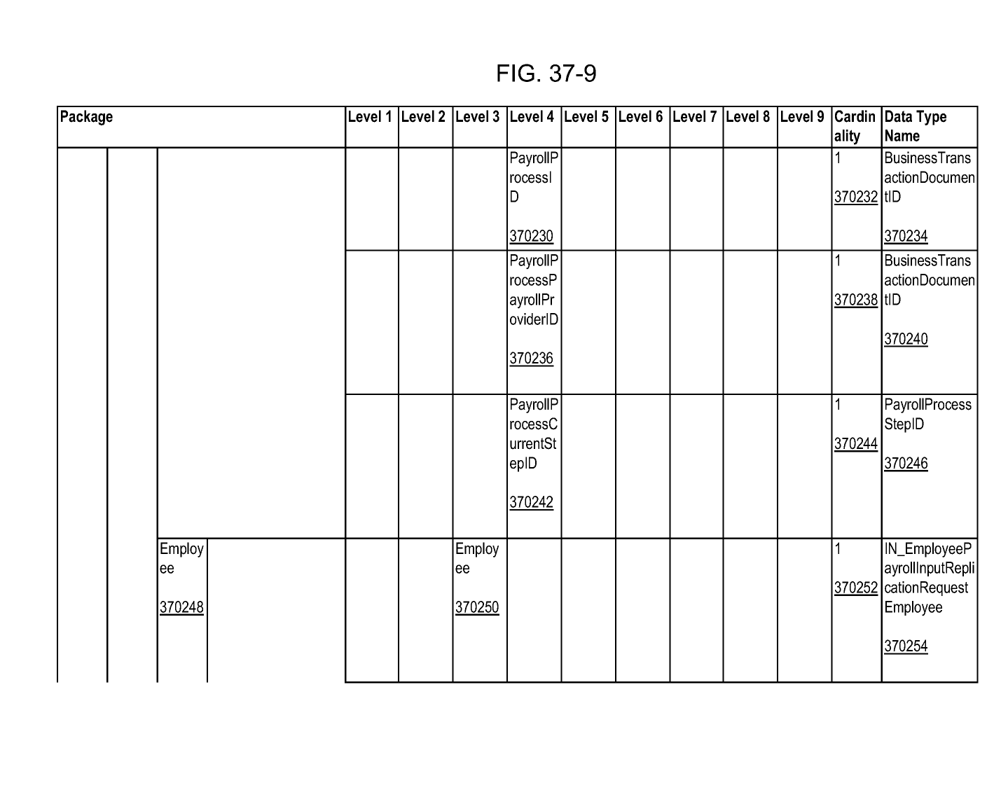

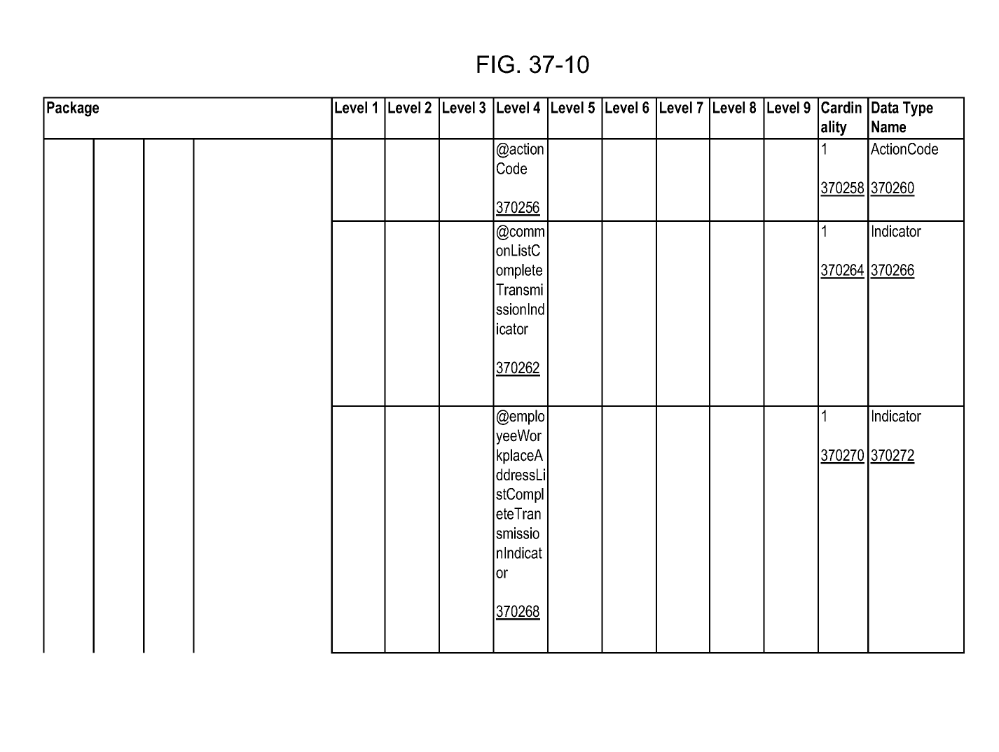

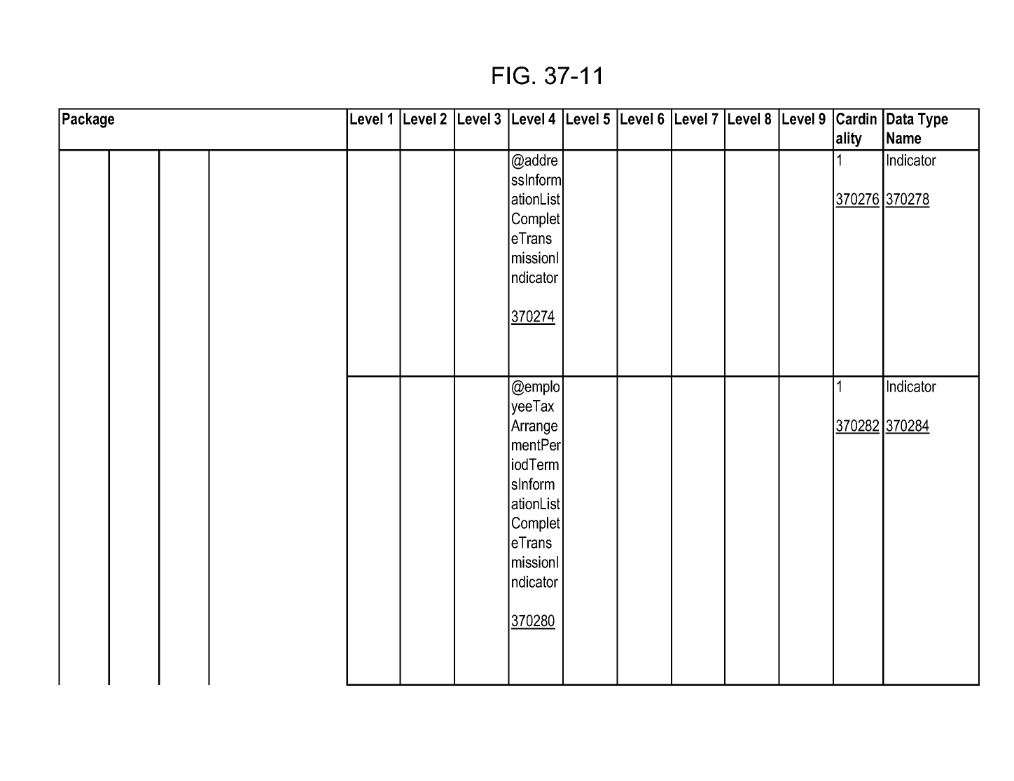

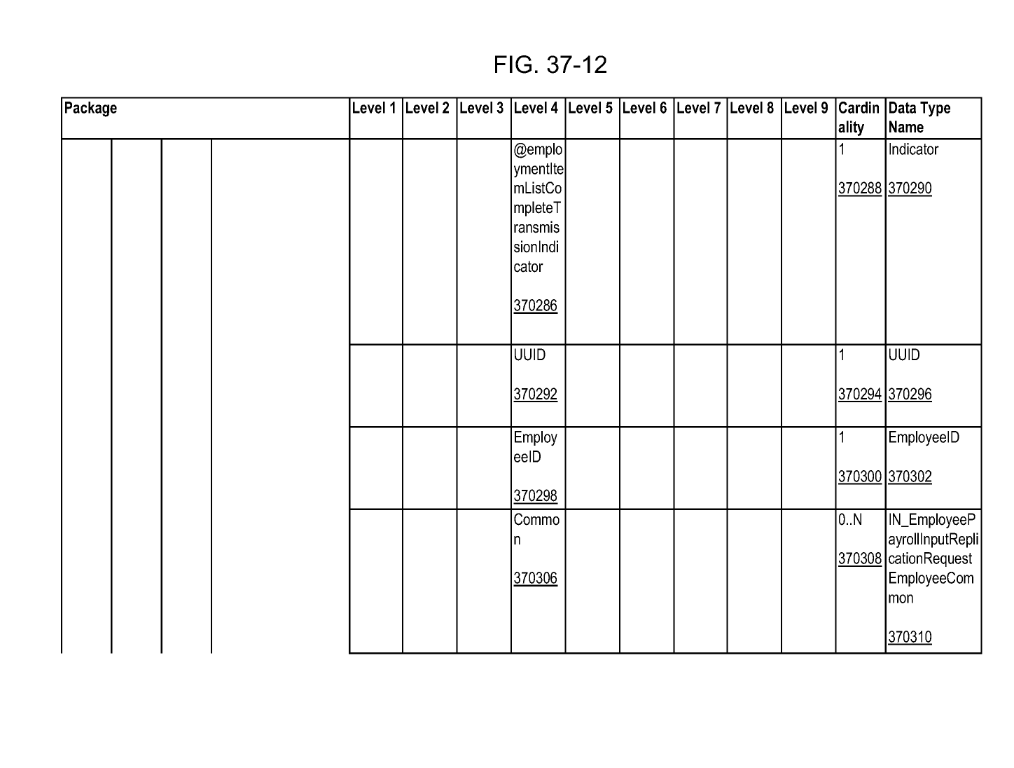

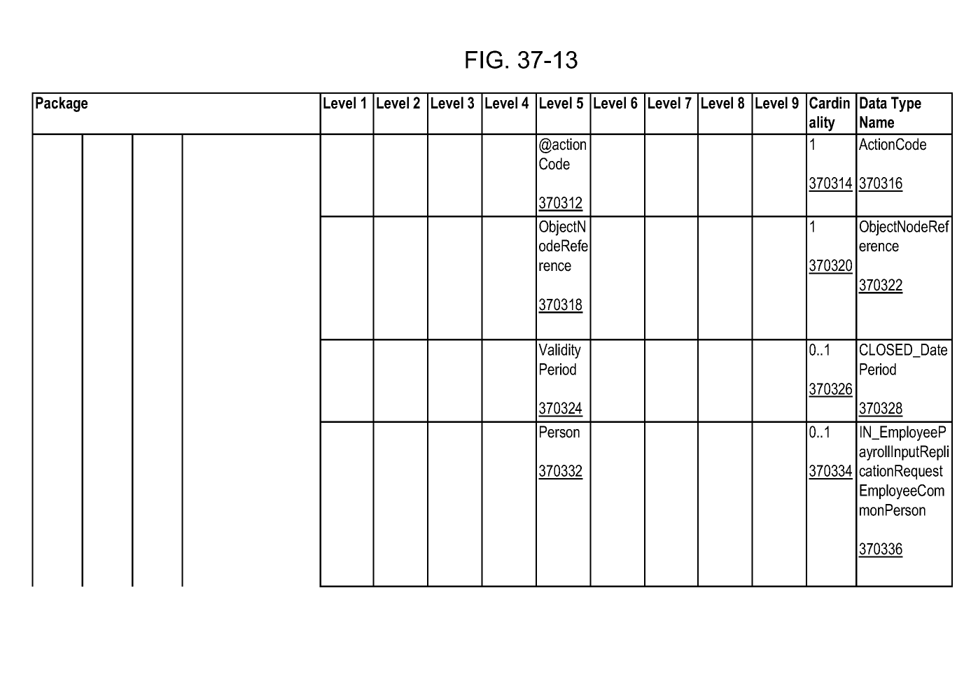

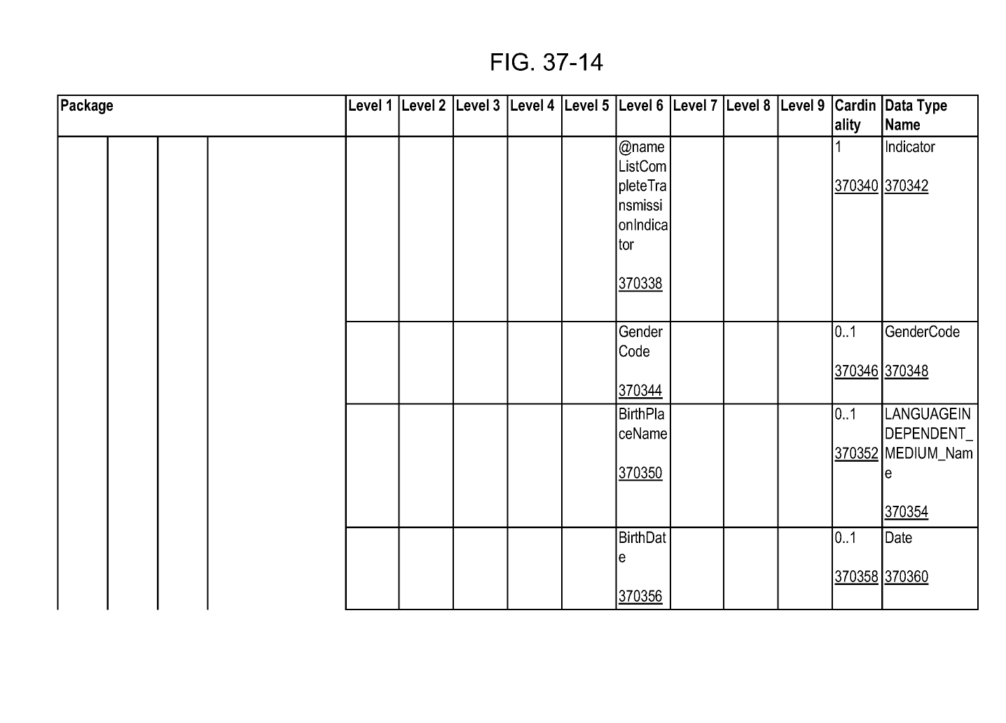

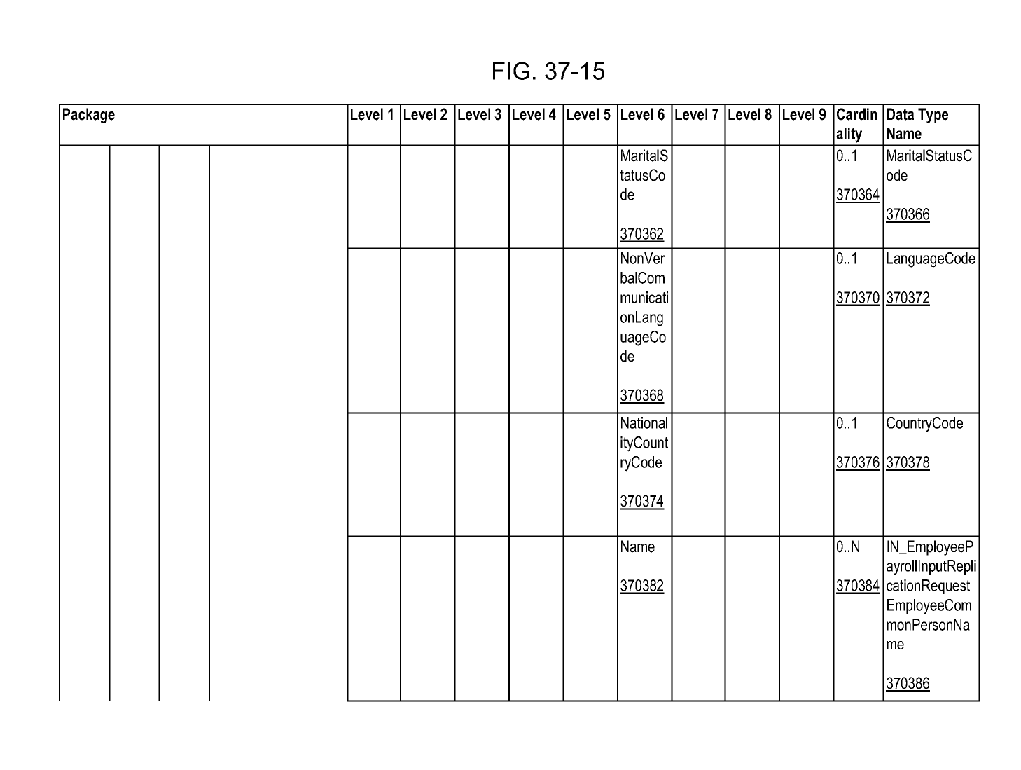

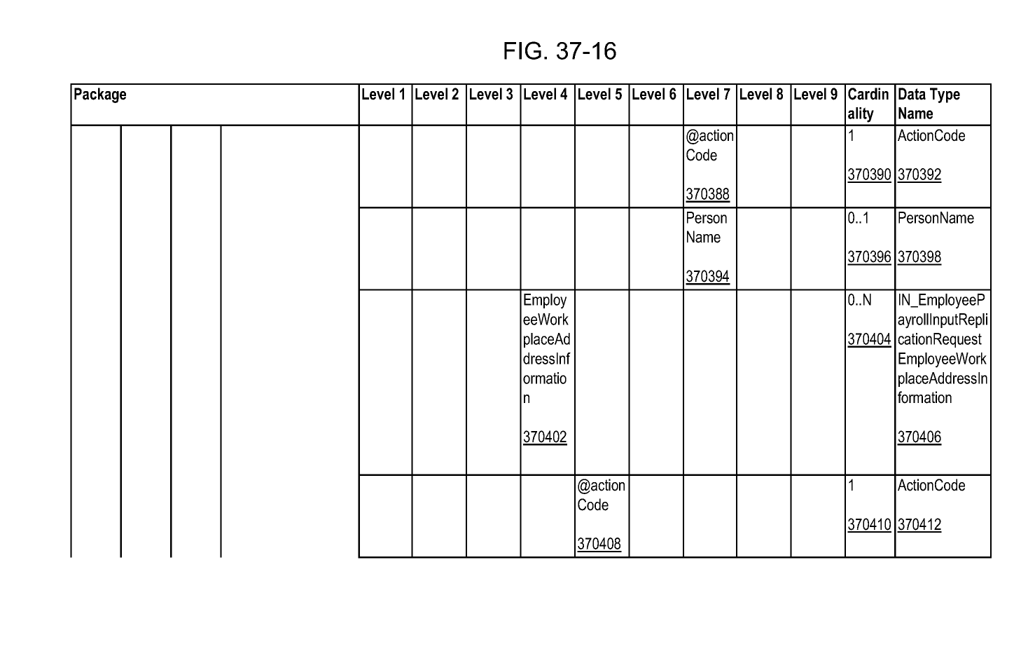

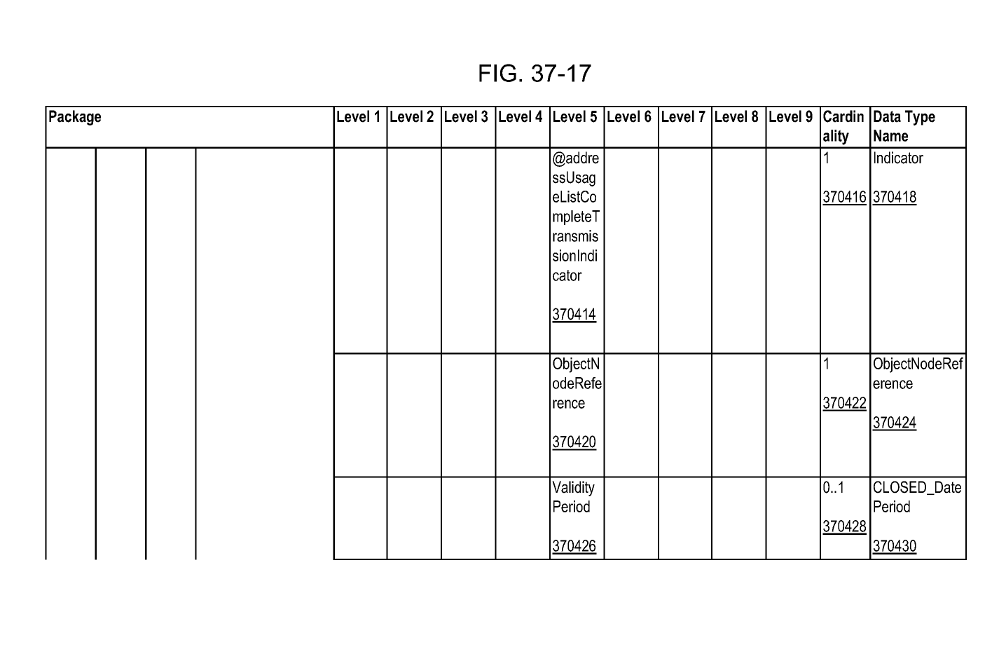

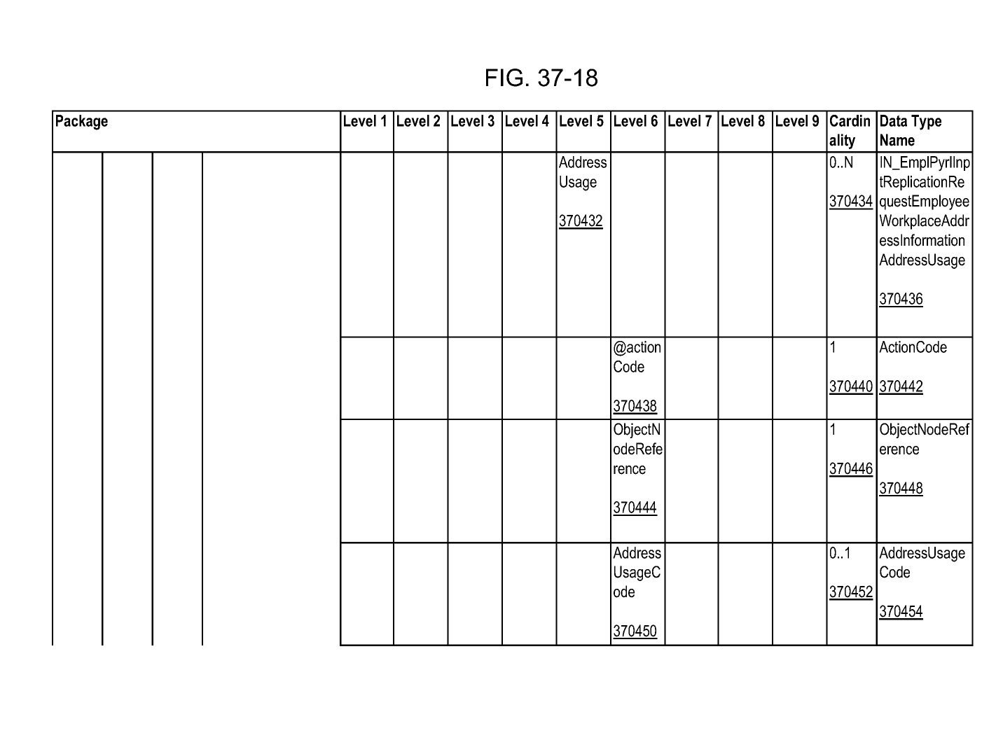

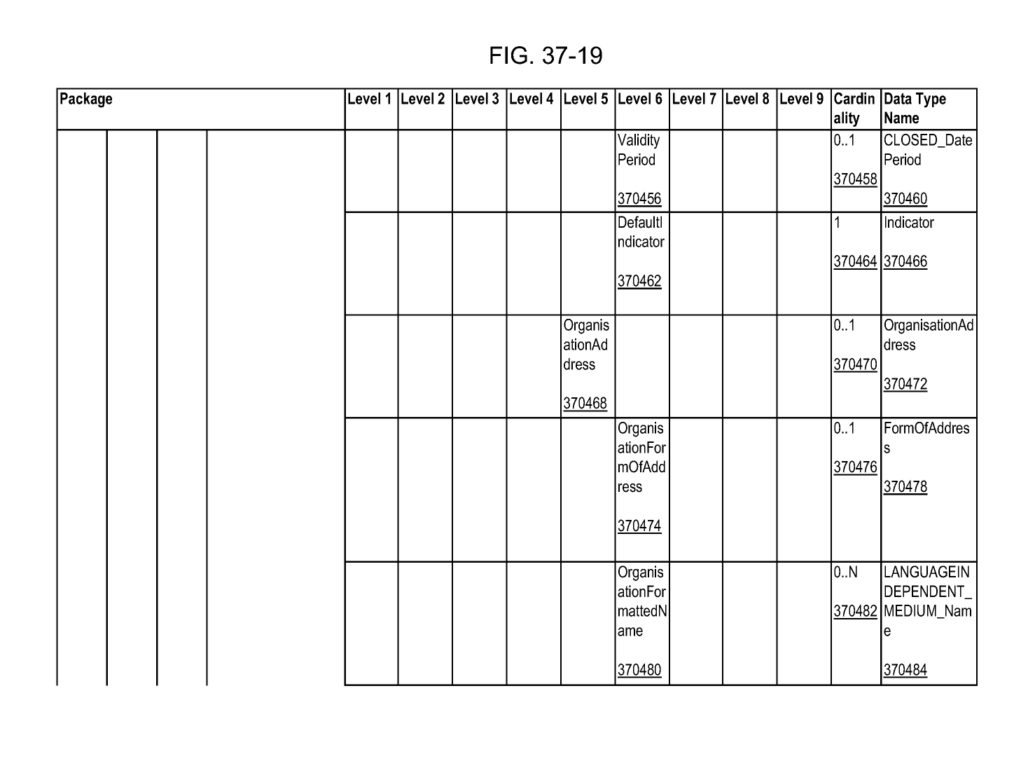

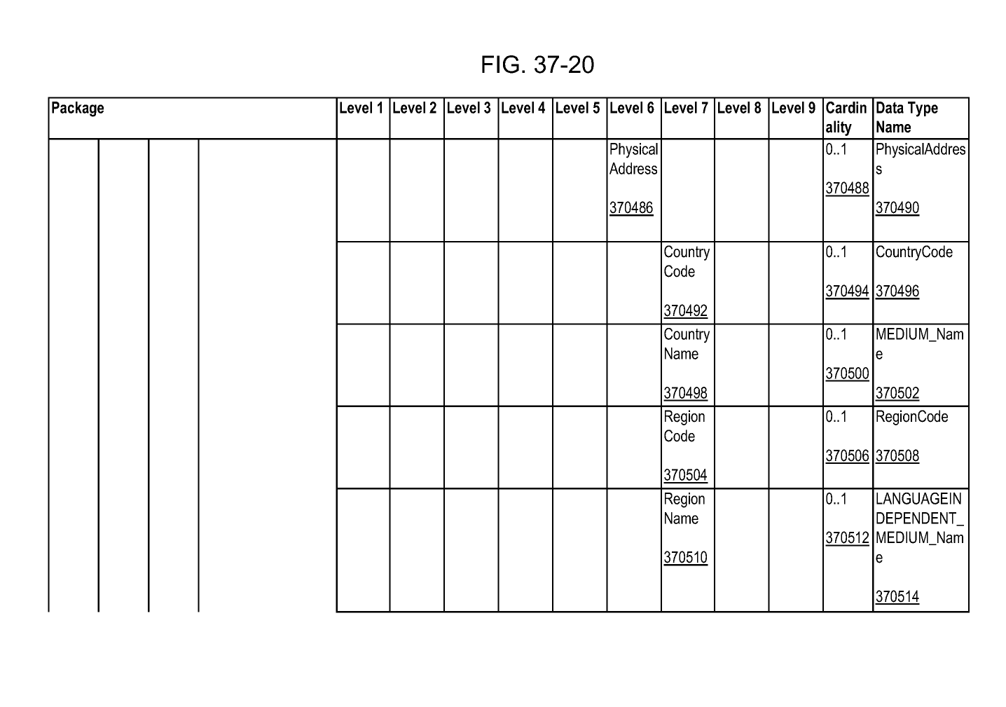

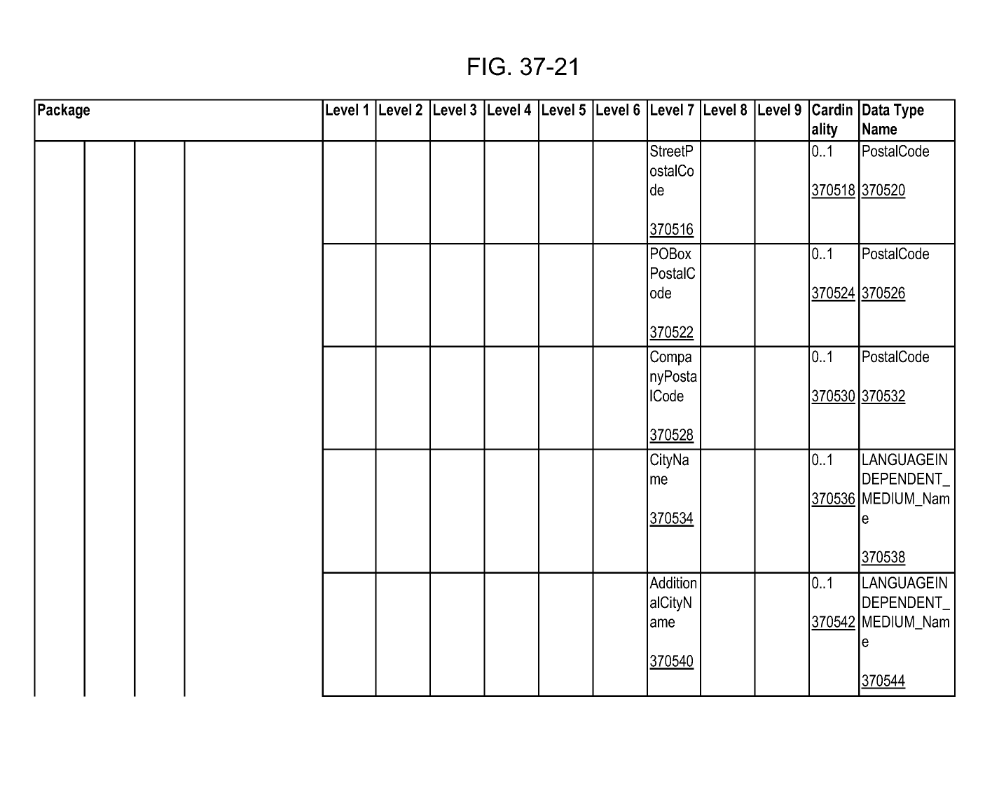

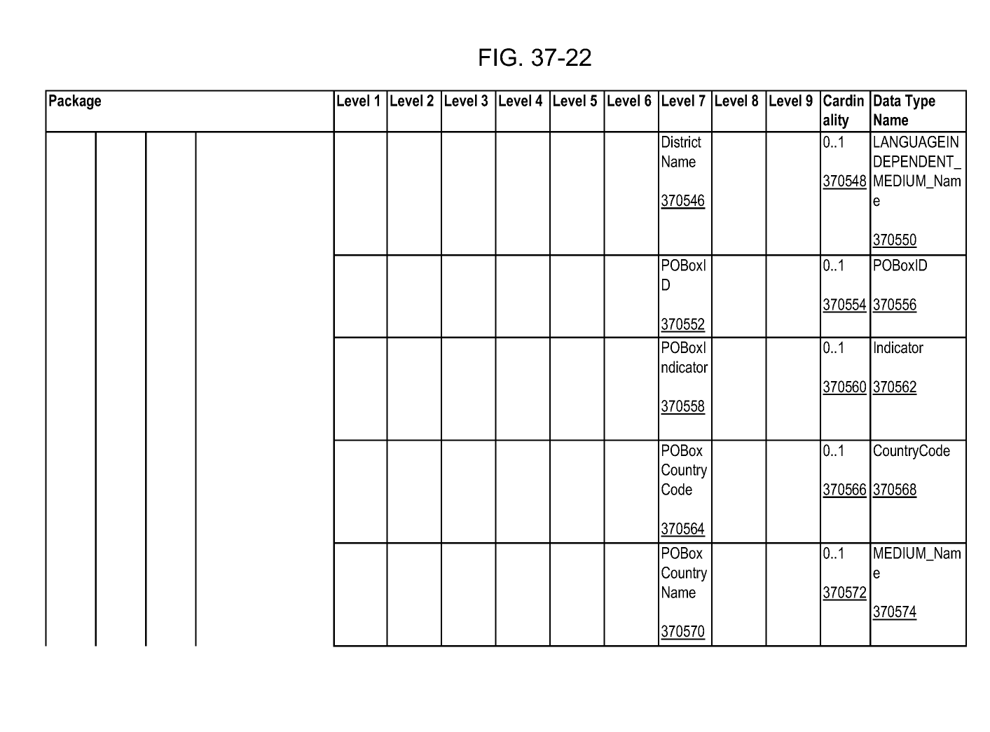

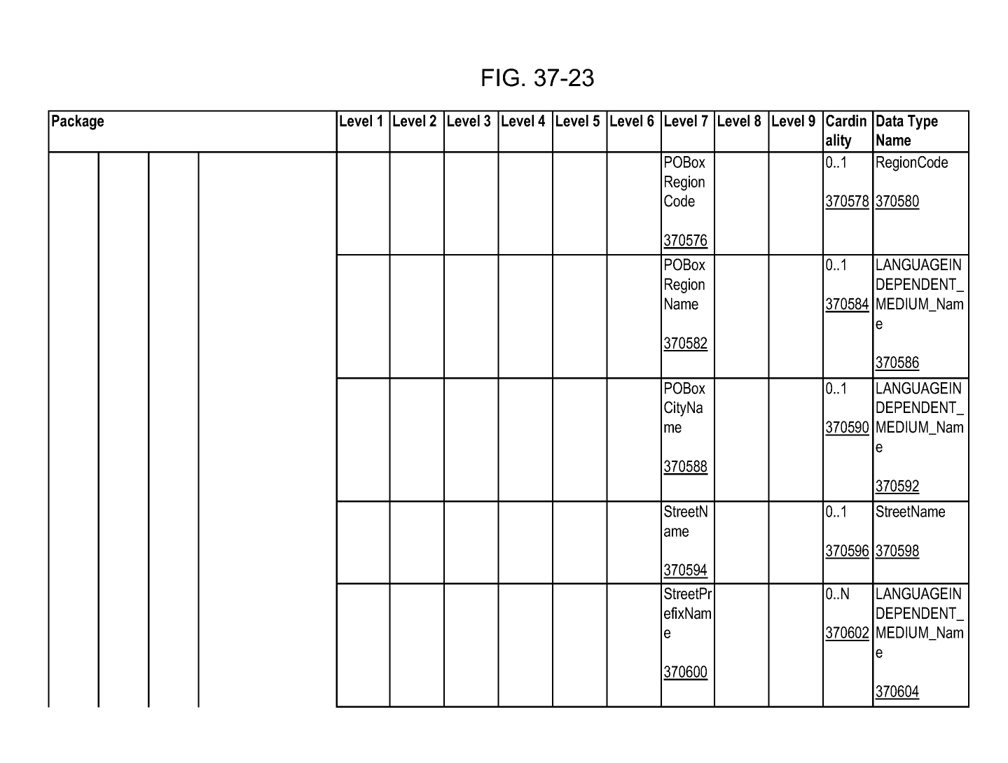

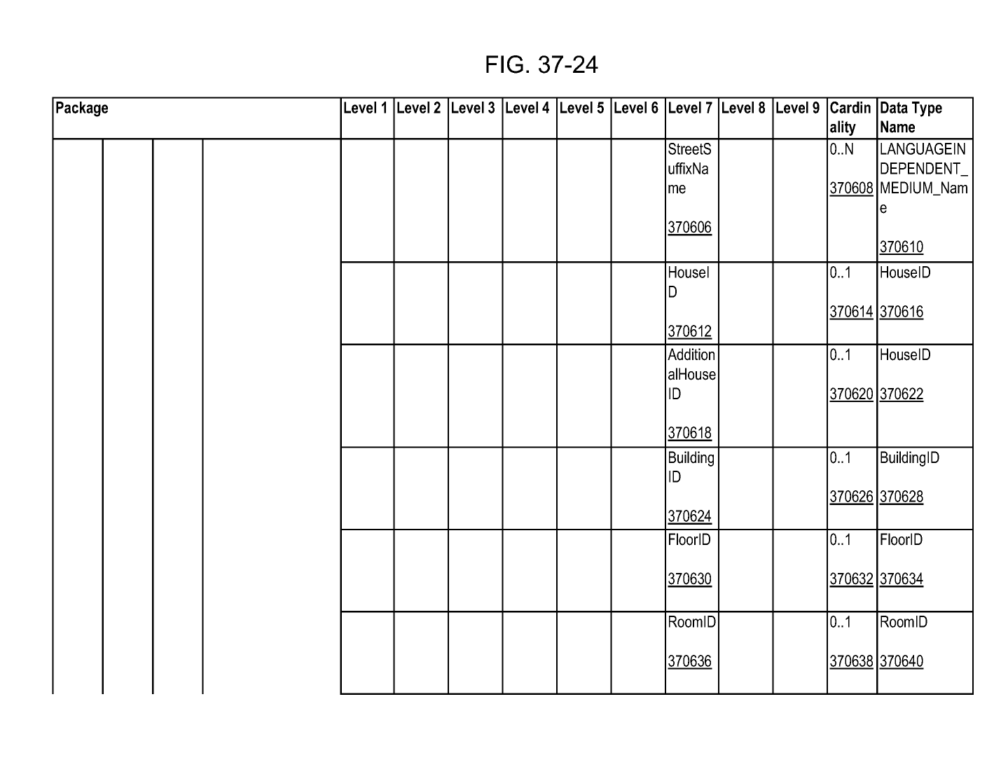

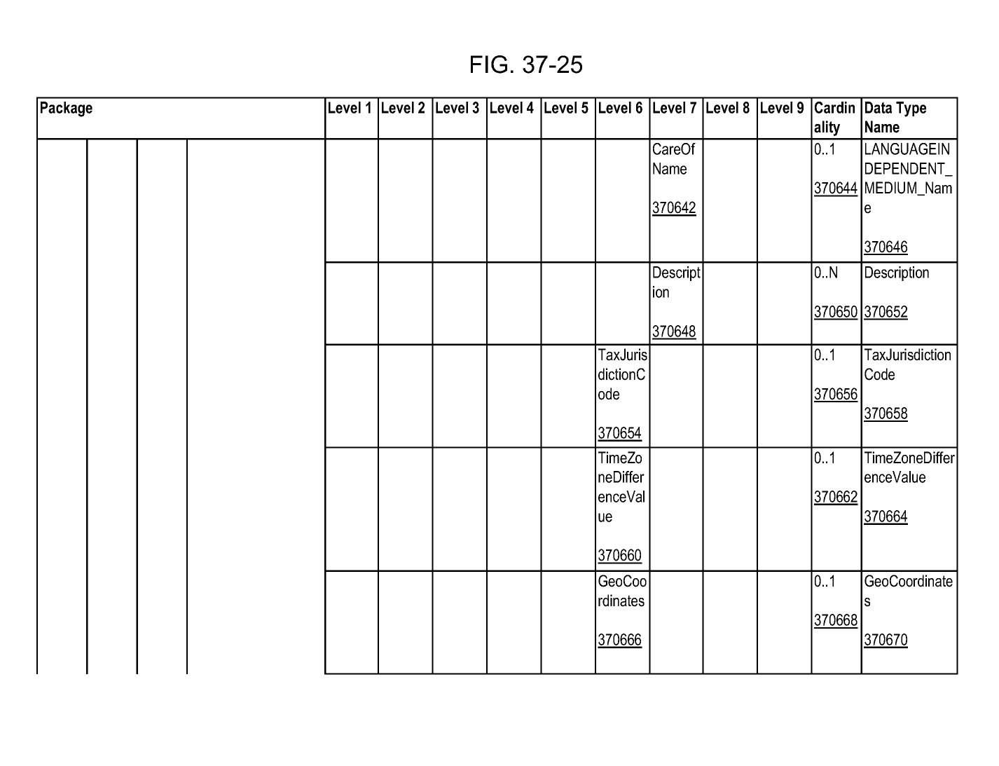

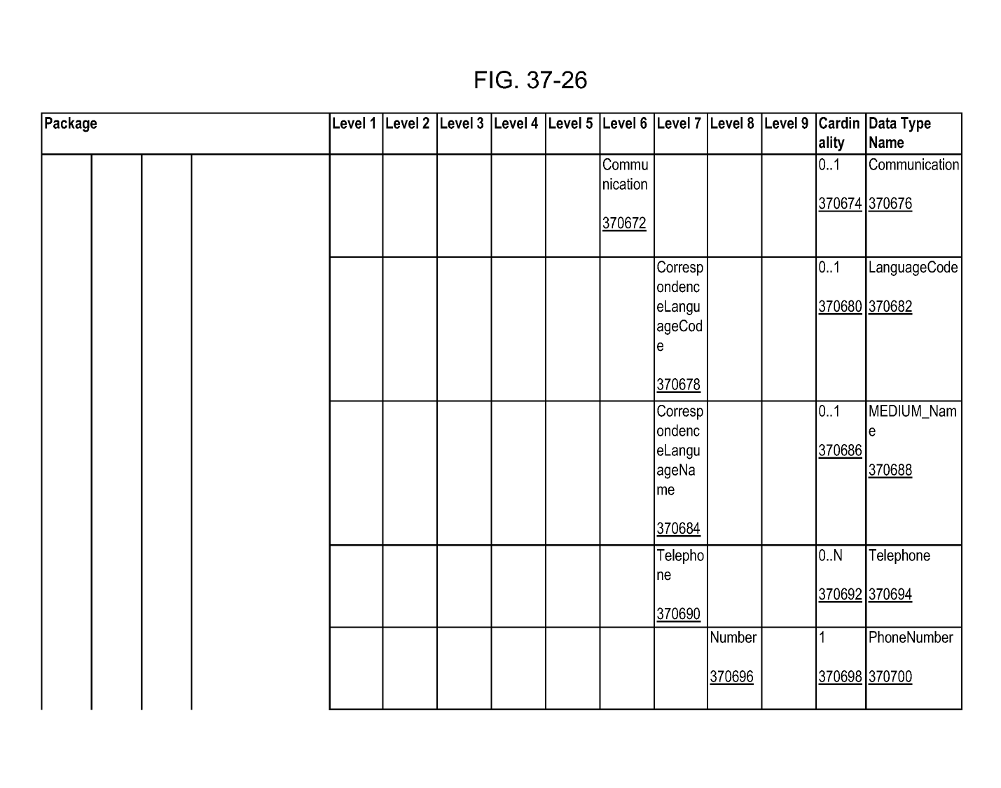

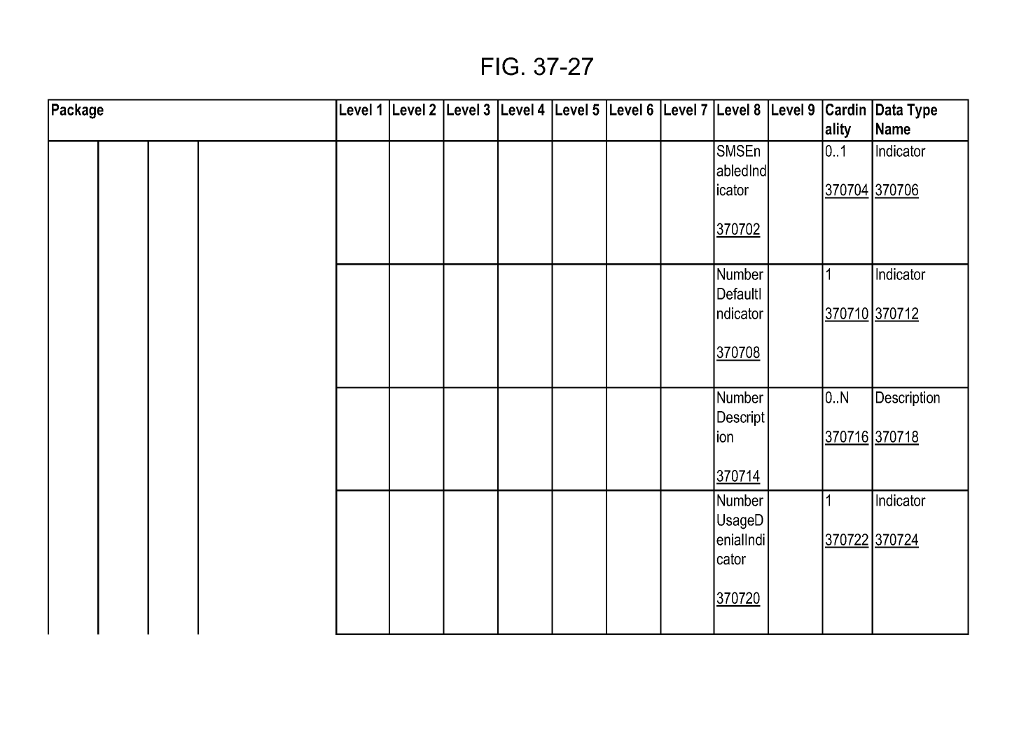

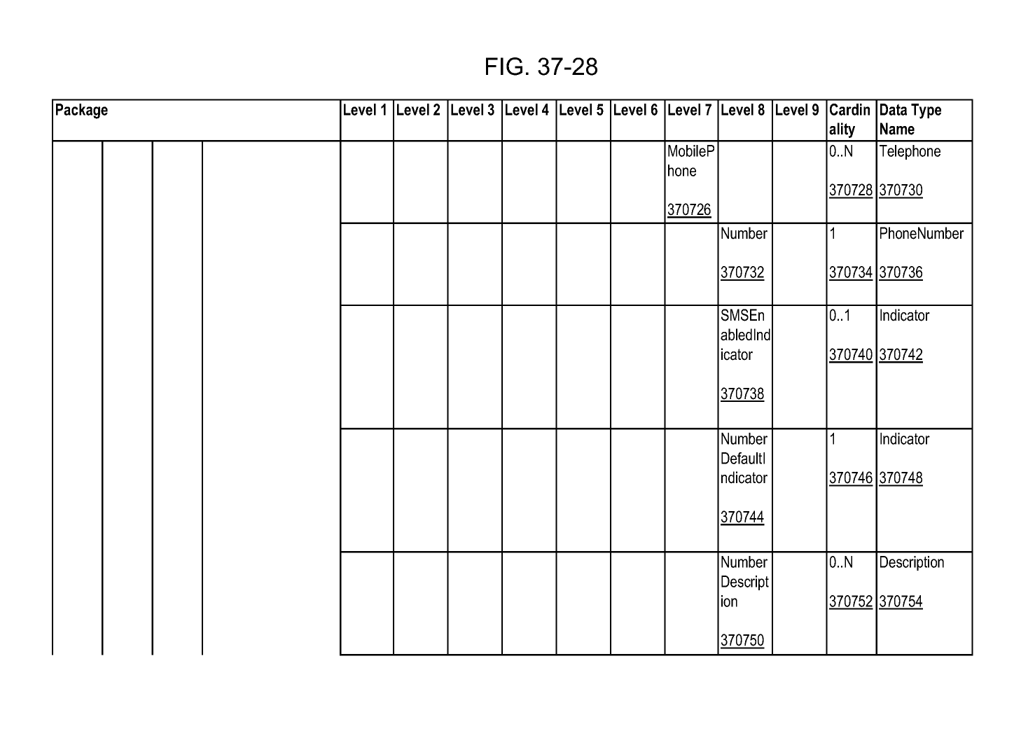

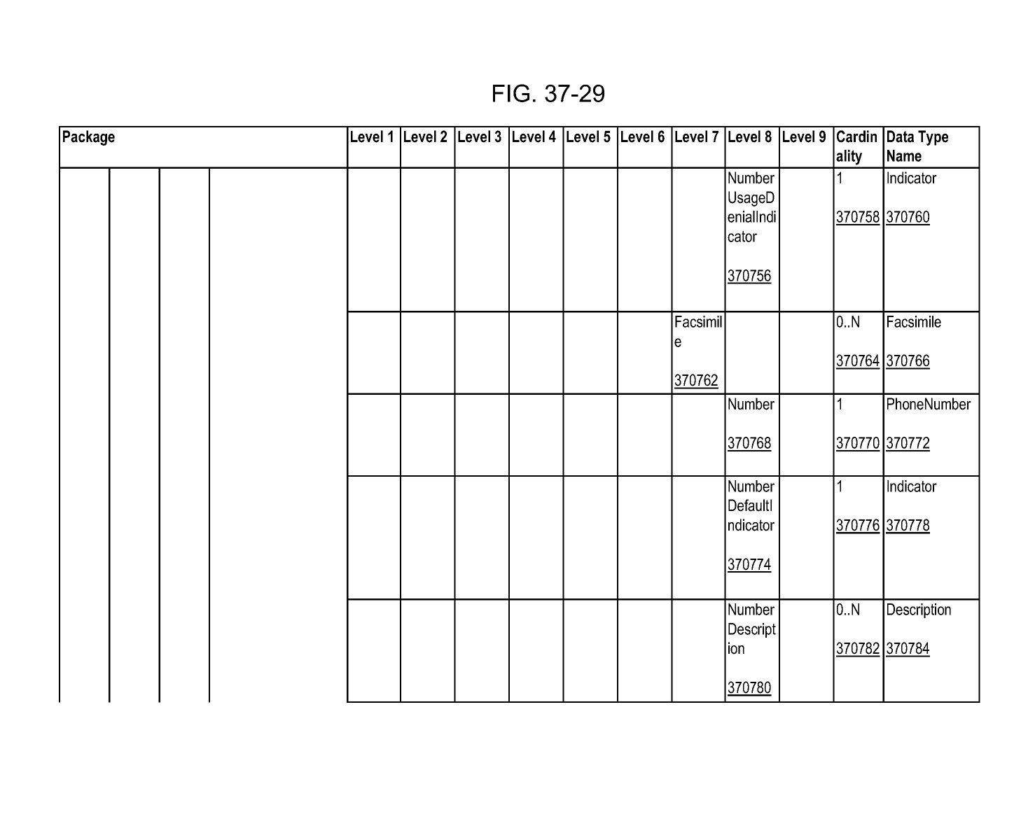

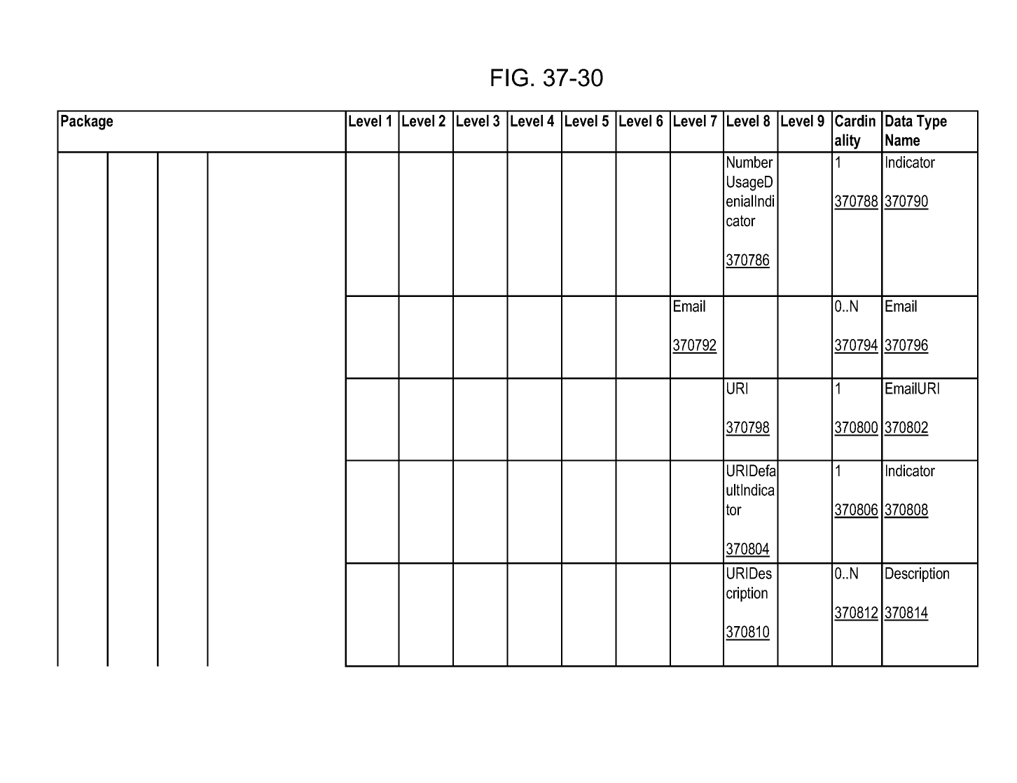

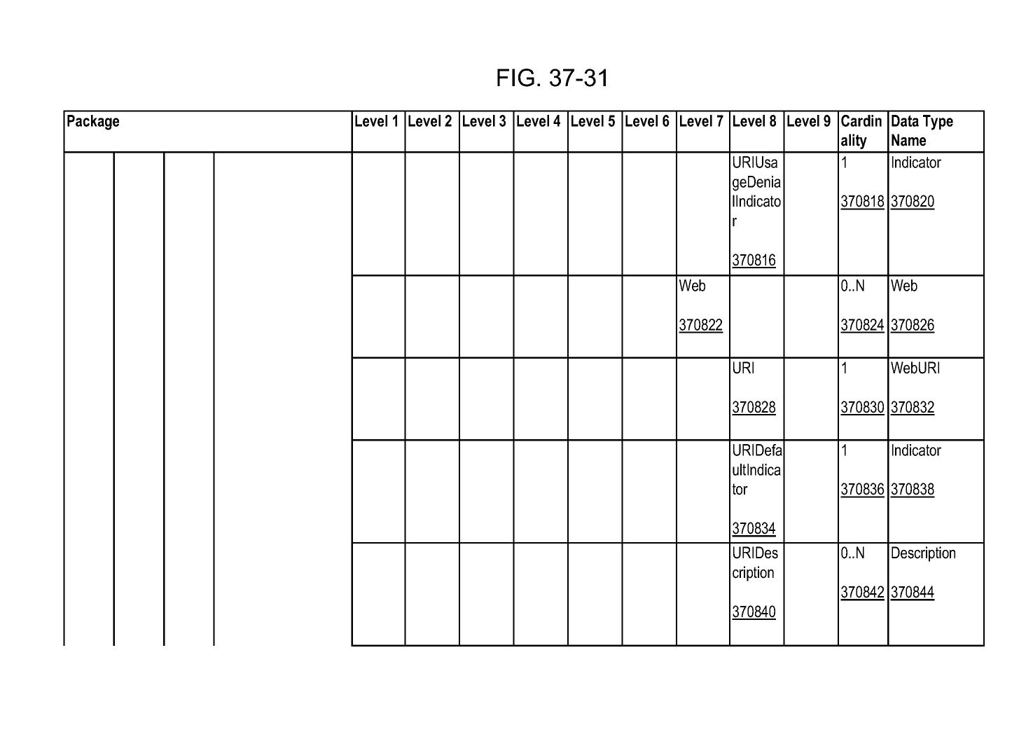

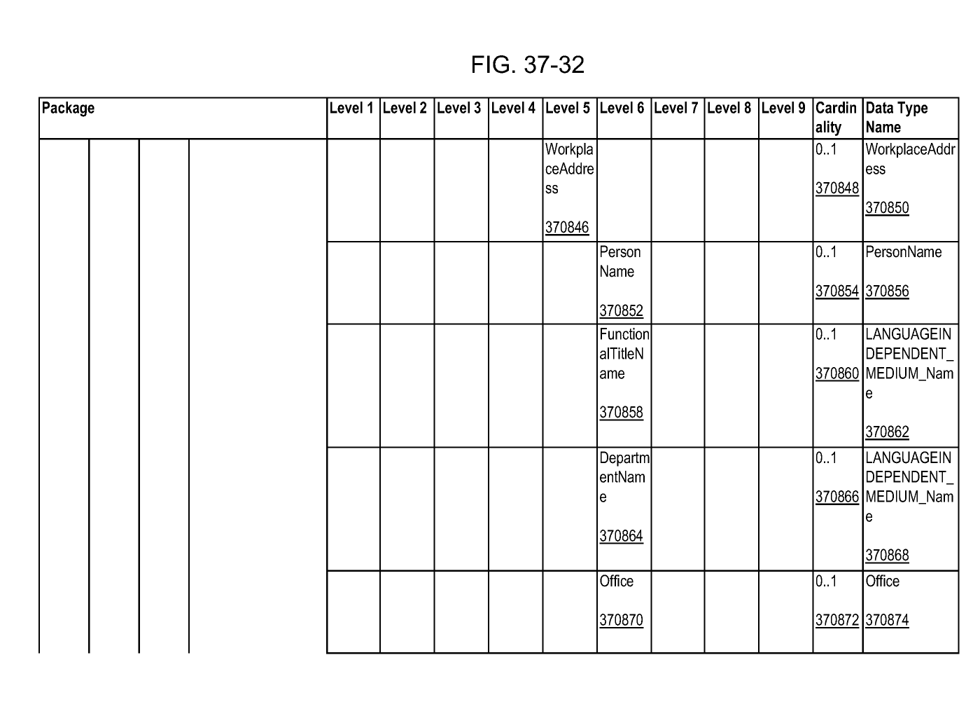

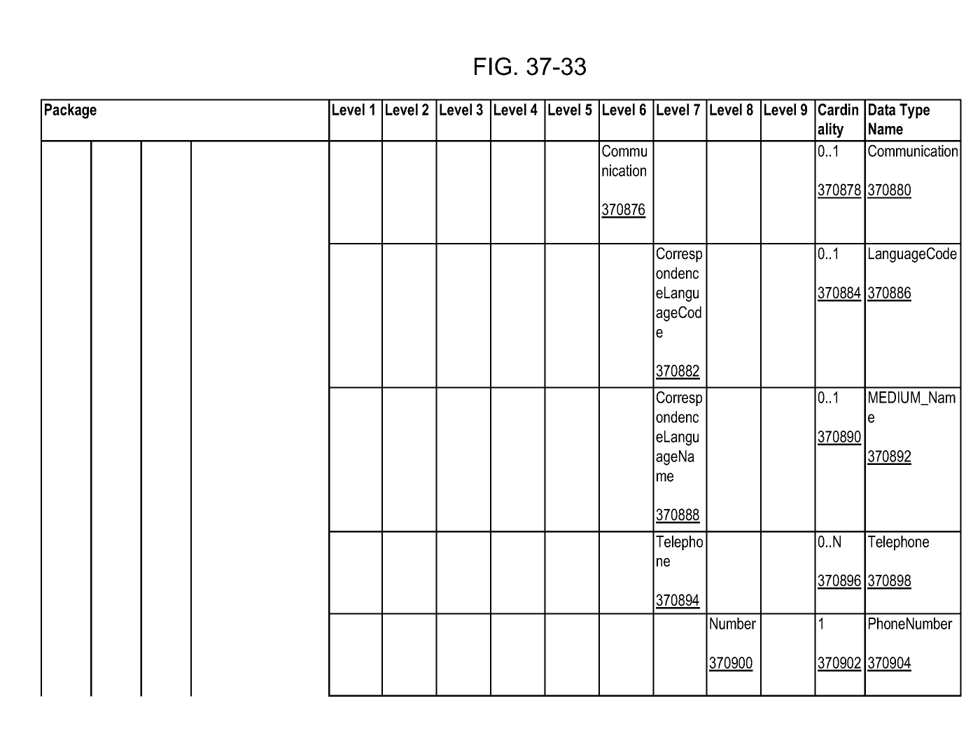

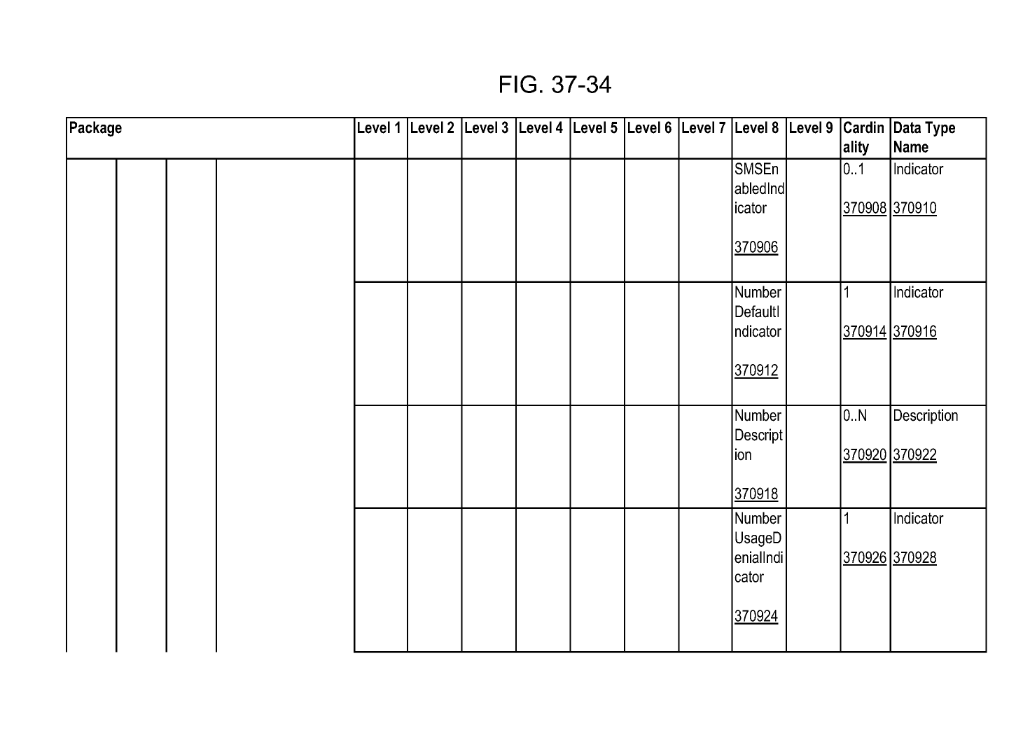

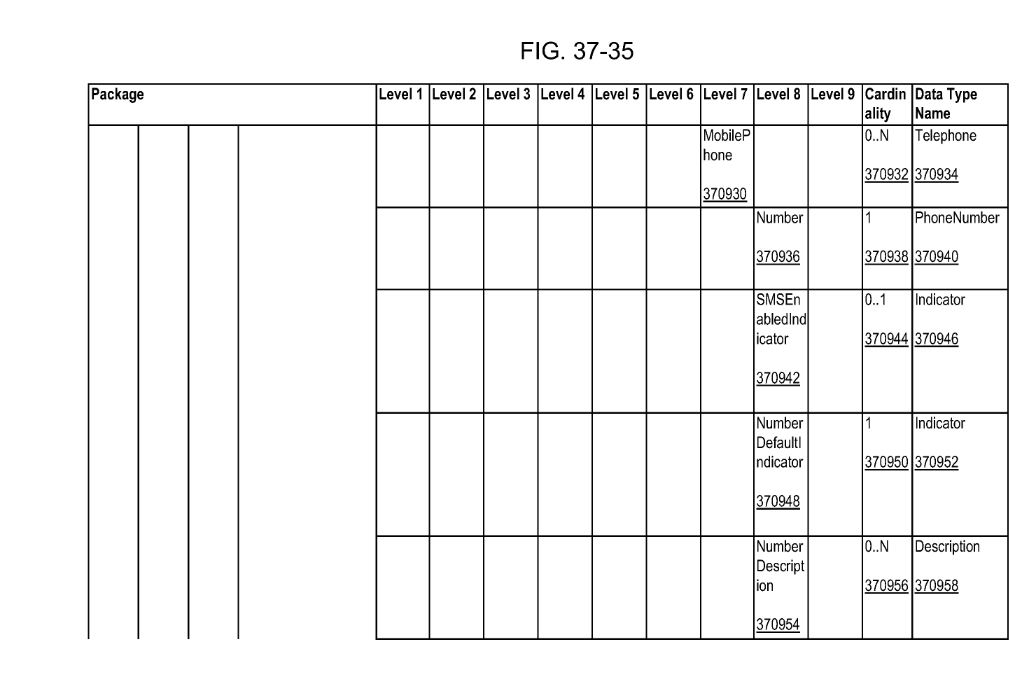

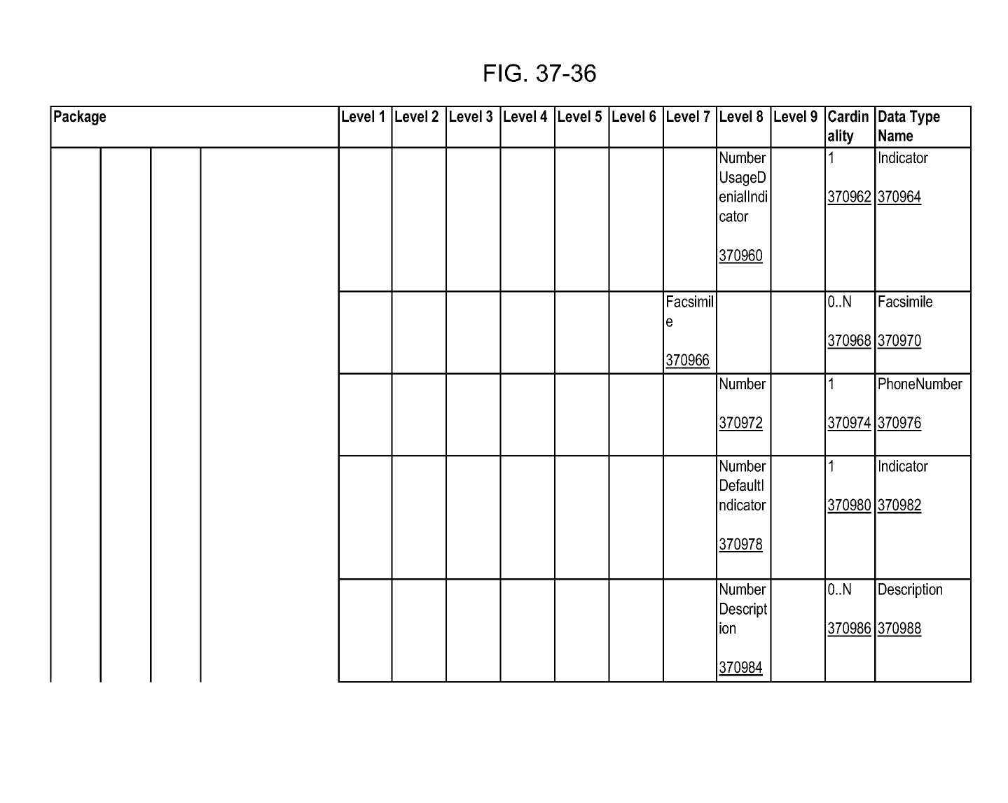

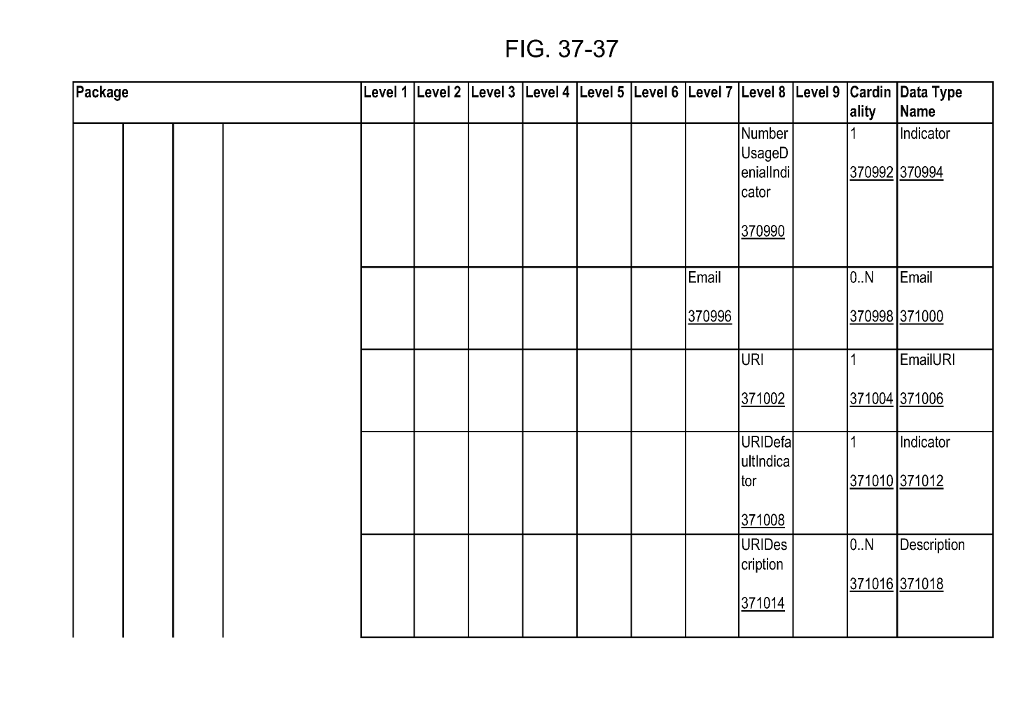

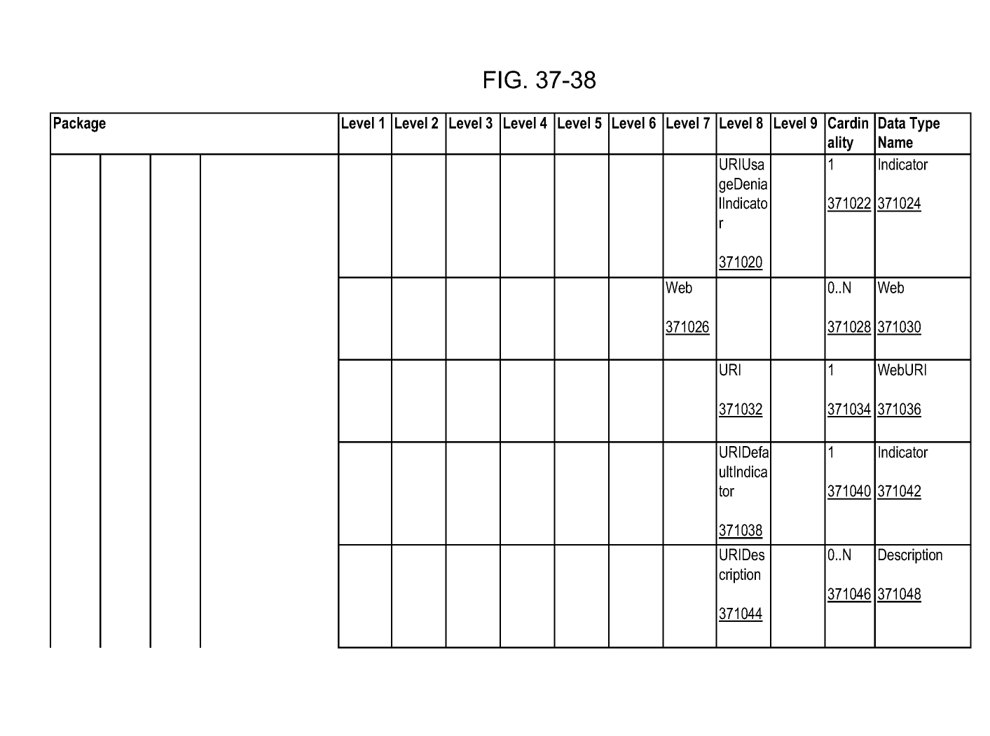

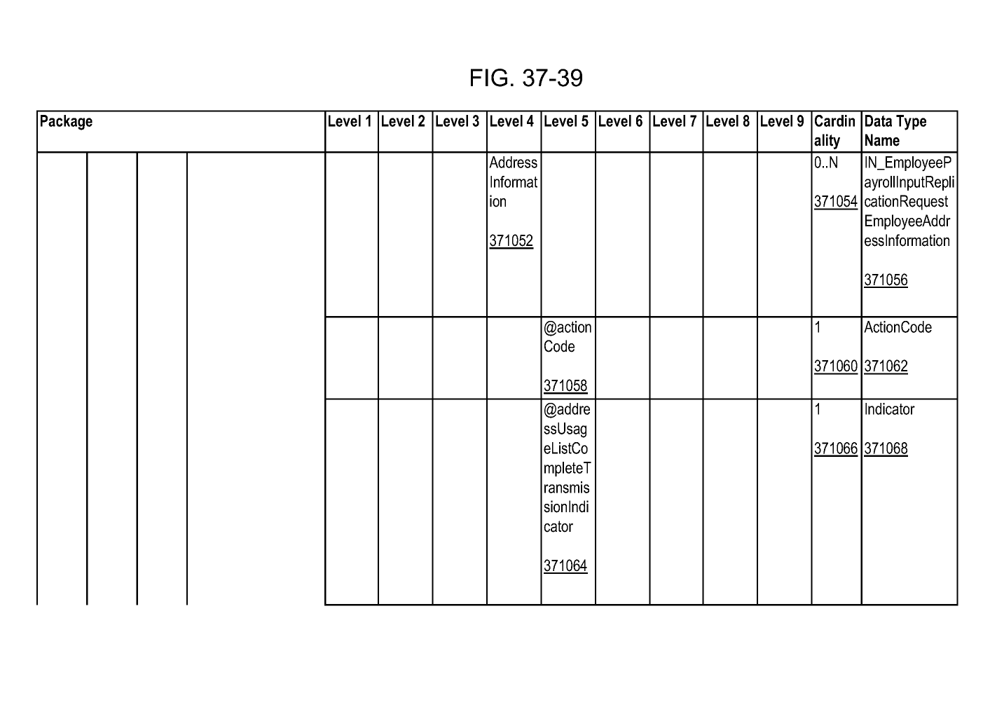

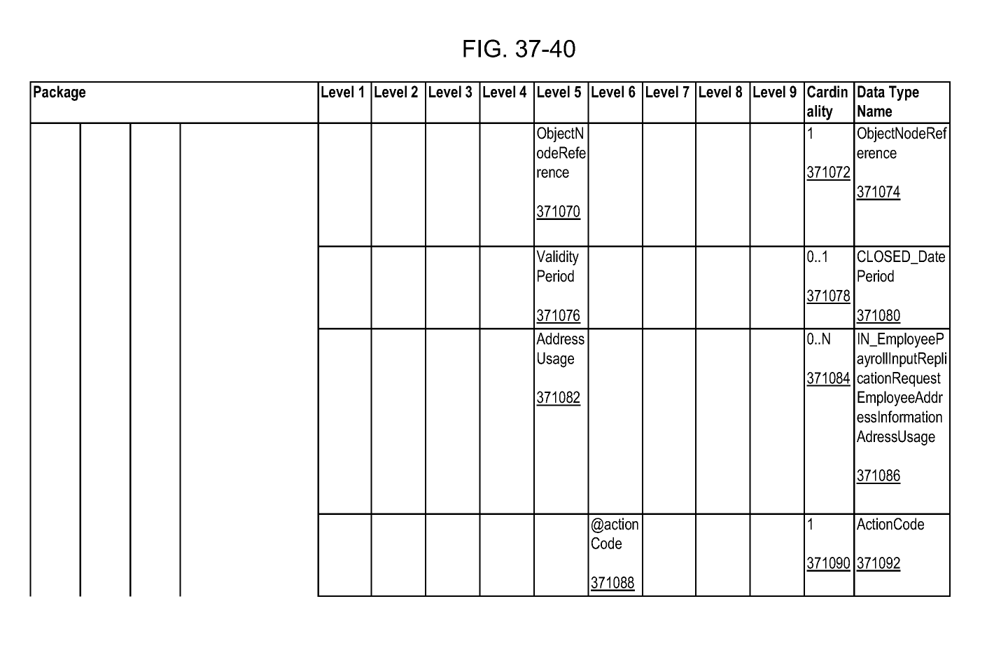

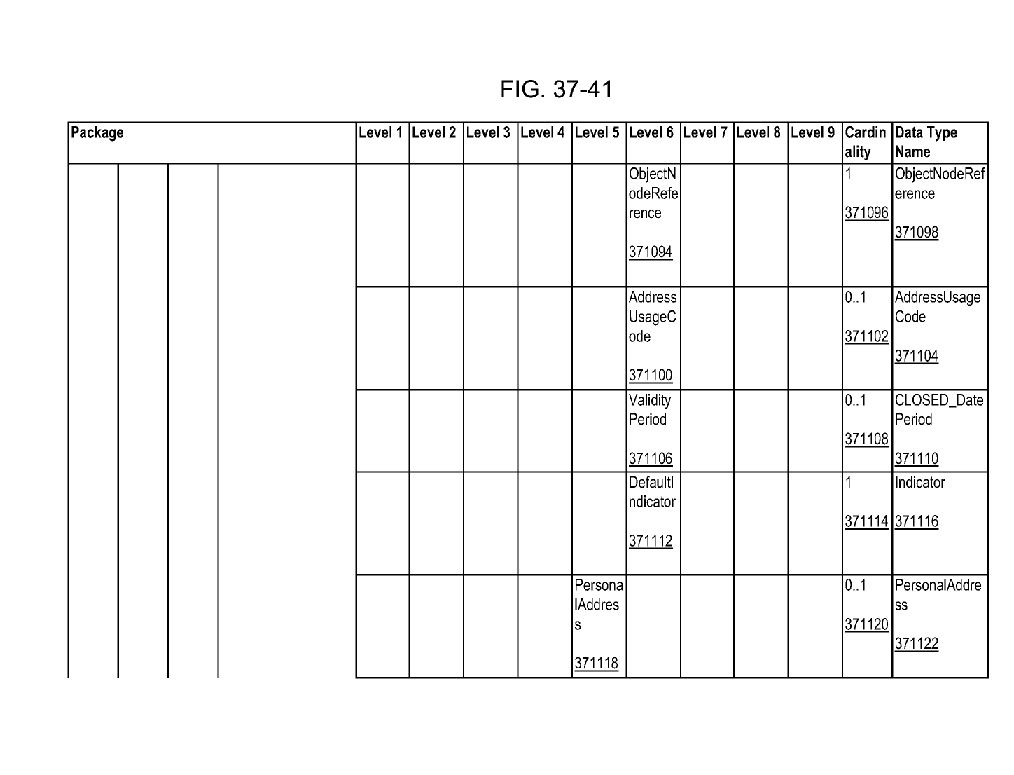

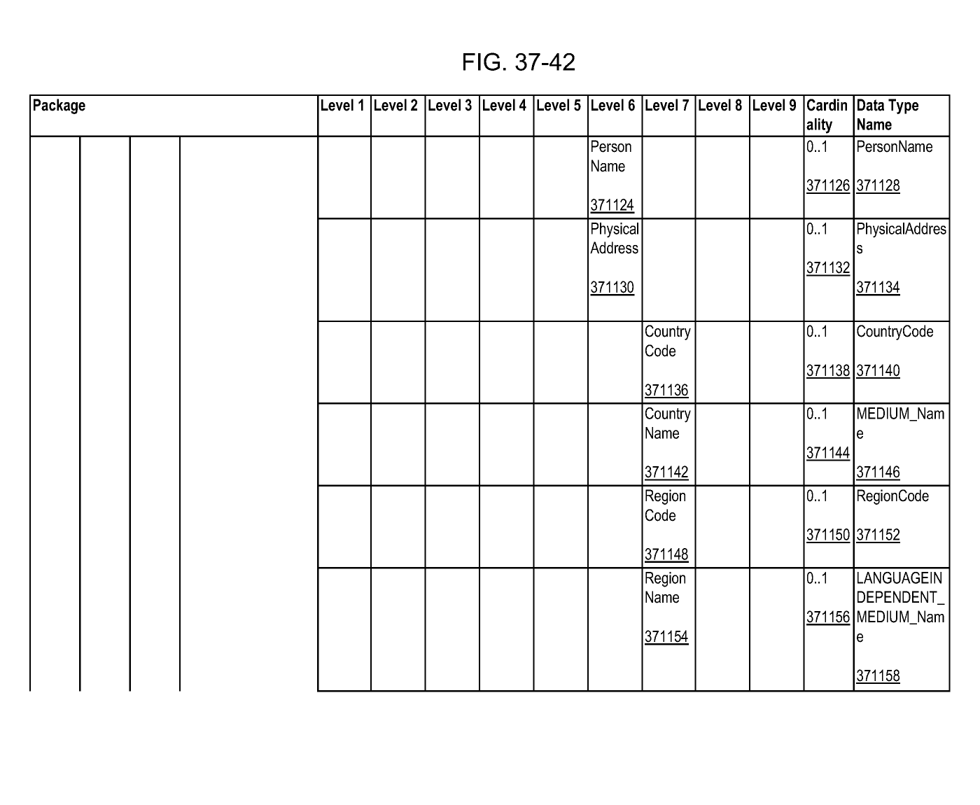

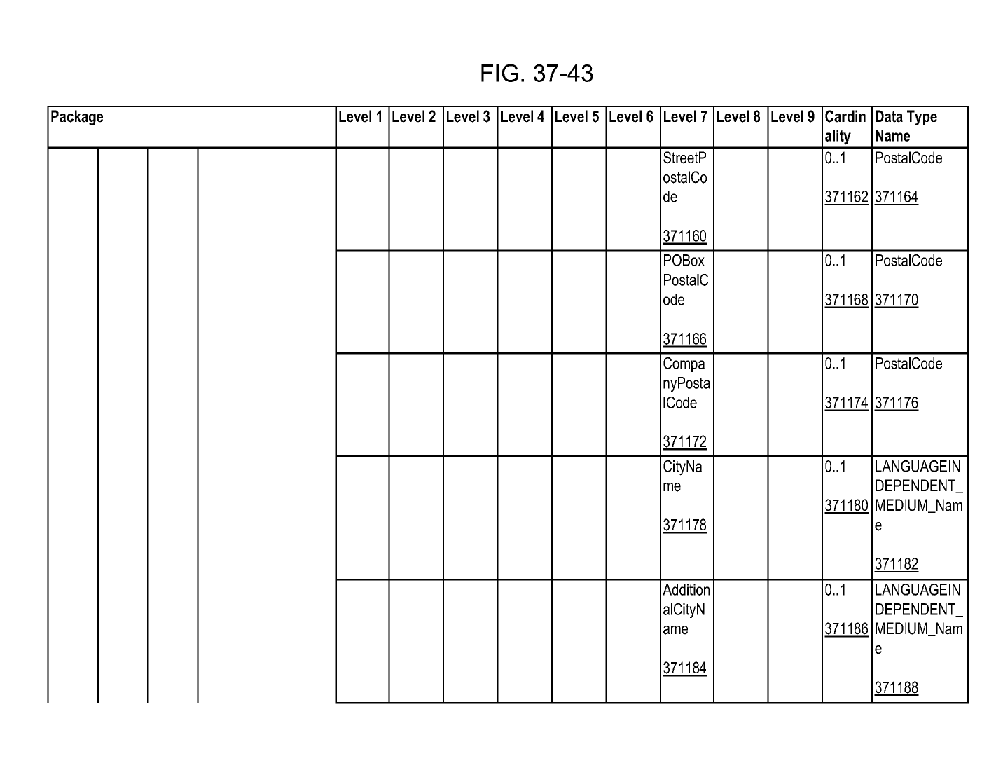

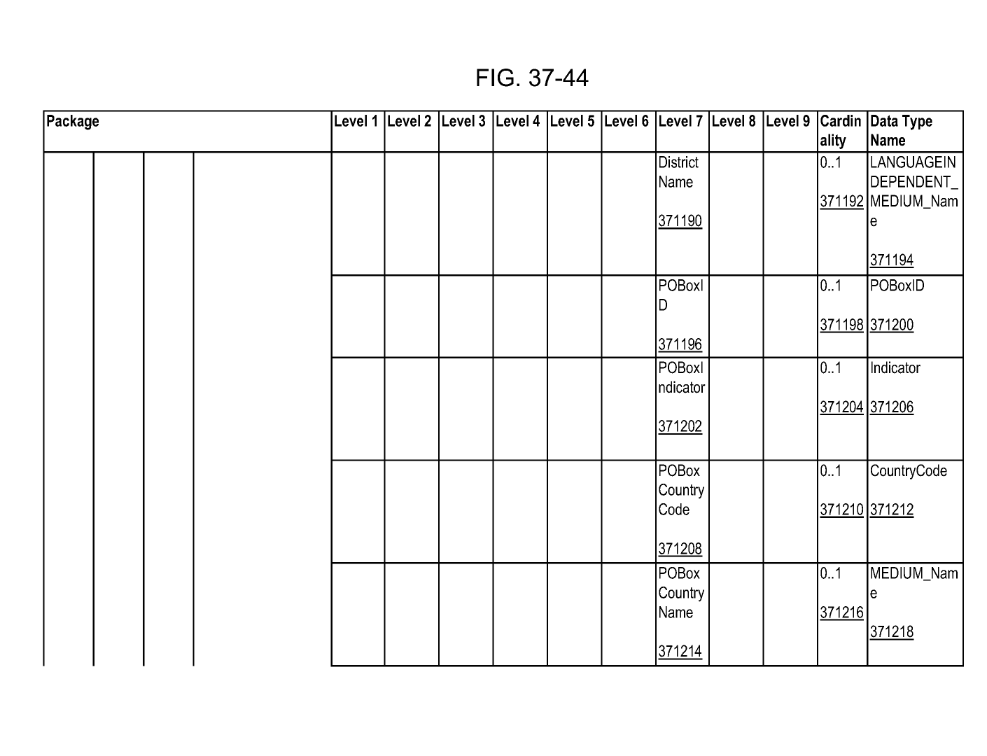

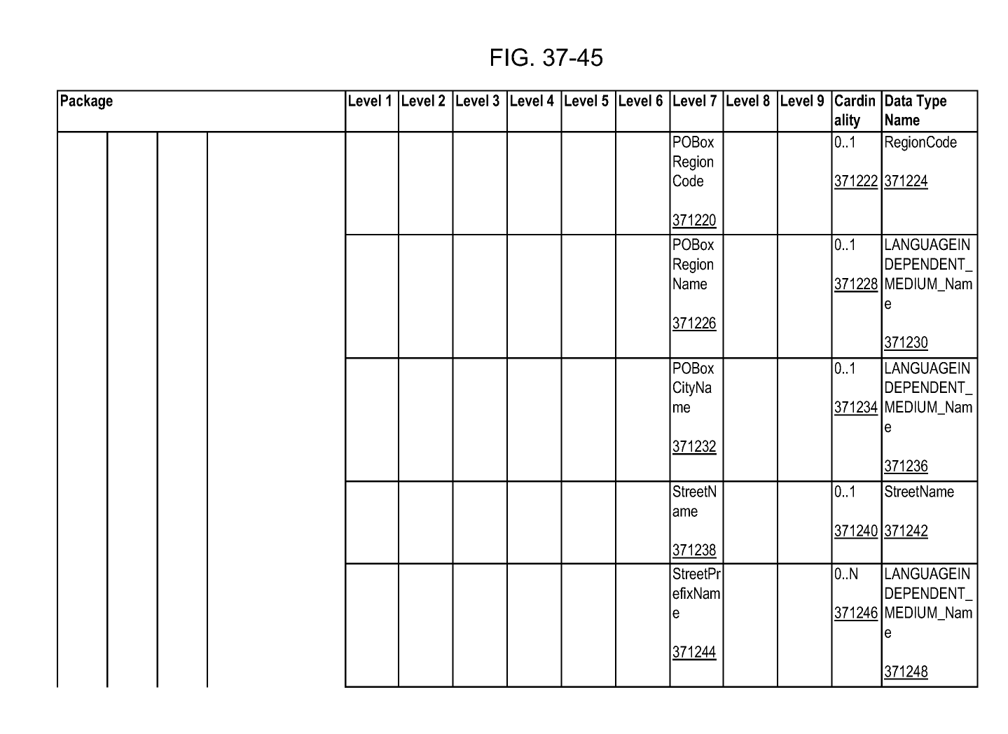

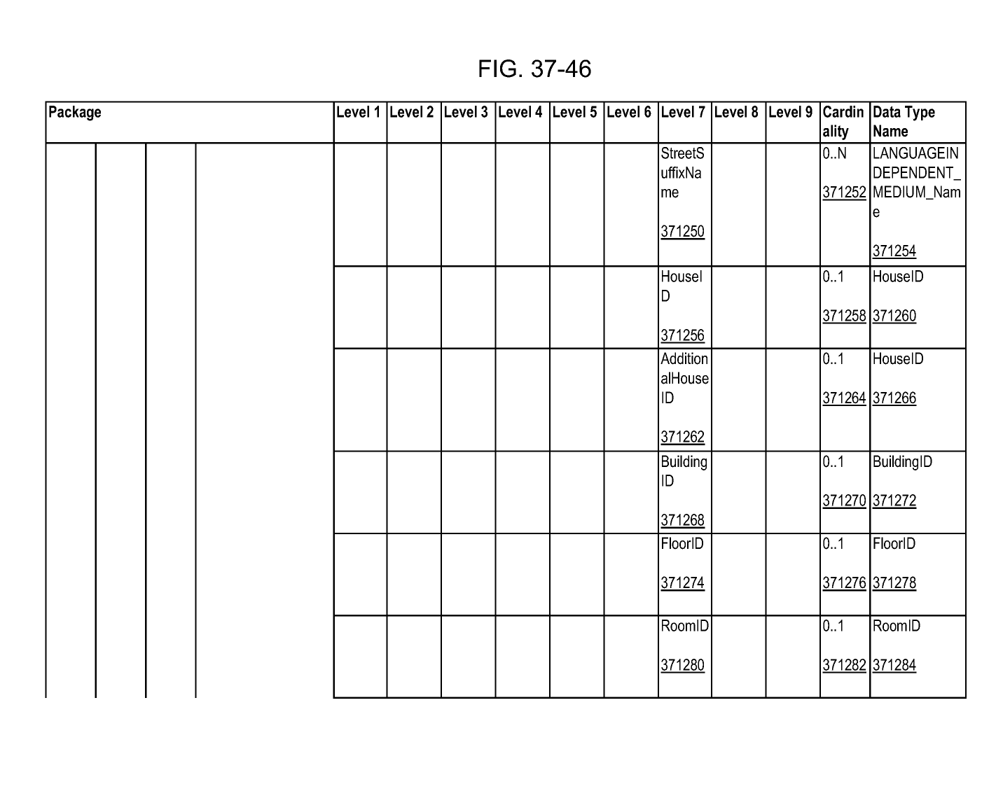

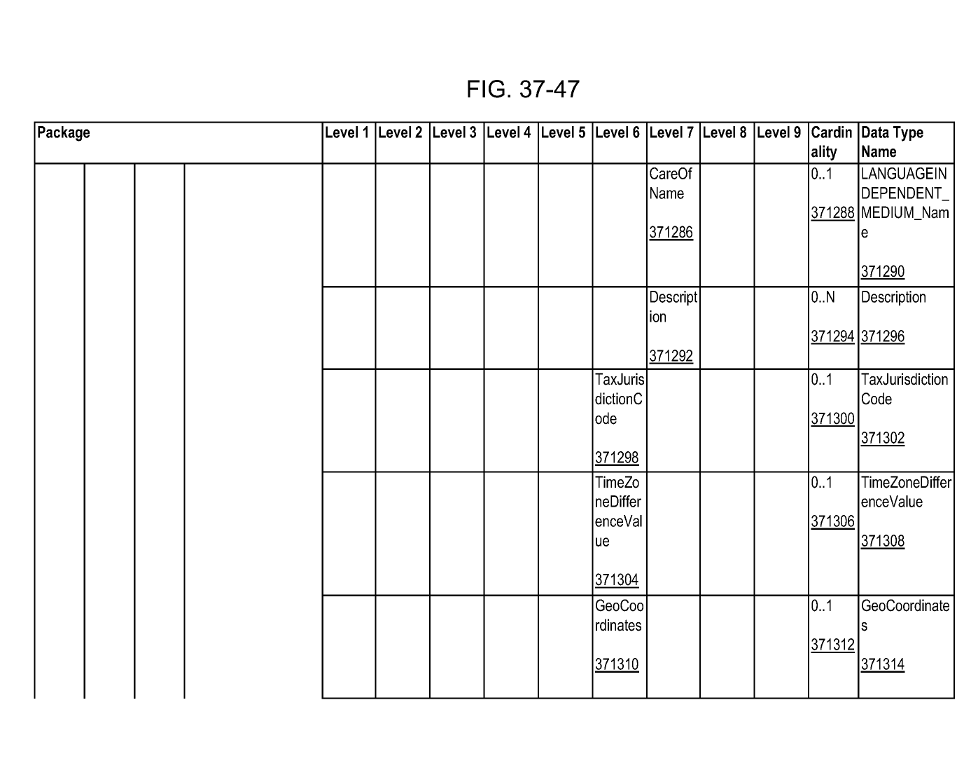

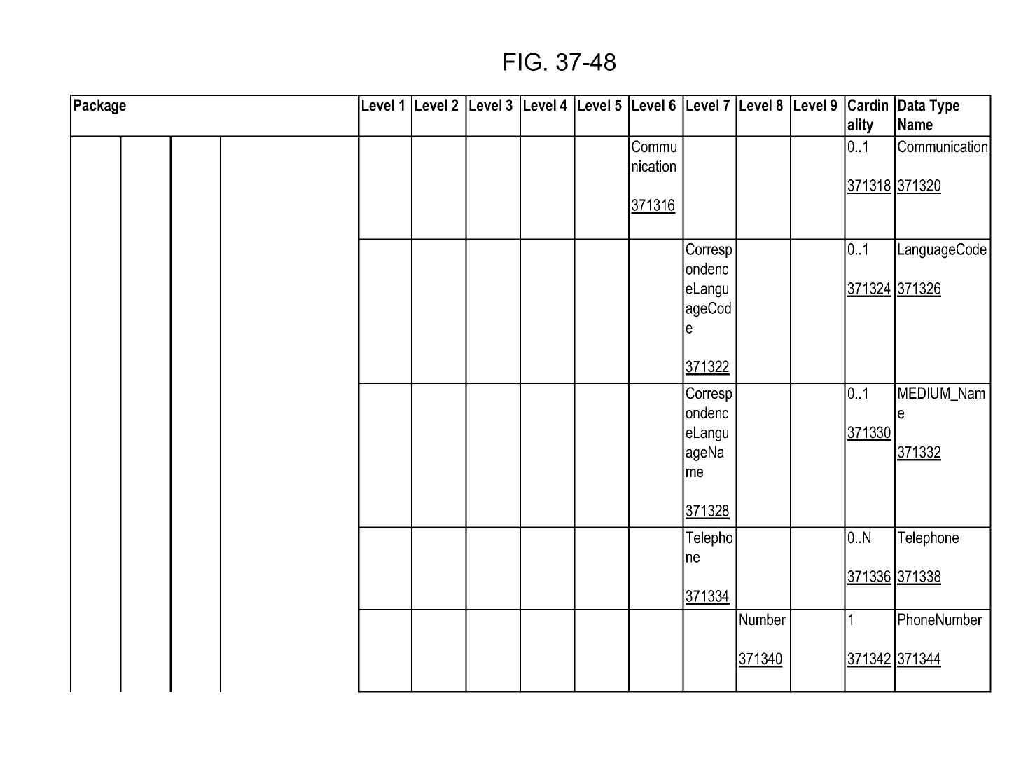

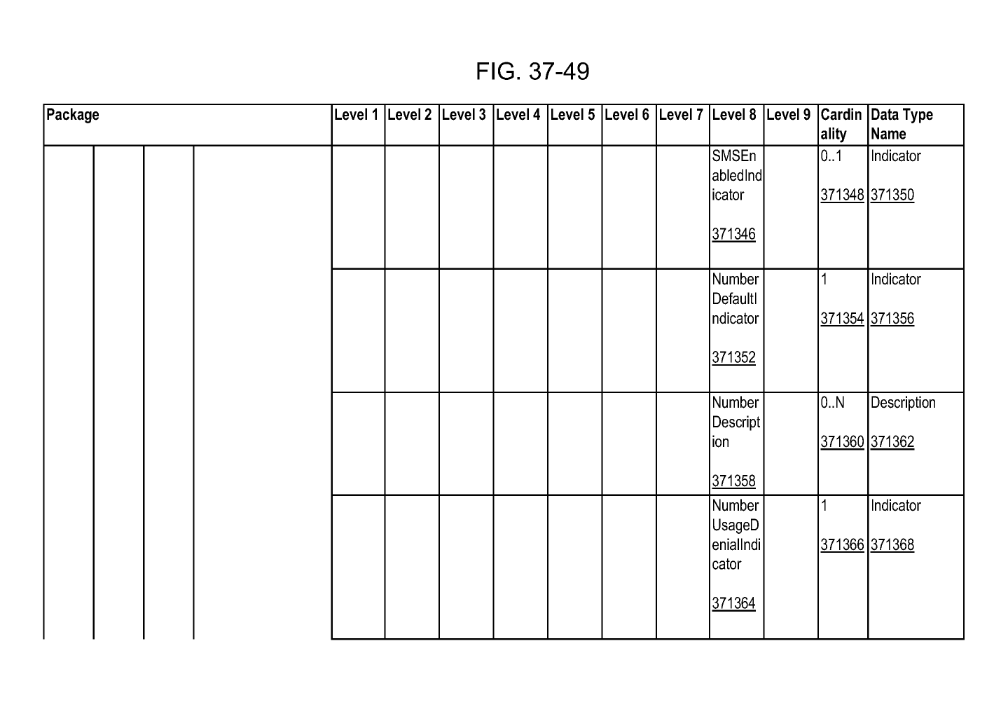

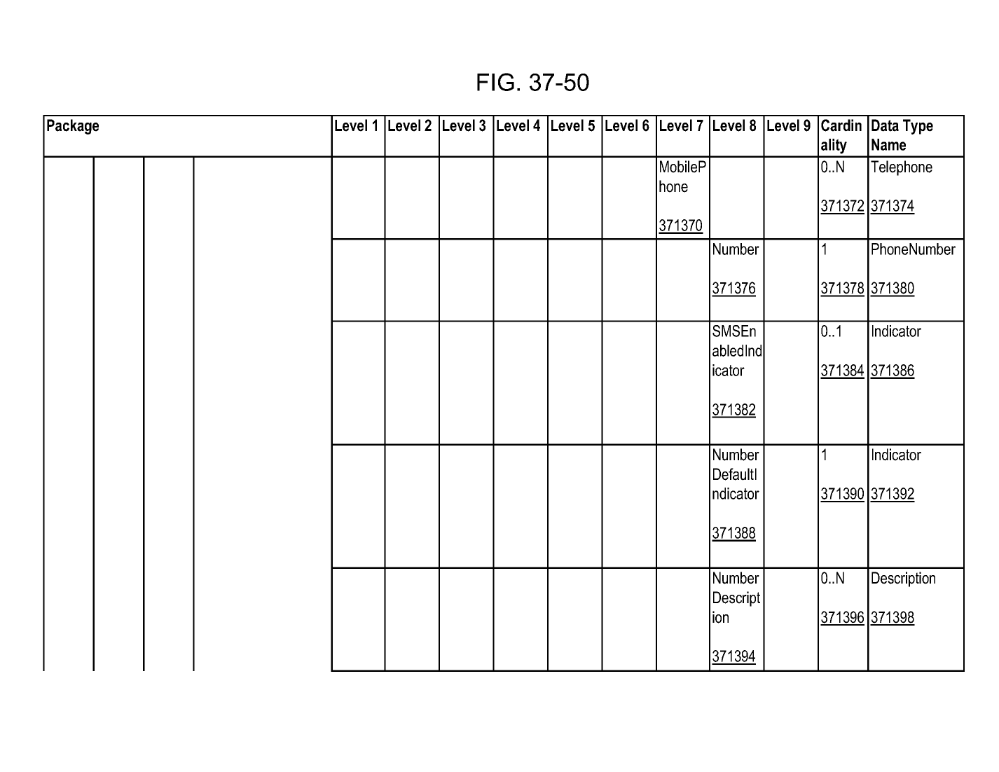

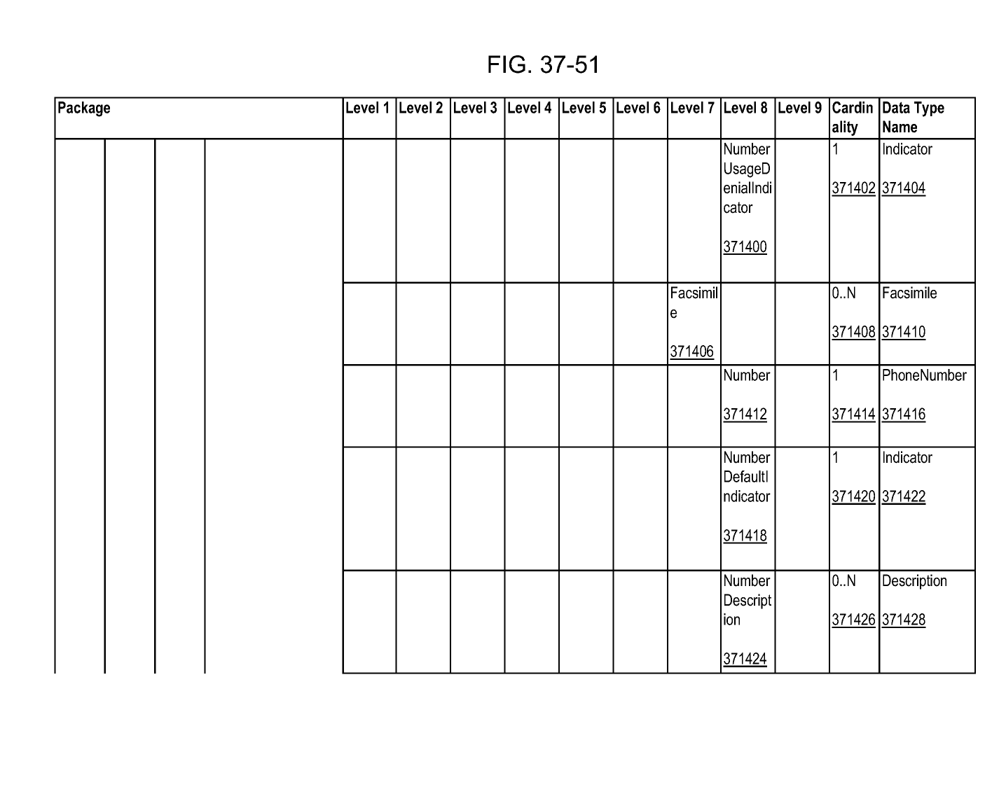

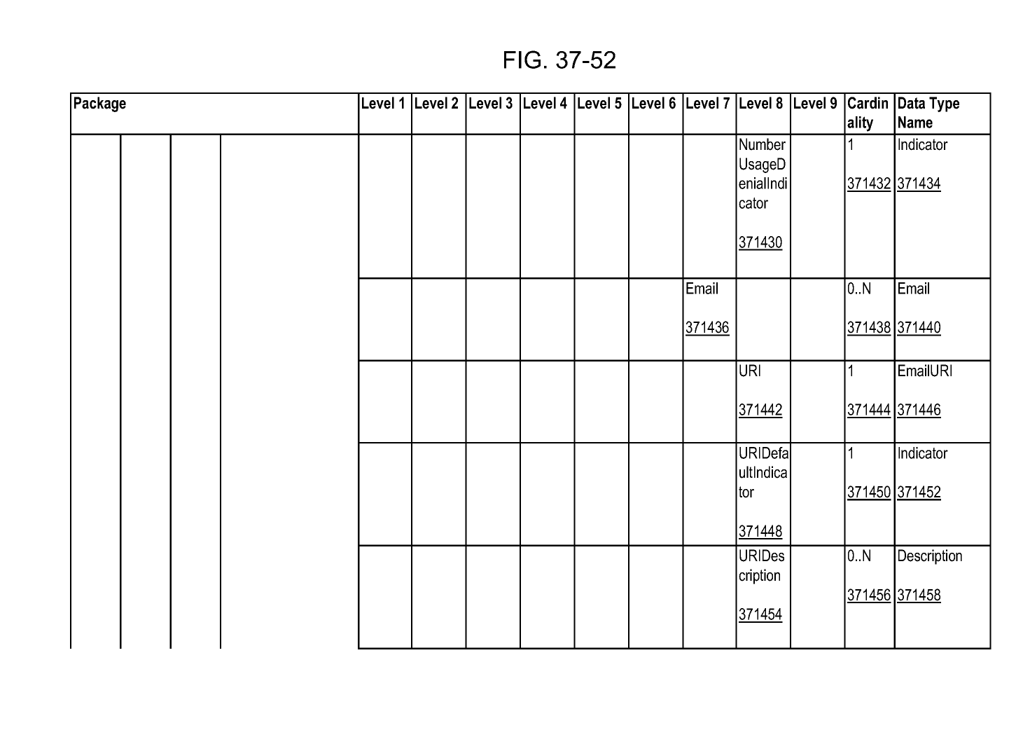

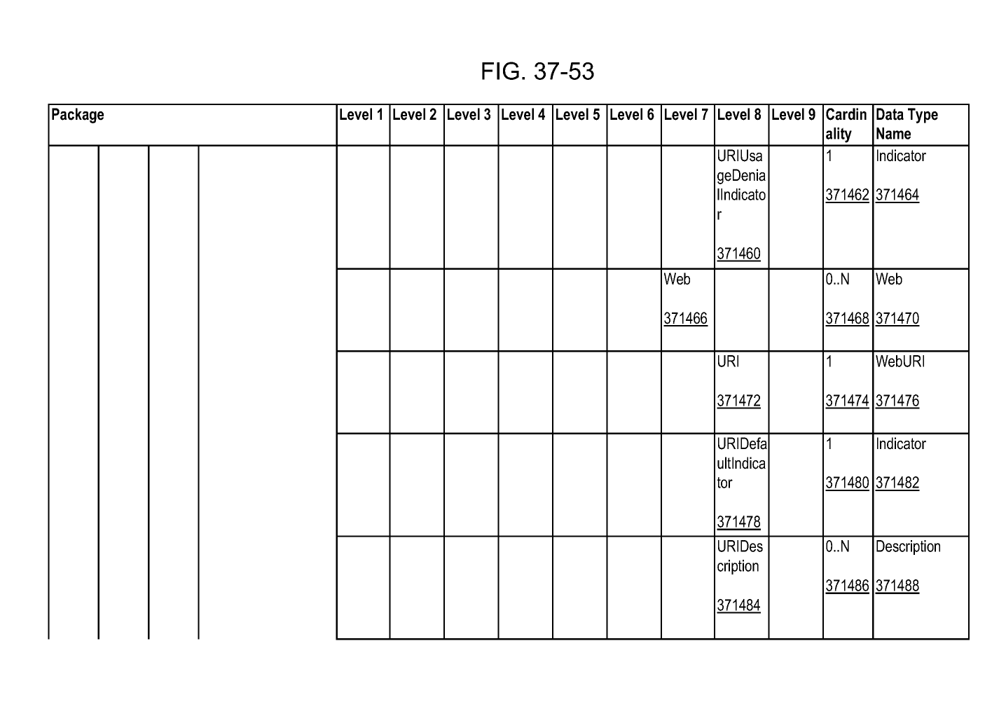

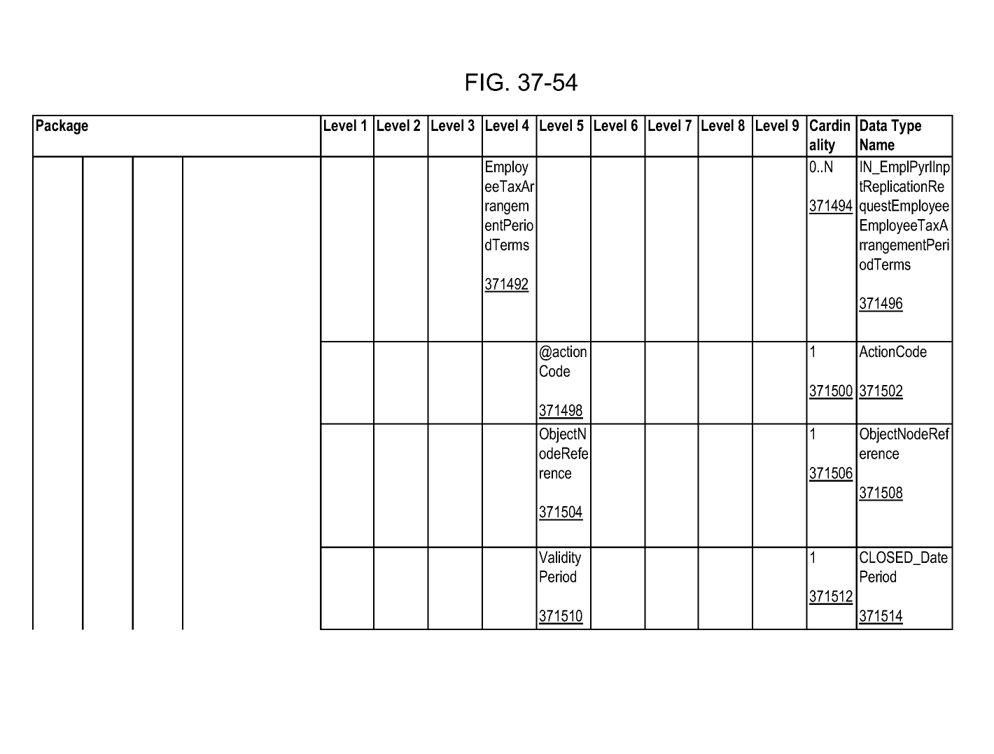

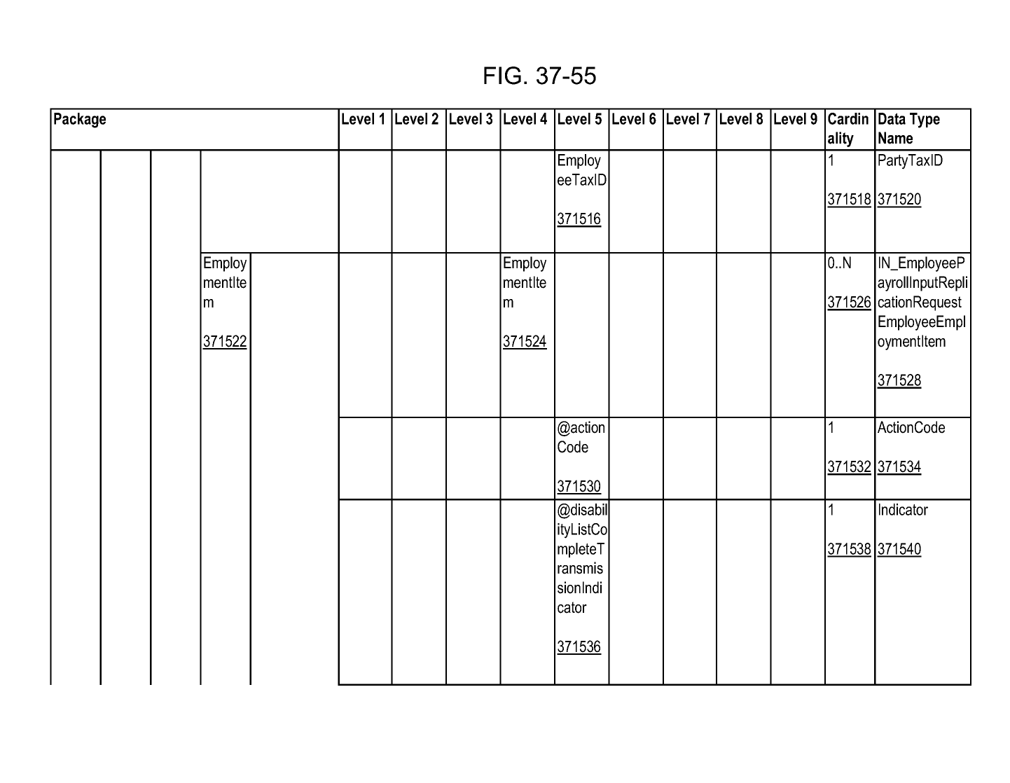

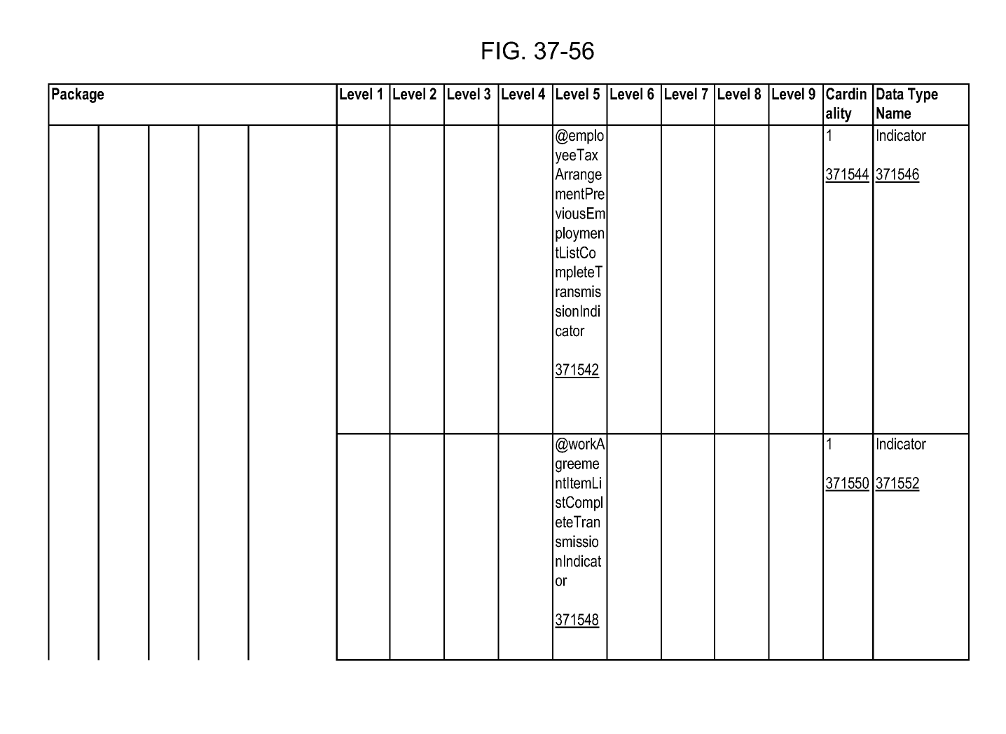

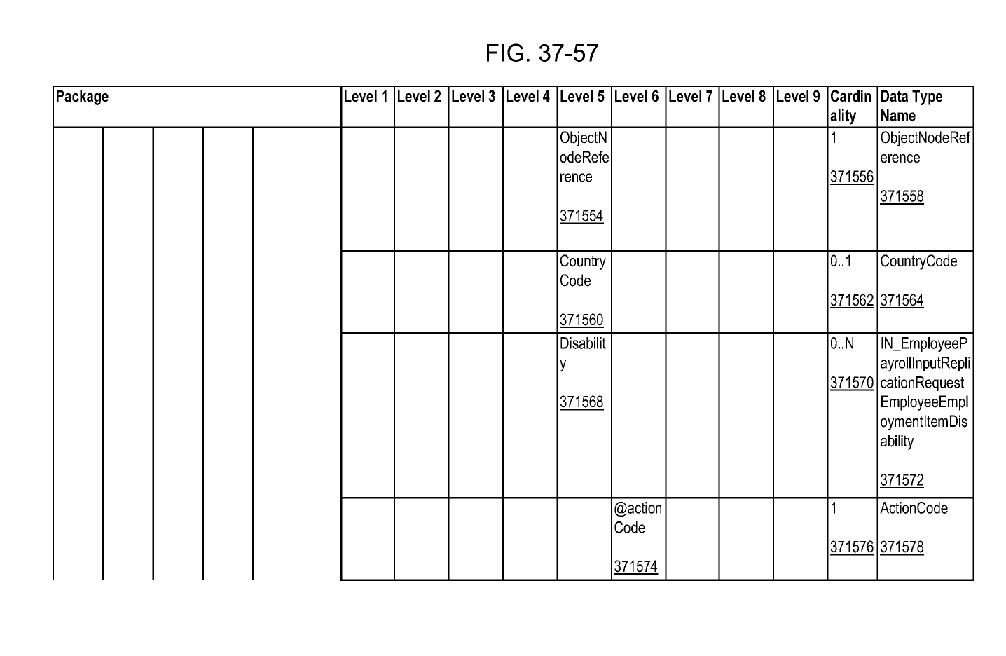

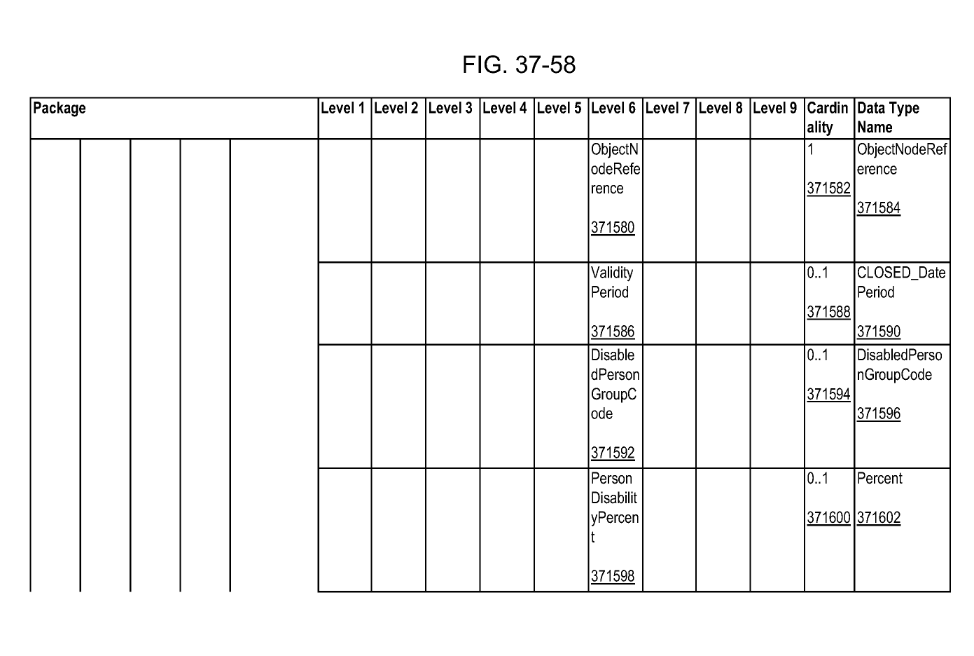

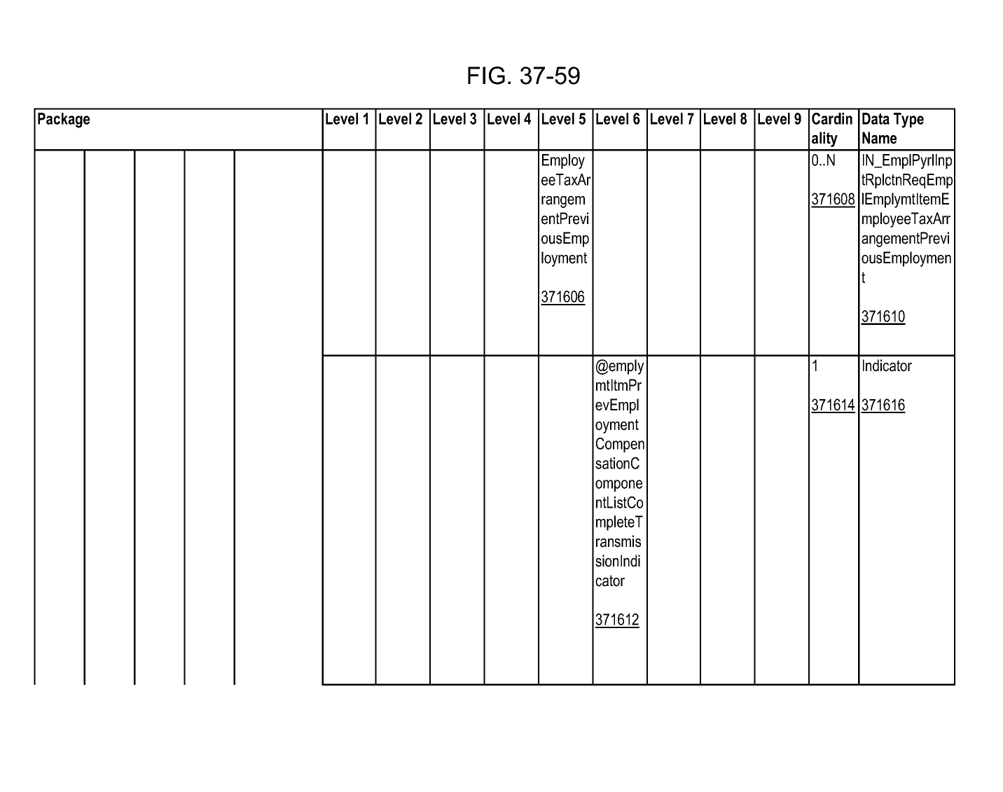

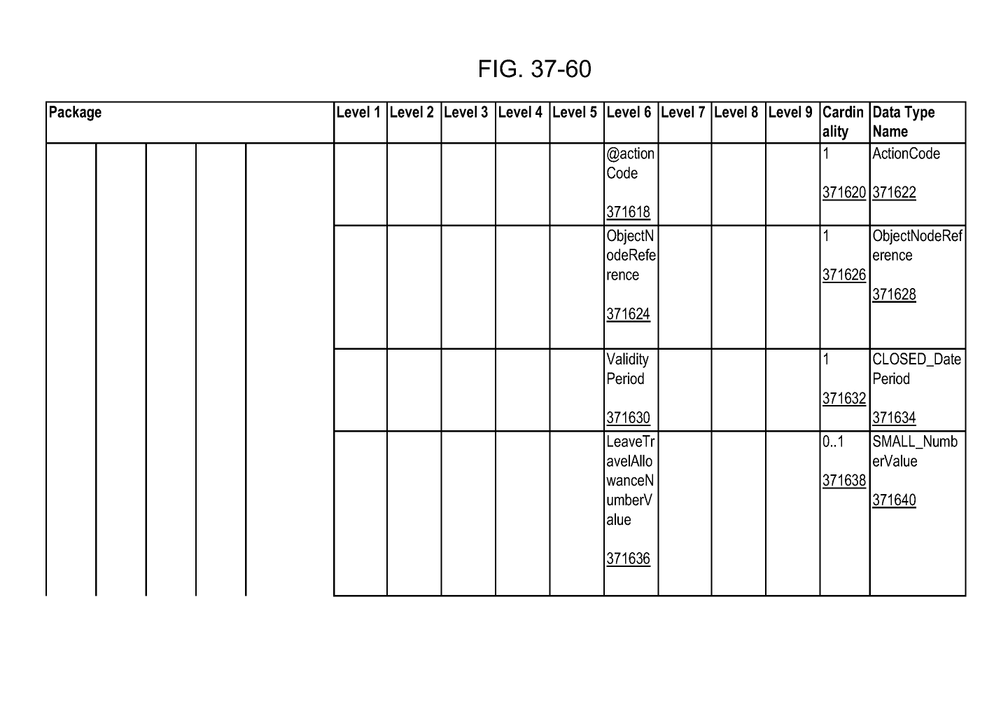

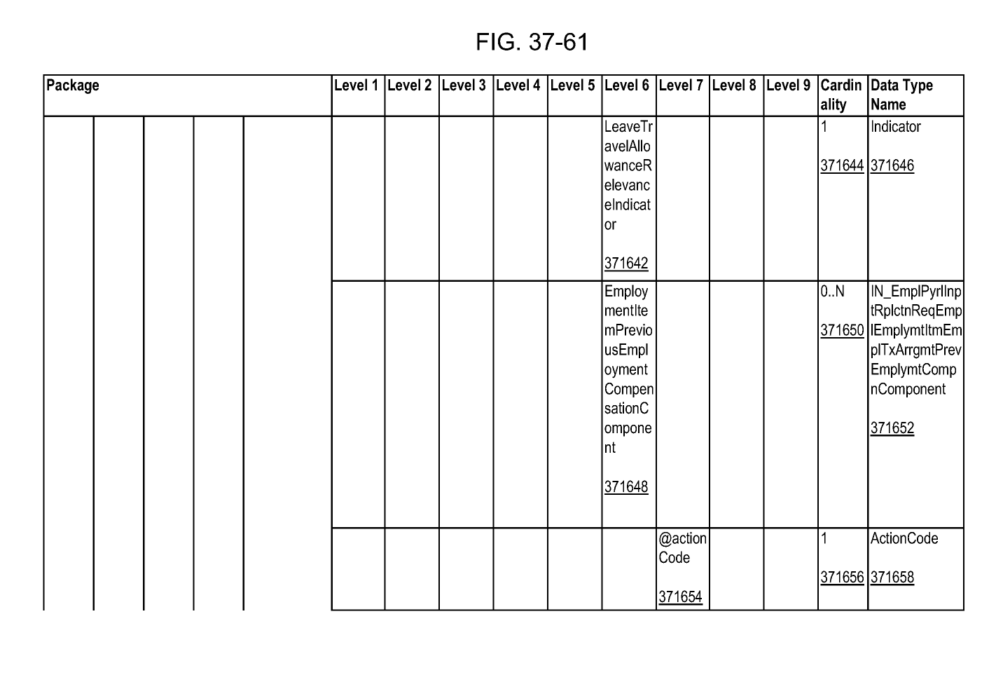

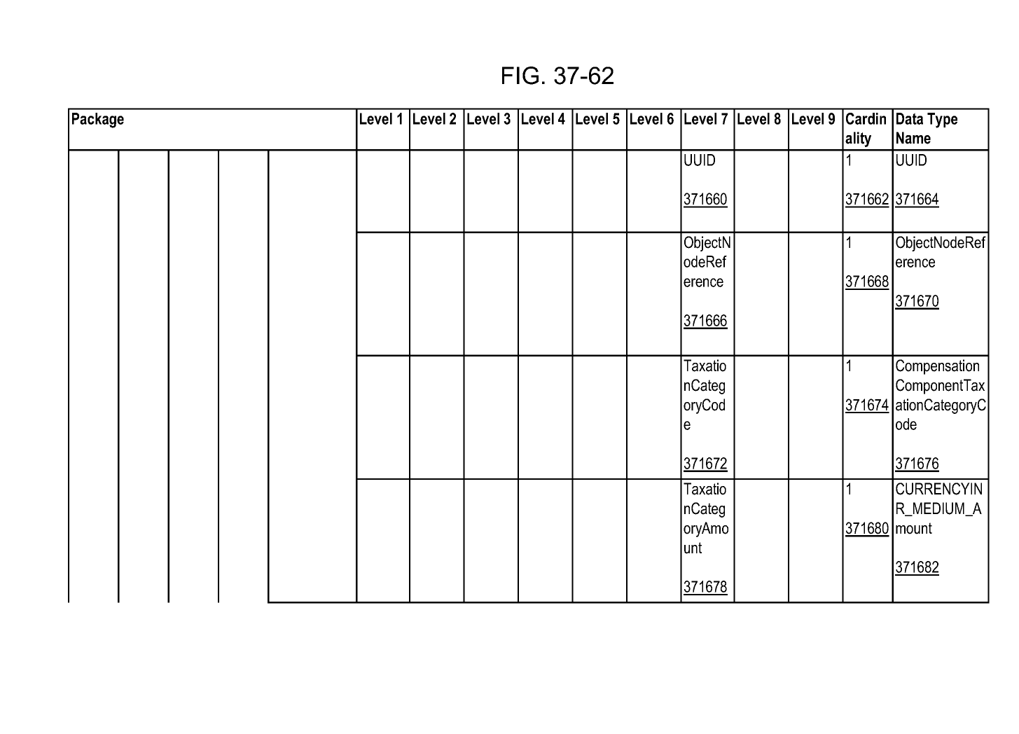

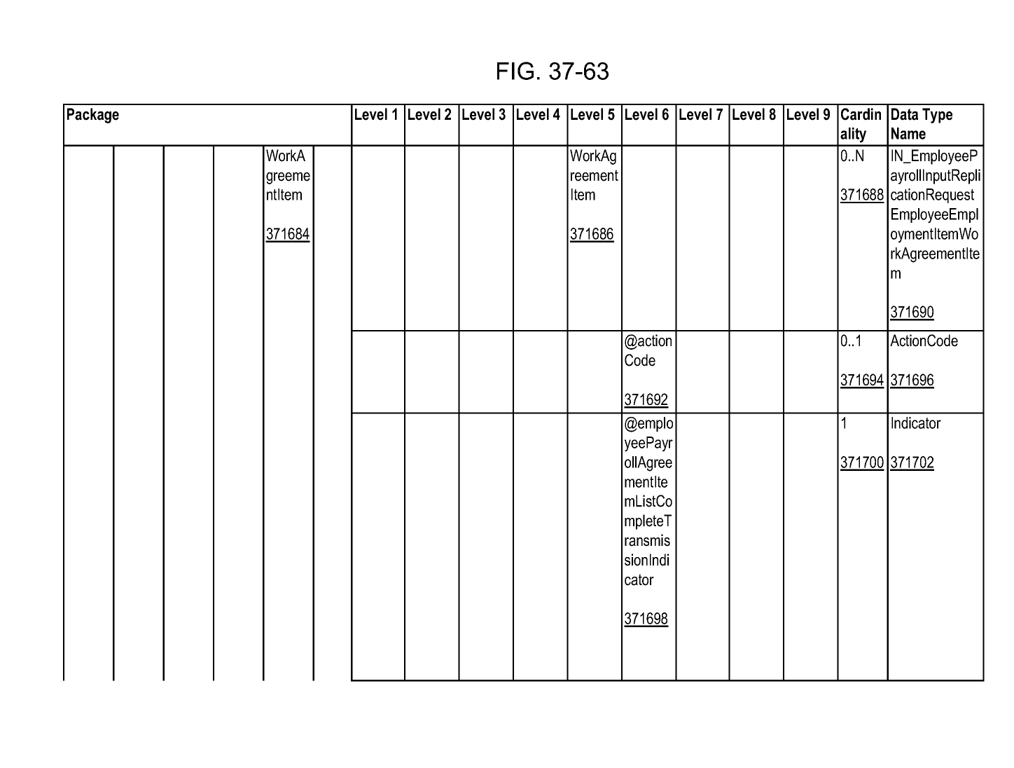

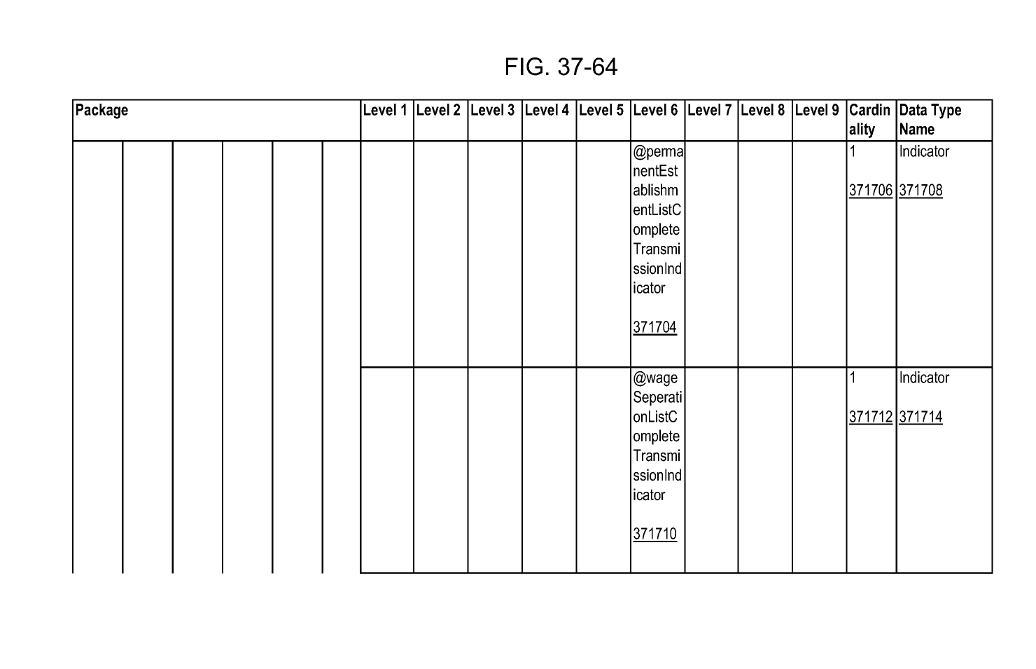

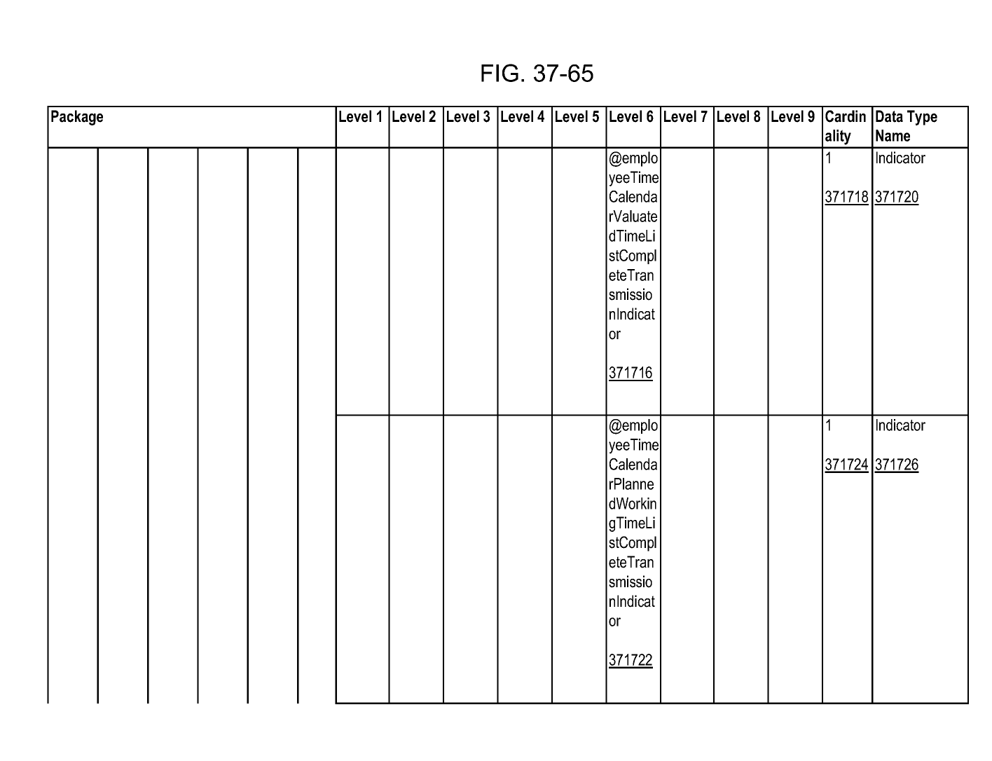

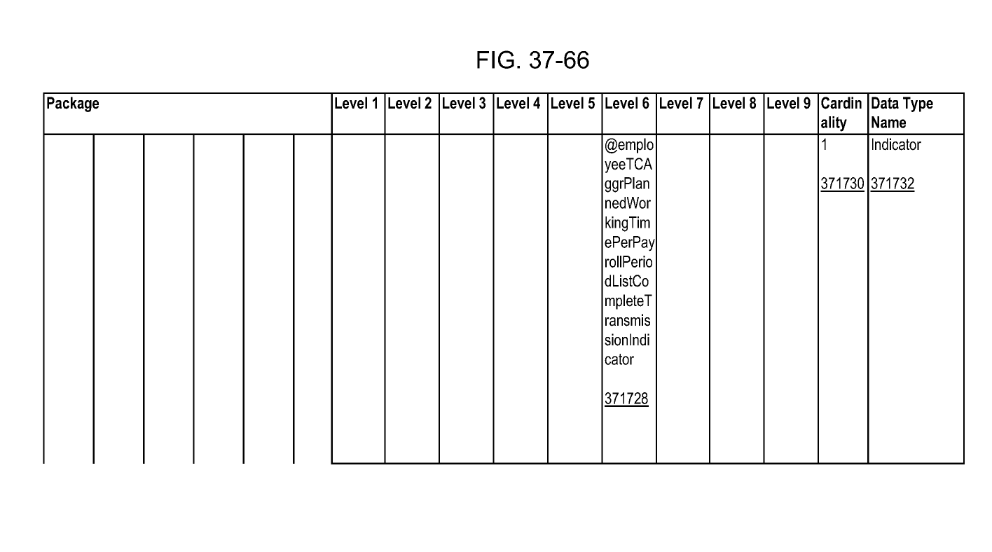

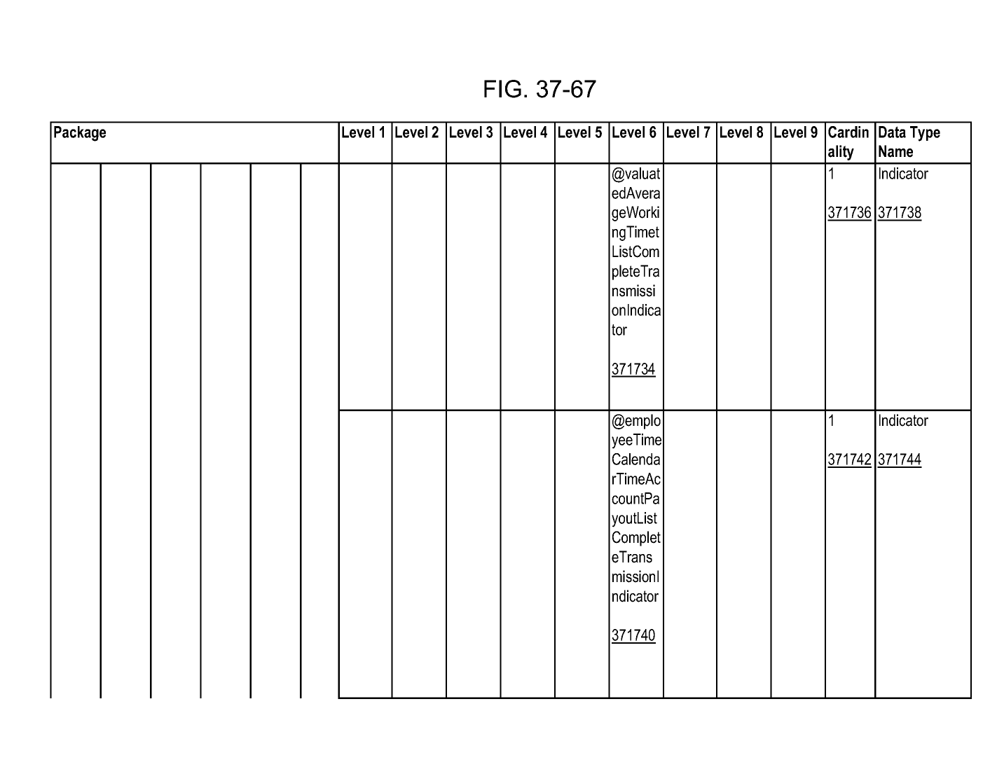

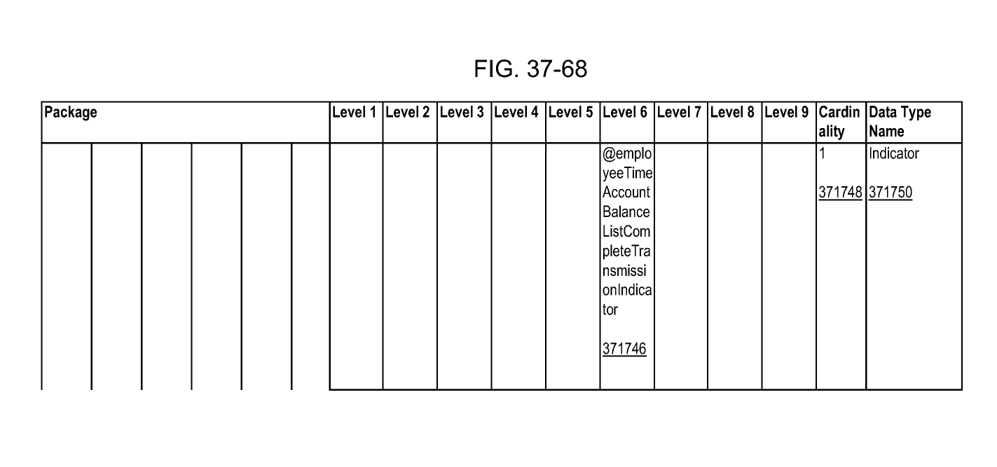

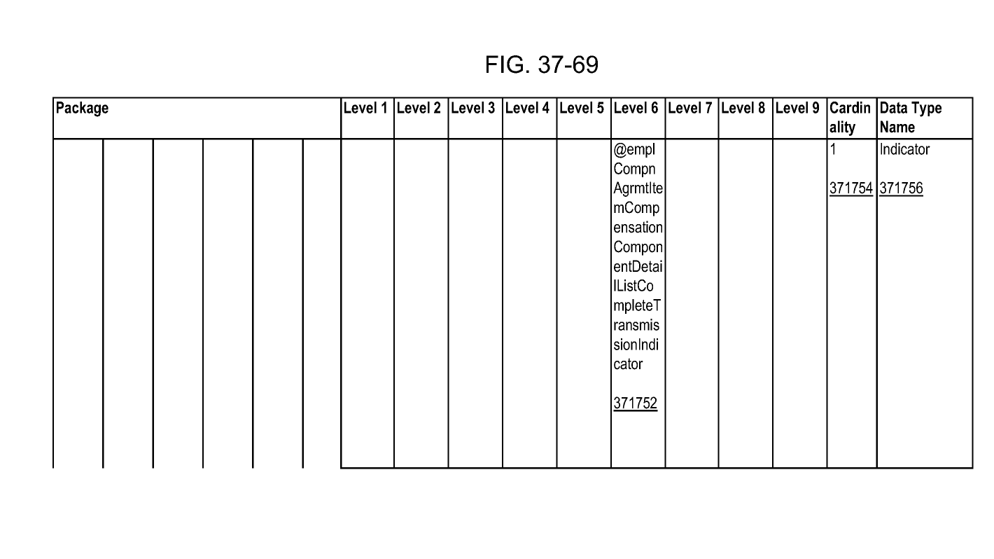

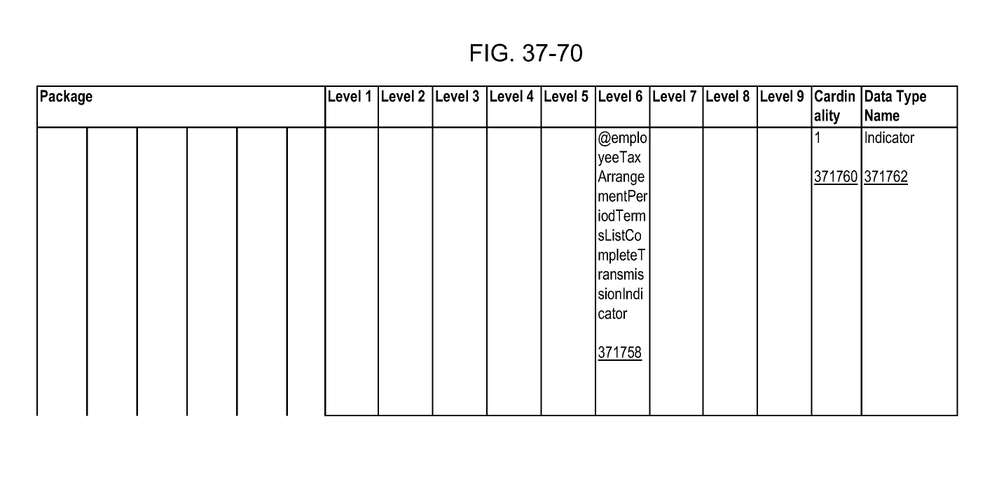

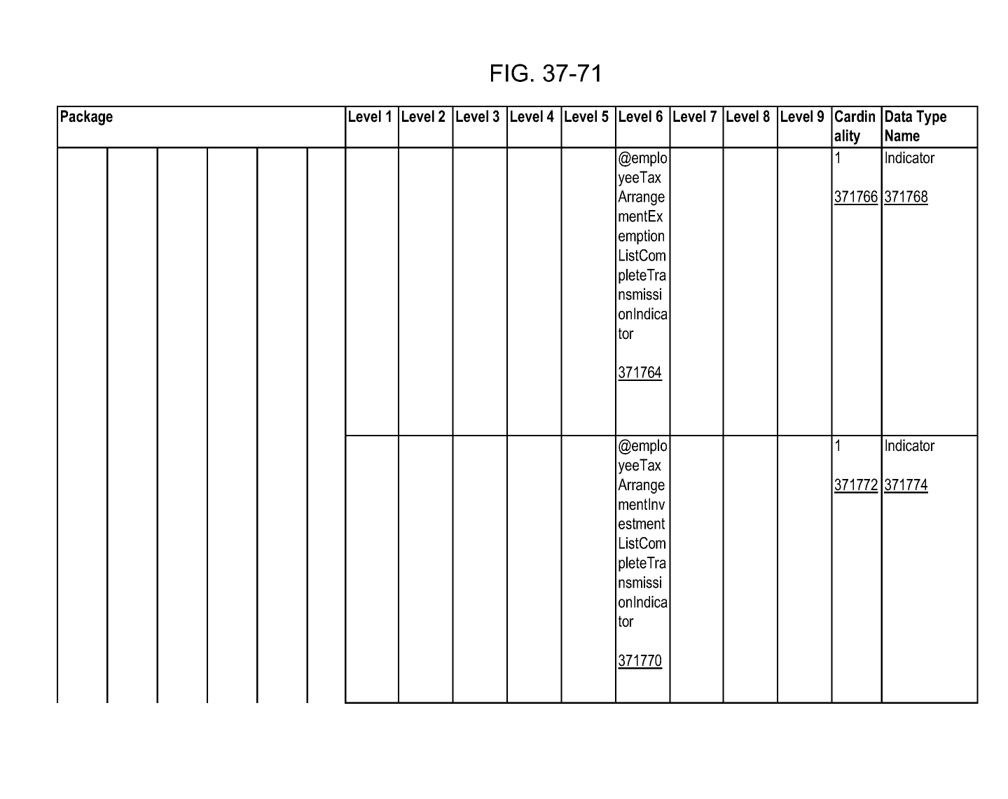

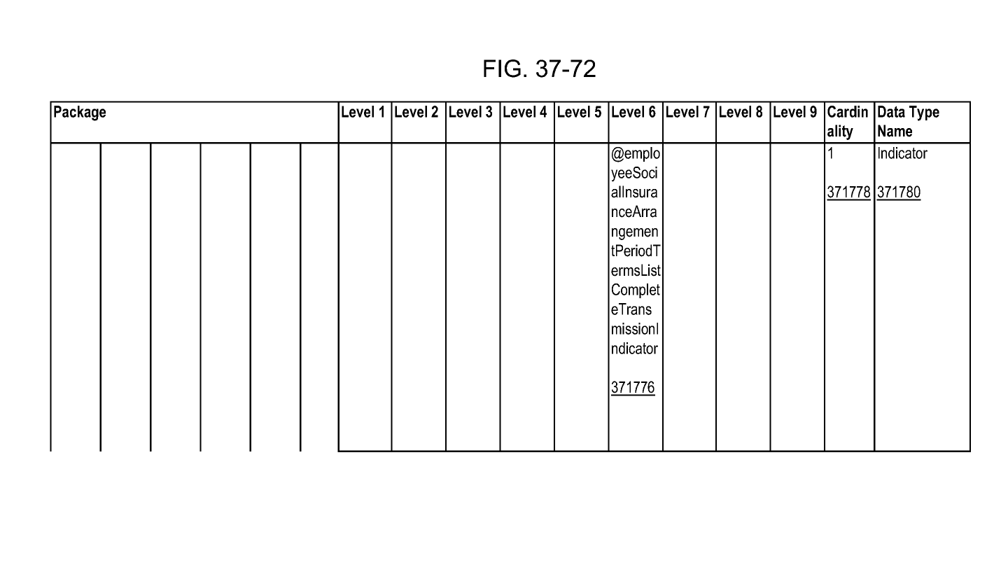

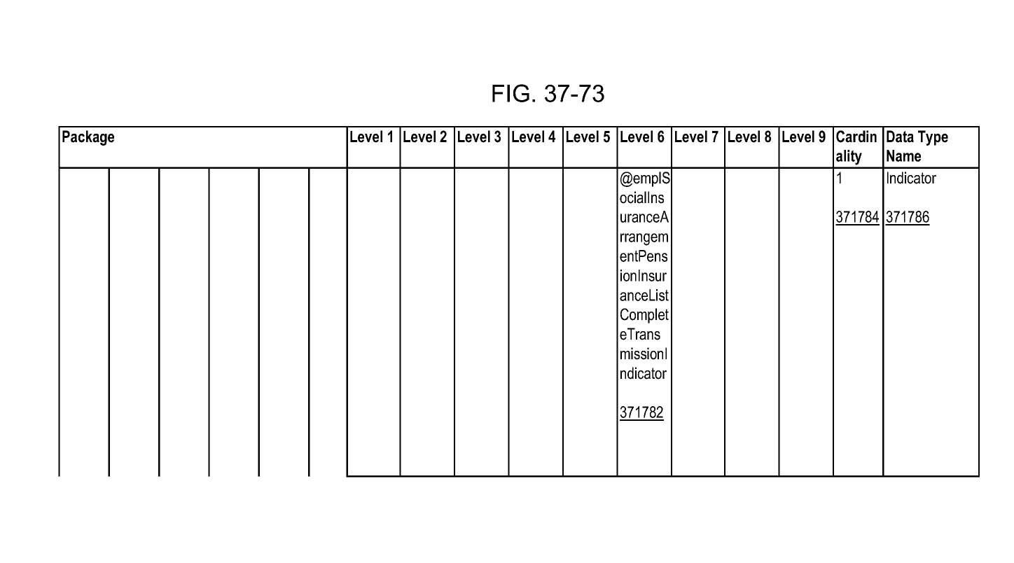

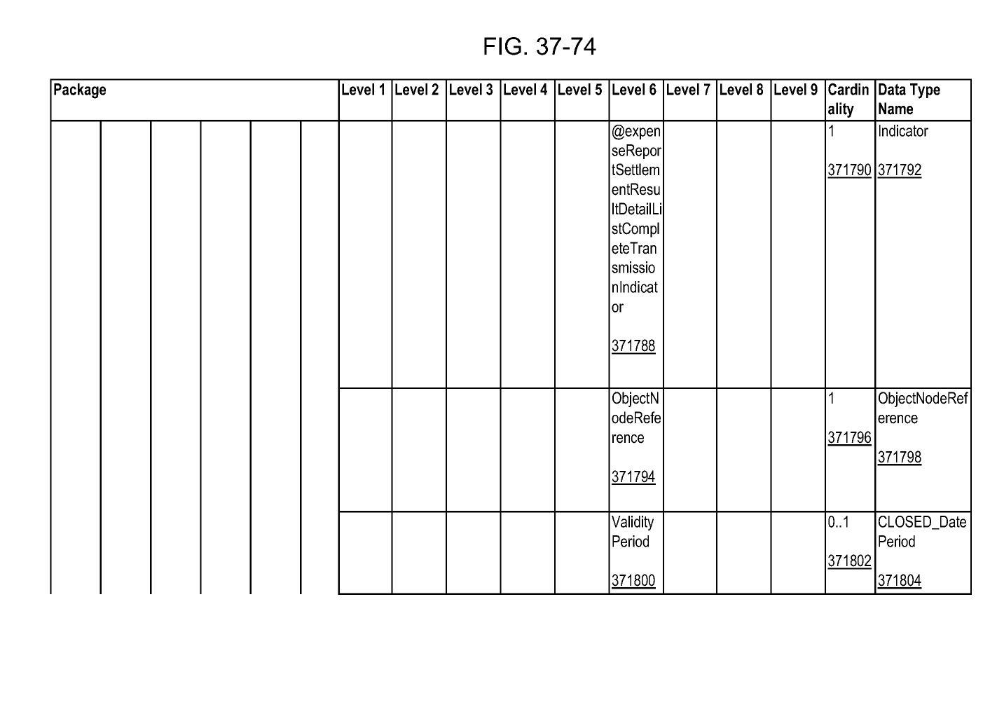

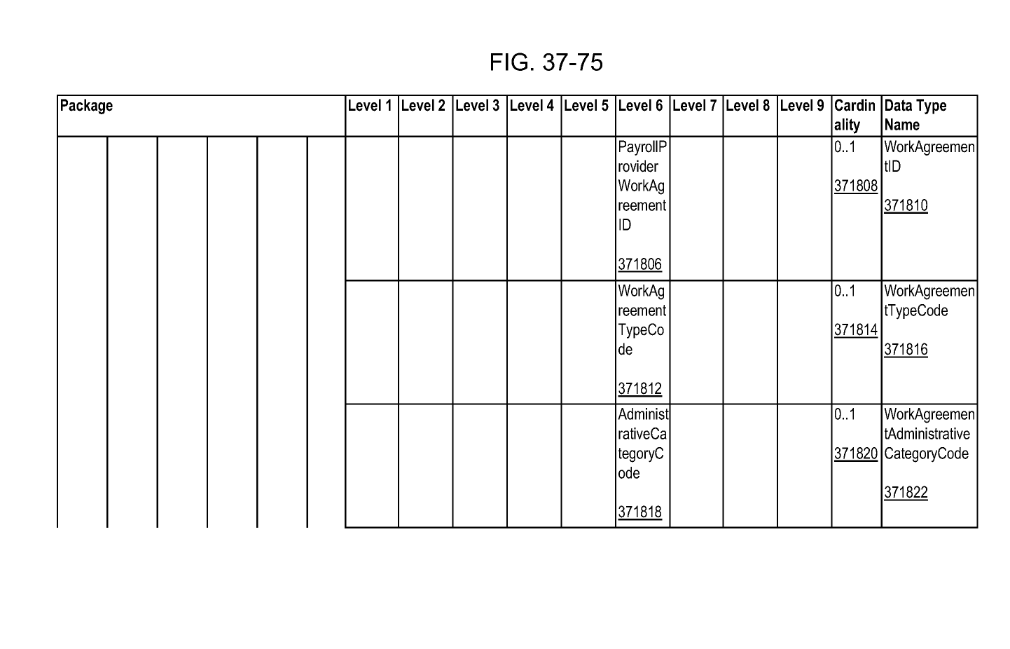

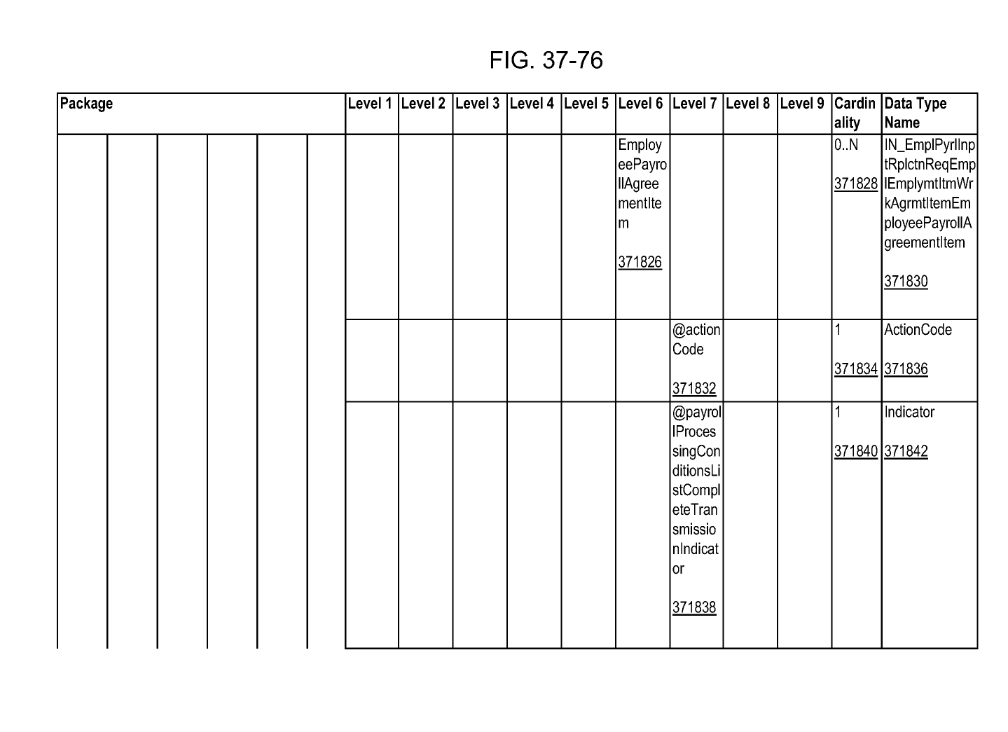

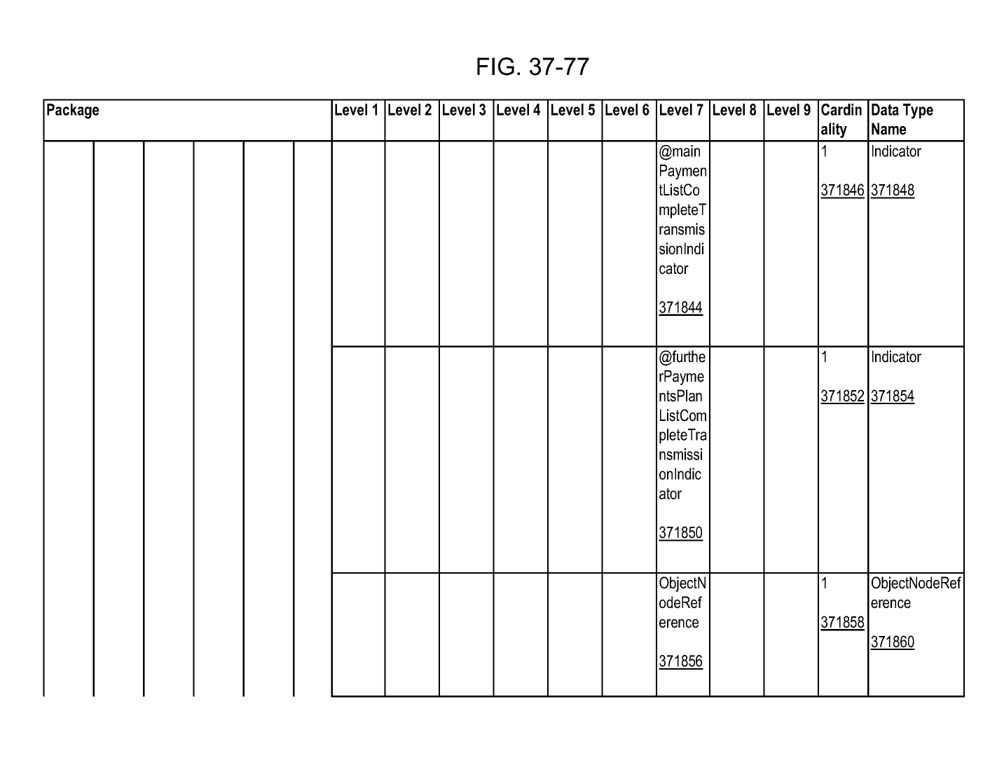

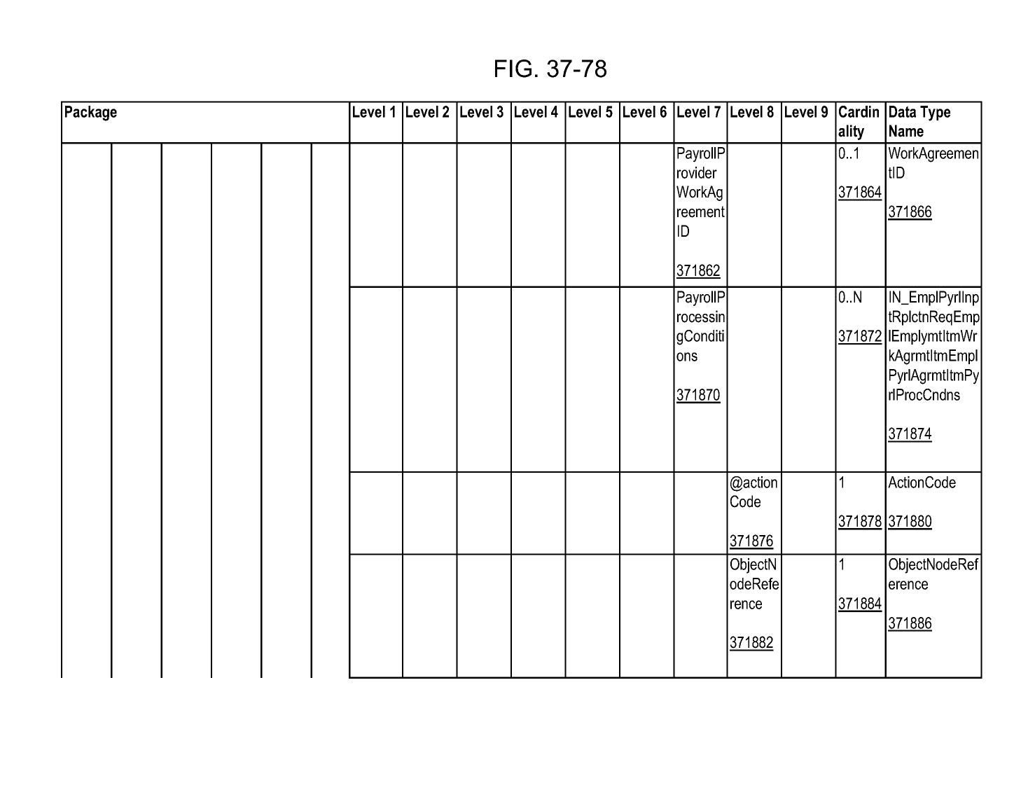

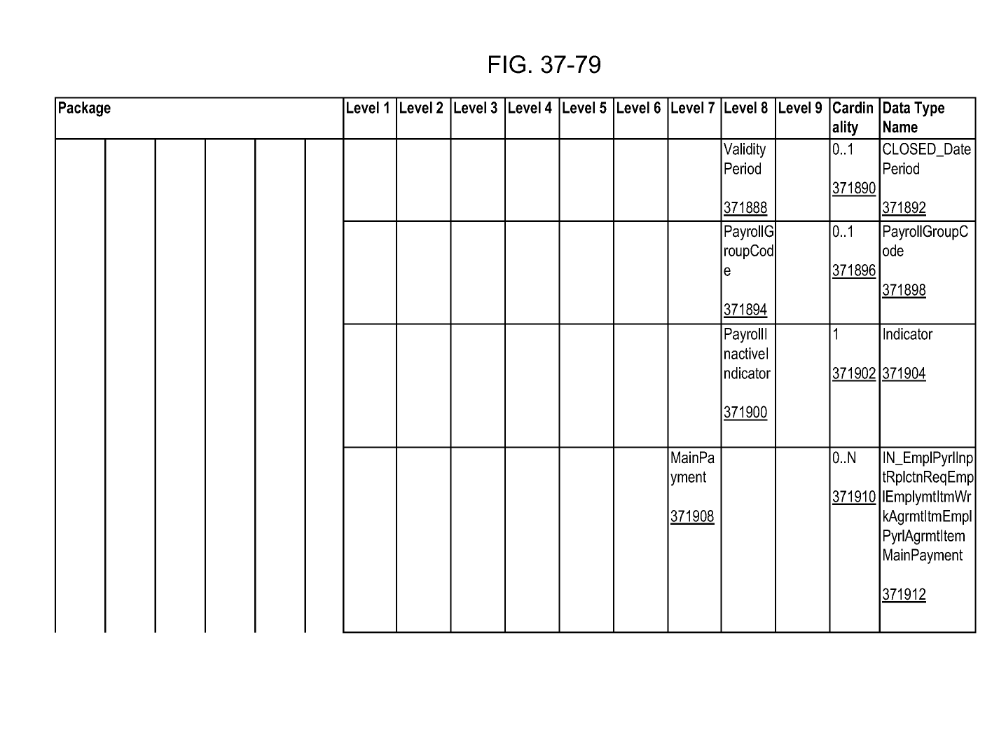

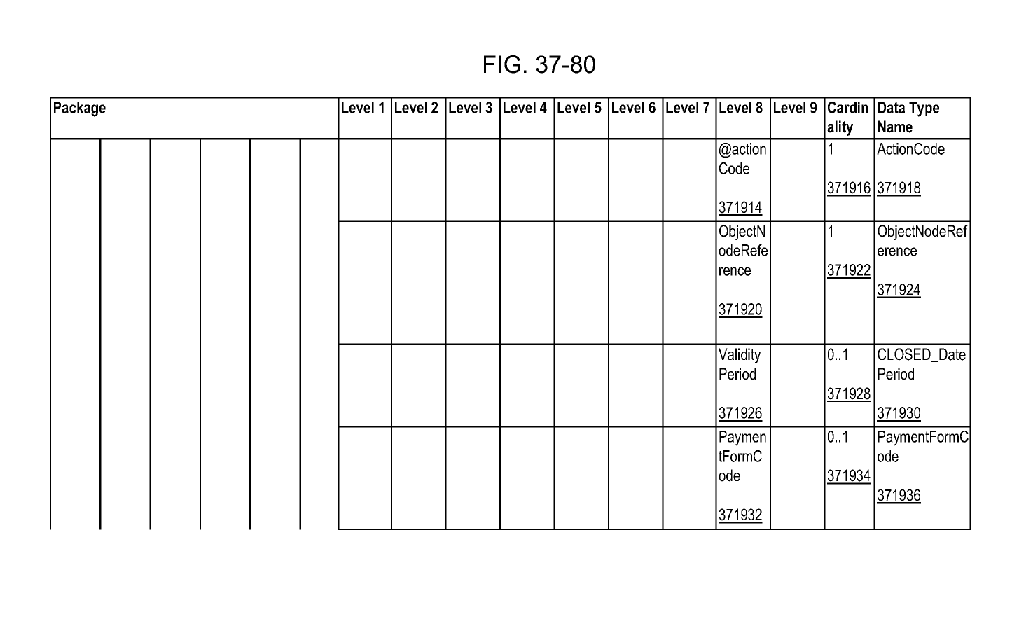

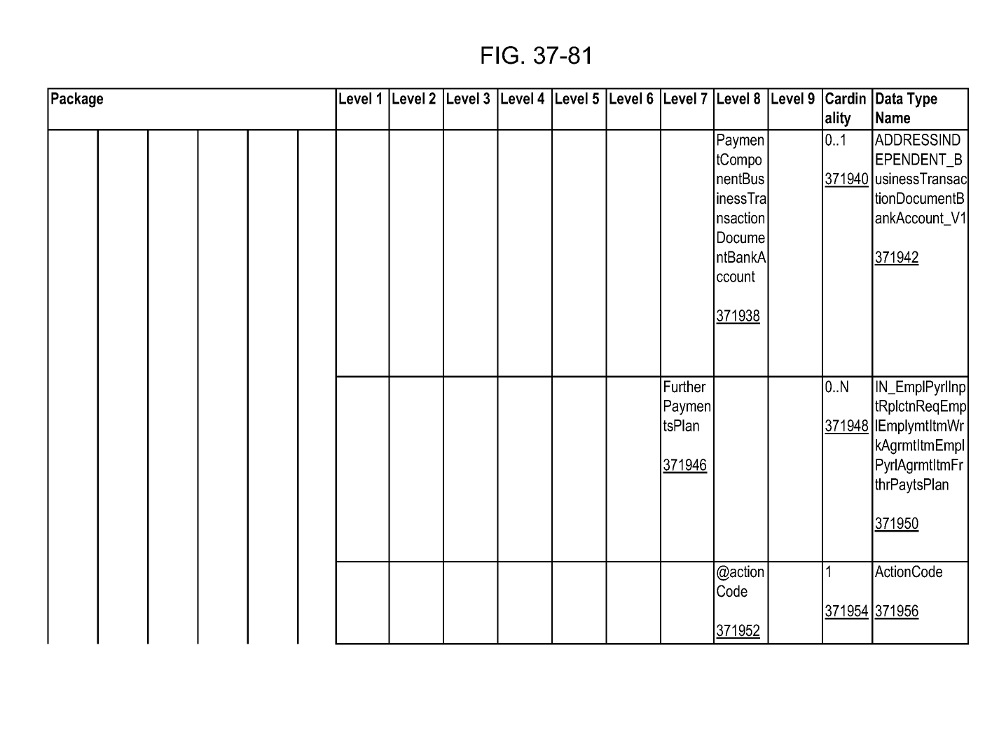

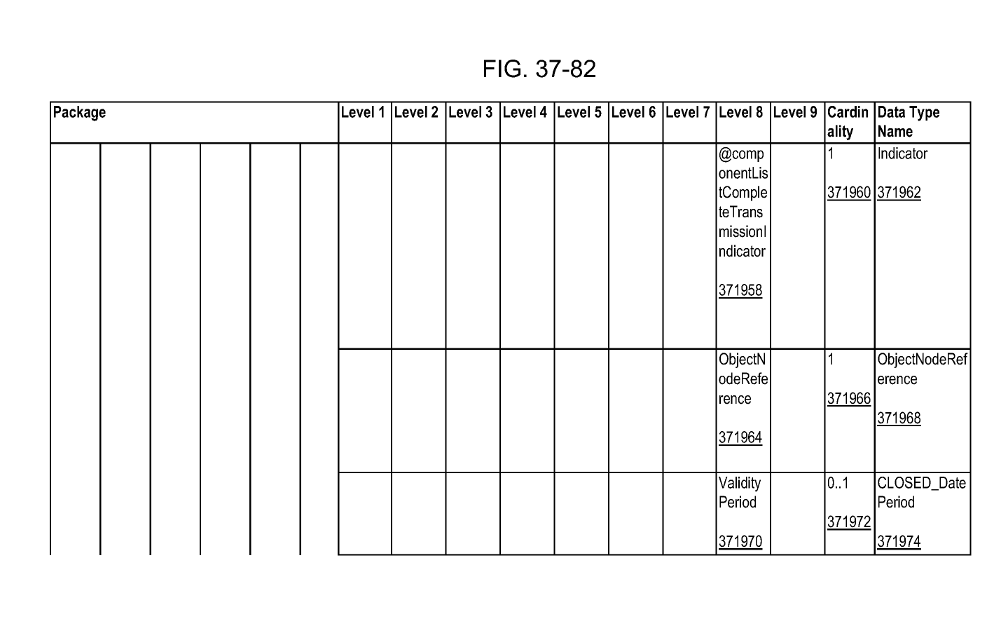

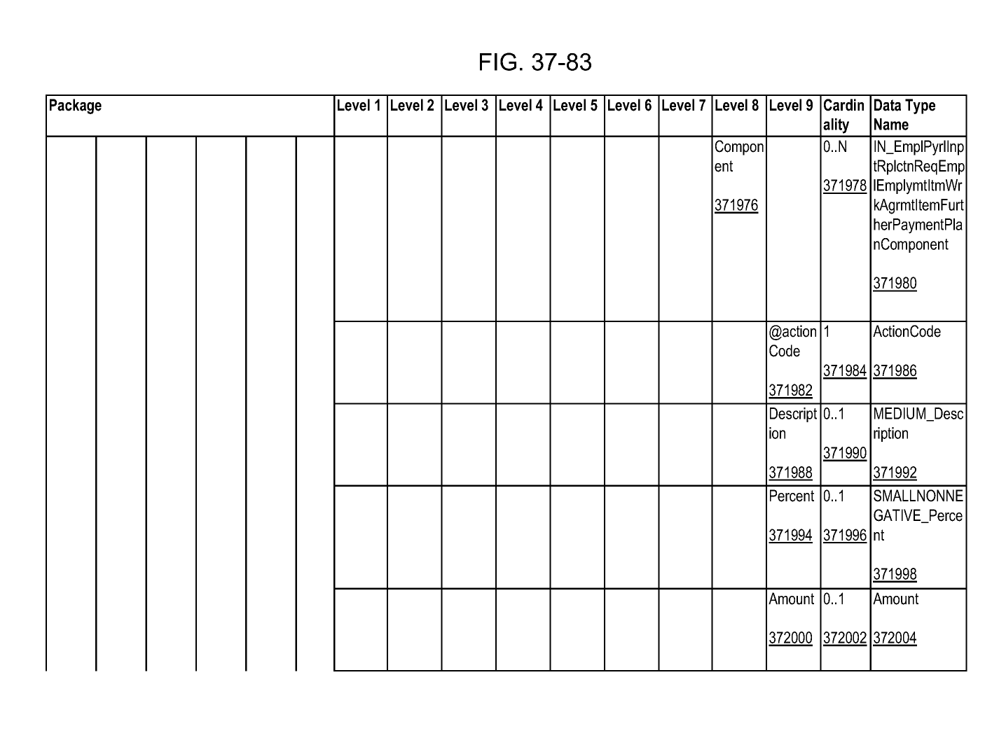

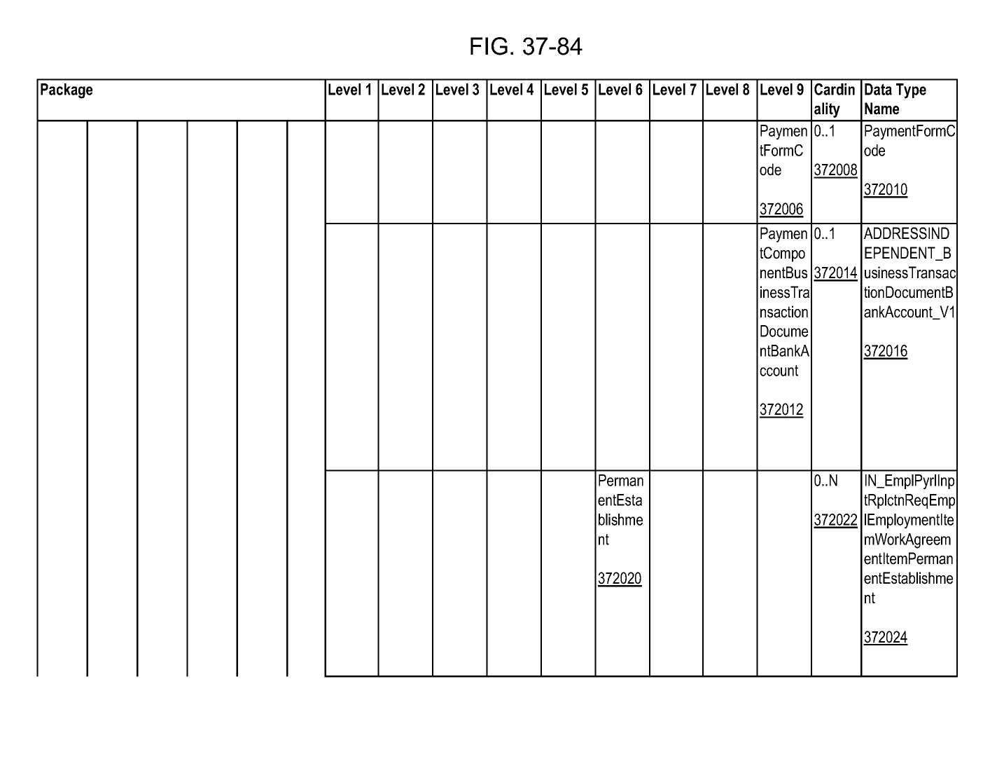

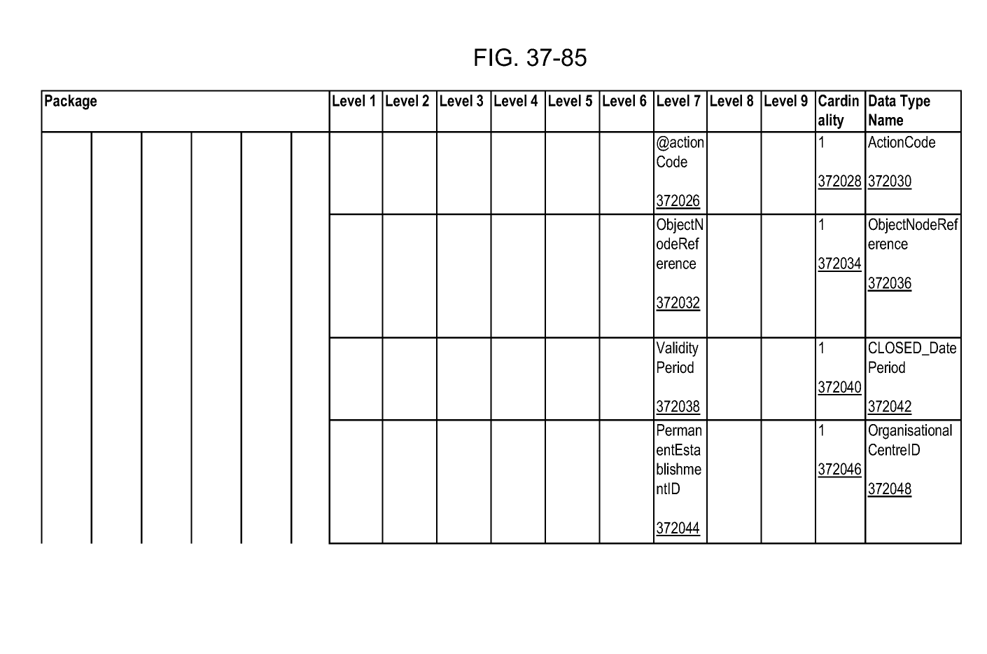

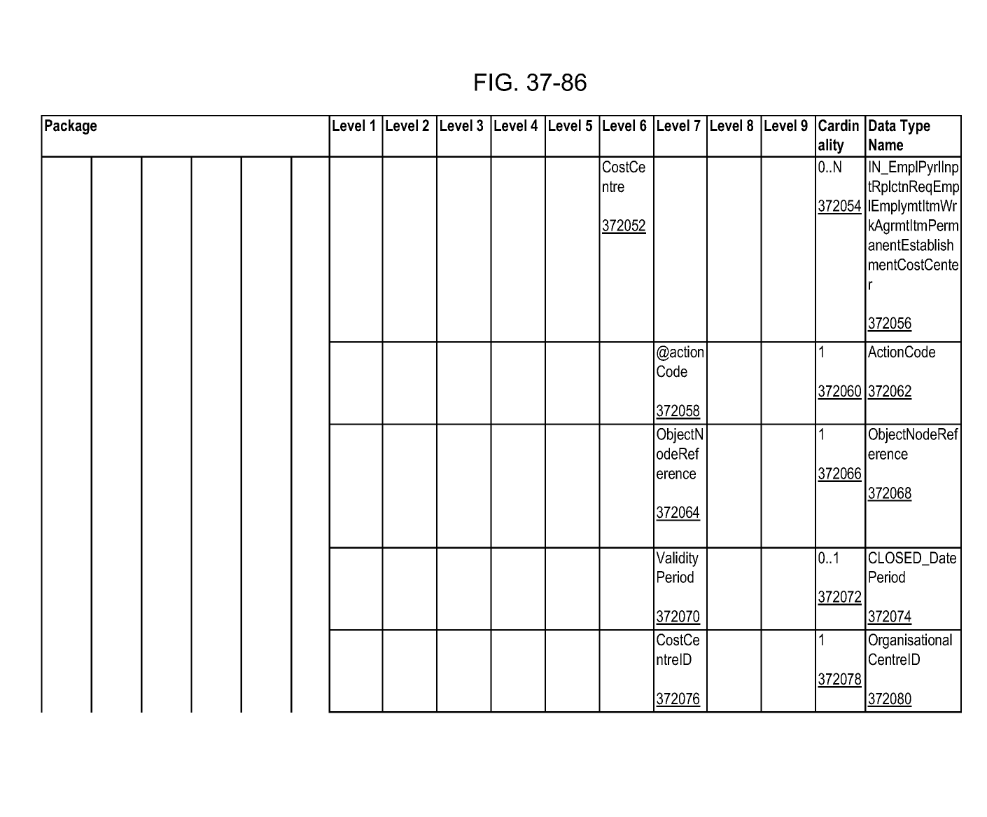

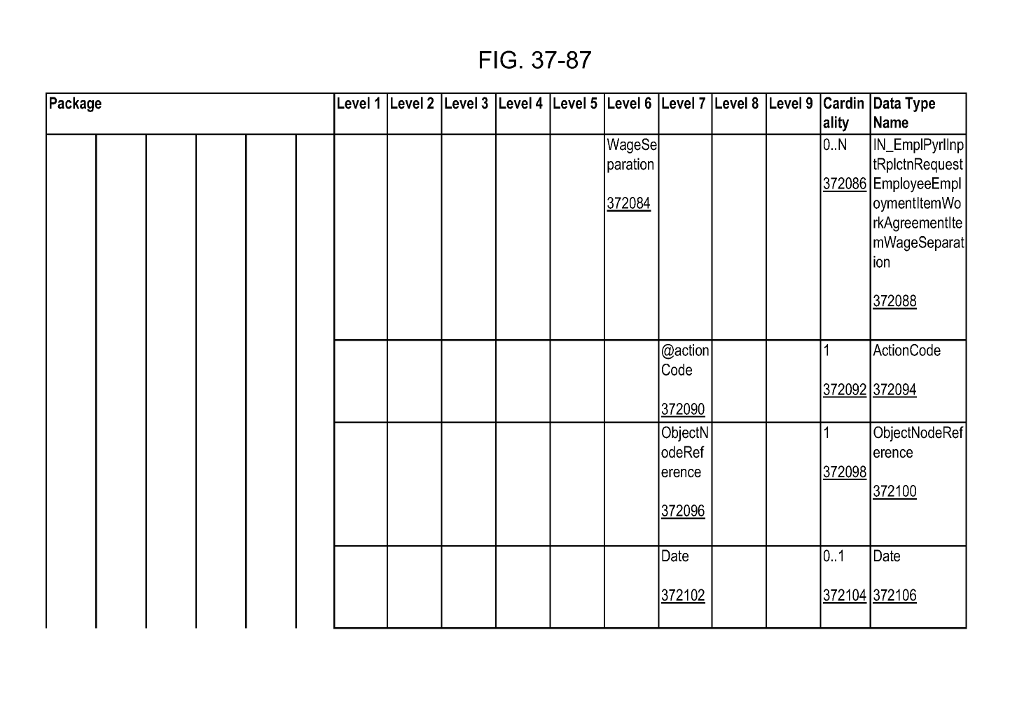

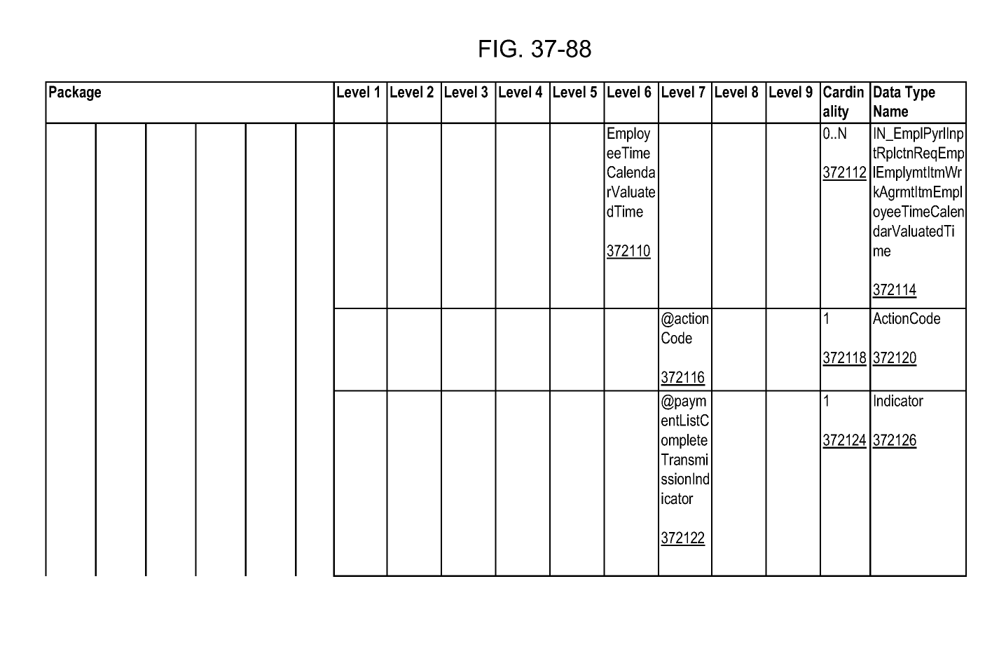

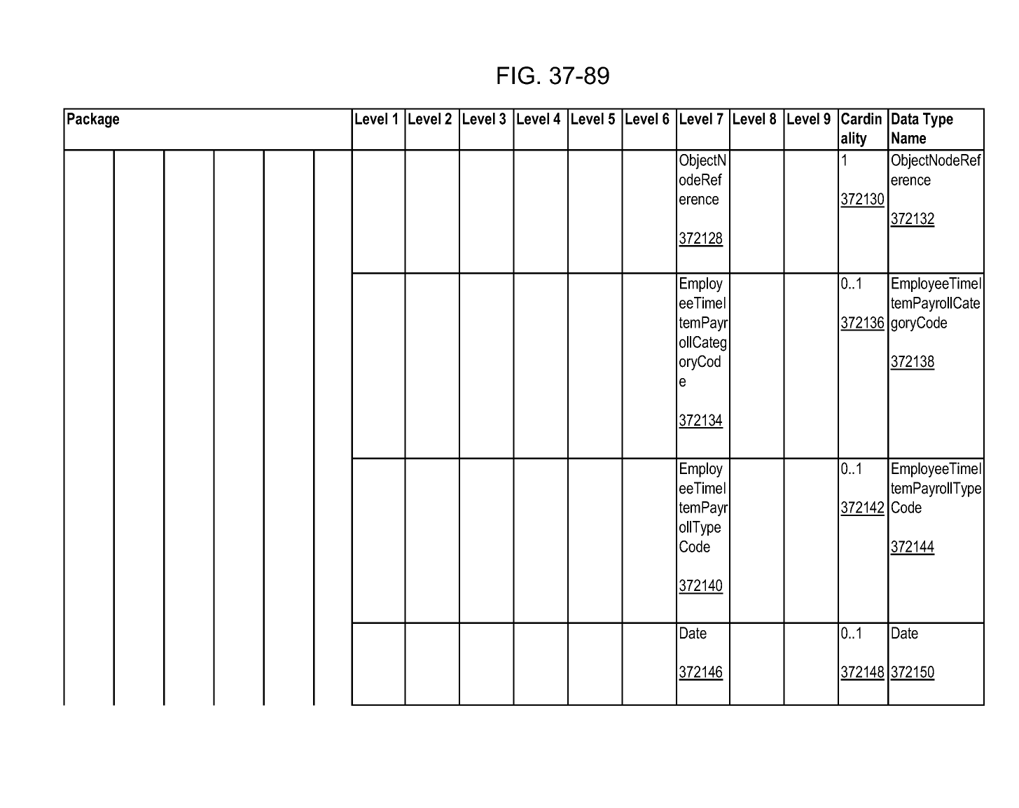

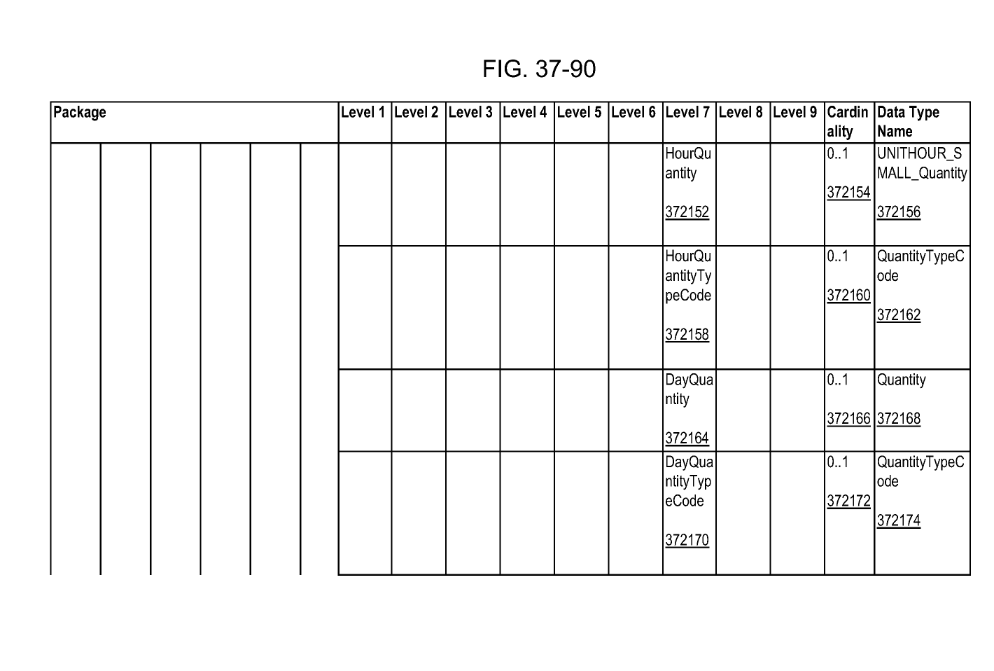

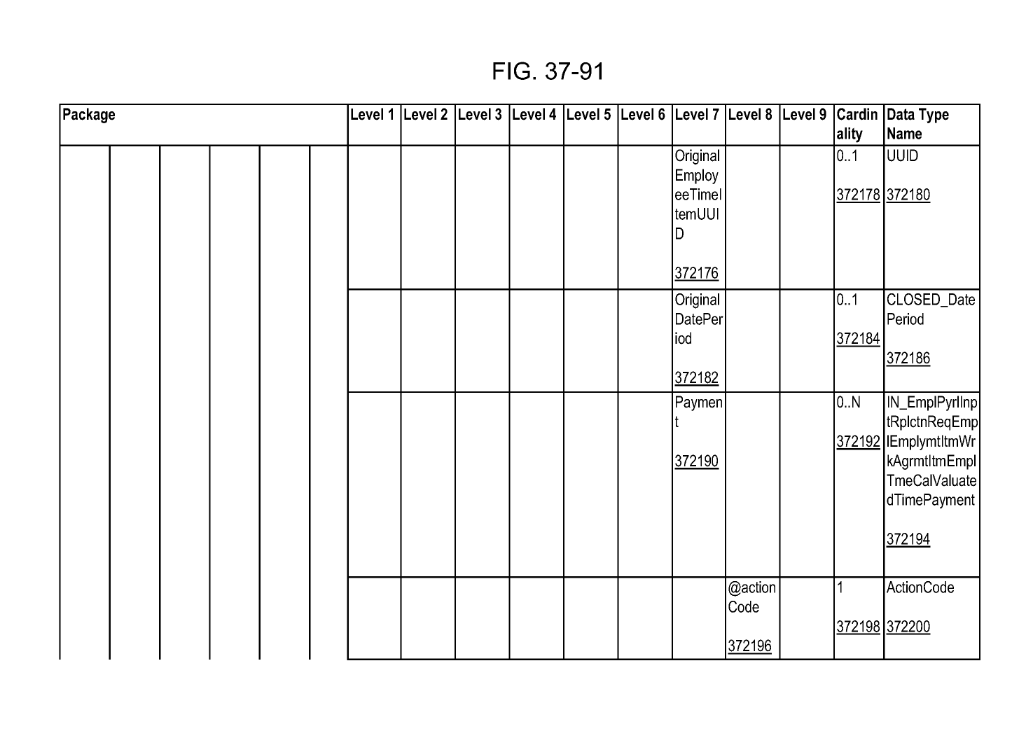

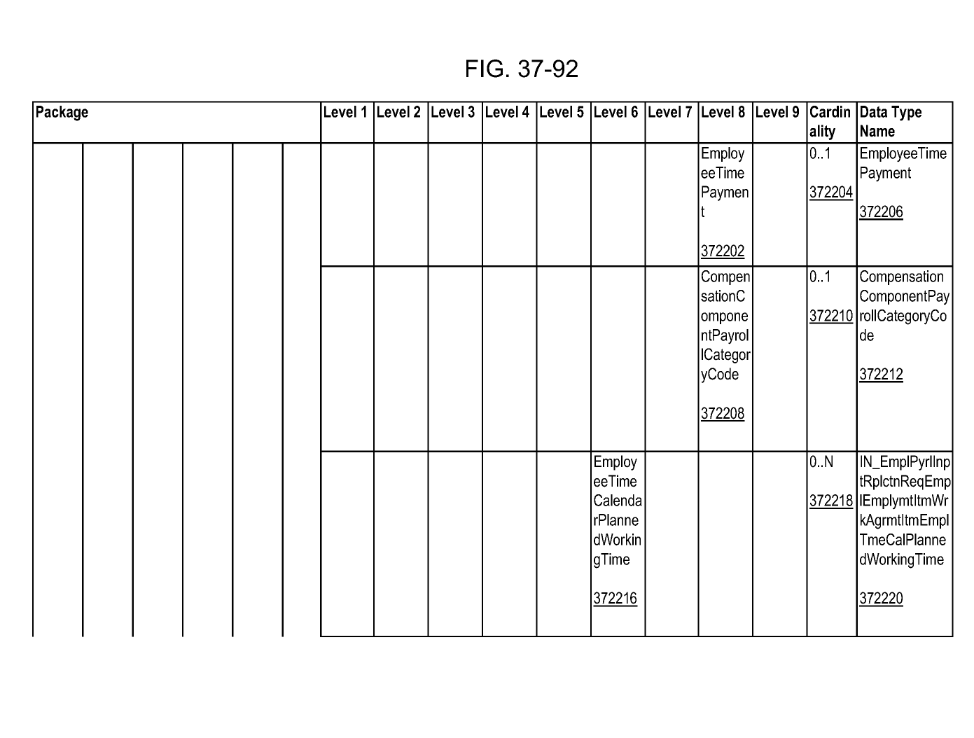

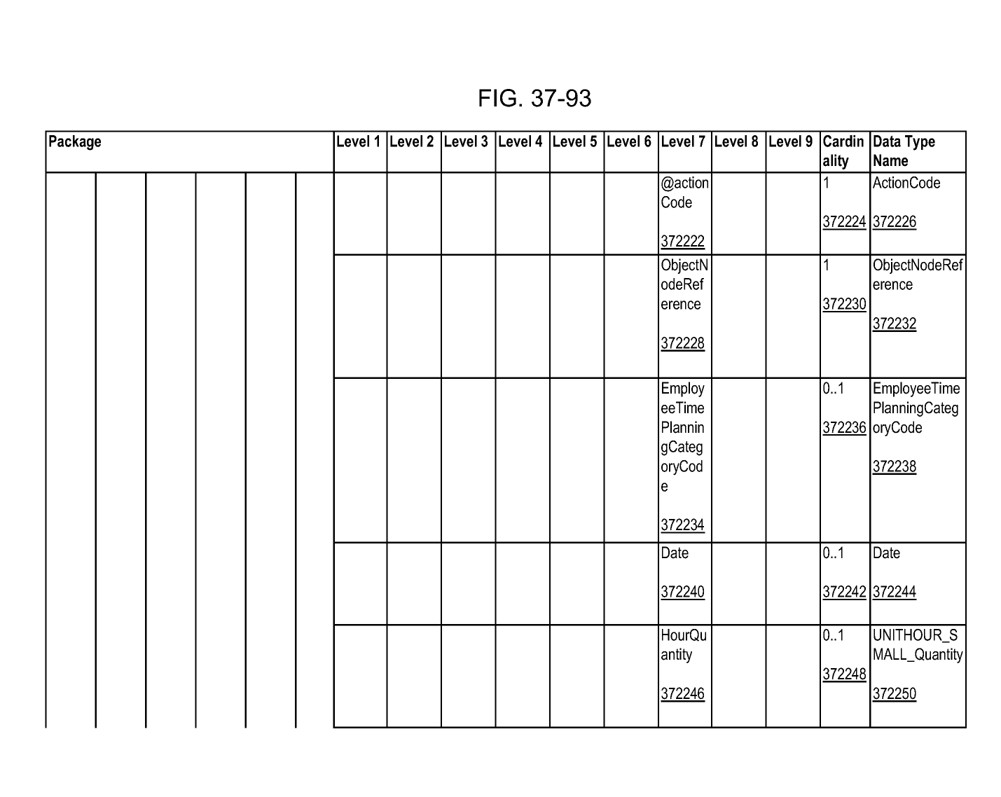

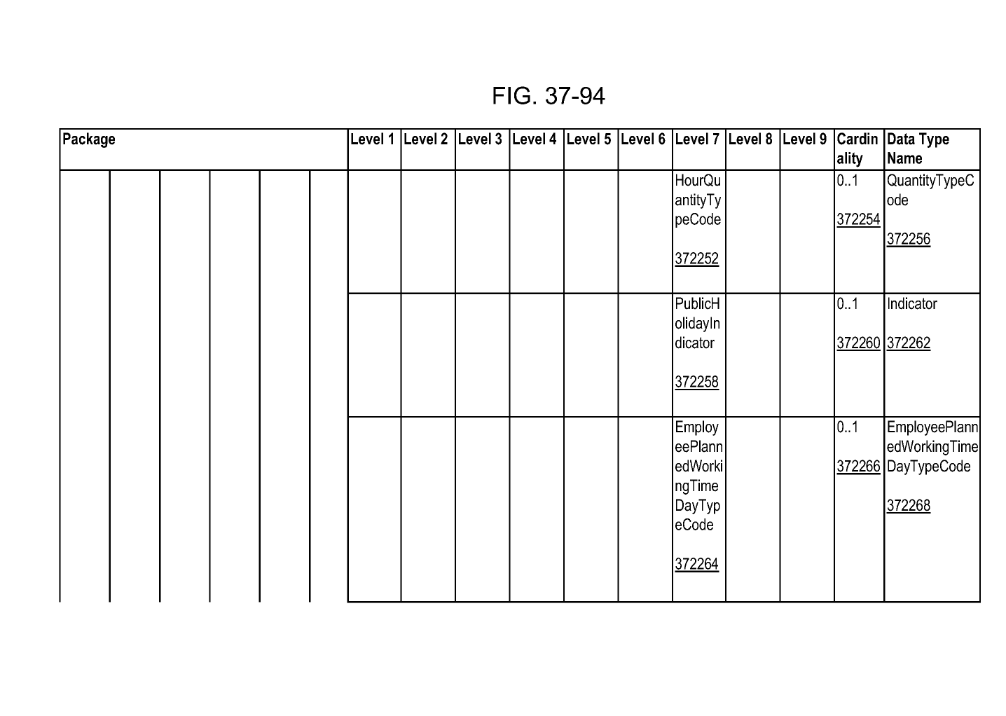

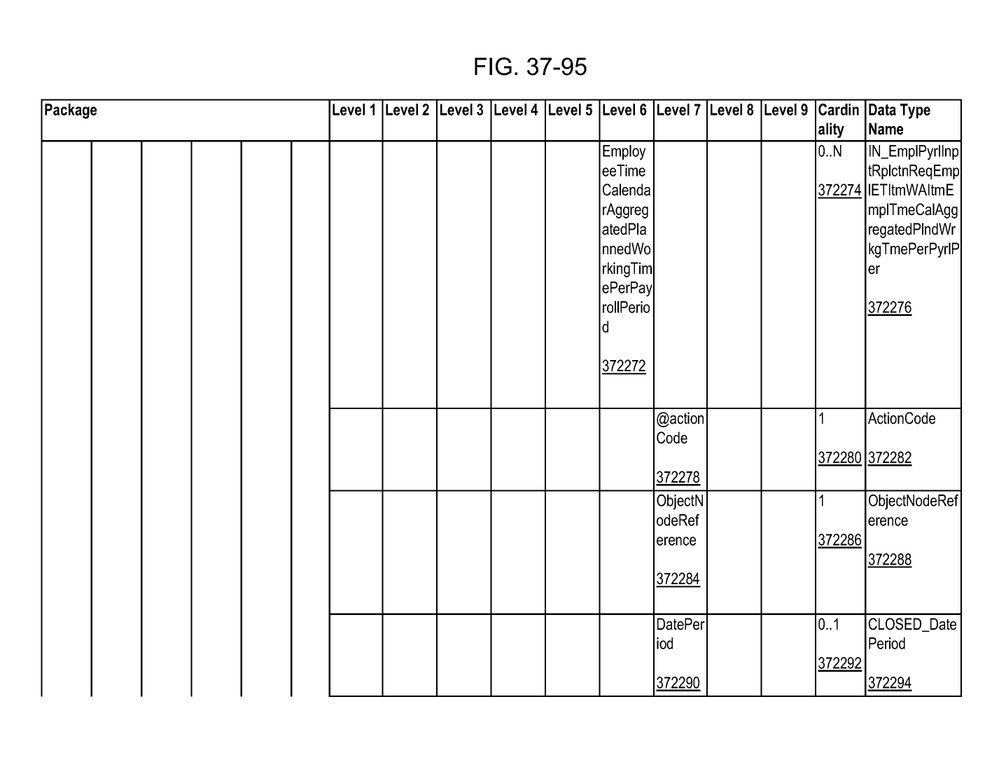

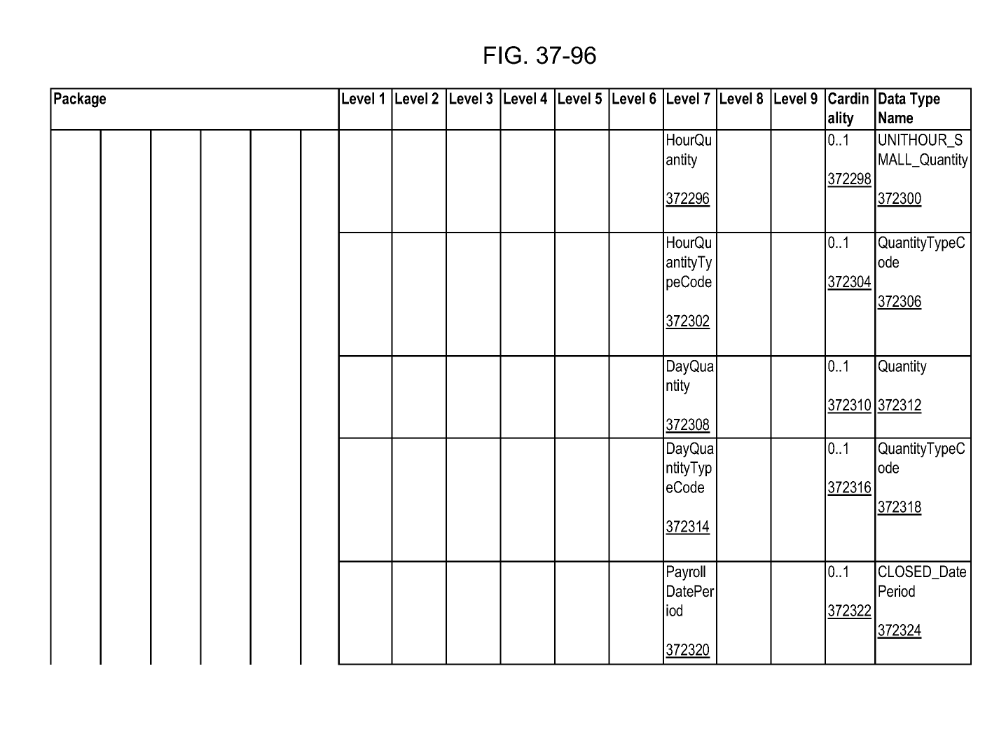

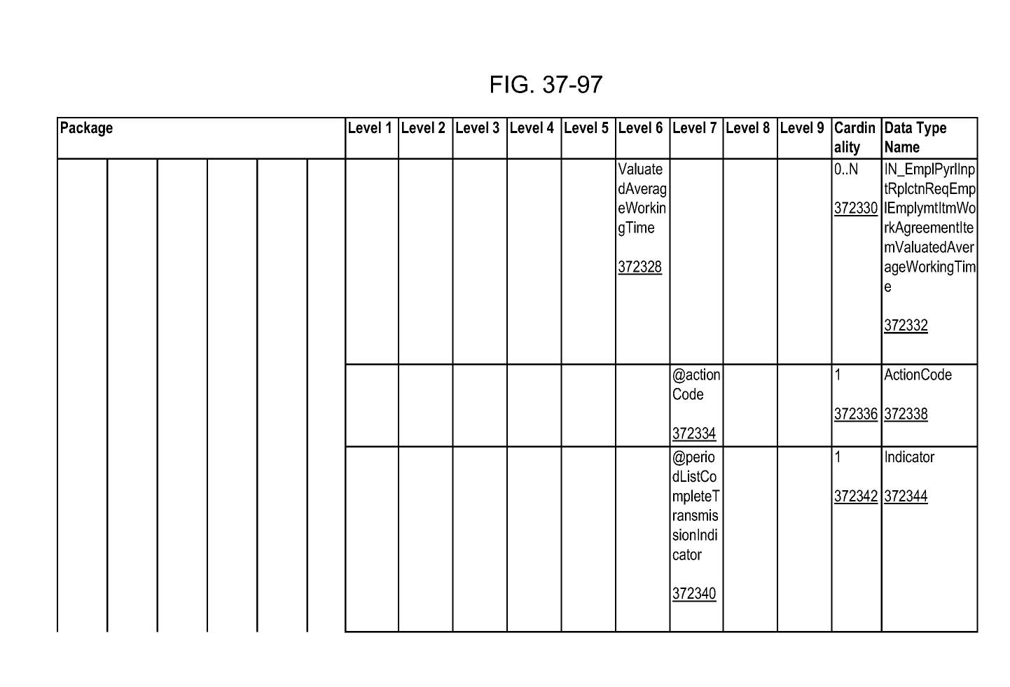

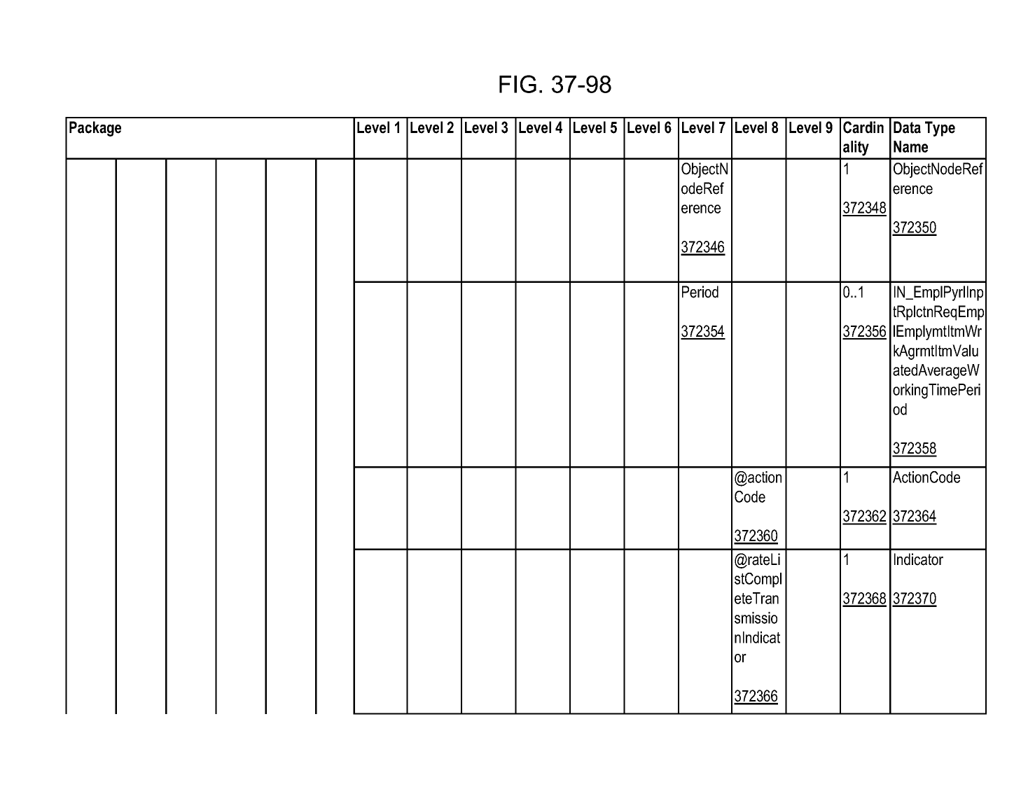

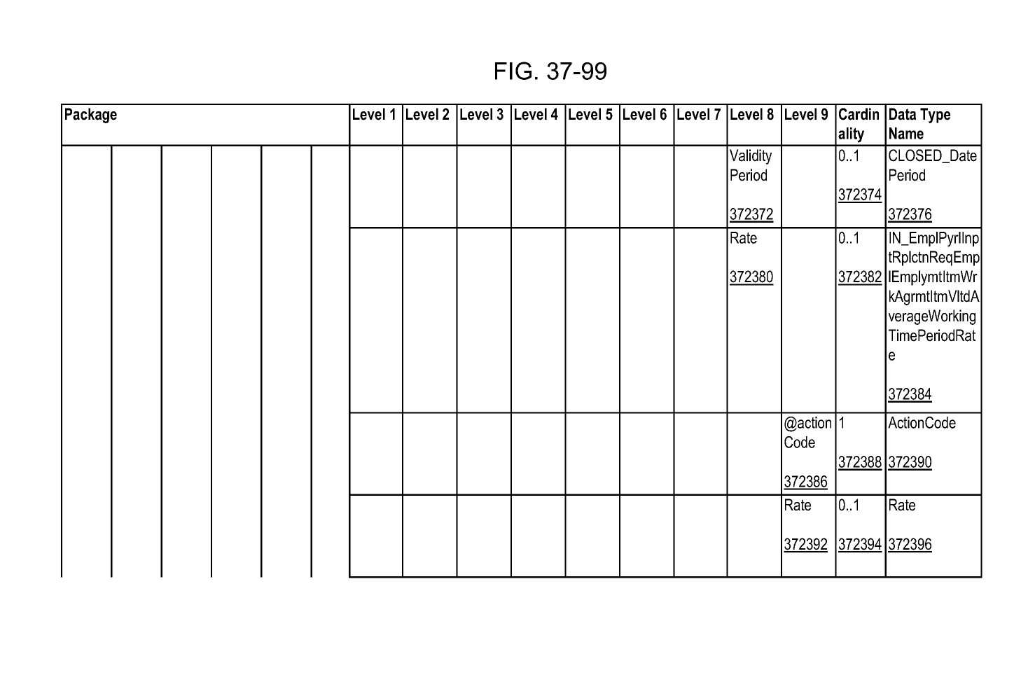

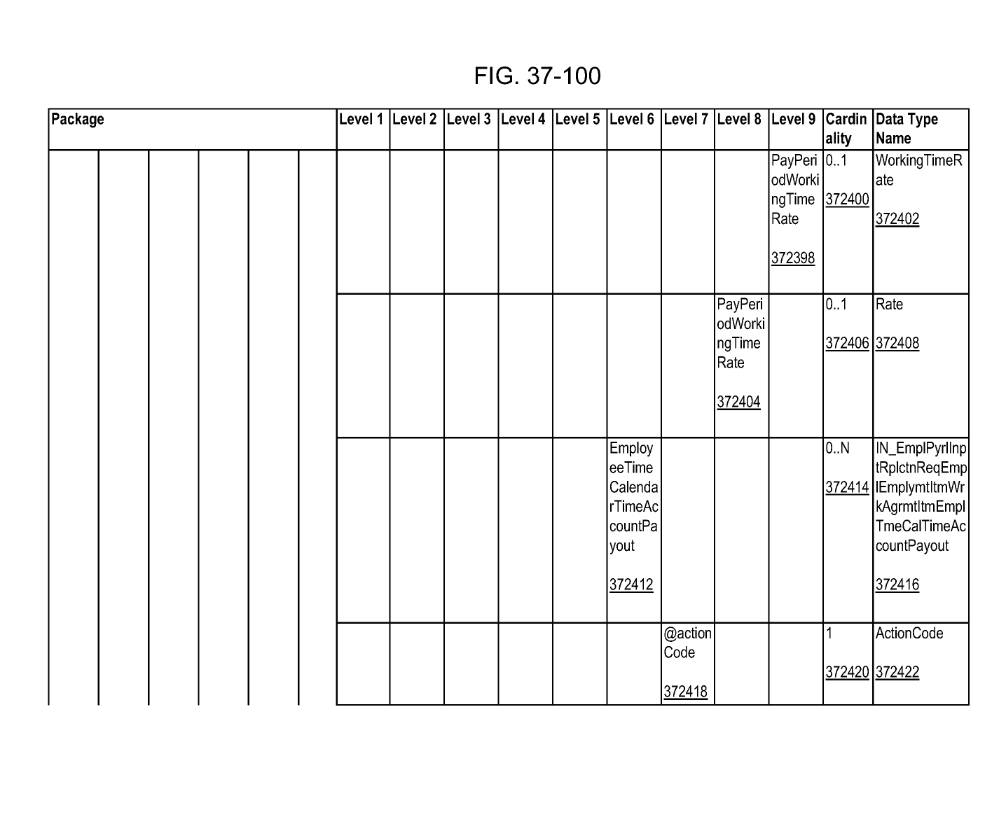

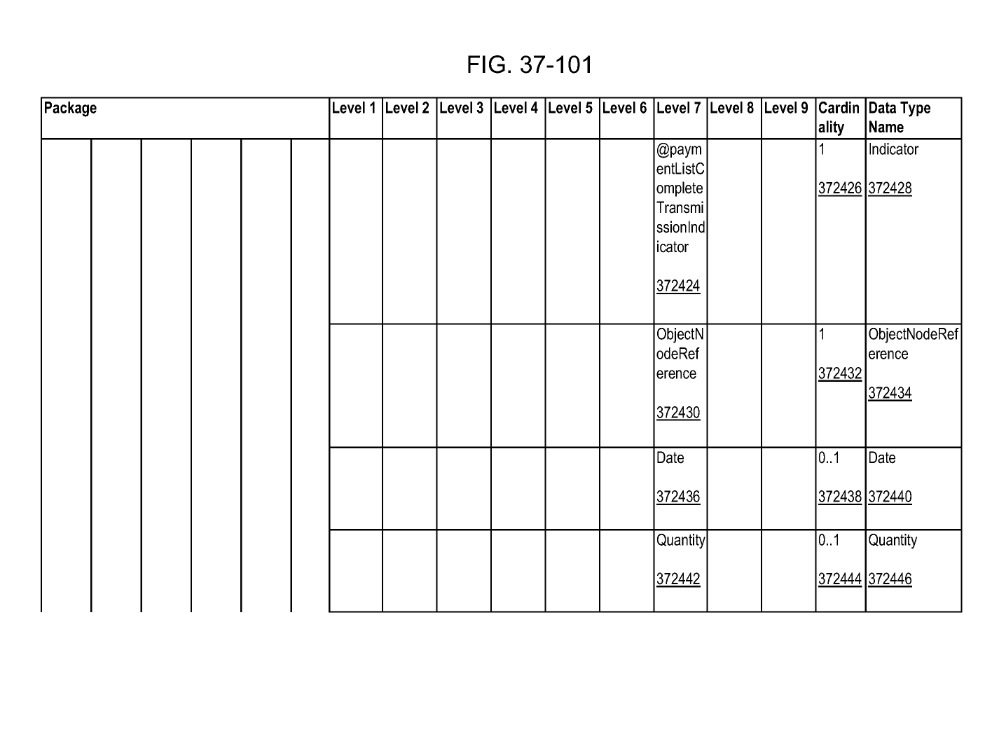

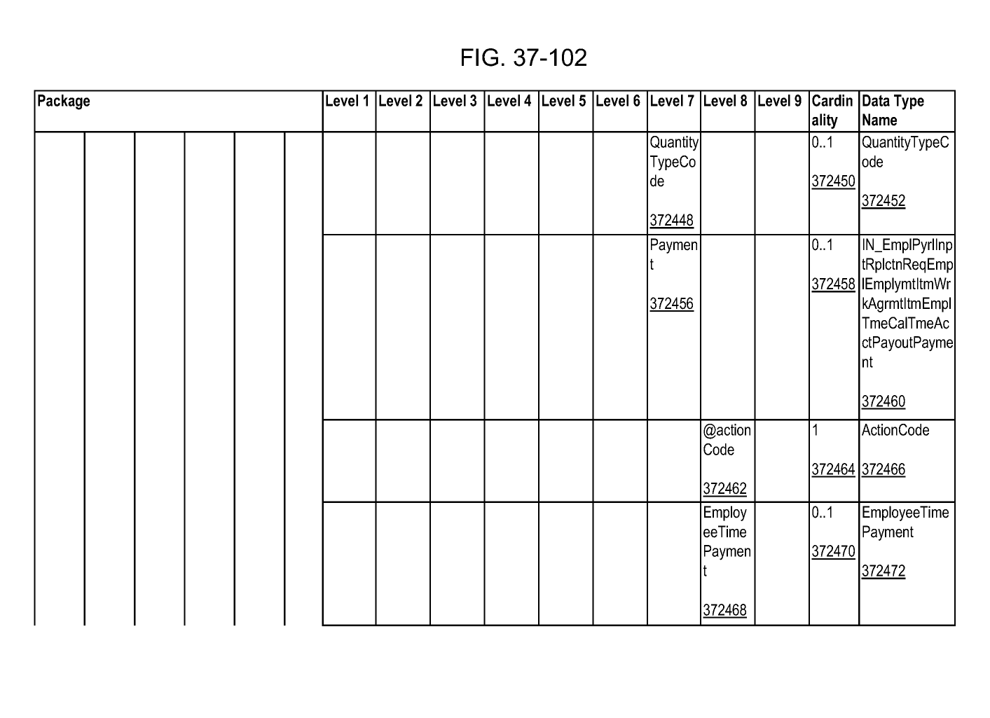

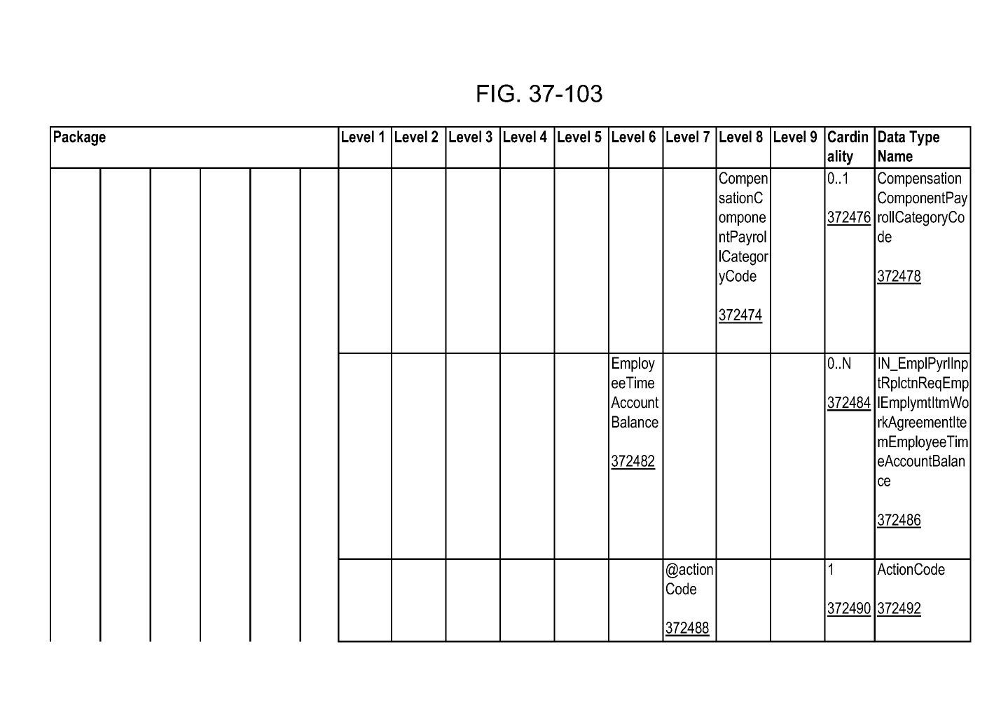

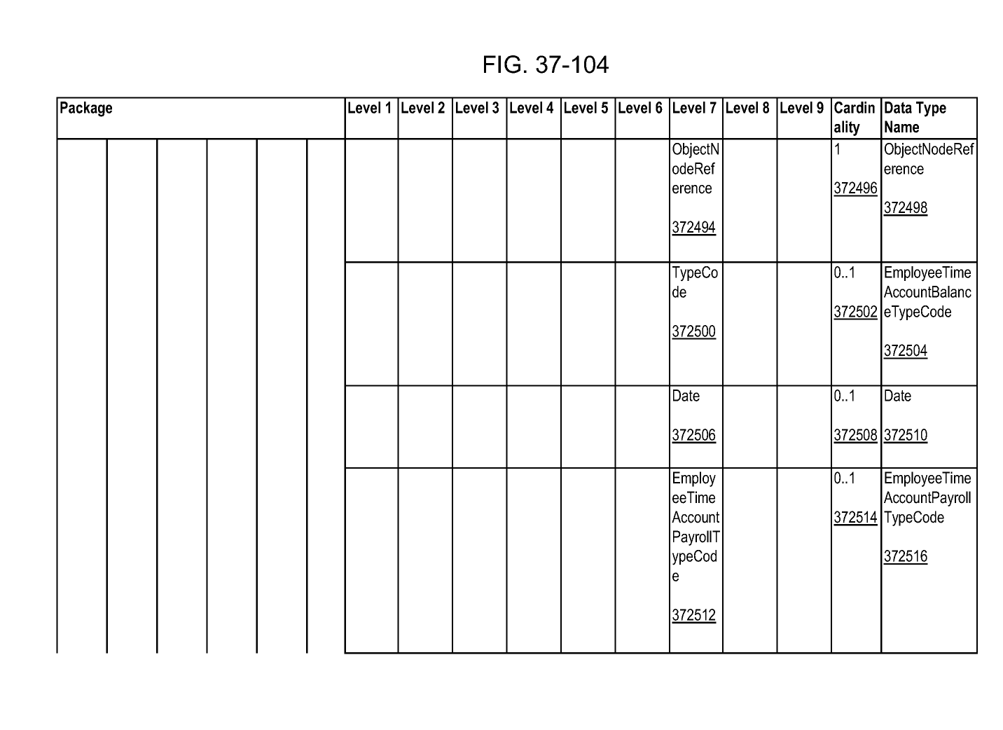

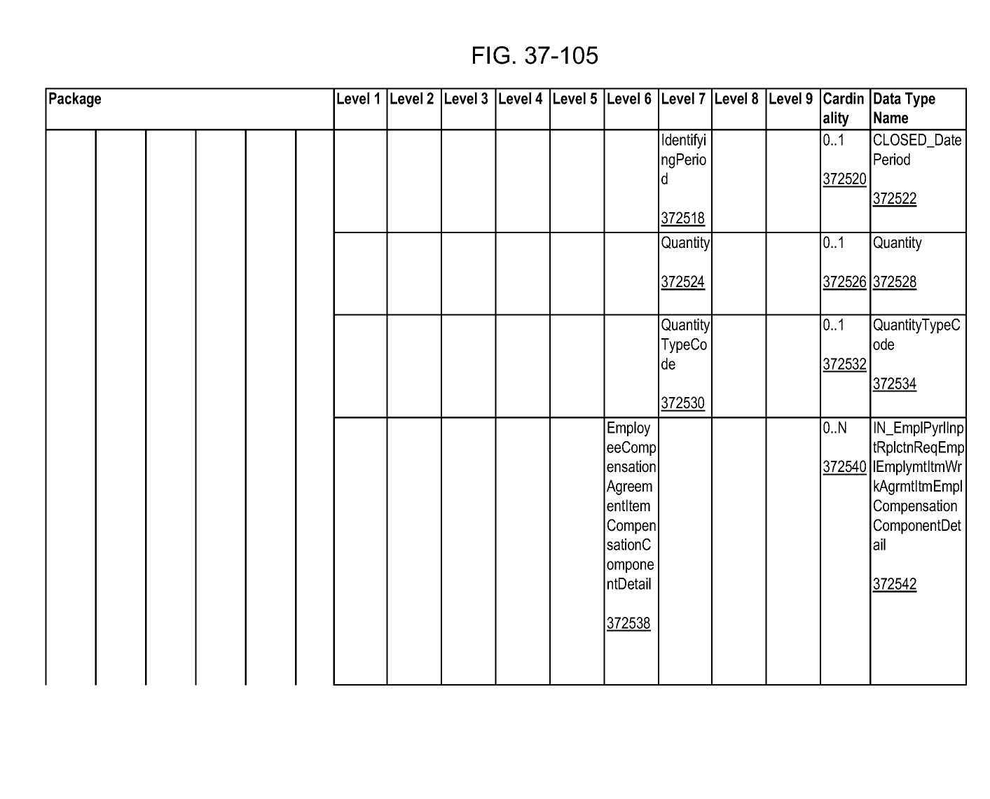

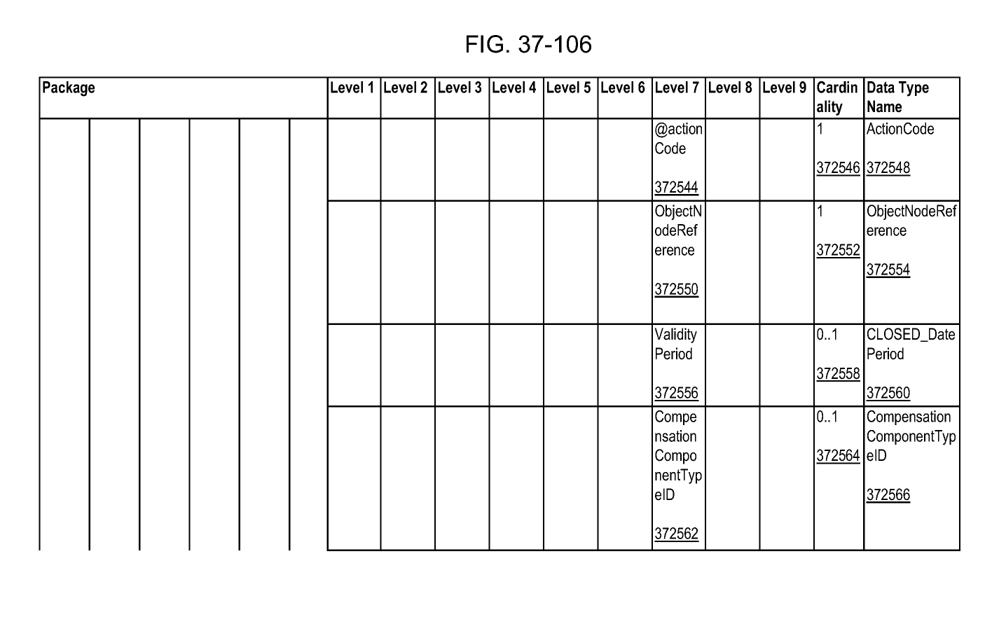

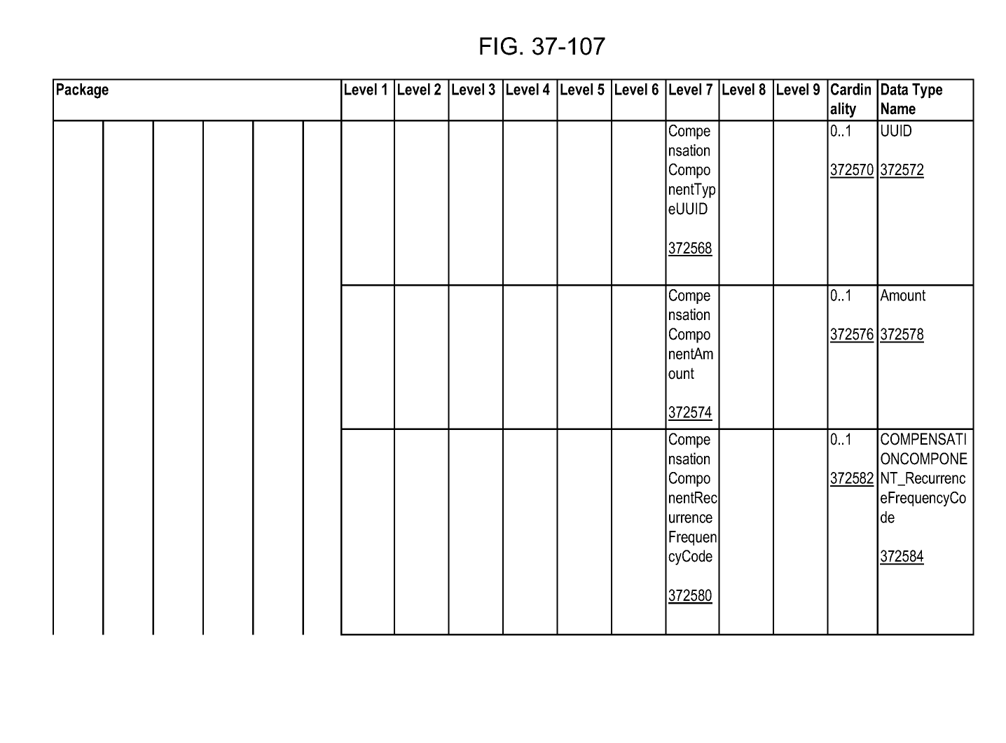

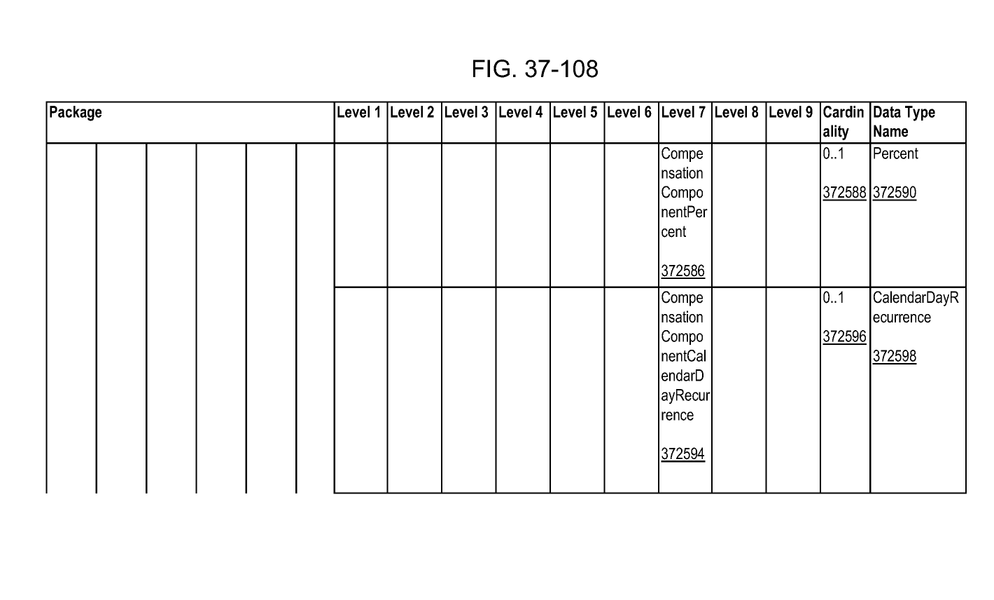

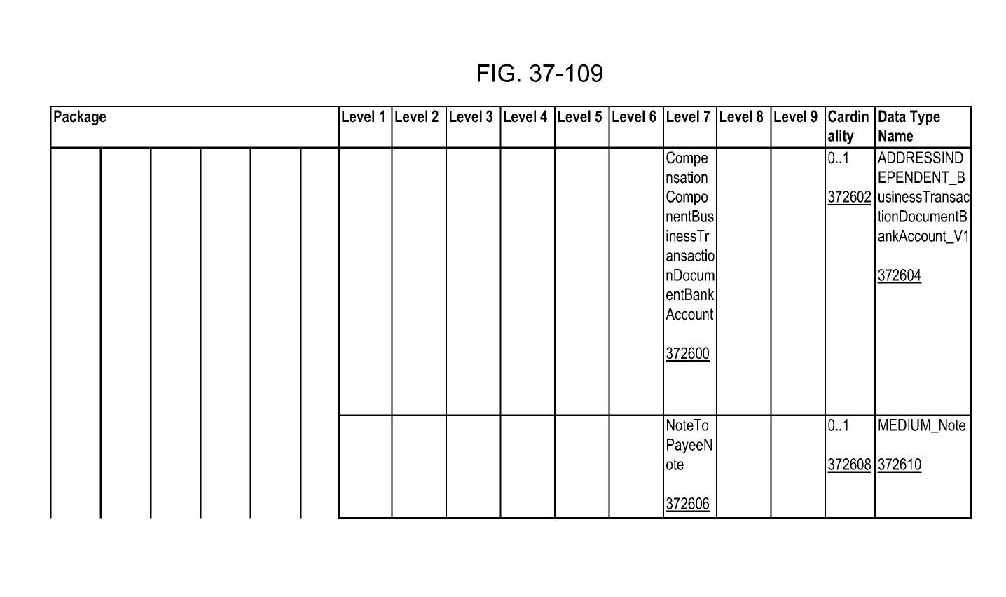

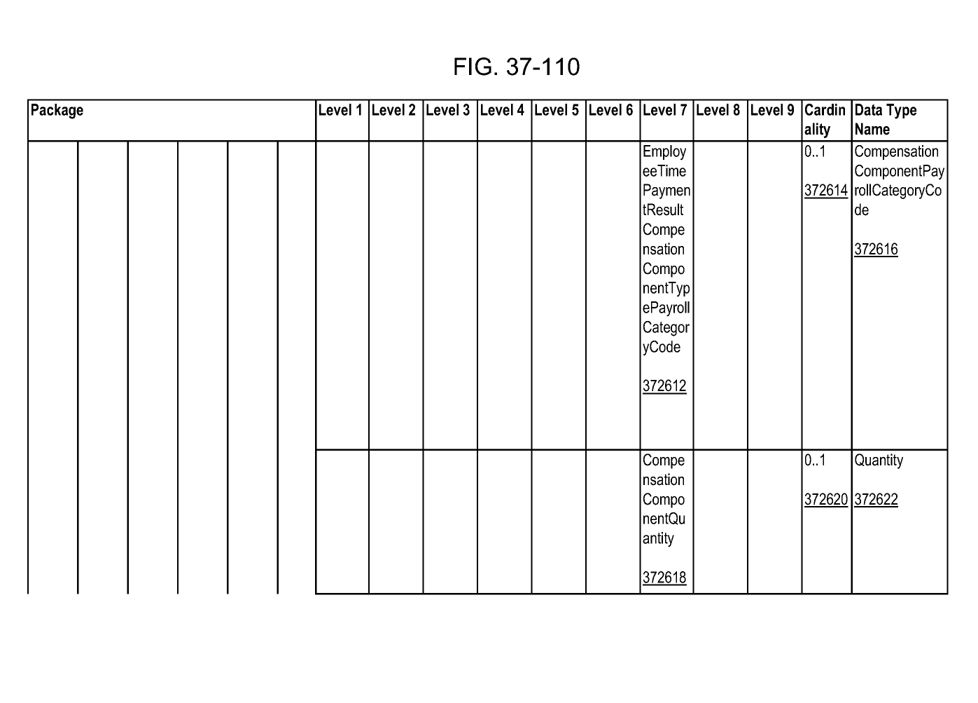

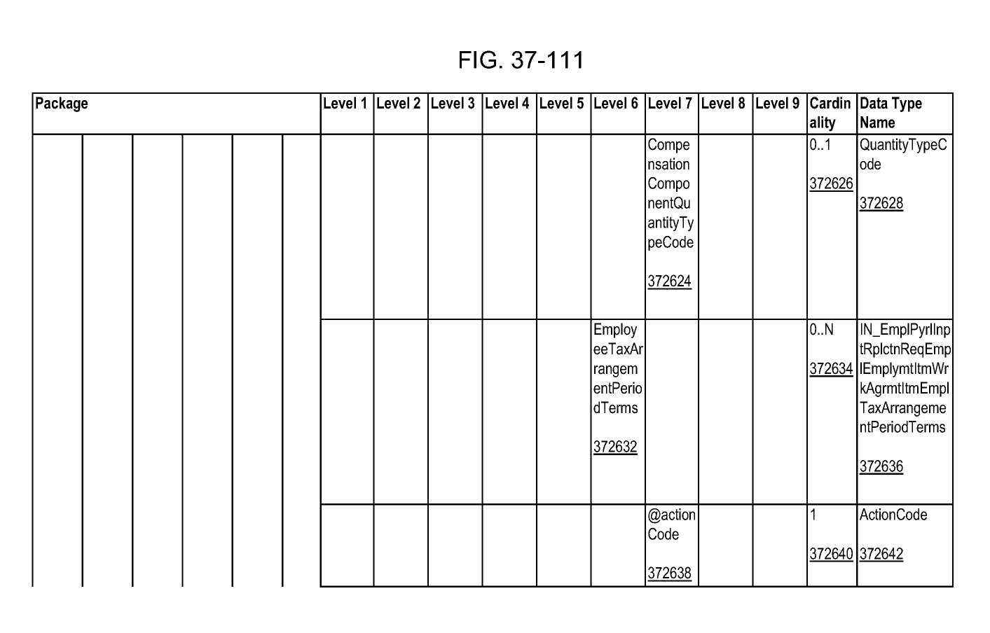

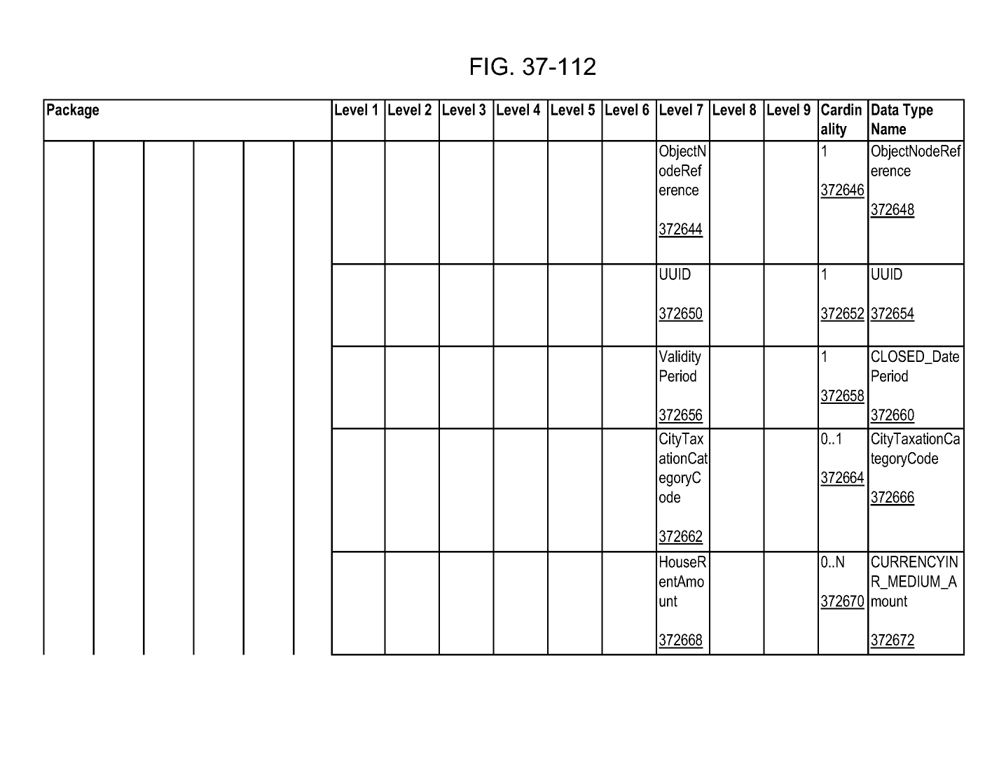

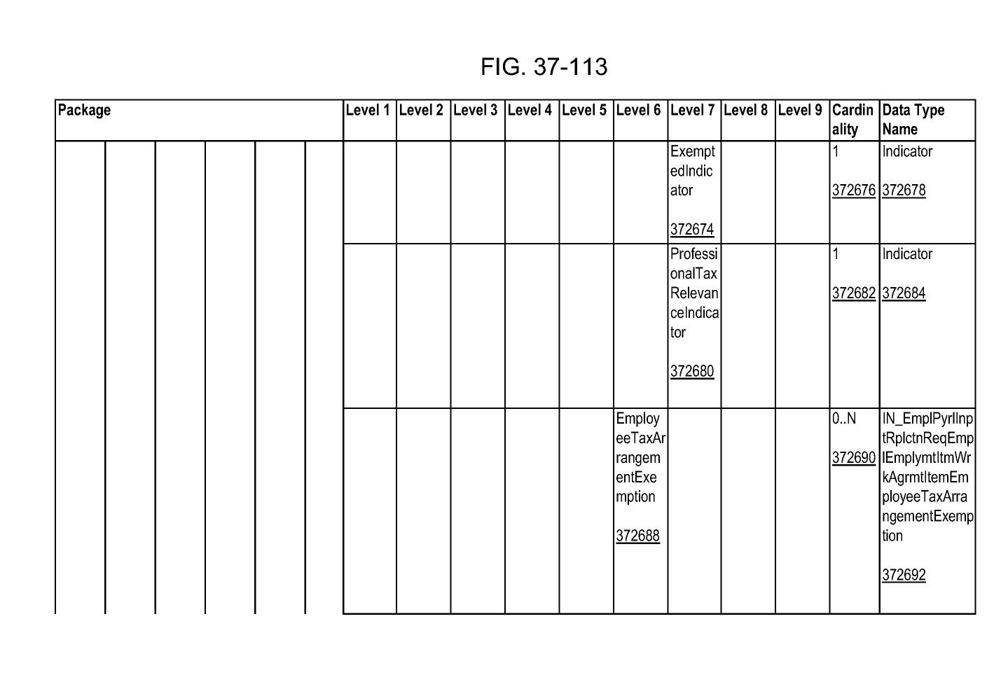

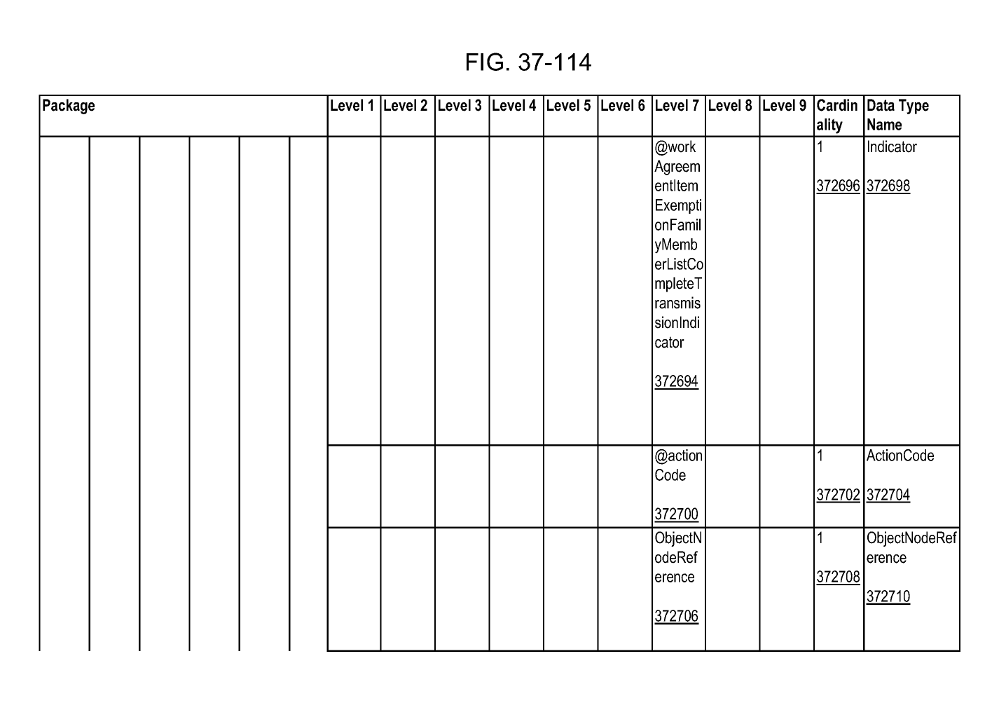

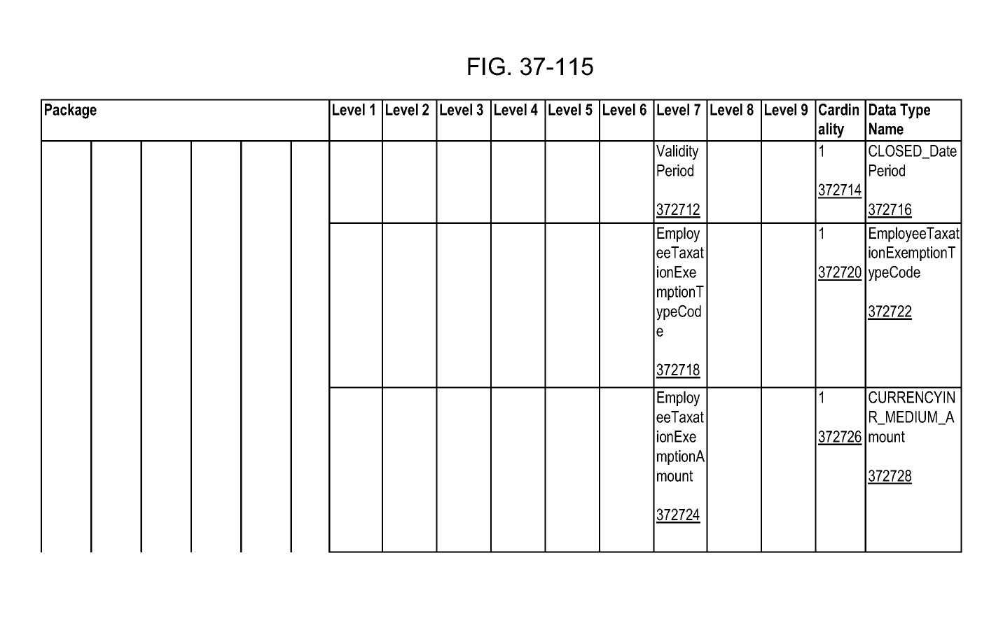

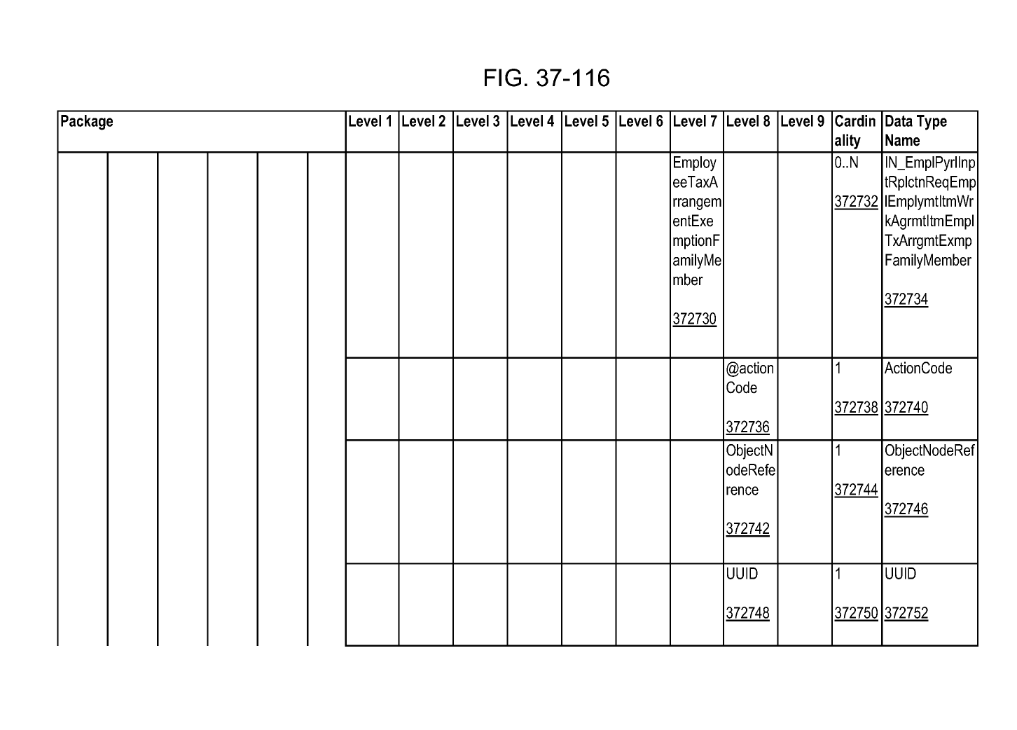

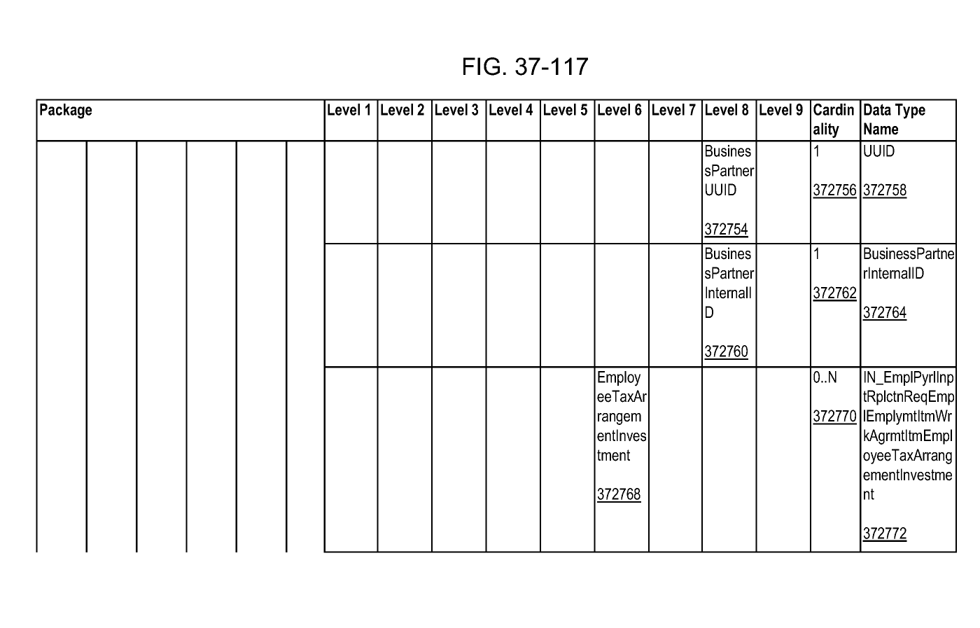

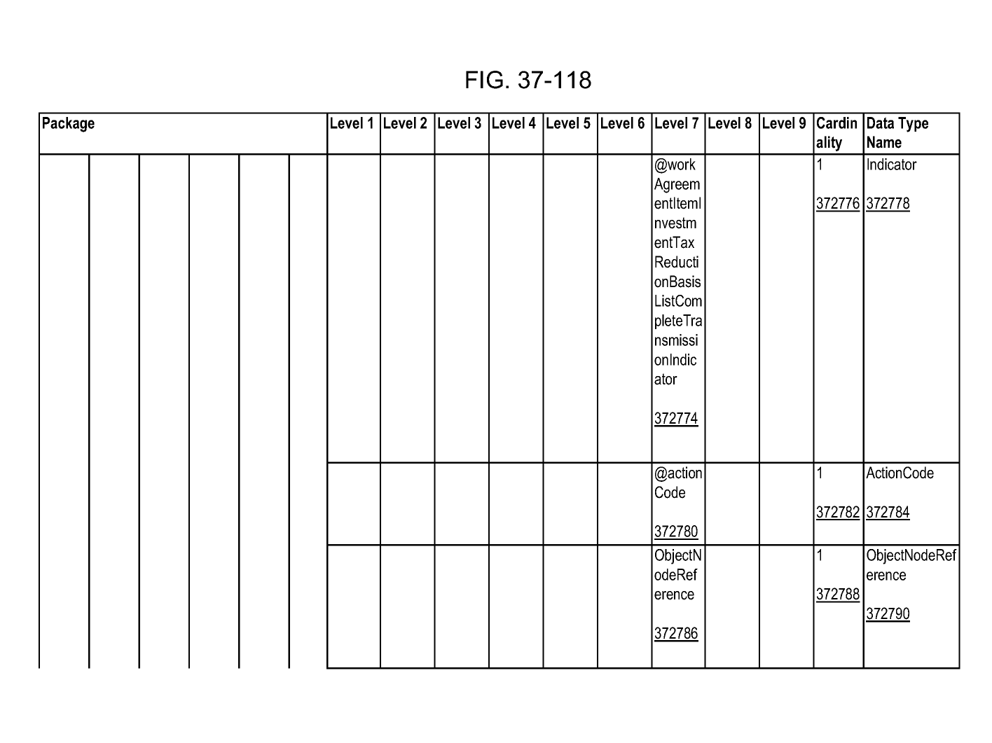

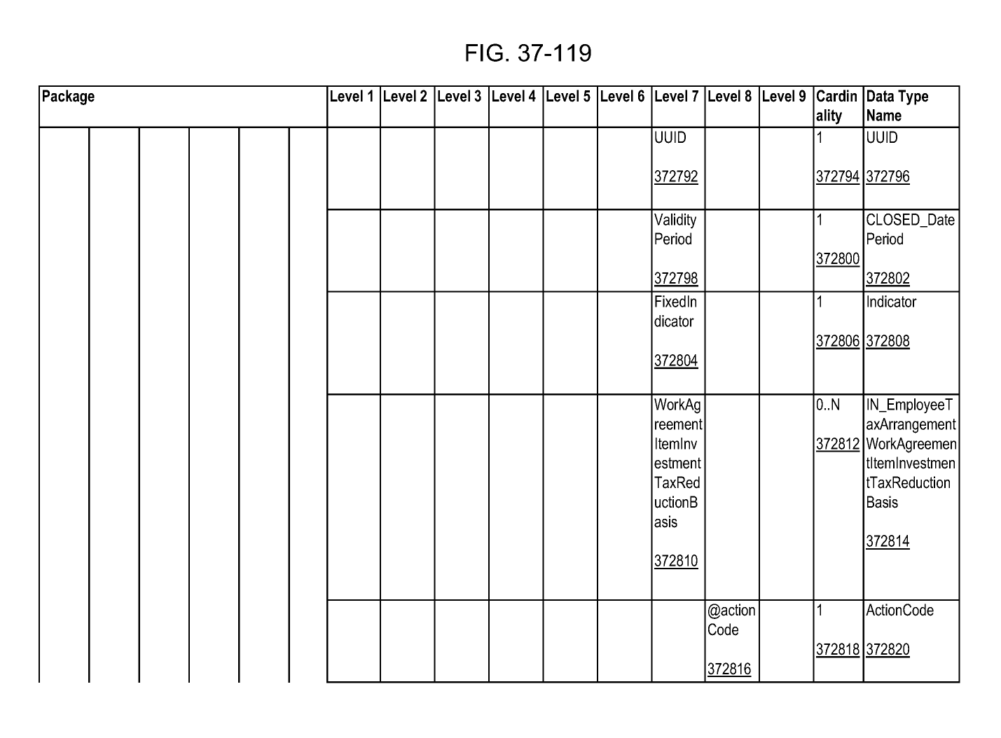

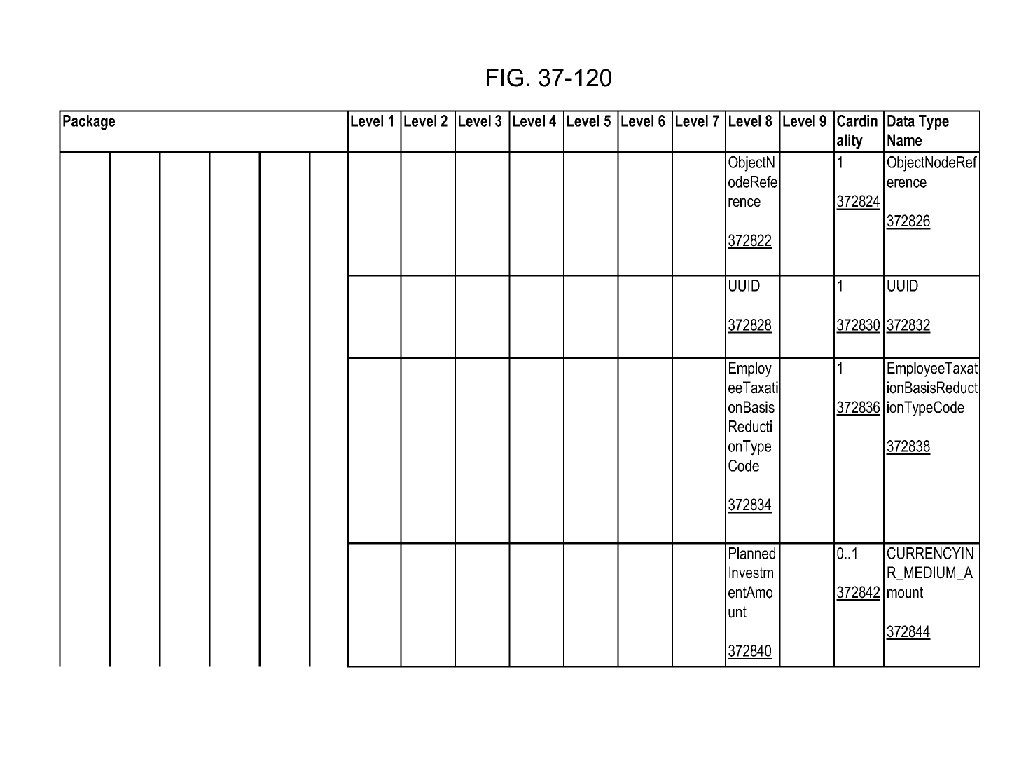

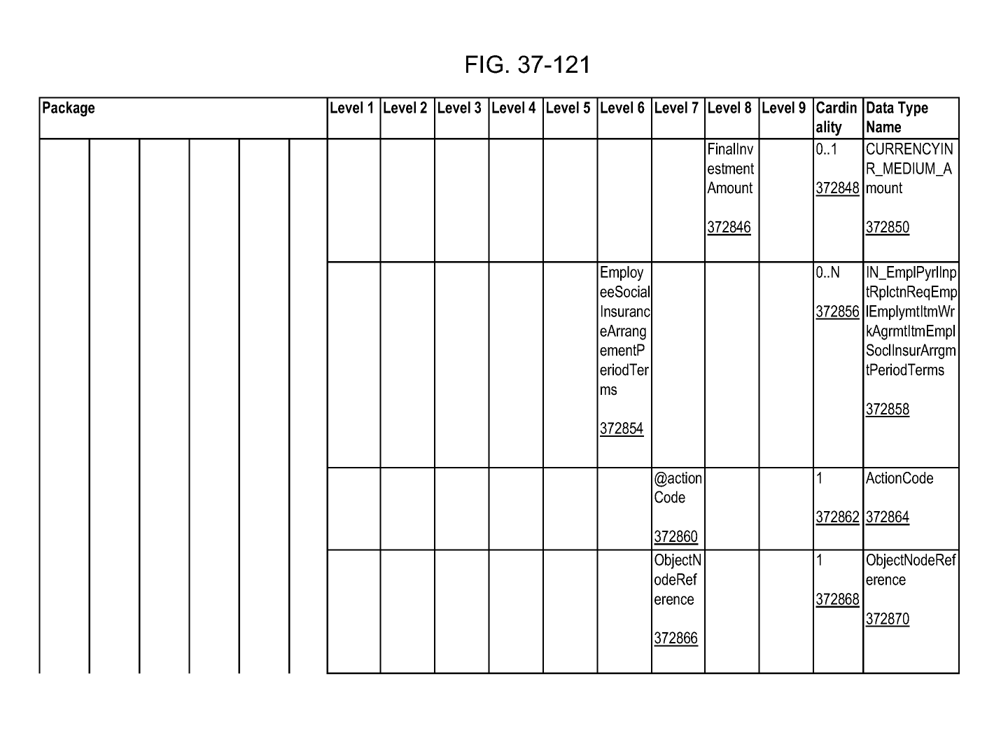

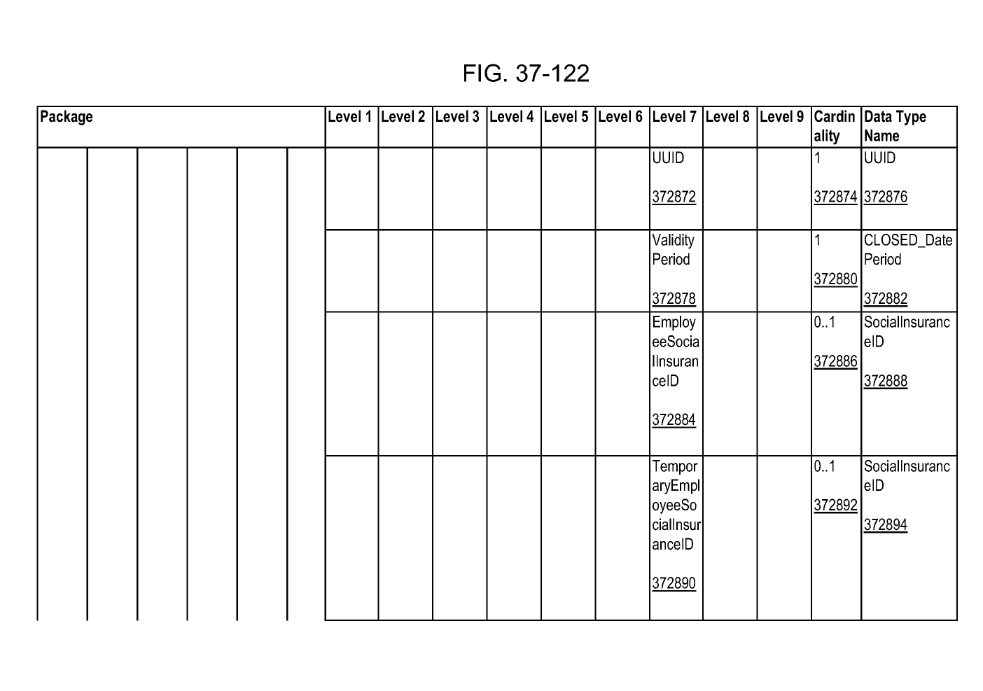

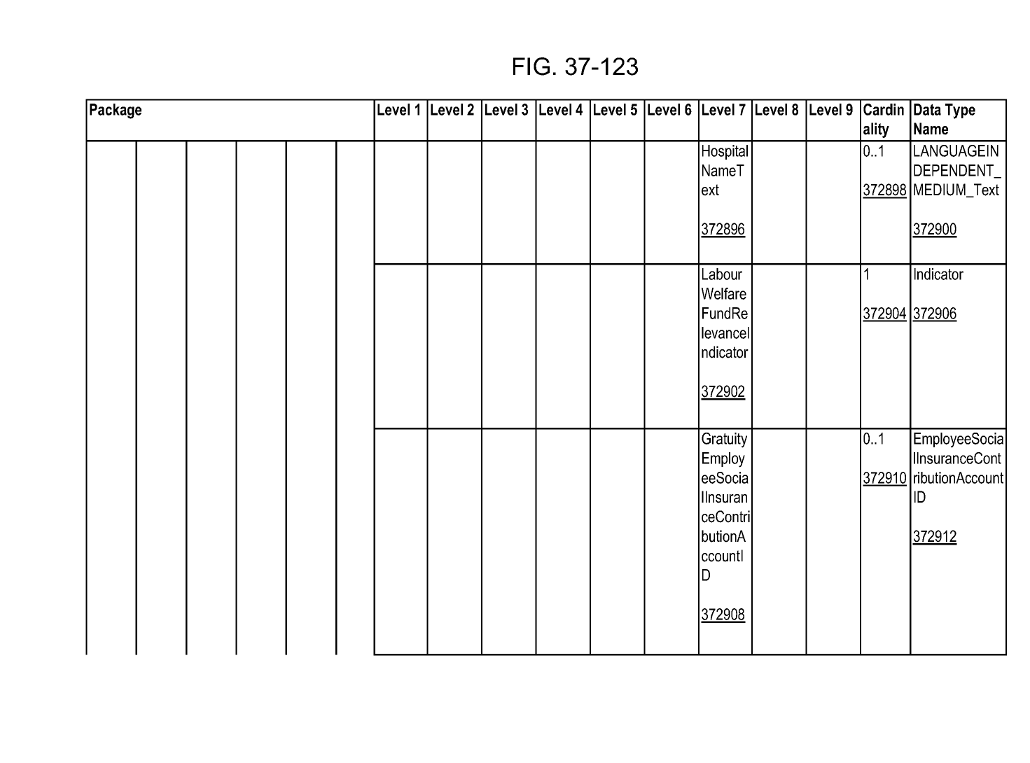

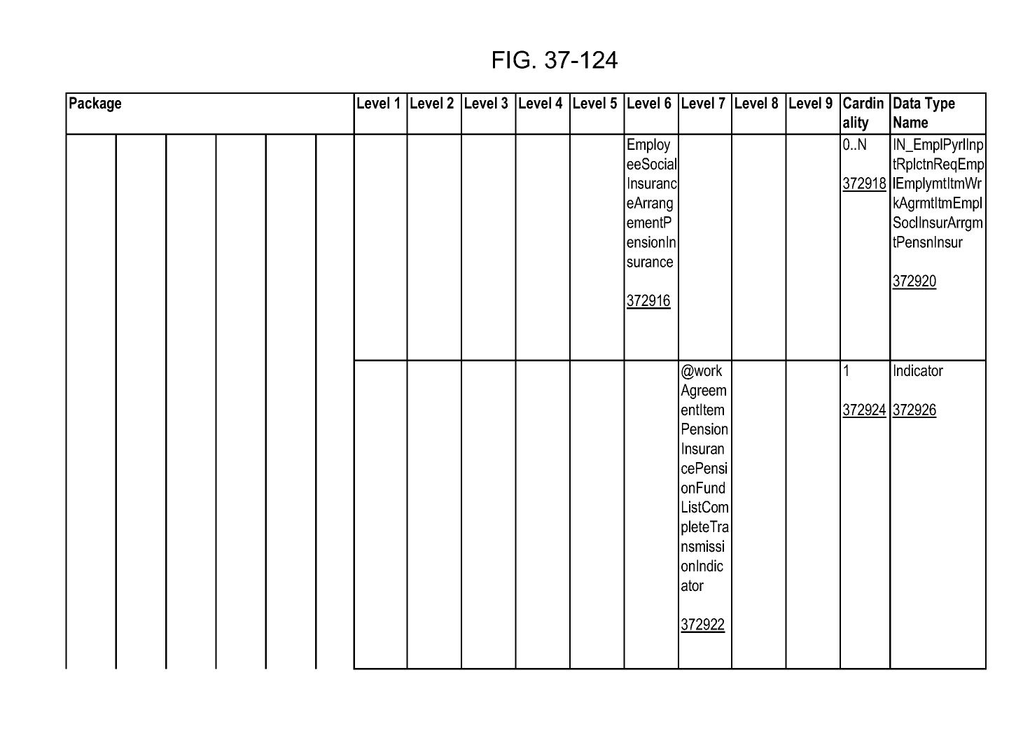

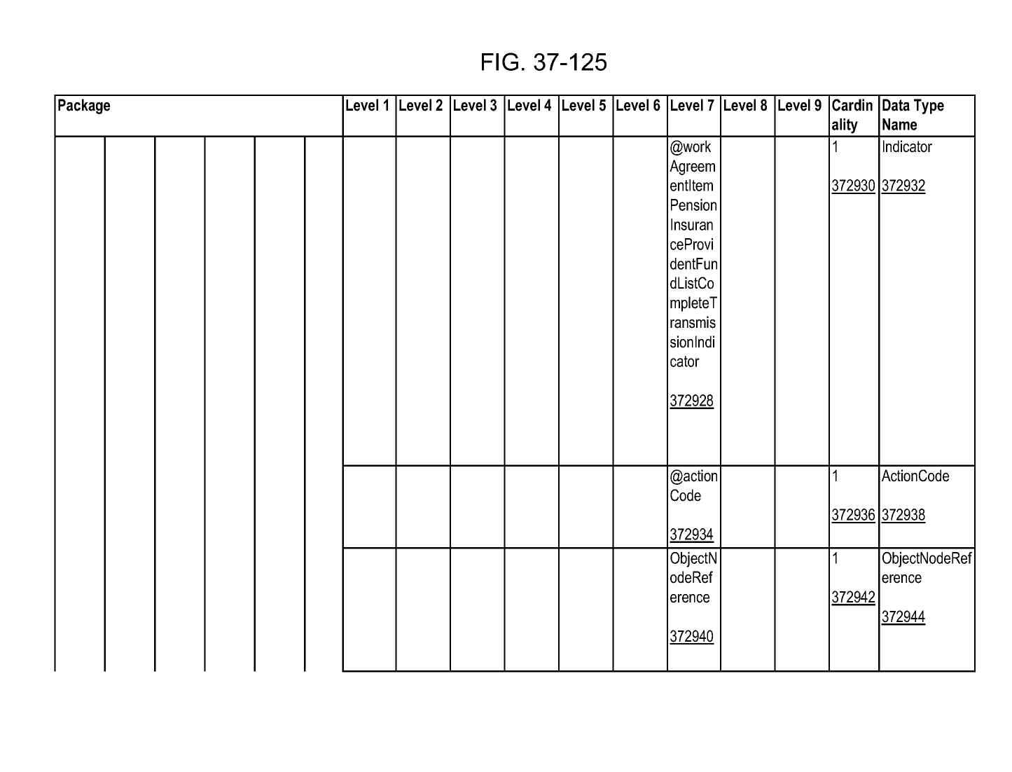

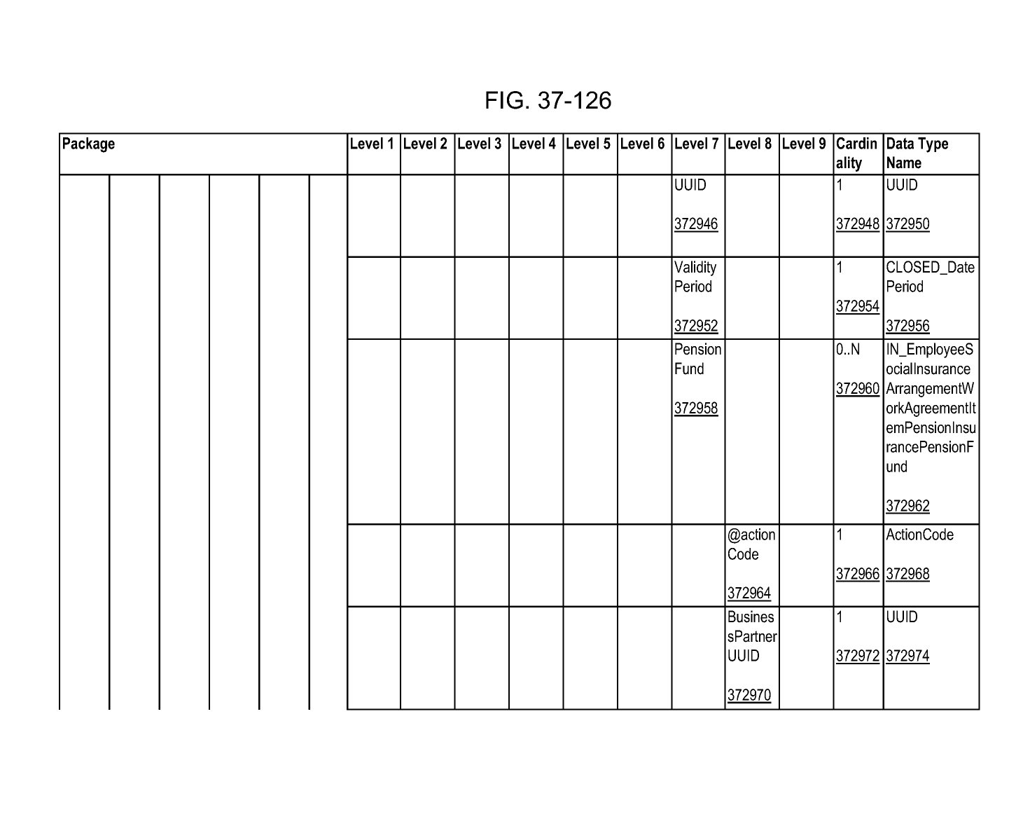

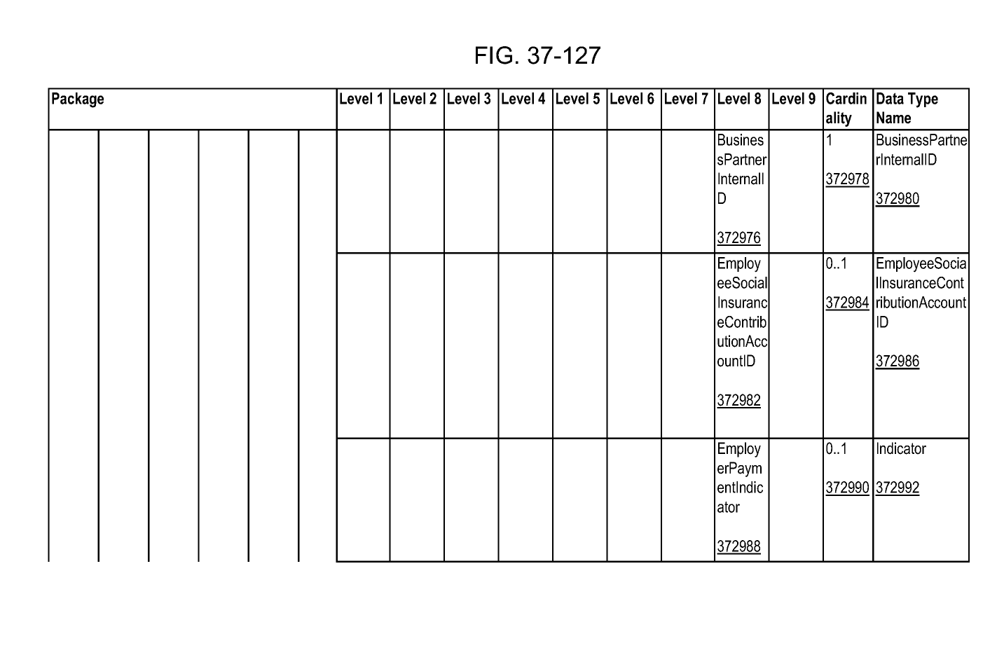

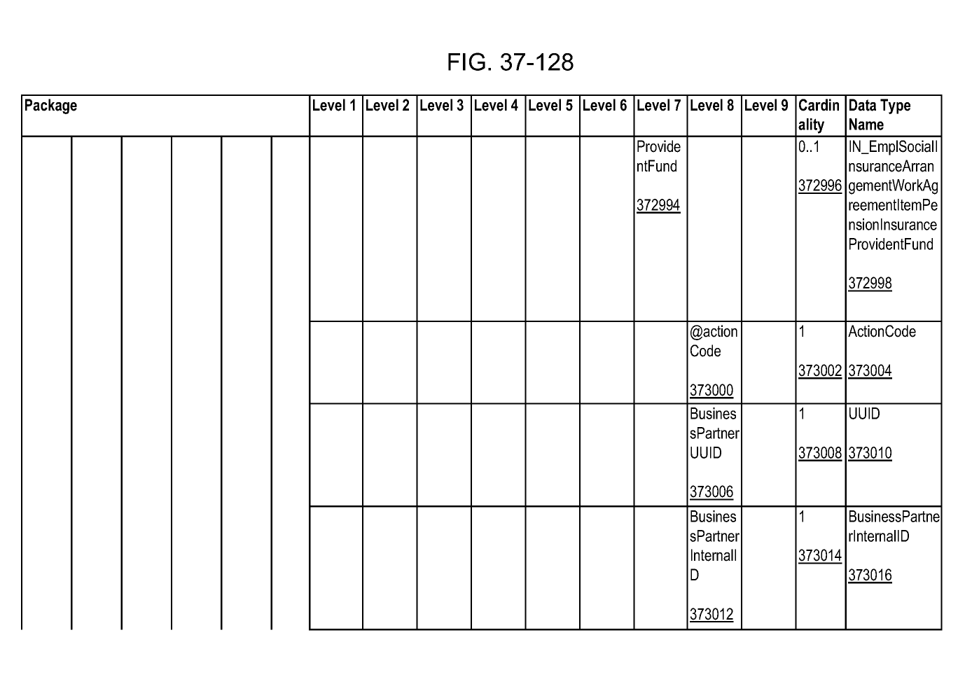

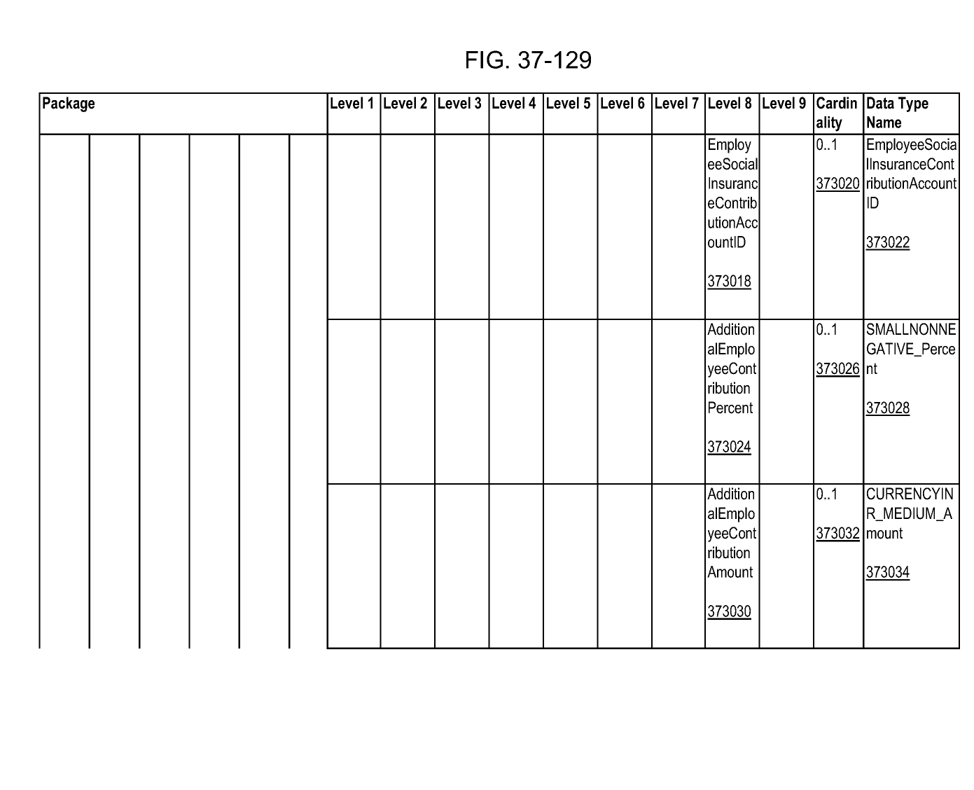

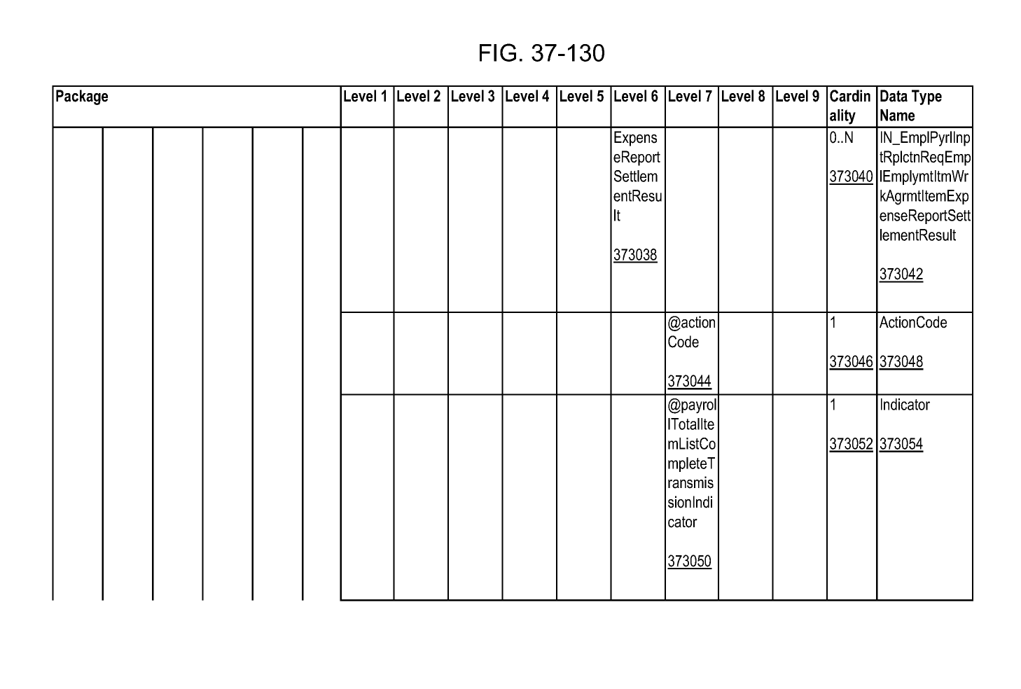

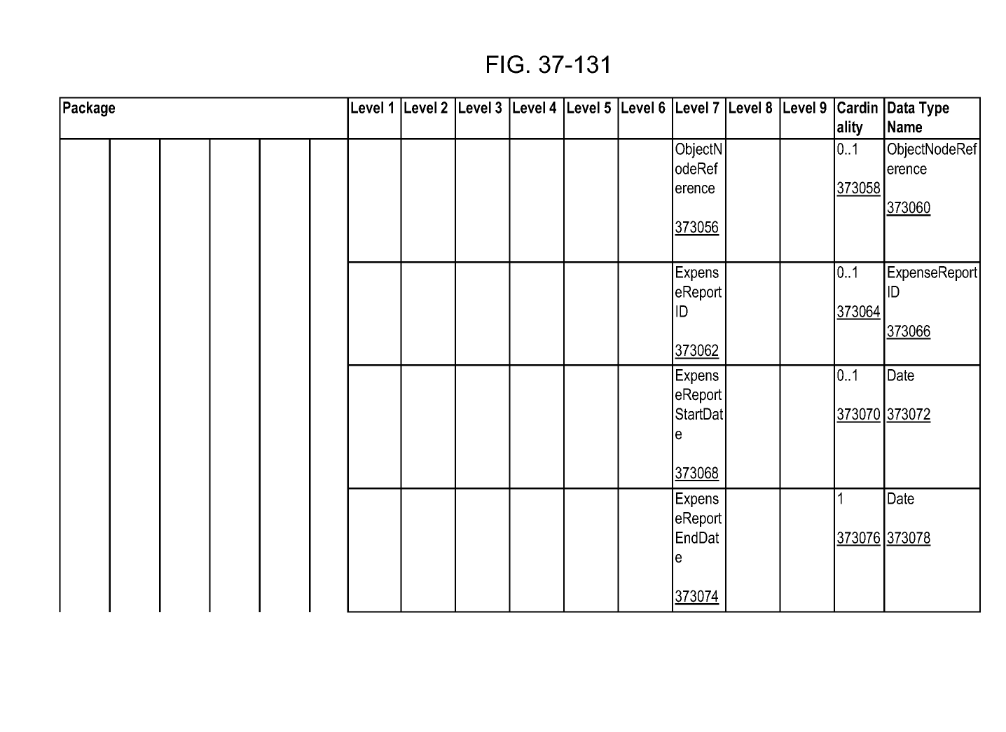

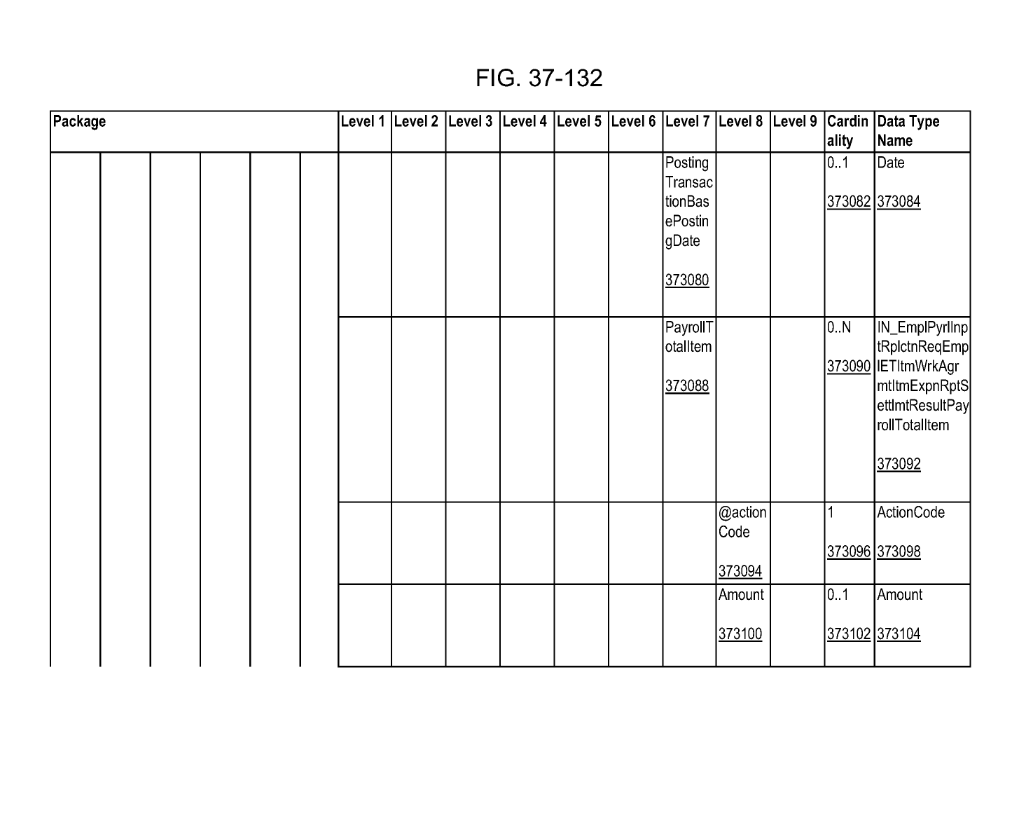

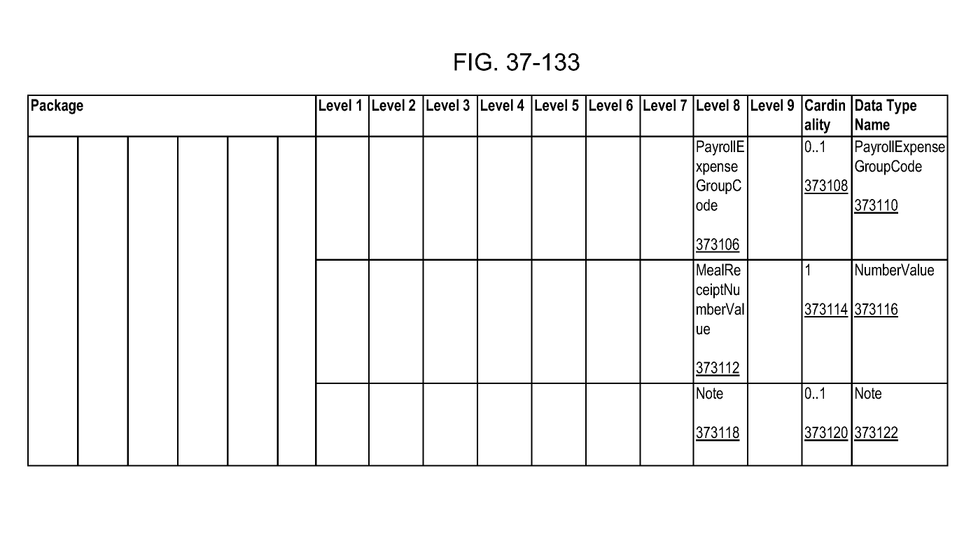

FIGS. 37-1 through 37-133 show an example configuration of an Element Structure that includes an IN_EmployeePayrollInputReplicationRequest 370000 package. Specifically, these figures depict the arrangement and hierarchy of various components such as one or more levels of packages, entities, and datatypes, shown here as 370000 through 373122. As described above, packages may be used to represent hierarchy levels. Entities are discrete business elements that are used during a business transaction. Data types are used to type object entities and interfaces with a structure. For example, the IN_EmployeePayrollInputReplicationRequest 370000 includes, among other things, an IN_EmployeePayrollInputReplicationRequest 370002. Accordingly, heterogeneous applications may communicate using this consistent message configured as such.

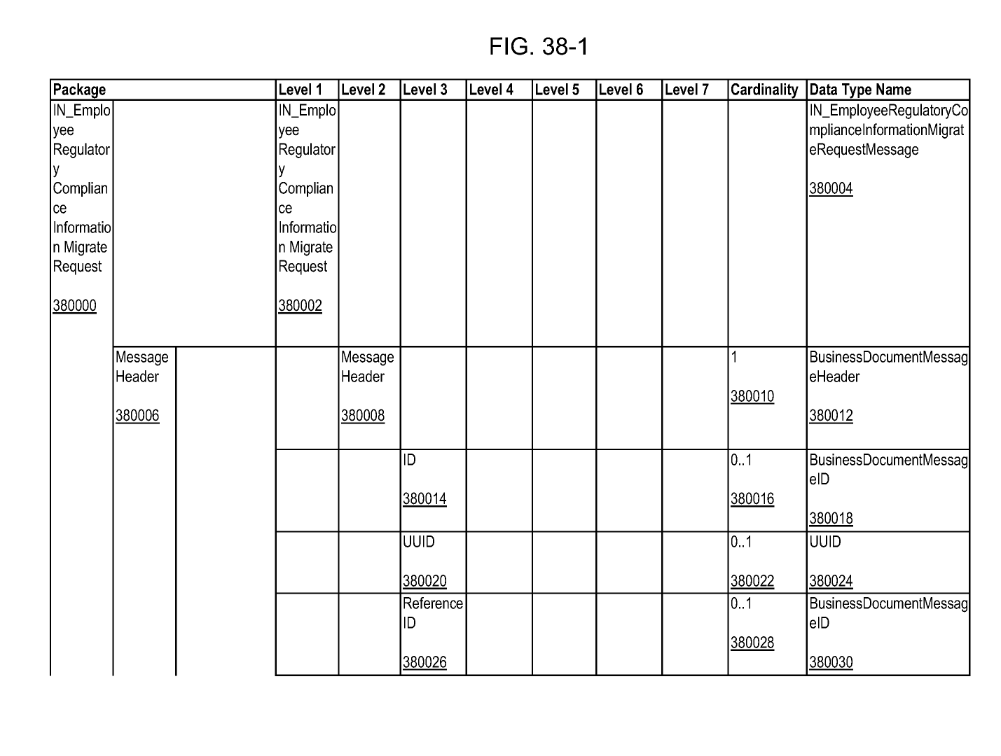

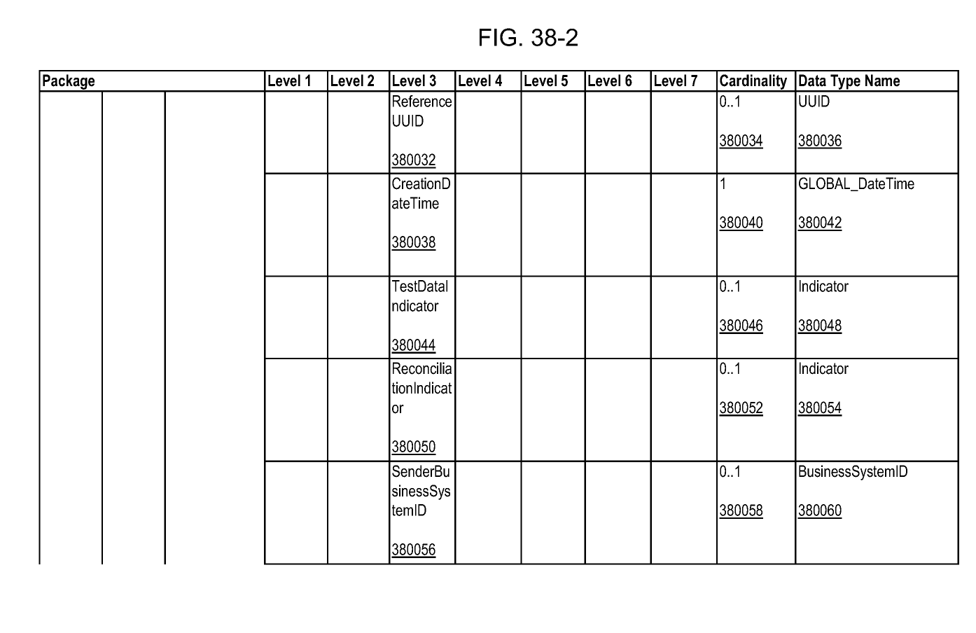

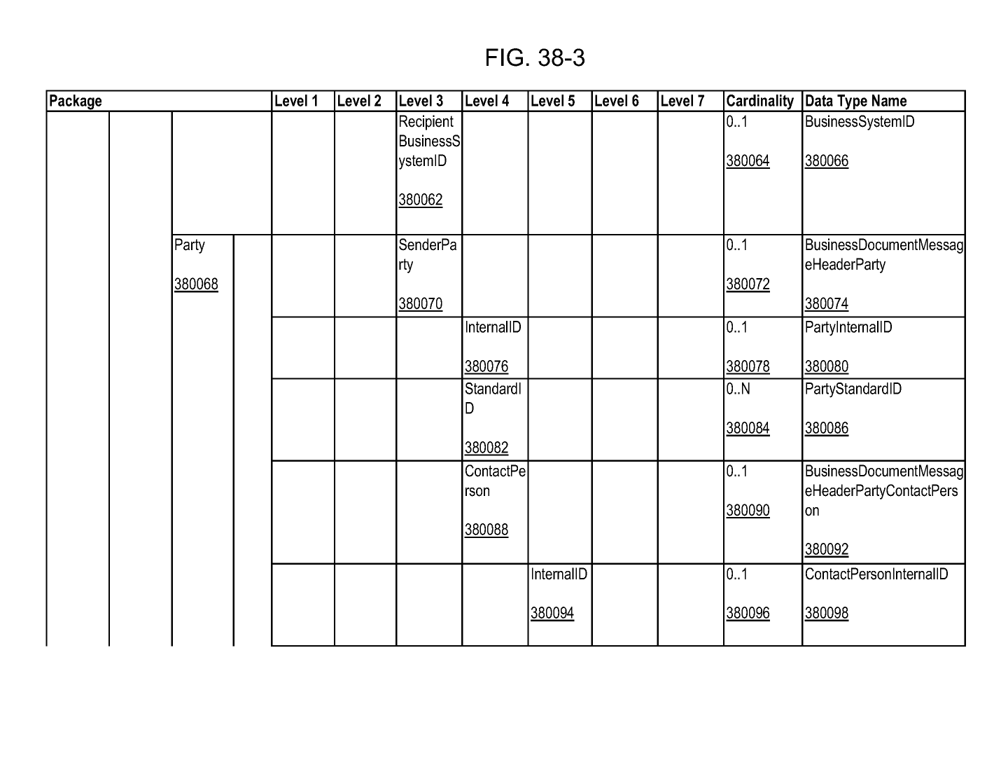

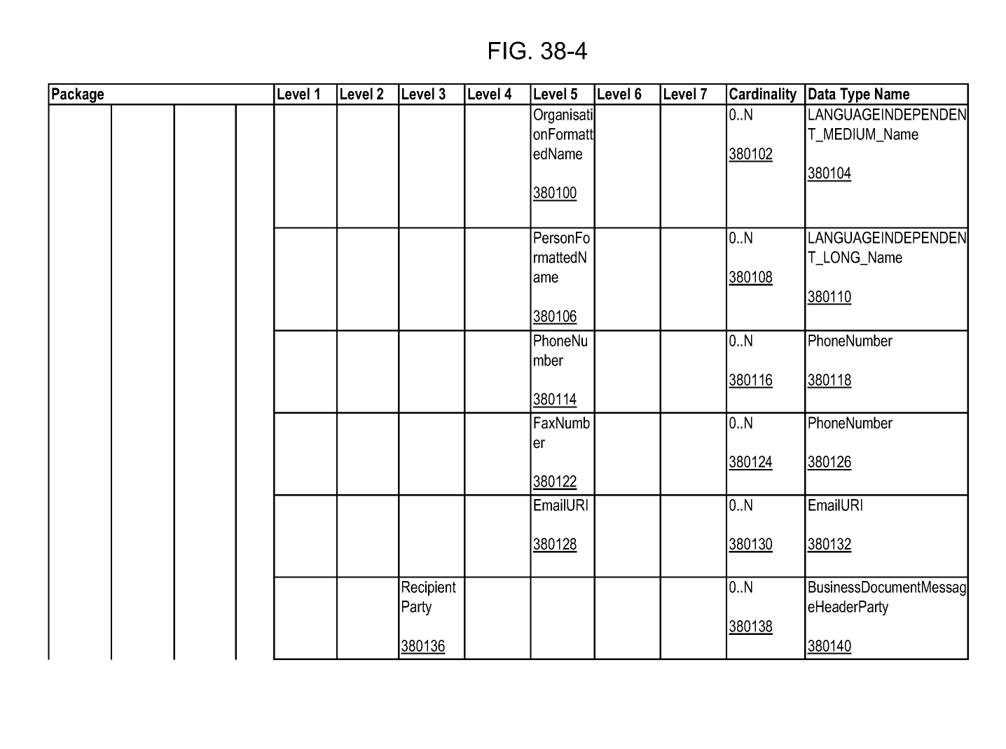

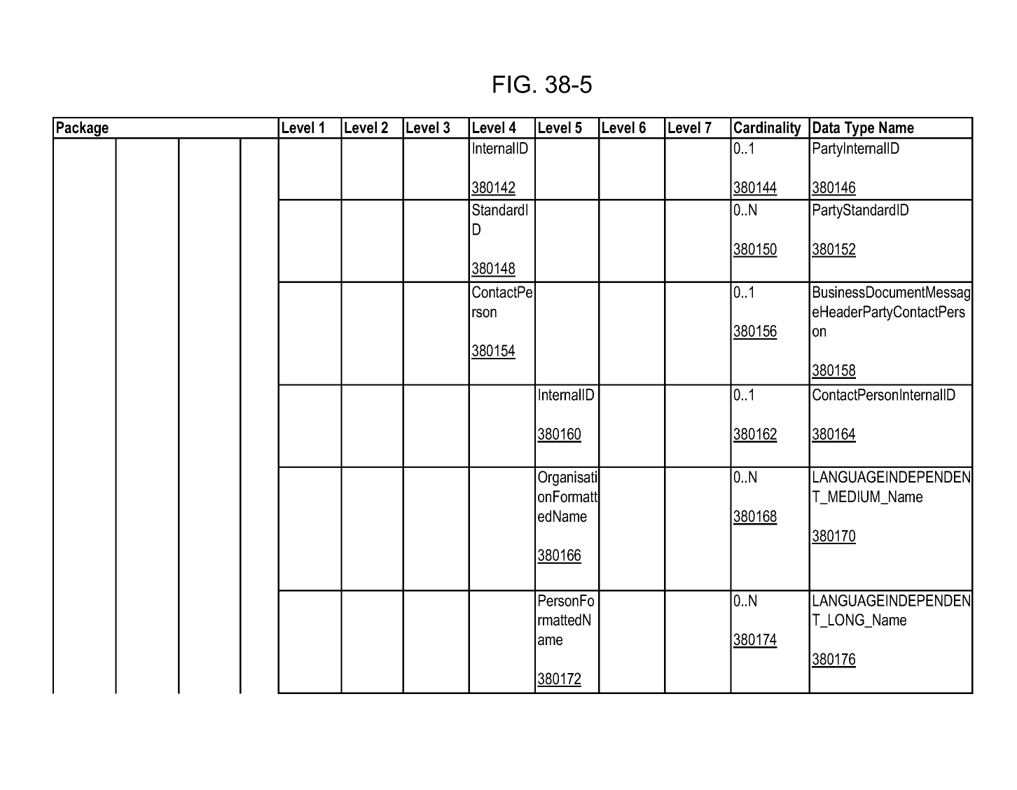

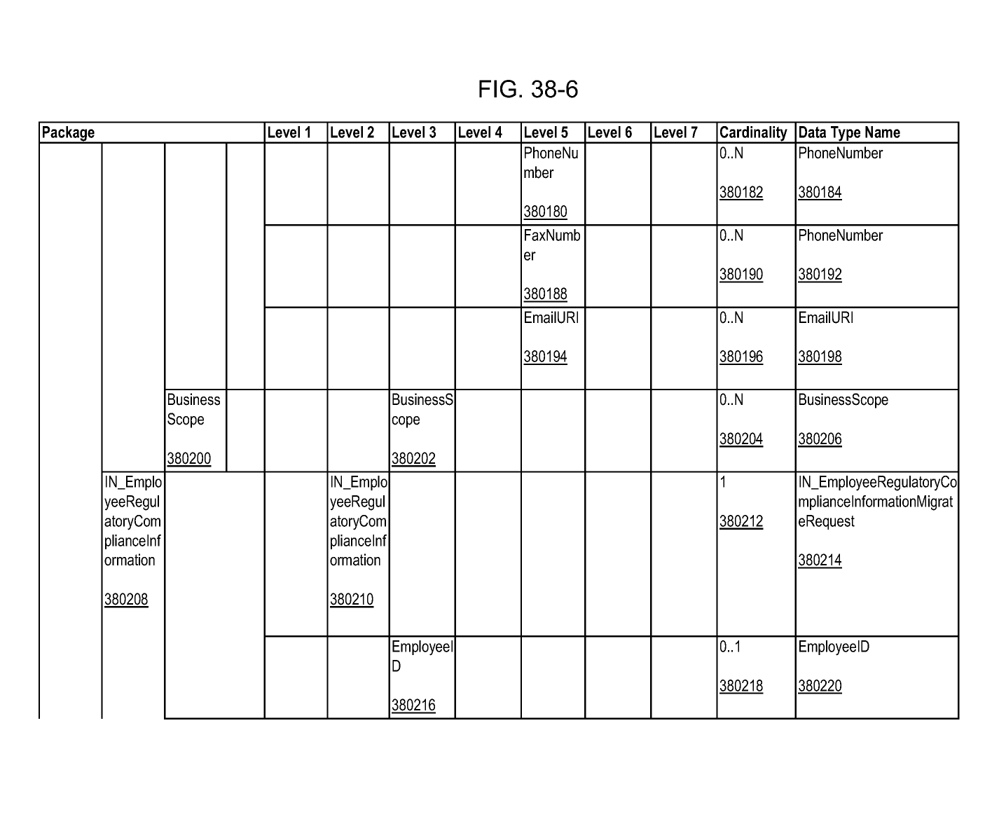

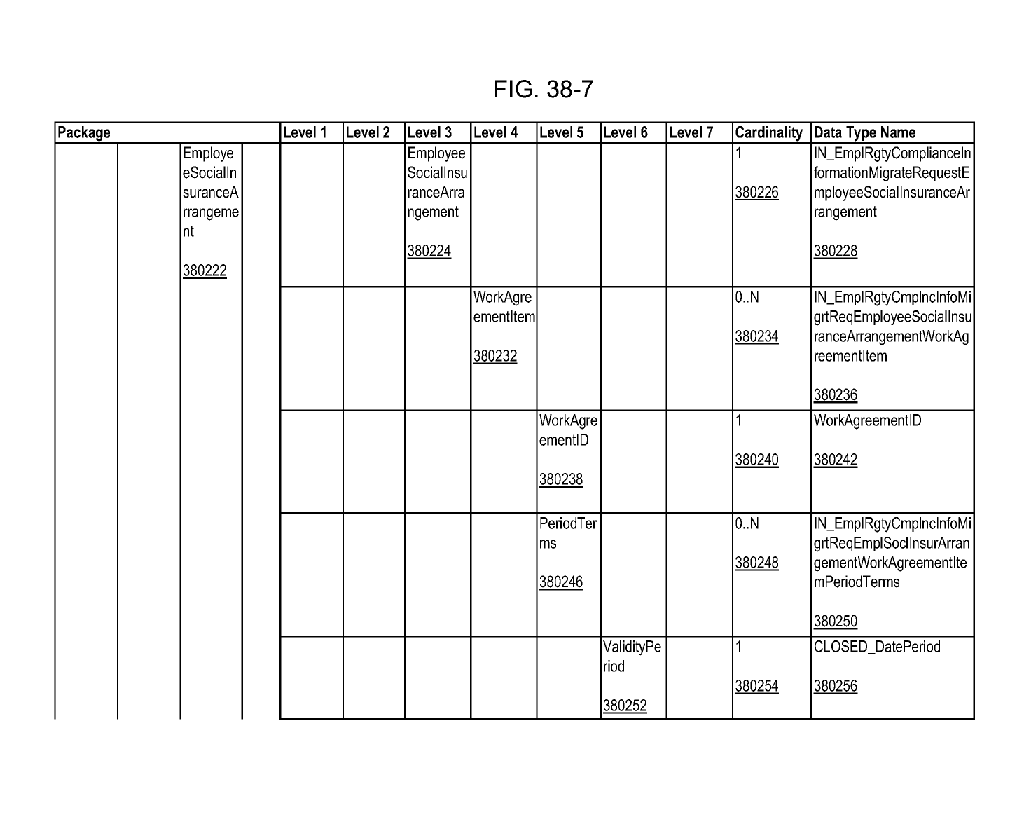

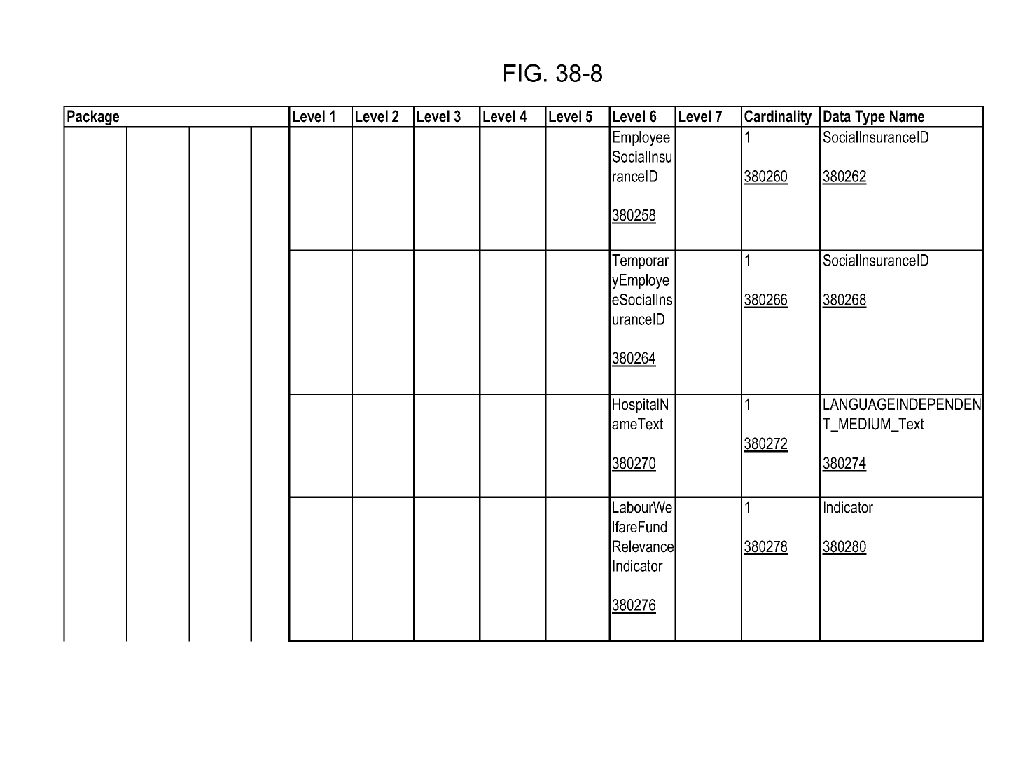

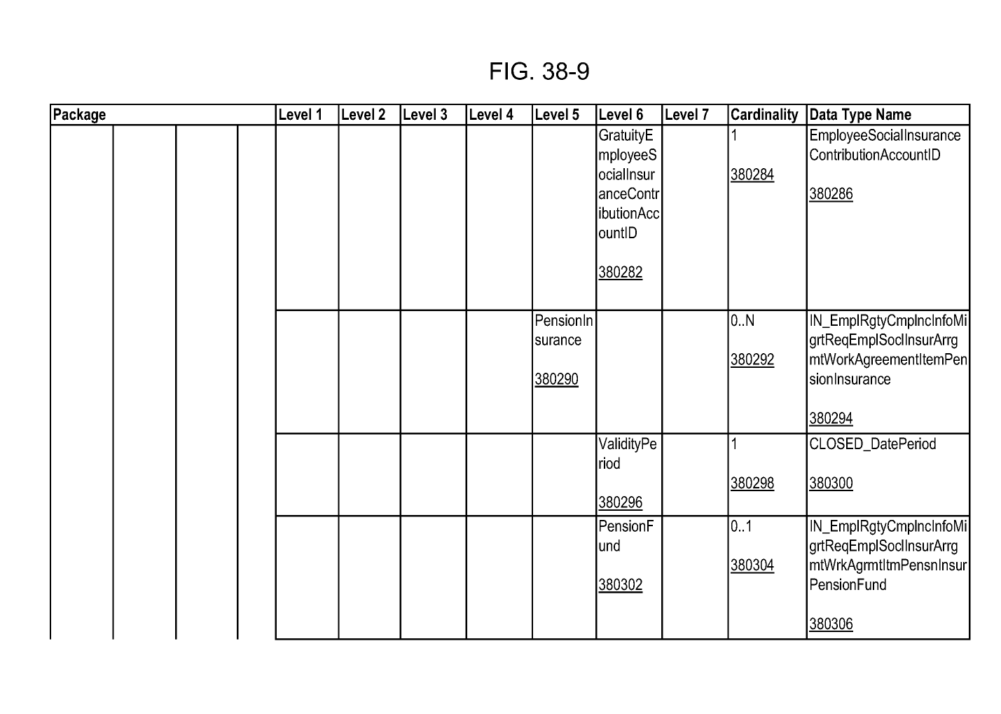

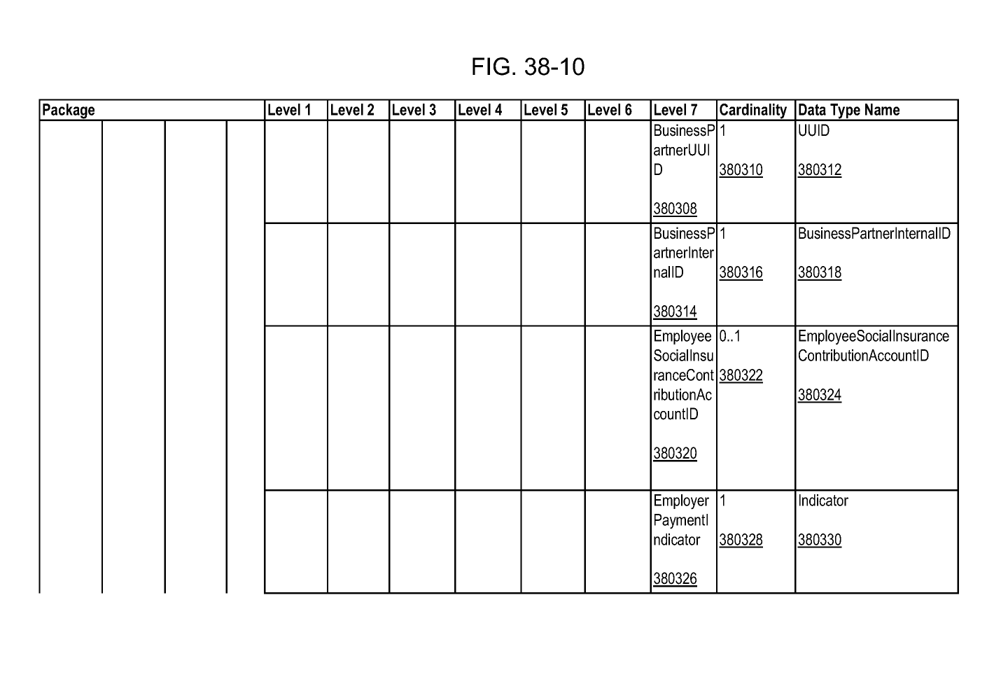

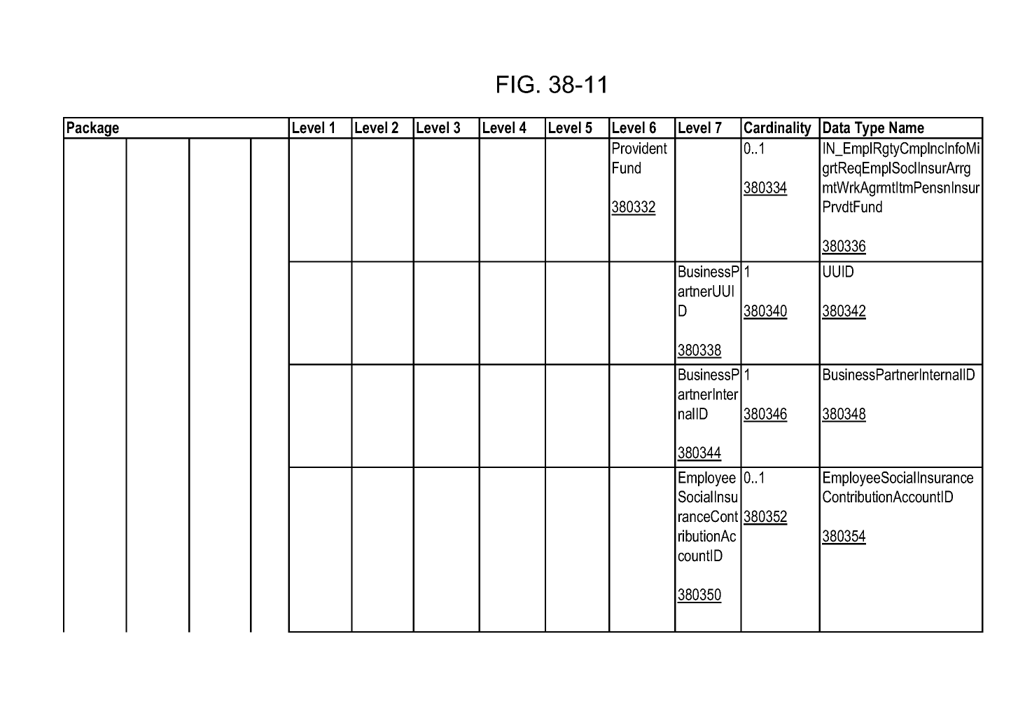

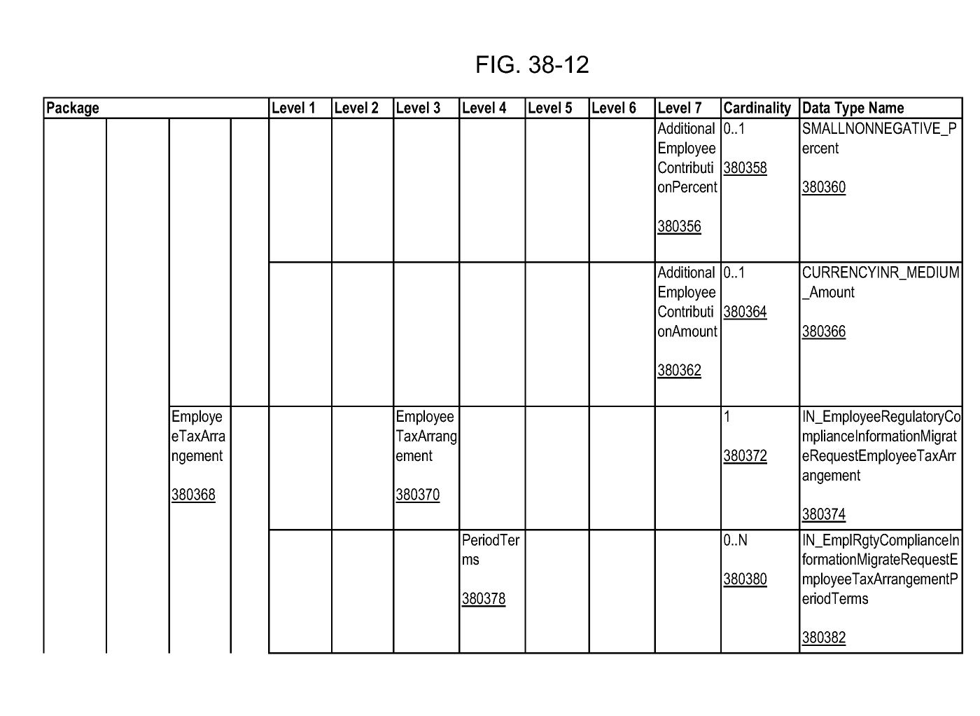

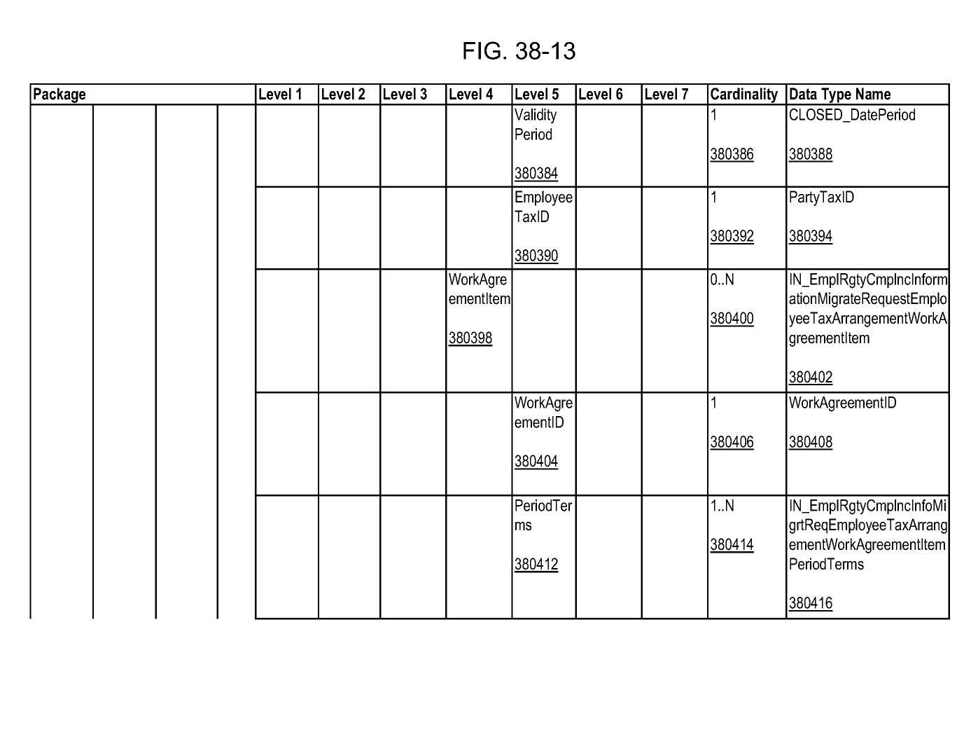

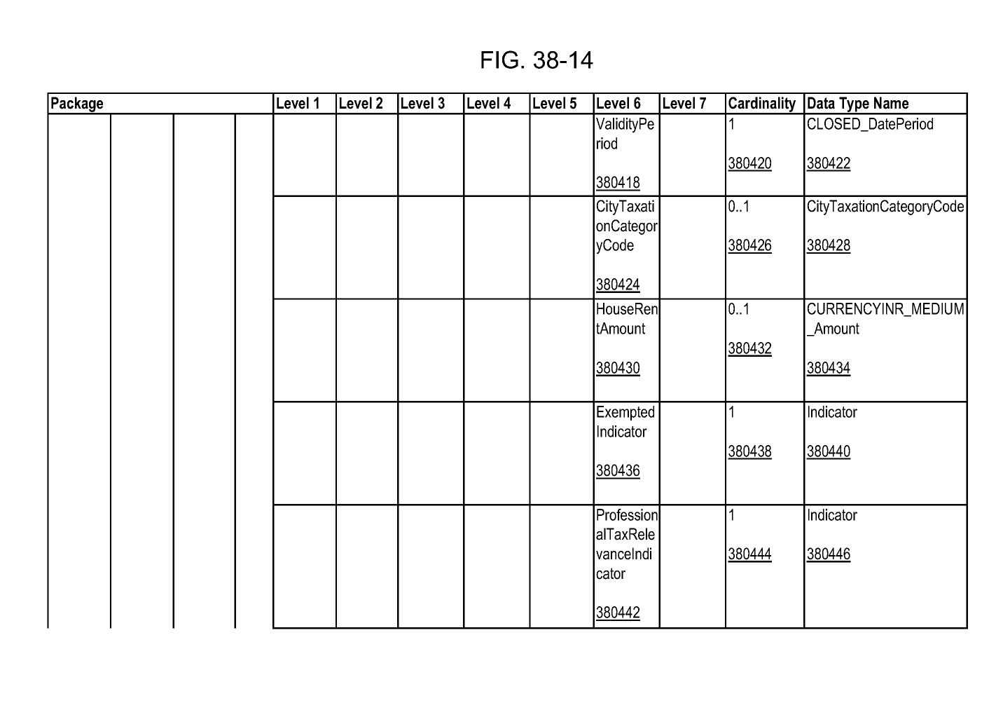

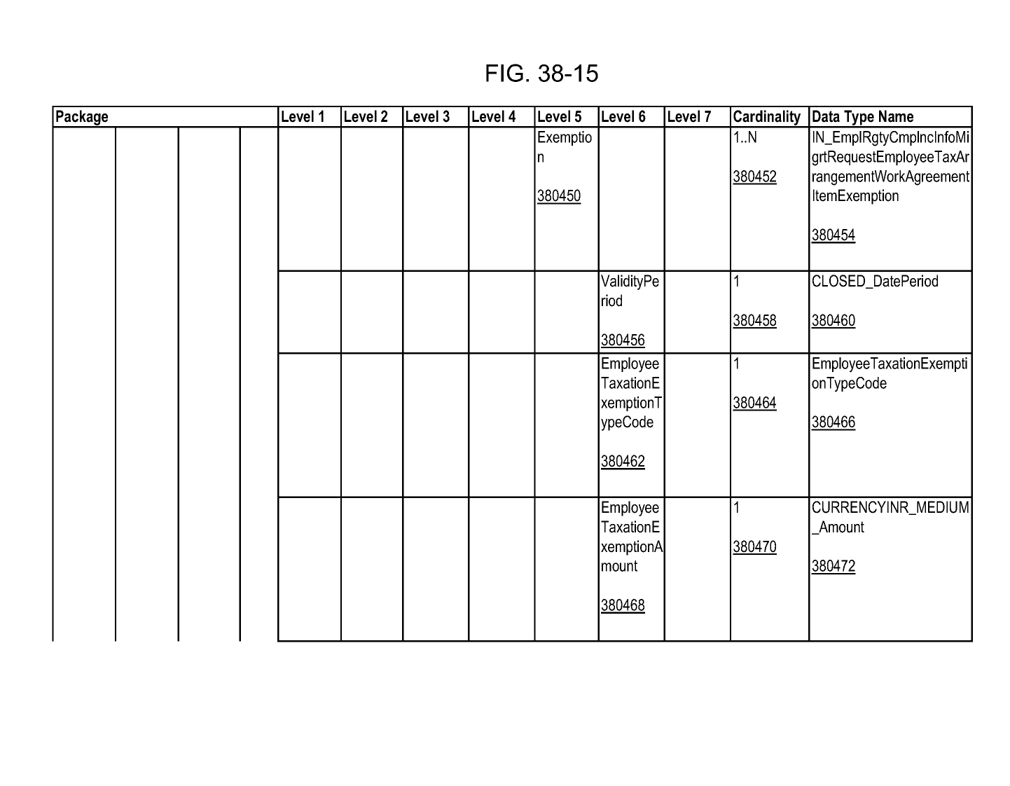

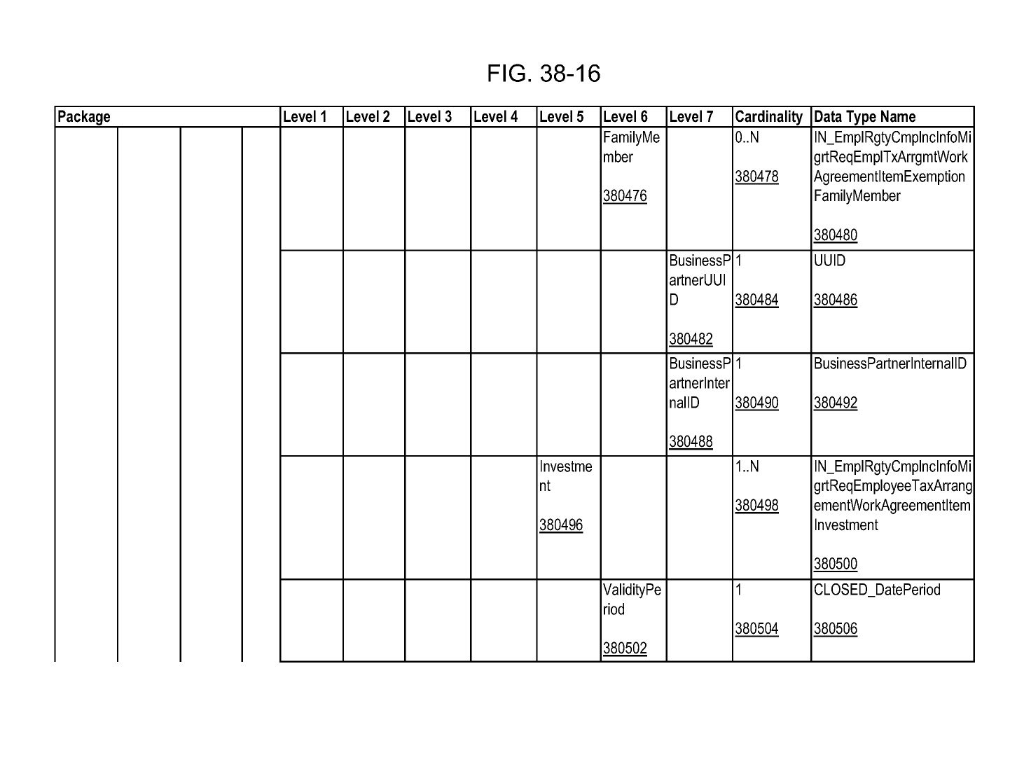

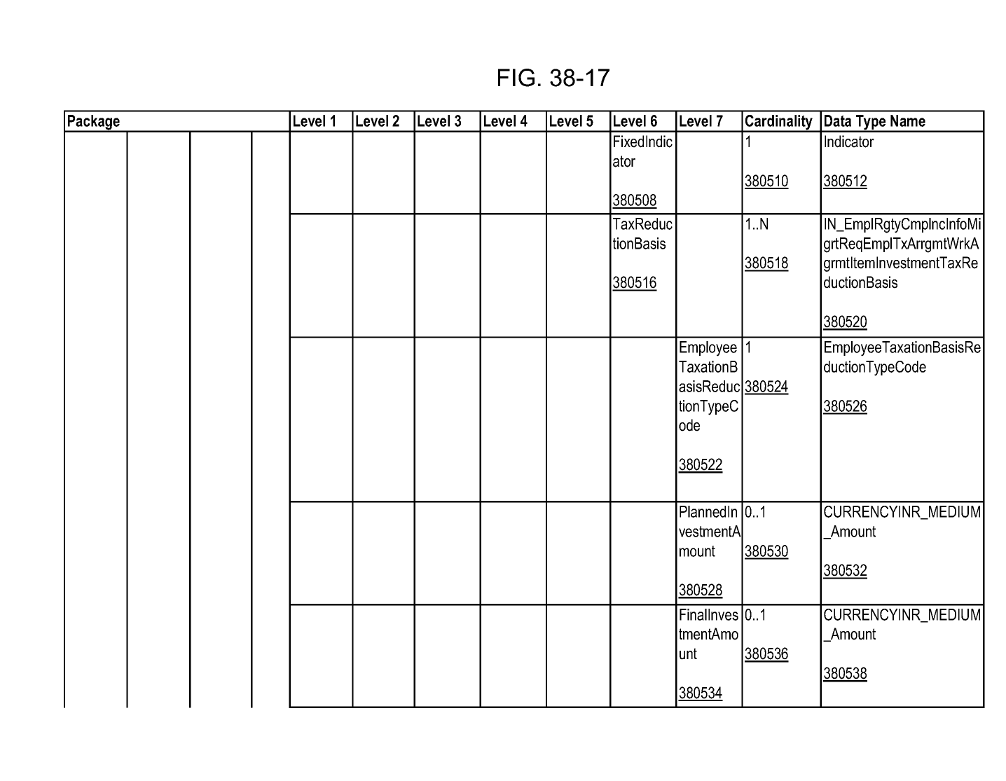

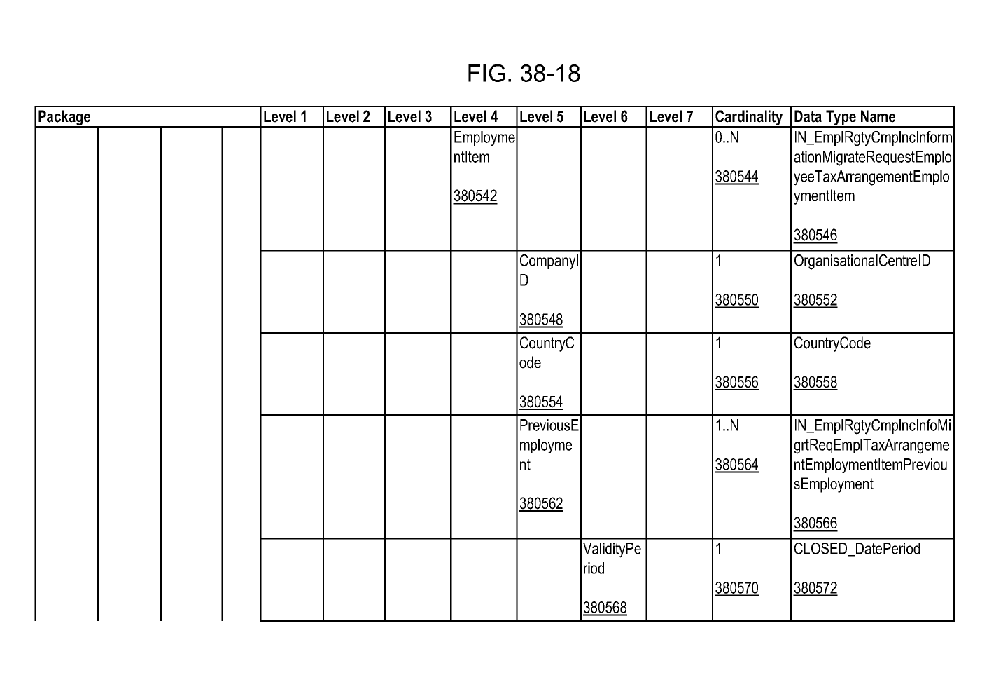

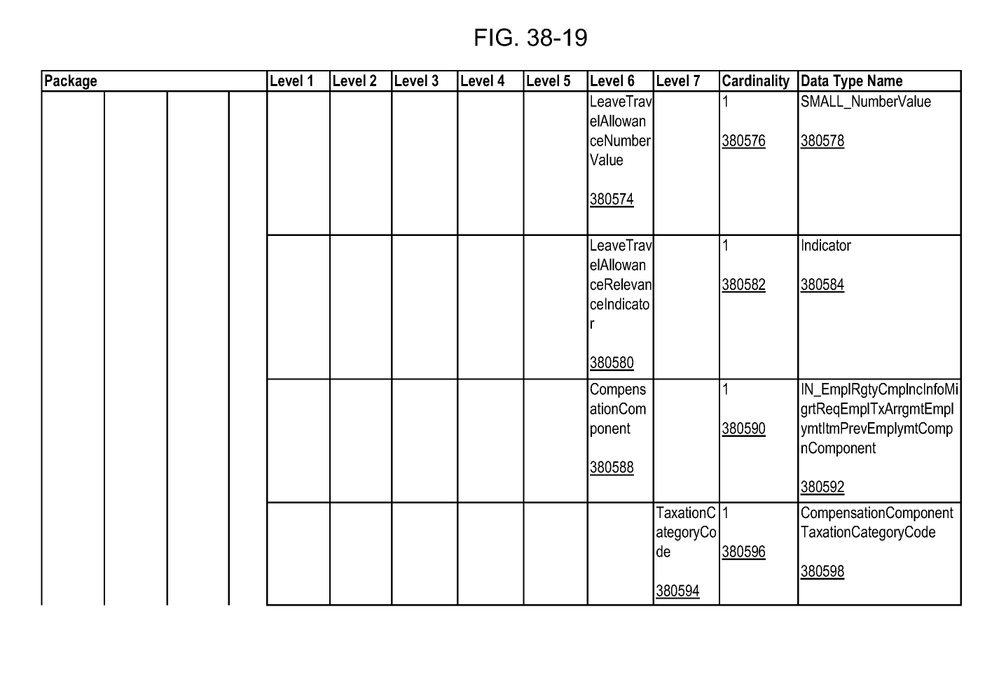

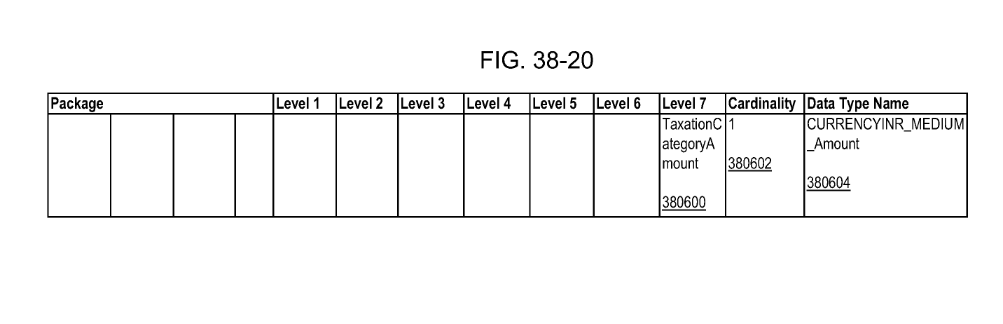

FIGS. 38-1 through 38-20 show an example configuration of an Element Structure that includes an IN_Employee Regulatory Compliance Information Migrate Request 380000 package. Specifically, these figures depict the arrangement and hierarchy of various components such as one or more levels of packages, entities, and datatypes, shown here as 380000 through 380604. As described above, packages may be used to represent hierarchy levels. Entities are discrete business elements that are used during a business transaction. Data types are used to type object entities and interfaces with a structure. For example, the IN_Employee Regulatory Compliance Information Migrate Request 380000 includes, among other things, an IN_Employee Regulatory Compliance Information Migrate Request 380002. Accordingly, heterogeneous applications may communicate using this consistent message configured as such.

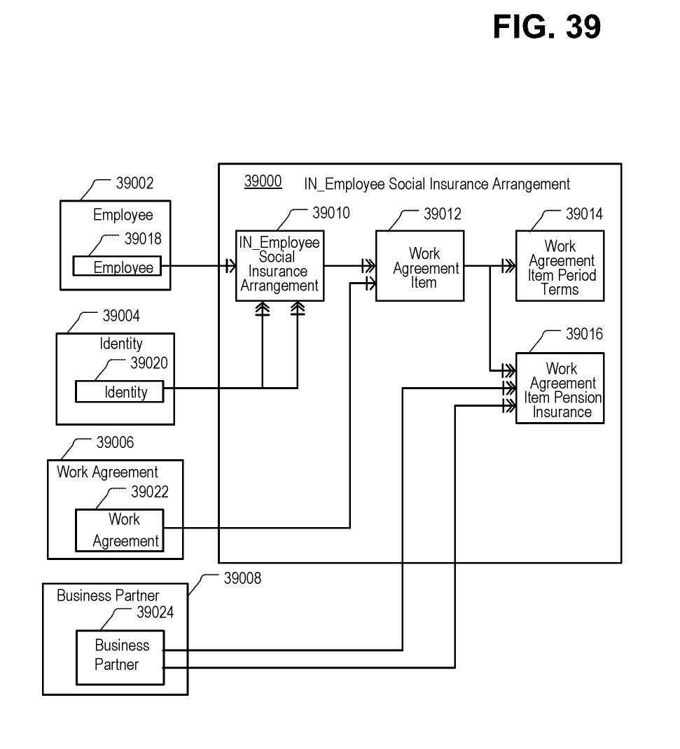

FIGS. 39-1 through 39-12 depict an example object model for the business object IN_Employee Social Insurance Arrangement 39000. The object model 39000 has relationships with other objects 39002-39008, as shown with lines and arrows. The object model 39000 hierarchically comprises elements 39010-39016. The other objects 39002-39008 include respective elements 39018-39024 as shown.

The business object IN_Employee Social Insurance Arrangement is an arrangement for an employee by responsible Indian bodies that are legally responsible for administering an employee's social insurance contributions. This arrangement concerns information used for calculation of Indian social insurance contributions and reporting according to Indian legal requirements. The business object IN_Employee Social Insurance Arrangement belongs to the process component IN Employer Regulatory Compliance and includes information used for different types of social insurance contributions (e.g. ESI (Employee State Insurance), Provident Fund, Labour Welfare Fund) to public and private bodies. An IN_EmployeeSocialInsuranceArrangement includes information from an employee's work agreements that is used for correct calculation and reporting of social insurance contributions. Information from a work agreement is time dependent and includes information for different types of private and public pension insurance contributions. The business object IN_Employee Social Insurance Arrangement is involved in the following process component interaction models: Data Migration System_IN Employer Regulatory Compliance_Employee and IN Employer Regulatory Compliance_Payroll Processing. The business object IN_Employee Social Insurance Arrangement includes information used for different types of social insurance contributions (e.g., illness, health insurance, pension insurance, unemployment insurance) to public and private bodies as supplementary information (e.g., reductions) assigned to an employee.

The elements located directly at the node IN_Employee Social Insurance Arrangement are defined by the datatype IN_EmployeeSocialInsuranceArrangementElements. These elements include: UUID, EmployeeUUID, MigratedDataAdaptationTypeCode, and SystemAdministrativeData. UUID may be an alternative key, is a universally unique identifier that identifies an Indian employee's social insurance arrangement, and may be based on datatype GDT: UUID. EmployeeUUID is a universally unique identifier of an employee for whom a social insurance arrangement applies, and may be based on datatype GDT: UUID. MigratedDataAdaptationTypeCode may be optional and is a coded representation of a type of data adaptation performed during migration of IN_Employee Social Insurance Arrangement data. When migrating data from a source system to a target system, this data may be adapted, for example, by a business object or business document and may be taken over completely or partially. In some implementations, MigratedDataAdaptationTypeCode is used when a IN_Employee Social Insurance Arrangement is migrated. MigratedDataAdaptationTypeCode may be based on datatype GDT: MigratedDataAdaptationTypeCode. SystemAdministrativeData describes who has created or changed an instance of IN_Employee Social Insurance Arrangement and at what date and time. SystemAdministrativeData may be based on datatype GDT: SystemAdministrativeData.

A composition relationship to a subordinate node Work Agreement Item with a cardinality of 1:CN may exist. An Employee inbound aggregation relationship from the business object Employee/node Employee may exist with a cardinality of 1:C which represents an employee for whom the Social Insurance Arrangement applies. A Last Change Identity inbound association relationship may exist from the business object Identity/node Identity, with a cardinality of 1:CN, which is an association from an identity which was a last changer of an IN_Employee Social Insurance Arrangement. A Creation Identity association may exist from the business object Identity/node Identity, with a cardinality of 1:CN, which is an association from an identity that has created an IN_Employee Social Insurance Arrangement. In some implementations, a definition is time-dependent per a work agreement and may be Indian-specific and may belong to one employee entity.

A Query By Employee query may be used to provide a list of all IN_EmployeeSocialInsuranceArrangements for a specified employee. The query elements for the Query By Employee query are defined by the datatype IN_EmployeeSocialInsuranceArrangementEmployeeQueryElements. These elements include: EmployeeUUID and EmployeeID. EmployeeUUID may be optional and may be based on datatype GDT: UUID. EmployeeID may be optional and may be based on datatype GDT: EmployeeID.

Work Agreement Item is a set of information required for Indian Social Insurance calculation and reporting purposes for one Work Agreement. The elements located directly at the node Work Agreement Item are defined by the datatype IN_EmployeeSocialInsuranceArrangementWorkAgreementItemElements. These elements include: UUID and WorkAgreementUUID. UUID may be an alternative key, is a universally unique identifier that identifies a Work Agreement Item node, and may be based on datatype GDT: UUID. WorkAgreementUUID is a universally unique identifier of a WorkAgreement for which an IN_EmployeeSocialInsuranceArrangement is valid, and may be based on datatype GDT: UUID.

The following composition relationships to subordinate nodes may exist: Work Agreement Item Period Terms with a cardinality of 1:CN, and Work Agreement Item Pension Insurance with a cardinality of 1:CN. A Work Agreement inbound aggregation relationship may exist from the business object Work Agreement/node Work Agreement with a cardinality of 1:C, which represents a Work Agreement for which Social Insurance details apply.

A Query By Employee And Work Agreement query may be used to provide a list of all IN_EmployeeSocialInsuranceArrangements for a specified work agreement of an employee. The query elements for the Query By Employee and Work Agreement query are defined by the datatype IN_EmployeeSocialInsuranceArrangementWorkAgreementItemEmployeeAndWorkAgreementQueryElements. These elements include: IN_EmployeeSocialInsuranceArrangementEmployeeUUID and WorkAgreementID. IN_EmployeeSocialInsuranceArrangementEmployeeUUID may be optional, is a universally unique identifier of an employee for whom a social insurance arrangement applies, and may be based on datatype GDT: UUID. WorkAgreementUUID: may be optional and may be based on datatype GDT: UUID.

Work Agreement Item Period Terms is a set of generic social insurance attributes which are valid for one work agreement relevant to a social insurance deduction calculation and reporting for a particular validity period. The period terms may be time dependent on Validity Period. Period terms details include information on a code for an employee social insurance contribution employee group and a relevance for a Labour Welfare Fund, Hospital Name, etc. The elements located directly at the node Work Agreement Item Period Terms are defined by the datatype IN_EmployeeSocialInsuranceArrangementWorkAgreementItemPeriodTermsElements. These elements include: UUID, ValidityPeriod, EmployeeSocialInsuranceID, TemporaryEmployeeSocialInsuranceID, HospitalNameText, LabourWelfareFundRelevanceIndicator, and GratuityEmployeeSocialInsuranceContributionAccountID. UUID may be an alternative key, is a universally unique identifier that identifies a Work Agreement Item Period Terms node, and may be based on datatype GDT: UUID. ValidityPeriod is a validity period of Work Agreement Item Period Terms, and may be based on datatype GDT: CLOSED_DatePeriod with a qualifier of Validity. EmployeeSocialInsuranceID may be optional, is a Social Insurance Arrangement account identification for an Employee, and may be based on datatype GDT: SocialInsuranceID. TemporaryEmployeeSocialInsuranceID may be optional, is a Temporary Social Insurance Arrangement account identification for an Employee, and may be based on datatype GDT: SocialInsuranceID. HospitalNameText may be optional, is a name of a Hospital recognized by a Social Insurance Arrangement of an Employee, and may be based on datatype GDT: LANGUAGEINDEPENDENT_MEDIUM_Text. Labour WelfareFundRelevanceIndicator indicates a relevance for a Labour Welfare Fund and may be based on datatype GDT: Indicator with a qualifier of Relevance. GratuityEmployeeSocialInsuranceContributionAccountID may be optional, is a gratuity account identification of a Social Insurance Arrangement of an Employee, and may be based on datatype GDT: EmployeeSocialInsuranceContributionAccountID.

Work Agreement Item Pension Insurance includes a set of relevant attributes of an Indian Pension Insurance that an employee has for a validity period. Work Agreement Item Pension Insurance may be time dependent on Validity Period. Pension insurance details include information on a code for a contribution type, and required amounts and rates to be paid by an employer or by an employee. The elements located directly at the node Work Agreement Item Pension Insurance are defined by the datatype IN_EmployeeSocialInsuranceArrangementWorkAgreementItemPensionInsuranceElements. These elements include: UUID, ValidityPeriod, PensionFund, BusinessPartnerUUID, BusinessPartnerInternalID, EmployeeSocialInsuranceContributionAccountID, EmployerPaymentIndicator, ProvidentFund, BusinessPartnerUUID, BusinessPartnerInternalID, EmployeeSocialInsuranceContributionAccountID, AdditionalEmployeeContributionPercent, and AdditionalEmployeeContributionAmount. UUID may be an alternative key, is a universally unique identifier that identifies a Work Agreement Item Pension Insurance node, and may be based on datatype GDT: UUID. ValidityPeriod is a validity period of a Work Agreement Item Pension Insurance, and may be based on datatype GDT: CLOSED_DatePeriod with a qualifier of Validity. PensionFund may be optional, is a set of relevant attributes of a pension fund where contributions towards pension are deposited, and may be based on datatype IDT: IN_EmployeeSocialInsuranceArrangementWorkAgreementItemPensionInsurancePensionFund. BusinessPartnerUUID is a universally unique identifier that identifies a Pension Insurance Business Partner, and may be based on datatype GDT: UUID. BusinessPartnerInternalID is a unique identifier that identifies a Pension Insurance Business Partner, and may be based on datatype GDT: BusinessPartnerInternalID. EmployeeSocialInsuranceContributionAccountID may be optional, is an identifier of a contribution account of an employee assigned by a Pension Insurance Authority, and may be based on datatype GDT: EmployeeSocialInsuranceContributionAccountID. EmployerPaymentIndicator indicates whether an employer contributes to a Pension fund, and may be based on datatype GDT: Indicator, with a qualifier of Payment. ProvidentFund may be optional, is a set of relevant attributes of a Provident Fund trust where contributions towards Pension Insurance are deposited, and may be based on datatype IDT: IN_EmployeeSocialInsuranceArrangementWorkAgreementItemPensionInsuranceProvidentFund. BusinessPartnerUUID is a universally unique identifier that identifies a Provident Fund Business Partner, and may be based on datatype GDT: UUID. BusinessPartnerInternalID is a unique identifier that identifies a Provident Fund Business Partner, and may be based on datatype GDT: BusinessPartnerInternalID. EmployeeSocialInsuranceContributionAccountID may be optional, is an identifier of a contribution account of an employee assigned by a Provident Fund, and may be based on datatype GDT: EmployeeSocialInsuranceContributionAccountID. AdditionalEmployeeContributionPercent may be optional, is a contribution percent for an additional contribution for Provident Fund of an Employee, and may be based on datatype GDT: SMALLNONNEGATIVE_Percent, with a qualifier of Contribution. AdditionalEmployeeContributionAmount may be optional, is a contribution amount for an additional contribution for Provident Fund of an Employee, and may be based on datatype GDT: CURRENCYINR_MEDIUM_Amount, with a qualifier of Contribution. A Provident Fund Business Partner inbound aggregation relationship may exist from the business object Business Partner/node Business Partner with a cardinality of 1:CN, which is a provident fund business partner for which the Work Agreement Item Pension Insurance applies. A Pension Fund Business Partner inbound aggregation relationship may exist from the business object Business Partner/node Business Partner with a cardinality of 1:CN, which is a pension fund business partner for which the Work Agreement Item Pension Insurance applies.

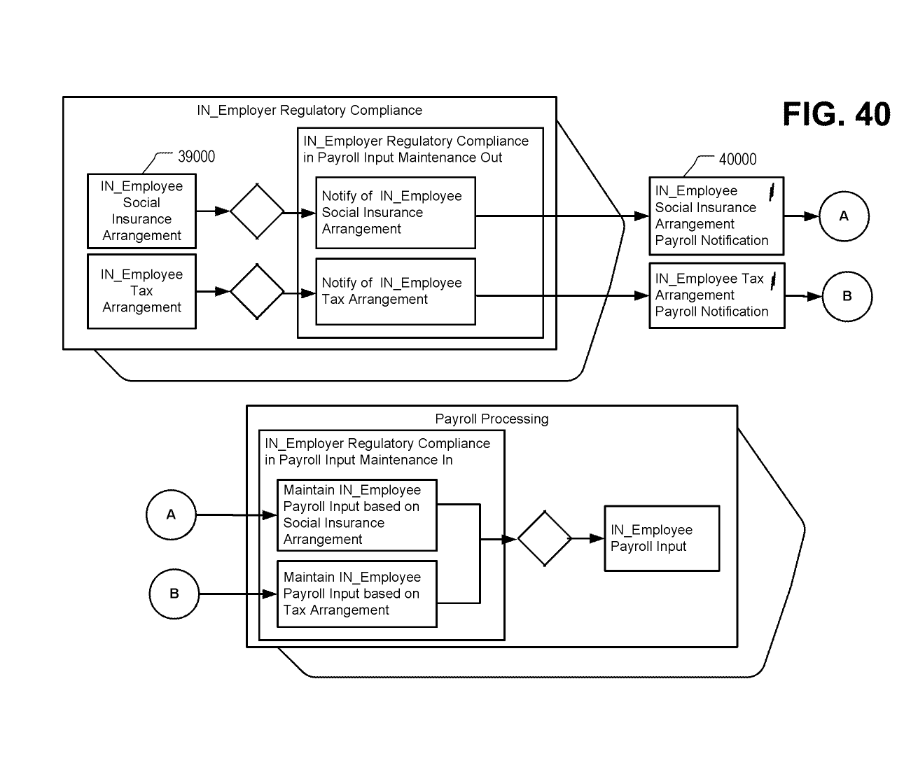

FIG. 40 depicts an example IN_EmployeeSocialInsuranceArrangementPayrollNotification Message Data Type 40000. The message type IN_EmployeeSocialInsuranceArrangementPayrollNotification includes a notification to a payroll deployment unit concerning an employee's social insurance information. Employee social insurance information is used to correctly calculate social insurance contributions and transfer contributions to social insurance organizations. In addition, an employee's social insurance information is used for social insurance contribution reporting purposes. The structure of the message type IN_EmployeeSocialInsuranceArrangementPayrollNotification is determined by the message data type IN_EmployeeSocialInsuranceArrangementMessage. The message type IN_EmployeeSocialInsuranceArrangementPayrollNotification is used in the following operations of business objects: IN_EmployeeSocialInsuranceArrangement, NotifyOfIN_EmployeeSocialInsuranceArrangement, IN_EmployeePayrollInput, and MaintainIN_EmployeePayrollInputBasedOnSocialInsuranceArrangement. The message data type IN_EmployeeSocialInsuranceArrangementPayrollNotification includes an object 1.1 which is included in a business document, business information that is relevant for sending a business document in a message, the MessageHeader package, and the 1.1 package. This message data type IN_EmployeeSocialInsuranceArrangementPayrollNotification provides a structure for the PIC_ServicePartDemandForecast message type and for associated operations.

The MessageHeader package is a grouping of business information that is relevant for sending a business document in a message. The MessageHeader package includes the MessageHeader node. The MessageHeader node is a grouping of business information from the perspective of a sending application, such as information to identify the business document in a message, information about the sender, and optionally information about the recipient. The MessageHeader includes SenderParty and RecipientParty. MessageHeader may be based on the datatype GDT:BusinessDocumentMessageHeader.

The following elements of the GDT may be used: RecipientParty, BusinessScope, SenderParty, SenderBusinessSystemID, TestDataIndicator, RecipientBusinessSystemID, ReferenceID, ReferenceUUID, ReconciliationIndicator, ID, UUID, and CreationDateTime. SenderParty is the partner responsible for sending a business document at a business application level. The SenderParty is of the type GDT:BusinessDocumentMessageHeaderParty. RecipientParty is of the type GDT:BusinessDocumentMessageHeaderParty. RecipientParty is the partner responsible for receiving a business document at a business application level.

The 1.1 package is a grouping of 1.1 with one or more WorkAgreementItemPackage packages. IN_EmployeeSocialInsuranceArrangement includes the elements: @WorkAgreementItemListCompleteTransmissionIndicator, @reconciliationPeriodCounterValue, UUID, and EmployeeUUID. @WorkAgreementItemListCompleteTransmissionIndicator may be based on datatype GDT: Indicator with a qualifier of CompleteTransmission, and specifies whether WorkAgreementItem data in a message is transmitted in its entirety. “Complete transmission” may mean a complete transmission of all child elements of an element that are relevant for a message. When an element is deleted, all child elements are regarded as also deleted. @reconciliationPeriodCounterValue may be based on datatype GDT: ReconciliationPeriodCounterValue. UUID may be based on datatype GDT: UUID. EmployeeUUID may be based on datatype GDT: UUID.

WorkAgreementItempackage is a grouping of WorkAgreementItempackage with its packages: WorkAgreementItemPeriodTerms with a cardinality of 0 . . . n, and WorkAgreementItemPensionInsurance with a cardinality of 0 . . . n. The WorkAgreementItempackage includes the elements: @workAgreementItemPeriodTermsListCompleteTransmissionIndicator, @workAgreementItemPensionInsuranceListCompleteTransmissionIndicator,and UUID, WorkAgreementUUID. @workAgreementItemPeriodTermsListCompleteTransmissionIndicator may be optional, may be based on datatype GDT: Indicator with a qualifier of CompleteTransmission and specifies whether the WorkAgreementItemPeriodTerms data in a message is transmitted in its entirety. @workAgreementItemPensionInsuranceListCompleteTransmissionIndicator may be optional, may be based on datatype GDT: Indicator with a qualifier of CompleteTransmission, and specifies whether the WorkAgreementItemPensionInsurance data in a message is transmitted in its entirety. UUID may be based on datatype GDT: UUID. WorkAgreementUUID may be based on datatype GDT: UUID.

WorkAgreementItemPeriodTerms includes the elements: @actionCode, UUID, ValidityPeriod, EmployeeSocialInsuranceID, TemporaryEmployeeSocialInsuranceID, HospitalNameText, Labour WelfareFundRelevanceIndicator, and GratuityEmployeeSocialInsuranceContributionAccountID. @actionCode may be based on datatype GDT: ActionCode. An ActionCode is a coded representation of an instruction to a recipient of a message describing how to process a transmitted element. UUID may be based on datatype GDT: UUID. ValidityPeriod may be based on datatype GDT: DatePeriod with a restriction of CLOSED and a qualifier of Validity. EmployeeSocialInsuranceID may be optional and may be based on datatype GDT: EmployeeSocialInsuranceID. TemporaryEmployeeSocialInsuranceID may be optional and may be based on datatype GDT: EmployeeSocialInsuranceID. HospitalNameText may be optional and may be based on datatype GDT: LanguageIndependent_Medium_Text. LabourWelfareFundRelevanceIndicator may be based on datatype GDT: Indicator with a qualifier of Relevance. GratuityEmployeeSocialInsuranceContributionAccountID may be optional and may be based on datatype GDT EmployeeSocialInsuranceContributionAccountID. In some implementations, if the value of the attribute @actionCode is “Delete”, only the UUID is filled. In some implementations, if the value of the attribute @actionCode is other than “Delete”, then ValidityPeriod, EmployeeSocialInsuranceID and LabourWelfareFundRelevanceIndicator are also filled.

WorkAgreementItemPensionInsurance is a grouping of WorkAgreementItemPensionInsurancepackage with its packages: WorkAgreementItemPensionInsurancePensionFund with a cardinality of 0 . . . n and WorkAgreementItemPensionInsuranceProvidentFund with a cardinality of 0 . . . n. WorkAgreementItemPensionInsurance includes the elements: @workAgreementItemPensionInsurancePensionFundListCompleteTransmissionIndicator, @workAgreementItemPensionInsuranceProvidentFundListCompleteTransmissionIndicator, @actionCode, UUID, ValidityPeriod, BusinessPartnerUUID, BusinessPartnerInternalID, EmployeeSocialInsuranceContributionAccountID, EmployerPaymentIndicator, ProvidentFund, AdditionalEmployeeContributionPercentage, and AdditionalEmployeeContributionAmount.

@workAgreementItemPensionInsurancePensionFundListCompleteTransmissionIndicator may be based on datatype GDT: Indicator and specifies whether the WorkAgreementItemPensionInsurancePensionFund data in a message is transmitted in its entirety. @workAgreementItemPensionInsuranceProvidentFundListCompleteTransmissionIndicator may be based on datatype GDT: Indicator and specifies whether the WorkAgreementItemPensionInsuranceProvidentFund data in a message is transmitted in its entirety.

@actionCode is a coded representation of an instruction to a recipient of a message describing how to process a transmitted element, and may be based on datatype GDT: ActionCode. UUID may be based on datatype GDT: UUID. ValidityPeriod may be based on datatype GDT: DatePeriod with a restriction of CLOSED and a qualifier of Validity. PensionFund may be based on datatype IDT: IN_EmployeeSocialInsuranceArrangementWorkAgreementItemPensionInsurancePensionFund. BusinessPartnerUUID may be based on datatype GDT: UUID. BusinessPartnerInternalID may be based on datatype GDT: BusinessPartnerInternalID. EmployeeSocialInsuranceContributionAccountID may be based on datatype GDT: EmployeeSocialInsuranceContributionAccountID. EmployerPaymentIndicator may be based on datatype GDT: Indicator with a qualifier of Payment. ProvidentFund may be based on datatype IDT: IN_EmployeeSocialInsuranceArrangementWorkAgreementItemPensionInsuranceProvidentFund. AdditionalEmployeeContributionPercentage may be based on datatype GDT: SMALLNONNEGATIVE_Percent. AdditionalEmployeeContributionAmount may be based on datatype GDT: CURRENCYINR_MEDIUM_Amount. In some implementations, if the value of the attribute @actionCode is “Delete”, only the UUID is filled. In some implementations, if the value of the attribute @actionCode is other than “Delete”, then ValidityPeriod, EmployeeSocialInsuranceID and LabourWelfareFundRelevanceIndicator are also filled.

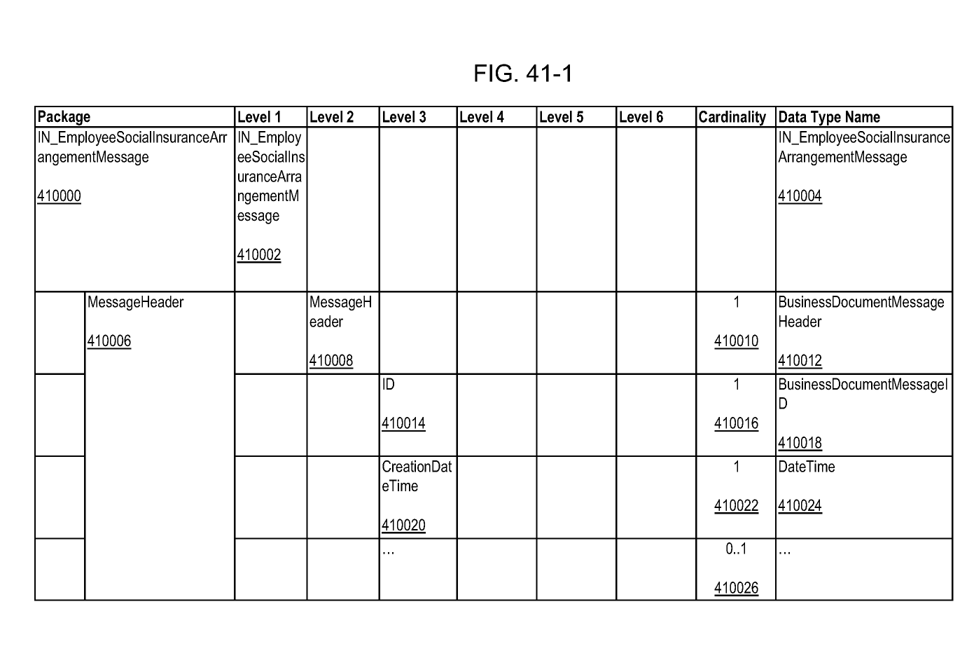

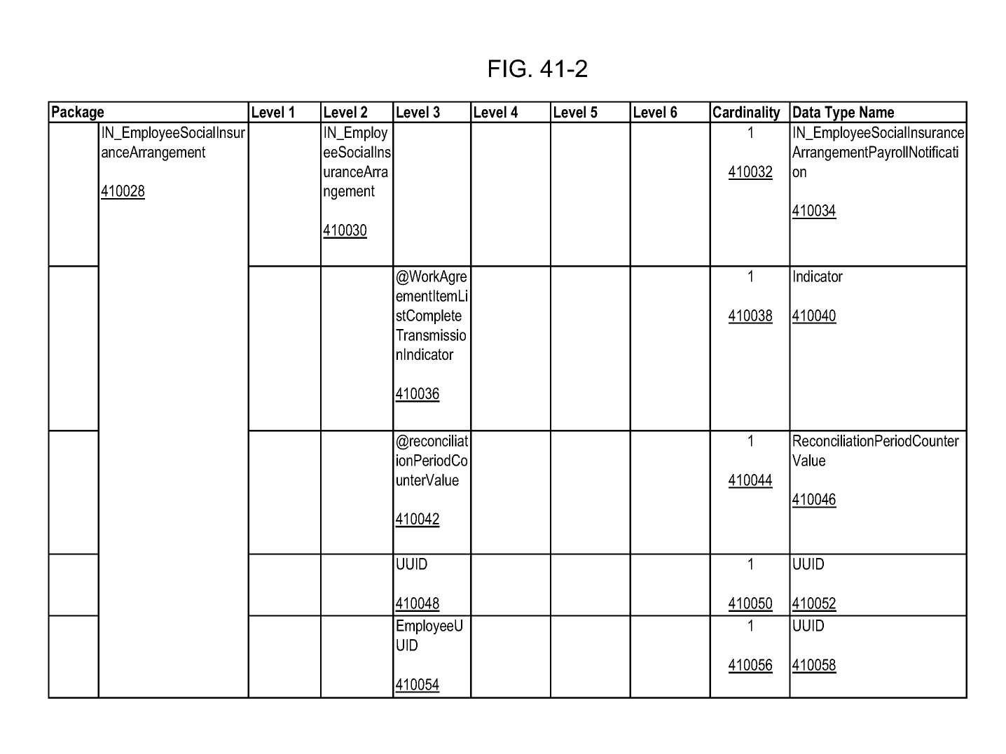

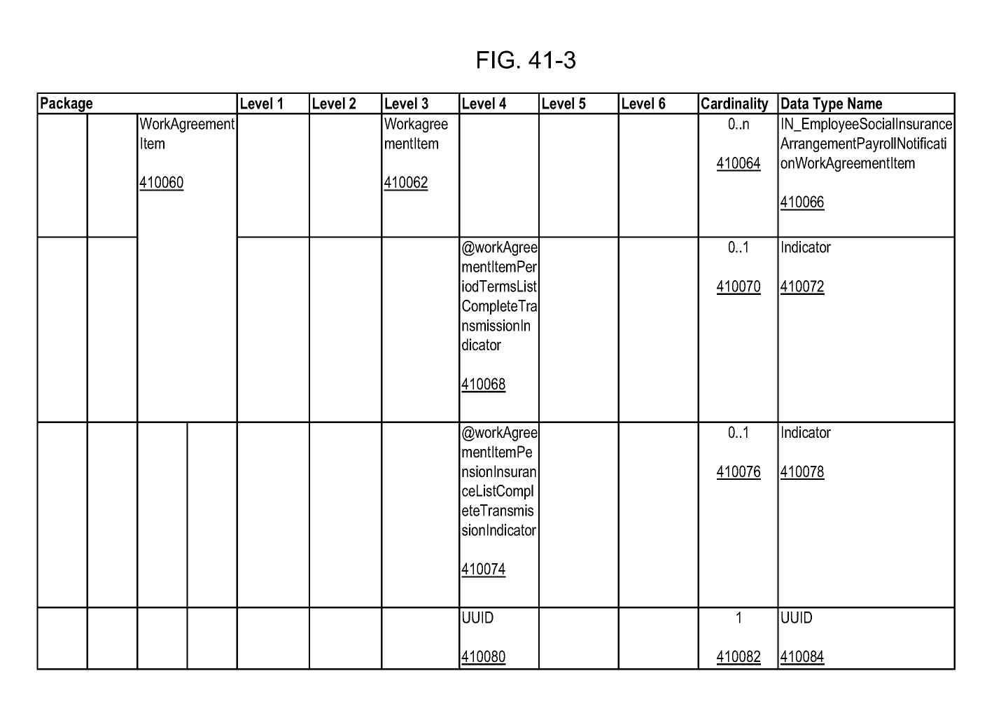

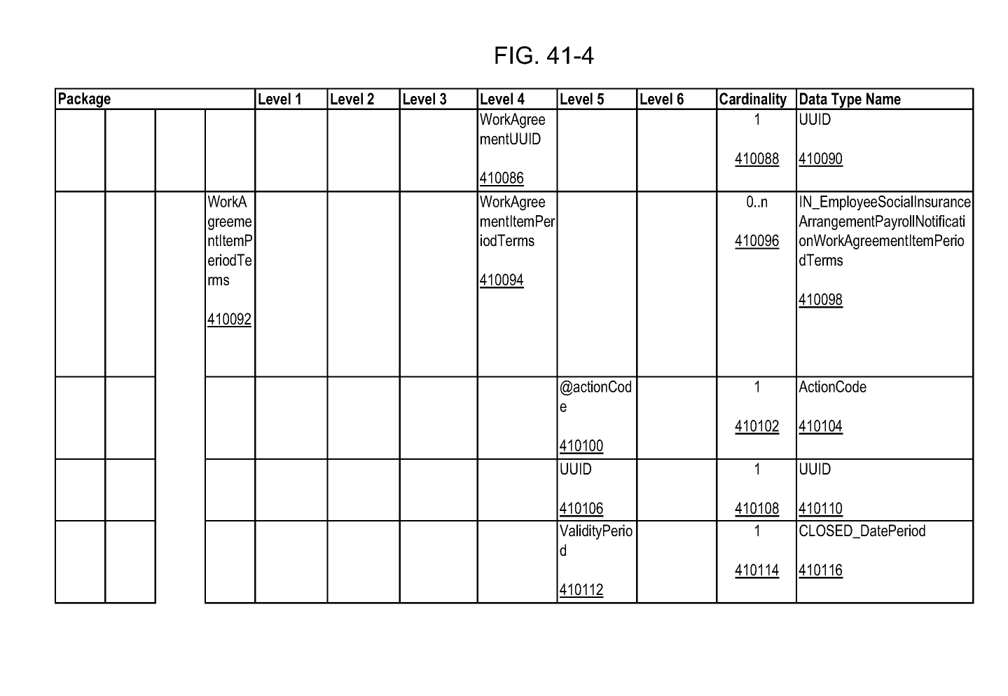

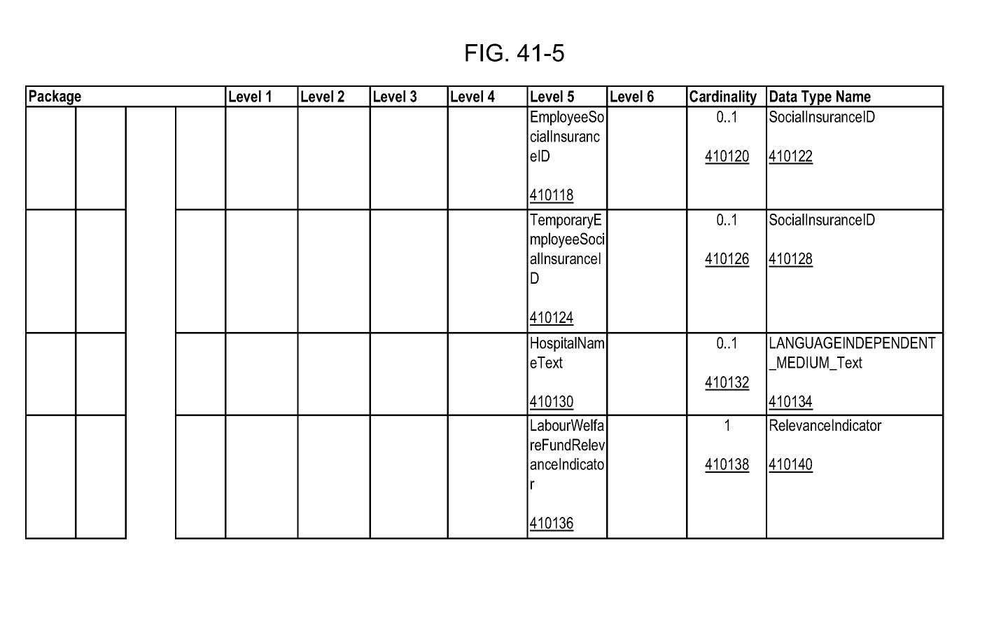

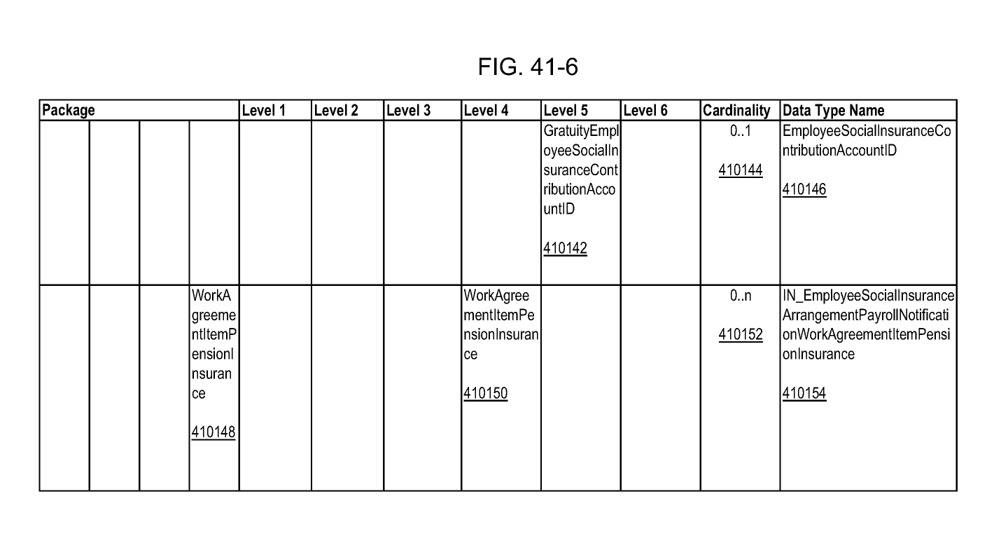

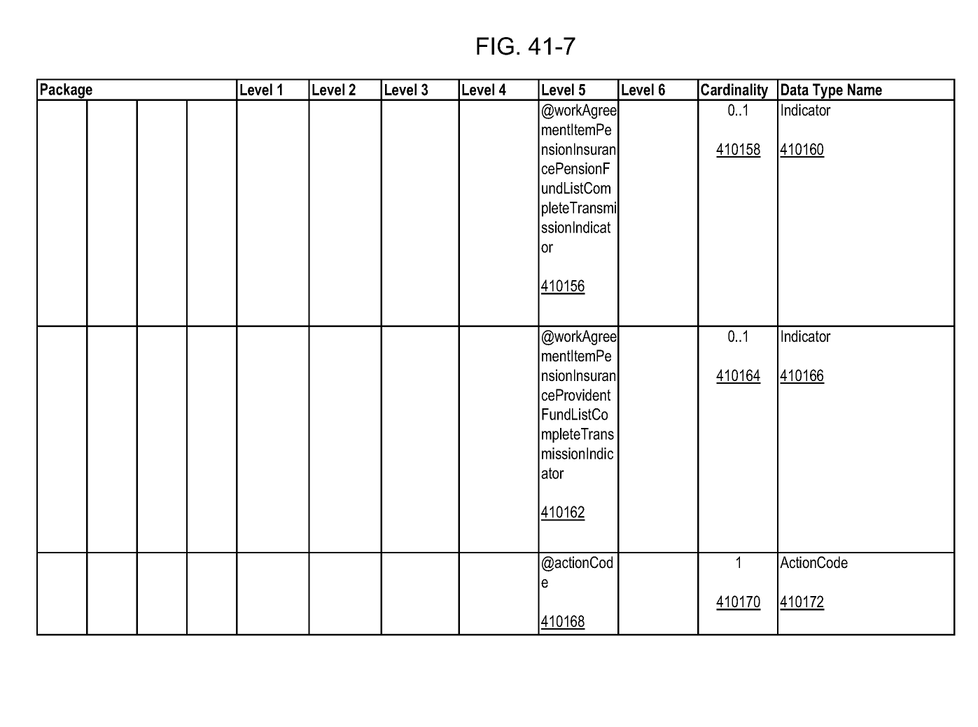

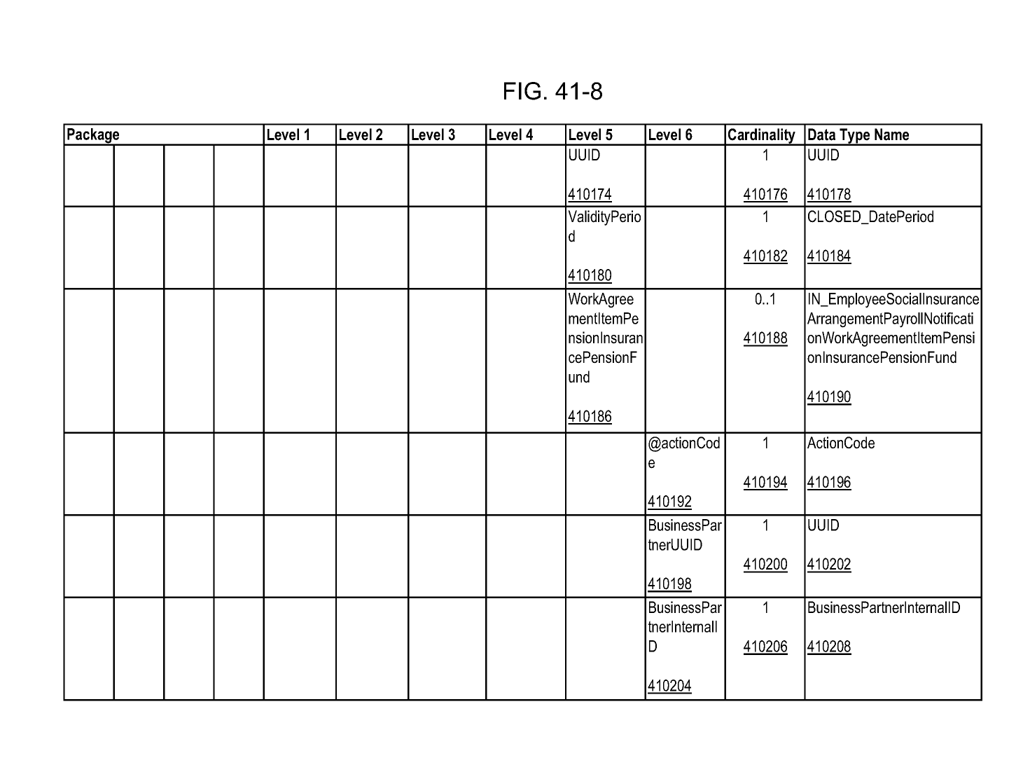

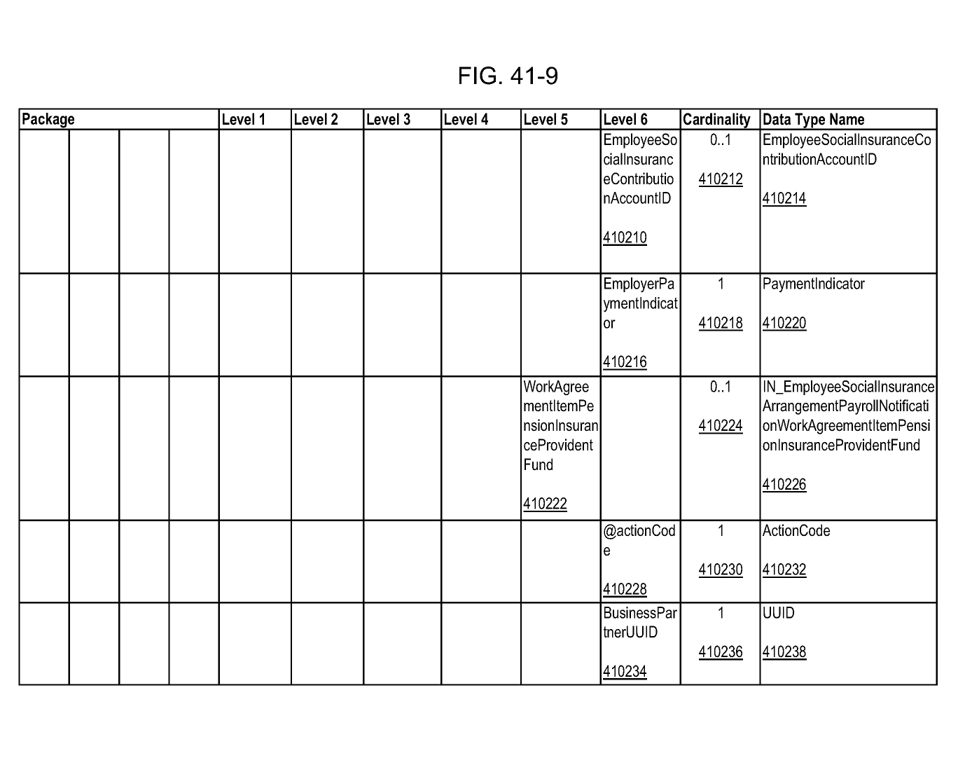

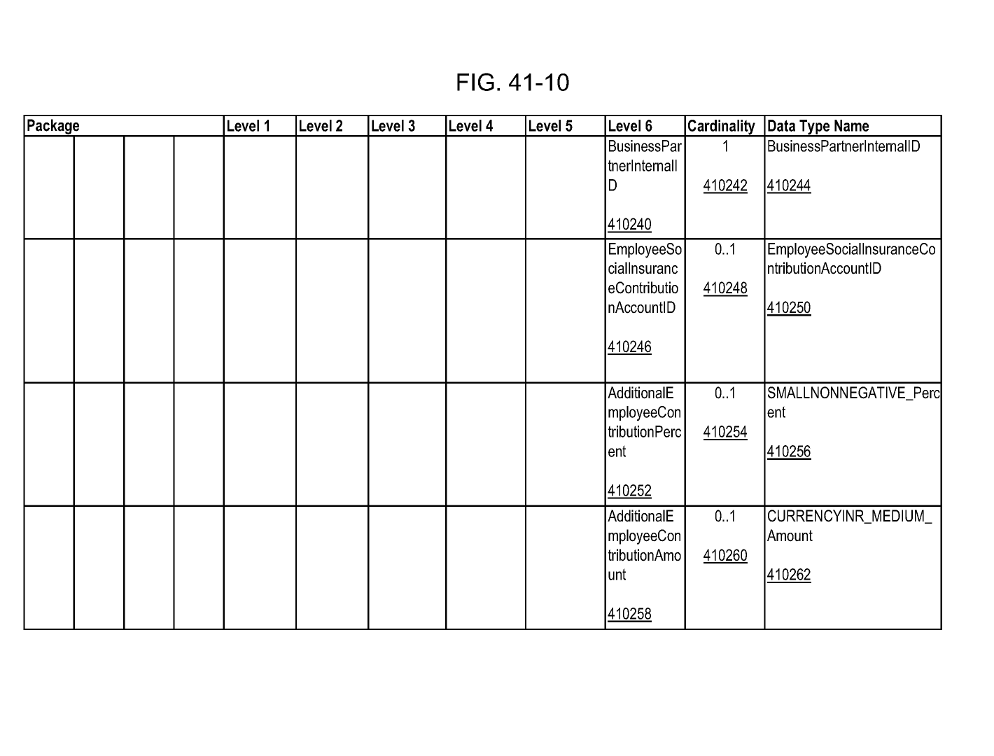

FIGS. 41-1 through 41-10 show an example configuration of an Element Structure that includes an IN_EmployeeSocialInsuranceArrangementMessage 410000 package. Specifically, these figures depict the arrangement and hierarchy of various components such as one or more levels of packages, entities, and datatypes, shown here as 410000 through 410262. As described above, packages may be used to represent hierarchy levels. Entities are discrete business elements that are used during a business transaction. Data types are used to type object entities and interfaces with a structure. For example, the IN_EmployeeSocialInsuranceArrangementMessage 410000 includes, among other things, a IN_EmployeeSocialInsuranceArrangementMessage 410002. Accordingly, heterogeneous applications may communicate using this consistent message configured as such.

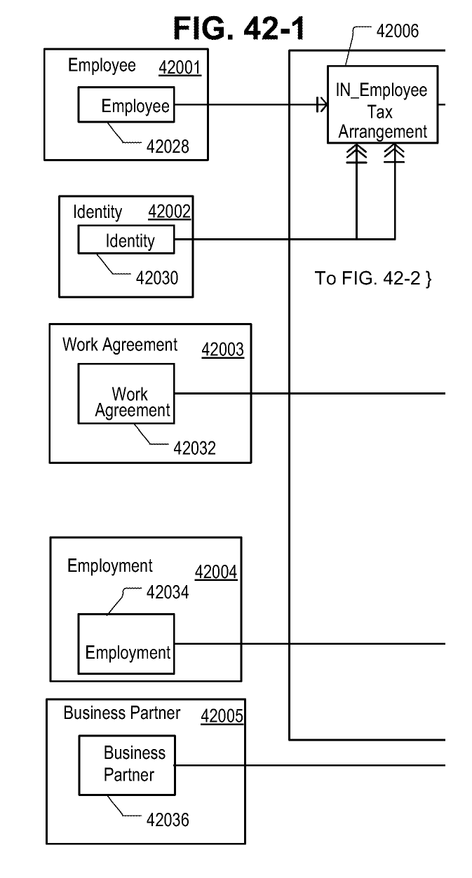

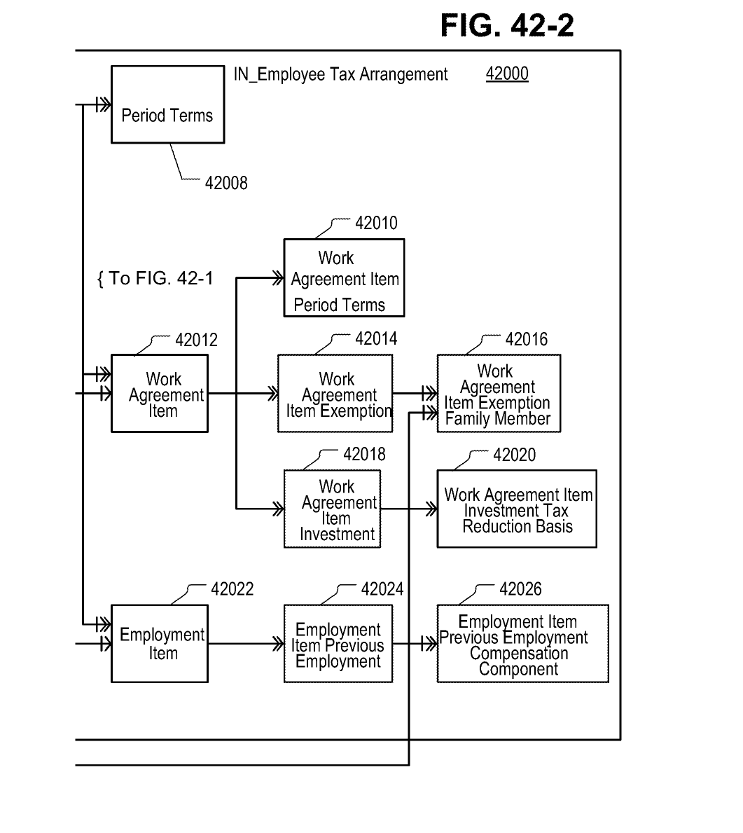

FIGS. 42-1 through 42-2 depict an example Object Model for the business object IN_Employee Tax Arrangement. The object model 42000 has relationships with other objects 42001-42005, as shown with lines and arrows. The object model 42000 hierarchically comprises elements 42006-42026. The other objects 42001-42005 include respective elements 42026-42036 as shown.

The business object IN_Employee Tax Arrangement is an arrangement between an employee and tax authorities of India that defines rules of how an employer calculates and reports taxes for the employee to be compliant with Indian legal requirements. The business object IN_Employee Tax Arrangement belongs to the process component IN Employer Regulatory Compliance. The business object IN_Employee Tax Arrangement includes information relating to a tax procedure, tax exemptions, and previous employer incomes. An IN_EmployeeTaxArrangement includes information for an employee's work agreements that is used for correct tax calculation and reporting. The information for a work agreement is time dependent and includes general tax information. The business object IN_EmployeeTaxArrangement is involved in the following Process Component Interaction Models: Data Migration System_IN Employer Regulatory Compliance_Employee and IN Employer Regulatory Compliance_Payroll Processing_Payroll Input Maintenance. A service interface Employee Migration In may have a technical name of INEmployerRegulatoryComplianceEmployeeMigrationln. The Service Interface Employee Migration In is part of the Data Migration System_IN Employer Regulatory Compliance_Employee process component interaction model and is an interface to migrate employee-specific data used for employer regulatory compliance in India. The Service Interface Employee Migration In may include a Create Employee Arrangements operation, which may have a technical name of INEmployerRegulatoryComplianceEmployeeMigrationIn.CreateEmployeeArrangements and which may be used to create business objects for employee arrangements. The Create Employee Arrangements operation is based on message type IN_Employee Regulatory Compliance Information Migrate Request, which may be derived from business object IN_Employee Regulatory Compliance Information_Virtual Object. A service interface IN Employer Regulatory Compliance in Payroll Input Maintenance Out may have a technical name of INEmployerRegulatoryComplianceINEmployerRegulatoryComplianceInPayrollInputMaintenan ceOut, may be part of the IN Employer Regulatory Compliance_Payroll Processing_Payroll Input Maintenance process component interaction model, and may be used to group operations that transmit employer regulatory compliance data for an employee in India from a Human Capital Management deployment unit to a Payroll Processing deployment unit. The INEmployerRegulatoryComplianceINEmployerRegulatoryComplianceInPayrollInputMaintenanceOut service interface may include a Notify of IN_Employee Tax Arrangement operation, which may have a technical name of INEmployerRegulatoryComplianceINEmployerRegulatoryComplianceInPayrollInputMaintenanceOut.NotifyOfTaxArrangement, may be used to notify a Payroll Processing deployment unit about new or changed tax data for an Employee in a Human Capital Management deployment unit, may be based on message type IN_Employee Tax Arrangement Payroll Notification derived from business object IN_Employee Tax Arrangement. In some implementations, after relevant Indian employee tax arrangement information is updated in IN Employer Regulatory Compliance, a message type IN_EmployeeTaxArrangementPayrollNotification is sent to Payroll Processing to update corresponding information in the object IN_EmployeePayrollInput. A Notify of IN_Employee Social Insurance Arrangement operation may have a technical name of INEmployerRegulatoryComplianceINEmployerRegulatoryComplianceInPayrollInputMaintenanceOut.NotifyOfSocialInsuranceArmnt, may be used to notify a Payroll Processing deployment unit about new or changed social insurance data for an Employee in a Human Capital Management deployment unit, and may be based on message type IN_Employee Social Insurance Arrangement Payroll Notification derived from business object IN_Employee Social Insurance Arrangement. In some implementations, after relevant Indian employee social insurance arrangement information is updated in IN Employer Regulatory Compliance, a message type IN_EmployeeSocialInsuranceArrangementPayrollNotification is sent to Payroll Processing to update the corresponding information in the object IN_EmployeePayrollInput.

The IN_Employee Tax Arrangement Root Node may include information recorded from a tax card submitted by an employee (e.g., tax identifier, tax area, employee tax type) and supplementary details (e.g., taxation category, tax exempt indicator) and may be time dependent on Validity Period. The elements located directly at the node IN_Employee Tax Arrangement are defined by the datatype IN_EmployeeTaxArrangementElements. These elements include: UUID, EmployeeUUID, MigratedDataAdaptionTypeCode, and SystemAdministrativeData. UUID may be an alternative key, is a universally unique identifier for an IN_EmployeeTaxArrangement, and may be based on datatype GDT: UUID. EmployeeUUID is a universally unique identifier of an employee for whom an IN_Employee Tax Arrangement is valid, and may be based on datatype GDT: UUID. MigratedDataAdaptionTypeCode may be optional, is a coded representation of a type of data adaptation performed during migration of IN_Employee Tax Arrangement data. When migrating data from a source system to a target system, data may be adapted, for example, by a business object or business document. MigratedDataAdaptionTypeCode may be based on datatype GDT: MigratedDataAdaptationTypeCode. The MigratedDataAdaptationTypeCode may be used when a IN_Employee Tax Arrangement is migrated. SystemAdministrativeData describes who has created or changed an instance of IN_Employee Tax Arrangement and at what time. SystemAdministrativeData may be based on datatype GDT: SystemAdministrativeData.

The following composition relationships to subordinate nodes may exist for the IN_Employee Tax Arrangement Root Node: PeriodTerms with a cardinality of 1:CN, WorkAgreementItem with a cardinality of 1:CN, and EmploymentItem with a cardinality of 1:CN. An Employee inbound aggregation relationship may exist from the business object Employee/node Employee with a cardinality of 1:C, which represent an employee for whom a tax arrangement applies. A Creation Identity inbound association relationship may exist from the business object Identity/node Identity with a cardinality of 1:CN, which is an association from an identity that has created the IN_Employee Tax Arrangement. A Last Change Identity association may exist from the business object Identity/node Identity with a cardinality of 1:CN, which is an association from an identity which was a last changer of the IN_Employee Tax Arrangement.

A Query By Employee ID query may be used to provide a list of all IN_EmployeeTaxArrangement for a specified employee. The query elements for Query By EmployeeID are defined by the datatype IN_EmployeeTaxArrangementEmployeeIDQueryElements. These EmployeeTaxArrangementEmployeeIDQueryElements. These elements include: EmployeeUUID and EmployeeldentificationEmployeeID. EmployeeUUID may be optional, may be an alternative key, and may be based on datatype GDT: UUID. EmployeeldentificationEmployeeID may be optional and may be based on datatype GDT: EmployeeID. A Select All query may be used to provides the NodeIDs of all instances of a node and may be used to to enable an initial load of data for a fast search infrastructure.

Period Terms is a set of information relevant for Indian tax calculation and reporting purposes for an employee for a validity period. Period Terms may be time dependent on Validity Period. The period terms details include a Tax Identification number of an employee. The elements located directly at the node Period Terms are defined by the datatype IN_EmployeeTaxArrangementPeriodTermsElements. These elements include: UUID, ValidityPeriod, and EmployeeTaxID. UUID may be an alternative key, is a universally unique identifier that identifies a Period Terms node, and may be based on datatype GDT: UUID. ValidityPeriod is a validity period of a Period Terms and may be based on datatype GDT: CLOSED_DatePeriod with a qualifier of Validity. EmployeeTaxID is an identifier of an Employee for tax purposes and may be based on datatype GDT: PartyTaxID.

Work Agreement Item is a set of information used for Indian tax calculation and reporting purposes for one Work Agreement. The elements located directly at the node Work Agreement Item are defined by the datatype IN_EmployeeTaxArrangementWorkAgreementItemElements. These elements include: UUID and WorkAgreementUUID. UUID may be an alternative key, is a universally unique identifier that identifies a WorkAgreementItem node, and may be based on datatype GDT: UUID. WorkAgreementUUID is a universally unique identifier of a WorkAgreement for which an IN_EmployeeTaxArrangement is valid, and may be based on datatype GDT: UUID.

The following composition relationships to subordinate nodes exist for Work Agreement Item: Work Agreement Item Period Terms with a cardinality of 1:N, Work Agreement Item Exemption with a cardinality of 1:N, and Work Agreement Item Investment with a cardinality of 1:N. A WorkAgreement inbound aggregation relationship may exist from the business object Work Agreement/node Work Agreement with a cardinality of 1:C which represents the WorkAgreement for which a tax-relevant data apply. In some implementations, WorkAgreementItemPeriodTerms may not overlap (i.e., only one node may be valid for any given point in time).

A Query By Employee And Work Agreement query may be used to provide a list of all IN_EmployeeTaxArrangement for a particular work agreement of an employee. The query elements for the Query By Employee And Work Agreement query are defined by the datatype IN_EmployeeTaxArrangementWorkAgreementItemEmployeeAndWorkAgreementQueryElements. These elements include: IN_EmployeeTaxArrangementEmployeeUUID and WorkAgreementUUID. IN_EmployeeTaxArrangementEmployeeUUID may be optional and may be based on datatype GDT: UUID. WorkAgreementUUID may be optional and may be based on datatype GDT: UUID.

Work Agreement Item Period Terms is a set of tax relevant attributes which are valid for one work agreement for a validity period. Work Agreement Item Period Terms may be time dependent on Validity Period and may include a taxation rule and an exemption method. The elements located directly at the node Work Agreement Item Period Terms are defined by the datatype IN_EmployeeTaxArrangementWorkAgreementItemPeriodTermsElements. These elements include: UUID, ValidityPeriod, CityTaxationCategoryCode, HouseRentAmount, ExemptedIndicator, and ProfessionalTaxRelevanceIndicator. UUID may be an alternative key, is a universally unique identifier that identifies a WorkAgreementItemPeriodTerms node, and may be based on datatype GDT: UUID. ValidityPeriod is a validity period of a WorkAgreementItemPeriodTerms node and may be based on datatype GDT: CLOSED_DatePeriod, with a qualifier of Validity. CityTaxationCategoryCode may be optional, is a coded representation of a city category for taxation purposes of an employees residence, and may be based on datatype GDT: CityTaxationCategoryCode. HouseRentAmount may be optional, indicates an amount paid per month as rent towards employee accommodation and may be based on datatype GDT: CURRENCYINR_MEDIUM_Amount with a qualifier of Rent. ExemptedIndicator is an indicator used to denote whether a special exemption for taxes applies and may be based on datatype GDT: Indicator, with a qualifier of Exempted. ProfessionalTaxRelevanceIndicator indicates whether a tax is relevant for a given profession and may be based on datatype GDT: Indicator, with a qualifier of Relevance.

Work Agreement Item Exemption is a set of tax relevant exemptions which are valid for a work agreement for a validity period. The elements located directly at the node Work Agreement Item Exemption are defined by the datatype IN_EmployeeTaxArrangementWorkAgreementItemExemptionElements. These elements include: UUID, ValidityPeriod, EmployeeTaxationExemptionTypeCode, and EmployeeTaxationExemptionAmount. UUID may be an alternative key, is a universally unique identifier for a WorkAgreementItemExemption, and may be based on datatype GDT: UUID. ValidityPeriod is a validity period of a WorkAgreementItemExemption and may be based on datatype GDT: CLOSED_DatePeriod with a qualifier of Validity. EmployeeTaxationExemptionTypeCode is a coded representation of a taxation exemption type for an employee and may be based on datatype GDT: EmployeeTaxationExemptionTypeCode. EmployeeTaxationExemptionAmount is an amount exempted for an employee taxation and may be based on datatype GDT: CURRENCYINR_MEDIUM_Amount.

A composition relationship to a subordinate node WorkAgreementItemExemptionFamilyMember may exist with a cardinality of 1:CN. Work Agreement Item Exemption Family Member is a family member for whom a tax exemption is applicable. The elements located directly at the node Work Agreement Item Exemption Family Member are defined by the datatype IN_EmployeeTaxArrangementWorkAgreementItemExemptionFamilyMemberElements. These elements include: UUID, BusinessPartnerinternalID, BusinessPartnerUUID, and BusinessPartnerRelationshipRoleCode. UUID may be an alternative key, is a universally unique identifier for a WorkAgreementItemExemptFamilyMember, and may be based on datatype GDT: UUID. BusinessPartnerinternalID is a unique identifier that identifies a Business Partner and may be based on datatype GDT: BusinessPartnerinternalID. BusinessPartnerUUID is a universally unique identifier that identifies a Family Member and may be based on datatype GDT: UUID. BusinessPartnerRelationshipRoleCode is a coded representation of a relationship role between an employee and a family member for whom a tax exemption applies and may be based on datatype GDT: BusinessPartnerRelationshipRoleCode. A Family Member Business Partner inbound aggregation relationship may exist from the business object Business Partner/node Business Partner with a cardinality of 1:CN which represents a family member business partner.

Work Agreement Item Investment is a set of tax-relevant investment details which are valid for a work agreement for a validity period. The elements located directly at the node Work Agreement Item Investment are defined by the datatype IN_EmployeeTaxArrangementWorkAgreementItemInvestmentElements. These elements include: UUID, ValidityPeriod, and FixedIndicator. UUID may be an alternative key, is a universally unique identifier that identifies a WorkAgreementItemInvestment node, and may be based on datatype GDT: UUID. ValidityPeriod is a validity period of a WorkAgreementItemnvestment node and may be based on datatype GDT: CLOSED_DatePeriod with a qualifier of Validity. FixedIndicator indicates whether an employee has fixed an investment and may be based on datatype GDT: Indicator with a qualifier of Fixed.

A composition relationships to a subordinate nodes WorkAgreementItemInvestmentTaxReductionBasis may exist with a cardinality of 1:N. Work Agreement Item Investment Tax Reduction Basis is a tax reduction basis due to an investment of an employee and may be valid for one Work Agreement Item Investment node. The elements located directly at the node Work Agreement Item Investment Tax Reduction Basis are defined by the datatype IN_EmployeeTaxArrangementWorkAgreementItemInvestmentTaxReductionBasisElements. These elements include: UUID, EmployeeTaxationBasisReductionTypeCode, PlannedInvestmentAmount, and FinalInvestmentAmount. UUID may be an alternative key, is a universally unique identifier that identifies a WorkAgreementItemInvestmentReductionBasis node and may be based on datatype GDT: UUID. EmployeeTaxationBasisReductionTypeCode is a coded representation of a reduction type which may be applied to a tax basis of an employee and may be based on datatype GDT: EmployeeTaxationBasisReductionTypeCode. PlannedInvestmentAmount may be optional, is a planned amount of an investment over a tax year, and may be based on datatype GDT: CURRENCYINR_MEDIUM_Amount with a qualifier of Investment. FinalInvestmentAmount may be optional, is a final amount of an investment over a tax year, and may be based on datatype GDT: CURRENCYINR_MEDIUM_Amount with a qualifier of Investment.

Employment Item is a set of information relevant for Indian tax calculation and reporting purposes for an employment. The elements located directly at the node Employment Item are defined by the datatype IN_EmployeeTaxArrangementEmploymentItemElements. These elements include: UUID and EmploymentUUID. UUID may be an alternative key, is a universally unique identifier that identifies an EmploymentItem node, and may be based on datatype GDT: UUID. EmploymentUUID is a universally unique identifier that identifies an Employment and may be based on datatype GDT: UUID.

A composition relationship to a subordinate node EmploymentItemPreviousEmployment may exist with a cardinality of 1:N. An Employment inbound aggregation relationship may exist from the business object Employment/node Employment with a cardinality of 1:C which represents an Employment for which tax-relevant data applies.

A Query By Employee And Employment query may be used to provide a list of all IN_EmployeeTaxArrangement for a particular Employment Item which satisfy selection criteria specified by the query Elements, which may be combined by logical “AND” operators. The query elements for the Query By Employee And Employment query are defined by the datatype IN_EmployeeTaxArrangementEmploymentItemEmployeeAndEmploymentQueryElements. These elements include: IN_EmployeeTaxArrangementEmploymentItemEmployeeUUID and EmploymentUUID. IN_EmployeeTaxArrangementEmploymentItemEmployeeUUID may be optional and may be based on datatype GDT: UUID. EmploymentUUID may be optional and may be based on datatype GDT: UUID.

Employment Item Previous Employment is a set of tax relevant attributes from previous employments in a current tax year. Employment Item Previous Employment may be time dependent on Validity Period. The elements located directly at the node Employment Item Previous Employment are defined by the datatype IN_EmployeeTaxArrangementEmploymentItemPreviousEmploymentElements. These elements include: UUID, ValidityPeriod, LeaveTravelAllowanceNumberValue, and LeaveTravelAllowanceRelevanceIndicator. UUID may be an alternative key, is a universally unique identifier for an Employment Item Previous Employment, and may be based on datatype GDT: UUID. ValidityPeriod is a validity period of an Employment Item Previous Employment and may be based on datatype GDT: CLOSED_DatePeriod with a qualifier of Validity. LeaveTravelAllowanceNumberValue may be optional, is a number value of allowances due to travel leave, and may be based on datatype GDT: SMALL_NumberValue. LeaveTravelAllowanceRelevanceIndicator is an indicator to denote a tax relevance of leave travel allowance and may be based on datatype GDT: Indicator, with a qualifier of Relevance.

A composition relationship to the subordinate node EmploymentItemPreviousEmploymentCompensationComponent may exist with a cardinality of 1:CN. Employment Item Previous Employment Compensation Component is a component that includes a taxation category code and amount from previous employments in a current tax year. The compensation component from previous employments encompasses a taxation category at previous employments. The elements located directly at the node Employment Item Previous Employment Compensation Component are defined by the datatype IN_EmployeeTaxArrangementEmploymentItemPreviousEmploymentCompensationComponent Elements. These elements include UUID, TaxationCategoryCode, and TaxationCategoryAmount. UUID may be an alternative key, is a universally unique identifier that identifies an Employment Item Previous Employer Compensation Component, and may be based on datatype GDT: UUID. TaxationCategoryCode is a coded representation of a taxation category of a Compensation Component, and may be based on datatype GDT: CompensationComponentTaxationCategoryCode. TaxationCategoryAmount is an amount due for a given taxation category and may be based on datatype GDT: CURRENCYINR_MEDIUM_Amount.

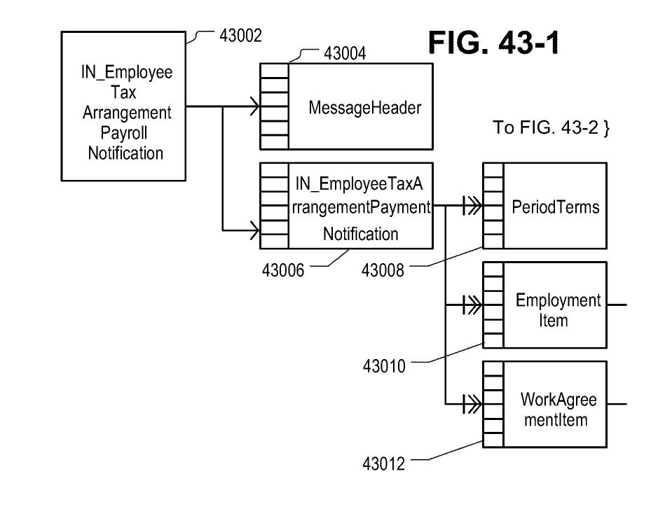

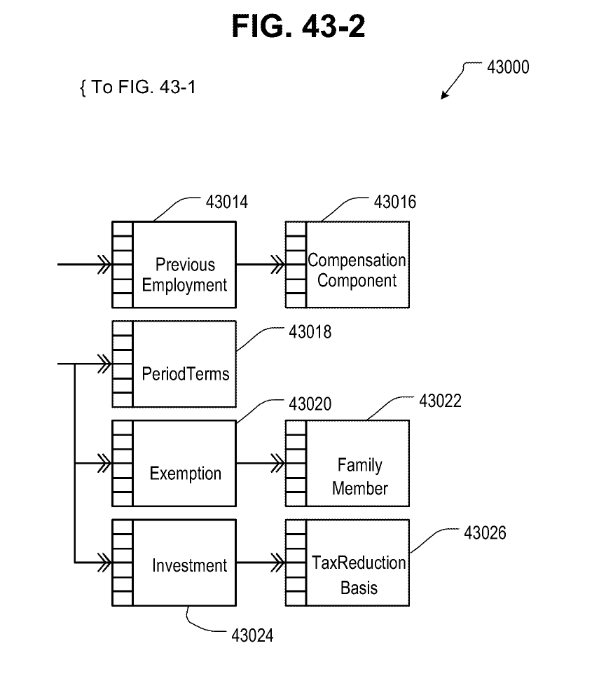

FIGS. 43-1 through 43-2 depict an example IN_Employee Tax Arrangement Payroll Notification Message Data Type 35000, which comprises 43002-43026, hierarchically related as shown. For example, the IN_Employee Tax Arrangement Payroll Notification 43002 includes a MessageHeader 43004.

The message type IN_Employee Tax Arrangement Payroll Notification is derived from a business object IN_Employee Tax Arrangement as a leading object together with its operation signature. The message type IN_Employee Tax Arrangement Payroll Notification is a notification to payroll processing about the creation of or changes in tax data for an Indian employee. Employee tax information is used to correctly calculate and transfer tax data to tax organizations. In addition, an employee's tax information is used for tax reporting purposes. The structure of the message type IN_Employee Tax Arrangement Payroll Notification is determined by a message data type IN_EmployeeTaxArrangementMessage. The message data type IN_EmployeeTaxArrangementMessage includes the object IN_EmployeeTaxArrangementPayrollNotification which is included in a business document, business information that is relevant for sending a business document in a message, the MessageHeader package, and the IN_EmployeeTaxArrangementPayrollNotification package. The message data type IN_EmployeeTaxArrangementMessage provides a structure for the IN_Employee Tax Arrangement Payroll Notification message type and for associated operations.

The MessageHeader package is a grouping of business information that is relevant for sending a business document in a message. The MessageHeader package includes the MessageHeader node. The MessageHeader node is a grouping of business information from the perspective of a sending application, such as information to identify the business document in a message, information about the sender, and optionally information about the recipient. The MessageHeader includes SenderParty and RecipientParty. MessageHeader may be based on the datatype GDT:BusinessDocumentMessageHeader.

The following elements of the GDT may be used: RecipientParty, BusinessScope, SenderParty, SenderBusinessSystemID, TestDataIndicator, RecipientBusinessSystemID, ReferenceID, ReferenceUUID, ReconciliationIndicator, ID, UUID, and CreationDateTime.

SenderParty is the partner responsible for sending a business document at a business application level. The SenderParty is of the type GDT:BusinessDocumentMessageHeaderParty. RecipientParty is of the type GDT:BusinessDocumentMessageHeaderParty. RecipientParty is the partner responsible for receiving a business document at a business application level.

The IN_EmployeeTaxArrangementPayrollNotification package is a grouping of IN_EmployeeTaxArrangementPayrollNotification with its PeriodTerms, EmploymentItem, and WorkAgreementItem packages and with the IN_EmployeeTaxArrangementPayrollNotification entity. IN_EmployeeTaxArrangementPayrollNotification includes the following Attributes: PeriodTermsListCompleteTransmissionIndicator, EmploymentItemListCompleteTransmissionIndicator, WorkAgreementItemListCompleteTransmissionIndicator, and ReconciliationPeriodCounterValue. PeriodTermsListCompleteTransmissionIndicator specifies whether the PeriodTerms data in a message is transmitted in its entirety. “Complete transmission” may means a complete transmission of all child elements of an element that are relevant for a message. When an element is deleted, all child elements are regarded as also deleted. PeriodTermsListCompleteTransmissionIndicator may be based on datatype CDT:Indicator with a qualifier of CompleteTransmission. EmploymentItemListCompleteTransmissionIndicator specifies whether EmploymentItem data in a message is transmitted in its entirety. EmploymentItemListCompleteTransmissionIndicator may be based on datatype CDT:Indicator with a qualifier of CompleteTransmission. WorkAgreementItemListCompleteTransmissionIndicator specifies whether WorkAgreementItem data in a message is transmitted in its entirety. WorkAgreementItemListCompleteTransmissionIndicator may be based on datatype CDT:Indicator with a qualifier of CompleteTransmission. ReconciliationPeriodCounterValue may be optional and may be based on datatype GDT:CounterValue with a qualifier of ReconciliationPeriod.

IN_EmployeeTaxArrangementPayrollNotification may include the non-node elements UUID and EmployeeUUID. UUID may be based on datatype GDT:UUID. EmployeeUUID may be based on datatype GDT:UUID. IN_EmployeeTaxArrangementPayrollNotification may include the node element PeriodTerms with a cardinality of 1:CN, EmploymentItem with a cardinality of 1:CN, and WorkAgreementItem with a cardinality of 1:CN.

The IN_EmployeeTaxArrangementPeriodTerms package includes the PeriodTerms entity. PeriodTerms includes an actionCode attribute. An ActionCode is a coded representation of an instruction to a recipient of a message describing how to process a transmitted element, and may be based on datatype GDT:ActionCode. PeriodTerms includes the non-node elements: UUID, ValidityPeriod, and EmployeeTaxID. UUID may be based on datatype GDT:UUID. ValidityPeriod may be based on datatype GDT:CLOSED_DatePeriod. EmployeeTaxID may be based on datatype GDT:PartyTaxID.

The IN_EmployeeTaxArrangementEmploymentItem package includes the EmploymentItem entity. EmploymentItem includes the employmentItemPreviousEmploymentListCompleteTransmissionIndicator attribute, which specifies whether EmploymentItemPreviousEmployment data in a message is transmitted in its entirety, and may be based on datatype CDT:Indicator with a qualifier of Complete Transmission. EmploymentItem includes the non-node element EmploymentUUID, which may be based on datatype GDT:UUID. EmploymentItem includes the node element PreviousEmployment with a cardinality of 1:N.

PreviousEmployment includes the following Attributes: EmploymentItemPreviousEmploymentCompensationComponentListCompleteTransmissionIndicator and ActionCode. EmploymentItemPreviousEmploymentCompensationComponentListCompleteTransmissionIndicator specifies whether EmploymentItemPreviousEmploymentCompensation-Component data in a message is transmitted in its entirety, and may be based on datatype CDT:Indicator with a qualifier of Complete Transmission. ActionCode is a coded representation of an instruction to a recipient of a message describing how to process a transmitted element, and may be based on datatype GDT:ActionCode. PreviousEmployment includes the non-node elements UUID, ValidityPeriod, LeaveTravelAllowanceNumberValue, and LeaveTravelAllowanceRelevanceIndicator. UUID may be based on datatype GDT:UUID. ValidityPeriod may be based on datatype GDT:CLOSED_DatePeriod. LeaveTravelAllowanceNumberValue may be optional and may be based on datatype GDT:SMALL_NumberValue. LeaveTravelAllowanceRelevanceIndicator may be based on datatype CDT:Indicator with a qualifier of Relevance.

PreviousEmployment may include the node element CompensationComponent with a cardinality of 1:N. CompensationComponent includes the ActionCode attribute. An ActionCode is a coded representation of an instruction to a recipient of a message describing how to process a transmitted element. ActionCode may be based on datatype GDT:ActionCode. CompensationComponent the following non-node elements: UUID, TaxationCategoryCode, and TaxationCategoryAmount. UUID may be based on datatype GDT:UUID. TaxationCategoryCode may be based on datatype GDT:CompensationComponentTaxationCategoryCode. TaxationCategoryAmount may be based on datatype CDT:CURRENCYINR_MEDIUM_Amount.

The IN_EmployeeTaxArrangementWorkAgreementItem package includes the WorkAgreementItem entity. WorkAgreementItem includes the following Attributes: WorkAgreementItemPeriodTermsListCompleteTransmissionIndicator, WorkAgreementItemExemptionListCompleteTransmissionIndicator, and WorkAgreementItemInvestmentListCompleteTransmissionIndicator. WorkAgreementItemPeriodTermsListCompleteTransmissionIndicator specifies whether WorkAgreementItemPeriodTerms data in a message is transmitted in its entirety and may be based on datatype CDT:Indicator with a qualifier of CompleteTransmission. WorkAgreementItemExemptionListCompleteTransmissionIndicator specifies whether workAgreementItemExemption data in a message is transmitted in its entirety and may be based on datatype CDT:Indicator with a qualifier of CompleteTransmission. WorkAgreementItemInvestmentListCompleteTransmissionIndicator specifies whether workAgreementItemInvestment data in a message is transmitted in its entirety and may be based on datatype CDT:Indicator with a qualifier of CompleteTransmission.

WorkAgreementItem includes the non-node elements: UUID and WorkAgreementUUID. UUID may be based on datatype GDT:UUID. WorkAgreementUUID may be based on datatype GDT:UUID. WorkAgreementItem includes the node element PeriodTerms with a cardinality of 1:N, the node element Exemption with a cardinality of 1:N, and the node element Investment with a cardinality of 1:N.

PeriodTerms includes the ActionCode attribute. An ActionCode is a coded representation of an instruction to a recipient of a message describing how to process a transmitted element and may be based on datatype GDT:ActionCode. PeriodTerms includes the non-node elements: UUID, ValidityPeriod, CityTaxationCategoryCode, HouseRentAmount, ExemptedIndicator, and ProfessionalTaxRelevanceIndicator. UUID may be based on datatype GDT:UUID. ValidityPeriod may be based on datatype GDT:CLOSED_DatePeriod. CityTaxationCategoryCode may be optional and may be based on datatype GDT:CityTaxationCategoryCode. HouseRentAmount may be based on datatype CDT:CURRENCYINR_MEDIUM_Amount with a qualifier of Rent. ExemptedIndicator may be based on datatype CDT:Indicator with a qualifier of Exempted. ProfessionalTaxRelevanceIndicator may be based on datatype CDT:Indicator with a qualifier of Relevance. In some implementations, if the value of the attribute actionCode is “Delete” only the UUID is filled and if the value of the attribute actionCode is other than “Delete”, then ValidityPeriod is also filled.

Exemption includes the following Attributes: WorkAgreementItemExemptionFamilyMemberListCompleteTransmissionIndicator and ActionCode. WorkAgreementItemExemptionFamilyMemberListCompleteTransmissionIndicator specifies whether workAgreementItemExemptionFamilyMember data in a message is transmitted in its entirety and may be based on datatype CDT:Indicator. ActionCode is a coded representation of an instruction to a recipient of a message describing how to process a transmitted element and may be based on datatype GDT:ActionCode.

Exemption includes the non-node elements: UUID, ValidityPeriod, EmployeeTaxationExemptionTypeCode, and EmployeeTaxationExemptionAmount. UUID may be based on datatype GDT:UUID. ValidityPeriod may be based on datatype GDT:CLOSED_DatePeriod. EmployeeTaxationExemptionTypeCode may be based on datatype GDT:EmployeeTaxationExemptionTypeCode. EmployeeTaxationExemptionAmount may be based on datatype CDT:CURRENCYINR_MEDIUM_Amount. Exemption includes the node element FamilyMember in a 1:N cardinality relationship.

The IN_EmployeeTaxArrangementWorkAgreementItemEmployeeTaxArrangement package includes FamilyMember entity. FamilyMember includes the ActionCode attribute. An ActionCode is a coded representation of an instruction to a recipient of a message describing how to process a transmitted element and may be based on datatype GDT:ActionCode. FamilyMember includes the non-node elements UUID, BusinessPartnerUUID, and BusinessPartnerInternalID. UUID may be based on datatype GDT:UUID. BusinessPartnerUUID may be based on datatype GDT:UUID. BusinessPartnerInternalID may be based on datatype GDT:BusinessPartnerInternalID.

Investment includes the following Attributes: WorkAgreementItemInvestmentTaxReductionBasisListCompleteTransmissionIndicator and ActionCode. WorkAgreementItemInvestmentTaxReductionBasisListCompleteTransmissionIndicator specifies whether workAgreementItemInvestmentTaxReductionBasis data in a message is transmitted in its entirety and may be based on datatype CDT:Indicator. ActionCode is a coded representation of an instruction to a recipient of a message describing how to process a transmitted element and may be based on datatype GDT:ActionCode. Investment includes the following non-node elements: UUID, ValidityPeriod, and FixedIndicator. UUID may be based on datatype GDT:UUID. ValidityPeriod may be based on datatype GDT:CLOSED_DatePeriod. FixedIndicator may be based on datatype CDT:Indicator with a qualifier of Fixed. Investment includes the node element TaxReductionBasis in a 1:N cardinality relationship.

The IN_EmployeeTaxArrangementWorkAgreementItemEmployeeTaxArrangement package includes the TaxReductionBasis entity. TaxReductionBasis includes the ActionCode attribute. An ActionCode is a coded representation of an instruction to a recipient of a message describing how to process a transmitted element and may be based on datatype GDT:ActionCode. TaxReductionBasis includes the following non-node elements: UUID, EmployeeTaxationBasisReductionTypeCode, PlannedInvestmentAmount, and FinalInvestmentAmount. UUID may be based on datatype GDT:UUID. EmployeeTaxationBasisReductionTypeCode may be based on datatype GDT:EmployeeTaxationBasisReductionTypeCode. PlannedInvestmentAmount may be optional and may be based on datatype CDT:CURRENCYINR_MEDIUM_Amount with a qualifier of Investment. FinalInvestmentAmount may be optional and may be based on datatype CDT:CURRENCYINR_MEDIUM_Amount with a qualifier of Investment.

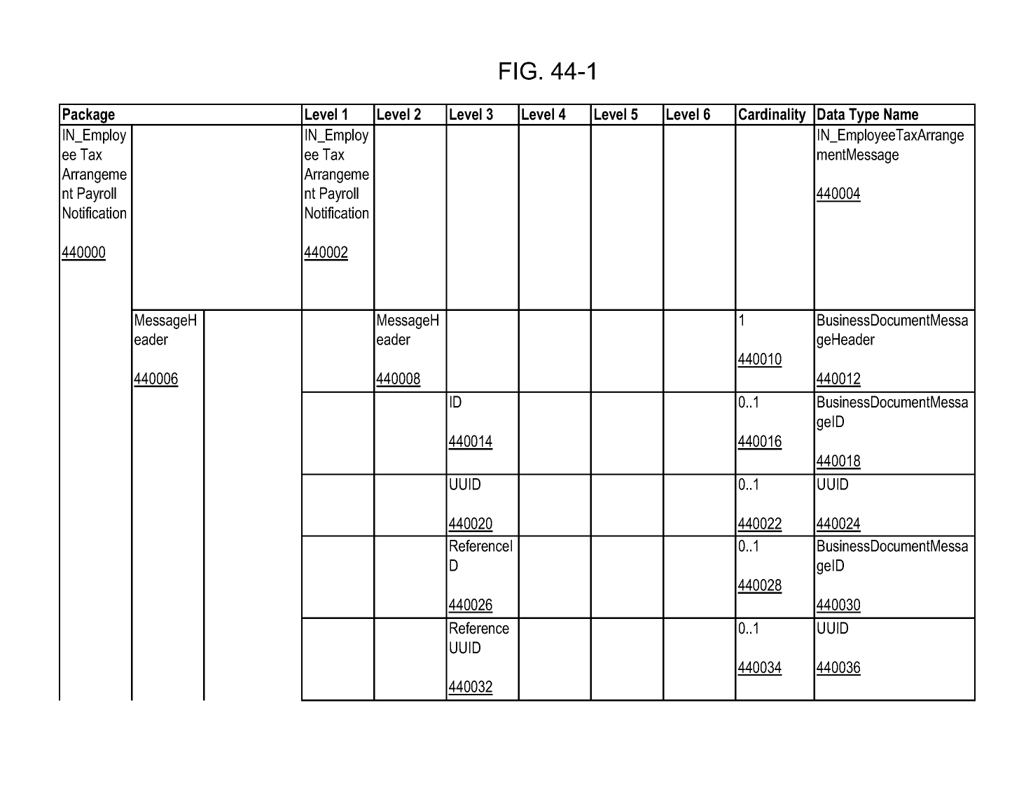

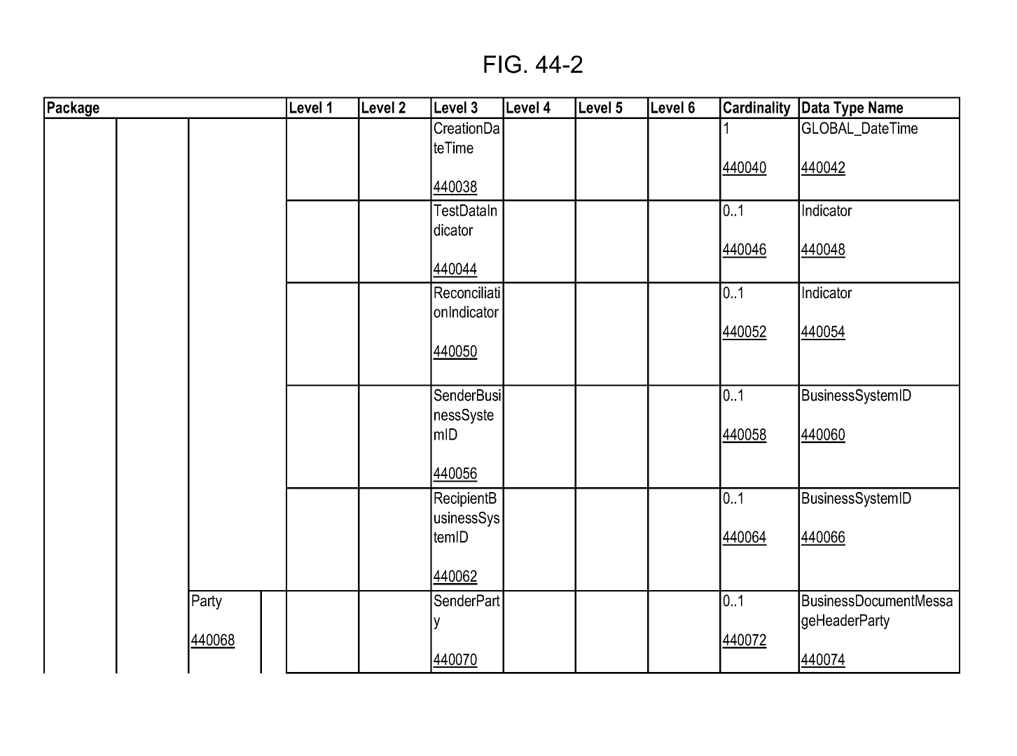

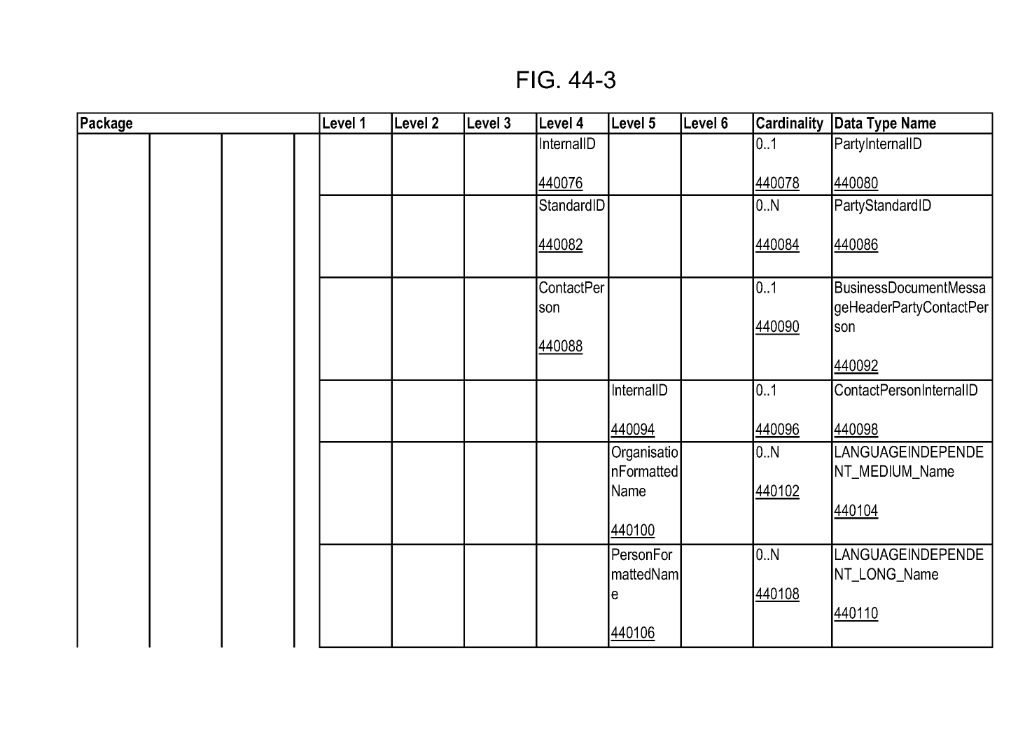

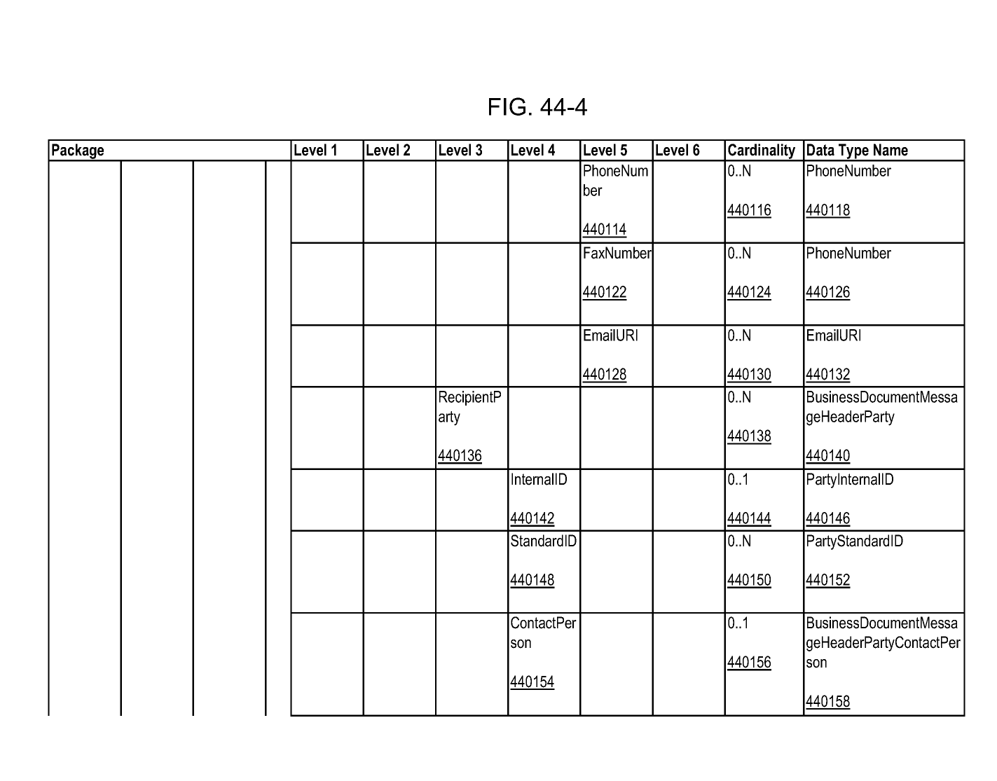

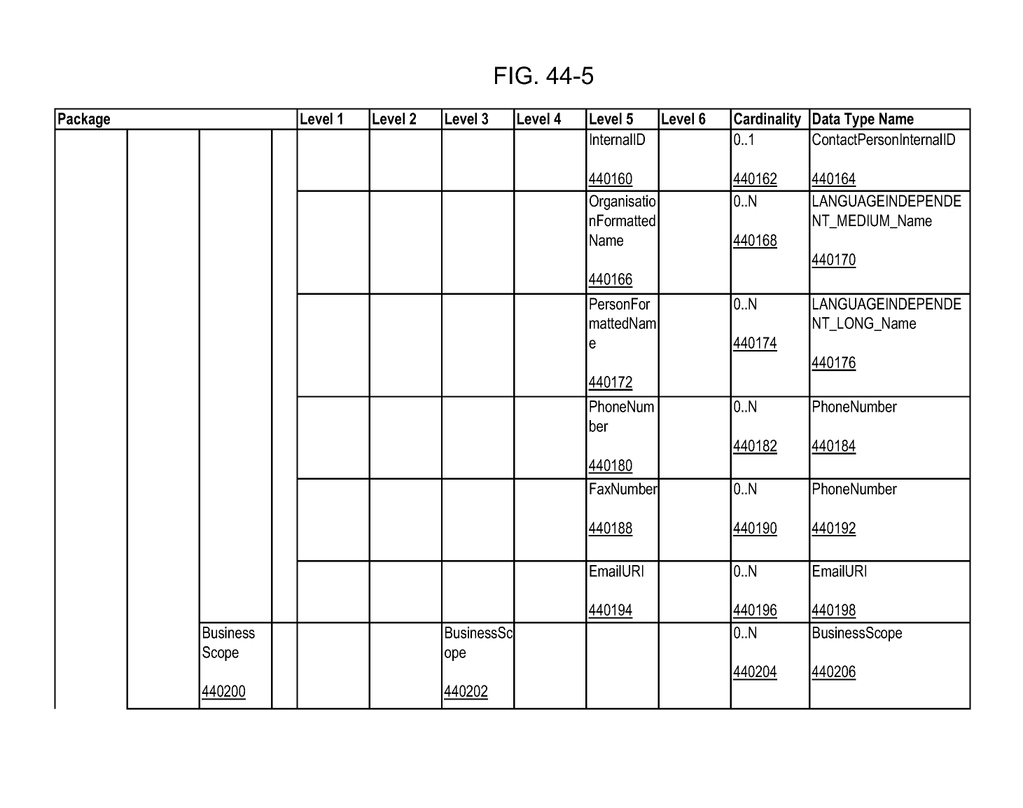

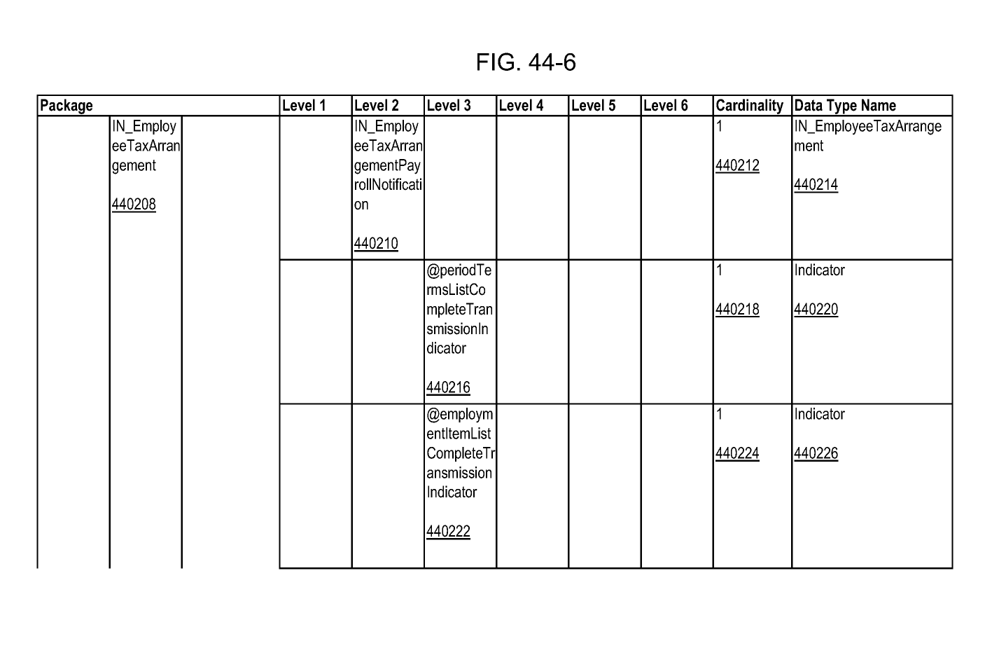

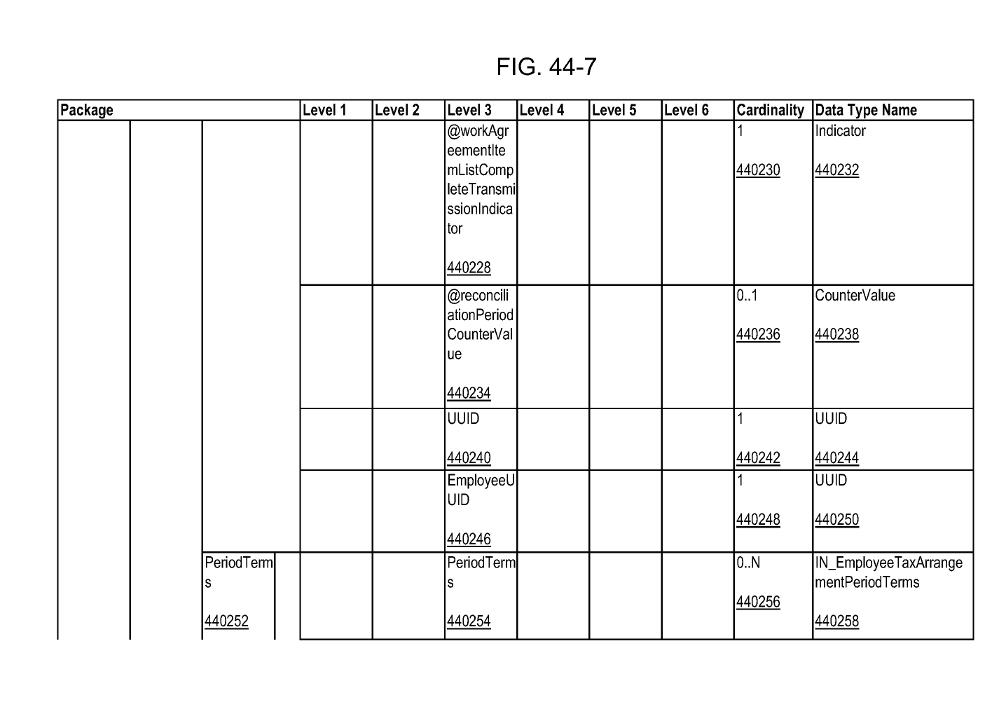

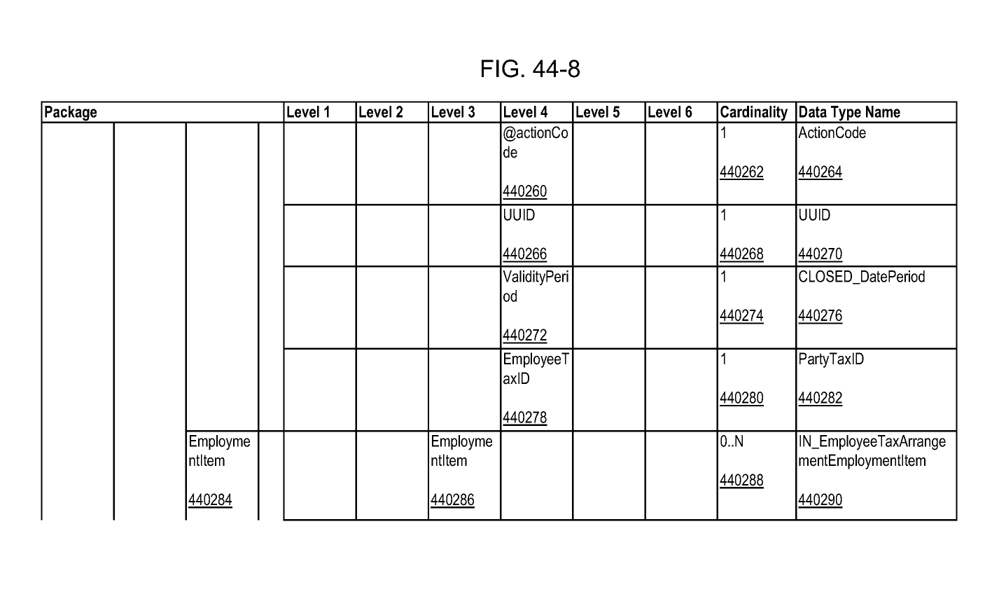

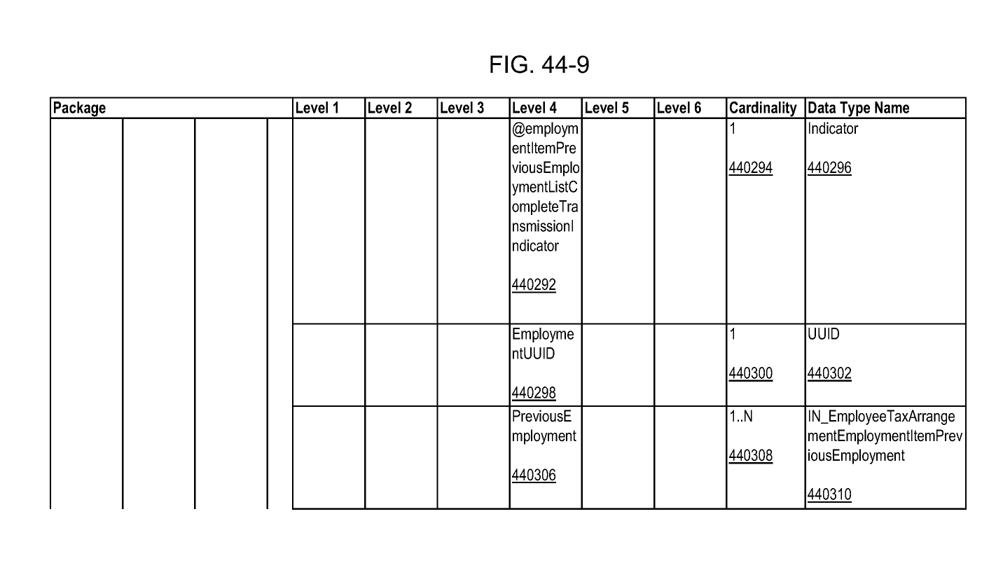

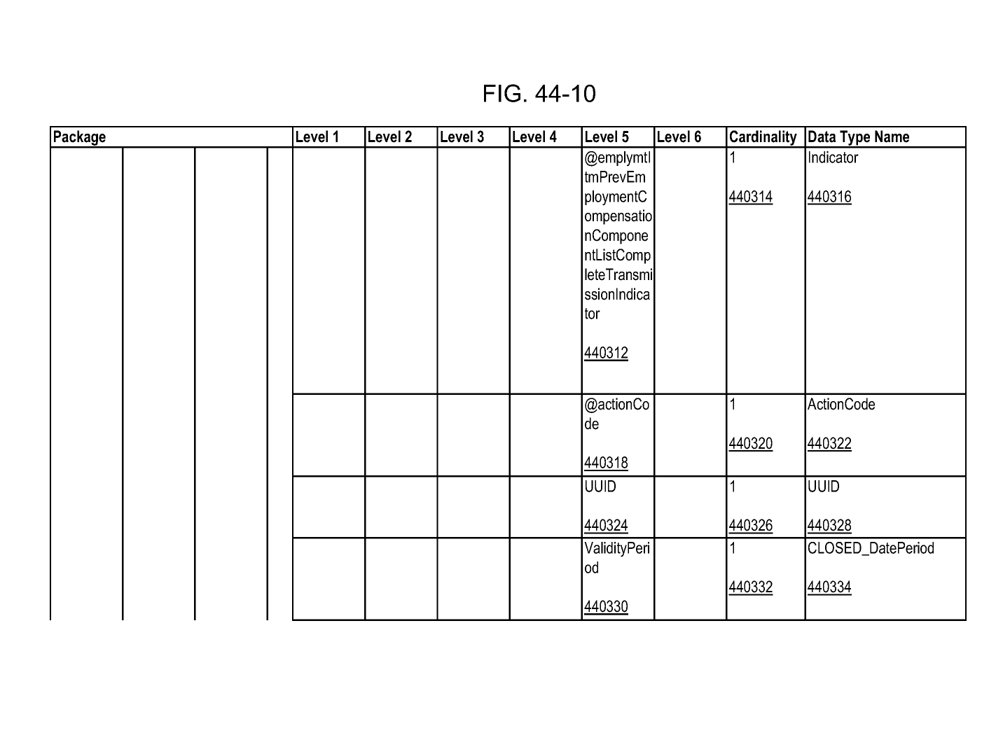

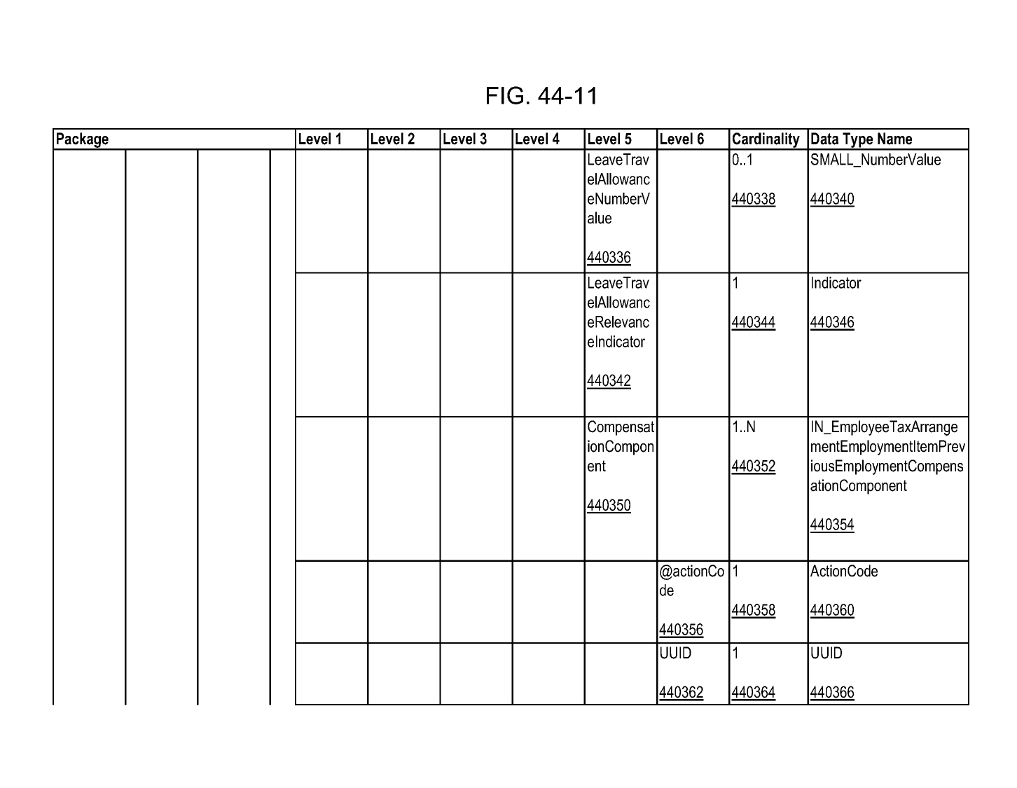

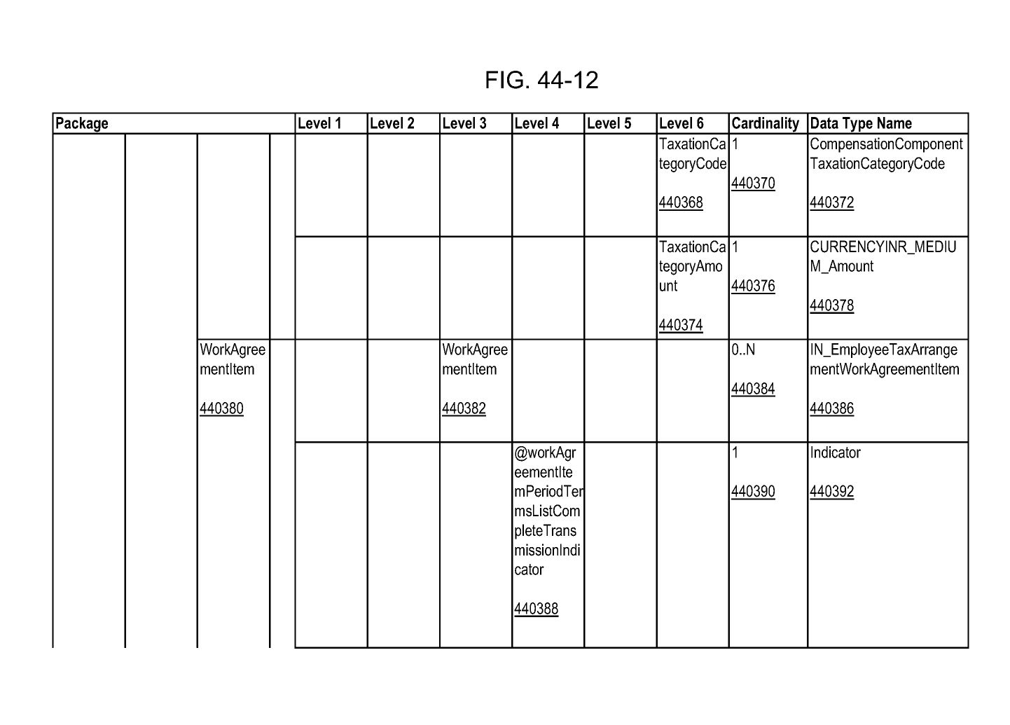

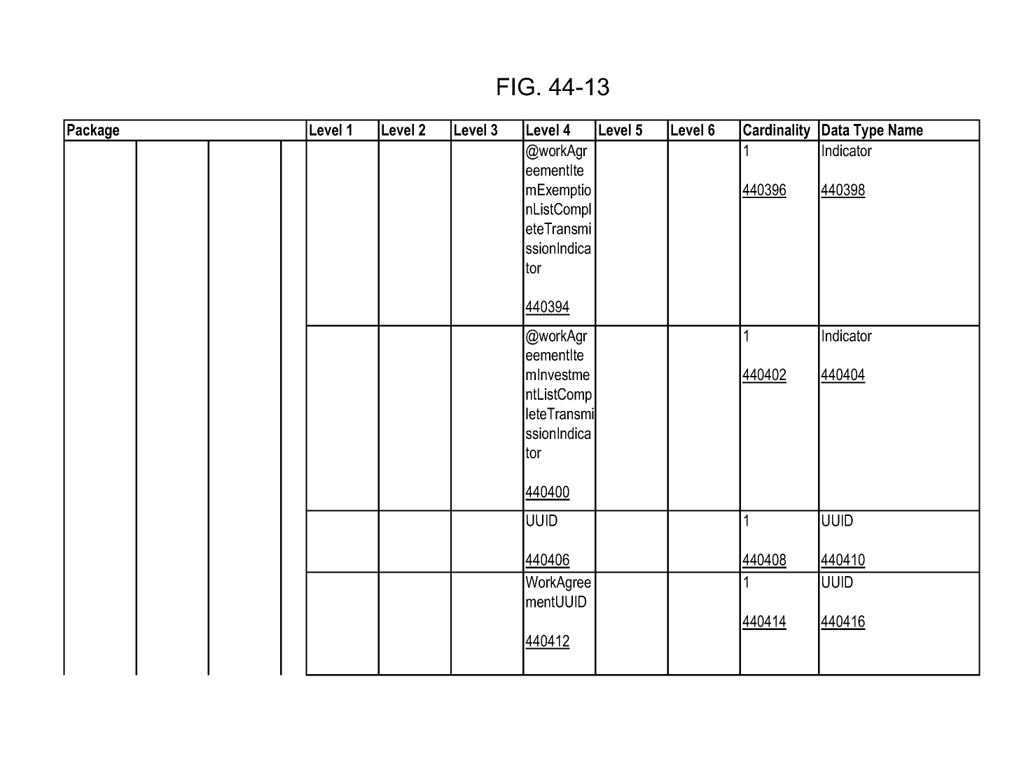

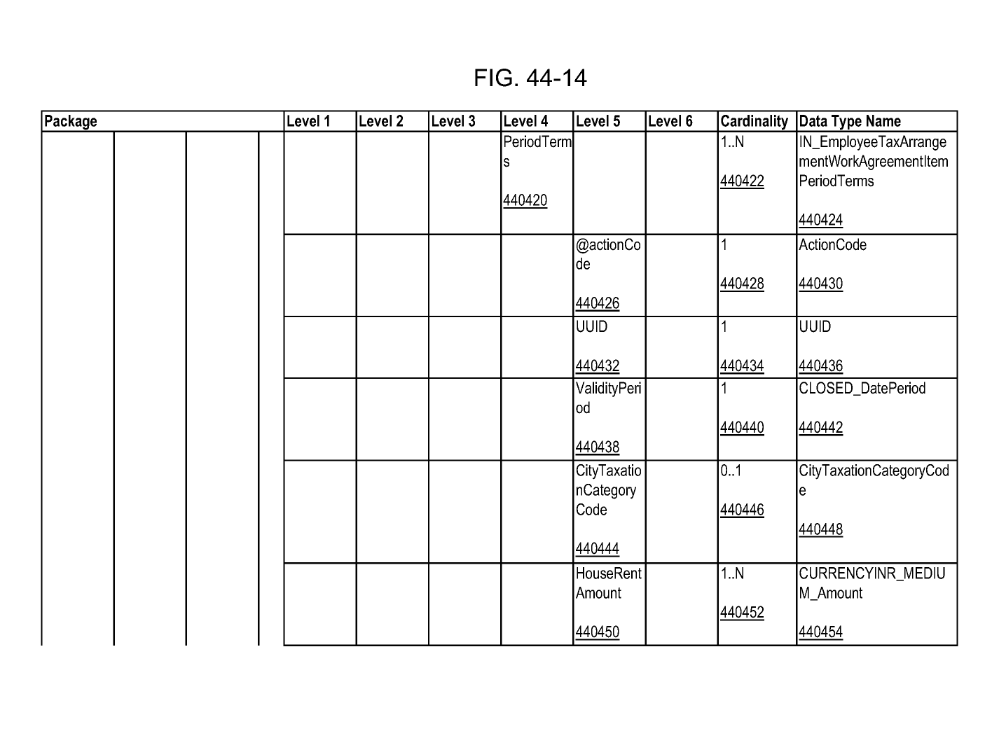

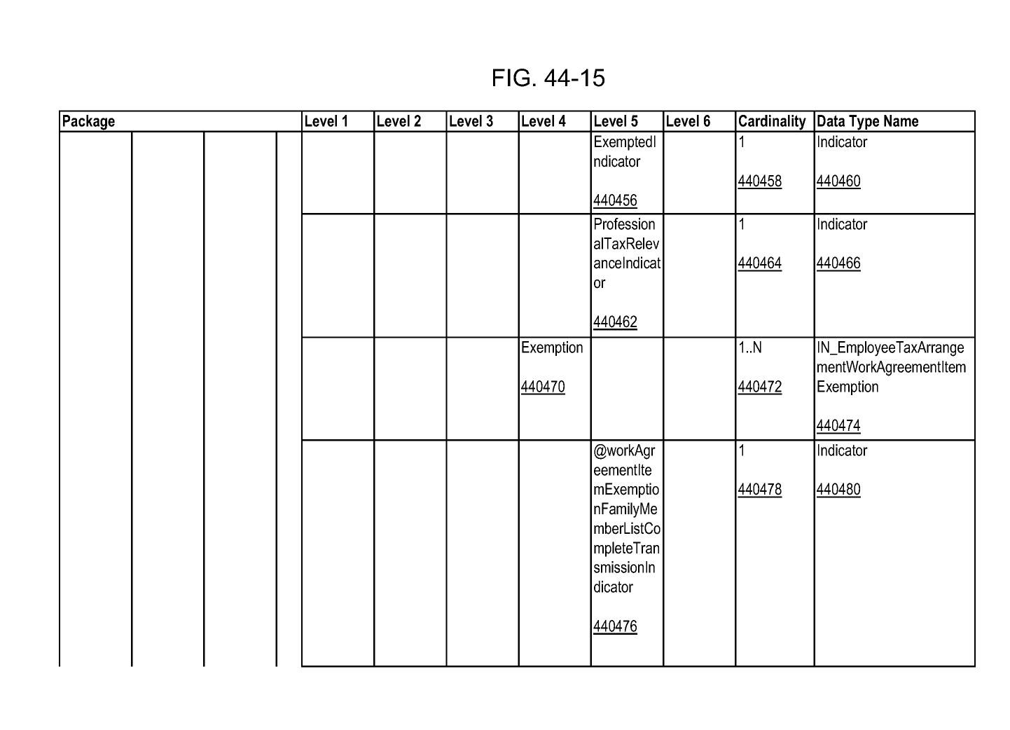

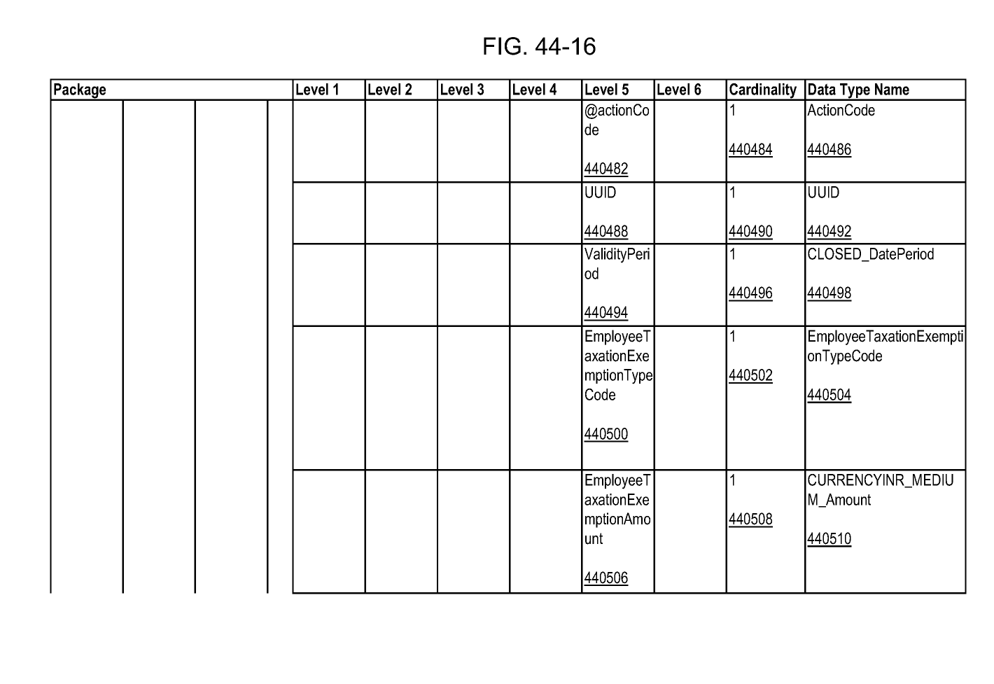

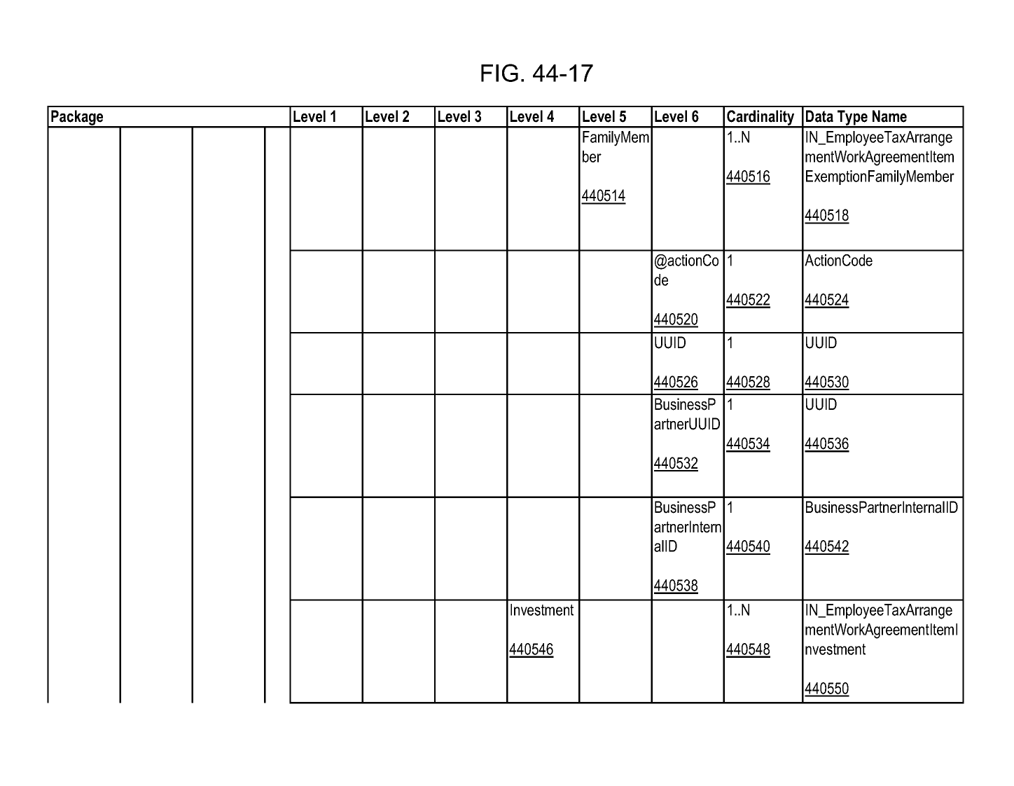

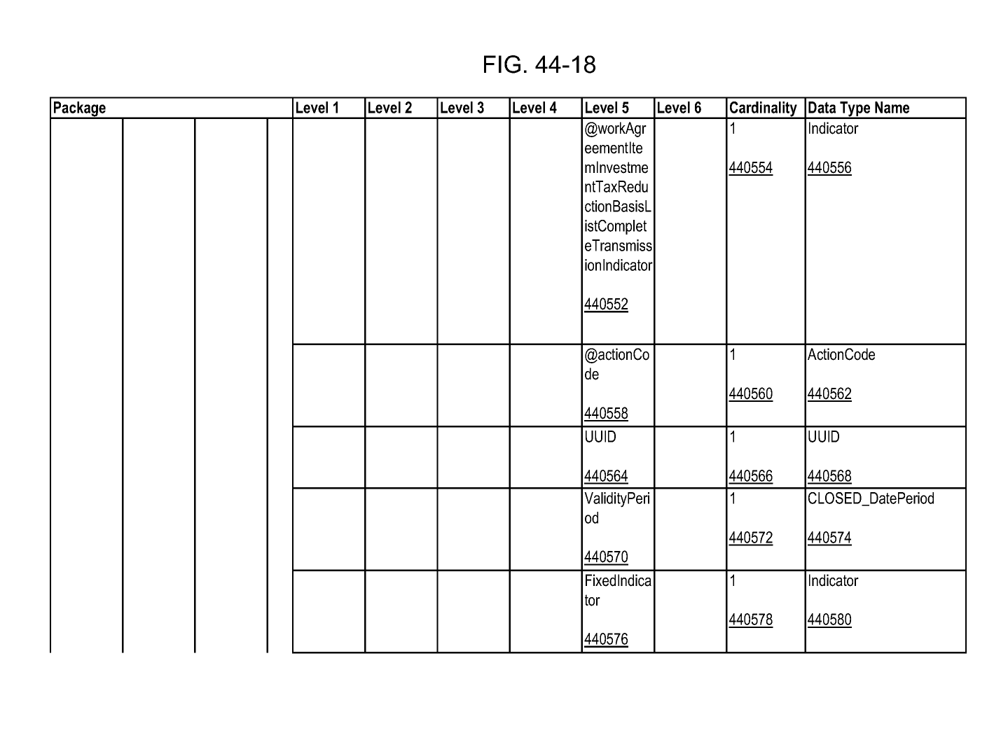

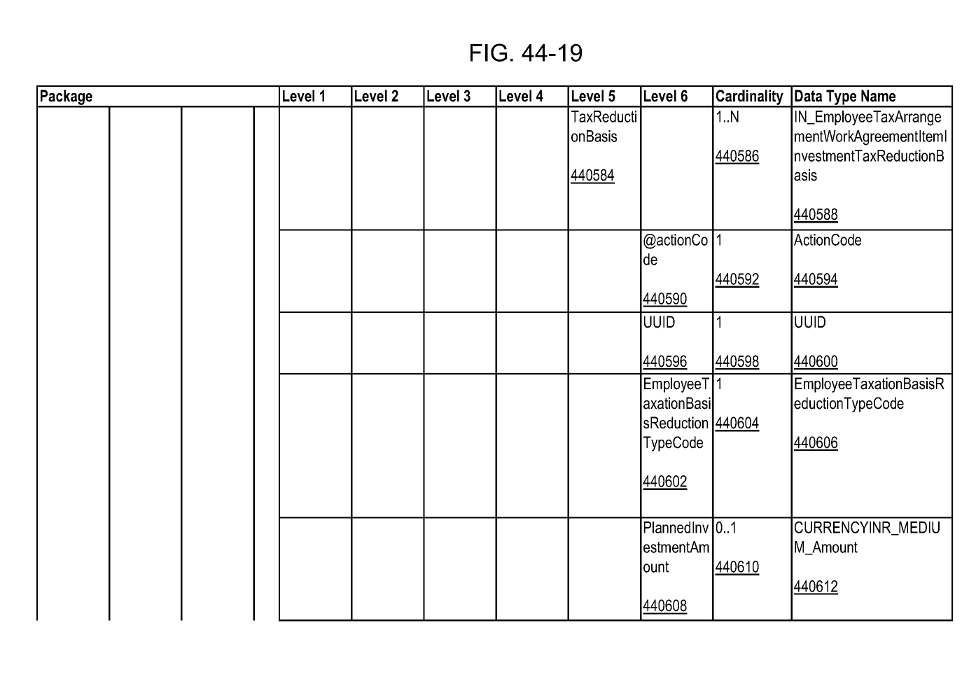

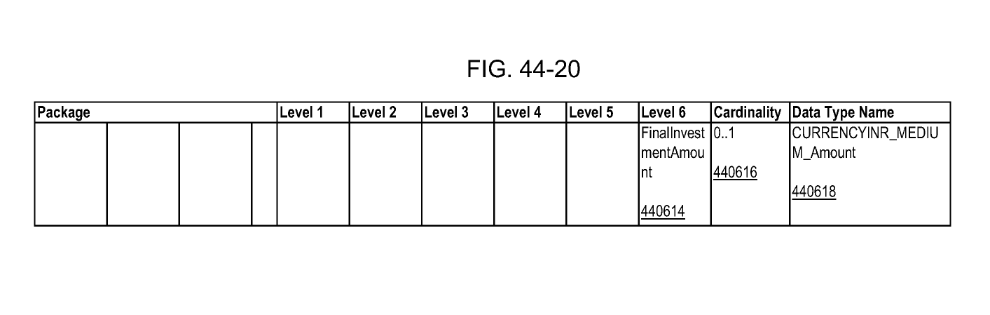

FIGS. 44-1 through 44-20 show an example configuration of an Element Structure that includes an IN_Employee Tax Arrangement Payroll Notification 440000 package. Specifically, these figures depict the arrangement and hierarchy of various components such as one or more levels of packages, entities, and datatypes, shown here as 440000 through 440618. As described above, packages may be used to represent hierarchy levels. Entities are discrete business elements that are used during a business transaction. Data types are used to type object entities and interfaces with a structure. For example, the IN_Employee Tax Arrangement Payroll Notification 440000 includes, among other things, an IN_Employee Tax Arrangement Payroll Notification 440002. Accordingly, heterogeneous applications may communicate using this consistent message configured as such.

A number of implementations have been described. Nevertheless, it will be understood that various modifications may be made without departing from the spirit and scope of the disclosure. Accordingly, other implementations are within the scope of the following claims.

What is claimed is:

1. A tangible computer readable medium including program code for providing a message-based interface for exchanging employee-specific payroll information between an employee information system and a payroll system, the medium comprising:
program code for receiving via a message-based interface derived from a common business object model, where the common business object model includes business objects having relationships that enable derivation of message-based interfaces and message packages, the message-based interface exposing at least one service as defined in a service registry and from a heterogeneous application executing in an environment of computer systems providing message-based services, a first message for requesting replication of employee-specific Indian payroll information to the payroll system that includes a first message package derived from the common business object model and hierarchically organized in memory as:
an Indian (IN)_employee payroll input collection replication request message entity; and
a collection package comprising an IN_employee payroll input collection entity and an IN_employee payroll input package, where the IN_employee payroll input package includes an employee payroll input entity and an employee package, where the employee package includes an employee entity, where the employee entity includes an action code, a common list complete transmission indicator, an employee workplace address list complete transmission indicator, an address information list complete transmission indicator, an employee tax arrangement period terms information list complete transmission indicator, an employment item list complete transmission indicator, a universal unique identifier, and an employee identifier;
program code for processing the first message according to the hierarchical organization of the first message package, where processing the first message includes unpacking the first message package based on the common business object model; and
program code for sending a second message to the heterogeneous application responsive to the first message, where the second message includes a second message package derived from the common business object model to provide consistent semantics with the first message package.

2. The computer readable medium of claim 1, wherein the employee package further comprises at least one of the following: a common entity, an employee workplace address information entity, an address information entity, an employee tax arrangement period terms entity, and an employment item package.

3. A distributed system operating in a landscape of computer systems providing message-based services defined in a service registry, the system comprising:
a graphical user interface comprising computer readable instructions, embedded on tangible media, for requesting replication of employee-specific Indian payroll information to a payroll system using a request;
a first memory storing a user interface controller for processing the request and involving a message including a message package derived from a common business object model, where the common business object model includes business objects having relationships that enable derivation of message-based service interfaces and message packages, the message package hierarchically organized as:
an Indian (IN)_employee payroll input collection replication request message entity; and
a collection package comprising an IN_employee payroll input collection entity and an IN_employee payroll input package, where the IN_employee payroll input package includes an employee payroll input entity and an employee package, where the employee package includes an employee entity, where the employee entity includes an action code, a common list complete transmission indicator, an employee workplace address list complete transmission indicator, an address information list complete transmission indicator, an employee tax arrangement period terms information list complete transmission indicator, an employment item list complete transmission indicator, a universal unique identifier, and an employee identifier; and
a second memory, remote from the graphical user interface, storing a plurality of message-based service interfaces derived from the common business object model to provide consistent semantics with messages derived from the common business object model, where one of the message-based service interfaces processes the message according to the hierarchical organization of the message package, where processing the message includes unpacking the first message package based on the common business object model.

4. The distributed system of claim 3, wherein the first memory is remote from the graphical user interface.

5. The distributed system of claim 3, wherein the first memory is remote from the second memory.

6. A tangible computer readable medium including program code for providing a message-based interface for exchanging payroll-related information between an employee information system and a payroll system, the medium comprising:
program code for receiving via a message-based interface derived from a common business object model, where the common business object model includes business objects having relationships that enable derivation of message-based interfaces and message packages, the message-based interface exposing at least one service as defined in a service registry and from a heterogeneous application executing in an environment of computer systems providing message-based services, a first message for providing notification to the payroll system concerning an employee's Indian social insurance arrangement information that includes a first message package derived from the common business object model and hierarchically organized in memory as:
an Indian (IN)_employee social insurance arrangement message entity; and
an IN_employee social insurance arrangement package comprising an IN_employee social insurance arrangement entity, where the IN_employee social insurance arrangement entity includes a work agreement item list complete transmission indicator, a reconciliation period counter value, a universal unique identifier, and an employee universal unique identifier;
program code for processing the first message according to the hierarchical organization of the first message package, where processing the first message includes unpacking the first message package based on the common business object model; and
program code for sending a second message to the heterogeneous application responsive to the first message, where the second message includes a second message package derived from the common business object model to provide consistent semantics with the first message package.

7. The computer readable medium of claim 6, wherein the employee social insurance arrangement package further comprises at least one of the following: a work agreement item package.

8. A distributed system operating in a landscape of computer systems providing message-based services defined in a service registry, the system comprising:
a graphical user interface comprising computer readable instructions, embedded on tangible media, for providing notification to a payroll system concerning an employee's Indian social insurance arrangement information using a request;
a first memory storing a user interface controller for processing the request and involving a message including a message package derived from a common business object model, where the common business object model includes business objects having relationships that enable derivation of message-based service interfaces and message packages, the message package hierarchically organized as:
an Indian (IN)_employee social insurance arrangement message entity; and
an IN_employee social insurance arrangement package comprising an IN_employee social insurance arrangement entity, where the IN_employee social insurance arrangement entity includes a work agreement item list complete transmission indicator, a reconciliation period counter value, a universal unique identifier, and an employee universal unique identifier; and
a second memory, remote from the graphical user interface, storing a plurality of message-based service interfaces derived from the common business object model to provide consistent semantics with messages derived from the common business object model, where one of the message-based service interfaces processes the message according to the hierarchical organization of the message package, where processing the message includes unpacking the first message package based on the common business object model.

9. The distributed system of claim 8, wherein the first memory is remote from the graphical user interface.

10. The distributed system of claim 8, wherein the first memory is remote from the second memory.

11. A tangible computer readable medium including program code for providing a message-based interface for exchanging payroll-related information between an employee information system and a payroll system, the medium comprising:
program code for receiving via a message-based interface derived from a common business object model, where the common business object model includes business objects having relationships that enable derivation of message-based interfaces and message packages, the message-based interface exposing at least one service as defined in a service registry and from a heterogeneous application executing in an environment of computer systems providing message-based services, a first message for providing notification to the payroll system concerning an employee's Indian tax arrangement information that includes a first message package derived from the common business object model and hierarchically organized in memory as:
an Indian (IN)_employee tax arrangement payroll notification message entity; and
an IN_employee tax arrangement package comprising an IN_employee tax arrangement payroll notification entity, where the IN_employee tax arrangement payroll notification entity includes a period terms list complete transmission indicator, an employment item list complete transmission indicator, a work agreement item list complete transmission indicator, a universal unique identifier, and an employee universal unique identifier;
program code for processing the first message according to the hierarchical organization of the first message package, where processing the first message includes unpacking the first message package based on the common business object model; and
program code for sending a second message to the heterogeneous application responsive to the first message, where the second message includes a second message package derived from the common business object model to provide consistent semantics with the first message package.

12. The computer readable medium of claim 11, wherein the employee tax arrangement package further comprises at least one of the following: a period terms package, an employment item package, and a work agreement package.

13. The computer readable medium of claim 11, wherein the employee tax arrangement payroll notification entity further comprises at least one of the following: a reconciliation period counter value.

14. A distributed system operating in a landscape of computer systems providing message-based services defined in a service registry, the system comprising:
a graphical user interface comprising computer readable instructions, embedded on tangible media, for providing notification to a payroll system concerning an employee's Indian tax arrangement information using a request;
a first memory storing a user interface controller for processing the request and involving a message including a message package derived from a common business object model, where the common business object model includes business objects having relationships that enable derivation of message-based service interfaces and message packages, the message package hierarchically organized as:
an Indian (IN)_employee tax arrangement payroll notification message entity; and
an IN_employee tax arrangement package comprising an IN_employee tax arrangement payroll notification entity, where the IN_employee tax arrangement payroll notification entity includes a period terms list complete transmission indicator, an employment item list complete transmission indicator, a work agreement item list complete transmission indicator, a universal unique identifier, and an employee universal unique identifier; and
a second memory, remote from the graphical user interface, storing a plurality of message-based service interfaces derived from the common business object model to provide consistent semantics with messages derived from the common business object model, where one of the message-based service interfaces processes the message according to the hierarchical organization of the message package, where processing the message includes unpacking the first message package based on the common business object model.

15. The distributed system of claim 14, wherein the first memory is remote from the graphical user interface.

16. The distributed system of claim 14, wherein the first memory is remote from the second memory.
